(19) United States
(12) Patent Application Publication
(10) Pub. No.: US 2007/0124086 A1
(43) Pub. Date: May 31, 2007

(54) Molecular nephrotoxicology modeling

(76) Inventors: Donna L. Mendrick, Gaithersburg, MD (US); Mark W. Porter, Gaithersburg, MD (US); Kory R. Johnson, Gaithersburg, MD (US); Arthur Castle, Gaithersburg, MD (US); Brandon Higgs, Gaithersburg, MD (US); Michael Elashoff, Gaithersburg, MD (US)

Correspondence Address: COOLEY GODWARD KRONISH LLP;ATTN: Patent Group, Suite 500, 1200 - 19th Street, NW, WASHINGTON, DC, 20036-2402, US

(21) Appl. No.: 11/642,647

(22) Filed: Dec. 21, 2006

Related U.S. Application Data
(63) Continuation of application No. 10/301,856, filed on Nov. 22, 2002.
Application No. 10/301,856 is a continuation-in-part of application No. 10/152,319, filed on May 22, 2002.
(60) Provisional application No. 60/292,335, filed on May 22, 2001.
(60) Provisional application No. 60/297,523, filed on Jun. 13, 2001.
(60) Provisional application No. 60/298,925, filed on Jun. 19, 2001.
(60) Provisional application No. 60/303,810, filed on Jul. 10, 2001.
(60) Provisional application No. 60/303,807, filed on Jul. 10, 2001.
(60) Provisional application No. 60/303,808, filed on Jul. 10, 2001.
(60) Provisional application No. 60/315,047, filed on Aug. 28, 2001.
(60) Provisional application No. 60/324,928, filed on Sep. 27, 2001.
(60) Provisional application No. 60/330,867, filed on Nov. 1, 2001.
(60) Provisional application No. 60/330,462, filed on Oct. 22, 2001.
(60) Provisional application No. 60/331,805, filed on Nov. 21, 2001.
(60) Provisional application No. 60/336,144, filed on Dec. 6, 2001.
(60) Provisional application No. 60/340,873, filed on Dec. 19, 2001.
(60) Provisional application No. 60/357,843, filed on Feb. 21, 2002.
(60) Provisional application No. 60/357,842, filed on Feb. 21, 2002.
(60) Provisional application No. 60/357,844, filed on Feb. 21, 2002.
(60) Provisional application No. 60/364,134, filed on Mar. 15, 2002.
(60) Provisional application No. 60/370,206, filed on Apr. 8, 2002.
(60) Provisional application No. 60/370,247, filed on Apr. 8, 2002.
(60) Provisional application No. 60/370,144, filed on Apr. 8, 2002.
(60) Provisional application No. 60/371,679, filed on Apr. 12, 2002.
(60) Provisional application No. 60/372,794, filed on Apr. 17, 2002.

(51) Int. Cl. G06F 19/00

(52) U.S. Cl. 702/20

(57) ABSTRACT

The present invention is based on the elucidation of the global changes in gene expression and the identification of toxicity markers in kidney tissues or cells exposed to a known renal toxin. The genes may be used as toxicity markers in drug screening and toxicity assays. The invention includes a database of genes characterized by toxin-induced differential expression that is designed for use with microarrays and other solid-phase probes.

### RELATED APPLICATIONS

This application is a continuation of U.S. application Ser. No. 10/301,856, filed Nov. 22, 2002 which is a continuation-in-part of U.S. application Ser. No. 10/152,319, filed May 22, 2002, which claims priority under 35 U.S.C. §119(e) to U.S. Provisional Applications 60/292,335, filed May 22, 2001; 60/297,523, filed Jun. 13, 2001; 60/298,925, filed Jun. 19, 2001; 60/303,810, filed Jul. 10, 2001; 60/303,807, filed Jul. 10, 2001; 60/303,808, filed Jul. 10, 2001; 60/315,047, filed Aug. 28, 2001; 60/324,928, filed Sep. 27, 2001; 60/330,867, filed Nov. 1, 2001; 60/330,462, Oct. 22, 2001; 60/331,805, filed Nov. 21, 2001; 60/336,144, filed Dec. 6, 2001; 60/340,873, filed Dec. 19, 2001; 60/357,843, filed Feb. 21, 2002; 60/357,842, filed Feb. 21, 2002; 60/357,844, filed Feb. 21, 2002; 60/364,134 filed Mar. 15, 2002; 60/370,206, filed Apr. 8, 2002; 60/370,247, filed Apr. 8, 2002; 60/370,144, filed Apr. 8, 2002; 60/371,679, filed Apr. 12, 2002; and 60/372,794, filed Apr. 17, 2002, all of which are herein incorporated by reference in their entirety.

### SEQUENCE LISTING SUBMISSION ON COMPACT DISC

The Sequence Listing submitted concurrently herewith on compact disc under 37 C.F.R. §§1.821(c) and 1.821(e) is herein incorporated by reference in its entirety. The compact disc copy of the Sequence Listing in this application, is identical to the computer readable copy of the Sequence Listing filed in U.S. patent application Ser. No. 10/301,856, filed Nov. 22, 2002. The electronic copy of the Sequence Listing was created on Dec. 21, 2006.

### BACKGROUND OF THE INVENTION

The need for methods of assessing the toxic impact of a compound, pharmaceutical agent or environmental pollutant on a cell or living organism has led to the development of procedures which utilize living organisms as biological monitors. The simplest and most convenient of these systems utilize unicellular microorganisms such as yeast and bacteria, since they are the most easily maintained and manipulated. In addition, unicellular screening systems often use easily detectable changes in phenotype to monitor the effect of test compounds on the cell. Unicellular organisms, however, are inadequate models for estimating the potential effects of many compounds on complex multicellular animals, as they do not have the ability to carry out biotransformations.

The biotransformation of chemical compounds by multicellular organisms is a significant factor in determining the overall toxicity of agents to which they are exposed. Accordingly, multicellular screening systems may be preferred or required to detect the toxic effects of compounds. The use of multicellular organisms as toxicology screening tools has been significantly hampered, however, by the lack of convenient screening mechanisms or endpoints, such as those available in yeast or bacterial systems. Additionally, previous attempts to produce toxicology prediction systems have failed to provide the necessary modeling data and statistical information to accurately predict toxic responses (e.g., WO 00/12760, WO 00/47761, WO 00/63435, WO 01/32928, and WO 01/38579).

### SUMMARY OF THE INVENTION

The present invention is based on the elucidation of the global changes in gene expression in renal tissues or cells exposed to known toxins, in particular renal toxins, as compared to unexposed tissues or cells as well as the identification of individual genes that are differentially expressed upon toxin exposure.

In various aspects, the invention includes methods of predicting at least one toxic effect of a compound, predicting the progression of a toxic effect of a compound, and predicting the renal toxicity of a compound. The invention also includes methods of identifying agents that modulate the onset or progression of a toxic response. Also provided are methods of predicting the cellular pathways that a compound modulates in a cell. The invention also includes methods of identifying agents that modulate protein activities.

In a further aspect, the invention includes probes comprising sequences that specifically hybridize to genes in Tables 1-5. In some instances, the genes are rat genes. Also included are solid supports comprising at least two of the previously mentioned probes. The invention also includes a computer system that has a database containing information identifying the expression level in a tissue or cell sample exposed to a renal toxin of a set of genes comprising at least two genes in Tables 1-5.

### DETAILED DESCRIPTION

Many biological functions are accomplished by altering the expression of various genes through transcriptional (e.g. through control of initiation, provision of RNA precursors, RNA processing, etc.) and/or translational control. For example, fundamental biological processes such as cell cycle, cell differentiation and cell death, are often characterized by the variations in the expression levels of groups of genes.

Changes in gene expression are also associated with the effects of various chemicals, drugs, toxins, pharmaceutical agents and pollutants on an organism or cell. For example, the lack of sufficient expression of functional tumor suppressor genes and/or the over expression of oncogene/protooncogenes after exposure to an agent could lead to tumorgenesis or hyperplastic growth of cells (Marshall (1991), Cell 64:313-326; Weinberg (1991), Science 254:1138-1146). Thus, changes in the expression levels of particular genes (e.g. oncogenes or tumor suppressors) may serve as signposts for the presence and progression of toxicity or other cellular responses to exposure to a particular compound.

Monitoring changes in gene expression may also provide certain advantages during drug screening and development. Often drugs are screened for the ability to interact with a major target without regard to other effects the drugs have on cells. These cellular effects may cause toxicity in the whole animal, which prevents the development and clinical use of the potential drug.

The present inventors have examined tissue from animals exposed to known renal toxins which induce detrimental kidney effects, to identify global changes in gene expression induced by these compounds. These global changes in gene expression, which can be detected by the production of expression profiles (an expression level of one or more genes), provide useful toxicity markers that can be used to monitor toxicity and/or toxicity progression by a test compound. Some of these markers may also be used to monitor or detect various disease or physiological states, disease progression, drug efficacy, and drug metabolism.

Identification of Toxicity Markers

To evaluate and identify gene expression changes that are predictive of toxicity, studies using selected compounds with well characterized toxicity have been conducted by the present inventors to catalogue altered gene expression. In the present study, indomethacin, diflunisal, colchicine, chloroform, diclofenac, menadione, sodium chromate, sodium oxalate, thioacetamide, and vancomycin were selected as known renal toxins.

Cephaloridine is an amphoteric, semi-synthetic, broad-spectrum cephalosporin derived from cephalosporin C. Cephalosporins are 3-lactam-containing antibiotics which prevent bacterial growth by inhibiting polymerization of the peptidoglycan bacterial cell wall. The linear glycan chains (composed of N-acetylglucosime and N-acetylmuramic acid) are cross-linked to each other by the coupling of short chains of several amino acids, the coupling resulting from the action of a transpeptidase. It is believed that cephalosporins act by blocking the activity of the transpeptidase (Goodman & Gilman's The Pharmalogical Basis of Therapeutics 9^{th} ed., J. G. Hardman et al. Eds., McGraw Hill, New York, 1996, pp. 1074-1075, 1089-1095).

Cephaloridine is administered intramuscularly and is used to treat infections of the respiratory tract, gastrointestinal tract and urinary tract, as well as infections of soft tissue, bones and joints. Noted adverse effects include hypersensitivity reactions (such as anaphylactic shock, urticaria and bronchospasm), gastrointestinal disturbances, candidiasis, and cardiovascular and blood toxicity, in particular, toxicity to the hematopoietic system (cells responsible for the formation of red and white blood cells and platelets).

Although cephaloridine may be nephrotoxic at high dosages, it is not as harmful to the kidneys as are the aminoglycosides and polymixins. High dosages of cephaloridine may cause acute renal tubular necrosis (Cecil Textbook of Medicine 20^{th} ed., part XII, p. 586, J. C. Bennett and F. Plum Eds., W. B. Saunders Co., Philadelphia, 1996) or drug-induced interstitial nephritis, which is accompanied by elevated IgE levels, fever, arthralgia and maculopapular rash. Renal biopsy demonstrates edema and interstitial inflammatory lesions, mainly with lymphocytes, monocytes, eosinophils and plasma cells. Vasculitis of small vessels may develop, leading to necrotising glomerulonephritis (G. Koren, “The nephrotoxic potential of drugs and chemicals. Pharmacological basis and clinical relevance.,” Med Toxicol Adverse Drug Exp 4(1):59-72, 1989).

Cephaloridine has also been shown to reduce mitochondrial respiration and uptake of anionic succinate and carrier-mediated anionic substrate transport (Tune et al. (1990), J Pharmacol Exp Ther 252:65-69). In a study of oxidative stress and damage to kidney tissue, cephaloridine depleted reduced glutathione (GSH) and produced oxidized glutathione (GSSG) in the renal cortex. This drug also inhibited glutathione reductase and produced malondialdehyde and conjugated dienes (Tune et al. (1989), Biochem Pharmacol 38:795-802). Because cephaloridine is actively transported into the proximal renal tubule, but slowly transported across the lumenal membrane into the tubular fluid, high concentrations can accumulate and cause necrosis. Necrosis can be prevented by administering inhibitors of organic anion transport, although such treatment may be counterproductive, as cephaloridine is passed in and out of the kidney by the renal organic anion transport system (Tune et al. (1980), J Pharmacol Exp Ther 215:186-190).

Cisplatin (Pt (NH₃)₂(Cl)₂), a broad-spectrum anti-tumor agent, is commonly used to treat tumors of the testicles, ovaries, bladder, skin, head and neck, and lungs (PDR 47^{th} ed., pp. 754-757, Medical Economics Co., Inc., Montvale, N.J., 1993; Goodman & Gilman's The Pharmalogical Basis of Therapeutics 9th ed., pp. 1269-1271, J. G. Hardman et al. Eds., McGraw Hill, New York, 1996). Cisplatin diffuses into cells and functions mainly by alkylating the N⁷ of guanine, a highly reactive site, causing interstrand and intrastrand crosslinks in the DNA that are lethal to cells. The drug is not sensitive to the cell cycle, although its effects are most pronounced in S phase.

Because the drug is cleared from the body mainly by the kidneys, the most frequent adverse effect of cisplatin usage is nephrotoxicity, the severity of which increases with increasing dosage and treatment terms. Other adverse effects include renal tubule damage, myelosuppression (reduced numbers of circulating platelets, leukocytes and erythrocytes), nausea and vomiting, ototoxicity, serum electrolyte disturbances (decreased concentrations of magnesium, calcium, sodium, potassium and phosphate, probably resulting from renal tubule damage), increased serum concentrations of urea and creatinine, and peripheral neuropathies.

In one study on rats (Nonclercq et al. (1989), Exp Mol Pathol 51:123-140) administration of cisplatin or carboplatin induced renal injury, carboplatin causing less damage than cisplatin. The most prominent injury was to the straight portion of proximal renal tubule.

In another rat study (Goldstein et al. (1981), Toxicol Appl Pharmacol 60:163-175) animals injected with cisplatin displayed decreased food intake as drug dosage increased. On day 2, the high-dose groups (10-15 mg/kg) exhibited a six or seven-fold elevation in BUN. On day 4, BUN elevation was noted in the 5 mg/kg group. An increase in urine volume was observed beginning on days 3-4, along with decreased urine osmolality in the low-dose groups (2.5 or 5 mg/kg). Another experiment on rats (Agarwal et al. (1995), Kidney Int 48:1298-1307) showed that cisplatin treatment produced elevations in serum creatinine levels, which began on day 3 and progressed for the duration of the study.

PAN (C₂₂H₂₉N₇O₅), an antibiotic produced by Streptomyces alboniger, inhibits protein synthesis and is commonly used experimentally on rats to mimic human minimal change disease. One study showed that PAN-injected rats demonstrated an increase in levels of serum non-esterified fatty acids, while the serum albumin concentration was negatively affected (Sasaki et al. (1999), Adv Exp Med Biol 467:341-346).

In another rat study, an adenosine deaminase inhibitor prevented PAN nephrotoxicity, indicating that PAN toxicity is linked to adenosine metabolism (Nosaka et al. (1997), Free Radic Biol Med 22:597-605). Another group showed that PAN, when administered to rats, led to proteinuria, a condition associated with abnormal amounts of protein in the urine, and renal damage, e.g. blebbing of glomerular epithelial cells, focal separation of cells from the glomerular basement membrane, and fusion of podocytes (Olson et al. (1981), Lab Invest 44:271-279). In another study on rats, administration of PAN induced glomerular epithelial cell apoptosis in a dose- and time-dependent manner (Sanwal et al. (2001), Exp Mol Pathol 70:54-64).

One study with PAN-injected rats (Koukouritaki et al. (1998), J Investig Med 46: 284-289) examined the changes in the expression of the proteins paxillin, focal adhesion kinase, and Rho, all of which regulate cell adhesion to the extracellular matrix. Paxillin levels increased steadily, peaked at day 9 after PAN injection, and then remained elevated even after proteinuria resolved. There was no observed change in expression of either focal adhesion kinase or Rho.

BEA, (C₂H₆BrN.HBr), is commonly used experimentally on rats to induce papillary necrosis and renal cortex damage, which is similar to human analgesic nephropathy. BEA-induced papillary necrosis in rats eventually leads to the onset of focal glomerular sclerosis and nephrotic proteinuria (Garber et al. (1999), Am J Kidney Dis 33: 1033-1039). Even at low doses (50 mg/kg), BEA can induce an apex limited renal papillary necrosis (Bach et al. (1983), Toxicol Appl Pharmacol 69:333-344). In male Wistar rats, BEA administered at 100 mg/kg was shown to cause renal papillary necrosis within 24 hours (Bach et al. (1991), Food Chem Toxicol 29:211-219). Additionally, Bach et al. showed that there was an increase in urinary triglycerides, and lipid deposits were seen by Oil Red O lipid staining in the cells of the collecting ducts and hyperplastic urothelia adjacent to the necrosed region.

It has also been shown that succinate and citrate concentrations are significantly lower in the urine of BEA-treated rats (Holmes et al. (1995), Arch Toxicol 70:89-95). Moreover, BEA treatment induced glutaric and adipic aciduria, which is symptomatic of an enzyme deficiency in the acyl CoA dehydrogenases. The same study examined urinary taurine levels in desert mice, and in BEA-treated desert mice there was an increase in the urinary taurine level which is indicative of liver toxicity.

Another study on BEA-treated rats showed that there was an increase in the concentrations of creatine in the renal papilla and glutaric acid in the liver, renal cortex, and renal medulla as soon as 6 hours post-treatment (Garrod et al. (2001), Magn Reson Med 45: 781-790).

Discovered and purified in the early 1960's, gentamicin is a broad-spectrum aminoglycoside antibiotic that is cidal to aerobic gram-negative bacteria and commonly used to treat infections, e.g., those of the urinary tract, lungs and meninges. As is typical for an aminoglycoside, the compound is made of two amino sugar rings linked to a central aminocyclitol ring by glycosidic bonds. Aminoglycosides are absorbed poorly with oral administration, but are excreted rapidly by the kidneys. As a result, kidney toxicity is the main adverse effect, although ototoxicity and neuromuscular blockade can also occur. Gentamicin acts by interfering with bacterial protein synthesis. This compound is more potent than most other antibacterial inhibitors of protein synthesis, which are merely bacteriostatic, and its effects on the body are, likewise, more severe (Goodman & Gilman's The Pharmalogical Basis of Therapeutics 9^{th} ed., pp. 1103-1115, J. G. Hardman et al. Eds., McGraw Hill, New York, 1996).

Aminoglycosides work rapidly, and the rate of bacterial killing is concentration-dependent. Residual bactericidal activity remains after serum concentration has fallen below the minimum inhibitory concentration (MIC), with a duration that is also dosage/concentration-dependent. The residual activity allows for once-a-day administration in some patients. These drugs diffuse into bacterial cells through porin channels in the outer membrane and are then transported across the cytoplasmic membrane via a membrane potential that is negative on the inside (Goodman & Gilman, supra).

Kidney damage, which can develop into renal failure, is due to the attack of gentamicin on the proximal convoluted tubule, particularly in the S1 and S2 segments. The necrosis, however, is often patchy and focal (Shanley et al. (1990), Ren Fail 12:83-87). A rat study by Shanley et al. showed that superficial nephrons are more susceptible to necrosis than juxtamedullary nephrons, although the initial segment of the superficial nephrons is remarkably resistant to necrosis.

Reported enzymatic changes upon gentamicin treatment are increased activities of N-acetyl-beta-D-glucosaminidase and alkaline phosphatase and decreased activities of sphingomyelinase, cathepsin B, Na⁺/K⁺-ATPase, lactate dehydrogenase and NADPH cytochrome C reductase, along with decreased protein synthesis and alpha-methylglucose transport (Monteil et al. (1993), Ren Fail 15:475-483). An increase in gamma-glutamyl transpeptidase activity in urine has also been reported (Kocaoglu et al. (1994), Arch Immunol Ther Exp (Warsz) 42:125-127), and the quantification of this enzyme in urine is a useful marker for monitoring gentamicin toxicity.

One source of renal pathology resulting from gentamicin treatment is the generation of reactive oxygen metabolites. Gentamicin has been shown, both in vitro and in vivo, to be capable of enhancing the production of reactive oxygen species. Iron, a necessary co-factor that catalyzes free-radical formation, is supplied by cytochrome P450 (Baliga et al. (1999), Drug Metab Rev 31:971-997).

A gene delivery experiment in rats, in which the human kallikrein gene was cloned into an adenovirus vector and the construct then co-administered with a gentamicin preparation, showed that kallikrein can protect against gentamicin-induced nephrotoxicity. Significantly increased renal blood flow, glomerular filtration rates and urine flow were observed, along with decreased renal tubular damage, cellular necrosis and lumenal protein casts. Kallikrein gene delivery also caused a decrease in blood urea nitrogen levels and increases in urinary kinin and nitrite/nitrate levels. This study provides evidence that the tissue kallikrein-kinin system may be a key pathway that is perturbed during the induction of nephrotoxicity by gentamicin (Murakami et al. (1998), Kidney Int 53:1305-1313).

Ifosfamide, an alkylating agent, is commonly used in chemotherapy to treat testicular, cervical, and lung cancer. Ifosfamide is slowly activated in the liver by hydroxylation, forming the triazene derivative 5-(3,3-dimethyl-1-triazeno)-imidazole-4-carboxamide (DTIC) (Goodman & Gilman's The Pharmacological Basis of Therapeutics 9^{th} ed., p. 1235, J. G. Hardman et al., Eds., McGraw Hill, New York, 1996). Cytochrome P450 activates DTIC via an N-demethylation reaction yielding an alkylating moiety, diazomethane. The active metabolites are then able to cross-link DNA causing growth arrest and cell death. Though ifosfamide is therapeutically useful, it is also associated with nephrotoxicity, urotoxicity, and central neurotoxicity.

Mesna, another therapeutic, is often administered concomitantly to prevent kidney and bladder problems from arising (Brock and Pohl (1986), IARC Sci Publ 78:269-279). However, there are documented cases in which tubular toxicity occurred and elevated urinary levels of alanine aminopeptidase and N-acetyl-beta-D-glucosaminidase were found in patients even though mesna was administered alongside ifosfamide (Goren et al. (1987), Cancer Treat Rep 71:127-130).

One study examined 42 patients that had been administered ifosfamide to treat advanced soft-tissue sarcoma (Stuart-Harris et al. (1983), Cancer Chemother Pharmacol 11:69-72). The ifosfamide dosage varied from 5.0 g/m² to 8.0 g/m², and all of the patients were given mesna to counteract the negative effects of ifosfamide. Even so, nausea and vomiting were common to all of the patients. Out of the 42 patients, seven developed nephrotoxicity, and two of the cases progressed to fatal renal failure.

In another clinical study, renal tubular function was monitored in 18 neuroblastoma patients (Caron et al. (1992), Med Pediatr Oncol 20:42-47). Tubular toxicity occurred in at least 12 of the patients, and seven of those patients eventually developed Debre-de Toni-Fanconi syndrome, although in 3 cases the syndrome was reversible.

Fanconi syndrome is a disorder marked by dysfunction of the proximal tubules of the kidney. It is associated with aminoaciduria, renal glycosuria, and hyperphosphaturia. Ifosfamide is often used experimentally on rats to induce Fanconi syndrome. In one study, rats that were administered 80 mg/kg of ifosfamide had significantly lower body weight and hematocrit than control rats (Springate and Van Liew (1995), J Appl Toxicol 15:399-402). Additionally, the rats had low-grade glucosuria, proteinuria, and phosphaturia. In a mouse study, ifosfamide induced elevated serum creatinine and urea levels and decreased the clearance rate of creatinine (Badary (1999), J Ethnopharmacol 67:135-142).

Cyclophosphamide, a nitrogen mustard and alkylating agent, is highly toxic to dividing cells and is commonly used in chemotherapy to treat malignant lymphomas, such as non-Hodgkin's lymphomas and Burkitt's lymphoma, multiple myeloma, leukemias, neuroblastomas, ovarian adenocarcinomas and retinoblastomas, as well as breast and lung cancer (Goodman & Gilman's The Pharmacological Basis of Therapeutics 9^{th} ed., pp. 1234, 1237-1239, J. G. Hardman et al., eds., McGraw Hill, New York, 1996; Physicians Desk Reference, 47^{th} ed., pp. 744-745, Medical Economics Co., Inc., Montvale, N.J., 1993). Additionally, cyclophosphamide is used as an immunosuppressive agent in bone marrow transplantation and following organ transplantation. Although cyclophosphamide is therapeutically useful against certain types of cancer, it is also associated with cardiotoxicity, nephrotoxicity (including renal tubular necrosis), hemorrhagic cystitis, myelosuppression, hepatotoxicity, impairment of male and female reproductive systems, interstitial pneumonitis and central nervous system toxicity.

Once in the liver, cyclophosphamide is hydroxylated by the cytochrome P450 mixed function oxidase system, producing the active metabolites phosphoramide mustard and acrolein, which cross-link DNA and cause growth arrest and cell death. These metabolites, however, are highly toxic and cause adverse effects in the other organs into which they are transported, such as the kidneys. Acrolein is removed from the kidneys by secretion into the urine, resulting in cystitis (inflammation of the bladder), often hemorrhagic cystitis.

In the kidney, cyclophosphamide induces necrosis of the renal distal tubule. Cyclophosphamide, which is structurally similar to the anti-cancer drug ifosfamide, does not induce damage to the renal proximal tubule nor does it induce Debre-de Toni-Fanconi syndrome (Rossi et al. (1997), Nephrol Dial Transplant 12:1091-1092).

One clinical trial of patients being treated with cyclophosphamide showed that renal damage from the drug leads to a reduced biotransformation rate and low renal clearance of the drug, resulting in a build-up of toxic alkylating metabolic products (Wagner et al. (1980), Arzneimittelforschung 30:1588-1592).

In a study of patients suffering from malignant lymphomas and mammary carcinomas, a direct relationship was found between the dose of cyclophosphamide used in treatment and the concentration of alkylating metabolites in the patients' urine. The upper limit of the dose was determined by the nature and degree of the toxic side effects, rather than by the rate at which the drug could be metabolized (Saul et al. (1979), J Cancer Res Clin Oncol 94:277-286). It is the acrolein itself that is toxic, not the alkylating activity of cyclophosphamide (Brock et al. (1979), Arzneimittelforschung 29:659-661). A study on rats also showed that acrolein from the kidneys can produce hemorrhagic cystitis and that the acrolein concentration is directly related to the frequency and severity of the cystitis (Chijiwa et al. (1983), Cancer Res 43:5205-5209).

Carboplatin, a platinum coordination complex, is commonly used in chemotherapy as an anti-tumor agent. As a chemotherapeutic agent, carboplatin acts similarly to cisplatin. Carboplatin enters the cell by diffusion where it is activated by hydrolysis (Goodman & Gilman's The Pharmacological Basis of Therapeutics 9^{th} ed., p. 1270-1271, J. G. Hardman et al. Eds., McGraw Hill, New York 1996). Once activated, the platinum complexes are able to react with DNA causing cross-linking to occur. One of the differences between carboplatin and cisplatin is that carboplatin is better tolerated clinically. Some of the side-effects associated with cisplatin, such as nausea, neurotoxicity, and nephrotoxicity, are seen at a lesser degree in patients administered carboplatin. Some other side-effects are hypomagnesaemia and hypokalaemia (Kintzel (2001), Drug Saf 24:19-38).

In one study on male Wistar rats, carboplatin was administered at a dosage of 65 mg/kg (Wolfgang et al. (1994), Fundam Appl Toxicol 22:73-79). After treatment with carboplatin, CGT excretion was increased approximately two-fold.

Another study compared cisplatin and carboplatin when given in combination with vindesine and mitomycin C (Jelic et al. (2001) Lung Cancer 34:1-13). The study showed that carboplatin administered with vindesine and mitomycin C was advantageous in terms of overall survival, although the regimen was more hematologically toxic than when cisplatin was given.

AY-25329, is a phenothiazine that has been shown to be mildly hepatotoxic and to induce nephrosis. Its structure is shown below.

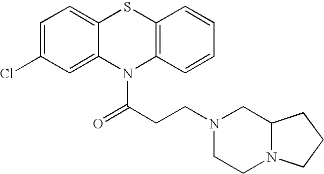

Phenothiazines are a class of psychoactive drugs. They have been used to treat schizophrenia, paranoia, mania, hyperactivity in children, some forms of senility, and anxiety (http://www.encyclopedia.com/articlesnew/36591.html). Some side effects associated with prolonged use of the drugs are reduced blood pressure, Parkinsonism, reduction of motor activity, and visual impairment.

Chlorpromazine (Thorazine or Largactil) is an aliphatic phenothiazine and is widely used for treating schizophrenia and manic depression. Prolactin secretion is increased while taking chlorpromazine, and galactorrhea and gynecomastia have both been associated with the drug (http://www.mentalhealth.com/drug/p30-c01.html). Trifluoperazine is another prescribed phenothiazine. It is used to treat anxiety, to prevent nausea and vomiting, and to manage psychotic disorders (http://www.mentalhealth.com/drug/p30-s04.html). Negative side-effects that have been associated with the drug are liver damage, bone marrow depression, and Parkinsonism.

Acyclovir (9-[(2-hydroxyethyl)methyl]guanine, Zovirax®), an anti-viral guanosine analogue, is used to treat herpes simplex virus (HSV), varicella zoster virus (VZV) and Epstein-Barr virus (EBV) infections. It is transported into cells by the nucleoside transporter that imports guanine, and acyclovir is phosphorylated by virally encoded thymidine kinase (TK). Other kinases convert acyclovir to its activated di- and triphosphate forms, which prevent the polymerization of viral DNA. Acyclovir triphosphate competes with dGTP for the viral polymerase, and acyclovir is preferentially incorporated, but as a monophosphate. As a result, chain elongation ceases (Fields Virology 3d ed., Fields et al., eds., pp. 436-440, Lippincott-Raven Publishers, Philadelphia, 1996; Cecil Textbook of Medicine 20^{th} ed., part XII, p. 1742, J. C. Bennett and F. Plum Eds., W. B. Saunders Co., Philadelphia, 1996).

The pharmacokinetics of acyclovir show that it has a useful half-life of about three hours and that most of it is excreted in the urine largely unchanged (Brigden et al. (1985), Scand J Infect Dis Suppl 47:33-39). Not surprisingly, the most frequent adverse effect of acyclovir treatment is damage to various parts of the kidney, particularly the renal tubules. Crystalluria, or the precipitation of crystals (in this case, crystals of acyclovir), in the lumina of the renal tubules can occur (Fogazzi (1996), Nephrol Dial Transplant 11:379-387). If the drug crystallizes in the renal collecting tubules, obstructive nephropathy and tubular necrosis can result (Richardson (2000), Vet Hum Toxicol 42:370-371). Tissues from biopsies of affected patients showed dilation of the proximal and distal renal tubules, with loss of the brush border, flattening of the lining cells and focal nuclear loss (Becker et al. (1993), Am J Kidney Dis 22:611-615).

Citrinin, a mycotoxin produced by the fungus Penicillium citrinum, is a natural contaminant of foods and feeds (Bondy and Armstrong (1998) Cell Biol. Toxicol. 14:323-332). It is known that mycotoxins can have negative effects on the immune system, however citrinin-treated animals have been shown to stimulate responses against antigens (Sharma (1993) J. Dairy Sci. 76:892-897). Citrinin is a known nephrotoxin, and in birds such as chickens, ducklings, and turkeys, it causes diarrhea, increased food consumption and reduced weight gain due to kidney degeneration (Mehdi et al. (1981) Food Cosmet. Toxicol. 19:723-733; Mehdi et al. (1984) Vet. Pathol. 21:216-223). In the turkey and duckling study, both species exhibited nephrosis with the occurrence of hepatic and lymphoid lesions (Mehdi et al., 1984).

In one study, citrinin was administered to rabbits as a single oral dose of either 120 or 67 mg/kg (Hanika et al. (1986) Vet. Pathol. 23:245-253). Rabbits treated with citrinin exhibited renal alterations such as condensed and distorted mitochondria, distended intercellular spaces of the medullary and straight cortical distal tubules, and disorganization of interdigitating processes. In another rabbit study, citrinin-administered rabbits displayed azotaemia and metabolic acidosis (Hanika et al. (1984) Food Chem. Toxicol. 22:999-1008). Renal failure was indicated by decreased creatinine clearance and increased blood urea nitrogen and serum-creatinine levels.

In the past, mercury was an important component of pharmaceuticals, particularly of antiseptics, antibacterials, skin ointments, diuretics and laxatives. Although, mercury has been largely replaced by more effective, more specific and safer compounds, making drug-induced mercury poisoning rare, it is still widely used in industry. Poisoning from occupational exposure and environmental pollution, such as mercury release into public water supplies, remains a concern as wildlife, domestic animals and humans are affected.

Because of their lipid solubility and ability to cross the blood-brain barrier, the most dangerous form of mercury is the organomercurials, the most common of which is methylmercury, a fungicide used for disinfecting crop seeds. In a number of countries, incidents involving large-scale illness and death from mercury poisoning have been reported when mercury-contaminated seeds were planted and the crops harvested and consumed. A second source of organic mercury poisoning results from industrial chemicals containing inorganic mercury, such as mercury catalysts, which form methylmercury as a reaction product. If this waste product is released into reservoirs, lakes, rivers or bays, the surrounding population can become sick or die, particularly those who eat local fish.

The inorganic salt mercuric chloride, HgCl₂, as well as other mercuric salts, are more irritating and more toxic than the mercurous forms. Mercuric chloride is used today in industry, for the manufacture of bleach, electronics, plastics, fungicides and dental amalgams. The main source of human exposure is industrial dumping into rivers (Goodman & Gilman's: The Pharmacological Basis of Therapeutics (9th ed.), pp. 1654-1659, McGraw-Hill, New York, 1996).

When inorganic mercury salts are ingested, about 10% of the mercuric ions are absorbed by the gastrointenstinal tract, and a considerable portion of the Hg²⁺ can remain bound to the mucosal surfaces. The highest concentration of Hg²⁺ is found in the kidneys, as it is retained there longer than in other tissues. Consequently, the kidneys are the organ most adversely affected by inorganic mercury poisoning. The proximal tubules are the major site of damage, where tubular necrosis results. The mercury affects primarily the S2 and S3 portions of the proximal tubules, but, at high levels of mercury exposure, the S1 and distal portions of the tubules are also damaged. These regions of the nephrons are affected because they contain enzymes (such as gamma-glutamyltranspeptidase) and transport proteins (such as the basolateral organic anion transport system) involved in mercury uptake (Diamond et al. (1998), Toxicol Pathol 26:92-103).

Urinary markers of mercury toxicity which can be detected in NMR spectra include elevated levels of lactate, acetate and taurine and decreased levels of hippurate (Holmes et al. (2000), Chem Res Toxicol 13:471-478). Known changes in gene expression in kidneys exposed to Hg²⁺ include up-regulation of the heat-shock protein hsp72 and of the glucose-regulated protein grp94. The degree of tissue necrosis and level of expression of these proteins is proportional to both the dose of mercury (Hg²⁺) and the length of the exposure time to mercury (Hg²⁺), with hsp72 accumulating in the renal cortex and grp94 accumulating in the renal medulla (Goering et al. (2000), Toxicol Sci 53:447-457).

Indomethacin is a non-steroidal antiinflammatory, antipyretic and analgesic drug commonly used to treat diseases such as rheumatoid arthritis, osteoarthritis, ankylosing spondylitis and gout. This drug acts as a potent inhibitor of prostaglandin synthesis; it inhibits the cyclooxygenase enzyme necessary for the conversion of arachidonic acid to prostaglandins (PDR 47th ed., Medical Economics Co., Inc., Montvale, N.J., 1993; Goodman & Gilman's The Pharmalogical Basis of Therapeutics 9th ed., J. G. Hardman et al., Eds., McGraw Hill, New York, 1996, pp. 1074-1075, 1089-1095; Cecil Textbook of Medicine, 20th ed., part XII, pp. 772-773, 805-808, J. C. Bennett and F. Plum Eds., W. B. Saunders Co., Philadelphia, 1996).

The most frequent adverse effects of indomethacin treatment are gastrointestinal disturbances, e.g., bleeding, ulcers and perforations, although renal toxicity can also result, particularly after long-term administration. In rats, hemorrhage and necrosis have been observed in the renal papillae and fornix, as well as damage to the thick ascending limbs (mTALs), and interstitial nephritis with hematuria, proteinuria and nephrotic syndrome have been reported in humans. Patients suffering from renal dysfunction risk developing a reduction in renal blood flow and urinary outflow, because renal prostaglandins play an important role in renal perfusion and glomerular filtration (Heyman et al. (1997), Kidney Int 51: 653-663).

Diflunisal, a non-steroidal anti-inflammatory drug (NSAID), is a difluorophenyl derivative of salicylic acid (Goodman & Gilman's The Pharmacological Basis of Therapeutics 9^{th} ed., p. 631, J. G. Hardman et al., Eds., McGraw Hill, New York, 1996). It is most frequently used in the treatment of osteoarthritis and musculoskeletal strains. NSAIDs have analgesic, antipyretic and anti-inflammatory actions, however hepatotoxicity is known to be an adverse side effect of NSAID treatment (Masubuchi et al. (1998) J. Pharmacol. Exp. Ther. 287:208-213). Diflunisal has been shown to be less toxic than other NSAIDs, nevertheless over long periods of dosage it can lead to deleterious effects on platelet or kidney function (Bergamo et al. (1989) Am. J. Nephrol. 9:460-463). Other side effects that have been associated with diflunisal treatment are diarrhea, dizziness, drowsiness, gas or heartburn, headache, nausea, vomiting, and insomnia (http://arthritisinsight.com/medical/meds/dolobid.html).

Masubuchi et al. compared the hepatotoxicity of 18 acidic NSAIDs. In the study, diflunisal (administered at a concentration of 500 μM) was shown to increase LDH leakage in rat hepatocytes, a marker for cell injury, when compared to the control sample. In addition, treatment with diflunisal led to decreased intracellular ATP concentrations.

One study compared the effects of diflunisal and ibuprofen when given to patients over a two week period (Muncie and Nasrallah (1989) Clin. Ther. 11:539-544). In both the ibuprofen and the diflunisal group, two patients complained of abdominal cramping. The study indicated that even during short-term usage some gastrointestinal effects may occur. The toxic dose used in this study was chosen as one that did not induce significant gastric ulceration in rats. The group of rats given the high dosage of diflunisal had increased concentrations of creatinine which is consistent with renal injury, although dehydration may also cause increases in creatinine concentration.

Cidofovir (Vistide®) is an antiviral cytosine analog used in the treatment of viral infections such as herpesvirus, adenovirus, papillomavirus, poxvirus and hepadnavirus (Goodman & Gilman's The Pharmacological Basis of Therapeutics 9^{th} ed., p. 1216, J. G. Hardman et al., Eds., McGraw Hill, New York, 1996). It is also useful for the treatment of cytomegalovirus (CMV) infection, which is a type of herpesvirus.

Some mild side effects seen in patients receiving cidofovir are nausea, vomiting, and fever. The most serious reported side effect of the drug is kidney toxicity (http://tthivclinic.com/cido.html). In response to the threat of nephrotoxicity, it is necessary for patients receiving cidofovir to have their kidneys checked before treatment, and the patients must be monitored during treatment for early symptoms of kidney problems. In addition, cidofovir is given with fluids to help reduce the risk of kidney toxicity (http://www.aidsinfonyc.org/network/simple/cido.html). Probenecid, a drug that helps protect the kidneys, is normally administered concomitantly (Lalezari and Kuppermann (1997) J. Acquir. Immune Defic. Syndr. Hum. Retrovirol. 14:S27-31).

One study compared the safety and efficacy of cidofovir in the treatment of CMV (Lalezari et al. (1998) J. Acquir. Immune Defic. Syndr. Hum. Retrovirol. 17:339-344). Approximately 40% of the patients exhibited dose-dependent asymptomatic proteinuria and 25% of the patients had elevated serum creatinine levels.

Pamidronate (Aredia®) is a bisphosphonate drug that is clinically used to inhibit bone resorption and make bones more stable. It is used to treat hypercalcemia (too much calcium in the blood) that occurs with some types of cancer. Typically administered by intravenous injection, pamidronate is frequently used in patients with breast cancer or multiple myeloma whose disease has spread to the bones. Some side effects related to pamidronate treatment are abdominal cramps, chills, confusion, fever, muscle spasms, nausea, muscle stiffness, and swelling at the injection site (http://www.nursing.uiowa.edu/sites/PedsPain/Adjuvants/PAMIDRnt.html). Patients with kidney problems may be prohibited from using pamidronate as it is excreted through the kidneys.

In one study, rats and mice were given varying doses of labeled pamidronate (Cal and Daley-Yates (1990) Toxicology 65:179-197). Pamidronate treatment led to significant weight loss and a decrease in creatinine clearance. Morphological studies showed a loss of brush border membranes and the presence of focal proximal tubular necrosis.

Another study compared the tolerability of different treatments for hypercalcemia of malignancy by reviewing articles published between 1979 and 1998 (Zojer et al. (1999) Drug Saf 21:389-406). The authors found that elevated serum creatinine level, nausea, and fever were reported following treatment with bisphosphonates such as pamidronate.

Markowitz et al. (2001, J. Am. Soc. Nephrol. 12:1164-1172) tried to determine whether there was a correlation between pamidronate treatment and collapsing focal segmental glomerulosclerosis (FSGS). The authors examined the histories of seven patients who had developed collapsing FSGS, and they found that the only drug treatment in common was the administration of pamidronate. When given at the recommended dose of 90 mg per month, renal toxicity was rare. However, when pamidronate was given at higher doses nephrotoxicity occurred.

Lithium, an alkali metal, is the main pharmacological treatment for bipolar disorders. It is typically given as a salt, such as lithium carbonate or lithium citrate. Some common side effects of lithium treatment are an increase in urination, increase in drinking, dry mouth, weight gain, fine tremor, and fatigue. Some more serious side effects related to lithium treatment are blurred vision, mental confusion, seizures, vomiting, diarrhea, muscle weakness, drowsiness, and coarse tremor (Goodman & Gilman's The Pharmacological Basis of Therapeutics 9^{th} ed., p. 448, J. G. Hardman et al., Eds., McGraw Hill, New York, 1996).

Since lithium is often used on a maintenance basis for a lifelong period, numerous studies have been performed to try and elucidate the effects of lithium on the kidney. One group administered lithium in daily doses within the human therapeutic range to male Wistar rats (Kling et al. (1984) Lab Invest 50:526-535). Rats that were given lithium developed marked polyuria within three weeks of the initial dosing. The rats displayed elevated free water clearance and vasopressin-resistant diabetes insipidus. The cortical collecting tubules displayed morphological changes, e.g. dilation of the tubules, bulging cells lining the tubules, enlarged nuclei, following lithium treatment.

Another study examined a human population that had been given lithium for the treatment of bipolar disorder (Markowitz et al. (2000) J. Am. Soc. Nephrol. 11:1439-1448). The patients had a mean age of 42.5 years and had been undergoing lithium treatment from 2 to 25 years (mean of 13.6 years). Approximately one fourth of the patients had nephrotic proteinuria, almost 90% of them had nephrogenic diabetes insipidus (NDI), and renal biopsies revealed a chronic tubulointerstitial nephropathy in all of the patients. Following cessation of lithium treatment, seven of the patients proceeded to end-stage renal disease.

Even though nephrotoxicity is a known side effect of lithium treatment, some studies have indicated that in actuality it is not all that common (Johnson (1998) Neuropsychopharmacology 19:200-205). One study showed that the NDI-like effect in lithium treatment was easily overcome by increasing the levels of arginine vasopressin (AVP) (Carney et al. (1996) Kidney Int 50:377-383). Other studies have suggested that patients with psychiatric disorders display certain defects in renal function without undergoing lithium treatment (Gitlin (1999) Drug Saf 20:231-243).

Hydralazine, an antihypertensive drug, causes relaxation of arteriolar smooth muscle. Such vasodilation is linked to vigorous stimulation of the sympathetic nervous system, which in turn leads to increased heart rate and contractility, increased plasma renin activity, and fluid retention (Goodman & Gilman's The Pharmacological Basis of Therapeutics 9^{th} ed., p. 794, J. G. Hardman et al., Eds., McGraw Hill, New York, 1996). The increased renin activity leads to an increase in angiotensin II, which in turn causes stimulation of aldosterone and sodium reabsorption.

Hydralazine is used for the treatment of high blood pressure (hypertension) and for the treatment of pregnant women suffering from high blood pressure (pre-eclampsia or eclampsia). Some common side effects associated with hydralazine use are diarrhea, rapid heartbeat, headache, decreased appetite, and nausea. Hydralazine is often used concomitantly with drugs that inhibit sympathetic activity to combat the mild pulmonary hypertension that can be associated with hydralazine usage.

In one hydralazine study, rats were fed hydralazine and mineral metabolism was monitored (Peters et al. (1988) Toxicol Lett 41:193-202). Manganese and zinc concentrations were not effected by hydralazine treatment, however tissue iron concentrations were decreased and kidney copper concentrations were increased compared to control groups.

Another study compared the effects of hydrazine, pheneizine, and hydralazine treatment on rats (Runge-Morris et al. (1996) Drug Metab Dispos 24:734-737). Hydralazine caused an increase in renal GST-alpha subunit expression, although unlike hydrazine and pheneizine it did not alter renal cytochrome P4502E1 expression.

Colchicine, an alkoloid of Colchicum autumale, is an antiinflammatory agent used in the treatment of gouty arthritis (Goodman & Gilman's The Pharmacological Basis of Therapeutics 9^{th} ed., p. 647, J. G. Hardman et al., Eds., McGraw Hill, New York, 1996).

An antimitotic agent, colchicine binds to tubulin which leads to depolymerization and disappearance of the fibrillar microtubules in granulocytes and other motile cells. In doing so, the migration of granulocytes into the inflamed area is inhibited. Through a series of events, the inflammatory response is blocked.

Some common, mild side effects associated with colchicine treatment are loss of appetite and hair loss. More severe side effects that warrant cessation of treatment are nausea, vomiting, diarrhea, and abdominal pain. Colchicine overdose can induce multiorgan failure with a high incidence of mortality. In this setting, renal failure is multifactorial and related to prolonged hypotension, hypoxemia, sepsis, and rhabdomyolysis. In rats, less dramatic doses have been shown to inhibit the secretion of many endogenous proteins such as insulin and parathyroid hormone.

One study investigated the effects of colchicine on microtubule polymerization status and post-translational modifications of tubulin in rat seminiferous tubules (Correa and Miller (2001) Biol Reprod 64:1644-1652). Colchicine caused extensive microtubule depolymerization, and total tubulin levels decreased twofold after colchicine treatment. The authors also found that colchicine treatment led to a decrease in tyrosination of the microtubule pool of tubulin which was associated with depolymerization of microtubules.

Sulfadiazine, a sulfonamide, is an antimicrobial agent. It is commonly used concomitantly with pyrimethamine to treat toxoplasmosis, an infection of the brain, in patient suffering from AIDS. These drugs are able to cross the blood-brain barrier and are used at relatively high doses. In addition, sulfadiazine has been shown to be effective at preventing certain types of meningococcal diseases and in treating urinary tract infections.

Sulfonamides in general are structural analogs of para-aminobenzoic acid (PABA). Because they are competitive antagonists of PABA, sulfonamides are effective against bacteria that are required to utilize PABA for the synthesis of folic acid (Goodman & Gilman's The Pharmacological Basis of Therapeutics 9^{th} ed., p. 1058-1060, J. G. Hardman et al., Eds., McGraw Hill, New York, 1996).

The main side effects associated with sulfadiazine treatment are fever and skin rashes. Decreases in white blood cells, red blood cells, and platelets, nausea, vomiting, and diarrhea are some other side effects that may result from sulfadiazine treatment. The most troublesome problem with this drug for HIV/AIDS patients is kidney toxicity. These patients tend to use these drugs for extended periods of time, which puts a constant strain on the kidneys. In addition, kidney stones tend to form in the bladder and ureter thereby blocking the flow of urine. Kidney damage may result, and if left untreated kidney failure may occur. Therefore, patients being treated with sulfadiazine are instructed to increase their fluid intake in order to prevent crystal formation in the kidneys.

One case study examined four HIV-positive patients who had been given sulfadiazine to treat toxoplasmosis (Crespo et al. (2000) Clin Nephrol 54:68-72). All four of the patients, one of whom was a previously healthy person, developed oliguria, abdominal pain, renal failure, and displayed multiple radiolucent renal calculi in echography. Following extensive hydration and alcalinization, the renal function of the patients returned to normal.

Adriamycin, known generically as doxorubicin, is an anthracycline antibiotic produced by the fungus Streptomyces peucetius. It is an anti-tumor drug used in the treatment of breast, ovarian, bladder, and lung cancers as well as non-Hodgkin's lymphoma, Hodgkin's disease and sarcoma (Goodman & Gilman's The Pharmacological Basis of Therapeutics 9^{th} ed., p. 1264-1265, J. G. Hardman et al., Eds., McGraw Hill, New York, 1996).

Adriamycin has tetracycline ring structures with the sugar daunosamine attached by glycosidic linkage. It is able to intercalate with DNA, it affects DNA and RNA synthesis, and it can interact with cell membranes and alter their functions. Typically the drug is cell-cycle specific for the S phase of cell division. By binding to the cancer cells' DNA and blocking topoisomerase II, cancer cells are unable to divide and grow.

Some common side effects associated with adriamycin treatment are fatigue, a drop in white blood cell, red blood cell, or platelet count, hair loss, skin discoloration, and watery eyes (www.cancerhelp.org.uk/help/default.asp?page=4025). More serious side effects include myocardial toxicity, ulceration and necrosis of the colon, and development of a second cancer.

Because of its utility in fighting cancer, numerous studies have been performed in attempts to further understand the mechanisms and effects of adriamycin. In one study, investigators injected mice with a single dose of adriamycin (Chen et al. (1998) Nephron 78:440-452). The mice exhibited signs of combined glomerular albuminuria and immunoglublinuria, progressively elevated levels of nitrite/nitrate in the urine, abnormal renal function, and other symptoms indicative of focal segmental glomerulosclerosis.

In another study, rats were given adriamycin and the effects on angiotensin converting enzyme (ACE) were monitored (Venkatesan et al. (1993) Toxicology 85:137-148). The rats developed glomerular and tubular injury, and serum ACE levels were significantly elevated 20, 25, and 30 days post-treatment. A different study followed rabbits for up to one year that were treated with either adriamycin, nephrectomy, or combinations thereof (Gadeholt-Gothlin et al. (1995) Urol Res 23:169-173). The rabbits that were treated with adriamycin exhibited signs of nephrotoxicity at relatively low doses.

Menadione (vitamin K₃) is a fat-soluble vitamin precursor that is converted into menaquinone in the liver. The primary known function of vitamin K is to assist in normal blood clotting, but it may also play a role in bone calcificaton. Menadione is a quinone compound that induces oxidative stress. It has been used as an anticancer agent and radiosensitizer and can produce toxicity in the kidney, lung, heart, and liver. In the kidney, signs of toxicity are dose-dependent, ranging from minor degranulation of tubular cells at lower doses to tubular dilatation, formation of protein casts in the renal tubules, calcium mineralization, vacuolization in the proximal and distal renal tubules, granular degeneration in the cortex and necrosis and apoptosis (Chiou et al., Toxicology (1997) 124(3):193-202).

Monocrotaline, an alkaloid obtained from Crotalaria spectabilis, a warm-climate garden plant, induces multi-organ toxicity affecting the kidney, heart, liver and lung. This compound is used to induce mesangiolysis in the kidney, to mimic the effects of Habu venom poisoning and hemolytic-uremic syndrome. Renal lesions in rats first appeared in the glomerular capillaries (endothelial cell detachment and adhesion of platelets to the basal lamina), followed by severe edema in the mesangium. Mesangiolysis subsequently occurred, accompanied by dilatation or obliteration of capillaries and necrosis and hemorrhage in the mesangium (Kurozumi et al., Exp Mol Pathol (1983) 39(3):377-386).

Vancomycin is a polycyclic glycoprotein antibiotic that is used to treat severe systemic infections by beta-lactam-resistant bacteria, in particular, resistant staphylococci. This drug may be given to patients who are allergic to penicillin. Vancomycin can induce renal failure and interstitial nephritis (Physicians Desk Reference 56^{th Ed}., pp. 1970-1971, Medical Economics Co., Montvale, N.J., 2002).

Sodium chromate, a model compound used to induce liver toxicity, also produces toxic effects in the kidney. Necrosis of the S1 segment of the proximal tubule has been reported, as well as acute renal failure, characterized by increased levels of kininogens in the renal cortex and medulla and in urine and decreased rates of glomerular filtration (Bompart et al., Nephron (1993) 65(4):612-618; Beckwith-Hall et al., Chem Res Toxicol (1998) 11(4):260-272).

In the kidney, sodium oxalate forms crystals in the urinary tract, resulting in tubular obstruction, and produces calcific kidney stones in humans and in rats. The stones are located on renal papillary surfaces and consist of an organic matrix and crystals of calcium oxalate and/or calcium phosphate. The matrix is intimately associated with the crystals and contains substances that both promote and inhibit calcification: osteopontin, Tamm-Horsfall protein, bikunin and prothrombin fragment 1. Rats with these stones show decreased urine levels of magnesium and citrate, and the same is believed to occur in humans. Males of both species tend to develop calcium oxalate kidney stones, whereas females tend to form calcium phosphate stones (Khan, World J Urol (1997) 15(4):236-243).

Hexachloro-1,2-butadiene (HCBD) is a solvent that forms toxic conjugates and metabolites with glutathione, cysteine and N-acetyl cysteine. These then cause damage to the S1, S2 and S3 (pars recta) segments of the proximal tubules in the outer medulla of the kidney. Mitochondrial swelling has been observed in the S1 and S2 segments, although most of the pathological changes occur in the S2 and S3 segments (loss of brush boarder and cellular necrosis in S2, necrosis in S3). In rats, HCBD is about four times more toxic to females than to males (Ishmael et al., Toxicol Pathol (1986) 14(2):258-262; Ishmael et al., J Pathol (1982) 138(2):99-113).

Chloroform (CHCl₃) is widely used in the manufacture of drugs, cosmetics, plastics and cleaning agents and is a contaminant by-product in chlorinated drinking water. Chloroform was also an early anesthetic used in humans, and, therefore, much is known regarding its toxicity. Exposure can induce liver and kidney damage and cardiac arrthymias.

Toxic levels of exposure in rodents are carcinogenic due to the chronic cycle of cell injury and repair that is induced, rather than because of direct genotoxic action. The injury to the liver and kidney are thought to occur by two different mechanisms related to its metabolism in the target organ. Studies have shown that the extent of liver and kidney damage and necrosis relates multiple factors including sex, strain, route of exposure and the vehicle used. In the kidney, biotransformation of chloroform by cytochrome P450 produces reactive intermediates, which damage mainly the renal proximal tubules. Typical signs of nephrotoxicity include proteinuria, glucosuria and increased BUN levels (Casarett & Doull's Toxicology: The Basic Science of Poisons 6th Ed. Klaasen, ed., Chap. 14, pp. 503-508, McGraw-Hill, New York, 2001; Smith et al., Toxicol Appl Pharmacol 70:467-479, 1983).

Diclofenac, a non-steroidal anti-inflammatory drug, is commonly administered to patients suffering from rheumatoid arthritis, osteoarthritis, and ankylosing spondylitis. Following oral administration, diclofenac is rapidly absorbed and then metabolized in the liver by cytochrome P450 isozyme of the CYC2C subfamily (Goodman & Gilman's The Pharmacological Basis of Therapeutics 9^{th} Ed., Hardman et al., eds., p. 637, McGraw Hill, New York, 1996). In addition, diclofenac is used topically to treat pain due to corneal damage (Jayamanne et al., Eye 11(Pt. 1):79-83, 1997; Domic et al., Am J. Ophthalmol 125(5):719-721, 1998).

Metabolism of diclofenac in kidney tissue produces reactive oxygen species that can cause severe oxidative stress and genomic DNA fragmentation. Examination of diverse types of kidney cells for nuclei with apoptotic characteristics showed that such nuclei are found in the linings of the renal proximal and distal tubules. Additional toxic effects include elevated levels of BUN, malondialdehyde (MDA), SOD, and activated Ca²⁺—Mg²⁺-endonuclease (Hickey et al., Free Radic Biol Med (2001) 31(2):139-152).

Thioacetamide's only significant commercial use is as a replacement for hydrogen sulfide in qualitative analyses (IARC, Vol. 7, 1974). It has also been used as an organic solvent in the leather, textile and paper industries, as an accelerator in the vulcanization of buna rubber, and as a stabilizer of motor fuel. The primary routes of human exposure are inhalation and skin contact with products in which thioacetamide was used as a solvent (9th Report on Carcinogens, U.S. Dept. of Health and Human Services, Public Health Service, National Toxicology Program, http://ehp.niehs.nih.gov/roc/toc9.html).

In exposed rats, thioacetamide was shown to accumulate in the liver and kidney, resulting in elevated levels of serum total bilirubin, aspartate aminotransferase, alanine aminotransferase, BUN, creatinine and TNF∀. Impaired clearance of the toxin and increased secretion of TNF∀ are related to the progression of toxic effects in the liver and kidney (Nakatani et al., Liver (2001) 21(1):64-70). Additional histological changes in kidney tissue include glomerular tuft collapse and interstitial hemorrhage (Caballero et al., Gut (2001) 48(1):34-40).

Toxicity Prediction and Modeling

The genes and gene expression information, gene expression profiles, as well as the portfolios and subsets of the genes provided in Tables 1-5, may be used to predict at least one toxic effect, including the nephrotoxicity of a test or unknown compound. As used, herein, at least one toxic effect includes, but is not limited to, a detrimental change in the physiological status of a cell or organism. The response may be, but is not required to be, associated with a particular pathology, such as tissue necrosis. Accordingly, the toxic effect includes effects at the molecular and cellular level. Nephrotoxicity is an effect as used herein and includes but is not limited to the pathologies of nephritis, tubular toxicity, kidney necrosis, glomerular and tubular injury, and focal segmental glomerulosclerosis. As used herein, a gene expression profile comprises any quantitative representation of the expression of at least one mRNA species in a cell sample or population and includes profiles made by various methods such as differential display, PCR, microarray and other hybridization analysis, etc.

In general, assays to predict the toxicity or nephrotoxicity of a test agent (or compound or multi-component composition) comprise the steps of exposing a cell population to the test compound, assaying or measuring the level of relative or absolute gene expression of one or more of the genes in Tables 1-5 and comparing the identified expression level(s) to the expression levels disclosed in the Tables and database(s) disclosed herein. Assays may include the measurement of the expression levels of about 2, 3, 4, 5, 6, 7, 8, 9, 10, 15, 20, 25, 30, 50, 75, 100 or more genes from Tables 1-5.

In the methods of the invention, the gene expression level for a gene or genes induced by the test agent, compound or compositions may be comparable to the levels found in the Tables or databases disclosed herein if the expression level varies within a factor of about 2, about 1.5 or about 1.0 fold. In some cases, the expression levels are comparable if the agent induces a change in the expression of a gene in the same direction (e.g., up or down) as a reference toxin.

The cell population that is exposed to the test agent, compound or composition may be exposed in vitro or in vivo. For instance, cultured or freshly isolated renal cells, in particular rat renal cells, may be exposed to the agent under standard laboratory and cell culture conditions. In another assay format, in vivo exposure may be accomplished by administration of the agent to a living animal, for instance a laboratory rat.

Procedures for designing and conducting toxicity tests in in vitro and in vivo systems are well known, and are described in many texts on the subject, such as Loomis et al., Loomis's Essentials of Toxicology, 4th Ed., Academic Press, New York, 1996; Echobichon, The Basics of Toxicity Testing, CRC Press, Boca Raton, 1992; Frazier, editor, In Vitro Toxicity Testing, Marcel Dekker, New York, 1992; and the like.

In in vitro toxicity testing, two groups of test organisms are usually employed: One group serves as a control and the other group receives the test compound in a single dose (for acute toxicity tests) or a regimen of doses (for prolonged or chronic toxicity tests). Because, in some cases, the extraction of tissue as called for in the methods of the invention requires sacrificing the test animal, both the control group and the group receiving compound must be large enough to permit removal of animals for sampling tissues, if it is desired to observe the dynamics of gene expression through the duration of an experiment.

In setting up a toxicity study, extensive guidance is provided in the literature for selecting the appropriate test organism for the compound being tested, route of administration. dose ranges, and the like. Water or physiological saline (0.9% NaCl in water) is the solute of choice for the test compound since these solvents permit administration by a variety of routes. When this is not possible because of solubility limitations, vegetable oils such as corn oil or organic solvents such as propylene glycol may be used.

Regardless of the route of administration, the volume required to administer a given dose is limited by the size of the animal that is used. It is desirable to keep the volume of each dose uniform within and between groups of animals. When rats or mice are used, the volume administered by the oral route generally should not exceed about 0.005 ml per gram of animal. Even when aqueous or physiological saline solutions are used for parenteral injection the volumes that are tolerated are limited, although such solutions are ordinarily thought of as being innocuous. The intravenous LD₅₀ of distilled water in the mouse is approximately 0.044 ml per gram and that of isotonic saline is 0.068 ml per gram of mouse. In some instances, the route of administration to the test animal should be the same as, or as similar as possible to, the route of administration of the compound to man for therapeutic purposes.

When a compound is to be administered by inhalation, special techniques for generating test atmospheres are necessary. The methods usually involve aerosolization or nebulization of fluids containing the compound. If the agent to be tested is a fluid that has an appreciable vapor pressure, it may be administered by passing air through the solution under controlled temperature conditions. Under these conditions, dose is estimated from the volume of air inhaled per unit time, the temperature of the solution, and the vapor pressure of the agent involved. Gases are metered from reservoirs. When particles of a solution are to be administered, unless the particle size is less than about 2 μm the particles will not reach the terminal alveolar sacs in the lungs. A variety of apparatuses and chambers are available to perform studies for detecting effects of irritant or other toxic endpoints when they are administered by inhalation. The preferred method of administering an agent to animals is via the oral route, either by intubation or by incorporating the agent in the feed.

When the agent is exposed to cells in vitro or in cell culture, the cell population to be exposed to the agent may be divided into two or more subpopulations, for instance, by dividing the population into two or more identical aliquots. In some preferred embodiments of the methods of the invention, the cells to be exposed to the agent are derived from kidney tissue. For instance, cultured or freshly isolated rat renal cells may be used.

The methods of the invention may be used generally to predict at least one toxic response, and, as described in the Examples, may be used to predict the likelihood that a compound or test agent will induce various specific kidney pathologies, such as nephritis, kidney necrosis, glomerular and tubular injury, focal segmental glomerulosclerosis, or other pathologies associated with at least one of the toxins herein described. The methods of the invention may also be used to determine the similarity of a toxic response to one or more individual compounds. In addition, the methods of the invention may be used to predict or elucidate the potential cellular pathways influenced, induced or modulated by the compound or test agent due to the similarity of the expression profile compared to the profile induced by a known toxin (see Tables 5-5L).

Diagnostic Uses for the Toxicity Markers

As described above, the genes and gene expression information or portfolios of the genes with their expression information as provided in Tables 1-5 may be used as diagnostic markers for the prediction or identification of the physiological state of tissue or cell sample that has been exposed to a compound or to identify or predict the toxic effects of a compound or agent. For instance, a tissue sample such as a sample of peripheral blood cells or some other easily obtainable tissue sample may be assayed by any of the methods described above, and the expression levels from a gene or genes from Tables 1-5 may be compared to the expression levels found in tissues or cells exposed to the toxins described herein. These methods may result in the diagnosis of a physiological state in the cell or may be used to identify the potential toxicity of a compound, for instance a new or unknown compound or agent. The comparison of expression data, as well as available sequence or other information may be done by researcher or diagnostician or may be done with the aid of a computer and databases as described below.

In another format, the levels of a gene(s) of Tables 1-5, its encoded protein(s), or any metabolite produced by the encoded protein may be monitored or detected in a sample, such as a bodily tissue or fluid sample to identify or diagnose a physiological state of an organism. Such samples may include any tissue or fluid sample, including urine, blood and easily obtainable cells such as peripheral lymphocytes.

Use of the Markers for Monitoring Toxicity Progression

As described above, the genes and gene expression information provided in Tables 1-5 may also be used as markers for the monitoring of toxicity progression, such as that found after initial exposure to a drug, drug candidate, toxin, pollutant, etc. For instance, a tissue or cell sample may be assayed by any of the methods described above, and the expression levels from a gene or genes from Tables 1-5 may be compared to the expression levels found in tissue or cells exposed to the renal toxins described herein. The comparison of the expression data, as well as available sequence or other information may be done by a researcher or diagnostician or may be done with the aid of a computer and databases.

Use of the Toxicity Markers for Drug Screening

According to the present invention, the genes identified in Tables 1-5 may be used as markers or drug targets to evaluate the effects of a candidate drug, chemical compound or other agent on a cell or tissue sample. The genes may also be used as drug targets to screen for agents that modulate their expression and/or activity. In various formats, a candidate drug or agent can be screened for the ability to stimulate the transcription or expression of a given marker or markers or to down-regulate or counteract the transcription or expression of a marker or markers. According to the present invention, one can also compare the specificity of a drug's effects by looking at the number of markers which the drug induces and comparing them. More specific drugs will have less transcriptional targets. Similar sets of markers identified for two drugs may indicate a similarity of effects.

Assays to monitor the expression of a marker or markers as defined in Tables 1-5 may utilize any available means of monitoring for changes in the expression level of the nucleic acids of the invention. As used herein, an agent is said to modulate the expression of a nucleic acid of the invention if it is capable of up- or down-regulating expression of the nucleic acid in a cell.

In one assay format, gene chips containing probes to one, two or more genes from Tables 1-5 may be used to directly monitor or detect changes in gene expression in the treated or exposed cell. Cell lines, tissues or other samples are first exposed to a test agent and in some instances, a known toxin, and the detected expression levels of one or more, or preferably 2 or more of the genes of Tables 1-5 are compared to the expression levels of those same genes exposed to a known toxin alone. Compounds that modulate the expression patterns of the known toxin(s) would be expected to modulate potential toxic physiological effects in vivo. The genes in Tables 1-5 are particularly appropriate markers in these assays as they are differentially expressed in cells upon exposure to a known renal toxin. Tables 1 and 2 disclose those genes that are differentially expressed upon exposure to the named toxins and their corresponding GenBank Accession numbers. Table 3 discloses the human homologues and the corresponding GenBank Accession numbers of the differentially expressed genes of Tables 1 and 2.

In another format, cell lines that contain reporter gene fusions between the open reading frame and/or the transcriptional regulatory regions of a gene in Tables 1-5 and any assayable fusion partner may be prepared. Numerous assayable fusion partners are known and readily available including the firefly luciferase gene and the gene encoding chloramphenicol acetyltransferase (Alam et al. (1990), Anal Biochem 188:245-254). Cell lines containing the reporter gene fusions are then exposed to the agent to be tested under appropriate conditions and time. Differential expression of the reporter gene between samples exposed to the agent and control samples identifies agents which modulate the expression of the nucleic acid.

Additional assay formats may be used to monitor the ability of the agent to modulate the expression of a gene identified in Tables 1-5. For instance, as described above, mRNA expression may be monitored directly by hybridization of probes to the nucleic acids of the invention. Cell lines are exposed to the agent to be tested under appropriate conditions and time, and total RNA or mRNA is isolated by standard procedures such those disclosed in Sambrook et al. (Molecular Cloning: A Laboratory Manual, 2nd Ed., Cold Spring Harbor Laboratory Press, Cold Spring Harbor, N.Y., 1989).

In another assay format, cells or cell lines are first identified which express the gene products of the invention physiologically. Cells and/or cell lines so identified would be expected to comprise the necessary cellular machinery such that the fidelity of modulation of the transcriptional apparatus is maintained with regard to exogenous contact of agent with appropriate surface transduction mechanisms and/or the cytosolic cascades. Further, such cells or cell lines may be transduced or transfected with an expression vehicle (e.g., a plasmid or viral vector) construct comprising an operable non-translated 5′-promoter containing end of the structural gene encoding the gene products of Tables 1-5 fused to one or more antigenic fragments or other detectable markers, which are peculiar to the instant gene products, wherein said fragments are under the transcriptional control of said promoter and are expressed as polypeptides whose molecular weight can be distinguished from the naturally occurring polypeptides or may further comprise an immunologically distinct or other detectable tag. Such a process is well known in the art (see Sambrook et al., supra).

Cells or cell lines transduced or transfected as outlined above are then contacted with agents under appropriate conditions; for example, the agent comprises a pharmaceutically acceptable excipient and is contacted with cells comprised in an aqueous physiological buffer such as phosphate buffered saline (PBS) at physiological pH, Eagles balanced salt solution (BSS) at physiological pH, PBS or BSS comprising serum or conditioned media comprising PBS or BSS and/or serum incubated at 37° C. Said conditions may be modulated as deemed necessary by one of skill in the art. Subsequent to contacting the cells with the agent, said cells are disrupted and the polypeptides of the lysate are fractionated such that a polypeptide fraction is pooled and contacted with an antibody to be further processed by immunological assay (e.g., ELISA, immunoprecipitation or Western blot). The pool of proteins isolated from the agent-contacted sample is then compared with the control samples (no exposure and exposure to a known toxin) where only the excipient is contacted with the cells and an increase or decrease in the immunologically generated signal from the agent-contacted sample compared to the control is used to distinguish the effectiveness and/or toxic effects of the agent.

Another embodiment of the present invention provides methods for identifying agents that modulate at least one activity of a protein(s) encoded by the genes in Tables 1-5. Such methods or assays may utilize any means of monitoring or detecting the desired activity.

In one format, the relative amounts of a protein (Tables 1-5) between a cell population that has been exposed to the agent to be tested compared to an un-exposed control cell population and a cell population exposed to a known toxin may be assayed. In this format, probes such as specific antibodies are used to monitor the differential expression of the protein in the different cell populations. Cell lines or populations are exposed to the agent to be tested under appropriate conditions and time. Cellular lysates may be prepared from the exposed cell line or population and a control, unexposed cell line or population. The cellular lysates are then analyzed with the probe, such as a specific antibody.

Agents that are assayed in the above methods can be randomly selected or rationally selected or designed. As used herein, an agent is said to be randomly selected when the agent is chosen randomly without considering the specific sequences involved in the association of a protein of the invention alone or with its associated substrates, binding partners, etc. An example of randomly selected agents is the use a chemical library or a peptide combinatorial library, or a growth broth of an organism.

As used herein, an agent is said to be rationally selected or designed when the agent is chosen on a nonrandom basis which takes into account the sequence of the target site and/or its conformation in connection with the agent's action. Agents can be rationally selected or rationally designed by utilizing the peptide sequences that make up these sites. For example, a rationally selected peptide agent can be a peptide whose amino acid sequence is identical to or a derivative of any functional consensus site.

The agents of the present invention can be, as examples, peptides, small molecules, vitamin derivatives, as well as carbohydrates. Dominant negative proteins, DNAs encoding these proteins, antibodies to these proteins, peptide fragments of these proteins or mimics of these proteins may be introduced into cells to affect function. “Mimic” used herein refers to the modification of a region or several regions of a peptide molecule to provide a structure chemically different from the parent peptide but topographically and functionally similar to the parent peptide (see G. A. Grant in: Molecular Biology and Biotechnology, Meyers, ed., pp. 659-664, VCH Publishers, New York, 1995). A skilled artisan can readily recognize that there is no limit as to the structural nature of the agents of the present invention.

Nucleic Acid Assay Formats

The genes identified as being differentially expressed upon exposure to a known renal toxin (Tables 1-5) may be used in a variety of nucleic acid detection assays to detect or quantify the expression level of a gene or multiple genes in a given sample. The genes described in Tables 1-5 may also be used in combination with one or more additional genes whose differential expression is associate with toxicity in a cell or tissue. In preferred embodiments, the genes in Tables 1-5 may be combined with one or more of the genes described in prior and related application Ser. Nos. 10/152,319, filed May 22, 2002; 60/292,335, filed May 22, 2001; 60/297,523, filed Jun. 13, 2001; 60/298,925, filed Jun. 19, 2001; 60/303,810, filed Jul. 10, 2001; 60/303,807, filed Jul. 10, 2001; 60/303,808, filed Jul. 10, 2001; 60/315,047, filed Aug. 28, 2001; 60/324,928, filed Sep. 27, 2001; 60/330,867, filed Nov. 1, 2001; 60/330,462, filed Oct. 22, 2001; 60/331,805, filed Nov. 21, 2001; 60/336,144, filed Dec. 6, 2001; 60/340,873, filed Dec. 19, 2001; 60/357,843, filed Feb. 21, 2002; 60/357,842, filed Feb. 21, 2002; 60/357,844, filed Feb. 21, 2002; 60/364,134; 60/370,206 filed Mar. 15, 2002, filed Apr. 8, 2002; 60/370,247, filed Apr. 8, 2002; 60/370,144, filed Apr. 8, 2002; 60/371,679, filed Apr. 12, 2002; and 60/372,794, filed Apr. 17, 2002, all of which are incorporated by reference on page 1 of this application.

Any assay format to detect gene expression may be used. For example, traditional Northern blotting, dot or slot blot, nuclease protection, primer directed amplification, RT-PCR, semi- or quantitative PCR, branched-chain DNA and differential display methods may be used for detecting gene expression levels. Those methods are useful for some embodiments of the invention. In cases where smaller numbers of genes are detected, amplification based assays may be most efficient. Methods and assays of the invention, however, may be most efficiently designed with hybridization-based methods for detecting the expression of a large number of genes.

Any hybridization assay format may be used, including solution-based and solid support-based assay formats. Solid supports containing oligonucleotide probes for differentially expressed genes of the invention can be filters, polyvinyl chloride dishes, particles, beads, microparticles or silicon or glass based chips, etc. Such chips, wafers and hybridization methods are widely available, for example, those disclosed by Beattie (WO 95/11755).

Any solid surface to which oligonucleotides can be bound, either directly or indirectly, either covalently or non-covalently, can be used. A preferred solid support is a high density array or DNA chip. These contain a particular oligonucleotide probe in a predetermined location on the array. Each predetermined location may contain more than one molecule of the probe, but each molecule within the predetermined location has an identical sequence. Such predetermined locations are termed features. There may be, for example, from 2, 10, 100, 1000 to 10,000, 100,000 or 400,000 or more of such features on a single solid support. The solid support, or the area within which the probes are attached may be on the order of about a square centimeter. Probes corresponding to the genes of Tables 1-5 or from the related applications described above may be attached to single or multiple solid support structures, e.g., the probes may be attached to a single chip or to multiple chips to comprise a chip set.

Oligonucleotide probe arrays for expression monitoring can be made and used according to any techniques known in the art (see for example, Lockhart et al. (1996), Nat Biotechnol 14:1675-1680; McGall et al. (1996), Proc Nat Acad Sci USA 93: 13555-13460). Such probe arrays may contain at least two or more oligonucleotides that are complementary to or hybridize to two or more of the genes described in Tables 1-5. For instance, such arrays may contain oligonucleotides that are complementary to or hybridize to at least 2, 3, 4, 5, 6, 7, 8, 9, 10, 20, 30, 50, 70, 100 or more of the genes described herein. Preferred arrays contain all or nearly all of the genes listed in Tables 1-5, or individually, the gene sets of Tables 5-5L. In a preferred embodiment, arrays are constructed that contain oligonucleotides to detect all or nearly all of the genes in any one of or all of Tables 1-5 on a single solid support substrate, such as a chip.

The sequences of the expression marker genes of Tables 1-5 are in the public databases. Table 1 provides the GenBank Accession Number or NCBI RefSeq ID for each of the sequences (see www.ncbi.nlm.nih.gov/), as well as the title for the cluster of which gene is part. Table 2 lists the metabolic pathways in which each listed gene functions, while Table 3 provides the gene names and cluster titles for the human homologues of the genes described in Tables 1 and 2. The sequences of the genes in GenBank and/or RefSeq are expressly herein incorporated by reference in their entirety as of the filing date of this application, as are related sequences, for instance, sequences from the same gene of different lengths, variant sequences, polymorphic sequences, genomic sequences of the genes and related sequences from different species, including the human counterparts, where appropriate. These sequences may be used in the methods of the invention or may be used to produce the probes and arrays of the invention. In some embodiments, the genes in Tables 1-5 that correspond to the genes or fragments previously associated with a toxic response may be excluded from the Tables. Table 4 provides the key to the model codes used in Tables 3 and 5-5L, where each model represents a toxin treatment or a set of pathological effects (disease state) resulting from a toxin treatment. In Tables 5A-5L, the genes that are differentially expressed, i.e., up- or down-regulated, in response to a toxin treatment or in a particular disease state are listed. The expression levels of these genes in samples in which a toxic response was found and in samples in which a toxic response was not found are also indicated. The general table (Table 5) is a summation of the data in Tables 5A-5L.

As described above, in addition to the sequences of the GenBank Accession Numbers or NCBI RefSeq ID's disclosed in the Tables 1-5, sequences such as naturally occurring variants or polymorphic sequences may be used in the methods and compositions of the invention. For instance, expression levels of various allelic or homologous forms of a gene disclosed in Tables 1-5 may be assayed, including homologs from species other than rat. Any and all nucleotide variations that do not alter the functional activity of a gene listed in the Tables 1-5, including all naturally occurring allelic variants of the genes herein disclosed, may be used in the methods and to make the compositions (e.g., arrays) of the invention.

Probes based on the sequences of the genes described above may be prepared by any commonly available method. Oligonucleotide probes for screening or assaying a tissue or cell sample are preferably of sufficient length to specifically hybridize only to appropriate, complementary genes or transcripts. Typically the oligonucleotide probes will be at least about 10, 12, 14, 16, 18, 20 or 25 nucleotides in length. In some cases, longer probes of at least 30, 40, or 50 nucleotides will be desirable.

As used herein, oligonucleotide sequences that are complementary to one or more of the genes described in Tables 1-5 refer to oligonucleotides that are capable of hybridizing under stringent conditions to at least part of the nucleotide sequences of said genes. Such hybridizable oligonucleotides will typically exhibit at least about 75% sequence identity at the nucleotide level to said genes, preferably about 80% or 85% sequence identity or more preferably about 90% or 95% or more sequence identity to said genes.

“Bind(s) substantially” refers to complementary hybridization between a probe nucleic acid and a target nucleic acid and embraces minor mismatches that can be accommodated by reducing the stringency of the hybridization media to achieve the desired detection of the target polynucleotide sequence.

The terms “background” or “background signal intensity” refer to hybridization signals resulting from non-specific binding, or other interactions, between the labeled target nucleic acids and components of the oligonucleotide array (e.g., the oligonucleotide probes, control probes, the array substrate, etc.). Background signals may also be produced by intrinsic fluorescence of the array components themselves. A single background signal can be calculated for the entire array, or a different background signal may be calculated for each target nucleic acid. In a preferred embodiment, background is calculated as the average hybridization signal intensity for the lowest 5% to 10% of the probes in the array, or, where a different background signal is calculated for each target gene, for the lowest 5% to 10% of the probes for each gene. Of course, one of skill in the art will appreciate that where the probes to a particular gene hybridize well and thus appear to be specifically binding to a target sequence, they should not be used in a background signal calculation. Alternatively, background may be calculated as the average hybridization signal intensity produced by hybridization to probes that are not complementary to any sequence found in the sample (e.g. probes directed to nucleic acids of the opposite sense or to genes not found in the sample such as bacterial genes where the sample is mammalian nucleic acids). Background can also be calculated as the average signal intensity produced by regions of the array that lack any probes at all.

The phrase “hybridizing specifically to” or “specifically hybridizes” refers to the binding, duplexing, or hybridizing of a molecule substantially to or only to a particular nucleotide sequence or sequences under stringent conditions when that sequence is present in a complex mixture (e.g., total cellular) DNA or RNA.

Assays and methods of the invention may utilize available formats to simultaneously screen at least about 100, preferably about 1000, more preferably about 10,000 and most preferably about 1,000,000 different nucleic acid hybridizations.

As used herein a “probe” is defined as a nucleic acid, capable of binding to a target nucleic acid of complementary sequence through one or more types of chemical bonds, usually through complementary base pairing, usually through hydrogen bond formation. As used herein, a probe may include natural (i.e., A, G, U, C, or T) or modified bases (7-deazaguanosine, inosine, etc.). In addition, the bases in probes may be joined by a linkage other than a phosphodiester bond, so long as it does not interfere with hybridization. Thus, probes may be peptide nucleic acids in which the constituent bases are joined by peptide bonds rather than phosphodiester linkages.

The term “perfect match probe” refers to a probe that has a sequence that is perfectly complementary to a particular target sequence. The test probe is typically perfectly complementary to a portion (subsequence) of the target sequence. The perfect match (PM) probe can be a “test probe”, a “normalization control” probe, an expression level control probe and the like. A perfect match control or perfect match probe is, however, distinguished from a “mismatch control” or “mismatch probe.”

The terms “mismatch control” or “mismatch probe” refer to a probe whose sequence is deliberately selected not to be perfectly complementary to a particular target sequence. For each mismatch (MM) control in a high-density array there typically exists a corresponding perfect match (PM) probe that is perfectly complementary to the same particular target sequence. The mismatch may comprise one or more bases.

While the mismatch(es) may be located anywhere in the mismatch probe, terminal mismatches are less desirable as a terminal mismatch is less likely to prevent hybridization of the target sequence. In a particularly preferred embodiment, the mismatch is located at or near the center of the probe such that the mismatch is most likely to destabilize the duplex with the target sequence under the test hybridization conditions.

The term “stringent conditions” refers to conditions under which a probe will hybridize to its target subsequence, but with only insubstantial hybridization to other sequences or to other sequences such that the difference may be identified. Stringent conditions are sequence-dependent and will be different in different circumstances. Longer sequences hybridize specifically at higher temperatures. Generally, stringent conditions are selected to be about 5° C. lower than the thermal melting point (Tm) for the specific sequence at a defined ionic strength and pH.

Typically, stringent conditions will be those in which the salt concentration is at least about 0.01 to 1.0 M Na⁺ ion concentration (or other salts) at pH 7.0 to 8.3 and the temperature is at least about 30° C. for short probes (e.g., 10 to 50 nucleotides). Stringent conditions may also be achieved with the addition of destabilizing agents such as formamide.

The “percentage of sequence identity” or “sequence identity” is determined by comparing two optimally aligned sequences or subsequences over a comparison window or span, wherein the portion of the polynucleotide sequence in the comparison window may optionally comprise additions or deletions (i.e., gaps) as compared to the reference sequence (which does not comprise additions or deletions) for optimal alignment of the two sequences. The percentage is calculated by determining the number of positions at which the identical submit (e.g. nucleic acid base or amino acid residue) occurs in both sequences to yield the number of matched positions, dividing the number of matched positions by the total number of positions in the window of comparison and multiplying the result by 100 to yield the percentage of sequence identity. Percentage sequence identity when calculated using the programs GAP or BESTFIT (see below) is calculated using default gap weights.

Probe Design

One of skill in the art will appreciate that an enormous number of array designs are suitable for the practice of this invention. The high density array will typically include a number of test probes that specifically hybridize to the sequences of interest. Probes may be produced from any region of the genes identified in the Tables and the attached representative sequence listing. In instances where the gene reference in the Tables is an EST, probes may be designed from that sequence or from other regions of the corresponding full-length transcript that may be available in any of the sequence databases, such as those herein described. See WO 99/32660 for methods of producing probes for a given gene or genes. In addition, any available software may be used to produce specific probe sequences, including, for instance, software available from Molecular Biology Insights, Olympus Optical Co. and Biosoft International. In a preferred embodiment, the array will also include one or more control probes.

High density array chips of the invention include “test probes.” Test probes may be oligonucleotides that range from about 5 to about 500, or about 7 to about 50 nucleotides, more preferably from about 10 to about 40 nucleotides and most preferably from about 15 to about 35 nucleotides in length. In other particularly preferred embodiments, the probes are 20 or 25 nucleotides in length. In another preferred embodiment, test probes are double or single strand DNA sequences such as cDNA fragments. DNA sequences are isolated or cloned from natural sources or amplified from natural sources using native nucleic acid as templates. These probes have sequences complementary to particular subsequences of the genes whose expression they are designed to detect. Thus, the test probes are capable of specifically hybridizing to the target nucleic acid they are to detect.

In addition to test probes that bind the target nucleic acid(s) of interest, the high density array can contain a number of control probes. The control probes may fall into three categories referred to herein as 1) normalization controls; 2) expression level controls; and 3) mismatch controls.

Normalization controls are oligonucleotide or other nucleic acid probes that are complementary to labeled reference oligonucleotides or other nucleic acid sequences that are added to the nucleic acid sample to be screened. The signals obtained from the normalization controls after hybridization provide a control for variations in hybridization conditions, label intensity, “reading” efficiency and other factors that may cause the signal of a perfect hybridization to vary between arrays. In a preferred embodiment, signals (e.g., fluorescence intensity) read from all other probes in the array are divided by the signal (e.g., fluorescence intensity) from the control probes thereby normalizing the measurements.

Virtually any probe may serve as a normalization control. However, it is recognized that hybridization efficiency varies with base composition and probe length. Preferred normalization probes are selected to reflect the average length of the other probes present in the array, however, they can be selected to cover a range of lengths. The normalization control(s) can also be selected to reflect the (average) base composition of the other probes in the array, however in a preferred embodiment, only one or a few probes are used and they are selected such that they hybridize well (i.e., no secondary structure) and do not match any target-specific probes.

Expression level controls are probes that hybridize specifically with constitutively expressed genes in the biological sample. Virtually any constitutively expressed gene provides a suitable target for expression level controls. Typically expression level control probes have sequences complementary to subsequences of constitutively expressed “housekeeping genes” including, but not limited to the actin gene, the transferrin receptor gene, the GAPDH gene, and the like.

Mismatch controls may also be provided for the probes to the target genes, for expression level controls or for normalization controls. Mismatch controls are oligonucleotide probes or other nucleic acid probes identical to their corresponding test or control probes except for the presence of one or more mismatched bases. A mismatched base is a base selected so that it is not complementary to the corresponding base in the target sequence to which the probe would otherwise specifically hybridize. One or more mismatches are selected such that under appropriate hybridization conditions (e.g., stringent conditions) the test or control probe would be expected to hybridize with its target sequence, but the mismatch probe would not hybridize (or would hybridize to a significantly lesser extent). Preferred mismatch probes contain a central mismatch. Thus, for example, where a probe is a 20 mer, a corresponding mismatch probe will have the identical sequence except for a single base mismatch (e.g., substituting a G, a C or a T for an A) at any of positions 6 through 14 (the central mismatch).

Mismatch probes thus provide a control for non-specific binding or cross hybridization to a nucleic acid in the sample other than the target to which the probe is directed. For example, if the target is present the perfect match probes should be consistently brighter than the mismatch probes. In addition, if all central mismatches are present, the mismatch probes can be used to detect a mutation, for instance, a mutation of a gene in the accompanying Tables 1-5. The difference in intensity between the perfect match and the mismatch probe provides a good measure of the concentration of the hybridized material.

Nucleic Acid Samples

Cell or tissue samples may be exposed to the test agent in vitro or in vivo. When cultured cells or tissues are used, appropriate mammalian cell extracts, such as liver extracts, may also be added with the test agent to evaluate agents that may require biotransformation to exhibit toxicity. In a preferred format, primary isolates or cultured cell lines of animal or human renal cells may be used.

The genes which are assayed according to the present invention are typically in the form of mRNA or reverse transcribed mRNA. The genes may or may not be cloned. The genes may or may not be amplified. The cloning and/or amplification do not appear to bias the representation of genes within a population. In some assays, it may be preferable, however, to use polyA+RNA as a source, as it can be used with less processing steps.

As is apparent to one of ordinary skill in the art, nucleic acid samples used in the methods and assays of the invention may be prepared by any available method or process. Methods of isolating total mRNA are well known to those of skill in the art. For example, methods of isolation and purification of nucleic acids are described in detail in Chapter 3 of Laboratory Techniques in Biochemistry and Molecular Biology, Vol. 24, Hybridization With Nucleic Acid Probes: Theory and Nucleic Acid Probes, P. Tijssen, Ed., Elsevier Press, New York, 1993. Such samples include RNA samples, but also include cDNA synthesized from a mRNA sample isolated from a cell or tissue of interest. Such samples also include DNA amplified from the cDNA, and RNA transcribed from the amplified DNA. One of skill in the art would appreciate that it is desirable to inhibit or destroy RNase present in homogenates before homogenates are used.

Biological samples may be of any biological tissue or fluid or cells from any organism as well as cells raised in vitro, such as cell lines and tissue culture cells. Frequently the sample will be a tissue or cell sample that has been exposed to a compound, agent, drug, pharmaceutical composition, potential environmental pollutant or other composition. In some formats, the sample will be a “clinical sample” which is a sample derived from a patient. Typical clinical samples include, but are not limited to, sputum, blood, blood-cells (e.g., white cells), tissue or fine needle biopsy samples, urine, peritoneal fluid, and pleural fluid, or cells therefrom. Biological samples may also include sections of tissues, such as frozen sections or formalin fixed sections taken for histological purposes.

Forming High Density Arrays

Methods of forming high density arrays of oligonucleotides with a minimal number of synthetic steps are known. The oligonucleotide analogue array can be synthesized on a single or on multiple solid substrates by a variety of methods, including, but not limited to, light-directed chemical coupling, and mechanically directed coupling (see Pirrung, U.S. Pat. No. 5,143,854).

In brief, the light-directed combinatorial synthesis of oligonucleotide arrays on a glass surface proceeds using automated phosphoramidite chemistry and chip masking techniques. In one specific implementation, a glass surface is derivatized with a silane reagent containing a functional group, e.g., a hydroxyl or amine group blocked by a photolabile protecting group. Photolysis through a photolithographic mask is used selectively to expose functional groups which are then ready to react with incoming 5′ photoprotected nucleoside phosphoramidites. The phosphoramidites react only with those sites which are illuminated (and thus exposed by removal of the photolabile blocking group). Thus, the phosphoramidites only add to those areas selectively exposed from the preceding step. These steps are repeated until the desired array of sequences have been synthesized on the solid surface. Combinatorial synthesis of different oligonucleotide analogues at different locations on the array is determined by the pattern of illumination during synthesis and the order of addition of coupling reagents.

In addition to the foregoing, additional methods which can be used to generate an array of oligonucleotides on a single substrate are described in PCT Publication Nos. WO 93/09668 and WO 01/23614. High density nucleic acid arrays can also be fabricated by depositing pre-made or natural nucleic acids in predetermined positions. Synthesized or natural nucleic acids are deposited on specific locations of a substrate by light directed targeting and oligonucleotide directed targeting. Another embodiment uses a dispenser that moves from region to region to deposit nucleic acids in specific spots.

Hybridization

Nucleic acid hybridization simply involves contacting a probe and target nucleic acid under conditions where the probe and its complementary target can form stable hybrid duplexes through complementary base pairing. See WO 99/32660. The nucleic acids that do not form hybrid duplexes are then washed away leaving the hybridized nucleic acids to be detected, typically through detection of an attached detectable label. It is generally recognized that nucleic acids are denatured by increasing the temperature or decreasing the salt concentration of the buffer containing the nucleic acids. Under low stringency conditions (e.g., low temperature and/or high salt) hybrid duplexes (e.g., DNA:DNA, RNA:RNA, or RNA:DNA) will form even where the annealed sequences are not perfectly complementary. Thus, specificity of hybridization is reduced at lower stringency. Conversely, at higher stringency (e.g., higher temperature or lower salt) successful hybridization tolerates fewer mismatches. One of skill in the art will appreciate that hybridization conditions may be selected to provide any degree of stringency.

In a preferred embodiment, hybridization is performed at low stringency, in this case in 6×SSPET at 37° C. (0.005% Triton X-100), to ensure hybridization and then subsequent washes are performed at higher stringency (e.g., 1×SSPET at 37° C.) to eliminate mismatched hybrid duplexes. Successive washes may be performed at increasingly higher stringency (e.g., down to as low as 0.25×SSPET at 37° C. to 50° C.) until a desired level of hybridization specificity is obtained. Stringency can also be increased by addition of agents such as formamide. Hybridization specificity may be evaluated by comparison of hybridization to the test probes with hybridization to the various controls that can be present (e.g., expression level control, normalization control, mismatch controls, etc.).

In general, there is a tradeoff between hybridization specificity (stringency) and signal intensity. Thus, in a preferred embodiment, the wash is performed at the highest stringency that produces consistent results and that provides a signal intensity greater than approximately 10% of the background intensity. Thus, in a preferred embodiment, the hybridized array may be washed at successively higher stringency solutions and read between each wash. Analysis of the data sets thus produced will reveal a wash stringency above which the hybridization pattern is not appreciably altered and which provides adequate signal for the particular oligonucleotide probes of interest.

Signal Detection

The hybridized nucleic acids are typically detected by detecting one or more labels attached to the sample nucleic acids. The labels may be incorporated by any of a number of means well known to those of skill in the art. See WO 99/32660.

Databases

The present invention includes relational databases containing sequence information, for instance, for the genes of Tables 1-5, as well as gene expression information from tissue or cells exposed to various standard toxins, such as those herein described (see Tables 5-5L). Databases may also contain information associated with a given sequence or tissue sample such as descriptive information about the gene associated with the sequence information (see Tables 1 and 2), or descriptive information concerning the clinical status of the tissue sample, or the animal from which the sample was derived. The database may be designed to include different parts, for instance a sequence database and a gene expression database. Methods for the configuration and construction of such databases and computer-readable media to which such databases are saved are widely available, for instance, see U.S. Pat. No. 5,953,727, which is herein incorporated by reference in its entirety.

The databases of the invention may be linked to an outside or external database such as GenBank (www.ncbi.nlm.nih.gov/entrez.index.html); KEGG (www.genome.ad.jp/kegg); SPAD (www.grt.kyushu-u.acjp/spad/index.html); HUGO (www.gene.ucl.ac.uk/hugo); Swiss-Prot (www.expasy.ch.sprot); Prosite (www.expasy.ch/tools/scnpsitl.html); OMIM (www.ncbi.nlm.nih.gov/omim); and GDB (www.gdb.org). In a preferred embodiment, as described in Tables 1-5, the external database is GenBank and the associated databases maintained by the National Center for Biotechnology Information (NCBI) (www.ncbi.nlm.nih.gov).

Any appropriate computer platform, user interface, etc. may be used to perform the necessary comparisons between sequence information, gene expression information and any other information in the database or information provided as an input. For example, a large number of computer workstations are available from a variety of manufacturers, such has those available from Silicon Graphics. Client/server environments, database servers and networks are also widely available and appropriate platforms for the databases of the invention.

The databases of the invention may be used to produce, among other things, electronic Northerns that allow the user to determine the cell type or tissue in which a given gene is expressed and to allow determination of the abundance or expression level of a given gene in a particular tissue or cell.

The databases of the invention may also be used to present information identifying the expression level in a tissue or cell of a set of genes comprising one or more of the genes in Tables 1-5, comprising the step of comparing the expression level of at least one gene in Tables 1-5 in a cell or tissue exposed to a test agent to the level of expression of the gene in the database. Such methods may be used to predict the toxic potential of a given compound by comparing the level of expression of a gene or genes in Tables 1-5 from a tissue or cell sample exposed to the test agent to the expression levels found in a control tissue or cell samples exposed to a standard toxin or renal toxin such as those herein described. Such methods may also be used in the drug or agent screening assays as described herein.

Kits

The invention further includes kits combining, in different combinations, high-density oligonucleotide arrays, reagents for use with the arrays, protein reagents encoded by the genes of the Tables, signal detection and array-processing instruments, gene expression databases and analysis and database management software described above. The kits may be used, for example, to predict or model the toxic response of a test compound, to monitor the progression of renal disease states, to identify genes that show promise as new drug targets and to screen known and newly designed drugs as discussed above.

The databases packaged with the kits are a compilation of expression patterns from human or laboratory animal genes and gene fragments (corresponding to the genes of Tables 1-5). In particular, the database software and packaged information that may contain the databases saved to a computer-readable medium include the expression results of Tables 1-5 that can be used to predict toxicity of a test agent by comparing the expression levels of the genes of Tables 1-5 induced by the test agent to the expression levels presented in Tables 5-5L. In another format, database and software information may be provided in a remote electronic format, such as a website, the address of which may be packaged in the kit.

The kits may used in the pharmaceutical industry, where the need for early drug testing is strong due to the high costs associated with drug development, but where bioinformatics, in particular gene expression informatics, is still lacking. These kits will reduce the costs, time and risks associated with traditional new drug screening using cell cultures and laboratory animals. The results of large-scale drug screening of pre-grouped patient populations, pharmacogenomics testing, can also be applied to select drugs with greater efficacy and fewer side-effects. The kits may also be used by smaller biotechnology companies and research institutes who do not have the facilities for performing such large-scale testing themselves.

Databases and software designed for use with microarrays is discussed in Balaban et al., U.S. Pat. No. 6,229,911, a computer-implemented method for managing information, stored as indexed Tables 1-5, collected from small or large numbers of microarrays, and U.S. Pat. No. 6,185,561, a computer-based method with data mining capability for collecting gene expression level data, adding additional attributes and reformatting the data to produce answers to various queries. Chee et al., U.S. Pat. No. 5,974,164, disclose a software-based method for identifying mutations in a nucleic acid sequence based on differences in probe fluorescence intensities between wild type and mutant sequences that hybridize to reference sequences.

Without further description, it is believed that one of ordinary skill in the art can, using the preceding description and the following illustrative examples, make and utilize the compounds of the present invention and practice the claimed methods. The following working examples therefore, specifically point out the preferred embodiments of the present invention, and are not to be construed as limiting in any way the remainder of the disclosure.

### EXAMPLES

### Example 1

### Identification of Toxicity Markers

The renal toxins indomethacin, diflunisal, colchicine, chloroform, diclofenac, menadione, sodium chromate, sodium oxalate, thioacetamide, and vancomycin were administered to male Sprague-Dawley rats at various timepoints using administration diluents, protocols and dosing regimes as previously described in the art and previously described in the priority applications discussed above. In experiments using toxins A-G, as labeled in Table 4, blood and tissue samples were collected at the following time-points: chloroform (A), thioacetamide (F) and vancomycin (G)—after 6, 24 and 48 hours of exposure; diclofenac (B) and menadione (C)—after 3, 6 and 24 hours of exposure; and sodium chromate (D) and sodium oxalate (E)—after 6, 24 and 72 hours of exposure. For these compounds, no significant changes in the levels of gene expression were found with varying exposure time, i.e., short and long time-points showed the same pattern of differential gene expression. The low and high dose level for each compound are provided in the chart below.

| | Low | | Method of |
|---|---|---|---|
| Renal Toxin | Dose (mg/kg) | High Dose (mg/kg) | Administration |
| indomethacin | 1 | 10 | oral gavage |
| diflunisal | 2 | 400 | oral gavage |
| colchicine | 0.15 | 1.5 | intraperitoneal |
| chloroform | 11.95 | 239 | oral gavage |
| diclofenac | 1 | 200 | intraperitoneal |
| menadione | 15 | 150 | intravenous |
| sodium chromate | 3 | 30 | intraperitoneal |
| sodium oxalate | 10 | 100 | intraperitoneal |
| thioacetamide | 30 | 300 | intraperitoneal |
| vancomycin | 50 | 500 | intravenous |

After administration, the dosed animals were observed and tissues were collected as described below:

Observation of Animals

1. Clinical cage side observations—twice daily mortality and moribundity check. Skin and fur, eyes and mucous membrane, respiratory system, circulatory system, autonomic and central nervous system, somatomotor pattern, and behavior pattern were checked. Potential signs of toxicity, including tremors, convulsions, salivation, diarrhea, lethargy, coma or other atypical behavior or appearance, were recorded as they occurred and included a time of onset, degree, and duration.

2. Physical Examinations—Prior to randomization, prior to initial treatment, and prior to sacrifice.

3. Body Weights—Prior to randomization, prior to initial treatment, and prior to sacrifice.

Clinical Pathology

1. Frequency—Prior to necropsy.

2. Number of animals—All surviving animals.

3. Bleeding Procedure—Blood was obtained by puncture of the orbital sinus while under 70% CO₂/30% O₂ anesthesia.

4. Collection of Blood Samples—Approximately 0.5 mL of blood was collected into EDTA tubes for evaluation of hematology parameters. Approximately 1 mL of blood was collected into serum separator tubes for clinical chemistry analysis. Approximately 200 uL of plasma was obtained and frozen at ˜−80° C. for test compound/metabolite estimation. An additional ˜2 mL of blood was collected into a 15 mL conical polypropylene vial to which ˜3 mL of Trizol was immediately added. The contents were immediately mixed with a vortex and by repeated inversion. The tubes were frozen in liquid nitrogen and stored at ˜−80° C.

Termination Procedures

Terminal Sacrifice

Approximately 3, 6, 24, 48, 72, 120, 144, 168, 336, and/or 360 hours after the initial dose, rats were weighed, physically examined, sacrificed by decapitation, and exsanguinated. The animals were necropsied within approximately five minutes of sacrifice. Separate sterile, disposable instruments were used for each animal, with the exception of bone cutters, which were used to open the skull cap. The bone cutters were dipped in disinfectant solution between animals.

Necropsies were conducted on each animal following procedures approved by board-certified pathologists.

Animals not surviving until terminal sacrifice were discarded without necropsy (following euthanasia by carbon dioxide asphyxiation, if moribund). The approximate time of death for moribund or found dead animals was recorded.

Postmortem Procedures

Fresh and sterile disposable instruments were used to collect tissues. Gloves were worn at all times when handling tissues or vials. All tissues were collected and frozen within approximately 5 minutes of the animal's death. The liver sections and kidneys were frozen within approximately 3-5 minutes of the animal's death. The time of euthanasia, an interim time point at freezing of liver sections and kidneys, and time at completion of necropsy were recorded. Tissues were stored at approximately −80° C. or preserved in 10% neutral buffered formalin.

Tissue Collection and Processing

Liver
1. Right medial lobe—snap frozen in liquid nitrogen and stored at ˜−80° C.
2. Left medial lobe—Preserved in 10% neutral-buffered formalin (NBF) and evaluated for gross and microscopic pathology.
3. Left lateral lobe—snap frozen in liquid nitrogen and stored at ˜−80° C.

Heart—A sagittal cross-section containing portions of the two atria and of the two ventricles was preserved in 10% NBF. The remaining heart was frozen in liquid nitrogen and stored at ˜−80° C.

Kidneys (both)
1. Left—Hemi-dissected; half was preserved in 10% NBF and the remaining half was frozen in liquid nitrogen and stored at ˜−80° C.
2. Right—Hemi-dissected; half was preserved in 10% NBF and the remaining half was frozen in liquid nitrogen and stored at ˜−80° C.

Testes (both)—A sagittal cross-section of each testis was preserved in 10% NBF. The remaining testes were frozen together in liquid nitrogen and stored at ˜−80° C.

Brain (whole)—A cross-section of the cerebral hemispheres and of the diencephalon was preserved in 10% NBF, and the rest of the brain was frozen in liquid nitrogen and stored at ˜−80° C.

Microarray sample preparation was conducted with minor modifications, following the protocols set forth in the Affymetrix GeneChip Expression Analysis Manual. Frozen tissue was ground to a powder using a Spex Certiprep 6800 Freezer Mill. Total RNA was extracted with Trizol (GibcoBRL) utilizing the manufacturer's protocol. The total RNA yield for each sample was 200-500 μg per 300 mg tissue weight. mRNA was isolated using the Oligotex mRNA Midi kit (Qiagen) followed by ethanol precipitation. Double stranded cDNA was generated from mRNA using the SuperScript Choice system (GibcoBRL). First strand cDNA synthesis was primed with a T7-(dT24) oligonucleotide. The cDNA was phenol-chloroform extracted and ethanol precipitated to a final concentration of 1 μg/ml. From 2 μg of cDNA, cRNA was synthesized using Ambion's T7 MegaScript in vitro Transcription Kit.

To biotin label the cRNA, nucleotides Bio-11-CTP and Bio-16-UTP (Enzo Diagnostics) were added to the reaction. Following a 37° C. incubation for six hours, impurities were removed from the labeled cRNA following the RNeasy Mini kit protocol (Qiagen). cRNA was fragmented (fragmentation buffer consisting of 200 mM Tris-acetate, pH 8.1, 500 mM KOAc, 150 mM MgOAc) for thirty-five minutes at 94° C. Following the Affymetrix protocol, 55 μg of fragmented cRNA was hybridized on the Affymetrix rat array set for twenty-four hours at 60 rpm in a 45° C. hybridization oven. The chips were washed and stained with Streptavidin Phycoerythrin (SAPE) (Molecular Probes) in Affymetrix fluidics stations. To amplify staining, SAPE solution was added twice with an anti-streptavidin biotinylated antibody (Vector Laboratories) staining step in between. Hybridization to the probe arrays was detected by fluorometric scanning (Hewlett Packard Gene Array Scanner). Data was analyzed using Affymetrix GeneChip® version 2.0 and Expression Data Mining (EDMT) software (version 1.0), GeneExpress2000, and S-Plus.

Tables 1 and 2 disclose those genes that are differentially expressed upon exposure to the named toxins and their corresponding GenBank Accession and Sequence Identification numbers, the identities of the metabolic pathways in which the genes function, the gene names if known, and the unigene cluster titles. The model code represents the various toxicity state that each gene is able to discriminate as well as the individual toxin type associated with each gene. The codes are defined in Table 4. The GLGC ID is the internal Gene Logic identification number.

Table 3 discloses those genes that are the human homologues of those genes in Tables 1 and 2 that are differentially expressed upon exposure to the named toxins. The corresponding GenBank Accession and Sequence Identification numbers, the gene names if known, and the unigene cluster titles of the human homologues are listed.

Table 4 defines the comparison codes used in Tables 1, 2, 3, and 5.

Tables 5-5L disclose the summary statistics for each of the comparisons performed. Each of these tables contains a set of predictive genes and creates a model for predicting the renal toxicity of an unknown, i.e., untested compound. Each gene is identified by its Gene Logic identification number and can be cross-referenced to a gene name and representative SEQ ID NO. in Tables 1 and 2. For each comparison of gene expression levels between samples in the toxicity group (samples affected by exposure to a specific toxin) and samples in the non-toxicity group (samples not affected by exposure to that same specific toxin), the tox mean (for toxicity group samples) is the mean signal intensity, as normalized for the various chip parameters that are being assayed. The non-tox mean represents the mean signal intensity, as normalized for the various chip parameters that are being assayed, in samples from animals other than those treated with the high dose of the specific toxin. These animals were treated with a low dose of the specific toxin, or with vehicle alone, or with a different toxin. Samples in the toxicity groups were obtained from animals sacrificed at the timepoint(s) indicated in the Table 5 headings, while samples in the non-toxicity groups were obtained from animals sacrificed at all time points in the experiments. For individual genes, an increase in the tox mean compared to the non-tox mean indicates up-regulation upon exposure to a toxin. Conversely, a decrease in the tox mean compared to the non-tox mean indicates down-regulation.

The mean values are derived from Average Difference (AveDiff) values for a particular gene, averaged across the corresponding samples. Each individual Average Difference value is calculated by integrating the intensity information from multiple probe pairs that are tiled for a particular fragment. The normalization multiplies each expression intensity for a given experiment (chip) by a global scaling factor. The intent of this normalization is to make comparisons of individual genes between chips possible. The scaling factor is calculated as follows:

1. From all the unnormalized expression values in the experiment, delete the largest 2% and smallest 2% of the values. That is, if the experiment yields 10,000 expression values, order the values and delete the smallest 200 and the largest 200.

2. Compute the trimmed mean, which is equal to the mean of the remaining values.

3. Compute the scale factor SF=100/(trimmed mean).

The value of 100 used here is the standard target value used. Some AveDiff values may be negative due to the general noise involved in nucleic acid hybridization experiments. Although many conclusions can be made corresponding to a negative value on the GeneChip platform, it is difficult to assess the meaning behind the negative value for individual fragments. Our observations show that, although negative values are observed at times within the predictive gene set, these values reflect a real biological phenomenon that is highly reproducible across all the samples from which the measurement was taken. For this reason, those genes that exhibit a negative value are included in the predictive set. It should be noted that other platforms of gene expression measurement may be able to resolve the negative numbers for the corresponding genes. The predictive ability of each of those genes should extend across platforms, however. Each mean value is accompanied by the standard deviation for the mean. The linear discriminant analysis score (discriminant score), as disclosed in the tables, measures the ability of each gene to predict whether or not a sample is toxic. The discriminant score is calculated by the following steps:

Calculation of a Discriminant Score

1. Let Xᵢ represent the AveDiff values for a given gene across the non-tox samples, i=1 . . . n.
2. Let Yᵢ represent the AveDiff values for a given gene across the tox samples, i=1 . . . t. The calculations proceed as follows:
3. Calculate mean and standard deviation for Xᵢ's and Yᵢ's, and denote these by m_{X}, m_{Y}, s_{X}, s_{Y}.
4. For all Xᵢ's and Yᵢ's, evaluate the function f(z)=((1/s_{Y})*exp(−0.5*((z−m_{Y})/s_{Y})²))/(((1/s_{Y})*exp(−0.5*((z−m_{Y})/s_{Y})²))+((1/s_{X})*exp(−0.5*((z−m_{X})/s_{X})²))).
5. The number of correct predictions, say P, is then the number of Yᵢ's such that f(Yᵢ)>0.5 plus the number of Xᵢ's such that f(Xᵢ)<0.5.
6. The discriminant score is then P/(n+t).

Linear discriminant analysis uses both the individual measurements of each gene and the calculated measurements of all combinations of genes to classify samples. For each gene a weight is derived from the mean and standard deviation of the toxic and nontox groups. Every gene is multiplied by a weight and the sum of these values results in a collective discriminate score. This discriminant score is then compared against collective centroids of the tox and nontox groups. These centroids are the average of all tox and nontox samples respectively. Therefore, each gene contributes to the overall prediction. This contribution is dependent on weights that are large positive or negative numbers if the relative distances between the tox and nontox samples for that gene are large and small numbers if the relative distances are small. The discriminant score for each unknown sample and centroid values can be used to calculate a probability between zero and one as to the group in which the unknown sample belongs.

### Example 2

### General Toxicity Modeling

Samples were selected for grouping into tox-responding and non-tox-responding groups by examining each study individually with Principal Components Analysis (PCA) to determine which treatments had an observable response. Only groups where confidence of their tox-responding and non-tox-responding status was established were included in building a general tox model (Table 5).

Linear discriminant models were generated to describe toxic and non-toxic samples. The top discriminant genes and/or EST's were used to determine toxicity by calculating each gene's contribution with homo and heteroscedastic treatment of variance and inclusion or exclusion of mutual information between genes. Prediction of samples within the database exceeded 80% true positives with a false positive rate of less than 5%. It was determined that combinations of genes and/or EST's generally provided a better predictive ability than individual genes and that the more genes and/or EST used the better predictive ability. Although the preferred embodiment includes fifty or more genes, many pairings or greater combinations of genes and/or EST can work better than individual genes. All combinations of two or more genes from the selected list (Table 5) could be used to predict toxicity. These combinations could be selected by pairing in an agglomerate, divisive, or random approach. Further, as yet undetermined genes and/or EST's could be combined with individual or combination of genes and/or EST's described here to increase predictive ability. However, the genes and/or EST's described here would contribute most of the predictive ability of any such undetermined combinations.

Other variations on the above method can provide adequate predictive ability. These include selective inclusion of components via agglomerate, divisive, or random approaches or extraction of loading and combining them in agglomerate, divisive, or random approaches. Also the use of composite variables in logistic regression to determine classification of samples can also be accomplished with linear discriminate analysis, neural or Bayesian networks, or other forms of regression and classification based on categorical or continual dependent and independent variables.

### Example 3

### Modeling Methods

The above modeling methods provide broad approaches of combining the expression of genes to predict sample toxicity. One could also provide no weight in a simple voting method or determine weights in a supervised or unsupervised method using agglomerate, divisive, or random approaches. All or selected combinations of genes may be combined in ordered, agglomerate, or divisive, supervised or unsupervised clustering algorithms with unknown samples for classification. Any form of correlation matrix may also be used to classify unknown samples. The spread of the group distribution and discriminate score alone provide enough information to enable a skilled person to generate all of the above types of models with accuracy that can exceed discriminate ability of individual genes. Some examples of methods that could be used individually or in combination after transformation of data types include but are not limited to: Discriminant Analysis, Multiple Discriminant Analysis, logistic regression, multiple regression analysis, linear regression analysis, conjoint analysis, canonical correlation, hierarchical cluster analysis, k-means cluster analysis, self-organizing maps, multidimensional scaling, structural equation modeling, support vector machine determined boundaries, factor analysis, neural networks, bayesian classifications, and resampling methods.

### Example 4

### Grouping of Individual Compound and Pathology Classes

Samples were grouped into individual pathology classes based on known toxicological responses and observed clinical chemical and pathology measurements or into early and late phases of observable toxicity within a compound (Tables 5A-5L). The top 10, 25, 50, 100 genes based on individual discriminate scores were used in a model to ensure that combination of genes provided a better prediction than individual genes. As described above, all combinations of two or more genes from this list could potentially provide better prediction than individual genes when selected in any order or by ordered, agglomerate, divisive, or random approaches. In addition, combining these genes with other genes could provide better predictive ability, but most of this predictive ability would come from the genes listed herein.

Samples may be considered toxic if they score positive in any pathological or individual compound class represented here or in any modeling method mentioned under general toxicology models based on combination of individual time and dose grouping of individual toxic compounds obtainable from the data. The pathological groupings and early and late phase models are preferred examples of all obtainable combinations of sample time and dose points. Most logical groupings with one or more genes and one or more sample dose and time points should produce better predictions of general toxicity, pathological specific toxicity, or similarity to known toxicant than individual genes.

Although the present invention has been described in detail with reference to examples above, it is understood that various modifications can be made without departing from the spirit of the invention. Accordingly, the invention is limited only by the following claims. All cited patents, patent applications and publications referred to in this application are herein incorporated by reference in their entirety.

TABLE 1
ANNOTATIONS

Atty. Docket No. GENE-077/26US
Doc. No. 44941

| GLGC | | GenBank Acc | | | |
|---|---|---|---|---|---|
| Identifier | Seq ID | or RefSeq ID | Model Code | Known Gene Name | Sequence Cluster Title |
| 23758 | 285 | AA956414 | C, G | | ESTs, Weakly similar to ACDS_RAT Acyl- |
| | | | | | CoA dehydrogenase, short-chain specific, |
| | | | | | mitochondrial precursor (SCAD) (Butyryl- |
| | | | | | CoA dehydrogenase) [R. norvegicus] |
| 16625 | 324 | AA998062 | D | HHs: Alg5, S. cerevisiae, | ESTs, Highly similar to T51776 dolichyl- |
| | | | | homolog of | phosphate beta-glucosyltransferase (EC |
| | | | | | 2.4.1.117) [imported] - human [H. sapiens] |
| 24648 | 1046 | NM_030985 | GENERAL | Rattus norvegicus | Angiotensin II receptor, type 1 (AT1A) |
| | | | | Angiotensin II receptor, type | |
| | | | | 1 (AT1A) (Agtr1a), mRNA. | |
| | | | | Length = 1450 | |
| 21462 | 77 | AA851261 | GENERAL, J | | ESTs, Highly similar to A61382 |
| | | | | | phosphorylation regulatory protein HP-10 - |
| | | | | | human [H. sapiens] |
| 5867 | 85 | AA858953 | GENERAL | | ESTs, Moderately similar to |
| | | | | | SYN_HUMAN Asparaginyl-tRNA |
| | | | | | synthetase, cytoplasmic (Asparagine - |
| | | | | | tRNA ligase) (AsnRS) [H. sapiens] |
| 21632 | 359 | AI009167 | GENERAL, | | ESTs, Highly similar to BAG2_HUMAN |
| | | | H, I | | BAG-family molecular chaperone |
| | | | | | regulator-2 [H. sapiens] |
| 23957 | 291 | AA957123 | GENERAL | | ESTs, Weakly similar to NADE_HUMAN |
| | | | | | p75NTR-associated cell death executor |
| | | | | | (Nerve growth factor receptor associated |
| | | | | | protein 1) (Ovarian granulosa cell 13.0 kDa |
| | | | | | protein HGR74) [H. sapiens] |
| 12716 | 372 | AI010178 | GENERAL | | ESTs, Moderately similar to |
| | | | | | CA00_HUMAN Protein CGI-100 |
| | | | | | precursor [H. sapiens] |
| 3121 | 353 | AI008160 | GENERAL, | | ESTs, Moderately similar to T44603 |
| | | | G, K | | hypothetical protein CGI-83 [imported] - |
| | | | | | human [H. sapiens] |
| 8944 | 466 | AI070597 | F | | ESTs, Highly similar to YC97_HUMAN |
| | | | | | Hypothetical protein CGI-97 [H. sapiens] |
| 4360 | 785 | H31813 | GENERAL, | | ESTs, Moderately similar to T14781 |
| | | | G, I | | hypothetical protein DKFZp586B1621.1 - |
| | | | | | human (fragment) [H. sapiens] |
| 3834 | 629 | AI177902 | G | | ESTs, Highly similar to T14743 |
| | | | | | hypothetical protein DKFZp586F1524.1 - |
| | | | | | human (fragment) [H. sapiens] |
| 4373 | 153 | AA892310 | F | | ESTs, Highly similar to T08783 |
| | | | | | hypothetical protein DKFZp586O0120.1 - |
| | | | | | human (fragment) [H. sapiens] |
| 5990 | 290 | AA956907 | GENERAL | | ESTs, Highly similar to IF3A_MOUSE |
| | | | | | EUKARYOTIC TRANSLATION |
| | | | | | INITIATION FACTOR 3 SUBUNIT 10 |
| | | | | | (EIF-3 THETA) (EIF3 P167) (EIF3 P180) |
| | | | | | (EIF3 P185) (P162 PROTEIN) |
| | | | | | (CENTROSOMIN) [M. musculus] |
| 17921 | 607 | AI176422 | F | | ESTs, Highly similar to S41115 probable |
| | | | | | flavoprotein-ubiquinone oxidoreductase |
| | | | | | (EC 1.6.5.—) - human [H. sapiens] |
| 3439 | 185 | AA893000 | B | | ESTs, Moderately similar to T00335 |
| | | | | | hypothetical protein KIAA0564 - human |
| | | | | | (fragment) [H. sapiens] |
| 13607 | 640 | AI179403 | H | | ESTs, Weakly similar to U520_HUMAN |
| | | | | | U5 small nuclear ribonucleoprotein 200 kDa |
| | | | | | helicase (U5 snRNP-specific 200 kDa |
| | | | | | protein) (U5-200 KD) [H. sapiens] |
| 20810 | 1235 | X14181 | G | | ESTs, Highly similar to R5RT18 |
| | | | | | ribosomal protein L18a, cytosolic |
| | | | | | [validated] - rat [R. norvegicus] |
| 17734 | 1114 | NM_031970 | GENERAL, | Rattus norvegicus Heat | ESTs, Moderately similar to hypothetical |
| | | | C, I | shock 27 kDa protein | protein MGC10974 [Homo sapiens] |
| | | | | (Hsp27), mRNA. Length = 787 | [H. sapiens], heat shock 27 kD protein 1 |
| 17735 | 1114 | NM_031970 | C, K | Rattus norvegicus Heat | ESTs, Moderately similar to hypothetical |
| | | | | shock 27 kDa protein | protein MGC10974 [Homo sapiens] |
| | | | | (Hsp27), mRNA. Length = 787 | [H. sapiens], heat shock 27 kD protein 1 |
| 17736 | 1114 | NM_031970 | H, K | Rattus norvegicus Heat | ESTs, Moderately similar to hypothetical |
| | | | | shock 27 kDa protein | protein MGC10974 [Homo sapiens] |
| | | | | (Hsp27), mRNA. Length = 787 | [H. sapiens], heat shock 27 kD protein 1 |
| 7414 | 557 | AI137586 | K | | ESTs, Highly similar to IMB3_HUMAN |
| | | | | | Importin beta-3 subunit (Karyopherin beta |
| | | | | | 3 subunit) (Ran-binding protein 5) |
| | | | | | [H. sapiens] |
| 15302 | 9 | AA799518 | GENERAL | | ESTs, Highly similar to hypothetical |
| | | | | | protein FLJ13725; KIAA1930 protein |
| | | | | | [Homo sapiens] [H. sapiens] |
| 15303 | 9 | AA799518 | F | | ESTs, Highly similar to hypothetical |
| | | | | | protein FLJ13725; KIAA1930 protein |
| | | | | | [Homo sapiens] [H. sapiens] |
| 19412 | 66 | AA849222 | D | | ESTs, Weakly similar to T46904 |
| | | | | | hypothetical protein DKFZp761D081.1 - |
| | | | | | human [H. sapiens] |
| 13563 | 718 | AI233773 | E | MAWD binding protein | MAWD binding protein |
| 5952 | 298 | AA963102 | E | amino acid transporter | amino acid transporter system A2 |
| | | | | system A2 | |
| 5481 | 647 | AI180170 | GENERAL | | ESTs, Highly similar to S50853 |
| | | | | | translation releasing factor eRF-1 |
| | | | | | [validated] - human [H. sapiens] |
| 23987 | 1238 | X51615 | B | | ESTs, Highly similar to 1604368A gap |
| | | | | | junction protein Cx26 [Rattus norvegicus] |
| | | | | | [R. norvegicus] |
| 7451 | 420 | AI029450 | L | | ESTs, Moderately similar to |
| | | | | | SYEP_HUMAN Bifunctional aminoacyl- |
| | | | | | tRNA synthetase [includes: Glutamyl- |
| | | | | | tRNA synthetase (Glutamate - tRNA |
| | | | | | ligase); Prolyl-tRNA synthetase (Proline - |
| | | | | | tRNA ligase)] [H. sapiens] |
| 16756 | 38 | AA818089 | GENERAL, | HHs: glycyl-tRNA synthetase | ESTs, Highly similar to SYG_HUMAN |
| | | | A, I | | Glycyl-tRNA synthetase (Glycine - tRNA |
| | | | | | ligase) (GlyRS) [H. sapiens] |
| 13285 | 586 | AI171361 | A | | ESTs, Moderately similar to A Chain A, |
| | | | | | Musashi1 Rbd2, Nmr [M. musculus] |
| 8820 | 1186 | NM_080399 | B, H, L | Rattus norvegicus Smhs1 | Smhs1 protein |
| | | | | protein (Smhs1), mRNA. | |
| | | | | Length = 1107 | |
| 23282 | 1232 | U90725 | A | lipoprotein-binding protein | lipoprotein-binding protein |
| 3083 | 459 | AI060150 | E | | ESTs, Moderately similar to HIRA- |
| | | | | | interacting protein 3 [Homo sapiens] |
| | | | | | [H. sapiens] |
| 3816 | 716 | AI233729 | H | | ESTs, Moderately similar to |
| | | | | | PSD5_HUMAN 26S proteasome non- |
| | | | | | ATPase regulatory subunit 5 (26S |
| | | | | | proteasome subunit S5B) (26S protease |
| | | | | | subunit S5 basic) [H. sapiens] |
| 8739 | 469 | AI070859 | D | | ESTs, Weakly similar to T48686 |
| | | | | | hypothetical protein DKFZp761D1823.1 - |
| | | | | | human [H. sapiens] |
| 24197 | 462 | AI070314 | B, L | | ESTs, Moderately similar to |
| | | | | | ARVC_HUMAN Armadillo repeat protein |
| | | | | | deleted in velo-cardio-facial syndrome |
| | | | | | [H. sapiens] |
| 7540 | 450 | AI045882 | GENERAL, | vitamin A-deficient testicular | vitamin A-deficient testicular protein 5 |
| | | | B, L | protein 5 | |
| 22592 | 410 | AI013740 | GENERAL, | | ESTs, Moderately similar to S32567 A4 |
| | | | G, K | | protein - human [H. sapiens] |
| 11164 | 735 | AI235739 | GENERAL, I | | ESTs, Moderately similar to A56716 |
| | | | | | aromatic ester hydrolase (EC 3.1.1.—) - |
| | | | | | human [H. sapiens] |
| 22984 | 220 | AA924560 | E | | ESTs, Highly similar to T12449 |
| | | | | | hypothetical protein DKFZp564E1616.1 - |
| | | | | | human (fragments) [H. sapiens] |
| 6518 | 391 | AI012114 | GENERAL | | ESTs, Moderately similar to |
| | | | | | TRM1_HUMAN Probable N(2),N(2)- |
| | | | | | dimethylguanosine tRNA |
| | | | | | methyltransferase (tRNA(guanine-26,N(2) |
| | | | | | N(2)) methyltransferase) (tRNA 2,2- |
| | | | | | dimethylguanosine-26 methyltransferase) |
| | | | | | (tRNA(m(2,2)G26)dimethyltransferase) |
| | | | | | [H. sapiens] |
| 8665 | 483 | AI071965 | C | | ESTs, Moderately similar to T17342 |
| | | | | | hypothetical protein DKFZp586K1924.1 - |
| | | | | | human (fragment) [H. sapiens], |
| | | | | | R. norvegicus hsp70.2 mRNA for heat |
| | | | | | shock protein 70 |
| 8664 | 1261 | Z75029 | C, D | | ESTs, Moderately similar to T17342 |
| | | | | | hypothetical protein DKFZp586K1924.1 - |
| | | | | | human (fragment) [H. sapiens], |
| | | | | | R. norvegicus hsp70.2 mRNA for heat |
| | | | | | shock protein 70 |
| 22569 | 646 | AI179979 | GENERAL, I | | ESTs, Moderately similar to hypothetical |
| | | | | | protein FLJ21634 [Homo sapiens] |
| | | | | | [H. sapiens] |
| 18128 | 134 | AA891800 | I | | ESTs, Weakly similar to IPYR_HUMAN |
| | | | | | Inorganic pyrophosphatase |
| | | | | | (Pyrophosphate phospho-hydrolase) |
| | | | | | (PPase) [H. sapiens] |
| 15339 | 113 | AA875171 | D | | ESTs, Weakly similar to T45062 |
| | | | | | hypothetical protein c316G12.3 |
| | | | | | [imported] - human [H. sapiens] |
| 5369 | 567 | AI169058 | A | | ESTs, Weakly similar to JC5889 OS-9 |
| | | | | | protein precursor - human [H. sapiens] |
| 18168 | 247 | AA942995 | E | | ESTs, Highly similar to T50630 |
| | | | | | hypothetical protein DKFZp762N0610.1 - |
| | | | | | human (fragment) [H. sapiens] |
| 2191 | 203 | AA894086 | F | | ESTs, Highly similar to hypothetical |
| | | | | | protein MGC17552 [Homo sapiens] |
| | | | | | [H. sapiens] |
| 16731 | 293 | AA957244 | D | | ESTs, Moderately similar to JTV1; |
| | | | | | hypothetical protein PRO0992 [Homo |
| | | | | | sapiens] [H. sapiens] |
| 3053 | 320 | AA997726 | H | | ESTs, Highly similar to RRP5_HUMAN |
| | | | | | RRP5 protein homolog (Fragment) |
| | | | | | [H. sapiens] |
| 10069 | 452 | AI058503 | F | | ESTs, Moderately similar to |
| | | | | | Y247_HUMAN Hypothetical protein |
| | | | | | KIAA0247 [H. sapiens] |
| 22490 | 206 | AA899289 | A | | ESTs, Moderately similar to KIAA1049 |
| | | | | | protein [Homo sapiens] [H. sapiens] |
| 21653 | 753 | AI237535 | GENERAL, | LPS-induced TNF-alpha | LPS-induced TNF-alpha factor |
| | | | C, K | factor | |
| 21654 | 1221 | U53184 | GENERAL, | LPS-induced TNF-alpha | LPS-induced TNF-alpha factor |
| | | | I, L | factor | |
| 8317 | 149 | AA892234 | GENERAL | | ESTs, Moderately similar to microsomal |
| | | | | | glutathione S-transferase 3; microsomal |
| | | | | | glutathione S-transferase III [Homo |
| | | | | | sapiens] [H. sapiens] |
| 17923 | 178 | AA892843 | D | | ESTs, Moderately similar to hypothetical |
| | | | | | protein FLJ20917 [Homo sapiens] |
| | | | | | [H. sapiens] |
| 20866 | 236 | AA926098 | J | | ESTs, Moderately similar to |
| | | | | | mitochondrial ribosomal protein L53 |
| | | | | | [Homo sapiens] [H. sapiens] |
| 21672 | 132 | AA891789 | C, D | | ESTs, Highly similar to MRGX_HUMAN |
| | | | | | Transcription factor-like protein MRGX |
| | | | | | (MORF-related gene X protein) |
| | | | | | [H. sapiens] |
| 16881 | 190 | AA893185 | J | | ESTs, Moderately similar to NADH |
| | | | | | dehydrogenase (ubiquinone) 1 beta |
| | | | | | subcomplex, 5 (16 kD, SGDH) [Homo |
| | | | | | sapiens] [H. sapiens] |
| 18509 | 526 | AI104528 | A | | ESTs, Weakly similar to NADH |
| | | | | | dehydrogenase (ubiquinone) 1 beta |
| | | | | | subcomplex, 6 (17 kD, B17) [Homo |
| | | | | | sapiens] [H. sapiens] |
| 3099 | 664 | AI229680 | E | HHs: NADH dehydrogenase | ESTs, Moderately similar to NADH |
| | | | | (ubiquinone) Fe—S protein 3 | dehydrogenase (ubiquinone) Fe—S |
| | | | | (30 kD) (NADH-coenzyme Q | protein 3 (30 kD) (NADH-coenzyme Q |
| | | | | reductase) | reductase) [Homo sapiens] [H. sapiens] |
| 23843 | 296 | AA957410 | D | | ESTs, Highly similar to NCK adaptor |
| | | | | | protein 2 [Homo sapiens] [H. sapiens] |
| 3874 | 419 | AI029428 | GENERAL, I | | ESTs, Highly similar to S50082 nuclear |
| | | | | | cap binding protein - human [H. sapiens] |
| 3875 | 727 | AI235047 | GENERAL, A | | ESTs, Highly similar to S50082 nuclear |
| | | | | | cap binding protein - human [H. sapiens] |
| 13111 | 553 | AI137224 | GENERAL | | ESTs, Weakly similar to T02435 probable |
| | | | | | oxysterol-binding protein DJ430N08.1 - |
| | | | | | human (fragment) [H. sapiens] |
| 7270 | 406 | AI013564 | D | | ESTs, Highly similar to PEST-containing |
| | | | | | nuclear protein [Homo sapiens] |
| | | | | | [H. sapiens] |
| 7888 | 715 | AI233583 | GENERAL | | ESTs, Highly similar to SYR_HUMAN |
| | | | | | ARGINYL-TRNA SYNTHETASE |
| | | | | | (ARGININE—TRNA LIGASE) (ARGRS) |
| | | | | | [H. sapiens], ESTs, Moderately similar to |
| | | | | | JC4365 arginine-tRNA ligase (EC |
| | | | | | 6.1.1.19) - human [H. sapiens] |
| 235 | 978 | NM_019347 | C | Rattus norvegicus solute | Urea transporter |
| | | | | carrier family 14, member 2 | |
| | | | | (Slc14a2), mRNA. Length = 3974 | |
| 17514 | 232 | AA925554 | E, G | succinate dehydrogenase | succinate dehydrogenase complex, |
| | | | | complex, subunit A, | subunit A, flavoprotein (Fp) |
| | | | | flavoprotein (Fp) | |
| 12031 | 201 | AA893860 | GENERAL, I | HHs: threonyl-tRNA | ESTs, Moderately similar to |
| | | | | synthetase | SYTC_HUMAN Threonyl-tRNA |
| | | | | | synthetase, cytoplasmic (Threonine - |
| | | | | | tRNA ligase) (ThrRS) [H. sapiens] |
| 16469 | 160 | AA892462 | A, C | | ESTs, Moderately similar to |
| | | | | | UCRY_HUMAN Ubiquinol-cytochrome C |
| | | | | | reductase complex 6.4 kDa protein |
| | | | | | (Complex III subunit XI) [H. sapiens] |
| 16468 | 238 | AA926137 | A | | ESTs, Moderately similar to |
| | | | | | UCRY_HUMAN Ubiquinol-cytochrome C |
| | | | | | reductase complex 6.4 kDa protein |
| | | | | | (Complex III subunit XI) [H. sapiens] |
| 15576 | 148 | AA892132 | J | | ESTs, Moderately similar to |
| | | | | | uncharacterized hematopoietic |
| | | | | | stem/progenitor cells protein MDS032 |
| | | | | | [Homo sapiens] [H. sapiens] |
| 15409 | 1182 | NM_057197 | L | Rattus norvegicus 2,4- | 2,4-dienoyl CoA reductase 1, |
| | | | | dienoyl CoA reductase 1, | mitochondrial |
| | | | | mitochondrial (Decr1), | |
| | | | | mRNA. Length = 1109 | |
| 22602 | 341 | AF044574 | GENERAL | putative peroxisomal 2,4- | putative peroxisomal 2,4-dienoyl-CoA |
| | | | | dienoyl-CoA reductase | reductase |
| 20493 | 988 | NM_020076 | GENERAL | Rattus norvegicus 3- | 3-hydroxyanthranilate 3,4-dioxygenase |
| | | | | hydroxyanthranilate 3,4- | |
| | | | | dioxygenase (Haao), mRNA. | |
| | | | | Length = 1254 | |
| 20494 | 988 | NM_020076 | E | Rattus norvegicus 3- | 3-hydroxyanthranilate 3,4-dioxygenase |
| | | | | hydroxyanthranilate 3,4- | |
| | | | | dioxygenase (Haao), mRNA. | |
| | | | | Length = 1254 | |
| 21950 | 412 | AI013861 | G | 3-hydroxyisobutyrate | 3-hydroxyisobutyrate dehydrogenase |
| | | | | dehydrogenase | |
| 1527 | 934 | NM_017220 | B | Rattus norvegicus 6-pyruvoyl- | 6-pyruvoyl-tetrahydropterin synthase |
| | | | | tetrahydropterin synthase | |
| | | | | (Pts), mRNA. Length = 1176 | |
| 13485 | 989 | NM_020306 | B | Rattus norvegicus a | a disintegrin and metalloproteinase |
| | | | | disintegrin and | domain 17 |
| | | | | metalloproteinase domain 17 | |
| | | | | (Adam17), mRNA. Length = 4128 | |
| 2153 | 1227 | U75404 | GENERAL, L | A kinase (PRKA) anchor | A kinase (PRKA) anchor protein (gravin) |
| | | | | protein (gravin) 12 | 12 |
| 17516 | 950 | NM_017321 | A, E, L | Rattus norvegicus iron- | iron-responsive element-binding protein |
| | | | | responsive element-binding | |
| | | | | protein (Ratireb), mRNA. | |
| | | | | Length = 3564 | |
| 19991 | 1169 | NM_053961 | K | Rattus norvegicus | mitochondrial aconitase (nuclear aco2 |
| | | | | endoplasmic retuclum protein | gene) |
| | | | | 29 (Erp29), mRNA. Length = 4529 | |
| 16708 | 864 | NM_012895 | GENERAL | Rattus norvegicus Adenosin | Adenosin kinase |
| | | | | kinase (Adk), mRNA. Length = 1086 | |
| 15032 | 852 | NM_012816 | GENERAL, | Rattus norvegicus alpha- | alpha-methylacyl-CoA racemase |
| | | | A, H, I, K, L | methylacyl-CoA racemase | |
| | | | | (Amacr), mRNA. Length = 1504 | |
| 18564 | 865 | NM_012899 | GENERAL | Rattus norvegicus | aminolevulinate, delta-, dehydratase |
| | | | | aminolevulinate, delta-, | |
| | | | | dehydratase (Alad), mRNA. | |
| | | | | Length = 1116 | |
| 21038 | 1042 | NM_024484 | H | Rattus norvegicus | aminolevulinic acid synthase 1 |
| | | | | aminolevulinic acid synthase | |
| | | | | 1 (Alas1), mRNA. Length = 2052 | |
| 21039 | 1042 | NM_024484 | H | Rattus norvegicus | aminolevulinic acid synthase 1 |
| | | | | aminolevulinic acid synthase | |
| | | | | 1 (Alas1), mRNA. Length = 2052 | |
| 2079 | 966 | NM_019220 | F | Rattus norvegicus amino- | amino-terminal enhancer of split |
| | | | | terminal enhancer of split | |
| | | | | (Aes), mRNA. Length = 1356 | |
| 744 | 983 | NM_019622 | GENERAL | Rattus norvegicus espin | espin |
| | | | | (Espn), mRNA. Length = 2786 | |
| 7196 | 867 | NM_012904 | GENERAL, | Rattus norvegicus Annexin 1 | Annexin 1 (p35) (Lipocortin 1) |
| | | | E, G, K | (p35) (Lipocortin 1) (Anxa1), | |
| | | | | mRNA. Length = 1402 | |
| 7197 | 867 | NM_012904 | GENERAL, | Rattus norvegicus Annexin 1 | Annexin 1 (p35) (Lipocortin 1) |
| | | | G, K, L | (p35) (Lipocortin 1) (Anxa1), | |
| | | | | mRNA. Length = 1402 | |
| 21391 | 1192 | NM_130416 | GENERAL, K | Rattus norvegicus annexin | annexin A7 |
| | | | | A7 (Anxa7), mRNA. Length = 2912 | |
| 16649 | 891 | NM_013132 | GENERAL, E | Rattus norvegicus Annexin V | Annexin V |
| | | | | (Anx5), mRNA. Length = 1417 | |
| 16650 | 891 | NM_013132 | E | Rattus norvegicus Annexin V | Annexin V |
| | | | | (Anx5), mRNA. Length = 1417 | |
| 20801 | 1033 | NM_024148 | GENERAL, | Rattus norvegicus | apurinic/apyrimidinic endonuclease 1 |
| | | | H, I, J, L | apurinic/apyrimidinic | |
| | | | | endonuclease 1 (Apex1), | |
| | | | | mRNA. Length = 1213 | |
| 20173 | 959 | NM_019136 | C | Rattus norvegicus | Vasopressin receptor V2 |
| | | | | Vasopressin receptor V2 | |
| | | | | (Avpr2), mRNA. Length = 1116 | |
| 20725 | 1149 | NM_053602 | A | Rattus norvegicus ATP | ATP synthase, H+ transporting, |
| | | | | synthase, H+ transporting, | mitochondrial F0 complex, subunit F6 |
| | | | | mitochondrial F0 complex, | |
| | | | | subunit F6 (Atp5j), mRNA. | |
| | | | | Length = 573 | |
| 18449 | 1204 | U00926 | H | ATP synthase, H+ | ATP synthase, H+ transporting, |
| | | | | transporting, mitochondrial | mitochondrial F1 complex, delta subunit |
| | | | | F1 complex, delta subunit | |
| 16907 | 35 | AA817977 | C | | ESTs, Weakly similar to VATC_MOUSE |
| | | | | | Vacuolar ATP synthase subunit C (V- |
| | | | | | ATPase C subunit) (Vacuolar proton |
| | | | | | pump C subunit) [M. musculus] |
| 15701 | 1187 | NM_080581 | A, I | Rattus norvegicus ATP- | ATP-binding cassette, sub-family C |
| | | | | binding cassette, sub-family | (CFTR/MRP), member 3 |
| | | | | C (CFTR/MRP), member 3 | |
| | | | | (Abcc3), mRNA. Length = 5174 | |
| 9176 | 490 | AI072675 | A | | ESTs, Highly similar to TO1A_MOUSE |
| | | | | | Torsin A precursor [M. musculus] |
| 20582 | 93 | AA859688 | A, E, F, K | | ESTs, Highly similar to AU RNA-binding |
| | | | | | enoyl-coenzyme A hydratase; AU RNA- |
| | | | | | binding protein/enoyl-coenzyme A |
| | | | | | hydratase [Mus musculus] [M. musculus] |
| 21562 | 1185 | NM_078623 | A | Rattus norvegicus Enoyl-CoA | Enoyl-CoA hydratase, short chain 1, |
| | | | | hydratase, short chain 1, | mitochondrial |
| | | | | mitochondrial (Echs1), | |
| | | | | mRNA. Length = 1454 | |
| 5565 | 1153 | NM_053618 | GENERAL, C | Rattus norvegicus Bardet- | Bardet-Biedl syndrome 2 (human) |
| | | | | Biedl syndrome 2 (human) | |
| | | | | (Bbs2), mRNA. Length = 2573 | |
| 15299 | 942 | NM_017259 | GENERAL, | Rattus norvegicus B-cell | Early induced gene, B-cell translocation |
| | | | I, J | translocation gene 2, anti- | gene 2 |
| | | | | proliferative (Btg2), mRNA. | |
| | | | | Length = 2519 | |
| 15300 | 942 | NM_017259 | GENERAL | Rattus norvegicus B-cell | Early induced gene, B-cell translocation |
| | | | | translocation gene 2, anti- | gene 2 |
| | | | | proliferative (Btg2), mRNA. | |
| | | | | Length = 2519 | |
| 23679 | 974 | NM_019290 | C, L | Rattus norvegicus B-cell | B-cell translocation gene 3 |
| | | | | translocation gene 3 (Btg3), | |
| | | | | mRNA. Length = 1259 | |
| 23033 | 1188 | NM_080888 | A, C, K | Rattus norvegicus | BCL2/adenovirus E1B 19 kDa-interacting |
| | | | | BCL2/adenovirus E1B 19 kDa- | protein 3-like |
| | | | | interacting protein 3-like | |
| | | | | (Bnip3l), mRNA. Length = 3219 | |
| 15171 | 690 | AI231792 | H | | ESTs, Highly similar to BAG3_MOUSE |
| | | | | | BAG-family molecular chaperone |
| | | | | | regulator-3 (BCL-2 binding athanogene- |
| | | | | | 3) (BAG-3) (Bcl-2-binding protein Bis) |
| | | | | | [M. musculus] |
| 17824 | 54 | AA819362 | A | | ESTs, Highly similar to hypothetical |
| | | | | | protein MGC7474 [Mus musculus] |
| | | | | | [M. musculus] |
| 17823 | 76 | AA851214 | D | | ESTs, Highly similar to hypothetical |
| | | | | | protein MGC7474 [Mus musculus] |
| | | | | | [M. musculus] |
| 1888 | 1177 | NM_057130 | B | Rattus norvegicus BH3 | BH3 interacting (with BCL2 family) |
| | | | | interacting (with BCL2 family) | domain, apoptosis agonist |
| | | | | domain, apoptosis agonist | |
| | | | | (Bid3), mRNA. Length = 5253 | |
| 439 | 854 | NM_012827 | F | Rattus norvegicus Bone | Bone morphogenetic protein 4 |
| | | | | morphogenetic protein 4 | |
| | | | | (Bmp4), mRNA. Length = 1758 | |
| 15035 | 855 | NM_012836 | B | Rattus norvegicus | Carboxypeptidase D precursor |
| | | | | Carboxypeptidase D | |
| | | | | precursor (Cpd), mRNA. | |
| | | | | Length = 4377 | |
| 20555 | 1120 | NM_031987 | F | Rattus norvegicus carnitine | carnitine O-octanoyltransferase |
| | | | | O-octanoyltransferase (Crot), | |
| | | | | mRNA. Length = 2681 | |
| 1977 | 870 | NM_012930 | L | Rattus norvegicus Carnitine | Carnitine palmitoyltransferase 2 |
| | | | | palmitoyltransferase 2 | |
| | | | | (Cpt2), mRNA. Length = 2296 | |
| 16116 | 1105 | NM_031775 | F | Rattus norvegicus caspase 6 | caspase 6 |
| | | | | (Casp6), mRNA. Length = 1446 | |
| 24672 | 810 | M34097 | C | | Rat natural killer (NK) cell protease 1 |
| | | | | | (RNKP-1) mRNA, complete cds |
| 1894 | 949 | NM_017320 | B, L | Rattus norvegicus cathepsin | cathepsin S |
| | | | | S (Ctss), mRNA. Length = 1330 | |
| 21239 | 1029 | NM_024125 | GENERAL, | Rattus norvegicus Liver | Liver activating protein (LAP, also NF- |
| | | | H, I | activating protein (LAP, also | IL6, nuclear factor-IL6, previously |
| | | | | NF-IL6, nuclear factor-IL6, | designated TCF5) |
| | | | | previously designated TCF5) | |
| | | | | (Cebpb), mRNA. Length = 1408 | |
| 21683 | 896 | NM_013154 | GENERAL, | Rattus norvegicus | CCAAT/enhancerbinding, protein |
| | | | C, I, L | CCAAT/enhancerbinding, | (C/EBP) delta |
| | | | | protein (C/EBP) delta | |
| | | | | (Cebpd), mRNA. Length = 1200 | |
| 21651 | 975 | NM_019296 | E | Rattus norvegicus Cell | Cell division cycle control protein 2 |
| | | | | division cycle control protein | |
| | | | | 2 (Cdc2a), mRNA. Length = 1184 | |
| 19936 | 1071 | NM_031357 | D | Rattus norvegicus ceroid- | ceroid-lipofuscinosis, neuronal 2 |
| | | | | lipofuscinosis, neuronal 2 | |
| | | | | (Cln2), mRNA. Length = 2485 | |
| 17154 | 1161 | NM_053835 | J | Rattus norvegicus clathrin, | clathrin, light polypeptide (Lcb) |
| | | | | light polypeptide (Lcb) (Cltb), | |
| | | | | mRNA. Length = 982 | |
| 20404 | 1094 | NM_031700 | L | Rattus norvegicus claudin 3 | claudin 3 |
| | | | | (Cldn3), mRNA. Length = 1192 | |
| 20405 | 1094 | NM_031700 | B | Rattus norvegicus claudin 3 | claudin 3 |
| | | | | (Cldn3), mRNA. Length = 1192 | |
| 15364 | 921 | NM_017147 | J | Rattus norvegicus cofilin 1, | cofilin 1, non-muscle |
| | | | | non-muscle (Cfl1), mRNA. | |
| | | | | Length = 1039 | |
| 15851 | 1219 | U42719 | GENERAL | Complement component 4 | Complement component 4 |
| 2782 | 326 | AA998565 | J | | ESTs, Moderately similar to |
| | | | | | CDNC_MOUSE CYCLIN-DEPENDENT |
| | | | | | KINASE INHIBITOR 1C (CYCLIN- |
| | | | | | DEPENDENT KINASE INHIBITOR P57) |
| | | | | | (P57KIP2) [M. musculus] |
| 291 | 822 | NM_012522 | GENERAL, F | Rattus norvegicus | Cystathionine beta synthase |
| | | | | Cystathionine beta synthase | |
| | | | | (Cbs), mRNA. Length = 2363 | |
| 19003 | 1189 | NM_080903 | F | Rattus norvegicus ring finger | ring finger protein 28 |
| | | | | protein 28 (Rnf28), mRNA. | |
| | | | | Length = 1861 | |
| 15028 | 1129 | NM_052809 | F | Rattus norvegicus cytosolic | cytosolic cysteine dioxygenase 1 |
| | | | | cysteine dioxygenase 1 | |
| | | | | (Cdo1), mRNA. Length = 1458 | |
| 4234 | 1068 | NM_031330 | K | Rattus norvegicus | heterogeneous nuclear ribonucleoprotein |
| | | | | heterogeneous nuclear | A/B |
| | | | | ribonucleoprotein A/B | |
| | | | | (Hnrpab), mRNA. Length = 3061 | |
| 4235 | 1068 | NM_031330 | GENERAL, | Rattus norvegicus | heterogeneous nuclear ribonucleoprotein |
| | | | H, K, L | heterogeneous nuclear | A/B |
| | | | | ribonucleoprotein A/B | |
| | | | | (Hnrpab), mRNA. Length = 3061 | |
| 17226 | 1031 | NM_024131 | C, E | Rattus norvegicus D- | D-dopachrome tautomerase |
| | | | | dopachrome tautomerase | |
| | | | | (Ddt), mRNA. Length = 628 | |
| 17227 | 1031 | NM_024131 | E | Rattus norvegicus D- | D-dopachrome tautomerase |
| | | | | dopachrome tautomerase | |
| | | | | (Ddt), mRNA. Length = 628 | |
| 4327 | 1144 | NM_053563 | GENERAL, | Rattus norvegicus nuclear | nuclear RNA helicase, DECD variant of |
| | | | G, I | RNA helicase, DECD variant | DEAD box family |
| | | | | of DEAD box family (Ddxl), | |
| | | | | mRNA. Length = 1511 | |
| 24459 | 1183 | NM_057209 | C | Rattus norvegicus myosin | myosin light chain kinase 2, skeletal |
| | | | | light chain kinase 2, skeletal | muscle |
| | | | | muscle (Mylk2), mRNA. | |
| | | | | Length = 2799 | |
| 4504 | 1035 | NM_024159 | D | Rattus norvegicus DOC-2 | disabled homolog 2, mitogen-responsive |
| | | | | p82 isoform (Dab2), mRNA. | phosphoprotein (Drosophila) |
| | | | | Length = 3170 | |
| 14267 | 389 | AI011738 | A | | ESTs, Highly similar to P044_RAT 0-44 |
| | | | | | protein [R. norvegicus] |
| 18713 | 987 | NM_020075 | L | Rattus norvegicus eukaryotic | eukaryotic initiation factor 5 (eIF-5) |
| | | | | initiation factor 5 (eIF-5) | |
| | | | | (Eif5), mRNA. Length = 3504 | |
| 18716 | 987 | NM_020075 | F | Rattus norvegicus eukaryotic | eukaryotic initiation factor 5 (eIF-5) |
| | | | | initiation factor 5 (eIF-5) | |
| | | | | (Eif5), mRNA. Length = 3504 | |
| 21157 | 271 | AA946189 | I | | ESTs, Moderately similar to |
| | | | | | RGP1_MOUSE Ran-GTPase activating |
| | | | | | protein 1 [M. musculus] |
| 19834 | 1179 | NM_057139 | E | Rattus norvegicus | transporter protein; system N1 Na+ and |
| | | | | transporter protein; system | H+-coupled glutamine transporter |
| | | | | N1 Na+ and H+-coupled | |
| | | | | glutamine transporter | |
| | | | | (Hnrpu), mRNA. Length = 3563 | |
| 23868 | 825 | NM_012551 | GENERAL, L | Rattus norvegicus Early | Early growth response 1 |
| | | | | growth response 1 (Egr1), | |
| | | | | mRNA. Length = 3112 | |
| 23869 | 825 | NM_012551 | L | Rattus norvegicus Early | Early growth response 1 |
| | | | | growth response 1 (Egr1), | |
| | | | | mRNA. Length = 3112 | |
| 23872 | 825 | NM_012551 | GENERAL | Rattus norvegicus Early | Early growth response 1 |
| | | | | growth response 1 (Egr1), | |
| | | | | mRNA. Length = 3112 | |
| 20865 | 795 | L00117 | GENERAL | Elastase 1 | Elastase 1 |
| 17268 | 686 | AI231317 | F | | ESTs, Highly similar to endothelial- |
| | | | | | derived gene [Mus musculus] |
| | | | | | [M. musculus] |
| 23194 | 159 | AA892417 | GENERAL | ephrin A1 | ephrin A1 |
| 21509 | 1044 | NM_030847 | G | Rattus norvegicus epithelial | epithelial membrane protein 3 |
| | | | | membrane protein 3 (Emp3), | |
| | | | | mRNA. Length = 737 | |
| 17541 | 858 | NM_012844 | GENERAL, | Rattus norvegicus Epoxide | Epoxide hydrolase 1 (microsomal |
| | | | A, B, H, I | hydrolase 1 (microsomal | xenobiotic hydrolase) |
| | | | | xenobiotic hydrolase) | |
| | | | | (Ephx1), mRNA. Length = 1242 | |
| 2465 | 812 | M59814 | G, K | Eph receptor B2 (ELK- | Eph receptor B2 (ELK-related protein |
| | | | | related protein tyrosine | tyrosine kinase) |
| | | | | kinase) | |
| 10015 | 973 | NM_019289 | GENERAL, | Rattus norvegicus Actin- | Actin-related protein complex 1b |
| | | | G, K | related protein complex 1b | |
| | | | | (Arpc1b), mRNA. Length = 1430 | |
| 10016 | 973 | NM_019289 | GENERAL, G | Rattus norvegicus Actin- | Actin-related protein complex 1b |
| | | | | related protein complex 1b | |
| | | | | (Arpc1b), mRNA. Length = 1430 | |
| 1246 | 847 | NM_012770 | GENERAL, J | Rattus norvegicus Guanylate | Guanylate cyclase, soluble, beta 2 (GTP |
| | | | | cyclase, soluble, beta 2 (GTP | pyrophosphate —lyase) |
| | | | | pyrophosphate - lyase) | |
| | | | | (Gucy1b2), mRNA. Length = 2335 | |
| 6405 | 801 | L38615 | G | Glutathione synthetase gene | Glutathione synthetase gene |
| 15850 | 749 | AI236795 | K | | ESTs, ESTs, Highly similar to HS9B_RAT |
| | | | | | Heat shock protein HSP 90-beta (HSP |
| | | | | | 84) [R. norvegicus] |
| 6758 | 405 | AI013394 | B, L | heparan sulfate | heparan sulfate (glucosamine) 3-O- |
| | | | | (glucosamine) 3-O- | sulfotransferase 1 |
| | | | | sulfotransferase 1 | |
| 16967 | 895 | NM_013146 | E | Rattus norvegicus | Caldesmon 1 |
| | | | | Caldesmon 1 (Cald1), | |
| | | | | mRNA. Length = 5541 | |
| 17198 | 828 | NM_012593 | G | Rattus norvegicus Kallikrein | Kallikrein 1, renal/pancreas/salivary |
| | | | | 1, renal/pancreas/salivary | |
| | | | | (Klk1), mRNA. Length = 786 | |
| 17684 | 154 | AA892345 | GENERAL, I | dimethylglycine | dimethylglycine dehydrogenase |
| | | | | dehydrogenase precursor | precursor |
| 1535 | 331 | AB000778 | F | Phoshpolipase D gene 1 | Phoshpolipase D gene 1 |
| 23115 | 29 | AA801165 | A, F | Testis-specific histone 2a | Testis-specific histone 2a |
| 25702 | 1244 | X58465 | G | Ribosomal protein S5 | Ribosomal protein S5 |
| 10109 | 1244 | X58465 | G | Ribosomal protein S5 | Ribosomal protein S5 |
| 15185 | 1062 | NM_031140 | GENERAL | Rattus norvegicus vimentin | vimentin |
| | | | | (Vim), mRNA. Length = 1796 | |
| 1509 | 962 | NM_019157 | A | Rattus norvegicus aquaporin | aquaporin 7 |
| | | | | 7 (Aqp7), mRNA. Length = 1267 | |
| 17907 | 708 | AI233224 | GENERAL | Epidermal growth factor | Epidermal growth factor receptor, |
| | | | | receptor, formerly avian | formerly avian erythroblastic leukemia |
| | | | | erythroblastic leukemia viral | viral (v-erbB) oncogene homolog (Erbb1) |
| | | | | (v-erbB) oncogene homolog | |
| | | | | (Erbb1) | |
| 16476 | 1036 | NM_024162 | GENERAL, L | Rattus norvegicus heart fatty | Fatty acid binding protein 3, muscle and |
| | | | | acid binding protein (Fabp3), | heart |
| | | | | mRNA. Length = 666 | |
| 20711 | 905 | NM_016999 | L | Rattus norvegicus | Cytochrome P450, subfamily IVB, |
| | | | | Cytochrome P450, subfamily | polypeptide 1 |
| | | | | IVB, polypeptide 1 (Cyp4b1), | |
| | | | | mRNA. Length = 2462 | |
| 20713 | 905 | NM_016999 | J, L | Rattus norvegicus | Cytochrome P450, subfamily IVB, |
| | | | | Cytochrome P450, subfamily | polypeptide 1 |
| | | | | IVB, polypeptide 1 (Cyp4b1), | |
| | | | | mRNA. Length = 2462 | |
| 20714 | 905 | NM_016999 | J, L | Rattus norvegicus | Cytochrome P450, subfamily IVB, |
| | | | | Cytochrome P450, subfamily | polypeptide 1 |
| | | | | IVB, polypeptide 1 (Cyp4b1), | |
| | | | | mRNA. Length = 2462 | |
| 20715 | 905 | NM_016999 | L | Rattus norvegicus | Cytochrome P450, subfamily IVB, |
| | | | | Cytochrome P450, subfamily | polypeptide 1 |
| | | | | IVB, polypeptide 1 (Cyp4b1), | |
| | | | | mRNA. Length = 2462 | |
| 989 | 976 | NM_019318 | D, F | Rattus norvegicus v-maf | v-maf musculoaponeurotic fibrosarcoma |
| | | | | musculoaponeurotic | (avian) oncogene homolog (c-maf) |
| | | | | fibrosarcoma (avian) | |
| | | | | oncogene homolog (c-maf) | |
| | | | | (Maf), mRNA. Length = 1944 | |
| 1447 | 944 | NM_017281 | D | Rattus norvegicus | proteasome (prosome, macropain) |
| | | | | proteasome (prosome, | subunit, alpha type 4 |
| | | | | macropain) subunit, alpha | |
| | | | | type 4 (Psma4), mRNA. | |
| | | | | Length = 1121 | |
| 1857 | 1064 | NM_031315 | L | Rattus norvegicus acyl-CoA | acyl-CoA thioesterase 1, cytosolic |
| | | | | thioesterase 1, cytosolic | |
| | | | | (Cte1), mRNA. Length = 1591 | |
| 11849 | 1052 | NM_031065 | GENERAL, G | Rattus norvegicus ribosomal | ribosomal protein L10a |
| | | | | protein L10a (Rpl10a), | |
| | | | | mRNA. Length = 710 | |
| 17104 | 924 | NM_017160 | GENERAL, G | Rattus norvegicus ribosomal | ribosomal protein S6 |
| | | | | protein S6 (Rps6), mRNA. | |
| | | | | Length = 801 | |
| 21575 | 1093 | NM_031698 | J | Rattus norvegicus ribophorin | ribophorin II |
| | | | | II (Rpn2), mRNA. Length = 2234 | |
| 17175 | 1243 | X58389 | GENERAL | | R. norvegicus ASI mRNA for mammalian |
| | | | | | equivalent of bacterial large ribosomal |
| | | | | | subunit protein L22 |
| 24108 | 679 | AI230728 | G | | ESTs, Highly similar to S42114 small |
| | | | | | nuclear ribonucleoprotein U1A - mouse |
| | | | | | [M. musculus] |
| 15191 | 608 | AI176456 | GENERAL, | | ESTs, Highly similar to SMRT2 |
| | | | F, L | | metallothionein II - rat [R. norvegicus] |
| 21491 | 1027 | NM_022951 | B | Rattus norvegicus putative | putative protein phosphatase 1 nuclear |
| | | | | protein phosphatase 1 | targeting subunit |
| | | | | nuclear targeting subunit | |
| | | | | (Ppp1r10), mRNA. Length = 4131 | |
| 6917 | 1 | AA012709 | B | | ESTs, Highly similar to splicing factor 3b, |
| | | | | | subunit 1, 155 kDa [Mus musculus] |
| | | | | | [M. musculus] |
| 16204 | 1096 | NM_031706 | GENERAL, G | Rattus norvegicus ribosomal | ribosomal protein S8 |
| | | | | protein S8 (Rps8), mRNA. | |
| | | | | Length = 696 | |
| 16205 | 1096 | NM_031706 | F | Rattus norvegicus ribosomal | ribosomal protein S8 |
| | | | | protein S8 (Rps8), mRNA. | |
| | | | | Length = 696 | |
| 15135 | 1170 | NM_053971 | G | Rattus norvegicus ribosomal | ribosomal protein L6 |
| | | | | protein L6 (Rpl6), mRNA. | |
| | | | | Length = 963 | |
| 3995 | 388 | AI011678 | GENERAL, | Ryudocan/syndecan 2 | Ryudocan/syndecan 2 |
| | | | I, K | | |
| 1529 | 884 | NM_013082 | GENERAL, | Rattus norvegicus | Ryudocan/syndecan 2 |
| | | | B, F, I | Ryudocan/syndecan 2 | |
| | | | | (Sdc2), mRNA. Length = 2153 | |
| 22321 | 1109 | NM_031832 | GENERAL, | Rattus norvegicus IgE | lectin, galactose binding, soluble 3 |
| | | | B, G, L | binding protein (Lgals3), | |
| | | | | mRNA. Length = 948 | |
| 13633 | 1041 | NM_024403 | GENERAL | Rattus norvegicus activating | activating transcription factor ATF-4 |
| | | | | transcription factor ATF-4 | |
| | | | | (Atf4), mRNA. Length = 1173 | |
| 13634 | 1041 | NM_024403 | GENERAL | Rattus norvegicus activating | activating transcription factor ATF-4 |
| | | | | transcription factor ATF-4 | |
| | | | | (Atf4), mRNA. Length = 1173 | |
| 17357 | 899 | NM_013183 | GENERAL, | Rattus norvegicus Meprin 1 | Meprin 1 beta |
| | | | F, G, I, L | beta (Mep1b), mRNA. Length = 2290 | |
| 16929 | 1056 | NM_031108 | G | Rattus norvegicus mRNA for | mRNA for ribosomal protein S9 |
| | | | | ribosomal protein S9 (Rps9), | |
| | | | | mRNA. Length = 688 | |
| 15653 | 1236 | X14210 | G | NADH ubiquinone | NADH ubiquinone oxidoreductase |
| | | | | oxidoreductase subunit B13 | subunit B13 |
| 19712 | 994 | NM_021745 | K | Rattus norvegicus farnesoid | nuclear receptor subfamily 1, group H, |
| | | | | X activated receptor | member 4 |
| | | | | (LOC60351), mRNA. Length = 2070 | |
| 24563 | 1026 | NM_022676 | G, K | Rattus norvegicus protein | protein phosphatase 1, regulatory |
| | | | | phosphatase 1, regulatory | (inhibitor) subunit 1A |
| | | | | (inhibitor) subunit 1A | |
| | | | | (Ppp1r1a), mRNA. Length = 619 | |
| 24564 | 1026 | NM_022676 | G, K | Rattus norvegicus protein | protein phosphatase 1, regulatory |
| | | | | phosphatase 1, regulatory | (inhibitor) subunit 1A |
| | | | | (inhibitor) subunit 1A | |
| | | | | (Ppp1r1a), mRNA. Length = 619 | |
| 24615 | 1057 | NM_031112 | D | Rattus norvegicus ribosomal | ribosomal protein S24 |
| | | | | protein S24 (Rps24), mRNA. | |
| | | | | Length = 466 | |
| 16676 | 762 | AI639082 | E | mini chromosome | mini chromosome maintenance deficient |
| | | | | maintenance deficient 6 (S. cerevisiae) | 6 (S. cerevisiae) |
| 16674 | 1208 | U17565 | E | mini chromosome | mini chromosome maintenance deficient |
| | | | | maintenance deficient 6 (S. cerevisiae) | 6 (S. cerevisiae) |
| 16675 | 1208 | U17565 | E | mini chromosome | mini chromosome maintenance deficient |
| | | | | maintenance deficient 6 (S. cerevisiae) | 6 (S. cerevisiae) |
| 13151 | 860 | NM_012862 | GENERAL | Rattus norvegicus Matrix Gla | Matrix Gla protein |
| | | | | protein (Mgp), mRNA. Length = 521 | |
| 24472 | 117 | AA875523 | L | | ESTs, Highly similar to MLES_RAT |
| | | | | | Myosin light chain alkali, smooth-muscle isoform |
| | | | | | (MLC3SM) [R. norvegicus] |
| 4532 | 958 | NM_019134 | J | Rattus norvegicus Solute | Solute carrier family 12, member 1 |
| | | | | carrier family 12, member 1 | (bumetanide-sensitive sodium- |
| | | | | (bumetanide-sensitive | [potassium]-chloride cotransporter) |
| | | | | sodium-[potassium]-chloride | |
| | | | | cotransporter) (Slc12a1), | |
| | | | | mRNA. Length = 4595 | |
| 1597 | 1151 | NM_053611 | L | Rattus norvegicus nuclear | nuclear proten 1 |
| | | | | proten 1 (Nupr1), mRNA. | |
| | | | | Length = 602 | |
| 14138 | 94 | AA859700 | GENERAL | HMm:protoporphyrinogen | ESTs, Highly similar to PPOX_MOUSE |
| | | | | oxidase | PROTOPORPHYRINOGEN OXIDASE |
| | | | | | (PPO) [M. musculus] |
| 5208 | 747 | AI236754 | G | pregnancy-induced growth | pregnancy-induced growth inhibitor |
| | | | | inhibitor | |
| 18606 | 1239 | X53504 | GENERAL | | ESTs, Highly similar to RL12_RAT 60S |
| | | | | | RIBOSOMAL PROTEIN L12 |
| | | | | | [R. norvegicus] |
| 6049 | 3 | AA685178 | F | | ESTs, Highly similar to T30827 nascent |
| | | | | | polypeptide-associated complex alpha |
| | | | | | chain, non-muscle splice form - mouse |
| | | | | | [M. musculus] |
| 11953 | 501 | AI102505 | A | cytochrome c oxidase, | cytochrome c oxidase, subunit VIIIa |
| | | | | subunit VIIIa | |
| 3987 | 943 | NM_017280 | GENERAL | Rattus norvegicus | proteasome (prosome, macropain) |
| | | | | proteasome (prosome, | subunit, alpha type 3 |
| | | | | macropain) subunit, alpha | |
| | | | | type 3 (Psma3), mRNA. | |
| | | | | Length = 897 | |
| 20876 | 910 | NM_017050 | J | Rattus norvegicus | Superoxide dismutase 1, soluble |
| | | | | Superoxide dismutase 1, | |
| | | | | soluble (Sod1), mRNA. | |
| | | | | Length = 650 | |
| 6059 | 632 | AI178245 | GENERAL, J | | ESTs, Moderately similar to T13963 |
| | | | | | formin related protein, lymphocyte |
| | | | | | specific - mouse [M. musculus] |
| 17159 | 787 | J00797 | GENERAL, | alpha-tubulin | alpha-tubulin |
| | | | G, K | | |
| 17161 | 1002 | NM_022298 | GENERAL | Rattus norvegicus alpha- | alpha-tubulin |
| | | | | tubulin (Tuba1), mRNA. | |
| | | | | Length = 1617 | |
| 13974 | 103 | AA860030 | GENERAL, F | | Rattus norvegicus mRNA for class I beta- |
| | | | | | tubulin, complete cds |
| 13973 | 334 | AB011679 | E | | Rattus norvegicus mRNA for class I beta- |
| | | | | | tubulin, complete cds |
| 15050 | 520 | AI103911 | I | HHs:ubiquinol-cytochrome c | ESTs, Highly similar to A32296 ubiquinol- |
| | | | | reductase, Rieske iron-sulfur | cytochrome-c reductase (EC 1.10.2.2) |
| | | | | polypeptide 1 | Rieske iron-sulfur protein precursor - rat |
| | | | | | (fragment) [R. norvegicus] |
| 16913 | 652 | AI228236 | E | | ESTs, Highly similar to neuronal protein |
| | | | | | 15.6 [Mus musculus] [M. musculus] |
| 1340 | 1098 | NM_031715 | B | Rattus norvegicus | phosphofructokinase, muscle |
| | | | | phosphofructokinase, muscle | |
| | | | | (Pfkm), mRNA. Length = 2757 | |
| 16684 | 882 | NM_013052 | GENERAL | Rattus norvegicus Tyrosine 3- | Tyrosine 3-monooxygenase/tryptophan 5- |
| | | | | monooxygenase/tryptophan | monooxygenase activation protein, eta |
| | | | | 5-monooxygenase activation | polypeptide |
| | | | | protein, eta polypeptide | |
| | | | | (Ywhah), mRNA. Length = 1689 | |
| 20082 | 771 | AI639488 | GENERAL, | HMm:transformed mouse | ESTs, Highly similar to A42772 mdm2 |
| | | | H, I, J | 3T3 cell double minute 2 | protein - rat (fragments) [R. norvegicus] |
| 45 | 904 | NM_016996 | GENERAL, | Rattus norvegicus Calcium- | Calcium-sensing receptor (hypocalciuric |
| | | | J, L | sensing receptor | hypercalcemia 1, severe neonatal |
| | | | | (hypocalciuric hypercalcemia | hyperparathyroidism) |
| | | | | 1, severe neonatal | |
| | | | | hyperparathyroidism) (Casr), | |
| | | | | mRNA. Length = 4113 | |
| 19268 | 1055 | NM_031104 | D | Rattus norvegicus ribosomal | ribosomal protein L22 |
| | | | | protein L22 (Rpl22), mRNA. | |
| | | | | Length = 465 | |
| 25279 | 877 | NM_013011 | C | Rattus norvegicus Tyrosine 3- | Tyrosine 3-monooxygenase/tryptophan 5- |
| | | | | monooxygenase/tryptophan | monooxygenase activation protein, zeta |
| | | | | 5-monooxygenase activation | polypeptide |
| | | | | protein, zeta polypeptide | |
| | | | | (Ywhaz), mRNA. Length = 1687 | |
| 17393 | 875 | NM_012992 | GENERAL | Rattus norvegicus | Nucleoplasmin-related protein (Nuclear |
| | | | | Nucleoplasmin-related | protein B23 |
| | | | | protein (Nuclear protein B23 | |
| | | | | (Npm1), mRNA. Length = 1232 | |
| 17394 | 875 | NM_012992 | GENERAL, L | Rattus norvegicus | Nucleoplasmin-related protein (Nuclear |
| | | | | Nucleoplasmin-related | protein B23 |
| | | | | protein (Nuclear protein B23 | |
| | | | | (Npm1), mRNA. Length = 1232 | |
| 4198 | 814 | M83143 | GENERAL, I | | Rat beta-galactoside-alpha 2,6- |
| | | | | | sialyltransferase mRNA |
| 4199 | 814 | M83143 | GENERAL | | Rat beta-galactoside-alpha 2,6- |
| | | | | | sialyltransferase mRNA |
| 1877 | 911 | NM_017052 | A, D, E | Rattus norvegicus Sorbitol | Sorbitol dehydrogenase |
| | | | | dehydrogenase (Sord), | |
| | | | | mRNA. Length = 1358 | |
| 21078 | 902 | NM_016986 | G | Rattus norvegicus Acyl- | Acyl-Coenzyme A dehydrogenase, C-4 to |
| | | | | Coenzyme A | C-12 straight-chain |
| | | | | dehydrogenase, C-4 to C-12 | |
| | | | | straight-chain (Acadm), | |
| | | | | mRNA. Length = 1866 | |
| 22626 | 1040 | NM_024400 | GENERAL, K | Rattus norvegicus a | a disintegrin and metalloproteinase with |
| | | | | disintegrin and | thrombospondin motifs 1 (ADAMTS-1) |
| | | | | metalloproteinase with | |
| | | | | thrombospondin motifs 1 | |
| | | | | (ADAMTS-1) (Adamts1), | |
| | | | | mRNA. Length = 4878 | |
| 19235 | 441 | AI045074 | GENERAL | | ESTs, Highly similar to BGAL_MOUSE |
| | | | | | Beta-galactosidase precursor (Lactase) |
| | | | | | (Acid beta-galactosidase) [M. musculus] |
| 13954 | 1168 | NM_053955 | GENERAL | Rattus norvegicus crystallin, | crystallin, mu |
| | | | | mu (Crym), mRNA. Length = 1227 | |
| 2242 | 1138 | NM_053433 | GENERAL, | Rattus norvegicus flavin- | flavin-containing monooxygenase 3 |
| | | | H, I, J | containing monooxygenase 3 | |
| | | | | (Fmo3), mRNA. Length = 2037 | |
| 1546 | 1231 | U85512 | GENERAL, G | GTP cyclohydrolase I | GTP cyclohydrolase I feedback |
| | | | | feedback regulatory protein | regulatory protein |
| 1409 | 1124 | NM_033349 | GENERAL, | Rattus norvegicus | Hydroxyacyl glutathione hydrolase |
| | | | A, C, E, F | Hydroxyacyl glutathione | |
| | | | | hydrolase (Hagh), mRNA. | |
| | | | | Length = 783 | |
| 5206 | 235 | AA925755 | E | Glutaminase | Glutaminase |
| 24211 | 540 | AI111853 | G | | ESTs, Highly similar to H33_HUMAN |
| | | | | | Histone H3.3 (H3.A) (H3.B) (H3.3Q) |
| | | | | | [M. musculus] |
| 15642 | 1172 | NM_053985 | GENERAL, | Rattus norvegicus H3 | H3 histone, family 3B |
| | | | F, J | histone, family 3B (H3f3b), | |
| | | | | mRNA. Length = 1107 | |
| 67 | 1085 | NM_031605 | B | Rattus norvegicus | cytochrome P450, 4a10 |
| | | | | cytochrome P450, 4a10 | |
| | | | | (Cyp4a10), mRNA. Length = 1957 | |
| 1764 | 1171 | NM_053974 | C | Rattus norvegicus eukaryotic | eukaryotic translation initiation factor 4E |
| | | | | translation initiation factor 4E | |
| | | | | (Eif4e), mRNA. Length = 1647 | |
| 21659 | 382 | AI010584 | D | | Rattus norvegicus interferon-inducible |
| | | | | | protein variant 10 mRNA, complete cds |
| 21657 | 1247 | X61381 | GENERAL | | Rattus norvegicus interferon-inducible |
| | | | | | protein variant 10 mRNA, complete cds |
| 1712 | 892 | NM_013138 | GENERAL | Rattus norvegicus Inositol 1, | Inositol 1,4,5-triphosphate receptor 3 |
| | | | | 4,5-triphosphate receptor 3 | |
| | | | | (ltpr3), mRNA. Length = 8806 | |
| 755 | 890 | NM_013126 | GENERAL | Rattus norvegicus | Diacylglycerol kinase 3 (gamma) |
| | | | | Diacylglycerol kinase 3 | |
| | | | | (gamma) (Dgkg), mRNA. | |
| | | | | Length = 3466 | |
| 18011 | 1082 | NM_031588 | GENERAL, H | Rattus norvegicus neuregulin | neuregulin 1 |
| | | | | 1 (Nrg1), mRNA. Length = 3272 | |
| 1081 | 1097 | NM_031712 | GENERAL, D | Rattus norvegicus PDZ | PDZ domain containing 1 |
| | | | | domain containing 1 (Pdzk1), | |
| | | | | mRNA. Length = 2005 | |
| 19998 | 1125 | NM_033352 | GENERAL | Rattus norvegicus ATP- | PDZ domain containing 1 |
| | | | | binding cassette, sub-family | |
| | | | | D (ALD), member 2 (Abcd2), | |
| | | | | mRNA. Length = 5531 | |
| 13369 | 1157 | NM_053742 | D | Rattus norvegicus | phosphotidylinositol transfer protein, beta |
| | | | | phosphotidylinositol transfer | |
| | | | | protein, beta (Pitpnb), | |
| | | | | mRNA. Length = 2680 | |
| 472 | 780 | D26111 | G | | R. norvegicus mRNA for chloride channel |
| | | | | | (putative) 2313 bp |
| 605 | 935 | NM_017221 | C | Rattus norvegicus sonic | sonic hedgehog homolog, (Drosophila) |
| | | | | hedgehog homolog, | |
| | | | | (Drosophila) (Shh), mRNA. | |
| | | | | Length = 1715 | |
| 16871 | 863 | NM_012887 | E | Rattus norvegicus | Thymopoietin (lamina associated |
| | | | | Thymopoietin (lamina | polypeptide 2) |
| | | | | associated polypeptide 2) | |
| | | | | (Tmpo), mRNA. Length = 3508 | |
| 14121 | 1202 | S82383 | I | | R. norvegicus mRNA for tropomyosin |
| | | | | | isoform 6 |
| 6055 | 831 | NM_012619 | GENERAL, D | Rattus norvegicus | Phenylalanine hydroxylase |
| | | | | Phenylalanine hydroxylase | |
| | | | | (Pah), mRNA. Length = 1998 | |
| 24438 | 817 | M85183 | GENERAL, | angiotensin/vasopressin | angiotensin/vasopressin receptor |
| | | | F, L | receptor | |
| 8984 | 1014 | NM_022539 | D | Rattus norvegicus initiation | methionine aminopeptidase 2 |
| | | | | factor 2 associated 67 kDa | |
| | | | | protein (Amp2), mRNA. | |
| | | | | Length = 1944 | |
| 19252 | 1145 | NM_053576 | H | Rattus norvegicus thiol- | peroxiredoxin 5 |
| | | | | specific antioxidant protein | |
| | | | | (Prdx5), mRNA. Length = 1414 | |
| 19254 | 1145 | NM_053576 | H | Rattus norvegicus thiol- | peroxiredoxin 5 |
| | | | | specific antioxidant protein | |
| | | | | (Prdx5), mRNA. Length = 1414 | |
| 17401 | 881 | NM_013043 | GENERAL, | Rattus norvegicus | Transforming growth factor beta |
| | | | B, G | Transforming growth factor | stimulated clone 22 |
| | | | | beta stimulated clone 22 | |
| | | | | (Tgfb1i4), mRNA. Length = 1666 | |
| 4449 | 827 | NM_012592 | B, G, K | Rattus norvegicus Isovaleryl | Isovaleryl Coenzyme A dehydrogenase |
| | | | | Coenzyme A dehydrogenase | |
| | | | | (Ivd), mRNA. Length = 2104 | |
| 4450 | 827 | NM_012592 | E | Rattus norvegicus Isovaleryl | Isovaleryl Coenzyme A dehydrogenase |
| | | | | Coenzyme A dehydrogenase | |
| | | | | (Ivd), mRNA. Length = 2104 | |
| 4451 | 827 | NM_012592 | GENERAL, F | Rattus norvegicus Isovaleryl | Isovaleryl Coenzyme A dehydrogenase |
| | | | | Coenzyme A dehydrogenase | |
| | | | | (Ivd), mRNA. Length = 2104 | |
| 645 | 977 | NM_019345 | G, K | Rattus norvegicus solute | solute carrier family 12, member 3 |
| | | | | carrier family 12, member 3 | |
| | | | | (Slc12a3), mRNA. Length = 4361 | |
| 646 | 977 | NM_019345 | G, K | Rattus norvegicus solute | solute carrier family 12, member 3 |
| | | | | carrier family 12, member 3 | |
| | | | | (Slc12a3), mRNA. Length = 4361 | |
| 17473 | 1132 | NM_053319 | GENERAL, K | Rattus norvegicus dynein, | dynein, cytoplasmic, light chain 1 |
| | | | | cytoplasmic, light chain 1 | |
| | | | | (Pin), mRNA. Length = 505 | |
| 1884 | 783 | D50695 | I | proteasome (prosome, | proteasome (prosome, macropain) 26S |
| | | | | macropain) 26S subunit, | subunit, ATPase, 4 |
| | | | | ATPase, 4 | |
| 2439 | 970 | NM_019277 | A, F | Rattus norvegicus SEC15 | SEC15 homolog (S. cerevisiae) |
| | | | | homolog (S. cerevisiae) | |
| | | | | (Sec15), mRNA. Length = 3059 | |
| 14346 | 1075 | NM_031533 | B, H | Rattus norvegicus | Rat UDP-glucuronosyltransferase mRNA, |
| | | | | Androsterone UDP- | complete cds |
| | | | | glucuronosyltransferase | |
| | | | | (Ugt2b2), mRNA. Length = 1593 | |
| 14633 | 1075 | NM_031533 | H | Rattus norvegicus | Androsterone UDP- |
| | | | | Androsterone UDP- | glucuronosyltransferase |
| | | | | glucuronosyltransferase | |
| | | | | (Ugt2b2), mRNA. Length = 1593 | |
| 14347 | 1075 | NM_031533 | H | Rattus norvegicus | Rat UDP-glucuronosyltransferase mRNA, |
| | | | | Androsterone UDP- | complete cds |
| | | | | glucuronosyltransferase | |
| | | | | (Ugt2b2), mRNA. Length = 1593 | |
| 17805 | 1117 | NM_031980 | B | Rattus norvegicus UDP- | UDP-glucuronosyltransferase |
| | | | | glucuronosyltransferase | |
| | | | | (Ugt2b12), mRNA. Length = 1846 | |
| 1537 | 1216 | U27518 | H | | Rattus norvegicus UDP- |
| | | | | | glucuronosyltransferase mRNA, complete |
| | | | | | cds |
| 15926 | 1150 | NM_053607 | D | Rattus norvegicus long-chain | long-chain fatty acid coenzyme A ligase 5 |
| | | | | fatty acid coenzyme A ligase | |
| | | | | 5 (Facl5), mRNA. Length = 2454 | |
| 18246 | 1003 | NM_022300 | B, F | Rattus norvegicus brain | brain acidic membrane protein |
| | | | | acidic membrane protein | |
| | | | | (Basp1), mRNA. Length = 1024 | |
| 23625 | 969 | NM_019269 | D | Rattus norvegicus solute | solute carrier family 22 (organic cation |
| | | | | carrier family 22 (organic | transporter), member 5 |
| | | | | cation transporter), member | |
| | | | | 5 (Slc22a5), mRNA. Length = 3037 | |
| 6416 | 1136 | NM_053380 | GENERAL, K | Rattus norvegicus solute | solute carrier family 34 (sodium |
| | | | | carrier family 34 (sodium | phosphate), member 2 |
| | | | | phosphate), member 2 | |
| | | | | (Slc34a2), mRNA. Length = 3950 | |
| 14978 | 622 | AI177386 | F | Protein tyrosine | Protein tyrosine phosphatase, receptor |
| | | | | phosphatase, receptor type, D | type, D |
| 1798 | 261 | AA945569 | GENERAL, D | | R. norvegicus alpha-1-macroglobulin |
| | | | | | mRNA, complete cds |
| 21977 | 1133 | NM_053329 | A, B | Rattus norvegicus insulin-like | insulin-like growth factor binding protein, |
| | | | | growth factor binding protein, | acid labile subunit |
| | | | | acid labile subunit (Igfals), | |
| | | | | mRNA. Length = 1812 | |
| 8426 | 338 | AF036335 | E, F | | Rattus norvegicus NonO/p54nrb homolog |
| | | | | | mRNA, partial cds |
| 22219 | 972 | NM_019286 | F | Rattus norvegicus Alcohol | Alcohol dehydrogenase (class I), alpha |
| | | | | dehydrogenase 3 (Adh3), | polypeptide |
| | | | | mRNA. Length = 1131 | |
| 1650 | 34 | AA817825 | A | Peptidylglycine alpha- | Peptidylglycine alpha-amidating |
| | | | | amidating monooxygenase | monooxygenase |
| 1644 | 121 | AA891068 | A, F | Peptidylglycine alpha- | Peptidylglycine alpha-amidating |
| | | | | amidating monooxygenase | monooxygenase |
| 1649 | 518 | AI103782 | F | Peptidylglycine alpha- | Peptidylglycine alpha-amidating |
| | | | | amidating monooxygenase | monooxygenase |
| 1651 | 651 | AI228068 | A, H | Peptidylglycine alpha- | Peptidylglycine alpha-amidating |
| | | | | amidating monooxygenase | monooxygenase |
| 1652 | 665 | AI229728 | A | Peptidylglycine alpha- | Peptidylglycine alpha-amidating |
| | | | | amidating monooxygenase | monooxygenase |
| 1653 | 719 | AI233806 | A | Peptidylglycine alpha- | Peptidylglycine alpha-amidating |
| | | | | amidating monooxygenase | monooxygenase |
| 15051 | 741 | AI236332 | GENERAL | | ESTs, Highly similar to S43429 diamine |
| | | | | | N-acetyltransferase (EC 2.3.1.57) - |
| | | | | | mouse [M. musculus] |
| 3430 | 897 | NM_013156 | GENERAL, | Rattus norvegicus Cathepsin | Cathepsin L |
| | | | G, I | L (Ctsl), mRNA. Length = 1386 | |
| 10378 | 709 | AI233300 | A | | ESTs, Moderately similar to |
| | | | | | CO5_MOUSE Complement C5 precursor |
| | | | | | (Hemolytic complement) [Contains: C5A |
| | | | | | anaphylatoxin] [M. musculus] |
| 20832 | 268 | AA946040 | A | | ESTs, Highly similar to COXG_MOUSE |
| | | | | | Cytochrome c oxidase polypeptide VIb |
| | | | | | (AED) [M. musculus] |
| 20833 | 524 | AI104035 | A | | ESTs, Highly similar to COXG_MOUSE |
| | | | | | Cytochrome c oxidase polypeptide VIb |
| | | | | | (AED) [M. musculus] |
| 15411 | 1078 | NM_031559 | B, L | Rattus norvegicus Carnitine | Carnitine palmitoyltransferase 1 alpha, |
| | | | | palmitoyltransferase 1 alpha, | liver isoform |
| | | | | liver isoform (Cpt1a), mRNA. | |
| | | | | Length = 4377 | |
| 8888 | 916 | NM_017090 | B | Rattus norvegicus guanylate | guanylate cyclase 1, soluble, alpha 3 |
| | | | | cyclase 1, soluble, alpha 3 | |
| | | | | (Gucy1a3), mRNA. Length = 4775 | |
| 20716 | 984 | NM_019623 | G | Rattus norvegicus | cytochrome P450 4F1 |
| | | | | cytochrome P450 4F1 | |
| | | | | (Cyp4f1), mRNA. Length = 1977 | |
| 25070 | 1038 | NM_024392 | GENERAL | Rattus norvegicus | peroxisomal multifunctional enzyme type |
| | | | | peroxisomal multifunctional | II |
| | | | | enzyme type II (Hsd17b4), | |
| | | | | mRNA. Length = 2535 | |
| 811 | 1095 | NM_031705 | GENERAL, I | Rattus norvegicus | dihydropyrimidinase |
| | | | | dihydropyrimidinase (Dpys), | |
| | | | | mRNA. Length = 2091 | |
| 812 | 1095 | NM_031705 | GENERAL, I | Rattus norvegicus | dihydropyrimidinase |
| | | | | dihydropyrimidinase (Dpys), | |
| | | | | mRNA. Length = 2091 | |
| 14083 | 619 | AI177181 | C | | ESTs, Weakly similar to FYV1_MOUSE |
| | | | | | FYVE finger-containing phosphoinositide |
| | | | | | kinase (1-phosphatidylinositol-4- |
| | | | | | phosphate kinase) (PIP5K) (Ptdlns(4)P-5- |
| | | | | | kinase) (p235) [M. musculus] |
| 11421 | 1190 | NM_130405 | E | Rattus norvegicus src | src associated in mitosis, 68 kDa |
| | | | | associated in mitosis, 68 kDa | |
| | | | | (Sam68), mRNA. Length = 2655 | |
| 2554 | 873 | NM_012967 | GENERAL | Rattus norvegicus | Intercellular adhesion molecule 1 |
| | | | | Intercellular adhesion | |
| | | | | molecule 1 (Icam1), mRNA. | |
| | | | | Length = 2602 | |
| 2555 | 873 | NM_012967 | GENERAL, | Rattus norvegicus | Intercellular adhesion molecule 1 |
| | | | C, I | Intercellular adhesion | |
| | | | | molecule 1 (Icam1), mRNA. | |
| | | | | Length = 2602 | |
| 16003 | 1103 | NM_031757 | C | Rattus norvegicus matrix | matrix metalloproteinase 24 (membrane- |
| | | | | metalloproteinase 24 | inserted) |
| | | | | (membrane-inserted) | |
| | | | | (Mmp24), mRNA. Length = 4245 | |
| 405 | 1081 | NM_031587 | GENERAL, | Rattus norvegicus | peroxisomal membrane protein 2, 22 kDa |
| | | | H, K | peroxisomal membrane | |
| | | | | protein 2, 22 kDa (Pxmp2), | |
| | | | | mRNA. Length = 852 | |
| 1475 | 1115 | NM_031971 | C | Rattus norvegicus Heat | ESTs, Highly similar to S10A_RAT S-100 |
| | | | | shock protein 70-1 (Hspa1a), | protein, alpha chain [R. norvegicus], Heat |
| | | | | mRNA. Length = 2455 | shock protein 70-1 |
| 1472 | 1215 | U26356 | K | | ESTs, Highly similar to S10A_RAT S-100 |
| | | | | | protein, alpha chain [R. norvegicus] |
| 9332 | 694 | AI232210 | F | MIC2 like 1 | MIC2 like 1 |
| 19031 | 928 | NM_017180 | GENERAL, L | Rattus norvegicus T-cell | T-cell death associated gene |
| | | | | death associated gene | |
| | | | | (Tdag), mRNA. Length = 1353 | |
| 1511 | 1137 | NM_053424 | D | Rattus norvegicus solute | solute carrier family 4, sodium |
| | | | | carrier family 4, sodium | bicarbonate cotransporter, member 4 |
| | | | | bicarbonate cotransporter, | |
| | | | | member 4 (Slc4a4), mRNA. | |
| | | | | Length = 3573 | |
| 20802 | 1018 | NM_022592 | H | Rattus norvegicus | transketolase |
| | | | | transketolase (Tkt), mRNA. | |
| | | | | Length = 2098 | |
| 20803 | 1018 | NM_022592 | B, H, I | Rattus norvegicus | transketolase |
| | | | | transketolase (Tkt), mRNA. | |
| | | | | Length = 2098 | |
| 20804 | 1018 | NM_022592 | H | Rattus norvegicus | transketolase |
| | | | | transketolase (Tkt), mRNA. | |
| | | | | Length = 2098 | |
| 11843 | 1143 | NM_053555 | A | Rattus norvegicus vesicle- | vesicle-associated membrane protein 5 |
| | | | | associated membrane | |
| | | | | protein 5 (Vamp5), mRNA. | |
| | | | | Length = 309 | |
| 4592 | 979 | NM_019356 | H | Rattus norvegicus eukaryotic | eukaryotic translation initiation factor 2, |
| | | | | translation initiation factor 2, | subunit 1 (alpha) |
| | | | | subunit 1 (alpha) (Eif2s1), | |
| | | | | mRNA. Length = 1377 | |
| 16948 | 850 | NM_012793 | A, C | Rattus norvegicus | Guanidinoacetate methyltransferase |
| | | | | Guanidinoacetate | |
| | | | | methyltransferase (Gamt), | |
| | | | | mRNA. Length = 924 | |
| 18750 | 940 | NM_017257 | G | Rattus norvegicus protease | protease (prosome, macropain) 28 |
| | | | | (prosome, macropain) 28 | subunit, beta |
| | | | | subunit, beta (Psme2), | |
| | | | | mRNA. Length = 806 | |
| 18751 | 940 | NM_017257 | G | Rattus norvegicus protease | protease (prosome, macropain) 28 |
| | | | | (prosome, macropain) 28 | subunit, beta |
| | | | | subunit, beta (Psme2), | |
| | | | | mRNA. Length = 806 | |
| 12682 | 1069 | NM_031332 | D | Rattus norvegicus organic | organic anion transporter |
| | | | | anion transporter | |
| | | | | (LOC83500), mRNA. Length = 2157 | |
| 17324 | 991 | NM_021593 | GENERAL | Rattus norvegicus | kynurenine 3-hydroxylase |
| | | | | kynurenine 3-hydroxylase | |
| | | | | (Kmo), mRNA. Length = 1733 | |
| 5837 | 893 | NM_013143 | GENERAL, F | Rattus norvegicus Meprin 1 | Meprin 1 alpha |
| | | | | alpha (Mep1a), mRNA. | |
| | | | | Length = 2928 | |
| 5838 | 893 | NM_013143 | GENERAL, | Rattus norvegicus Meprin 1 | Meprin 1 alpha |
| | | | F, G | alpha (Mep1a), mRNA. | |
| | | | | Length = 2928 | |
| 7690 | 48 | AA818875 | GENERAL | uroguanylin | uroguanylin |
| 1809 | 274 | AA946503 | G, K | lipocalin 2 | lipocalin 2 |
| 20740 | 1197 | S69874 | D | | Rattus norvegicus Sprague-Dawley lipid- |
| | | | | | binding protein mRNA, complete cds |
| 8188 | 1167 | NM_053927 | GENERAL | Rattus norvegicus | erythrocyte protein band 4.1-like 3 |
| | | | | erythrocyte membrane | |
| | | | | protein band 4.1-like 3 | |
| | | | | (Epb41I3), mRNA. Length = 4543 | |
| 6782 | 606 | AI176170 | B | FK506-binding protein 1 | FK506-binding protein 1 (12 kD) |
| | | | | (12 kD) | |
| 15295 | 887 | NM_013102 | GENERAL, | Rattus norvegicus FK506- | FK506-binding protein 1 (12 kD) |
| | | | H, I | binding protein 1 (12 kD) | |
| | | | | (Fkbp1a), mRNA. Length = 554 | |
| 15296 | 887 | NM_013102 | H, I | Rattus norvegicus FK506- | FK506-binding protein 1 (12 kD) |
| | | | | binding protein 1 (12 kD) | |
| | | | | (Fkbp1a), mRNA. Length = 554 | |
| 15297 | 887 | NM_013102 | K | Rattus norvegicus FK506- | FK506-binding protein 1 (12 kD) |
| | | | | binding protein 1 (12 kD) | |
| | | | | (Fkbp1a), mRNA. Length = 554 | |
| 13091 | 550 | AI136977 | L | | ESTs, Highly similar to S14538 transition |
| | | | | | protein - mouse [M. musculus] |
| 13092 | 689 | AI231547 | L | | ESTs, Highly similar to S14538 transition |
| | | | | | protein - mouse [M. musculus] |
| 1143 | 971 | NM_019280 | A | Rattus norvegicus gap | gap junction membrane channel protein |
| | | | | junction membrane channel | alpha 5 (connexin 40) |
| | | | | protein alpha 5 (Gja5), | |
| | | | | mRNA. Length = 3115 | |
| 15072 | 726 | AI234969 | A | GATA-binding protein 4 | GATA-binding protein 4 |
| 1399 | 907 | NM_017006 | GENERAL, | Rattus norvegicus Glucose-6- | Glucose-6-phosphate dehydrogenase |
| | | | H, I | phosphate dehydrogenase | |
| | | | | (G6pd), mRNA. Length = 2324 | |
| 14003 | 948 | NM_017305 | B, J | Rattus norvegicus glutamate- | glutamate-cysteine ligase, modifier |
| | | | | cysteine ligase, modifier | subunit |
| | | | | subunit (Gclm), mRNA. | |
| | | | | Length = 1382 | |
| 16775 | 1048 | NM_031031 | GENERAL, | Rattus norvegicus L-arginine: | L-arginine: glycine amidinotransferase |
| | | | D, I, L | glycine amidinotransferase | |
| | | | | (Gatm), mRNA. Length = 2260 | |
| 1551 | 915 | NM_017084 | G | Rattus norvegicus Glycine | Glycine methyltransferase |
| | | | | methyltransferase (Gnmt), | |
| | | | | mRNA. Length = 988 | |
| 22675 | 980 | NM_019358 | G | Rattus norvegicus | glycoprotein 38 |
| | | | | glycoprotein 38 (Gp38), | |
| | | | | mRNA. Length = 1854 | |
| 352 | 1030 | NM_024127 | H | Rattus norvegicus DNA- | DNA-damage-inducible transcript 1 |
| | | | | damage-inducible transcript | |
| | | | | 1 (Gadd45a), mRNA. Length = 711 | |
| 353 | 1030 | NM_024127 | GENERAL, | Rattus norvegicus DNA- | DNA-damage-inducible transcript 1 |
| | | | H, I | damage-inducible transcript | |
| | | | | 1 (Gadd45a), mRNA. Length = 711 | |
| 354 | 1030 | NM_024127 | GENERAL, | Rattus norvegicus DNA- | DNA-damage-inducible transcript 1 |
| | | | H, I | damage-inducible transcript | |
| | | | | 1 (Gadd45a), mRNA. Length = 711 | |
| 17524 | 381 | AI010568 | GENERAL, | Growth hormone receptor | Growth hormone receptor |
| | | | A, I | | |
| 10887 | 917 | NM_017094 | GENERAL, I | Rattus norvegicus Growth | Growth hormone receptor |
| | | | | hormone receptor (Ghr), | |
| | | | | mRNA. Length = 2950 | |
| 14184 | 1106 | NM_031776 | GENERAL | Rattus norvegicus guanine | guanine deaminase |
| | | | | deaminase (Gda), mRNA. | |
| | | | | Length = 1568 | |
| 14185 | 1106 | NM_031776 | GENERAL | Rattus norvegicus guanine | guanine deaminase |
| | | | | deaminase (Gda), mRNA. | |
| | | | | Length = 1568 | |
| 3608 | 1049 | NM_031044 | GENERAL, J | Rattus norvegicus histamine | histamine N-methyltransferase |
| | | | | N-methyltransferase (Hnmt), | |
| | | | | mRNA. Length = 1225 | |
| 3610 | 1049 | NM_031044 | GENERAL, | Rattus norvegicus histamine | histamine N-methyltransferase |
| | | | G, I, J | N-methyltransferase (Hnmt), | |
| | | | | mRNA. Length = 1225 | |
| 3609 | 1203 | S82579 | F | histamine N- | histamine N-methyltransferase |
| | | | | methyltransferase | |
| 1382 | 332 | AB002406 | G | RuvB-like protein 1 | RuvB-like protein 1 |
| 15750 | 1131 | NM_053309 | H | Rattus norvegicus homer, | homer, neuronal immediate early gene, 2 |
| | | | | neuronal immediate early | |
| | | | | gene, 2 (Homer2), mRNA. | |
| | | | | Length = 1994 | |
| 4944 | 218 | AA924405 | GENERAL, | | ESTs, Weakly similar to NFH_MOUSE |
| | | | H, I, K | | Neurofilament triplet H protein (200 kDa |
| | | | | | neurofilament protein) (Neurofilament |
| | | | | | heavy polypeptide) (NF-H) [M. musculus] |
| 24643 | 1006 | NM_022400 | K | Rattus norvegicus branched | branched chain aminotransferase 2, |
| | | | | chain aminotransferase 2, | mitochondrial |
| | | | | mitochondrial (Bcat2), | |
| | | | | mRNA. Length = 1548 | |
| 3941 | 386 | AI011598 | GENERAL, J | | ESTs, Moderately similar to |
| | | | | | LMA5_MOUSE Laminin alpha-5 chain |
| | | | | | precursor [M. musculus] |
| 20896 | 1148 | NM_053592 | A, F | Rattus norvegicus dUTPase | Deoxyuridinetriphosphatase (dUTPase) |
| | | | | (LOC94200), mRNA. Length = 952 | |
| 457 | 813 | M60666 | E, G, K | Tropomyosin 1 (alpha) | Tropomyosin 1 (alpha) |
| 455 | 957 | NM_019131 | E | Rattus norvegicus | Tropomyosin 1 (alpha) |
| | | | | Tropomyosin 1 (alpha) | |
| | | | | (Tpm1), mRNA. Length = 1004 | |
| 16681 | 920 | NM_017136 | B, L | Rattus norvegicus squalene | squalene epoxidase |
| | | | | epoxidase (Sqle), mRNA. | |
| | | | | Length = 2199 | |
| 24900 | 925 | NM_017163 | H | Rattus norvegicus X | X transporter protein 2 |
| | | | | transporter protein 2 (Xtrp2), | |
| | | | | mRNA. Length = 2336 | |
| 7300 | 1070 | NM_031341 | C | Rattus norvegicus solute | solute carrier family 7 (cationic amino |
| | | | | carrier family 7 (cationic | acid transporter, y+system), member 7 |
| | | | | amino acid transporter, | |
| | | | | y+system), member 7 | |
| | | | | (Slc7a7), mRNA. Length = 2077 | |
| 3615 | 754 | AI237645 | J | transferrin receptor | transferrin receptor |
| 20884 | 857 | NM_012842 | G, K | Rattus norvegicus Epidermal | Epidermal growth factor |
| | | | | growth factor (Egf), mRNA. | |
| | | | | Length = 4801 | |
| 20885 | 857 | NM_012842 | G, K | Rattus norvegicus Epidermal | Epidermal growth factor |
| | | | | growth factor (Egf), mRNA. | |
| | | | | Length = 4801 | |
| 23748 | 566 | AI169037 | F | | ESTs, Highly similar to MPU1_MOUSE |
| | | | | | Mannose-P-dolichol utilization defect 1 |
| | | | | | protein (Suppressor of Lec15 and Lec35 |
| | | | | | glycosylation mutation homolog) (SL15) |
| | | | | | [M. musculus] |
| 21211 | 1023 | NM_022607 | C | Rattus norvegicus MIPP65 | MIPP65 protein |
| | | | | protein (Mipp65), mRNA. | |
| | | | | Length = 1468 | |
| 15599 | 938 | NM_017236 | J | Rattus norvegicus | phosphatidylethanolamine binding protein |
| | | | | phosphatidylethanolamine | |
| | | | | binding protein (Pbp), mRNA. | |
| | | | | Length = 1075 | |
| 1247 | 792 | J05181 | J | Glutamylcysteine gamma | Glutamylcysteine gamma synthetase light |
| | | | | synthetase light chain | chain |
| 15662 | 1065 | NM_031318 | G | Rattus norvegicus t-complex | t-complex testis expressed 1 |
| | | | | testis expressed 1 (Tctex1), | |
| | | | | mRNA. Length = 698 | |
| 15663 | 1065 | NM_031318 | GENERAL | Rattus norvegicus t-complex | t-complex testis expressed 1 |
| | | | | testis expressed 1 (Tctex1), | |
| | | | | mRNA. Length = 698 | |
| 20960 | 1020 | NM_022598 | D | Rattus norvegicus cellular | cellular nucleic acid binding protein |
| | | | | nucleic acid binding protein | |
| | | | | (Cnbp), mRNA. Length = 1640 | |
| 729 | 819 | M95762 | D | solute carrier family 6 | solute carrier family 6 (neurotransmitter |
| | | | | (neurotransmitter transporter, | transporter, GABA), member 13 |
| | | | | GABA), member 13 | |
| 15175 | 1091 | NM_031682 | E | Rattus norvegicus | hydroxysteroid (17-beta) dehydrogenase |
| | | | | hydroxyacyl-Coenzyme A | 10 |
| | | | | dehydrogenase, type II | |
| | | | | (Hadh2), mRNA. Length = 917 | |
| 275 | 914 | NM_017081 | GENERAL | Rattus norvegicus | Hydroxysteroid dehydrogenase, 11 beta |
| | | | | Hydroxysteroid | type 2 |
| | | | | dehydrogenase, 11 beta type | |
| | | | | 2 (Hsd11b2), mRNA. Length = 1864 | |
| 2059 | 565 | AI146005 | A, H | HMm: pseudouridine | ESTs, Highly similar to TRUA_MOUSE |
| | | | | synthase 1 | tRNA pseudouridine synthase A |
| | | | | | (Pseudouridylate synthase I) |
| | | | | | (Pseudouridine synthase I) (Uracil |
| | | | | | hydrolyase) [M. musculus] |
| 16982 | 894 | NM_013144 | GENERAL, | Rattus norvegicus Insulin-like | Insulin-like growth factor binding protein 1 |
| | | | B, L | growth factor binding protein | |
| | | | | 1 (Igfbp1), mRNA. Length = 1500 | |
| 14989 | 621 | AI177366 | GENERAL, K | Integrin, beta 1 | Integrin, beta 1 |
| 1729 | 961 | NM_019147 | B | Rattus norvegicus jagged 1 | jagged 1 |
| | | | | (Jag1), mRNA. Length = 5575 | |
| 22352 | 603 | AI175959 | GENERAL, H | Avian sarcoma virus 17 (v- | Avian sarcoma virus 17 (v-jun) oncogene |
| | | | | jun) oncogene homolog | homolog |
| 5384 | 120 | AA891041 | I | jun B proto-oncogene | jun B proto-oncogene |
| 20161 | 998 | NM_021836 | GENERAL, | Rattus norvegicus Jun B | jun B proto-oncogene |
| | | | C, I | proto-oncogene (Junb), | |
| | | | | mRNA. Length = 1035 | |
| 16726 | 1112 | NM_031855 | GENERAL, | Rattus norvegicus | Ketohexokinase |
| | | | E, G, H, I | Ketohexokinase (Khk), | |
| | | | | mRNA. Length = 1342 | |
| 15761 | 345 | AF062741 | B | | Rattus norvegicus pyruvate |
| | | | | | dehydrogenase phosphatase isoenzyme |
| | | | | | 2 mRNA, complete cds |
| 24631 | 1032 | NM_024137 | F | Rattus norvegicus human | human immunodeficiency virus type I |
| | | | | immunodeficiency virus type | enhancer-binding protein 2 |
| | | | | I enhancer-binding protein 2 | |
| | | | | (Hivep2), mRNA. Length = 9731 | |
| 1850 | 840 | NM_012696 | GENERAL | Rattus norvegicus T- | T-kininogen, see also D11Elh1 and |
| | | | | kininogen, see also D11Elh1 | D11Mit8 |
| | | | | and D11Mit8 (Kng), mRNA. | |
| | | | | Length = 1417 | |
| 25379 | 1156 | NM_053713 | GENERAL, C | Rattus norvegicus Kruppel- | Kruppel-like factor 4 (gut) |
| | | | | like factor 4 (gut) (Klf4), | |
| | | | | mRNA. Length = 2393 | |
| 17807 | 909 | NM_017025 | GENERAL, G | Rattus norvegicus Lactate | Lactate dehydrogenase A |
| | | | | dehydrogenase A (Ldha), | |
| | | | | mRNA. Length = 1609 | |
| 7124 | 829 | NM_012595 | E | Rattus norvegicus Lactate | Lactate dehydrogenease B |
| | | | | dehydrogenease B (Ldhb), | |
| | | | | mRNA. Length = 1217 | |
| 410 | 358 | AI008974 | GENERAL, E | low density lipoprotein | low density lipoprotein receptor-related |
| | | | | receptor-related protein | protein associated protein 1 |
| | | | | associated protein 1 | |
| 409 | 695 | AI232268 | GENERAL, I | low density lipoprotein | low density lipoprotein receptor-related |
| | | | | receptor-related protein | protein associated protein 1 |
| | | | | associated protein 1 | |
| 408 | 1169 | NM_053961 | GENERAL | Rattus norvegicus | low density lipoprotein receptor-related |
| | | | | endoplasmic retuclum protein | protein associated protein 1 |
| | | | | 29 (Erp29), mRNA. Length = 4529 | |
| 406 | 1259 | Z11995 | GENERAL | low density lipoprotein | low density lipoprotein receptor-related |
| | | | | receptor-related protein | protein associated protein 1 |
| | | | | associated protein 1 | |
| 407 | 1259 | Z11995 | C | low density lipoprotein | low density lipoprotein receptor-related |
| | | | | receptor-related protein | protein associated protein 1 |
| | | | | associated protein 1 | |
| 15242 | 964 | NM_019191 | D | Rattus norvegicus MAD | MAD homolog 2 (Drosophila) |
| | | | | homolog 2 (Drosophila) | |
| | | | | (Madh2), mRNA. Length = 2113 | |
| 21122 | 1242 | X56228 | E | Thiosulfate | Thiosulfate sulphurtransferase |
| | | | | sulphurtransferase | (rhodanese) |
| | | | | (rhodanese) | |
| 21123 | 1242 | X56228 | D | Thiosulfate | Thiosulfate sulphurtransferase |
| | | | | sulphurtransferase | (rhodanese) |
| | | | | (rhodanese) | |
| 19152 | 768 | AI639387 | GENERAL, D | | ESTs, Highly similar to RT06_MOUSE |
| | | | | | Mitochondrial 28S ribosomal protein S6 |
| | | | | | (MRP-S6) [M. musculus] |
| 3925 | 75 | AA851017 | A, E | | ESTs, Highly similar to molybdenum |
| | | | | | cofactor synthesis 2 [Mus musculus] |
| | | | | | [M. musculus] |
| 809 | 1207 | U17035 | C | small inducible cytokine B | small inducible cytokine B subfamily (Cys- |
| | | | | subfamily (Cys-X-Cys), | X-Cys), member 10 |
| | | | | member 10 | |
| 17223 | 605 | AI176140 | D | | ESTs, Highly similar to testis expressed |
| | | | | | gene 189 [Mus musculus] [M. musculus] |
| 1462 | 733 | AI235585 | GENERAL, | cathepsin D | cathepsin D |
| | | | E, G | | |
| 1463 | 1241 | X54467 | GENERAL, | cathepsin D | cathepsin D |
| | | | G, K | | |
| 16610 | 781 | D28557 | E, L | cold shock domain protein A | cold shock domain protein A |
| 23810 | 402 | AI012781 | E | | ESTs, Highly similar to EZH2_MOUSE |
| | | | | | Enhancer of zeste homolog 2 (ENX-1) |
| | | | | | [M. musculus] |
| 19824 | 995 | NM_021750 | G, K | Rattus norvegicus cysteine- | cysteine-sulfinate decarboxylase |
| | | | | sulfinate decarboxylase | |
| | | | | (Csad), mRNA. Length = 2413 | |
| 6577 | 1011 | NM_022532 | F | Rattus norvegicus A-raf | A-raf |
| | | | | (Araf1), mRNA. Length = 2288 | |
| 22781 | 111 | AA874926 | F | | ESTs, Weakly similar to dual-specificity |
| | | | | | phosphatase [Mus musculus] |
| | | | | | [M. musculus] |
| 22783 | 205 | AA894207 | A, F | | ESTs, Weakly similar to dual-specificity |
| | | | | | phosphatase [Mus musculus] |
| | | | | | [M. musculus] |
| 23093 | 217 | AA924342 | G | | ESTs, Weakly similar to dual-specificity |
| | | | | | phosphatase [Mus musculus] |
| | | | | | [M. musculus] |
| 15790 | 1135 | NM_053341 | E | Rattus norvegicus regulator | regulator of G-protein signaling 19 |
| | | | | of G-protein signaling 19 | |
| | | | | (Rgs19), mRNA. Length = 1607 | |
| 15791 | 1135 | NM_053341 | C | Rattus norvegicus regulator | regulator of G-protein signaling 19 |
| | | | | of G-protein signaling 19 | |
| | | | | (Rgs19), mRNA. Length = 1607 | |
| 24484 | 1128 | NM_052806 | H | Rattus norvegicus | Acetylcholine receptor beta 4 |
| | | | | Acetylcholine receptor beta 4 | |
| | | | | (Chrnb4), mRNA. Length = 2461 | |
| 19184 | 631 | AI178025 | GENERAL, | | ESTs, Highly similar to TGIF_MOUSE 5′- |
| | | | H, I | | TG-3′ INTERACTING FACTOR |
| | | | | | (HOMEOBOX PROTEIN TGIF) |
| | | | | | [M. musculus] |
| 35 | 1162 | NM_053840 | C | Rattus norvegicus gamma- | gamma-glutamyl transpeptidase |
| | | | | glutamyl transpeptidase | |
| | | | | (M33821), mRNA. Length = 2141 | |
| 699 | 1223 | U55765 | E | serine (or cysteine) | serine (or cysteine) proteinase inhibitor, |
| | | | | proteinase inhibitor, clade A | clade A (alpha-1 antiproteinase, |
| | | | | (alpha-1 antiproteinase, | antitrypsin), member 10 |
| | | | | antitrypsin), member 10 | |
| 24582 | 939 | NM_017243 | D | Rattus norvegicus | phosphoribosyl pyrophosphate |
| | | | | phosphoribosyl | synthetase 1 |
| | | | | pyrophosphate synthetase 1 | |
| | | | | (Prps1), mRNA. Length = 1981 | |
| 23698 | 821 | NM_012489 | D | Rattus norvegicus Acetyl- | Acetyl-CoA acyltransferase, 3-oxo acyl- |
| | | | | CoA acyltransferase, 3-oxo | CoA thiolase A 1, peroxisomal |
| | | | | acyl-CoA thiolase A, | |
| | | | | peroxisomal (Acaa), mRNA. | |
| | | | | Length = 1619 | |
| 23699 | 821 | NM_012489 | D, E | Rattus norvegicus Acetyl- | Acetyl-CoA acyltransferase, 3-oxo acyl- |
| | | | | CoA acyltransferase, 3-oxo | CoA thiolase A 1, peroxisomal |
| | | | | acyl-CoA thiolase A, | |
| | | | | peroxisomal (Acaa), mRNA. | |
| | | | | Length = 1619 | |
| 16884 | 517 | AI103758 | E | aldehyde dehydrogenase | aldehyde dehydrogenase family 9, |
| | | | | family 9, subfamily A1 | subfamily A1 |
| 16885 | 531 | AI105188 | K | aldehyde dehydrogenase | aldehyde dehydrogenase family 9, |
| | | | | family 9, subfamily A1 | subfamily A1 |
| 21695 | 1191 | NM_130411 | G | Rattus norvegicus coronin, | coronin, actin binding protein 1A |
| | | | | actin binding protein 1A | |
| | | | | (Coro1a), mRNA. Length = 1386 | |
| 19058 | 342 | AF054618 | E | cortactin isoform B | cortactin isoform B |
| 3454 | 1155 | NM_053662 | J | Rattus norvegicus cyclin L | cyclin L |
| | | | | (Ccnl), mRNA. Length = 2092 | |
| 794 | 1166 | NM_053902 | GENERAL, I | Rattus norvegicus | kynureninase (L-kynurenine hydrolase) |
| | | | | kynureninase (L-kynurenine | |
| | | | | hydrolase) (Kynu), mRNA. | |
| | | | | Length = 1765 | |
| 1929 | 1045 | NM_030872 | A, C, D, E | Rattus norvegicus pyruvate | pyruvate dehydrogenase kinase 2 subunit |
| | | | | dehydrogenase kinase 2 | p45 (PDK2) |
| | | | | subunit p45 (PDK2) (Pdk2), | |
| | | | | mRNA. Length = 2207 | |
| 18502 | 1118 | NM_031984 | G, J | Rattus norvegicus cerebellar | cerebellar Ca-binding protein, spot 35 |
| | | | | Ca-binding protein, spot 35 | protein |
| | | | | protein (Calb1), mRNA. | |
| | | | | Length = 2280 | |
| 18503 | 1118 | NM_031984 | G | Rattus norvegicus cerebellar | cerebellar Ca-binding protein, spot 35 |
| | | | | Ca-binding protein, spot 35 | protein |
| | | | | protein (Calb1), mRNA. | |
| | | | | Length = 2280 | |
| 5496 | 1083 | NM_031589 | GENERAL, | Rattus norvegicus glucose-6- | glucose-6-phosphatase, transport protein 1 |
| | | | D, E | phosphatase, transport | |
| | | | | protein 1 (G6pt1), mRNA. | |
| | | | | Length = 1930 | |
| 5497 | 1083 | NM_031589 | GENERAL, | Rattus norvegicus glucose-6- | glucose-6-phosphatase, transport protein 1 |
| | | | D, E | phosphatase, transport | |
| | | | | protein 1 (G6pt1), mRNA. | |
| | | | | Length = 1930 | |
| 14970 | 1059 | NM_031127 | GENERAL, | Rattus norvegicus sulfite | sulfite oxidase |
| | | | B, H, I, K | oxidase (Suox), mRNA. | |
| | | | | Length = 1777 | |
| 2629 | 830 | NM_012603 | K | Rattus norvegicus Avian | Avian myelocytomatosis viral (v-myc) |
| | | | | myelocytomatosis viral (v- | oncogene homolog |
| | | | | myc) oncogene homolog | |
| | | | | (Myc), mRNA. Length = 2168 | |
| 21302 | 404 | AI013297 | J | HMm: NADH dehydrogenase | ESTs, Moderately similar to NADH |
| | | | | (ubiquinone) Fe—S protein 4 | dehydrogenase (ubiquinone) Fe—S |
| | | | | | protein 4; NADH dehydrogenase |
| | | | | | (ubiquinone) Fe—S protein 4 (18 kDa) |
| | | | | | [Mus musculus] [M. musculus] |
| 14638 | 551 | AI137049 | J | nibrin | nibrin |
| 1508 | 1163 | NM_053845 | G | Rattus norvegicus | ureidopropionase, beta |
| | | | | ureidopropionase, beta | |
| | | | | (Upb1), mRNA. Length = 1420 | |
| 1401 | 1152 | NM_053616 | J | Rattus norvegicus | preimplantation protein 2 |
| | | | | preimplantation protein 2 | |
| | | | | (Prei2), mRNA. Length = 2412 | |
| 14332 | 775 | AJ001044 | D | tumor-associated calcium | tumor-associated calcium signal |
| | | | | signal transducer 1 | transducer 1 |
| 20457 | 986 | NM_020073 | GENERAL, | Rattus norvegicus | parathyroid hormone receptor |
| | | | B, K, L | parathyroid hormone | |
| | | | | receptor (LOC56813), | |
| | | | | mRNA. Length = 2065 | |
| 20458 | 986 | NM_020073 | GENERAL, | Rattus norvegicus | parathyroid hormone receptor |
| | | | I, K, L | parathyroid hormone | |
| | | | | receptor (LOC56813), | |
| | | | | mRNA. Length = 2065 | |
| 4290 | 1141 | NM_053487 | L | Rattus norvegicus | peroxisomal membrane protein Pmp26p |
| | | | | peroxisomal membrane | (Peroxin-11) |
| | | | | protein Pmp26p (Peroxin-11) | |
| | | | | (Pex11a), mRNA. Length = 1194 | |
| 21976 | 266 | AA946011 | B | phosphatidylinositol-4- | phosphatidylinositol-4-phosphate 5- |
| | | | | phosphate 5-kinase, type II, | kinase, type II, gamma |
| | | | | gamma | |
| 5295 | 240 | AA926247 | GENERAL, L | putative potassium channel | putative potassium channel TWIK |
| | | | | TWIK | |
| 19665 | 993 | NM_021688 | D, L | Rattus norvegicus putative | putative potassium channel TWIK |
| | | | | potassium channel TWIK | |
| | | | | (Kcnk1), mRNA. Length = 1582 | |
| 24566 | 833 | NM_012630 | B, F, L | Rattus norvegicus Prolactin | Prolactin receptor |
| | | | | receptor (Prlr), mRNA. | |
| | | | | Length = 1635 | |
| 24567 | 833 | NM_012630 | F | Rattus norvegicus Prolactin | Prolactin receptor |
| | | | | receptor (Prlr), mRNA. | |
| | | | | Length = 1635 | |
| 24568 | 833 | NM_012630 | GENERAL, B | Rattus norvegicus Prolactin | Prolactin receptor |
| | | | | receptor (Prlr), mRNA. | |
| | | | | Length = 1635 | |
| 11454 | 1004 | NM_022381 | GENERAL | Rattus norvegicus | Proliferating cell nuclear antigen |
| | | | | Proliferating cell nuclear | |
| | | | | antigen (Pcna), mRNA. | |
| | | | | Length = 1160 | |
| 11455 | 1004 | NM_022381 | GENERAL | Rattus norvegicus | Proliferating cell nuclear antigen |
| | | | | Proliferating cell nuclear | |
| | | | | antigen (Pcna), mRNA. | |
| | | | | Length = 1160 | |
| 19469 | 146 | AA892112 | GENERAL, D | | ESTs, Weakly similar to PROD_MOUSE |
| | | | | | PROLINE OXIDASE, MITOCHONDRIAL |
| | | | | | PRECURSOR (PROLINE |
| | | | | | DEHYDROGENASE) [M. musculus] |
| 1422 | 1066 | NM_031324 | GENERAL, | Rattus norvegicus prolyl | prolyl endopeptidase |
| | | | B, G, L | endopeptidase (Prep), | |
| | | | | mRNA. Length = 2743 | |
| 15470 | 1116 | NM_031978 | H | Rattus norvegicus 26S | 26S proteasome, subunit p112 |
| | | | | proteasome, subunit p112 | |
| | | | | (PSMD1), mRNA. Length = 3089 | |
| 3254 | 945 | NM_017282 | L | Rattus norvegicus | proteasome (prosome, macropain) |
| | | | | proteasome (prosome, | subunit, alpha type 5 |
| | | | | macropain) subunit, alpha | |
| | | | | type 5 (Psma5), mRNA. | |
| | | | | Length = 970 | |
| 25253 | 1173 | NM_057099 | H | Rattus norvegicus | proteasome (prosome, macropain) |
| | | | | proteasome (prosome, | subunit, beta type 6 |
| | | | | macropain) subunit, beta | |
| | | | | type 6 (Psmb6), mRNA. | |
| | | | | Length = 760 | |
| 24219 | 1079 | NM_031579 | GENERAL, L | Rattus norvegicus protein | protein tyrosine phosphatase 4a1 |
| | | | | tyrosine phosphatase 4a1 | |
| | | | | (Ptp4a1), mRNA. Length = 2638 | |
| 25198 | 996 | NM_021754 | GENERAL, | Rattus norvegicus Nopp140 | Nopp140 associated protein |
| | | | I, K | associated protein (Nap65), | |
| | | | | mRNA. Length = 1980 | |
| 20035 | 996 | NM_021754 | GENERAL, H | Rattus norvegicus Nopp140 | Nopp140 associated protein |
| | | | | associated protein (Nap65), | |
| | | | | mRNA. Length = 1980 | |
| 4661 | 207 | AA899709 | GENERAL, | receptor activity modifying | receptor activity modifying protein 3 |
| | | | B, L | protein 3 | |
| 28 | 1077 | NM_031546 | GENERAL, | Rattus norvegicus | Regucalcin |
| | | | F, G, I, J, L | Regucalcin (Rgn), mRNA. | |
| | | | | Length = 1605 | |
| 1515 | 1053 | NM_031095 | J | Rattus norvegicus renin- | renin-binding protein |
| | | | | binding protein (Renbp), | |
| | | | | mRNA. Length = 1292 | |
| 10789 | 1039 | NM_024399 | GENERAL | Rattus norvegicus | aspartoacylase |
| | | | | aspartoacylase (Aspa), | |
| | | | | mRNA. Length = 1552 | |
| 18452 | 913 | NM_017074 | GENERAL | Rattus norvegicus CTL target | CTL target antigen |
| | | | | antigen (Cth), mRNA. Length = 1743 | |
| 18453 | 913 | NM_017074 | G | Rattus norvegicus CTL target | CTL target antigen |
| | | | | antigen (Cth), mRNA. Length = 1743 | |
| 18001 | 79 | AA858573 | GENERAL | spp-24 precursor | spp-24 precursor |
| 17999 | 1211 | U19485 | GENERAL | spp-24 precursor | spp-24 precursor |
| 18000 | 1211 | U19485 | I | spp-24 precursor | spp-24 precursor |
| 1549 | 1009 | NM_022508 | G | Rattus norvegicus C1- | C1-tetrahydrofolate synthase |
| | | | | tetrahydrofolate synthase | |
| | | | | (LOC64300), mRNA. Length = 3332 | |
| 15800 | 1159 | NM_053810 | A | Rattus norvegicus | synaptosomal-associated protein, 29 kD |
| | | | | synaptosomal-associated | |
| | | | | protein, 29 kD (Snap29), | |
| | | | | mRNA. Length = 774 | |
| 25467 | 818 | M93297 | G | ornithine aminotransferase | ornithine aminotransferase |
| 21253 | 530 | AI105110 | F | | ESTs, Highly similar to S58180 sui1 |
| | | | | | protein - mouse (fragment) [M. musculus] |
| 23884 | 1099 | NM_031731 | J | Rattus norvegicus alcohol | alcohol dehydrogenase family 3, |
| | | | | dehydrogenase family 3, | subfamily A2 |
| | | | | subfamily A2 (Aldh3a2), | |
| | | | | mRNA. Length = 2977 | |
| 12921 | 546 | AI112636 | GENERAL, | HMm: uridine phosphorylase | ESTs, Highly similar to A57501 uridine |
| | | | B, L | | phosphorylase (EC 2.4.2.3) I - mouse |
| | | | | | [M. musculus] |
| 20809 | 951 | NM_017326 | D | Rattus norvegicus calmodulin | Calmodulin 2 (phosphorylase kinase, |
| | | | | (RCM3), mRNA. Length = 1112 | delta) |
| 25802 | 1113 | NM_031969 | G, K | Rattus norvegicus | Calmodulin 1 (phosphorylase kinase, |
| | | | | Calmodulin 1 (phosphorylase | delta) |
| | | | | kinase, delta) (Calm1), | |
| | | | | mRNA. Length = 3513 | |
| 3878 | 193 | AA893230 | GENERAL | | ESTs, Weakly similar to CALM_HUMAN |
| | | | | | Calmodulin [R. norvegicus] |
| 24233 | 308 | AA964756 | F | | ESTs, Weakly similar to CALM_HUMAN |
| | | | | | Calmodulin [R. norvegicus] |
| 16168 | 194 | AA893280 | GENERAL, J | | ESTs, Moderately similar to |
| | | | | | ADFP_MOUSE ADIPOPHILIN |
| | | | | | (ADIPOSE DIFFERENTIATION- |
| | | | | | RELATED PROTEIN) (ADRP) |
| | | | | | [M. musculus] |
| 16169 | 430 | AI030932 | J | | ESTs, Moderately similar to |
| | | | | | ADFP_MOUSE ADIPOPHILIN |
| | | | | | (ADIPOSE DIFFERENTIATION- |
| | | | | | RELATED PROTEIN) (ADRP) |
| | | | | | [M. musculus] |
| 3172 | 317 | AA997406 | B | | ESTs, Highly similar to PSA7_RAT |
| | | | | | Proteasome subunit alpha type 7 |
| | | | | | (Proteasome subunit RC6-1) |
| | | | | | [R. norvegicus] |
| 13157 | 558 | AI138020 | D | | ESTs, Weakly similar to S43429 diamine |
| | | | | | N-acetyltransferase (EC 2.3.1.57) - |
| | | | | | mouse [M. musculus] |
| 7700 | 534 | AI105383 | GENERAL, D | sphingosine kinase 1 | sphingosine kinase 1 |
| 1847 | 834 | NM_012634 | B | Rattus norvegicus | Phophoribosylpyrophosphate synthetase, |
| | | | | Phophoribosylpyrophosphate | subunit II |
| | | | | synthetase, subunit II | |
| | | | | (Prps2), mRNA. Length = 2697 | |
| 2098 | 20 | AA799995 | C | ribosomal protein L14 | ribosomal protein L14 |
| 16227 | 960 | NM_019137 | F | Rattus norvegicus Zinc-finger | Zinc-finger transcription factor NGFI-C |
| | | | | transcription factor NGFI-C | (early response gene) |
| | | | | (early response gene) | |
| | | | | (Egr4I1), mRNA. Length = 2145 | |
| 23166 | 100 | AA859954 | GENERAL, | Vacuole Membrane Protein 1 | Vacuole Membrane Protein 1 |
| | | | C, L | | |
| 18354 | 1246 | X59859 | J | decorin | decorin |
| 18352 | 1260 | Z12298 | L | decorin | decorin |
| 16552 | 1169 | NM_053961 | L | Rattus norvegicus | endoplasmic retuclum protein 29 |
| | | | | endoplasmic retuclum protein | |
| | | | | 29 (Erp29), mRNA. Length = 4529 | |
| 4280 | 672 | AI230247 | F | selenoprotein P, plasma, 1 | selenoprotein P, plasma, 1 |
| 17088 | 142 | AA891998 | B, L | | ESTs, Highly similar to JC4978 oxidative |
| | | | | | stress protein A170 - mouse |
| | | | | | [M. musculus] |
| 17301 | 926 | NM_017173 | E, I | Rattus norvegicus serine | serine proteinase inhibitor, clade H (heat |
| | | | | proteinase inhibitor, clade H | shock protein 47), member 1 |
| | | | | (heat shock protein 47), | |
| | | | | member 1 (Serpinh1), | |
| | | | | mRNA. Length = 2063 | |
| 1214 | 1102 | NM_031741 | GENERAL, K | Rattus norvegicus solute | solute carrier family 2 (facilitated glucose |
| | | | | carrier family 2 (facilitated | transporter), member 5 |
| | | | | glucose transporter), | |
| | | | | member 5 (Slc2a5), mRNA. | |
| | | | | Length = 2169 | |
| 17468 | 165 | AA892545 | D | | ESTs, Moderately similar to organic |
| | | | | | cationic transporter-like 2 [Mus musculus] |
| | | | | | [M. musculus] |
| 23509 | 383 | AI010962 | A | | ESTs, Highly similar to SNX3_MOUSE |
| | | | | | Sorting nexin 3 (SDP3 protein) |
| | | | | | [M. musculus] |
| 15393 | 581 | AI170663 | J | HHs: sterol regulatory | ESTs, Weakly similar to A48085 |
| | | | | element binding transcription | transcription factor ADD1 - rat |
| | | | | factor 2 | [R. norvegicus] |
| 11692 | 758 | AI638982 | GENERAL | sulfotransferase family, | sulfotransferase family, cytosolic, 1C, |
| | | | | cytosolic, 1C, member 2 | member 2 |
| 494 | 861 | NM_012880 | J | Rattus norvegicus | Superoxide dismutase 3 |
| | | | | Superoxide dismutase 3 | |
| | | | | (Sod3), mRNA. Length = 1729 | |
| 495 | 861 | NM_012880 | J | Rattus norvegicus | Superoxide dismutase 3 |
| | | | | Superoxide dismutase 3 | |
| | | | | (Sod3), mRNA. Length = 1729 | |
| 24821 | 1158 | NM_053788 | J | Rattus norvegicus syntaxin 1 | syntaxin 1 a |
| | | | | a (Stx1a), mRNA. Length = 871 | |
| 7489 | 963 | NM_019169 | GENERAL, | Rattus norvegicus synuclein, | synuclein, alpha |
| | | | G, I, J, L | alpha (Snca), mRNA. Length = 1018 | |
| 3407 | 322 | AA997953 | F | TCF3 (E2A) fusion partner | TCF3 (E2A) fusion partner (in childhood |
| | | | | (in childhood leukemia) | leukemia) |
| 24234 | 1086 | NM_031614 | GENERAL, | Rattus norvegicus | thioredoxin reductase 1 |
| | | | A, I | thioredoxin reductase 1 | |
| | | | | (Txnrd1), mRNA. Length = 3360 | |
| 24235 | 1086 | NM_031614 | GENERAL, | Rattus norvegicus | thioredoxin reductase 1 |
| | | | H, I | thioredoxin reductase 1 | |
| | | | | (Txnrd1), mRNA. Length = 3360 | |
| 17234 | 507 | AI102741 | J | Tissue inhibitor of | Tissue inhibitor of metalloproteinase 3 |
| | | | | metalloproteinase 3 | |
| 15004 | 729 | AI235224 | GENERAL, | tissue inhibitor of | tissue inhibitor of metalloproteinase 1 |
| | | | G, K | metalloproteinase 1 | |
| 15002 | 1160 | NM_053819 | GENERAL, | Rattus norvegicus tissue | tissue inhibitor of metalloproteinase 1 |
| | | | E, G, K | inhibitor of metalloproteinase | |
| | | | | 1 (Timp1), mRNA. Length = 740 | |
| 15003 | 1160 | NM_053819 | G, K | Rattus norvegicus tissue | tissue inhibitor of metalloproteinase 1 |
| | | | | inhibitor of metalloproteinase | |
| | | | | 1 (Timp1), mRNA. Length = 740 | |
| 16039 | 1107 | NM_031811 | H | Rattus norvegicus | transaldolase 1 |
| | | | | transaldolase 1 (Taldo1), | |
| | | | | mRNA. Length = 1057 | |
| 7505 | 1013 | NM_022534 | A | Rattus norvegicus | transcobalamin II precursor |
| | | | | transcobalamin II precursor | |
| | | | | (Tcn2p), mRNA. Length = 1808 | |
| 1885 | 888 | NM_013103 | GENERAL | Rattus norvegicus | Transcription factor 2, hepatic; LF-B3; |
| | | | | Transcription factor 2, | variant hepatic nuclear factor |
| | | | | hepatic; LF-B3; variant | |
| | | | | hepatic nuclear factor (Tcf2), | |
| | | | | mRNA. Length = 2328 | |
| 2125 | 502 | AI102519 | G | | ESTs, Highly similar to TYRO protein |
| | | | | | tyrosine kinase binding protein; killer cell |
| | | | | | activating receptor associated protein |
| | | | | | [Mus musculus] [M. musculus] |
| 15124 | 1175 | NM_057105 | B | Rattus norvegicus UDP | UDP glycosyltransferase 1 family, |
| | | | | glycosyltransferase 1 family, | polypeptide A6, UDP glycosyltransferase |
| | | | | polypeptide A6 (Ugt1a6), | 1 family, polypeptide A7, UDP- |
| | | | | mRNA. Length = 1593 | glucuronosyltransferase 1 family, |
| | | | | | member 1 |
| 15125 | 1175 | NM_057105 | B | Rattus norvegicus UDP | UDP glycosyltransferase 1 family, |
| | | | | glycosyltransferase 1 family, | polypeptide A6, UDP glycosyltransferase |
| | | | | polypeptide A6 (Ugt1a6), | 1 family, polypeptide A7 |
| | | | | mRNA. Length = 1593 | |
| 10241 | 1101 | NM_031740 | C, K | Rattus norvegicus UDP- | UDP-Gal: betaGlcNAc beta 1,4- |
| | | | | Gal: betaGlcNAc beta 1,4- | galactosyltransferase, polypeptide 6 |
| | | | | galactosyltransferase, | |
| | | | | polypeptide 6 (B4galt6), | |
| | | | | mRNA. Length = 5729 | |
| 18597 | 1067 | NM_031325 | B, H | Rattus norvegicus UDP- | UDP-glucose dehydrogeanse |
| | | | | glucose dehydrogeanse | |
| | | | | (Ugdh), mRNA. Length = 2318 | |
| 20443 | 982 | NM_019379 | H | Rattus norvegicus vesicle | vesicle docking protein, 115 kDa |
| | | | | docking protein, 115 kDa | |
| | | | | (Vdp), mRNA. Length = 3842 | |
| 12331 | 1180 | NM_057155 | GENERAL, H | Rattus norvegicus X-prolyl | X-prolyl aminopeptidase (aminopeptidase |
| | | | | aminopeptidase | P) 2, membrane-bound |
| | | | | (aminopeptidase P) 2, | |
| | | | | membrane-bound | |
| | | | | (Xpnpep2), mRNA. Length = 2828 | |
| 12332 | 1180 | NM_057155 | GENERAL, G | Rattus norvegicus X-prolyl | X-prolyl aminopeptidase (aminopeptidase |
| | | | | aminopeptidase | P) 2, membrane-bound |
| | | | | (aminopeptidase P) 2, | |
| | | | | membrane-bound | |
| | | | | (Xpnpep2), mRNA. Length = 2828 | |
| 15008 | 340 | AF038591 | E | cytoplasmic aminopeptidase P | cytoplasmic aminopeptidase P |
| 17695 | 704 | AI232784 | E | | ESTs, Weakly similar to S11021 2,4- |
| | | | | | dienoyl-CoA reductase (NADPH) (EC |
| | | | | | 1.3.1.34) - rat [R. norvegicus] |
| 3279 | 512 | AI103224 | F | | Rattus norvegicus mRNA for carbonyl |
| | | | | | reductase/NADP-retinol dehydrogenase, |
| | | | | | complete cds |
| 4462 | 105 | AA866264 | GENERAL, | | ESTs, Weakly similar to PE2R_RAT 20- |
| | | | A, C, I | | alpha-hydroxysteroid dehydrogenase (20- |
| | | | | | alpha-HSD) (HSD1) [R. norvegicus] |
| 4463 | 135 | AA891831 | GENERAL, | | ESTs, Weakly similar to PE2R_RAT 20- |
| | | | A, I | | alpha-hydroxysteroid dehydrogenase (20- |
| | | | | | alpha-HSD) (HSD1) [R. norvegicus] |
| 21585 | 1087 | NM_031620 | D | Rattus norvegicus 3- | 3-phosphoglycerate dehydrogenase |
| | | | | phosphoglycerate | |
| | | | | dehydrogenase (Phgdh), | |
| | | | | mRNA. Length = 1803 | |
| 21586 | 1087 | NM_031620 | D | Rattus norvegicus 3- | 3-phosphoglycerate dehydrogenase |
| | | | | phosphoglycerate | |
| | | | | dehydrogenase (Phgdh), | |
| | | | | mRNA. Length = 1803 | |
| 21587 | 1087 | NM_031620 | D | Rattus norvegicus 3- | 3-phosphoglycerate dehydrogenase |
| | | | | phosphoglycerate | |
| | | | | dehydrogenase (Phgdh), | |
| | | | | mRNA. Length = 1803 | |
| 22537 | 175 | AA892799 | GENERAL, | HMm: glyoxylate | ESTs, Weakly similar to 3- |
| | | | A, D | reductase/hydroxypyruvate | phosphoglycerate dehydrogenase [Rattus |
| | | | | reductase | norvegicus] [R. norvegicus] |
| 22538 | 175 | AA892799 | GENERAL, D | HMm: glyoxylate | ESTs, Weakly similar to 3- |
| | | | | reductase/hydroxypyruvate | phosphoglycerate dehydrogenase [Rattus |
| | | | | reductase | norvegicus] [R. norvegicus] |
| 22539 | 175 | AA892799 | GENERAL | HMm: glyoxylate | ESTs, Weakly similar to 3- |
| | | | | reductase/hydroxypyruvate | phosphoglycerate dehydrogenase [Rattus |
| | | | | reductase | norvegicus] [R. norvegicus] |
| 22540 | 221 | AA924630 | E | HMm: glyoxylate | ESTs, Weakly similar to 3- |
| | | | | reductase/hydroxypyruvate | phosphoglycerate dehydrogenase [Rattus |
| | | | | reductase | norvegicus] [R. norvegicus] |
| 347 | 1205 | U01914 | D | A kinase anchor protein 8 | A kinase anchor protein 8 |
| 21696 | 1034 | NM_024152 | C | Rattus norvegicus ADP- | ADP-ribosylation factor 6 |
| | | | | ribosylation factor 6 (Arf6), | |
| | | | | mRNA. Length = 995 | |
| 11968 | 597 | AI172208 | F | | ESTs, Weakly similar to FETA_RAT |
| | | | | | Alpha-fetoprotein precursor (Alpha- |
| | | | | | fetoglobulin) (Alpha-1-fetoprotein) |
| | | | | | [R. norvegicus] |
| 4749 | 1110 | NM_031834 | L | Rattus norvegicus | Aryl sulfotransferase cytosolic, 1A, |
| | | | | sulfotransferase family 1A, | phenol-preferring, member 3, |
| | | | | phenol-preferring, member 1 | sulfotransferase family 1A, phenol- |
| | | | | (Sult1a1), mRNA. Length = 1227 | preferring, member 1 |
| 22662 | 725 | AI234939 | GENERAL | ATPase, H+ transporting, | ATPase, H+ transporting, lysosomal |
| | | | | lysosomal (vacuolar proton | (vacuolar proton pump), subunit 1 |
| | | | | pump), subunit 1 | |
| 20841 | 1084 | NM_031604 | H | Rattus norvegicus ATPase, | ATPase, H+ transporting, lysosomal |
| | | | | H+ transporting, lysosomal | (vacuolar proton pump) noncatalytic |
| | | | | (vacuolar proton pump) | accessory protein 1 (110/160 kDa) |
| | | | | noncatalytic accessory | |
| | | | | protein 1 (110/160 kDa) | |
| | | | | (Atp6n1), mRNA. Length = 3876 | |
| 19 | 941 | NM_017258 | GENERAL | Rattus norvegicus B-cell | B-cell translocation gene 1, anti- |
| | | | | translocation gene 1, anti- | proliferative |
| | | | | proliferative (Btg1), mRNA. | |
| | | | | Length = 1464 | |
| 556 | 851 | NM_012803 | GENERAL | Rattus norvegicus Protein C | Protein C |
| | | | | (Proc), mRNA. Length = 1543 | |
| 17836 | 198 | AA893626 | D | | ESTs, Weakly similar to guanine |
| | | | | | nucleotide-binding protein, beta-1# |
| | | | | | subunit [Rattus norvegicus] |
| | | | | | [R. norvegicus] |
| 17550 | 387 | AI011607 | GENERAL, I | epsilon-trimethyllysine | epsilon-trimethyllysine hydroxylase |
| | | | | hydroxylase | |
| 17249 | 137 | AA891858 | K | | ESTs, Weakly similar to cadherin 17 |
| | | | | | [Rattus norvegicus] [R. norvegicus] |
| 24437 | 931 | NM_017190 | A | Rattus norvegicus Myelin- | Myelin-associated glycoprotein |
| | | | | associated glycoprotein | |
| | | | | (Mag), mRNA. Length = 2474 | |
| 6635 | 68 | AA849786 | GENERAL | | ESTs, Weakly similar to CLK3_RAT |
| | | | | | Protein kinase CLK3 (CDC-like kinase 3) |
| | | | | | [R. norvegicus] |
| 15237 | 773 | AI639535 | J | | ESTs, Weakly similar to transporter-like |
| | | | | | protein [Rattus norvegicus] [R. norvegicus] |
| 108 | 797 | L14002 | J | | Rattus norvegicus clone 15 polymeric |
| | | | | | immunoglobulin receptor mRNA, 3′UTR |
| | | | | | microsatellite repeats |
| 3572 | 325 | AA998516 | E | HHs: cyclin A2 | ESTs, Weakly similar to CGB1_RAT |
| | | | | | G2/mitotic-specific cyclin B1 |
| | | | | | [R. norvegicus] |
| 22612 | 262 | AA945624 | GENERAL, I | | ESTs, Weakly similar to A34162 |
| | | | | | NAD(P)H dehydrogenase (quinone) (EC |
| | | | | | 1.6.99.2) - rat [R. norvegicus] |
| 1949 | 1212 | U19614 | A | | Rattus norvegicus lamina associated |
| | | | | | polypeptide 1C (LAP1C) mRNA, |
| | | | | | complete cds, Rattus norvegicus lamina- |
| | | | | | associated polypeptide 1C (LAP1C) |
| | | | | | mRNA, complete cds |
| 7307 | 736 | AI235935 | G, K | | ESTs, Weakly similar to C1TC_RAT C-1- |
| | | | | | tetrahydrofolate synthase, cytoplasmic |
| | | | | | (C1-THF synthase) [Includes: |
| | | | | | Methylenetetrahydrofolate |
| | | | | | dehydrogenase; |
| | | | | | Methenyltetrahydrofolate cyclohydrolase; |
| | | | | | Formyltetrahydrofolate synthetase] |
| | | | | | [R. norvegicus] |
| 1824 | 1210 | U17971 | K | protein tyrosine phosphatase | protein tyrosine phosphatase 2E |
| | | | | 2E | |
| 1727 | 1088 | NM_031642 | GENERAL | Rattus norvegicus core | core promoter element binding protein |
| | | | | promoter element binding | |
| | | | | protein (Copeb), mRNA. | |
| | | | | Length = 1356 | |
| 17535 | 1108 | NM_031816 | E | Rattus norvegicus | retinoblastoma binding protein 7 |
| | | | | retinoblastoma binding | |
| | | | | protein 7 (Rbbp7), mRNA. | |
| | | | | Length = 1947 | |
| 2912 | 373 | AI010220 | GENERAL, | | ESTs, Weakly similar to CLD7_RAT |
| | | | A, F | | CLAUDIN-7 [R. norvegicus] |
| 22648 | 636 | AI178996 | A | | ESTs, Weakly similar to K2C8_RAT |
| | | | | | Keratin, type II cytoskeletal 8 (Cytokeratin |
| | | | | | 8) (Cytokeratin endo A) [R. norvegicus] |
| 1460 | 1199 | S76054 | GENERAL, | | ESTs, Highly similar to K2C8_RAT |
| | | | A, C, I, K | | Keratin, type II cytoskeletal 8 (Cytokeratin |
| | | | | | 8) (Cytokeratin endo A) [R. norvegicus] |
| 16521 | 379 | AI010470 | B, J, L | Ceruloplasmin (ferroxidase) | Ceruloplasmin (ferroxidase) |
| 16520 | 823 | NM_012532 | GENERAL, | Rattus norvegicus | Ceruloplasmin (ferroxidase) |
| | | | B, C, L | Ceruloplasmin (ferroxidase) | |
| | | | | (Cp), mRNA. Length = 3700 | |
| 14484 | 628 | AI177867 | GENERAL | | ESTs, Weakly similar to intersectin (SH3 |
| | | | | | domain protein 1A) [Rattus norvegicus] |
| | | | | | [R. norvegicus] |
| 10667 | 742 | AI236366 | C | siah binding protein 1; FBP | siah binding protein 1; FBP interacting |
| | | | | interacting repressor; | repressor; pyrimidine tract binding |
| | | | | pyrimidine tract binding | splicing factor; Ro ribonucleoprotein- |
| | | | | splicing factor; Ro | binding protein 1 |
| | | | | ribonucleoprotein-binding | |
| | | | | protein 1 | |
| 21796 | 392 | AI012221 | GENERAL, K | | ESTs, Weakly similar to intracellular |
| | | | | | chloride ion channel protein p64H1 |
| | | | | | [Rattus norvegicus] [R. norvegicus] |
| 21797 | 488 | AI072439 | G, K | | ESTs, Weakly similar to intracellular |
| | | | | | chloride ion channel protein p64H1 |
| | | | | | [Rattus norvegicus] [R. norvegicus] |
| 12606 | 1016 | NM_022547 | E, K | Rattus norvegicus 10- | 10-formyltetrahydrofolate dehydrogenase |
| | | | | formyltetrahydrofolate | |
| | | | | dehydrogenase (Fthfd), | |
| | | | | mRNA. Length = 3109 | |
| 7101 | 839 | NM_012679 | GENERAL, E | Rattus norvegicus Clusterin | Clusterin |
| | | | | (Clu), mRNA. Length = 1638 | |
| 20831 | 1147 | NM_053589 | B | Rattus norvegicus GTPase | GTPase Rab14 |
| | | | | Rab14 (Rab14), mRNA. | |
| | | | | Length = 774 | |
| 783 | 859 | NM_012859 | F | Rattus norvegicus Hormone - | Hormone - sensitive lipase, testicular |
| | | | | sensitive lipase, testicular | isoform |
| | | | | isoform (Lipe), mRNA. | |
| | | | | Length = 3704 | |
| 4589 | 343 | AF062389 | GENERAL, D | kidney-specific protein (KS) | Rattus norvegicus kidney-specific protein |
| | | | | | (KS) mRNA, complete cds |
| 15137 | 1050 | NM_031051 | L | Rattus norvegicus | macrophage migration inhibitory factor |
| | | | | macrophage migration | |
| | | | | inhibitory factor (Mif), mRNA. | |
| | | | | Length = 551 | |
| 15138 | 1050 | NM_031051 | C | Rattus norvegicus | macrophage migration inhibitory factor |
| | | | | macrophage migration | |
| | | | | inhibitory factor (Mif), mRNA. | |
| | | | | Length = 551 | |
| 1430 | 816 | M84648 | GENERAL | Dopa decarboxylase | Dopa decarboxylase (aromatic L-amino |
| | | | | (aromatic L-amino acid | acid decarboxylase) |
| | | | | decarboxylase) | |
| 1431 | 824 | NM_012545 | D | Rattus norvegicus Dopa | Dopa decarboxylase (aromatic L-amino |
| | | | | decarboxylase (aromatic L- | acid decarboxylase) |
| | | | | amino acid decarboxylase) | |
| | | | | (Ddc), mRNA. Length = 1954 | |
| 7892 | 661 | AI229172 | K | | ESTs, Weakly similar to FIBA_RAT |
| | | | | | Fibrinogen alpha/alpha-E chain precursor |
| | | | | | [R. norvegicus] |
| 24264 | 876 | NM_012999 | GENERAL | Rattus norvegicus Subtilisin - | Subtilisin - like endoprotease |
| | | | | like endoprotease (Pace4), | |
| | | | | mRNA. Length = 4153 | |
| 21025 | 88 | AA859241 | GENERAL, | synaptojanin 2 binding | synaptojanin 2 binding protein |
| | | | A, C | protein | |
| 21024 | 1021 | NM_022599 | GENERAL | Rattus norvegicus | synaptojanin 2 binding protein |
| | | | | synaptojanin 2 binding | |
| | | | | protein (Synj2bp), mRNA. | |
| | | | | Length = 5215 | |
| 15876 | 169 | AA892582 | G | | ESTs, Highly similar to RL8_HUMAN 60S |
| | | | | | ribosomal protein L8 [R. norvegicus] |
| 343 | 844 | NM_012747 | L | Rattus norvegicus Signal | Signal transducer and activator of |
| | | | | transducer and activator of | transcription 3 |
| | | | | transcription 3 (Stat3), | |
| | | | | mRNA. Length = 2924 | |
| 15110 | 1043 | NM_030827 | GENERAL, I | Rattus norvegicus | glycoprotein 330 |
| | | | | glycoprotein 330 (Lrp2), | |
| | | | | mRNA. Length = 15,438 | |
| 15111 | 1043 | NM_030827 | GENERAL, I | Rattus norvegicus | glycoprotein 330 |
| | | | | glycoprotein 330 (Lrp2), | |
| | | | | mRNA. Length = 15,438 | |
| 15112 | 1043 | NM_030827 | I | Rattus norvegicus | glycoprotein 330 |
| | | | | glycoprotein 330 (Lrp2), | |
| | | | | mRNA. Length = 15,438 | |
| 3822 | 211 | AA900863 | GENERAL, H | | ESTs, Weakly similar to HE47_RAT |
| | | | | | Probable ATP-dependent RNA helicase |
| | | | | | p47 [R. norvegicus] |
| 3823 | 706 | AI233147 | GENERAL | | ESTs, Weakly similar to HE47_RAT |
| | | | | | Probable ATP-dependent RNA helicase |
| | | | | | p47 [R. norvegicus] |
| 20925 | 1019 | NM_022594 | L | Rattus norvegicus enoyl | Peroxisomal enoyl hydratase-like protein |
| | | | | hydratase-like protein, | |
| | | | | peroxisomal (Ech1), mRNA. | |
| | | | | Length = 1097 | |
| 15489 | 1060 | NM_031137 | F | Rattus norvegicus | tripeptidylpeptidase II |
| | | | | tripeptidylpeptidase II (Tpp2), | |
| | | | | mRNA. Length = 4566 | |
| 14983 | 637 | AI179150 | D | | Rattus norvegicus CDK110 mRNA |
| 574 | 985 | NM_019905 | GENERAL, | Rattus norvegicus calpactin I | calpactin I heavy chain, hydroxyacid |
| | | | E, G, K | heavy chain (Anxa2), mRNA. | oxidase 3 (medium-chain), unknown Glu- |
| | | | | Length = 1395 | Pro dipeptide repeat protein |
| 1570 | 1164 | NM_053857 | A | Rattus norvegicus eukaryotic | eukaryotic translation initiation factor 4E |
| | | | | translation initiation factor 4E | binding protein 1 |
| | | | | binding protein 1 (Eif4ebp1), | |
| | | | | mRNA. Length = 843 | |
| 14929 | 1134 | NM_053330 | GENERAL, | Rattus norvegicus ribosomal | ribosomal protein L21 |
| | | | G, K | protein L21 (Rpl21), mRNA. | |
| | | | | Length = 554 | |
| 4392 | 918 | NM_017101 | H | Rattus norvegicus | Peptidylprolyl isomerase A (cyclophilin A) |
| | | | | Peptidylprolyl isomerase A | |
| | | | | (cyclophilin A) (Ppia), mRNA. | |
| | | | | Length = 743 | |
| 1844 | 835 | NM_012637 | J | Rattus norvegicus protein | ESTs, protein tyrosine phosphatase, non- |
| | | | | tyrosine phosphatase, non- | receptor type 1 |
| | | | | receptor type 1 (Ptpn1), | |
| | | | | mRNA. Length = 4127 | |
| 1501 | 489 | AI072634 | GENERAL, | | Rattus norvegicus cytokeratin-18 mRNA, |
| | | | C, G, K | | partial cds |
| 15190 | 503 | AI102562 | GENERAL | Metallothionein 1 A | Metallothionein |
| 15189 | 803 | M11794 | B | Metallothionein 1 A | Metallothionein |
| 1581 | 955 | NM_017365 | GENERAL, | Rattus norvegicus PDZ and | PDZ and LIM domain 1 (elfin) |
| | | | A, C | LIM domain 1 (elfin) | |
| | | | | (Pdlim1), mRNA. Length = 1392 | |
| 1687 | 645 | AI179971 | J | Hemoglobin, alpha 1 | Hemoglobin, alpha 1 |
| 1684 | 885 | NM_013096 | J | Rattus norvegicus | Hemoglobin, alpha 1 |
| | | | | Hemoglobin, alpha 1 (Hba1), | |
| | | | | mRNA. Length = 556 | |
| 1685 | 885 | NM_013096 | J | Rattus norvegicus | Hemoglobin, alpha 1 |
| | | | | Hemoglobin, alpha 1 (Hba1), | |
| | | | | mRNA. Length = 556 | |
| 1688 | 885 | NM_013096 | J | Rattus norvegicus | Hemoglobin, alpha 1 |
| | | | | Hemoglobin, alpha 1 (Hba1), | |
| | | | | mRNA. Length = 556 | |
| 1689 | 885 | NM_013096 | J | Rattus norvegicus | Hemoglobin, alpha 1 |
| | | | | Hemoglobin, alpha 1 (Hba1), | |
| | | | | mRNA. Length = 556 | |
| 25468 | 1123 | NM_033234 | J | Rattus norvegicus | Hemoglobin, beta |
| | | | | Hemoglobin, beta (Hbb), | |
| | | | | mRNA. Length = 620 | |
| 17829 | 1123 | NM_033234 | J | Rattus norvegicus | Hemoglobin, beta |
| | | | | Hemoglobin, beta (Hbb), | |
| | | | | mRNA. Length = 620 | |
| 17832 | 1123 | NM_033234 | J | Rattus norvegicus | Hemoglobin, beta |
| | | | | Hemoglobin, beta (Hbb), | |
| | | | | mRNA. Length = 620 | |
| 17833 | 1123 | NM_033234 | F | Rattus norvegicus | Hemoglobin, beta |
| | | | | Hemoglobin, beta (Hbb), | |
| | | | | mRNA. Length = 620 | |
| 9504 | 549 | AI136723 | F | | ESTs, Weakly similar to ZF37_RAT Zinc |
| | | | | | finger protein 37 (Zfp-37) [R. norvegicus] |
| 15437 | 930 | NM_017187 | E | Rattus norvegicus high | high mobility group box 2 |
| | | | | mobility group box 2 | |
| | | | | (Hmgb2), mRNA. Length = 1072 | |
| 22412 | 1005 | NM_022392 | C, H | Rattus norvegicus growth | growth response protein (CL-6) |
| | | | | response protein (CL-6) | |
| | | | | (LOC64194), mRNA. Length = 2410 | |
| 22413 | 1005 | NM_022392 | C, H | Rattus norvegicus growth | growth response protein (CL-6) |
| | | | | response protein (CL-6) | |
| | | | | (LOC64194), mRNA. Length = 2410 | |
| 22414 | 1005 | NM_022392 | H | Rattus norvegicus growth | growth response protein (CL-6) |
| | | | | response protein (CL-6) | |
| | | | | (LOC64194), mRNA. Length = 2410 | |
| 22415 | 1005 | NM_022392 | C | Rattus norvegicus growth | growth response protein (CL-6) |
| | | | | response protein (CL-6) | |
| | | | | (LOC64194), mRNA. Length = 2410 | |
| 11434 | 778 | D14014 | B | Cyclin D1 | Cyclin D1 |
| 24232 | 1252 | X75207 | B | Cyclin D1 | Cyclin D1 |
| 19112 | 764 | AI639157 | J | ribosomal protein L13 | ribosomal protein L13 |
| 23854 | 1054 | NM_031101 | G | Rattus norvegicus ribosomal | ribosomal protein L13 |
| | | | | protein L13 (Rpl13), mRNA. | |
| | | | | Length = 722 | |
| 165 | 561 | AI145329 | F | malate dehydrogenase | malate dehydrogenase mitochondrial |
| | | | | mitochondrial | |
| 1858 | 1064 | NM_031315 | B, L | Rattus norvegicus acyl-CoA | acyl-CoA thioesterase 1, cytosolic, |
| | | | | thioesterase 1, cytosolic | mitochondrial acyl-CoA thioesterase 1 |
| | | | | (Cte1), mRNA. Length = 1591 | |
| 1478 | 843 | NM_012744 | GENERAL | Rattus norvegicus Pyruvate | Pyruvate carboxylase |
| | | | | carboxylase (Pc), mRNA. | |
| | | | | Length = 3945 | |
| 1479 | 843 | NM_012744 | D | Rattus norvegicus Pyruvate | Pyruvate carboxylase |
| | | | | carboxylase (Pc), mRNA. | |
| | | | | Length = 3945 | |
| 4441 | 1249 | X62146 | G | | ESTs, Highly similar to RL11_HUMAN |
| | | | | | 60S ribosomal protein L11 [R. norvegicus] |
| 18612 | 658 | AI228624 | G | ribosomal protein L29 | ribosomal protein L29 |
| 18642 | 500 | AI102023 | C | | Rattus norvegicus mRNA for ribosomal |
| | | | | | protein L35 |
| 19040 | 1058 | NM_031114 | GENERAL, | Rattus norvegicus S-100 | S-100 related protein, clone 42C |
| | | | C, G, K | related protein, clone 42C | |
| | | | | (S100A10), mRNA. Length = 573 | |
| 13647 | 155 | AA892367 | G | | ESTs, Highly similar to RL3_RAT 60S |
| | | | | | RIBOSOMAL PROTEIN L3 (L4) |
| | | | | | [R. norvegicus] |
| 13646 | 1250 | X62166 | GENERAL, | | ESTs, Highly similar to RL3_RAT 60S |
| | | | A, G | | RIBOSOMAL PROTEIN L3 (L4) |
| | | | | | [R. norvegicus] |
| 2232 | 303 | AA963990 | D | | ESTs, Weakly similar to S70642 ubiquitin |
| | | | | | ligase Nedd4 - rat (fragment) |
| | | | | | [R. norvegicus] |
| 17661 | 1025 | NM_022674 | E | Rattus norvegicus H2A | H2A histone family, member Z |
| | | | | histone family, member Z | |
| | | | | (H2afz), mRNA. Length = 811 | |
| 18269 | 129 | AA891769 | GENERAL, | | ESTs, Weakly similar to SC65 |
| | | | D, L | | synaptonemal complex protein [Rattus |
| | | | | | norvegicus] [R. norvegicus] |
| 3125 | 682 | AI231028 | K | erythrocyte protein band 4.1- | erythrocyte protein band 4.1-like 1 |
| | | | | like 1 | |
| 1490 | 1226 | U63839 | E | nucleoporin p58 | nucleoporin p58 |
| 17378 | 1061 | NM_031138 | D | Rattus norvegicus ubiquitin | ubiquitin conjugating enzyme |
| | | | | conjugating enzyme | |
| | | | | (LOC81816), mRNA. Length = 1737 | |
| 2010 | 1206 | U05675 | K | | Rattus norvegicus Sprague-Dawley |
| | | | | | fibrinogen B beta chain mRNA, complete |
| | | | | | cds |
| 23445 | 849 | NM_012792 | GENERAL | Rattus norvegicus Flavin- | Flavin-containing monooxygenase 1 |
| | | | | containing monooxygenase 1 | |
| | | | | (Fmo1), mRNA. Length = 2042 | |
| 9191 | 485 | AI072107 | A | | ESTs, Weakly similar to 2008147B |
| | | | | | protein RAKc [Rattus norvegicus] |
| | | | | | [R. norvegicus] |
| 3512 | 927 | NM_017177 | F | Rattus norvegicus | choline kinase-like |
| | | | | choline/ethanolamine kinase | |
| | | | | (Chetk), mRNA. Length = 1679 | |
| 23195 | 223 | AA925026 | GENERAL | | ESTs, Weakly similar to MCT7_RAT Mast |
| | | | | | cell protease 7 precursor (RMCP-7) |
| | | | | | (Tryptase, skin) [R. norvegicus] |
| 12587 | 668 | AI229979 | GENERAL | | ESTs, Weakly similar to MOT2_RAT |
| | | | | | Monocarboxylate transporter 2 (MCT 2) |
| | | | | | [R. norvegicus] |
| 725 | 1225 | U62316 | B | solute carrier family 16 | solute carrier family 16 (monocarboxylic |
| | | | | (monocarboxylic acid | acid transporters), member 7 |
| | | | | transporters), member 7 | |
| 1558 | 1217 | U28504 | H | solute carrier family 17 | solute carrier family 17 vesicular |
| | | | | vesicular glutamate | glutamate transporter), member 1 |
| | | | | transporter), member 1 | |
| 2109 | 1010 | NM_022511 | G | Rattus norvegicus profilin | profilin |
| | | | | (Pfn1), mRNA. Length = 689 | |
| 20449 | 1074 | NM_031530 | GENERAL | Rattus norvegicus Small | Small inducible gene JE |
| | | | | inducible gene JE (Scya2), | |
| | | | | mRNA. Length = 780 | |
| 954 | 1121 | NM_032061 | B | Rattus norvegicus contactin | contactin associated protein 1 |
| | | | | associated protein 1 | |
| | | | | (Cntnap1), mRNA. Length = 5350 | |
| 15273 | 1063 | NM_031237 | E | Rattus norvegicus ubiquitin- | ubiquitin-conjugating enzyme E2D 3 |
| | | | | conjugating enzyme E2D 3 | (homologous to yeast UBC4/5) |
| | | | | (homologous to yeast | |
| | | | | UBC4/5) (Ube2d3), mRNA. | |
| | | | | Length = 1531 | |
| 15277 | 1063 | NM_031237 | D | Rattus norvegicus ubiquitin- | ubiquitin-conjugating enzyme E2D 3 |
| | | | | conjugating enzyme E2D 3 | (homologous to yeast UBC4/5) |
| | | | | (homologous to yeast | |
| | | | | UBC4/5) (Ube2d3), mRNA. | |
| | | | | Length = 1531 | |
| 25290 | 1174 | NM_057100 | J | Rattus norvegicus growth | growth arrest specific 6 |
| | | | | arrest specific 6 (Gas6), | |
| | | | | mRNA. Length = 2573 | |
| 2632 | 965 | NM_019213 | A, D | Rattus norvegicus jumping | jumping translocation breakpoint |
| | | | | translocation breakpoint | |
| | | | | (Jtb), mRNA. Length = 897 | |
| 23307 | 1176 | NM_057119 | D | Rattus norvegicus splicing | splicing factor, arginine/serine-rich |
| | | | | factor, arginine/serine-rich | (transformer 2 Drosophila homolog) 10 |
| | | | | (transformer 2 Drosophila | |
| | | | | homolog) 10 (Sfrs10), | |
| | | | | mRNA. Length = 1978 | |
| 16006 | 344 | AF062594 | GENERAL | nucleosome assembly | nucleosome assembly protein 1-like 1 |
| | | | | protein 1-like 1 | |
| 16007 | 344 | AF062594 | E | nucleosome assembly | nucleosome assembly protein 1-like 1 |
| | | | | protein 1-like 1 | |
| 7665 | 429 | AI030668 | E | nucleosome assembly | nucleosome assembly protein 1-like 1 |
| | | | | protein 1-like 1 | |
| 1312 | 1130 | NM_053291 | J | Rattus norvegicus | ESTs, Highly similar to A33792 |
| | | | | phosphoglycerate kinase 1 | phosphoglycerate kinase (EC 2.7.2.3) - |
| | | | | (Pgk1), mRNA. Length = 1675 | rat [R. norvegicus], phosphoglycerate |
| | | | | | kinase 1 |
| 21400 | 811 | M36410 | C, F | sepiapterin reductase | sepiapterin reductase |
| 10464 | 793 | J05510 | GENERAL, I | Inositol 1,4,5-triphosphate | Inositol 1,4,5-triphosphate receptor type 1 |
| | | | | receptor type 1 | |
| 20848 | 954 | NM_017343 | GENERAL, | Rattus norvegicus myosin | Rat mRNA for myosin regulatory light |
| | | | G, K | regulatory light chain | chain (RLC) |
| | | | | (MRLCB), mRNA. Length = 1139 | |
| 20849 | 954 | NM_017343 | GENERAL, | Rattus norvegicus myosin | Rat mRNA for myosin regulatory light |
| | | | G, K | regulatory light chain | chain (RLC) |
| | | | | (MRLCB), mRNA. Length = 1139 | |
| 6290 | 571 | AI169232 | C | kinase D-interacting | kinase D-interacting substance of 220 kDa |
| | | | | substance of 220 kDa | |
| 20682 | 1028 | NM_022952 | B | Rattus norvegicus clathrin- | clathrin-associated protein 17 |
| | | | | associated protein 17 | |
| | | | | (Ap2s1), mRNA. Length = 797 | |
| 20753 | 1104 | NM_031763 | GENERAL, | Rattus norvegicus platelet- | platelet-activating factor acetylhydrolase |
| | | | C, I | activating factor | beta subunit (PAF-AH beta) |
| | | | | acetylhydrolase beta subunit | |
| | | | | (PAF-AH beta) (Pafah1b1), | |
| | | | | mRNA. Length = 1233 | |
| 17570 | 626 | AI177683 | C, E | | Rattus norvegicus mRNA for hnRNP |
| | | | | | protein, partial |
| 19110 | 872 | NM_012963 | A, J | Rattus norvegicus High | High mobility group 1 |
| | | | | mobility group 1 (Hmg1), | |
| | | | | mRNA. Length = 1225 | |
| 19433 | 57 | AA819776 | H | | ESTs, Weakly similar to HS9B_RAT Heat |
| | | | | | shock protein HSP 90-beta (HSP 84) |
| | | | | | [R. norvegicus] |
| 20795 | 253 | AA944397 | H | HMm: heat shock protein, 86 kDa 1 | ESTs, Moderately similar to HS9B_RAT |
| | | | | | Heat shock protein HSP 90-beta (HSP |
| | | | | | 84) [R. norvegicus] |
| 16518 | 612 | AI176546 | C, K | HMm: heat shock protein, 86 kDa 1 | ESTs, Moderately similar to HS9B_RAT |
| | | | | | Heat shock protein HSP 90-beta (HSP |
| | | | | | 84 [R. norvegicus] |
| 11840 | 1258 | Y15068 | H, I | stress-induced- | stress-induced-phosphoprotein 1 |
| | | | | phosphoprotein 1 | (Hsp70/Hsp90-organizing protein) |
| | | | | (Hsp70/Hsp90-organizing | |
| | | | | protein) | |
| 9067 | 460 | AI070087 | GENERAL | | ESTs, Weakly similar to NUCL_RAT |
| | | | | | Nucleolin (Protein C23) [R. norvegicus] |
| 3016 | 37 | AA818069 | H | polyubiquitin | polyubiquitin |
| 3015 | 779 | D16554 | A | polyubiquitin | polyubiquitin |
| 825 | 270 | AA946108 | GENERAL, A | | Rattus norvegicus laminin-5 alpha 3 |
| | | | | | chain mRNA, complete cds |
| 18070 | 898 | NM_013160 | GENERAL | Rattus norvegicus Max | Max interacting protein 1 |
| | | | | interacting protein 1 (Mxi1), | |
| | | | | mRNA. Length = 922 | |
| 3467 | 756 | AI237835 | GENERAL, I | | ESTs, Moderately similar to MXI1_RAT |
| | | | | | MAX interacting protein 1 (MXI1 protein) |
| | | | | | [R. norvegicus] |
| 3465 | 898 | NM_013160 | GENERAL, | Rattus norvegicus Max | ESTs, Moderately similar to MXI1_RAT |
| | | | B, F | interacting protein 1 (Mxi1), | MAX interacting protein 1 (MXI1 protein) |
| | | | | mRNA. Length = 922 | [R. norvegicus] |
| 1970 | 900 | NM_013194 | K | Rattus norvegicus Myosin, | Myosin, heavy polypeptide 9, non-muscle |
| | | | | heavy polypeptide 9, non- | |
| | | | | muscle (Myh9), mRNA. | |
| | | | | Length = 6060 | |
| 1141 | 1007 | NM_022401 | GENERAL, | Rattus norvegicus plectin | plectin |
| | | | C, G | (Plec1), mRNA. Length = 15,231 | |
| 4445 | 602 | AI175466 | G | | ESTs, Weakly similar to RASH_RAT |
| | | | | | TRANSFORMING PROTEIN P21/H-RAS- |
| | | | | | 1 (C-H-RAS) [R. norvegicus] |
| 18741 | 107 | AA874859 | GENERAL | | ESTs, Weakly similar to S70642 ubiquitin |
| | | | | | ligase Nedd4 - rat (fragment) |
| | | | | | [R. norvegicus] |
| 12016 | 158 | AA892404 | C | | ESTs, Weakly similar to S70642 ubiquitin |
| | | | | | ligase Nedd4 - rat (fragment) |
| | | | | | [R. norvegicus] |
| 5601 | 700 | AI232461 | GENERAL, I | flavin containing | ESTs, Weakly similar to S33758 flavin- |
| | | | | monooxygenase 4 | containing monooxygenase 1 —rat |
| | | | | | [R. norvegicus] |
| 15535 | 946 | NM_017283 | L | Rattus norvegicus | proteasome (prosome, macropain) |
| | | | | proteasome (prosome, | subunit, alpha type 6 |
| | | | | macropain) subunit, alpha | |
| | | | | type 6 (Psma6), mRNA. | |
| | | | | Length = 932 | |
| 15538 | 946 | NM_017283 | L | Rattus norvegicus | proteasome (prosome, macropain) |
| | | | | proteasome (prosome, | subunit, alpha type 6 |
| | | | | macropain) subunit, alpha | |
| | | | | type 6 (Psma6), mRNA. | |
| | | | | Length = 932 | |
| 17345 | 144 | AA892014 | E | HLA-B associated transcript | HLA-B associated transcript 1A |
| | | | | 1A | |
| 18678 | 685 | AI231295 | L | | ESTs, Weakly similar to SM4F_RAT |
| | | | | | Semaphorin 4F precursor (Semaphorin |
| | | | | | W) (Sema W) [R. norvegicus] |
| 17771 | 42 | AA818224 | GENERAL | | Rat mRNA for beta-tubulin T beta15 |
| 18361 | 12 | AA799591 | GENERAL | | ESTs, Highly similar to TBB1_RAT |
| | | | | | TUBULIN BETA CHAIN (T BETA-15) |
| | | | | | [R. norvegicus] |
| 8215 | 588 | AI171692 | D | ferritin light chain 1 | ESTs, Highly similar to S66270 |
| | | | | | kynurenine—oxoglutarate transaminase |
| | | | | | (EC 2.6.1.7)/glutamine - phenylpyruvate |
| | | | | | transaminase (EC 2.6.1.64) mitochondrial |
| | | | | | precursor [validated] - rat [R. norvegicus], |
| | | | | | ferritin light chain 1 |
| 8211 | 1008 | NM_022500 | H | Rattus norvegicus ferritin | ferritin light chain 1 |
| | | | | light chain 1 (Ftl1), mRNA. | |
| | | | | Length = 552 | |
| 8212 | 1008 | NM_022500 | L | Rattus norvegicus ferritin | ferritin light chain 1 |
| | | | | light chain 1 (Ftl1), mRNA. | |
| | | | | Length = 552 | |
| 8210 | 1195 | S61960 | GENERAL | ferritin light chain 1 | ferritin light chain 1 |
| 1410 | 1126 | NM_052798 | H | Rattus norvegicus Kidney 1 | zinc finger protein 354A |
| | | | | (Kid1), mRNA. Length = 2563 | |
| 8640 | 1184 | NM_057211 | D | Rattus norvegicus Kruppel- | Kruppel-like factor 9 |
| | | | | like factor 9 (Klf9), mRNA. | |
| | | | | Length = 2721 | |
| 9541 | 1015 | NM_022542 | L | Rattus norvegicus rhoB gene | rhoB gene |
| | | | | (Arhb), mRNA. Length = 2183 | |
| 20126 | 826 | NM_012591 | K | Rattus norvegicus Interferon | Interferon regulatory factor 1, sirtuin 2 |
| | | | | regulatory factor 1 (Irf1), | (silent mating type information regulation |
| | | | | mRNA. Length = 2078 | 2, homolog) 2 (S. cerevisiae) |
| 15069 | 1111 | NM_031840 | H | Rattus norvegicus | Farnesyl diphosphate synthase |
| | | | | Farnesyldiphosphate | |
| | | | | synthase (Fdps), mRNA. | |
| | | | | Length = 1271 | |
| 23778 | 209 | AA899854 | E | topoisomerase (DNA) II | topoisomerase (DNA) II alpha |
| | | | | alpha | |
| 23780 | 1001 | NM_022183 | E | Rattus norvegicus | topoisomerase (DNA) II alpha |
| | | | | topoisomerase (DNA) II | |
| | | | | alpha (Top2a), mRNA. | |
| | | | | Length = 6052 | |
| 16718 | 538 | AI111537 | H | | Rat mRNA for RT1.D beta chain, Rattus |
| | | | | | norvegicus Class II MHC RT1.D(u) beta |
| | | | | | chain precursor (RT1.D(u)) mRNA, |
| | | | | | complete cds |
| 19678 | 992 | NM_021653 | GENERAL | Rattus norvegicus Thyroxine | Thyroxine deiodinase, type I |
| | | | | deiodinase, type I (Dio1), | |
| | | | | mRNA. Length = 2106 | |
| 19679 | 992 | NM_021653 | GENERAL, | Rattus norvegicus Thyroxine | Thyroxine deiodinase, type I |
| | | | A, D, G, I | deiodinase, type I (Dio1), | |
| | | | | mRNA. Length = 2106 | |
| 1943 | 912 | NM_017061 | L | Rattus norvegicus Lysyl | Lysyl oxidase |
| | | | | oxidase (Lox), mRNA. | |
| | | | | Length = 4557 | |
| 1946 | 912 | NM_017061 | F | Rattus norvegicus Lysyl | Lysyl oxidase |
| | | | | oxidase (Lox), mRNA. | |
| | | | | Length = 4557 | |
| 22386 | 27 | AA800844 | F | | ESTs, Moderately similar to LYOX_RAT |
| | | | | | Protein-lysine 6-oxidase precursor (Lysyl |
| | | | | | oxidase) [R. norvegicus] |
| 8829 | 845 | NM_012749 | GENERAL, | Rattus norvegicus Nucleolin | Nucleolin |
| | | | A, F, K | (Ncl), mRNA. Length = 2142 | |
| 17477 | 1181 | NM_057194 | GENERAL, | Rattus norvegicus | phospholipid scramblase 1 |
| | | | K, L | phospholipid scramblase 1 | |
| | | | | (Plscr1), mRNA. Length = 1569 | |
| 6321 | 496 | AI101256 | GENERAL | | ESTs, Weakly similar to S09017 |
| | | | | | heterogeneous ribonuclear particle |
| | | | | | protein type C - rat (fragment) |
| | | | | | [R. norvegicus] |
| 1453 | 1165 | NM_053887 | F, K | Rattus norvegicus mitogen | mitogen activated protein kinase kinase |
| | | | | activated protein kinase | kinase 1 |
| | | | | kinase kinase 1 (Map3k1), | |
| | | | | mRNA. Length = 5180 | |
| 1454 | 1165 | NM_053887 | GENERAL, K | Rattus norvegicus mitogen | mitogen activated protein kinase kinase |
| | | | | activated protein kinase | kinase 1 |
| | | | | kinase kinase 1 (Map3k1), | |
| | | | | mRNA. Length = 5180 | |
| 13723 | 871 | NM_012935 | K | Rattus norvegicus Crystallin, | Crystallin, alpha polypeptide 2, ESTs, |
| | | | | alpha polypeptide 2 (Cryab), | ESTs, Weakly similar to T46637 |
| | | | | mRNA. Length = 528 | transcription factor 1, neural —rat |
| | | | | | [R. norvegicus] |
| 22596 | 277 | AA955298 | GENERAL | | ESTs, Weakly similar to T46637 |
| | | | | | transcription factor 1, neural - rat |
| | | | | | [R. norvegicus] |
| 16354 | 782 | D50564 | C | mercaptopyruvate | mercaptopyruvate sulfurtransferase |
| | | | | sulfurtransferase | |
| 21165 | 1047 | NM_031005 | K | Rattus norvegicus non- | actinin, alpha 1 |
| | | | | muscle alpha-actinin 1 | |
| | | | | (Actn1), mRNA. Length = 2956 | |
| 21166 | 1047 | NM_031005 | K | Rattus norvegicus non- | actinin, alpha 1 |
| | | | | muscle alpha-actinin 1 | |
| | | | | (Actn1), mRNA. Length = 2956 | |
| 20983 | 440 | AI044900 | K | fatty acid Coenzyme A | fatty acid Coenzyme A ligase, long chain 2 |
| | | | | ligase, long chain 2 | |
| 15904 | 414 | AI013971 | F | neurofascin | neurofascin |
| 1993 | 1089 | NM_031655 | GENERAL, | Rattus norvegicus latexin | latexin |
| | | | E, G, K | (Lxn), mRNA. Length = 1087 | |
| 20780 | 1017 | NM_022590 | GENERAL, D | Rattus norvegicus low affinity | low affinity Na-dependent glucose |
| | | | | Na-dependent glucose | transporter (SGLT2) |
| | | | | transporter (SGLT2) (Sglt2), | |
| | | | | mRNA. Length = 2254 | |
| 6641 | 1012 | NM_022533 | GENERAL, | Rattus norvegicus | plasmolipin |
| | | | A, I | plasmolipin (Z49858), | |
| | | | | mRNA. Length = 1475 | |
| 5711 | 442 | AI045151 | GENERAL | | ESTs, Weakly similar to solute carrier |
| | | | | | family 25 (carnitine/acylcarnitine |
| | | | | | translocase), member 20 [Rattus |
| | | | | | norvegicus] [R. norvegicus] |
| 19768 | 1119 | NM_031986 | GENERAL, | Rattus norvegicus syntenin | syntenin |
| | | | C, G | (Sdcbp), mRNA. Length = 2077 | |
| 24649 | 903 | NM_016988 | C, K | Rattus norvegicus Acid | Acid phosphatase 2, lysozymal |
| | | | | phosphatase 2, lysozymal | |
| | | | | (Acp2), mRNA. Length = 2009 | |
| 1698 | 906 | NM_017000 | GENERAL, | Rattus norvegicus | Diaphorase (NADH/NADPH) |
| | | | B, H, I | Diaphorase (NADH/NADPH) | |
| | | | | (Dia4), mRNA. Length = 1396 | |
| 24431 | 868 | NM_012912 | GENERAL, F | Rattus norvegicus Activating | Activating transcription factor 3 |
| | | | | transcription factor 3 (Atf3), | |
| | | | | mRNA. Length = 1893 | |
| 3438 | 182 | AA892921 | K | | ESTs, Weakly similar to A55143 calpain |
| | | | | | (EC 3.4.22.17) light chain - rat (fragment) |
| | | | | | [R. norvegicus] |
| 24496 | 837 | NM_012654 | GENERAL, | Rattus norvegicus Solute | Solute carrier family 9 (sodium/hydrogen |
| | | | I, K | carrier family 9 | exchanger 3), antiporter 3, Na+/H+ |
| | | | | (sodium/hydrogen exchanger | (amiloride insensitive) |
| | | | | 3), antiporter 3, Na+/H+ | |
| | | | | (amiloride insensitive) | |
| | | | | (Slc9a3), mRNA. Length = 5153 | |
| 16350 | 777 | AJ011811 | G | claudin 7 | claudin 7 |
| 16351 | 777 | AJ011811 | G | claudin 7 | claudin 7 |
| 21914 | 1257 | Y13336 | J | defender against cell death 1 | defender against cell death 1 |
| 7784 | 848 | NM_012789 | GENERAL, I | Rattus norvegicus Dipeptidyl | Dipeptidyl peptidase 4 |
| | | | | peptidase 4 (Dpp4), mRNA. | |
| | | | | Length = 4835 | |
| 21145 | 339 | AF038571 | GENERAL, B | Solute carrier family 1 A1 | Solute carrier family 1 A1 (brain |
| | | | | (brain glutamate transporter) | glutamate transporter) |
| 21147 | 784 | D63772 | GENERAL, | Solute carrier family 1 A1 | Solute carrier family 1 A1 (brain |
| | | | F, H, I, J, L | (brain glutamate transporter) | glutamate transporter) |
| 23961 | 929 | NM_017181 | GENERAL, | Rattus norvegicus | fumarylacetoacetate hydrolase |
| | | | E, G, I | fumarylacetoacetate | |
| | | | | hydrolase (Fah), mRNA. | |
| | | | | Length = 1386 | |
| 18990 | 1072 | NM_031509 | H | Rattus norvegicus | Glutathione-S-transferase, alpha type |
| | | | | Glutathione-S-transferase, | (Yc?) |
| | | | | alpha type (Ya) (Gsta1), | |
| | | | | mRNA. Length = 1178 | |
| 20817 | 398 | AI012589 | GENERAL | glutathione S-transferase, pi 2 | glutathione S-transferase, pi 2 |
| 20818 | 1233 | X02904 | GENERAL | glutathione S-transferase, pi 2 | glutathione S-transferase, pi 2 |
| 6630 | 594 | AI172184 | F | | ESTs, Weakly similar to SYPH_RAT |
| | | | | | SYNAPTOPHYSIN (MAJOR SYNAPTIC |
| | | | | | VESICLE PROTEIN P38) [R. norvegicus] |
| 17908 | 967 | NM_019242 | GENERAL | Rattus norvegicus interferon- | interferon-related developmental |
| | | | | related developmental | regulator 1 |
| | | | | regulator 1 (Ifrd1), mRNA. | |
| | | | | Length = 1736 | |
| 17850 | 508 | AI102750 | H | | ESTs, Weakly similar to JQ0866 T- |
| | | | | | complex protein 1 - rat [R. norvegicus] |
| 187 | 866 | NM_012903 | F | Rattus norvegicus Acid | Acid nuclear phosphoprotein 32 (leucine |
| | | | | nuclear phosphoprotein 32 | rich) |
| | | | | (leucine rich) (Anp32), | |
| | | | | mRNA. Length = 1017 | |
| 24762 | 1139 | NM_053442 | GENERAL, D | Rattus norvegicus solute | solute carrier family 7 (cationic amino |
| | | | | carrier family 8 (cationic | acid transporter, y+ system), member 8 |
| | | | | amino acid transporter, y+ | |
| | | | | system), member 7 (Lat4), | |
| | | | | mRNA. Length = 4117 | |
| 22434 | 874 | NM_012974 | F | Rattus norvegicus Laminin | Laminin chain beta 2 |
| | | | | chain beta 2 (Lamb2), | |
| | | | | mRNA. Length = 5581 | |
| 16147 | 1220 | U51898 | GENERAL | phospholipase A2, group VI | phospholipase A2, group VI |
| 13609 | 161 | AA892468 | GENERAL, | protease, serine, 8 | protease, serine, 8 (prostasin) |
| | | | H, I | (prostasin) | |
| 13610 | 161 | AA892468 | GENERAL, | protease, serine, 8 | protease, serine, 8 (prostasin) |
| | | | A, C, F, H, I, K | (prostasin) | |
| 13611 | 639 | AI179378 | GENERAL, | protease, serine, 8 | protease, seine, 8 (prostasin) |
| | | | F, H | (prostasin) | |
| 7299 | 413 | AI013911 | GENERAL, | | ESTs, Weakly similar to cold inducible |
| | | | A, B, L | | RNA-binding protein [Rattus norvegicus] |
| | | | | | [R. norvegicus] |
| 23806 | 842 | NM_012733 | D | Rattus norvegicus Retinol- | Retinol-binding protein 1 |
| | | | | binding protein 1 (Rbp1), | |
| | | | | mRNA. Length = 601 | |
| 20886 | 886 | NM_013097 | E, G | Rattus norvegicus | Deoxyribonuclease I |
| | | | | Deoxyribonuclease I | |
| | | | | (Dnase1), mRNA. Length = 1143 | |
| 20887 | 886 | NM_013097 | E, G | Rattus norvegicus | Deoxyribonuclease I |
| | | | | Deoxyribonuclease I | |
| | | | | (Dnase1), mRNA. Length = 1143 | |
| 13392 | 922 | NM_017148 | GENERAL | Rattus norvegicus cysteine | cysteine rich protein 1 |
| | | | | rich protein 1 (Csrp1), | |
| | | | | mRNA. Length = 1403 | |
| 17325 | 22 | AA800587 | GENERAL, | | ESTs, Weakly similar to GSHC_RAT |
| | | | G, K | | Glutathione peroxidase (GSHPX-1) |
| | | | | | (Cellular glutathione peroxidase) |
| | | | | | [R. norvegicus] |
| 6675 | 36 | AA817994 | C | | ESTs, Weakly similar to regulator of G- |
| | | | | | protein signaling 3 [Rattus norvegicus] |
| | | | | | [R. norvegicus] |
| 1510 | 937 | NM_017224 | GENERAL, | Rattus norvegicus organic | solute carrier family 22 (organic anion |
| | | | D, K | cationic transporter-like 1 | transporter), member 6 |
| | | | | (Orctl1), mRNA. Length = 2227 | |
| 15986 | 1256 | Y09945 | GENERAL, I | putative integral membrane | putative integral membrane transport |
| | | | | transport UST1r | UST1r |
| 23076 | 752 | AI237388 | K | | ESTs, Weakly similar to IFR1_RAT |
| | | | | | INTERFERON-RELATED |
| | | | | | DEVELOPMENTAL REGULATOR 1 |
| | | | | | (NERVE GROWTH FACTOR- |
| | | | | | INDUCIBLE PROTEIN PC4) (IRPR) |
| | | | | | [R. norvegicus] |
| 17363 | 227 | AA925150 | F, K | | ESTs, Moderately similar to 2118320A |
| | | | | | neurodegeneration-associated protein 1 |
| | | | | | [Rattus norvegicus] [R. norvegicus] |
| 23261 | 226 | AA925145 | GENERAL, I | | ESTs, Weakly similar to betaine- |
| | | | | | homocysteine methyltransferase [Rattus |
| | | | | | norvegicus] [R. norvegicus] |
| 11653 | 62 | AA848689 | A, F | HMm:carbonic anhydrase 5b, | ESTs, Weakly similar to CAH5_RAT |
| | | | | mitochondrial | Carbonic anhydrase VA, mitochondrial |
| | | | | | precursor (Carbonate dehydratase VA) |
| | | | | | (CA-VA) [R. norvegicus] |
| 1962 | 995 | NM_021750 | J | Rattus norvegicus cysteine- | CCA2 protein |
| | | | | sulfinate decarboxylase | |
| | | | | (Csad), mRNA. Length = 2413 | |
| 4312 | 333 | AB010635 | J | carboxylesterase 2 (intestine, | carboxylesterase 2 (intestine, liver) |
| | | | | liver) | |
| 15132 | 684 | AI231180 | G | | ESTs, Moderately similar to JC4588 RNA- |
| | | | | | binding protein PIPPin - rat |
| | | | | | [R. norvegicus] |
| 770 | 1080 | NM_031584 | GENERAL | Rattus norvegicus solute | solute carrier family 22, member 2 |
| | | | | carrier family 22, member 2 | |
| | | | | (Slc22a2), mRNA. Length = 2152 | |
| 11162 | 354 | AI008183 | C | | ESTs, Weakly similar to solute carrier |
| | | | | | family 29 (nucleoside transporters), |
| | | | | | member 1 [Rattus norvegicus] |
| | | | | | [R. norvegicus] |
| 20741 | 347 | AF084186 | A, J | alpha-fodrin | alpha-fodrin |
| 19822 | 643 | AI179599 | A | Ras-related GTP-binding | Ras-related GTP-binding protein Rab29 |
| | | | | protein Rab29 | |
| 18300 | 878 | NM_013030 | GENERAL, | Rattus norvegicus Solute | Rattus norvegicus mRNA for NaPi-2 |
| | | | H, I, L | carrier family 17 | alpha, complete cds |
| | | | | (sodium/hydrogen | |
| | | | | exchanger), member 2 | |
| | | | | (Slc34a1), mRNA. Length = 2440 | |
| 23321 | 176 | AA892821 | GENERAL | aldo-keto reductase family 7, | aldo-keto reductase family 7, member A2 |
| | | | | member A2 (aflatoxin | (aflatoxin aldehyde reductase) |
| | | | | aldehyde reductase) | |
| 20864 | 901 | NM_013215 | B, J | Rattus norvegicus aflatoxin | aflatoxin B1 aldehyde reductase |
| | | | | B1 aldehyde reductase | |
| | | | | (AFAR), mRNA. Length = 1272 | |
| 14763 | 256 | AA944481 | L | | ESTs, Weakly similar to FCN2_RAT |
| | | | | | Ficolin 2 precursor (Collagen/fibrinogen |
| | | | | | domain-containing protein 2) (Ficolin-B) |
| | | | | | (Ficolin B) (Serum lectin P35) (EBP-37) |
| | | | | | (Hucolin) [R. norvegicus] |
| 16082 | 109 | AA874887 | E | | ESTs, Weakly similar to segregation of |
| | | | | | mitotic chromosomes b; SMC |
| | | | | | (segregation of mitotic chromosomes 1)- |
| | | | | | like 1 (yeast) [Rattus norvegicus] |
| | | | | | [R. norvegicus] |
| 1439 | 1224 | U57391 | H | SH2-B PH domain containing | SH2-B PH domain containing signaling |
| | | | | signaling mediator 1 | mediator 1 |
| 23538 | 506 | AI102727 | GENERAL | solute carrier family 20 | solute carrier family 20 (phosphate |
| | | | | (phosphate transporter), | transporter), member 1 |
| | | | | member 1 | |
| 24770 | 919 | NM_017111 | GENERAL, | Rattus norvegicus solute | solute carrier family (organic anion |
| | | | G, I, J | carrier family (organic anion | transporter) member 1 |
| | | | | transporter) member 1 | |
| | | | | (Slc21a1), mRNA. Length = 2758 | |
| 20873 | 616 | AI177042 | G | | ESTs, Highly similar to R3RT19 |
| | | | | | ribosomal protein S19, cytosolic |
| | | | | | [validated] - rat [R. norvegicus] |
| 2250 | 1024 | NM_022643 | GENERAL | Rattus norvegicus Testis- | ESTs, Highly similar to 0506206A histone |
| | | | | specific histone 2b (Th2b), | H2B [Rattus norvegicus] [R. norvegicus] |
| | | | | mRNA. Length = 470 | |
| 17682 | 157 | AA892382 | GENERAL, I | camello-like 1 | camello-like 1 |
| 12355 | 213 | AA923857 | D | | ESTs, Highly similar to 1809184A |
| | | | | | pregnancy-specific glycoprotein [Rattus |
| | | | | | norvegicus] [R. norvegicus] |
| 15039 | 1090 | NM_031672 | GENERAL, | Rattus norvegicus solute | solute carrier family 15 (H+/peptide |
| | | | F, I | carrier family 15 (H+/peptide | transporter), member 2 |
| | | | | transporter), member 2 | |
| | | | | (Slc15a2), mRNA. Length = 3923 | |
| 20816 | 990 | NM_021261 | GENERAL, | Rattus norvegicus thymosin, | thymosin, beta 10 |
| | | | G, K | beta 10 (Tmsb10), mRNA. | |
| | | | | Length = 539 | |
| 17196 | 956 | NM_019123 | GENERAL, I | Rattus norvegicus | sialyltransferase 7 ((alpha-N- |
| | | | | sialyltransferase 7 ((alpha-N- | acetylneuraminyl 2,3-betagalactosyl-1,3)- |
| | | | | acetylneuraminyl 2,3- | N-acetyl galactosaminide alpha-2,6- |
| | | | | betagalactosyl-1,3)-N-acetyl | sialyltransferase) C |
| | | | | galactosaminide alpha-2,6- | |
| | | | | sialyltransferase) C (Siat7c), | |
| | | | | mRNA. Length = 2956 | |
| 21975 | 923 | NM_017154 | B, L | Rattus norvegicus xanthine | xanthine dehydrogenase |
| | | | | dehydrogenase (Xdh), | |
| | | | | mRNA. Length = 4198 | |
| 573 | 692 | AI232087 | J | hydroxyacid oxidase 3 | hydroxyacid oxidase 3 (medium-chain) |
| | | | | (medium-chain) | |
| 18074 | 1100 | NM_031738 | K | Rattus norvegicus solute | solute carrier family 29 (nucleoside |
| | | | | carrier family 29 (nucleoside | transporters), member 2 |
| | | | | transporters), member 2 | |
| | | | | (Slc29a2), mRNA. Length = 1678 | |
| 19943 | 770 | AI639479 | GENERAL, | | ESTs, Highly similar to 2008147A protein |
| | | | F, G | | RAKb [Rattus norvegicus] [R. norvegicus] |
| 17284 | 789 | J02827 | G | Branched chain alpha- | Branched chain alpha-ketoacid |
| | | | | ketoacid dehydrogenase | dehydrogenase subunit E1 alpha |
| | | | | subunit E1 alpha | |
| 22820 | 58 | AA848315 | GENERAL | | ESTs, Weakly similar to guanosine |
| | | | | | monophosphate reductase [Rattus |
| | | | | | norvegicus] [R. norvegicus] |
| 21012 | 788 | J02592 | B | Glutathione-S-transferase, | Glutathione-S-transferase, mu type 2 |
| | | | | mu type 2 (Yb2) | (Yb2) |
| 21014 | 791 | J03914 | B, L | Glutathione-S-transferase, | Glutathione-S-transferase, mu type 2 |
| | | | | mu type 2 (Yb2) | (Yb2) |
| 21443 | 968 | NM_019262 | GENERAL, L | Rattus norvegicus | complement component 1, q |
| | | | | complement component 1, q | subcomponent, beta polypeptide |
| | | | | subcomponent, beta | |
| | | | | polypeptide (C1qb), mRNA. | |
| | | | | Length = 1136 | |
| 13310 | 618 | AI177119 | L | | ESTs, Weakly similar to S49158 |
| | | | | | complement protein C1q beta chain |
| | | | | | precursor - rat [R. norvegicus] |
| 6691 | 248 | AA943028 | J | | ESTs, Highly similar to KFMS_RAT |
| | | | | | Macrophage colony stimulating factor I |
| | | | | | receptor precursor (CSF-1-R) (Fms proto- |
| | | | | | oncogene) (c-fms) [R. norvegicus] |
| 13104 | 374 | AI010224 | D | Adducin 3, gamma | Adducin 3, gamma |
| 20086 | 403 | AI013260 | GENERAL, H | lamin A | lamin A |
| 15291 | 537 | AI111401 | D | multiple inositol | multiple inositol polyphosphate histidine |
| | | | | polyphosphate histidine | phosphatase 1 |
| | | | | phosphatase 1 | |
| 13618 | 678 | AI230724 | GENERAL, I | SAC1 (supressor of actin | SAC1 (supressor of actin mutations 1, |
| | | | | mutations 1, homolog)-like | homolog)-like (S. cerevisiae) |
| | | | | (S. cerevisiae) | |
| 24321 | 698 | AI232340 | GENERAL, | Stromal cell-derived factor 1 | Stromal cell-derived factor 1 |
| | | | K, L | | |
| 25233 | 774 | AJ000556 | E | Janus kinase 1 | |
| 15017 | 790 | J03752 | B | microsomal glutathione S- | microsomal glutathione S-transferase 1 |
| | | | | transferase 1 | |
| 20414 | 799 | L14323 | GENERAL | Phospholipase C-beta1 | Phospholipase C-beta1 |
| 25377 | 800 | L25387 | D | phosphofructokinase, platelet | |
| 21053 | 805 | M15481 | GENERAL | Insulin-like growth factor I | Insulin-like growth factor I |
| 21882 | 815 | M83740 | GENERAL, D | dimerization cofactor of | |
| | | | | hepatocyte nuclear factor-1- | |
| | | | | alpha | |
| 15540 | 832 | NM_012620 | K | Rattus norvegicus serine (or | serine (or cysteine) proteinase inhibitor, |
| | | | | cysteine) proteinase inhibitor, | clade E (nexin, plasminogen activator |
| | | | | clade E (nexin, plasminogen | inhibitor type 1), member 1 |
| | | | | activator inhibitor type 1), | |
| | | | | member 1 (Serpine1), | |
| | | | | mRNA. Length = 3053 | |
| 503 | 841 | NM_012704 | C | Rattus norvegicus Rat kidney | Rat kidney prostaglandin EP3 receptor |
| | | | | prostaglandin EP3 receptor | |
| | | | | (Ptger3), mRNA. Length = 1253 | |
| 20828 | 846 | NM_012752 | GENERAL, | Rattus norvegicus CD24 | CD24 antigen |
| | | | E, K | antigen (Cd24), mRNA. | |
| | | | | Length = 1703 | |
| 20829 | 846 | NM_012752 | GENERAL, D | Rattus norvegicus CD24 | CD24 antigen |
| | | | | antigen (Cd24), mRNA. | |
| | | | | Length = 1703 | |
| 20830 | 846 | NM_012752 | GENERAL | Rattus norvegicus CD24 | CD24 antigen |
| | | | | antigen (Cd24), mRNA. | |
| | | | | Length = 1703 | |
| 24893 | 853 | NM_012817 | B | Rattus norvegicus Insulin-like | Insulin-like growth factor-binding protein 5 |
| | | | | growth factor-binding protein | |
| | | | | 5 (Igfbps), mRNA. Length = 1630 | |
| 11137 | 856 | NM_012839 | J | Rattus norvegicus | Cytochrome C, expressed in somatic |
| | | | | Cytochrome C, expressed in | tissues |
| | | | | somatic tissues (Cycs), | |
| | | | | mRNA. Length = 318 | |
| 23651 | 862 | NM_012881 | GENERAL, | Rattus norvegicus | Sialoprotein (osteopontin) |
| | | | G, K | Sialoprotein (osteopontin) | |
| | | | | (Spp1), mRNA. Length = 1457 | |
| 433 | 869 | NM_012916 | C | Rattus norvegicus Brevican | Brevican |
| | | | | (Bcan), mRNA. Length = 2534 | |
| 24843 | 880 | NM_013042 | J | Rattus norvegicus Trefoil | Trefoil factor (intestinal) |
| | | | | factor (intestinal) (Tff3), | |
| | | | | mRNA. Length = 431 | |
| 1542 | 932 | NM_017193 | J | Rattus norvegicus | kynurenine aminotransferase II |
| | | | | kynurenine aminotransferase | |
| | | | | II (Kat2), mRNA. Length = 1828 | |
| 13939 | 933 | NM_017212 | D | Rattus norvegicus | microtubule-associated protein tau |
| | | | | microtubule-associated | |
| | | | | protein tau (Mapt), mRNA. | |
| | | | | Length = 5240 | |
| 13940 | 933 | NM_017212 | D | Rattus norvegicus | microtubule-associated protein tau |
| | | | | microtubule-associated | |
| | | | | protein tau (Mapt), mRNA. | |
| | | | | Length = 5240 | |
| 12349 | 947 | NM_017290 | GENERAL | Rattus norvegicus ATPase, | ATPase, Ca++ transporting, cardiac |
| | | | | Ca++ transporting, cardiac | muscle, slow twitch 2 |
| | | | | muscle, slow twitch 2 | |
| | | | | (Atp2a2), mRNA. Length = 5648 | |
| 245 | 952 | NM_017336 | J | Rattus norvegicus receptor- | receptor-type protein tyrosine |
| | | | | type protein tyrosine | phosphatase D30 |
| | | | | phosphatase D30 (Ptpro), | |
| | | | | mRNA. Length = 4871 | |
| 247 | 952 | NM_017336 | J | Rattus norvegicus receptor- | receptor-type protein tyrosine |
| | | | | type protein tyrosine | phosphatase D30 |
| | | | | phosphatase D30 (Ptpro), | |
| | | | | mRNA. Length = 4871 | |
| 20298 | 981 | NM_019374 | I | Rattus norvegicus | prodynorphin |
| | | | | prodynorphin (Pdyn), mRNA. | |
| | | | | Length = 747 | |
| 20085 | 997 | NM_021755 | C | Rattus norvegicus lamin | lamin A |
| | | | | (Lmn), mRNA. Length = 3091 | |
| 23151 | 1000 | NM_022005 | B, L | Rattus norvegicus FXYD | FXYD domain-containing ion transport |
| | | | | domain-containing ion | regulator 6 |
| | | | | transport regulator 6 (Fxyd6), | |
| | | | | mRNA. Length = 1711 | |
| 4011 | 1076 | NM_031543 | J | Rattus norvegicus | Cytochrome P450, subfamily 2e1 |
| | | | | Cytochrome P450, subfamily | (ethanol-inducible) |
| | | | | 2e1 (ethanol-inducible) | |
| | | | | (Cyp2e1), mRNA. Length = 1624 | |
| 4012 | 1076 | NM_031543 | J | Rattus norvegicus | Cytochrome P450, subfamily 2e1 |
| | | | | Cytochrome P450, subfamily | (ethanol-inducible) |
| | | | | 2e1 (ethanol-inducible) | |
| | | | | (Cyp2e1), mRNA. Length = 1624 | |
| 17933 | 1122 | NM_032615 | K | Rattus norvegicus membrane | membrane interacting protein of RGS16 |
| | | | | interacting protein of RGS16 | |
| | | | | (Mir16), mRNA. Length = 1203 | |
| 16394 | 1140 | NM_053485 | K | Rattus norvegicus calcium | calcium binding protein A6 (calcyclin) |
| | | | | binding protein A6 (calcyclin) | |
| | | | | (S100a6), mRNA. Length = 291 | |
| 13004 | 1154 | NM_053623 | J, L | Rattus norvegicus fatty acid- | fatty acid-Coenzyme A ligase, long chain 4 |
| | | | | Coenzyme A ligase, long | |
| | | | | chain 4 (Facl4), mRNA. | |
| | | | | Length = 4862 | |
| 13005 | 1154 | NM_053623 | C | Rattus norvegicus fatty acid- | fatty acid-Coenzyme A ligase, long chain 4 |
| | | | | Coenzyme A ligase, long | |
| | | | | chain 4 (Facl4), mRNA. | |
| | | | | Length = 4862 | |
| 25686 | 1237 | X51536 | F | ribosomal protein S3 | |
| 25718 | 1248 | X62145 | GENERAL, G | ribosomal protein L8 | |
| 25098 | 2 | AA108277 | C, H | | |
| 25106 | 4 | AA686579 | B | | |
| 19222 | 5 | AA799279 | J | | ESTs, Highly similar to mitochondrial |
| | | | | | carrier homolog 2 [Mus musculus] |
| | | | | | [M. musculus] |
| 18272 | 6 | AA799294 | I | | ESTs |
| 18396 | 7 | AA799330 | GENERAL, | | ESTs, Weakly similar to T47122 cell |
| | | | H, I | | division protein pelota [imported] - fruit fly |
| | | | | | (Drosophila melanogaster) |
| | | | | | [D. melanogaster] |
| 20961 | 8 | AA799465 | L | | EST |
| 23063 | 10 | AA799534 | GENERAL, K | | ESTs |
| 22669 | 11 | AA799567 | D | | ESTs |
| 15844 | 13 | AA799600 | D | | ESTs, Highly similar to hypothetical |
| | | | | | protein DKFZp586I021 [Homo sapiens] |
| | | | | | [H. sapiens] |
| 22910 | 14 | AA799654 | K | | ESTs |
| 14309 | 15 | AA799676 | GENERAL | | ESTs |
| 17494 | 16 | AA799751 | GENERAL, K | | ESTs |
| 18360 | 17 | AA799771 | GENERAL, I | | ESTs |
| 23202 | 18 | AA799971 | GENERAL | | ESTs, Moderately similar to hypothetical |
| | | | | | protein FLJ10986 [Homo sapiens] |
| | | | | | [H. sapiens] |
| 23203 | 18 | AA799971 | GENERAL | | ESTs, Moderately similar to hypothetical |
| | | | | | protein FLJ10986 [Homo sapiens] |
| | | | | | [H. sapiens] |
| 21029 | 19 | AA799981 | C | | ESTs |
| 21086 | 21 | AA800305 | D | | ESTs, Moderately similar to |
| | | | | | RB5A_HUMAN Ras-related protein Rab- |
| | | | | | 5A [H. sapiens] |
| 13930 | 23 | AA800613 | GENERAL | | EST |
| 6595 | 24 | AA800753 | C | | ESTs |
| 21388 | 25 | AA800771 | C | | ESTs |
| 12797 | 26 | AA800790 | D | | ESTs |
| 14600 | 28 | AA801076 | K | | ESTs |
| 15027 | 30 | AA801212 | D | | ESTs |
| 7543 | 31 | AA801395 | GENERAL | | ESTs |
| 5930 | 32 | AA817688 | B | | ESTs |
| 24237 | 33 | AA817726 | GENERAL | | ESTs |
| 10983 | 39 | AA818132 | G | | ESTs |
| 6014 | 40 | AA818153 | B, H | | ESTs |
| 6022 | 41 | AA818197 | E | | ESTs |
| 5923 | 43 | AA818355 | GENERAL, I | | ESTs |
| 11610 | 44 | AA818725 | J | | ESTs |
| 4291 | 45 | AA818741 | GENERAL, | | ESTs |
| | | | I, J | | |
| 4330 | 46 | AA818747 | GENERAL, B | | ESTs |
| 19723 | 47 | AA818761 | GENERAL | | ESTs |
| 4952 | 49 | AA818907 | GENERAL, C | | ESTs |
| 10985 | 50 | AA818998 | GENERAL, I | | ESTs |
| 16958 | 51 | AA819021 | A | | EST |
| 5863 | 52 | AA819111 | GENERAL, | | ESTs |
| | | | H, I | | |
| 12684 | 53 | AA819179 | F | | ESTs |
| 6336 | 55 | AA819403 | GENERAL | | ESTs |
| 6278 | 56 | AA819471 | B | | ESTs |
| 6614 | 59 | AA848389 | G | | ESTs, Weakly similar to Iron-containing |
| | | | | | alcohol dehydrogenases [Caenorhabditis |
| | | | | | elegans] [C. elegans] |
| 21125 | 60 | AA848437 | GENERAL, L | | ESTs |
| 23505 | 61 | AA848496 | J | | ESTs, Moderately similar to |
| | | | | | IF4B_HUMAN Eukaryotic translation |
| | | | | | initiation factor 4B (eIF-4B) [H. sapiens] |
| 21140 | 63 | AA848738 | J | | ESTs, Weakly similar to phospholipase |
| | | | | | D3 [Mus musculus] [M. musculus] |
| 2924 | 64 | AA848948 | H | | ESTs, Weakly similar to F18H3.1.p |
| | | | | | [Caenorhabditis elegans] [C. elegans] |
| 22631 | 65 | AA849030 | K | | ESTs |
| 17339 | 67 | AA849497 | GENERAL | | ESTs |
| 18447 | 69 | AA849939 | F | | ESTs |
| 12129 | 70 | AA849966 | A, D | | ESTs, Moderately similar to Mpv17 |
| | | | | | transgene, kidney disease mutant-like |
| | | | | | [Mus musculus] [M. musculus] |
| 21341 | 71 | AA850195 | I | | ESTs |
| 14410 | 72 | AA850292 | F | | ESTs |
| 13615 | 73 | AA850364 | L | | ESTs, Moderately similar to |
| | | | | | RB17_MOUSE Ras-related protein Rab- |
| | | | | | 17 [M. musculus] |
| 21766 | 74 | AA850916 | J | | ESTs |
| 13349 | 78 | AA851417 | GENERAL, | | ESTs |
| | | | H, I | | |
| 24377 | 80 | AA858590 | H | | ESTs |
| 1801 | 81 | AA858636 | E | | ESTs, Highly similar to mini chromosome |
| | | | | | maintenance deficient 7 (S. cerevisiae) |
| | | | | | [Mus musculus] [M. musculus] |
| 18350 | 82 | AA858674 | C | | ESTs |
| 11615 | 83 | AA858816 | D | | ESTs, Weakly similar to F53A3.7.p |
| | | | | | [Caenorhabditis elegans] [C. elegans] |
| 7279 | 84 | AA858892 | GENERAL | | ESTs |
| 6431 | 86 | AA859085 | L | | ESTs |
| 17361 | 87 | AA859114 | GENERAL, | | ESTs |
| | | | A, G | | |
| 16314 | 89 | AA859348 | GENERAL, I | | ESTs |
| 4178 | 90 | AA859536 | GENERAL, A | | ESTs |
| 14353 | 91 | AA859585 | D | | ESTs |
| 19067 | 92 | AA859663 | GENERAL, B | | ESTs |
| 11079 | 95 | AA859829 | E | | ESTs |
| 11481 | 96 | AA859832 | B | | ESTs |
| 22562 | 97 | AA859835 | F | | ESTs |
| 22927 | 98 | AA859920 | E | | ESTs |
| 23000 | 99 | AA859933 | F | | ESTs |
| 18468 | 101 | AA859966 | J | | ESTs, Moderately similar to |
| | | | | | TNP1_HUMAN Tumor necrosis factor, |
| | | | | | alpha-induced protein 1, endothelial (B12 |
| | | | | | protein) [H. sapiens] |
| 19377 | 102 | AA859971 | A, E | | ESTs, Highly similar to RIKEN cDNA |
| | | | | | 0610010I12 [Mus musculus] |
| | | | | | [M. musculus] |
| 19144 | 104 | AA860049 | A | | ESTs |
| 9391 | 106 | AA866477 | J | | ESTs, Moderately similar to |
| | | | | | COXM_MOUSE Cytochrome c oxidase |
| | | | | | polypeptide VIIb, mitochondrial precursor |
| | | | | | [M. musculus] |
| 16070 | 108 | AA874873 | D | | ESTs |
| 16091 | 110 | AA874897 | J | | ESTs |
| 16312 | 112 | AA875032 | GENERAL, | | ESTs |
| | | | I, L | | |
| 15421 | 114 | AA875286 | C, L | | ESTs, Highly similar to prostate tumor |
| | | | | | over expressed gene 1 [Homo sapiens] |
| | | | | | [H. sapiens] |
| 15446 | 115 | AA875327 | L | | ESTs |
| 7936 | 116 | AA875495 | GENERAL, | | ESTs |
| | | | A, B, C, I | | |
| 15574 | 118 | AA875552 | H | | ESTs |
| 15618 | 119 | AA875620 | GENERAL | | ESTs |
| 15833 | 122 | AA891171 | K | | ESTs, Moderately similar to |
| | | | | | N4BM_HUMAN NADH-ubiquinone |
| | | | | | oxidoreductase subunit B14.5b (Complex |
| | | | | | I-B14.5b) (CI-B14.5b) [H. sapiens] |
| 16446 | 123 | AA891423 | L | | ESTs |
| 474 | 124 | AA891670 | D | | ESTs, Moderately similar to |
| | | | | | mannosidase 2, alpha B1; lysosomal |
| | | | | | alpha-mannosidase [Mus musculus] |
| | | | | | [M. musculus] |
| 17420 | 125 | AA891693 | GENERAL | | ESTs |
| 11959 | 126 | AA891735 | D | | ESTs |
| 17693 | 127 | AA891737 | J | | ESTs |
| 17256 | 128 | AA891739 | GENERAL, | | ESTs, Weakly similar to F52H3.5.p |
| | | | C, E, I | | [Caenorhabditis elegans] [C. elegans] |
| 9905 | 130 | AA891774 | GENERAL, | | ESTs |
| | | | A, I, K | | |
| 17289 | 131 | AA891785 | E | | ESTs, Weakly similar to A54756 |
| | | | | | isocitrate dehydrogenase (NADP+) (EC |
| | | | | | 1.1.1.42), cytosolic - rat [R. norvegicus] |
| 17290 | 131 | AA891785 | E | | ESTs, Weakly similar to A54756 |
| | | | | | isocitrate dehydrogenase (NADP+) (EC |
| | | | | | 1.1.1.42), cytosolic - rat [R. norvegicus] |
| 22124 | 133 | AA891790 | D | | ESTs |
| 20522 | 136 | AA891842 | L | | ESTs |
| 20523 | 136 | AA891842 | B, L | | ESTs |
| 2576 | 138 | AA891884 | K | | ESTs |
| 17438 | 139 | AA891943 | GENERAL | | ESTs |
| 1159 | 140 | AA891949 | GENERAL, | | ESTs |
| | | | D, I | | |
| 4473 | 141 | AA891965 | GENERAL, | | ESTs, Highly similar to fructosamine 3 |
| | | | A, D, I | | kinase [Mus musculus] [M. musculus] |
| 2107 | 143 | AA892006 | D, K | HMm:ATPase, H+ | ESTs, Highly similar to VAA1_MOUSE |
| | | | | transporting, lysosomal | Vacuolar ATP synthase catalytic subunit |
| | | | | 70 kD, V1 subunit A, isoform 1 | A, ubiquitous isoform (V-ATPase A |
| | | | | | subunit 1) (Vacuolar proton pump alpha |
| | | | | | subunit 1) (V-ATPase 69 kDa subunit 1) |
| | | | | | [M. musculus] |
| 23047 | 145 | AA892027 | GENERAL | | ESTs |
| 14595 | 147 | AA892128 | B, L | | ESTs |
| 15666 | 150 | AA892248 | L | | |
| 15667 | 150 | AA892248 | L | | |
| 9073 | 151 | AA892273 | J | | ESTs |
| 18190 | 152 | AA892280 | GENERAL | | ESTs |
| 3474 | 156 | AA892378 | C | | ESTs, Weakly similar to F13B9.8.p |
| | | | | | [Caenorhabditis elegans] [C. elegans] |
| 11991 | 162 | AA892483 | B | | ESTs |
| 8599 | 163 | AA892522 | GENERAL, F | | ESTs |
| 12276 | 164 | AA892541 | GENERAL, | | ESTs |
| | | | D, L | | |
| 17469 | 166 | AA892549 | D | | ESTs |
| 18906 | 167 | AA892561 | GENERAL, I | | ESTs |
| 18275 | 168 | AA892572 | K | | ESTs, Highly similar to RIKEN cDNA |
| | | | | | 1110001J03 [Mus musculus] |
| | | | | | [M. musculus] |
| 19085 | 170 | AA892598 | GENERAL | | ESTs, Weakly similar to putative |
| | | | | | nucleotide binding protein, estradiol- |
| | | | | | induced [Homo sapiens] [H. sapiens] |
| 19086 | 170 | AA892598 | GENERAL | | ESTs, Weakly similar to putative |
| | | | | | nucleotide binding protein, estradiol- |
| | | | | | induced [Homo sapiens] [H. sapiens] |
| 20088 | 171 | AA892666 | K | | ESTs |
| 23783 | 172 | AA892773 | GENERAL, | | ESTs |
| | | | I, K | | |
| 19251 | 173 | AA892796 | C | | ESTs |
| 13542 | 174 | AA892798 | B | | ESTs |
| 17332 | 177 | AA892829 | J | HMm:3′-phosphoadenosine | ESTs, Highly similar to 2204316A ATP |
| | | | | 5′-phosphosulfate synthase 1 | sulfurylase-adenosine phosphosulfate |
| | | | | | kinase [Mus musculus] [M. musculus] |
| 18887 | 179 | AA892860 | J | | ESTs |
| 9053 | 180 | AA892861 | GENERAL, I | | ESTs |
| 12848 | 181 | AA892916 | H, K | | ESTs, Weakly similar to JC7260 |
| | | | | | strictosidine synthase (EC 4.3.3.2) |
| | | | | | homolog 2 - fruit fly (Drosophila |
| | | | | | melanogaster) [D. melanogaster] |
| 14465 | 183 | AA892950 | K | | ESTs, Moderately similar to A Chain A, |
| | | | | | Crystal Structure Of The Accessory |
| | | | | | Subunit Of Murine Mitochondrial |
| | | | | | Polymerase Gamma [M. musculus] |
| 3853 | 184 | AA892999 | K | | ESTs |
| 3863 | 186 | AA893060 | C, D | | ESTs |
| 13332 | 187 | AA893080 | GENERAL, K | | ESTs |
| 21305 | 188 | AA893082 | GENERAL, | | ESTs |
| | | | D, H, I | | |
| 3870 | 189 | AA893147 | F, G | | ESTs |
| 17447 | 191 | AA893192 | GENERAL | | ESTs |
| 17744 | 192 | AA893206 | GENERAL | | ESTs |
| 3886 | 195 | AA893289 | J | | ESTs |
| 9082 | 196 | AA893357 | GENERAL | | ESTs |
| 17800 | 197 | AA893436 | K | | ESTs |
| 4542 | 199 | AA893643 | C | | ESTs |
| 9084 | 200 | AA893717 | E | | ESTs |
| 2128 | 202 | AA894008 | B | | ESTs |
| 2979 | 204 | AA894099 | H | | ESTs, Highly similar to vacuolar protein |
| | | | | | sorting protein 4a; RIKEN cDNA |
| | | | | | 4930589C15 gene [Mus musculus] |
| | | | | | [M. musculus] |
| 21354 | 208 | AA899721 | B, L | | ESTs |
| 9114 | 210 | AA899951 | GENERAL | | ESTs |
| 3959 | 212 | AA901338 | GENERAL | HMm:eukaryotic translation | ESTs, Highly similar to eukaryotic |
| | | | | initiation factor 2, subunit 2 | translation initiation factor 2, subunit 2 |
| | | | | (beta, 38 kDa) | (beta, 38 kDa) [Mus musculus] |
| | | | | | [M. musculus] |
| 6736 | 214 | AA924005 | C | | ESTs |
| 24192 | 215 | AA924210 | H | | ESTs |
| 4933 | 216 | AA924301 | GENERAL, A | | ESTs |
| 3631 | 219 | AA924460 | D | | ESTs, Weakly similar to PMC1_MOUSE |
| | | | | | Polymyositis/scleroderma autoantigen 1 |
| | | | | | (Autoantigen PM/Scl 1) |
| | | | | | (Polymyositis/scleroderma autoantigen |
| | | | | | 75 kDa) (PM/Scl-75) (P75 polymyositis- |
| | | | | | scleroderma overlap syndrome |
| | | | | | associated autoantigen) [M. musculus] |
| 23123 | 222 | AA924794 | K | | ESTs |
| 21458 | 224 | AA925049 | GENERAL | | ESTs |
| 14790 | 225 | AA925087 | GENERAL | | ESTs |
| 18271 | 228 | AA925267 | GENERAL, I | | ESTs |
| 5129 | 229 | AA925335 | J | | ESTs |
| 23978 | 230 | AA925352 | GENERAL, L | | ESTs |
| 22479 | 231 | AA925418 | B, L | | ESTs |
| 5183 | 233 | AA925662 | L | | ESTs |
| 5205 | 234 | AA925747 | K | | ESTs, Highly similar to DBS_MOUSE |
| | | | | | Guanine nucleotide exchange factor DBS |
| | | | | | (DBL's big sister) (MCF2 transforming |
| | | | | | sequence-like protein) [M. musculus] |
| 17157 | 237 | AA926129 | GENERAL | | ESTs |
| 13411 | 239 | AA926196 | GENERAL | | ESTs |
| 21513 | 241 | AA926261 | H | | ESTs |
| 22928 | 242 | AA926262 | GENERAL | | ESTs, Moderately similar to S29993 |
| | | | | | P311 protein - mouse [M. musculus] |
| 894 | 243 | AA926305 | E | | ESTs |
| 6039 | 244 | AA942716 | GENERAL, G | | ESTs, Highly similar to hematological |
| | | | | | and neurological expressed sequence 1 |
| | | | | | [Mus musculus] [M. musculus] |
| 23005 | 245 | AA942770 | I | | ESTs |
| 21318 | 246 | AA942774 | GENERAL | | ESTs |
| 22180 | 249 | AA943202 | D | | ESTs |
| 21990 | 250 | AA943524 | C | | ESTs |
| 12673 | 251 | AA943773 | D, L | | ESTs |
| 18285 | 252 | AA943791 | F | | ESTs |
| 22681 | 254 | AA944413 | GENERAL, I | | ESTs |
| 6711 | 255 | AA944439 | GENERAL | | ESTs, Moderately similar to S60715 gene |
| | | | | | G11 protein - human [H. sapiens] |
| 22536 | 257 | AA944803 | K | | ESTs |
| 22501 | 258 | AA944811 | H | putative zinc finger protein | putative zinc finger protein SERZ-1 |
| | | | | SERZ-1 | |
| 11974 | 259 | AA944958 | GENERAL | | ESTs |
| 22554 | 260 | AA945076 | GENERAL, I | | ESTs |
| 22618 | 263 | AA945656 | E | | ESTs |
| 22625 | 264 | AA945704 | H | | ESTs |
| 22656 | 265 | AA945818 | GENERAL, H | | ESTs |
| 18524 | 267 | AA946017 | D | | ESTs |
| 18337 | 269 | AA946046 | GENERAL, I | | ESTs |
| 22770 | 272 | AA946428 | D | | ESTs |
| 17499 | 273 | AA946467 | GENERAL | | ESTs |
| 9452 | 275 | AA955206 | GENERAL | | ESTs |
| 23512 | 276 | AA955282 | GENERAL | | ESTs |
| 19347 | 278 | AA955334 | D | | EST |
| 23532 | 279 | AA955347 | E | | ESTs |
| 23533 | 280 | AA955350 | E | | ESTs |
| 23546 | 281 | AA955393 | I | | ESTs |
| 23626 | 282 | AA955540 | D | | ESTs |
| 23718 | 283 | AA955790 | A | | ESTs |
| 498 | 284 | AA956278 | GENERAL | | ESTs |
| 23790 | 286 | AA956499 | D | | ESTs |
| 23834 | 287 | AA956659 | C | | ESTs |
| 23839 | 288 | AA956684 | D | | ESTs |
| 18288 | 289 | AA956813 | C | | ESTs, Highly similar to JC4761 |
| | | | | | recombination activating gene 1 inducing |
| | | | | | protein - mouse [M. musculus] |
| 23958 | 292 | AA957125 | E | | ESTs |
| 23314 | 294 | AA957270 | H, I | | ESTs |
| 2702 | 295 | AA957307 | GENERAL, | HMm:seryl-aminoacyl-tRNA | ESTs, Highly similar to A41019 serine - |
| | | | I, J | synthetase 1 | tRNA ligase (EC 6.1.1.11) - mouse |
| | | | | | (fragment) [M. musculus] |
| 24051 | 297 | AA957452 | J | | ESTs |
| 17523 | 299 | AA963240 | D | | ESTs |
| 24246 | 300 | AA963703 | H | | ESTs, Highly similar to P2G4_MOUSE |
| | | | | | Proliferation-associated protein 2G4 |
| | | | | | (Proliferation-associated protein 1) |
| | | | | | (Protein p38-2G4) [M. musculus] |
| 2195 | 301 | AA963746 | GENERAL | | ESTs |
| 9309 | 302 | AA963794 | E | | ESTs |
| 2282 | 304 | AA964147 | F | | ESTs |
| 2113 | 305 | AA964275 | D | | ESTs, Weakly similar to Yeast YAE2 |
| | | | | | hypothetical protein [Caenorhabditis |
| | | | | | elegans] [C. elegans] |
| 2423 | 306 | AA964611 | D | | ESTs |
| 2457 | 307 | AA964752 | L | | ESTs |
| 12561 | 309 | AA964815 | GENERAL, C | | ESTs |
| 11324 | 310 | AA964832 | J, L | | ESTs |
| 21339 | 311 | AA964962 | J, L | HMm: ATP-binding cassette, | ESTs, Highly similar to ABC1_MOUSE |
| | | | | sub-family A (ABC1), | ATP-binding cassette, sub-family A, |
| | | | | member 1 | member 1 (ATP-binding cassette |
| | | | | | transporter 1) (ATP-binding cassette 1) |
| | | | | | (ABC-1) [M. musculus] |
| 2563 | 312 | AA965113 | K | | ESTs, Weakly similar to Y54E5A.5.p |
| | | | | | [Caenorhabditis elegans] [C. elegans] |
| 2569 | 313 | AA965122 | K | | ESTs, Weakly similar to T24832 |
| | | | | | hypothetical protein T11F9.11 - |
| | | | | | Caenorhabditis elegans [C. elegans] |
| 2905 | 314 | AA996727 | GENERAL | | ESTs |
| 2964 | 315 | AA996954 | F | | ESTs |
| 3145 | 316 | AA997237 | D | | ESTs |
| 12616 | 318 | AA997599 | E | | ESTs |
| 3020 | 319 | AA997656 | L | | ESTs, Moderately similar to T09071 SH3 |
| | | | | | domains-containing protein POSH - |
| | | | | | mouse [M. musculus] |
| 3269 | 321 | AA997800 | E | | ESTs, Moderately similar to T30249 cell |
| | | | | | proliferation antigen Ki-67 - mouse |
| | | | | | [M. musculus] |
| 21959 | 323 | AA997973 | D, E | | ESTs |
| 22737 | 327 | AA998660 | L | | ESTs |
| 11558 | 328 | AA998894 | D | | ESTs |
| 3069 | 329 | AA998910 | G | | ESTs, Highly similar to endoplasmic |
| | | | | | reticulum chaperone SIL1 homolog (S. cerevisiae) |
| | | | | | [Mus musculus] [M. musculus] |
| 3079 | 330 | AA999169 | GENERAL | | ESTs |
| 18043 | 335 | AF020618 | F | myeloid differentiation | myeloid differentiation primary response |
| | | | | primary response gene 116 | gene 116 |
| 11483 | 335 | AF020618 | GENERAL, I | myeloid differentiation | myeloid differentiation primary response |
| | | | | primary response gene 116 | gene 116 |
| 25168 | 336 | AF030050 | A | replication factor C | |
| 1564 | 337 | AF035963 | E, G, K | | Rattus norvegicus kidney injury molecule- |
| | | | | | 1 (KIM-1) mRNA, complete cds |
| 17426 | 346 | AF073839 | C | dynein-associated protein | dynein-associated protein RKM23 |
| | | | | RKM23 | |
| 2368 | 348 | AF095741 | K | Mg87 protein | Mg87 protein |
| 15232 | 349 | AI007622 | D | | ESTs |
| 24109 | 350 | AI007725 | J | | ESTs |
| 1804 | 351 | AI007824 | L | | |
| 6804 | 352 | AI007877 | GENERAL | | ESTs |
| 23917 | 355 | AI008441 | H, I | | ESTs, Highly similar to G01922 |
| | | | | | phosphogluconate dehydrogenase |
| | | | | | (decarboxylating) (EC 1.1.1.44) - human |
| | | | | | [H. sapiens] |
| 22599 | 356 | AI008458 | GENERAL | | ESTs |
| 22698 | 357 | AI008578 | L | | ESTs |
| 6382 | 360 | AI009362 | GENERAL | | ESTs |
| 10532 | 361 | AI009602 | K | | ESTs |
| 895 | 362 | AI009614 | E | | ESTs |
| 19358 | 363 | AI009675 | J | | EST |
| 6833 | 364 | AI009687 | L | | ESTs |
| 15089 | 365 | AI009752 | GENERAL, K | | ESTs |
| 6842 | 366 | AI009764 | K | | ESTs |
| 22619 | 367 | AI009825 | L | | ESTs |
| 26133 | 368 | AI009950 | F | | EST |
| 6869 | 369 | AI010025 | D | | EST |
| 16824 | 370 | AI010027 | D | | ESTs |
| 21105 | 371 | AI010067 | GENERAL, F | | ESTs |
| 17938 | 375 | AI010332 | C | | ESTs |
| 12095 | 376 | AI010339 | D | | ESTs, Weakly similar to C16C10.11.p |
| | | | | | [Caenorhabditis elegans] [C. elegans] |
| 6916 | 377 | AI010430 | GENERAL | | ESTs |
| 18657 | 378 | AI010435 | K | | ESTs |
| 6927 | 380 | AI010542 | GENERAL | | ESTs |
| 15679 | 384 | AI011058 | B, L | | ESTs |
| 3934 | 385 | AI011510 | D | | ESTs |
| 21060 | 390 | AI011746 | A | | ESTs |
| 23946 | 393 | AI012240 | GENERAL | | ESTs |
| 24200 | 394 | AI012356 | GENERAL, | | ESTs |
| | | | B, L | | |
| 7471 | 395 | AI012379 | L | | ESTs |
| 9116 | 396 | AI012457 | A, C | | ESTs |
| 7127 | 397 | AI012464 | GENERAL | | ESTs |
| 3493 | 399 | AI012590 | D, K | | ESTs |
| 3961 | 400 | AI012598 | A | | ESTs, Weakly similar to S37744 endo- |
| | | | | | exonuclease yNucR - yeast |
| | | | | | (Saccharomyces cerevisiae) |
| | | | | | [S. cerevisiae] |
| 7142 | 401 | AI012689 | C | | ESTs |
| 6674 | 407 | AI013568 | I | | ESTs |
| 15159 | 408 | AI013697 | D | | ESTs, Highly similar to RIKEN cDNA |
| | | | | | 6030432N09 [Mus musculus] |
| | | | | | [M. musculus] |
| 7278 | 409 | AI013738 | J | | ESTs |
| 15928 | 411 | AI013829 | GENERAL, K | | ESTs |
| 7216 | 415 | AI014165 | A | | ESTs |
| 11326 | 416 | AI029015 | F | | ESTs |
| 22502 | 417 | AI029017 | H | putative zinc finger protein | putative zinc finger protein SERZ-1 |
| | | | | SERZ-1 | |
| 12812 | 418 | AI029126 | GENERAL, H | | ESTs |
| 7537 | 421 | AI029829 | GENERAL | | ESTs |
| 7586 | 422 | AI030024 | C | | ESTs |
| 2370 | 423 | AI030179 | GENERAL, I | | ESTs |
| 7634 | 424 | AI030248 | A | | ESTs, Weakly similar to RM02_YEAST |
| | | | | | 60S RIBOSOMAL PROTEIN L2, |
| | | | | | MITOCHONDRIAL PRECURSOR |
| | | | | | (YML2) (YMR6) [S. cerevisiae] |
| 665 | 425 | AI030430 | B | | ESTs |
| 7681 | 426 | AI030449 | J | | ESTs, Moderately similar to |
| | | | | | methyltransferase-like 1 (S. cerevisiae) |
| | | | | | [Mus musculus] [M. musculus] |
| 11559 | 427 | AI030472 | C | | ESTs |
| 17419 | 428 | AI030524 | D | | ESTs |
| 7825 | 431 | AI031023 | F | | ESTs |
| 14856 | 432 | AI043721 | A | | ESTs |
| 7896 | 433 | AI043772 | D | | ESTs |
| 7903 | 434 | AI043805 | GENERAL | | ESTs |
| 10818 | 435 | AI043990 | GENERAL, I | | ESTs |
| 7964 | 436 | AI044046 | G | | ESTs |
| 5430 | 437 | AI044253 | F | | EST |
| 5461 | 438 | AI044338 | GENERAL, B | | ESTs |
| 2348 | 439 | AI044794 | GENERAL, D | | ESTs |
| 5474 | 443 | AI045477 | GENERAL | | ESTs |
| 10004 | 444 | AI045509 | C | | ESTs |
| 17755 | 445 | AI045608 | C, I | | ESTs |
| 26173 | 446 | AI045626 | F | | |
| 5855 | 447 | AI045669 | GENERAL | | ESTs |
| 23712 | 448 | AI045827 | L | | ESTs, Weakly similar to T00043 BH- |
| | | | | | protocadherin-a - mouse [M. musculus] |
| 5900 | 449 | AI045866 | I | | ESTs |
| 5329 | 451 | AI045970 | GENERAL | | ESTs |
| 8065 | 453 | AI058509 | B, L | | ESTs |
| 8104 | 454 | AI058655 | B | | EST |
| 8143 | 455 | AI058759 | GENERAL | | ESTs |
| 4789 | 456 | AI058889 | GENERAL | | ESTs |
| 8202 | 457 | AI058990 | L | | ESTs |
| 8283 | 458 | AI059290 | H | | ESTs |
| 6343 | 461 | AI070108 | A | | ESTs |
| 14424 | 463 | AI070421 | GENERAL | | ESTs |
| 10434 | 464 | AI070497 | B | | ESTs |
| 8927 | 465 | AI070523 | A | | ESTs, Highly similar to RIKEN cDNA |
| | | | | | 1810020G14 [Mus musculus] |
| | | | | | [M. musculus] |
| 8946 | 467 | AI070611 | A | | ESTs |
| 10446 | 468 | AI070638 | B | | ESTs |
| 9026 | 470 | AI070944 | L | | EST |
| 8721 | 471 | AI071024 | GENERAL, | | EST |
| | | | A, D, I | | |
| 9212 | 472 | AI071098 | K | | ESTs |
| 18792 | 473 | AI071177 | GENERAL, I | | ESTs |
| 9583 | 474 | AI071185 | GENERAL, | | ESTs |
| | | | C, L | | |
| 9079 | 475 | AI071251 | B, I | | ESTs, Moderately similar to A57050 K- |
| | | | | | glypican precursor - mouse [M. musculus] |
| 11057 | 476 | AI071509 | L | | ESTs |
| 22929 | 477 | AI071578 | GENERAL, F | | ESTs, Moderately similar to S29993 |
| | | | | | P311 protein - mouse [M. musculus] |
| 22930 | 477 | AI071578 | GENERAL | | ESTs, Moderately similar to S29993 |
| | | | | | P311 protein - mouse [M. musculus] |
| 9673 | 478 | AI071581 | GENERAL, I | | ESTs |
| 8099 | 479 | AI071586 | B | | ESTs |
| 11075 | 480 | AI071639 | F | | EST |
| 9699 | 481 | AI071646 | GENERAL | | ESTs |
| 9781 | 482 | AI071943 | GENERAL, I | | EST |
| 12846 | 484 | AI072068 | J | | ESTs |
| 10849 | 486 | AI072189 | F | | ESTs |
| 20003 | 487 | AI072362 | GENERAL | | ESTs |
| 16813 | 491 | AI072746 | I | | EST |
| 21885 | 492 | AI072886 | GENERAL | | ESTs |
| 9439 | 493 | AI072934 | J | | ESTs |
| 9468 | 494 | AI073021 | GENERAL | | ESTs |
| 24165 | 495 | AI101113 | F | | ESTs |
| 17743 | 497 | AI101660 | J | | ESTs |
| 4119 | 498 | AI101901 | L | | ESTs |
| 2824 | 499 | AI101999 | C | | ESTs |
| 19011 | 504 | AI102618 | L | | ESTs |
| 23837 | 505 | AI102620 | GENERAL | | ESTs |
| 6796 | 509 | AI102753 | GENERAL, B | | ESTs |
| 8837 | 510 | AI102849 | C | | ESTs |
| 3584 | 511 | AI103106 | E | | ESTs |
| 13028 | 513 | AI103253 | A | | ESTs |
| 7622 | 514 | AI103472 | A | | ESTs |
| 20918 | 515 | AI103552 | J | | ESTs |
| 4856 | 516 | AI103708 | G | | ESTs |
| 22885 | 519 | AI103828 | GENERAL, B | | ESTs |
| 7128 | 521 | AI103937 | GENERAL | | ESTs |
| 22271 | 522 | AI103947 | F | | ESTs, Moderately similar to |
| | | | | | mitochondrial ribosomal protein L36 [Mus |
| | | | | | musculus] [M. musculus] |
| 12450 | 523 | AI103955 | C | LRP16 protein | Rattus norvegicus LRP16-like protein |
| | | | | | mRNA, complete cds |
| 22101 | 525 | AI104251 | GENERAL, | | ESTs, Moderately similar to |
| | | | C, I | | DKFZP564O243 protein [Homo sapiens] |
| | | | | | [H. sapiens] |
| 12798 | 527 | AI104773 | GENERAL | | ESTs, Highly similar to hypothetical |
| | | | | | protein KIAA1695; hypothetical protein |
| | | | | | FLJ22297; KIAA1695 protein [Homo |
| | | | | | sapiens] [H. sapiens] |
| 11232 | 528 | AI104864 | F | | ESTs, Moderately similar to hypothetical |
| | | | | | protein MGC3037 [Homo sapiens] |
| | | | | | [H. sapiens] |
| 16887 | 529 | AI104883 | F | | ESTs |
| 5199 | 532 | AI105272 | GENERAL, G | | ESTs, Weakly similar to T21641 |
| | | | | | hypothetical protein F32B6.2 - |
| | | | | | Caenorhabditis elegans [C. elegans] |
| 7049 | 533 | AI105371 | C | | ESTs |
| 13343 | 535 | AI105398 | GENERAL | | ESTs |
| 17221 | 536 | AI105429 | K | | ESTs |
| 4479 | 539 | AI111599 | GENERAL | | ESTs |
| 12925 | 541 | AI111970 | B | | ESTs |
| 9017 | 542 | AI112138 | GENERAL | | ESTs |
| 11198 | 543 | AI112199 | F | | ESTs |
| 12945 | 544 | AI112212 | F | | ESTs |
| 3713 | 545 | AI112571 | GENERAL, J | | ESTs |
| 13013 | 547 | AI136233 | B | | ESTs |
| 13020 | 548 | AI136338 | F | | ESTs, Weakly similar to S36152 MHC |
| | | | | | class III histocompatibility antigen HLA-B- |
| | | | | | associated protein 2 [similarity] - human |
| | | | | | [H. sapiens] |
| 11937 | 552 | AI137218 | I | | ESTs, Moderately similar to hypothetical |
| | | | | | protein MGC2835 [Homo sapiens] |
| | | | | | [H. sapiens] |
| 5290 | 554 | AI137227 | D | | ESTs |
| 14142 | 555 | AI137435 | K | | ESTs |
| 6638 | 556 | AI137579 | GENERAL | | ESTs |
| 2264 | 559 | AI144741 | F | | ESTs |
| 14458 | 560 | AI145095 | GENERAL | | ESTs |
| 8339 | 562 | AI145761 | GENERAL | | ESTs, Weakly similar to T21659 |
| | | | | | hypothetical protein F32D8.4 - |
| | | | | | Caenorhabditis elegans [C. elegans] |
| 5531 | 563 | AI145859 | F | | ESTs |
| 18522 | 564 | AI145870 | A, F, I | | ESTs, Moderately similar to RIKEN |
| | | | | | cDNA 1110025H10 [Mus musculus] |
| | | | | | [M. musculus] |
| 11618 | 568 | AI169115 | GENERAL, | | ESTs |
| | | | C, F, I | | |
| 5920 | 569 | AI169163 | B | | ESTs |
| 12979 | 570 | AI169177 | GENERAL, | | ESTs, Highly similar to S33363 gly96 |
| | | | B, H, I, L | | protein - mouse [M. musculus] |
| 16338 | 572 | AI169374 | D | | ESTs |
| 8234 | 573 | AI169517 | B | | ESTs |
| 24592 | 574 | AI169622 | D | Serine protease inhibitor, | Serine protease inhibitor, kanzal type 1/ |
| | | | | kanzal type 1/Trypsin | Trypsin inhibitor-like protein, pancreatic |
| | | | | inhibitor-like protein, | |
| | | | | pancreatic | |
| 10839 | 575 | AI169655 | G | | ESTs |
| 11429 | 576 | AI169706 | H | | ESTs |
| 3916 | 577 | AI169947 | GENERAL, I | | ESTs |
| 16898 | 578 | AI170249 | B | | ESTs, Weakly similar to T29643 |
| | | | | | hypothetical protein F49E8.1 - |
| | | | | | Caenorhabditis elegans [C. elegans] |
| 5297 | 579 | AI170379 | GENERAL, D | | ESTs |
| 2534 | 580 | AI170632 | D, K | | ESTs |
| 10130 | 582 | AI170759 | GENERAL, | | ESTs |
| | | | A, I | | |
| 3803 | 583 | AI170773 | A | | Rattus norvegicus 250 kDa estrous- |
| | | | | | specific protein mRNA, partial cds |
| 22985 | 584 | AI171093 | A, F | | ESTs |
| 736 | 585 | AI171314 | G | | ESTs, Weakly similar to B Chain B, |
| | | | | | Solution Structure Of The C-Terminal |
| | | | | | Negative Regulatory Domain Of P53 In A |
| | | | | | Complex With Ca2+-Bound S100b(Bb) |
| | | | | | [R. norvegicus] |
| 11761 | 587 | AI171526 | A | | ESTs |
| 10087 | 589 | AI171803 | GENERAL | methylmalonate | methylmalonate semialdehyde |
| | | | | semialdehyde | dehydrogenase gene |
| | | | | dehydrogenase gene | |
| 11708 | 590 | AI171807 | GENERAL | | ESTs |
| 22747 | 591 | AI171832 | GENERAL | | ESTs, Highly similar to RIKEN cDNA |
| | | | | | 2410005O16 [Mus musculus] |
| | | | | | [M. musculus] |
| 21956 | 592 | AI171980 | L | | ESTs |
| 11205 | 593 | AI172057 | G | | ESTs |
| 3698 | 595 | AI172193 | C | | ESTs |
| 18681 | 596 | AI172206 | J | | ESTs |
| 15382 | 598 | AI172302 | GENERAL, H | | ESTs, Weakly similar to S43056 |
| | | | | | hypothetical protein - mouse |
| | | | | | [M. musculus] |
| 17887 | 599 | AI172414 | J | brain protein 44-like | brain protein 44-like |
| 13106 | 600 | AI172615 | D | | ESTs |
| 13457 | 601 | AI175319 | F | | ESTs |
| 22311 | 604 | AI176007 | B | | ESTs, Highly similar to PM5P_HUMAN |
| | | | | | Protein pM5 precursor [H. sapiens] |
| 21088 | 609 | AI176472 | A | | ESTs |
| 24236 | 610 | AI176473 | GENERAL | | ESTs |
| 18418 | 611 | AI176483 | D | | ESTs |
| 23299 | 613 | AI176839 | GENERAL | | ESTs |
| 22103 | 614 | AI176849 | L | | ESTs |
| 15146 | 615 | AI176969 | GENERAL, K | | ESTs |
| 23018 | 617 | AI177093 | D | | ESTs |
| 15964 | 620 | AI177360 | GENERAL, | | ESTs |
| | | | A, B, H, I, K, L | | |
| 4987 | 623 | AI177428 | F | | ESTs |
| 18095 | 624 | AI177482 | D | SH-PTP2 protein tyrosine | SH-PTP2 protein tyrosine phosphatase, |
| | | | | phosphatase, non-receptor | non-receptor type 11 |
| | | | | type 11 | |
| 150 | 625 | AI177510 | F | | ESTs |
| 14425 | 627 | AI177755 | GENERAL, L | | ESTs, Moderately similar to |
| | | | | | PBEF_HUMAN Pre-B cell enhancing |
| | | | | | factor precursor [H. sapiens] |
| 5929 | 630 | AI177962 | E | | ESTs, Moderately similar to S23251 |
| | | | | | protein-tyrosine kinase (EC 2.7.1.112) ark |
| | | | | | precursor - mouse [M. musculus] |
| 18996 | 633 | AI178326 | J | | ESTs, Highly similar to hypothetical |
| | | | | | protein MGC4175 [Homo sapiens] |
| | | | | | [H. sapiens] |
| 8445 | 634 | AI178394 | J | | ESTs |
| 22197 | 635 | AI178527 | GENERAL, H | | ESTs |
| 8477 | 638 | AI179167 | GENERAL | | ESTs |
| 13614 | 641 | AI179407 | B, L | | ESTs, Moderately similar to |
| | | | | | RB17_MOUSE Ras-related protein Rab- |
| | | | | | 17 [M. musculus] |
| 15042 | 642 | AI179422 | GENERAL | | ESTs |
| 5901 | 644 | AI179605 | D | | ESTs |
| 6765 | 648 | AI227761 | GENERAL, | | ESTs, Highly similar to EFER_HUMAN |
| | | | H, I | | Eferin [H. sapiens] |
| 6487 | 649 | AI227919 | GENERAL | | ESTs |
| 19188 | 650 | AI227938 | G, J | | ESTs |
| 15879 | 653 | AI228313 | GENERAL, K | | ESTs |
| 13727 | 654 | AI228326 | GENERAL, A | | ESTs, Weakly similar to S30825 AFG1 |
| | | | | | protein - yeast (Saccharomyces |
| | | | | | cerevisiae) [S. cerevisiae] |
| 6102 | 655 | AI228335 | L | | ESTs |
| 17892 | 656 | AI228438 | H | | ESTs |
| 13740 | 657 | AI228455 | A | | ESTs, Moderately similar to KIAA0943 |
| | | | | | protein [Homo sapiens] [H. sapiens] |
| 13176 | 659 | AI228654 | GENERAL | | ESTs |
| 22328 | 660 | AI229142 | GENERAL | | ESTs |
| 6886 | 662 | AI229332 | F | | ESTs |
| 23435 | 663 | AI229502 | H, I | | ESTs |
| 9035 | 666 | AI229879 | F, J | | ESTs |
| 11866 | 667 | AI229966 | F | | ESTs, Weakly similar to T29947 |
| | | | | | hypothetical protein T20D4.7 - |
| | | | | | Caenorhabditis elegans [C. elegans] |
| 24042 | 669 | AI230002 | C | | ESTs |
| 12551 | 670 | AI230056 | C, K | | ESTs |
| 6629 | 671 | AI230165 | D | | ESTs, Weakly similar to Deoxyribose- |
| | | | | | phosphate aldolase [Caenorhabditis |
| | | | | | elegans] [C. elegans] |
| 14450 | 673 | AI230262 | B | | ESTs |
| 18528 | 674 | AI230284 | K | | ESTs |
| 20895 | 675 | AI230549 | H | | ESTs |
| 12961 | 676 | AI230554 | GENERAL | | ESTs |
| 18529 | 677 | AI230716 | GENERAL, K | | ESTs |
| 21648 | 680 | AI230880 | J | | ESTs, Highly similar to AR21_HUMAN |
| | | | | | ARP2/3 complex 21 kDa subunit (P21- |
| | | | | | ARC) (Actin-related protein 2/3 complex |
| | | | | | subunit 3) [H. sapiens] |
| 16087 | 681 | AI231011 | F | | ESTs |
| 13934 | 683 | AI231044 | F | | ESTs |
| 13966 | 687 | AI231421 | B | | ESTs |
| 12343 | 688 | AI231433 | C | | ESTs |
| 14020 | 691 | AI232076 | GENERAL | | ESTs |
| 12366 | 693 | AI232088 | F | | ESTs |
| 15955 | 696 | AI232294 | GENERAL, | | ESTs |
| | | | G, I | | |
| 15246 | 697 | AI232332 | D | | ESTs |
| 16172 | 699 | AI232341 | K | | ESTs, Weakly similar to C13B9.2.p |
| | | | | | [Caenorhabditis elegans] [C. elegans] |
| 11157 | 701 | AI232494 | K | | ESTs |
| 4440 | 702 | AI232643 | GENERAL, I | | ESTs |
| 7285 | 703 | AI232731 | GENERAL | | ESTs, Weakly similar to E. coli YCAC like |
| | | | | | [Caenorhabditis elegans] [C. elegans] |
| 12467 | 705 | AI232924 | GENERAL | | ESTs |
| 11967 | 707 | AI233155 | GENERAL, J | | ESTs |
| 14120 | 710 | AI233433 | K | | ESTs |
| 19509 | 711 | AI233437 | L | | ESTs |
| 14095 | 712 | AI233468 | GENERAL, I | | ESTs |
| 14131 | 713 | AI233493 | L | | ESTs |
| 6046 | 714 | AI233530 | GENERAL, | | ESTs |
| | | | B, I, L | | |
| 7804 | 717 | AI233771 | K | | ESTs |
| 535 | 720 | AI233916 | E | | ESTs |
| 8325 | 721 | AI234293 | E | | ESTs |
| 14677 | 722 | AI234620 | GENERAL, | | ESTs |
| | | | G, K, L | | |
| 22213 | 723 | AI234858 | K | | ESTs, Highly similar to splicing factor 3b, |
| | | | | | subunit 3, 130 kD; spliceosome- |
| | | | | | associated protein 130 [Homo sapiens] |
| | | | | | [H. sapiens] |
| 26319 | 724 | AI234887 | H | | ESTs, Weakly similar to serine/threonine |
| | | | | | kinase [Caenorhabditis elegans] |
| | | | | | [C. elegans] |
| 8850 | 728 | AI235059 | B | | ESTs |
| 6632 | 730 | AI235277 | C | | ESTs |
| 896 | 731 | AI235313 | E | | ESTs |
| 7937 | 732 | AI235414 | B | | ESTs |
| 21061 | 734 | AI235631 | GENERAL, A | | ESTs |
| 15836 | 737 | AI235951 | A | | ESTs, Moderately similar to |
| | | | | | N4BM_HUMAN NADH-ubiquinone |
| | | | | | oxidoreductase subunit B14.5b (Complex |
| | | | | | I-B14.5b) (CI-B14.5b) [H. sapiens] |
| 3091 | 738 | AI236027 | GENERAL, | | ESTs |
| | | | A, C, H, I | | |
| 14867 | 739 | AI236061 | GENERAL | | ESTs |
| 22855 | 740 | AI236150 | A | | ESTs, Highly similar to JC7301 Down |
| | | | | | syndrome critical region protein 5 alpha - |
| | | | | | human [H. sapiens] |
| 17950 | 743 | AI236590 | L | | ESTs |
| 18259 | 744 | AI236601 | H | | ESTs |
| 2574 | 745 | AI236616 | F | | ESTs |
| 16859 | 746 | AI236753 | GENERAL, D | | ESTs |
| 24388 | 748 | AI236772 | GENERAL, K | | ESTs |
| 18303 | 750 | AI236863 | GENERAL | | Rattus norvegicus retinol dehydrogenase |
| | | | | | type II mRNA, complete cds |
| 19890 | 751 | AI237108 | F | | ESTs |
| 8759 | 755 | AI237646 | B, L | | ESTs |
| 6127 | 757 | AI638960 | A | | ESTs |
| 20000 | 759 | AI638989 | A, B | | ESTs, Moderately similar to T14273 zinc |
| | | | | | finger protein 106 - mouse [M. musculus] |
| 23781 | 760 | AI639012 | F | | ESTs, Weakly similar to hypothetical |
| | | | | | protein MGC2601 [Homo sapiens] |
| | | | | | [H. sapiens] |
| 10071 | 761 | AI639058 | F | | ESTs, Highly similar to Nedd4 WW |
| | | | | | binding# protein 4; Nedd4 WW-binding |
| | | | | | protein 4 [Mus musculus] [M. musculus] |
| 25902 | 763 | AI639154 | H | | EST |
| 15379 | 765 | AI639162 | B | | ESTs |
| 25921 | 766 | AI639209 | A, F | | |
| 15330 | 767 | AI639285 | GENERAL, | | ESTs |
| | | | F, I | | |
| 21542 | 769 | AI639476 | J | | ESTs |
| 20056 | 772 | AI639504 | GENERAL, I | | ESTs, Weakly similar to T13607 |
| | | | | | hypothetical protein 87B1.3 - fruit fly |
| | | | | | (Drosophila melanogaster) |
| | | | | | [D. melanogaster] |
| 25235 | 776 | AJ001290 | F | solute carrier family 5 | |
| | | | | (inositol transporters), | |
| | | | | member 3 | |
| 24033 | 786 | H33101 | H | | ESTs |
| 20149 | 794 | K03243 | F | | |
| 25364 | 796 | L13237 | F | | |
| 25366 | 798 | L14003 | J | | |
| 18629 | 802 | L40362 | G | | Rattus norvegicus MHC class I RT1.C- |
| | | | | | type protein mRNA, complete cds |
| 25399 | 804 | M13101 | F | | |
| 17274 | 806 | M18854 | J | | Rat T-cell receptor active beta-chain C- |
| | | | | | region mRNA, partial cds, clone TRB4 |
| 25415 | 807 | M19648 | G | | |
| 20481 | 808 | M22631 | GENERAL, | Propionyl Coenzyme A | |
| | | | G, K | carboxylase, alpha | |
| | | | | polypeptide | |
| 25419 | 809 | M22922 | G | | |
| 25470 | 820 | M95791 | E | | |
| 4529 | 836 | NM_012647 | GENERAL | Rattus norvegicus Sodium | ESTs |
| | | | | channel, voltage-gated, type | |
| | | | | II, alpha polypeptide | |
| | | | | (Scn2a1), mRNA. Length = 8553 | |
| 24590 | 838 | NM_012674 | D | Rattus norvegicus Serine | Serine protease inhibitor, kanzal type 1/ |
| | | | | protease inhibitor, kanzal | Trypsin inhibitor-like protein, pancreatic |
| | | | | type 1/Trypsin inhibitor-like | |
| | | | | protein, pancreatic (Spink1), | |
| | | | | mRNA. Length = 2338 | |
| 11136 | 856 | NM_012839 | J | Rattus norvegicus | |
| | | | | Cytochrome C, expressed in | |
| | | | | somatic tissues (Cycs), | |
| | | | | mRNA. Length = 318 | |
| 26083 | 879 | NM_013038 | B, H | Rattus norvegicus Syntaxin | |
| | | | | binding protein 1 (Stxbp1), | |
| | | | | mRNA. Length = 3226 | |
| 14996 | 883 | NM_013059 | GENERAL, D | Rattus norvegicus Tissue- | Tissue-nonspecific ALP alkaline |
| | | | | nonspecific ALP alkaline | phosphatase |
| | | | | phosphatase (Alpl), mRNA. | |
| | | | | Length = 2415 | |
| 21193 | 889 | NM_013104 | F | Rattus norvegicus Insulin-like | |
| | | | | growth factor binding protein | |
| | | | | 6 (lgfbp6), mRNA. Length = 970 | |
| 25567 | 897 | NM_013156 | GENERAL, I | Rattus norvegicus Cathepsin | |
| | | | | L (Ctsl), mRNA. Length = 1386 | |
| 25546 | 908 | NM_017023 | K | Rattus norvegicus Potassium | |
| | | | | inwardly-rectifying channel, | |
| | | | | subfamily J (Kcnj1), mRNA. | |
| | | | | Length = 2069 | |
| 18967 | 936 | NM_017222 | H | Rattus norvegicus solute | ESTs |
| | | | | carrier family 10, member 2 | |
| | | | | (Slc10a2), mRNA. Length = 4269 | |
| 16150 | 953 | NM_017340 | G | Rattus norvegicus acyl-coA | acyl-coA oxidase |
| | | | | oxidase (RATACOA1), | |
| | | | | mRNA. Length = 3741 | |
| 19930 | 994 | NM_021745 | F | Rattus norvegicus famesoid | EST |
| | | | | X activated receptor | |
| | | | | (LOC60351), mRNA. Length = 2070 | |
| 20167 | 999 | NM_021863 | E | Rattus norvegicus testis- | testis-specific heat shock protein-related |
| | | | | specific heat shock protein- | gene hst70 |
| | | | | related gene hst70 (Hspt70), | |
| | | | | mRNA. Length = 1902 | |
| 21072 | 1022 | NM_022601 | K | Rattus norvegicus pyridoxine | pyridoxine 5′-phosphate oxidase |
| | | | | 5′-phosphate oxidase | |
| | | | | (U91561), mRNA. Length = 1686 | |
| 2812 | 1037 | NM_024386 | J | Rattus norvegicus 3-hydroxy- | 3-hydroxy-3-methylglutaryl CoA lyase |
| | | | | 3-methylglutaryl CoA lyase | |
| | | | | (Hmgcl), mRNA. Length = 1390 | |
| 25453 | 1046 | NM_030985 | GENERAL, L | Rattus norvegicus | |
| | | | | Angiotensin II receptor, type | |
| | | | | 1 (AT1A) (Agtr1a), mRNA. | |
| | | | | Length = 1450 | |
| 7872 | 1046 | NM_030985 | GENERAL, B | Rattus norvegicus | ESTs |
| | | | | Angiotensin II receptor, type | |
| | | | | 1 (AT1A) (Agtr1a), mRNA. | |
| | | | | Length = 1450 | |
| 17269 | 1051 | NM_031057 | GENERAL | Rattus norvegicus | methylmalonate semialdehyde |
| | | | | methylmalonate | dehydrogenase gene |
| | | | | semialdehyde | |
| | | | | dehydrogenase gene | |
| | | | | (Mmsdh), mRNA. Length = 2059 | |
| 25862 | 1071 | NM_031357 | A | Rattus norvegicus ceroid- | |
| | | | | lipofuscinosis, neuronal 2 | |
| | | | | (Cln2), mRNA. Length = 2485 | |
| 26183 | 1071 | NM_031357 | A | Rattus norvegicus ceroid- | |
| | | | | lipofuscinosis, neuronal 2 | |
| | | | | (Cln2), mRNA. Length = 2485 | |
| 25069 | 1072 | NM_031509 | H | Rattus norvegicus | |
| | | | | Glutathione-S-transferase, | |
| | | | | alpha type (Ya) (Gsta1), | |
| | | | | mRNA. Length = 1178 | |
| 16245 | 1073 | NM_031523 | G | Rattus norvegicus Nerve | |
| | | | | growth factor, gamma | |
| | | | | polypeptide (Ngfg), mRNA. | |
| | | | | Length = 873 | |
| 11755 | 1075 | NM_031533 | B, H | Rattus norvegicus | |
| | | | | Androsterone UDP- | |
| | | | | glucuronosyltransferase | |
| | | | | (Ugt2b2), mRNA. Length = 1593 | |
| 1807 | 1092 | NM_031693 | L | Rattus norvegicus | |
| | | | | synaptotagmin 4 (Syt4), | |
| | | | | mRNA. Length = 2060 | |
| 25469 | 1123 | NM_033234 | J | Rattus norvegicus | |
| | | | | Hemoglobin, beta (Hbb), | |
| | | | | mRNA. Length = 620 | |
| 1553 | 1127 | NM_052802 | J | Rattus norvegicus Kidney | Kidney androgen-regulated protein |
| | | | | androgen-regulated protein | |
| | | | | (Kap), mRNA. Length = 704 | |
| 20708 | 1142 | NM_053543 | A | Rattus norvegicus | neurochondrin |
| | | | | neurochondrin (Ncdn- | |
| | | | | pending), mRNA. Length = 3730 | |
| 3049 | 1146 | NM_053582 | GENERAL | Rattus norvegicus | glucocorticoid-inducible protein |
| | | | | glucocorticoid-inducible | |
| | | | | protein (gis5), mRNA. Length = 1869 | |
| 3050 | 1146 | NM_053582 | GENERAL | Rattus norvegicus | glucocorticoid-inducible protein |
| | | | | glucocorticoid-inducible | |
| | | | | protein (gis5), mRNA. Length = 1869 | |
| 968 | 1178 | NM_057133 | G, K | Rattus norvegicus nuclear | nuclear receptor subfamily 0, group B, |
| | | | | receptor subfamily 0, group | member 2 |
| | | | | B, member 2 (Nr0b2), | |
| | | | | mRNA. Length = 1111 | |
| 20694 | 1193 | NM_130430 | GENERAL, I | Rattus norvegicus | ESTs |
| | | | | proteasome (prosome, | |
| | | | | macropain) 26S subunit, non- | |
| | | | | ATPase, 9 (Psmd9), mRNA. | |
| | | | | Length = 1448 | |
| 25064 | 1194 | S45392 | H, K | | |
| 3244 | 1196 | S63519 | GENERAL | | ESTs |
| 9224 | 1198 | S70011 | C | | ESTs, Weakly similar to T19996 |
| | | | | | hypothetical protein C47D12.3 - |
| | | | | | Caenorhabditis elegans [C. elegans] |
| 25547 | 1200 | S78556 | C | | |
| 25550 | 1201 | S79213 | J | protein phosphatase 1, | |
| | | | | regulatory (inhibitor) subunit 2 | |
| 9520 | 1209 | U17837 | B | | ESTs |
| 25589 | 1213 | U21718 | F | | |
| 22196 | 1214 | U21719 | GENERAL | | ESTs |
| 18301 | 1218 | U33500 | GENERAL | | Rattus norvegicus retinol dehydrogenase |
| | | | | | type II mRNA, complete cds |
| 18302 | 1218 | U33500 | GENERAL | | Rattus norvegicus retinol dehydrogenase |
| | | | | | type II mRNA, complete cds |
| 25606 | 1222 | U53214 | C | tubulin tyrosine ligase | tubulin tyrosine ligase |
| 4956 | 1228 | U76714 | H | solute carrier family 39 (iron- | solute carrier family 39 (iron-regulated |
| | | | | regulated transporter), | transporter), member 1 |
| | | | | member 1 | |
| 25643 | 1229 | U77829 | A | growth arrest specific 5 | |
| 25647 | 1230 | U83119 | F | | |
| 25662 | 1234 | X05472 | F | | |
| 25691 | 1239 | X53504 | G | | |
| 25692 | 1240 | X53581 | D | | |
| 20617 | 1240 | X53581 | F | | |
| 25705 | 1245 | X59375 | GENERAL, J | | |
| 16012 | 1251 | X62875 | GENERAL, I | high mobility group AT-hook 1 | ESTs, Highly similar to A31895 |
| | | | | | nonhistone chromosomal protein HMG- |
| | | | | | I(Y) - mouse [M. musculus] |
| 25747 | 1253 | X81448 | GENERAL, | keratin complex 1, acidic, | |
| | | | C, K | gene 18 | |
| 12978 | 1254 | X96437 | GENERAL, | | ESTs, Highly similar to S33363 gly96 |
| | | | H, I | | protein - mouse [M. musculus] |
| 25777 | 1255 | Y08355 | GENERAL, | oxidative stress induced | oxidative stress induced |
| | | | A, F, I | | |

TABLE 2
PATHWAYS

Atty. Docket No. GENE-077/26US
Doc. No. 44941

| GLGC | Seq | GenBank Acc or | | |
|---|---|---|---|---|
| Identifier | ID | RefSeq ID | Model Code | Pathways |
| 20414 | 799 | L14323 | GENERAL | Activation of PKC through G protein coupled receptor, CCR3 |
| | | | | signaling in Eosinophils, G-Protein Signaling Through Tubby |
| | | | | Proteins, Inositol phosphate metabolism, PKC-catalyzed |
| | | | | phosphorylation of inhibitory phosphoprotein of myosin |
| | | | | phosphatase, Phosphatidylinositol signaling system, |
| | | | | Phospholipase C Signaling Pathway, Regulation of ck1/cdk5 by |
| | | | | type 1 glutamate receptors, Thrombin signaling and protease- |
| | | | | activated receptors |
| 2554 | 873 | NM_012967 | GENERAL | Adhesion Molecules on Lymphocyte, B Lymphocyte Cell Surface |
| | | | | Molecules, CTL mediated immune response against target cells, |
| | | | | Cells and Molecules involved in local acute inflammatory |
| | | | | response, Monocyte and its Surface Molecules, Neutrophil and Its |
| | | | | Surface Molecules, T Cytotoxic Cell Surface Molecules, T Helper |
| | | | | Cell Surface Molecules |
| 2555 | 873 | NM_012967 | GENERAL, C, I | Adhesion Molecules on Lymphocyte, B Lymphocyte Cell Surface |
| | | | | Molecules, CTL mediated immune response against target cells, |
| | | | | Cells and Molecules involved in local acute inflammatory |
| | | | | response, Monocyte and its Surface Molecules, Neutrophil and Its |
| | | | | Surface Molecules, T Cytotoxic Cell Surface Molecules, T Helper |
| | | | | Cell Surface Molecules |
| 14989 | 621 | AI177366 | GENERAL, K | Adhesion Molecules on Lymphocyte, Cells and Molecules |
| | | | | involved in local acute inflammatory response, Erk and PI-3 |
| | | | | Kinase Are Necessary for Collagen Binding in Corneal Epithelia, |
| | | | | Erk1/Erk2 Mapk Signaling pathway, Integrin Signaling Pathway, |
| | | | | Monocyte and its Surface Molecules, PTEN dependent cell cycle |
| | | | | arrest and apoptosis, Ras-Independent pathway in NK cell- |
| | | | | mediated cytotoxicity |
| 16684 | 882 | NM_013052 | GENERAL | AKT Signaling Pathway, Cell Cycle: G2/M Checkpoint, Control of |
| | | | | skeletal myogenesis by HDAC & calcium/calmodulin-dependent |
| | | | | kinase (CaMK), Multiple antiapoptotic pathways from IGF-1R |
| | | | | signaling lead to BAD phosphphorylation, RB Tumor |
| | | | | Suppressor/Checkpoint Signaling in response to DNA damage, |
| | | | | Regulation of BAD phosphorylation, Role of nicotinic acetylcholine |
| | | | | receptors in the regulation of apoptosis, Signal Dependent |
| | | | | Regulation of Myogenesis by Corepressor MITR, cdc25 and chk1 |
| | | | | Regulatory Pathway in response to DNA damage |
| 17524 | 381 | AI010568 | GENERAL, A, I | AKT Signaling Pathway, Growth Hormone Signaling Pathway, |
| | | | | Regulation of eIF4e and p70 S6 Kinase |
| 10887 | 917 | NM_017094 | GENERAL, I | AKT Signaling Pathway, Growth Hormone Signaling Pathway, |
| | | | | Regulation of eIF4e and p70 S6 Kinase |
| 4234 | 1068 | NM_031330 | K | Alanine and aspartate metabolism, Arginine and proline |
| | | | | metabolism, Urea cycle and metabolism of amino groups |
| 1478 | 843 | NM_012744 | GENERAL | Alanine and aspartate metabolism, Citrate cycle (TCA cycle), |
| | | | | Pyruvate metabolism |
| 1479 | 843 | NM_012744 | D | Alanine and aspartate metabolism, Citrate cycle (TCA cycle), |
| | | | | Pyruvate metabolism |
| 1430 | 816 | M84648 | GENERAL | Alkaloid biosynthesis I, Histidine metabolism, Phenylalanine |
| | | | | metabolism, Tryptophan metabolism, Tyrosine metabolism |
| 1431 | 824 | NM_012545 | D | Alkaloid biosynthesis I, Histidine metabolism, Phenylalanine |
| | | | | metabolism, Tryptophan metabolism, Tyrosine metabolism |
| 7489 | 963 | NM_019169 | GENERAL, G, I, | Alpha-synuclein and Parkin-mediated proteolysis in Parkinson's |
| | | | J, L | disease, Role of Parkin in Ubiquitin-Proteasomal Pathway |
| 16756 | 38 | AA818089 | GENERAL, A, I | Aminoacyl-tRNA biosynthesis, Glycine, serine and threonine |
| | | | | metabolism |
| 12031 | 201 | AA893860 | GENERAL, I | Aminoacyl-tRNA biosynthesis, Glycine, serine and threonine |
| | | | | metabolism |
| 2702 | 295 | AA957307 | GENERAL, I, J | Aminoacyl-tRNA biosynthesis, Glycine, serine and threonine |
| | | | | metabolism |
| 1515 | 1053 | NM_031095 | J | Aminosugars metabolism |
| 25070 | 1038 | NM_024392 | GENERAL | Androgen and estrogen metabolism |
| 275 | 914 | NM_017081 | GENERAL | Androgen and estrogen metabolism, C21-Steroid hormone |
| | | | | metabolism |
| 14633 | 1075 | NM_031533 | H | Androgen and estrogen metabolism, Pentose and glucuronate |
| | | | | interconversions, Porphyrin and chlorophyll metabolism, Starch |
| | | | | and sucrose metabolism |
| 15124 | 1175 | NM_057105 | B | Androgen and estrogen metabolism, Pentose and glucuronate |
| | | | | interconversions, Porphyrin and chlorophyll metabolism, Starch |
| | | | | and sucrose metabolism |
| 15125 | 1175 | NM_057105 | B | Androgen and estrogen metabolism, Pentose and glucuronate |
| | | | | interconversions, Porphyrin and chlorophyll metabolism, Starch |
| | | | | and sucrose metabolism |
| 11755 | 1075 | NM_031533 | B, H | Androgen and estrogen metabolism, Pentose and glucuronate |
| | | | | interconversions, Porphyrin and chlorophyll metabolism, Starch |
| | | | | and sucrose metabolism |
| 17907 | 708 | AI233224 | GENERAL | Angiotensin II mediated activation of JNK Pathway via Pyk2 |
| | | | | dependent signaling, EGF Signaling Pathway, Erk1/Erk2 Mapk |
| | | | | Signaling pathway, egf |
| 11137 | 856 | NM_012839 | J | Apoptotic Signaling in Response to DNA Damage, Caspase |
| | | | | Cascade in Apoptosis, D4-GDI Signaling Pathway, Electron - |
| | | | | Transfer Reaction in Mitochondria, HIV-I Nef: negative effector of |
| | | | | Fas and TNF, Induction of apoptosis through DR3 and DR4/5 |
| | | | | Death Receptors, Role of Mitochondria in Apoptotic Signaling |
| 16116 | 1105 | NM_031775 | F | Apoptotic Signaling in Response to DNA Damage, Caspase |
| | | | | Cascade in Apoptosis, FAS signaling pathway (CD95), HIV-I Nef: |
| | | | | negative effector of Fas and TNF, Induction of apoptosis through |
| | | | | DR3 and DR4/5 Death Receptors, Role of Mitochondria in |
| | | | | Apoptotic Signaling |
| 16884 | 517 | AI103758 | E | Arginine and proline metabolism, Ascorbate and aldarate |
| | | | | metabolism, Bile acid biosynthesis, Butanoate metabolism, Fatty |
| | | | | acid metabolism, Glycerolipid metabolism, Glycolysis/ |
| | | | | Gluconeogenesis, Histidine metabolism, Lysine degradation, |
| | | | | Propanoate metabolism, Pyruvate metabolism, Tryptophan |
| | | | | metabolism, Valine, leucine and isoleucine degradation, beta- |
| | | | | Alanine metabolism |
| 16885 | 531 | AI105188 | K | Arginine and proline metabolism, Ascorbate and aldarate |
| | | | | metabolism, Bile acid biosynthesis, Butanoate metabolism, Fatty |
| | | | | acid metabolism, Glycerolipid metabolism, Glycolysis/ |
| | | | | Gluconeogenesis, Histidine metabolism, Lysine degradation, |
| | | | | Propanoate metabolism, Pyruvate metabolism, Tryptophan |
| | | | | metabolism, Valine, leucine and isoleucine degradation, beta- |
| | | | | Alanine metabolism |
| 23884 | 1099 | NM_031731 | J | Arginine and proline metabolism, Ascorbate and aldarate |
| | | | | metabolism, Bile acid biosynthesis, Butanoate metabolism, Fatty |
| | | | | acid metabolism, Glycerolipid metabolism, Glycolysis/ |
| | | | | Gluconeogenesis, Histidine metabolism, Lysine degradation, |
| | | | | Propanoate metabolism, Pyruvate metabolism, Tryptophan |
| | | | | metabolism, Valine, leucine and isoleucine degradation, beta- |
| | | | | Alanine metabolism |
| 16948 | 850 | NM_012793 | A, C | Arginine and proline metabolism, Glycine, serine and threonine |
| | | | | metabolism, Urea cycle and metabolism of amino groups |
| 16775 | 1048 | NM_031031 | GENERAL, D, I, L | Arginine and proline metabolism, Glycine, serine and threonine |
| | | | | metabolism, Urea cycle and metabolism of amino groups |
| 25467 | 818 | M93297 | G | Arginine and proline metabolism, Urea cycle and metabolism of |
| | | | | amino groups |
| 22352 | 603 | AI175959 | GENERAL, H | ATM Signaling Pathway, Angiotensin II mediated activation of JNK |
| | | | | Pathway via Pyk2 dependent signaling, BCR Signaling Pathway, |
| | | | | D4-GDI Signaling Pathway, EGF Signaling Pathway, EPO |
| | | | | Signaling Pathway, FAS signaling pathway (CD95), Fc Epsilon |
| | | | | Receptor I Signaling in Mast Cells, Hypoxia-Inducible Factor in the |
| | | | | Cardiovascular System, IGF-1 Signaling Pathway, IL 2 signaling |
| | | | | pathway, IL 6 signaling pathway, Inhibition of Cellular Proliferation |
| | | | | by Gleevec, Insulin Signaling Pathway, Integrin Signaling |
| | | | | Pathway, Links between Pyk2 and Map Kinases, MAPKinase |
| | | | | Signaling Pathway, Nerve growth factor pathway (NGF), PDGF |
| | | | | Signaling Pathway, Pertussis toxin-insensitive CCR5 Signaling in |
| | | | | Macrophage, Repression of Pain Sensation by the Transcriptional |
| | | | | Regulator DREAM, Signal transduction through IL1R, Signaling |
| | | | | Pathway from G-Protein Families, T Cell Receptor Signaling |
| | | | | Pathway, TNF/Stress Related Signaling, TNFR1 Signaling |
| | | | | Pathway, TPO Signaling Pathway, TSP-1 Induced Apoptosis in |
| | | | | Microvascular Endothelial Cell, The 41BB-dependent immune |
| | | | | [symbol] |
| 352 | 1030 | NM_024127 | H | ATM Signaling Pathway, Cell Cycle: G2/M Checkpoint, Hypoxia |
| | | | | and p53 in the Cardiovascular system, p53 Signaling Pathway |
| 353 | 1030 | NM_024127 | GENERAL, H, I | ATM Signaling Pathway, Cell Cycle: G2/M Checkpoint, Hypoxia |
| | | | | and p53 in the Cardiovascular system, p53 Signaling Pathway |
| 354 | 1030 | NM_024127 | GENERAL, H, I | ATM Signaling Pathway, Cell Cycle: G2/M Checkpoint, Hypoxia |
| | | | | and p53 in the Cardiovascular system, p53 Signaling Pathway |
| 22662 | 725 | AI234939 | GENERAL | ATP Synthesis, Oxidative phosphorylation |
| 2107 | 143 | AA892006 | D, K | ATP Synthesis, Oxidative phosphorylation |
| 20725 | 1149 | NM_053602 | A | ATP Synthesis, Oxidative phosphorylation, Purine metabolism |
| 21562 | 1185 | NM_078623 | A | Benzoate degradation, Butanoate metabolism, Fatty acid |
| | | | | biosynthesis (path 2), Fatty acid metabolism, Lysine degradation, |
| | | | | Propanoate metabolism, Tryptophan metabolism, Valine, leucine |
| | | | | and isoleucine degradation, beta-Alanine metabolism |
| 15175 | 1091 | NM_031682 | E | Benzoate degradation, Butanoate metabolism, Fatty acid |
| | | | | biosynthesis (path 2), Fatty acid metabolism, Lysine degradation, |
| | | | | Tryptophan metabolism, Valine, leucine and isoleucine |
| | | | | degradation |
| 23698 | 821 | NM_012489 | D | Bile acid biosynthesis, Fatty acid biosynthesis (path 2), Fatty acid |
| | | | | metabolism, Valine, leucine and isoleucine degradation |
| 23699 | 821 | NM_012489 | D, E | Bile acid biosynthesis, Fatty acid biosynthesis (path 2), Fatty acid |
| | | | | metabolism, Valine, leucine and isoleucine degradation |
| 22219 | 972 | NM_019286 | F | Bile acid biosynthesis, Fatty acid metabolism, Glycerolipid |
| | | | | metabolism, Glycolysis/Gluconeogenesis, Tyrosine metabolism |
| 13939 | 933 | NM_017212 | D | Bioactive Peptide Induced Signaling Pathway |
| 13940 | 933 | NM_017212 | D | Bioactive Peptide Induced Signaling Pathway |
| 2812 | 1037 | NM_024386 | J | Butanoate metabolism, Synthesis and degradation of ketone |
| | | | | bodies, Valine, leucine and isoleucine degradation |
| 165 | 561 | AI145329 | F | Carbon fixation, Citrate cycle (TCA cycle), Glyoxylate and |
| | | | | dicarboxylate metabolism, Pyruvate metabolism, Reductive |
| | | | | carboxylate cycle (CO2 fixation) |
| 1312 | 1130 | NM_053291 | J | Carbon fixation, Glycolysis/Gluconeogenesis, Glycolysis |
| | | | | Pathway |
| 20802 | 1018 | NM_022592 | H | Carbon fixation, Pentose phosphate pathway |
| 20803 | 1018 | NM_022592 | B, H, I | Carbon fixation, Pentose phosphate pathway |
| 20804 | 1018 | NM_022592 | H | Carbon fixation, Pentose phosphate pathway |
| 20086 | 403 | AI013260 | GENERAL, H | Caspase Cascade in Apoptosis, FAS signaling pathway (CD95), |
| | | | | HIV-I Nef: negative effector of Fas and TNF, Induction of |
| | | | | apoptosis through DR3 and DR4/5 Death Receptors, TNFR1 |
| | | | | Signaling Pathway |
| 20085 | 997 | NM_021755 | C | Caspase Cascade in Apoptosis, FAS signaling pathway (CD95), |
| | | | | HIV-I Nef: negative effector of Fas and TNF, Induction of |
| | | | | apoptosis through DR3 and DR4/5 Death Receptors, TNFR1 |
| | | | | Signaling Pathway |
| 5206 | 235 | AA925755 | E | Catabolic Pathways for Arginine, Histidine, Glutamate, Glutamine, |
| | | | | and Proline, D-Glutamine and D-glutamate metabolism, |
| | | | | Glutamate metabolism, Nitrogen metabolism |
| 291 | 822 | NM_012522 | GENERAL, F | Catabolic Pathways for Methionine, Isoleucine, Threonine and |
| | | | | Valin, Glycine, serine and threonine metabolism, Methionine |
| | | | | metabolism, Selenoamino acid metabolism |
| 15364 | 921 | NM_017147 | J | CCR3 signaling in Eosinophils, Rac 1 cell motility signaling |
| | | | | pathway, Rho cell motility signaling pathway |
| 11434 | 778 | D14014 | B | Cell Cycle: G1/S Check Point, Cyclins and Cell Cycle Regulation, |
| | | | | Inactivation of Gsk3 by AKT causes accumulation of b-catenin in |
| | | | | Alveolar Macrophages, Influence of Ras and Rho proteins on G1 |
| | | | | to S Transition, WNT Signaling Pathway, p53 Signaling Pathway |
| 24232 | 1252 | X75207 | B | Cell Cycle: G1/S Check Point, Cyclins and Cell Cycle Regulation, |
| | | | | Inactivation of Gsk3 by AKT causes accumulation of b-catenin in |
| | | | | Alveolar Macrophages, Influence of Ras and Rho proteins on G1 |
| | | | | to S Transition, WNT Signaling Pathway, p53 Signaling Pathway |
| 21165 | 1047 | NM_031005 | K | Cell to Cell Adhesion Signaling, Integrin Signaling Pathway |
| 21166 | 1047 | NM_031005 | K | Cell to Cell Adhesion Signaling, Integrin Signaling Pathway |
| 6758 | 405 | AI013394 | B, L | Chondroitin/Heparan sulfate biosynthesis |
| 17516 | 950 | NM_017321 | A, E, L | Citrate cycle (TCA cycle), Glyoxylate and dicarboxylate |
| | | | | metabolism, Reductive carboxylate cycle (CO2 fixation) |
| 19991 | 1169 | NM_053961 | K | Citrate cycle (TCA cycle), Glyoxylate and dicarboxylate |
| | | | | metabolism, Reductive carboxylate cycle (CO2 fixation) |
| 17514 | 232 | AA925554 | E, G | Citrate cycle (TCA cycle), Oxidative phosphorylation |
| 15851 | 1219 | U42719 | GENERAL | Classic Complement Pathway, Complement Pathway, Lectin |
| | | | | Induced Complement Pathway |
| 21053 | 805 | M15481 | GENERAL | Control of skeletal myogenesis by HDAC & calcium/calmodulin- |
| | | | | dependent kinase (CaMK), Erythrocyte Differentiation Pathway, |
| | | | | IGF-1 Signaling Pathway, Regulation of BAD phosphorylation, |
| | | | | Skeletal muscle hypertrophy is regulated via AKT/mTOR pathway, |
| | | | | igf-1 |
| 24321 | 698 | AI232340 | GENERAL, K, L | CXCR4 Signaling Pathway, Pertussis toxin-insensitive CCR5 |
| | | | | Signaling in Macrophage |
| 16354 | 782 | D50564 | C | Cysteine metabolism |
| 17807 | 909 | NM_017025 | GENERAL, G | Cysteine metabolism, Glycolysis/Gluconeogenesis, Hypoxia- |
| | | | | Inducible Factor in the Cardiovascular System, Propanoate |
| | | | | metabolism, Pyruvate metabolism |
| 7124 | 829 | NM_012595 | E | Cysteine metabolism, Glycolysis/Gluconeogenesis, Propanoate |
| | | | | metabolism, Pyruvate metabolism |
| 18452 | 913 | NM_017074 | GENERAL | Cysteine metabolism, Methionine metabolism, Nitrogen |
| | | | | metabolism, Selenoamino acid metabolism |
| 18453 | 913 | NM_017074 | G | Cysteine metabolism, Methionine metabolism, Nitrogen |
| | | | | metabolism, Selenoamino acid metabolism |
| 15028 | 1129 | NM_052809 | F | Cysteine metabolism, Taurine and hypotaurine metabolism |
| 20884 | 857 | NM_012842 | G, K | EGF Signaling Pathway, egf |
| 20885 | 857 | NM_012842 | G, K | EGF Signaling Pathway, egf |
| 25233 | 774 | AJ000556 | E | EGF Signaling Pathway, IFN alpha signaling pathway, IFN |
| | | | | gamma signaling pathway, IL 2 signaling pathway, IL 4 signaling |
| | | | | pathway, IL-2 Receptor B Protein Interaction Pathway, PDGF |
| | | | | Signaling Pathway, egf, ifn_alpha, ifn_gamma, il2, il4, il6, interact6 |
| | | | | 1, pdgf |
| 2629 | 830 | NM_012603 | K | Erk1/Erk2 Mapk Signaling pathway, IL-2 Receptor B Protein |
| | | | | Interaction Pathway, Inhibition of Cellular Proliferation by Gleevec, |
| | | | | Neuropeptides VIP and PACAP inhibit the apoptosis of activated T |
| | | | | cells, Overview of telomerase protein component gene hTert |
| | | | | Transcriptional Regulation, WNT Signaling Pathway, p38 MAPK |
| | | | | Signaling Pathway |
| 15926 | 1150 | NM_053607 | D | Fatty acid metabolism |
| 20983 | 440 | AI044900 | K | Fatty acid metabolism |
| 13004 | 1154 | NM_053623 | J, L | Fatty acid metabolism |
| 13005 | 1154 | NM_053623 | C | Fatty acid metabolism |
| 16150 | 953 | NM_017340 | G | Fatty acid metabolism |
| 1977 | 870 | NM_012930 | L | Fatty acid metabolism, Glycerolipid metabolism, Mitochondrial |
| | | | | Carnitine Palmitoyltransferase (CPT) System |
| 15411 | 1078 | NM_031559 | B, L | Fatty acid metabolism, Glycerolipid metabolism, Mitochondrial |
| | | | | Carnitine Palmitoyltransferase (CPT) System, Reversal of Insulin |
| | | | | Resistance by Leptin |
| 21078 | 902 | NM_016986 | G | Fatty acid metabolism, Propanoate metabolism, Valine, leucine |
| | | | | and isoleucine degradation, beta-Alanine metabolism |
| 20711 | 905 | NM_016999 | L | Fatty acid metabolism, Tryptophan metabolism |
| 20713 | 905 | NM_016999 | J, L | Fatty acid metabolism, Tryptophan metabolism |
| 20714 | 905 | NM_016999 | J, L | Fatty acid metabolism, Tryptophan metabolism |
| 20715 | 905 | NM_016999 | L | Fatty acid metabolism, Tryptophan metabolism |
| 67 | 1085 | NM_031605 | B | Fatty acid metabolism, Tryptophan metabolism |
| 20716 | 984 | NM_019623 | G | Fatty acid metabolism, Tryptophan metabolism |
| 4011 | 1076 | NM_031543 | J | Fatty acid metabolism, Tryptophan metabolism |
| 4012 | 1076 | NM_031543 | J | Fatty acid metabolism, Tryptophan metabolism |
| 19252 | 1145 | NM_053576 | H | Flavonoids, stilbene and lignin biosynthesis, Methane metabolism, |
| | | | | Phenylalanine metabolism |
| 19254 | 1145 | NM_053576 | H | Flavonoids, stilbene and lignin biosynthesis, Methane metabolism, |
| | | | | Phenylalanine metabolism |
| 21400 | 811 | M36410 | C, F | Folate biosynthesis |
| 14996 | 883 | NM_013059 | GENERAL, D | Folate biosynthesis, Glycerolipid metabolism |
| 1549 | 1009 | NM_022508 | G | Folate biosynthesis, Glyoxylate and dicarboxylate metabolism, |
| | | | | One carbon pool by folate |
| 1527 | 934 | NM_017220 | B | Folate biosynthesis, Nicotinate and nicotinamide metabolism, |
| | | | | Purine metabolism, Pyrimidine metabolism |
| 19936 | 1071 | NM_031357 | D | Folate biosynthesis, Pyrimidine metabolism, Taurine and |
| | | | | hypotaurine metabolism |
| 20876 | 910 | NM_017050 | J | Free Radical Induced Apoptosis |
| 6405 | 801 | L38615 | G | Free Radical Induced Apoptosis, Glutamate metabolism, |
| | | | | Glutathione metabolism |
| 21975 | 923 | NM_017154 | B, L | Free Radical Induced Apoptosis, Purine metabolism |
| 1877 | 911 | NM_017052 | A, D, E | Fructose and mannose metabolism |
| 16726 | 1112 | NM_031855 | GENERAL, E, G, | Fructose and mannose metabolism |
| | | | H, I | |
| 1340 | 1098 | NM_031715 | B | Fructose and mannose metabolism, Galactose metabolism, |
| | | | | Glycolysis/Gluconeogenesis, Pentose phosphate pathway |
| 25377 | 800 | L25387 | D | Fructose and mannose metabolism, Galactose metabolism, |
| | | | | Glycolysis/Gluconeogenesis, Pentose phosphate pathway |
| 19712 | 994 | NM_021745 | K | FXR and LXR Regulation of Cholesterol Metabolism |
| 1214 | 1102 | NM_031741 | GENERAL, K | FXR and LXR Regulation of Cholesterol Metabolism |
| 989 | 976 | NM_019318 | D, F | GATA3 participate in activating the Th2 cytokine genes |
| | | | | expression |
| 14003 | 948 | NM_017305 | B, J | Glutamate metabolism, Glutathione metabolism |
| 1247 | 792 | J05181 | J | Glutamate metabolism, Glutathione metabolism |
| 18990 | 1072 | NM_031509 | H | Glutathione metabolism |
| 20817 | 398 | AI012589 | GENERAL | Glutathione metabolism |
| 20818 | 1233 | X02904 | GENERAL | Glutathione metabolism |
| 21012 | 788 | J02592 | B | Glutathione metabolism |
| 21014 | 791 | J03914 | B, L | Glutathione metabolism |
| 15017 | 790 | J03752 | B | Glutathione metabolism |
| 1399 | 907 | NM_017006 | GENERAL, H, I | Glutathione metabolism, Pentose phosphate pathway |
| 3512 | 927 | NM_017177 | F | Glycerolipid metabolism |
| 755 | 890 | NM_013126 | GENERAL | Glycerolipid metabolism, Phosphatidylinositol signaling system |
| 1535 | 331 | AB000778 | F | Glycerolipid metabolism, Phospholipid degradation, Rac 1 cell |
| | | | | motility signaling pathway, Ras Signaling Pathway |
| 21038 | 1042 | NM_024484 | H | Glycine, serine and threonine metabolism |
| 21039 | 1042 | NM_024484 | H | Glycine, serine and threonine metabolism |
| 1551 | 915 | NM_017084 | G | Glycine, serine and threonine metabolism |
| 21585 | 1087 | NM_031620 | D | Glycine, serine and threonine metabolism |
| 21586 | 1087 | NM_031620 | D | Glycine, serine and threonine metabolism |
| 21587 | 1087 | NM_031620 | D | Glycine, serine and threonine metabolism |
| 574 | 985 | NM_019905 | GENERAL, E, G, K | Glyoxylate and dicarboxylate metabolism |
| 573 | 692 | AI232087 | J | Glyoxylate and dicarboxylate metabolism |
| 22537 | 175 | AA892799 | GENERAL, A, D | Glyoxylate and dicarboxylate metabolism, Pyruvate metabolism |
| 22538 | 175 | AA892799 | GENERAL, D | Glyoxylate and dicarboxylate metabolism, Pyruvate metabolism |
| 22539 | 175 | AA892799 | GENERAL | Glyoxylate and dicarboxylate metabolism, Pyruvate metabolism |
| 22540 | 221 | AA924630 | E | Glyoxylate and dicarboxylate metabolism, Pyruvate metabolism |
| 3608 | 1049 | NM_031044 | GENERAL, J | Histidine metabolism |
| 3610 | 1049 | NM_031044 | GENERAL, G, I, J | Histidine metabolism |
| 3609 | 1203 | S82579 | F | Histidine metabolism |
| 1698 | 906 | NM_017000 | GENERAL, B, H, I | Hypoxia and p53 in the Cardiovascular system, Sterol |
| | | | | biosynthesis |
| 21239 | 1029 | NM_024125 | GENERAL, H, I | IL 6 signaling pathway, il6, interact6-1 |
| 4392 | 918 | NM_017101 | H | IL-2 Receptor B Protein Interaction Pathway |
| 17234 | 507 | AI102741 | J | Inhibition of Matrix Metalloproteinases, p53 Signaling Pathway |
| 10087 | 589 | AI171803 | GENERAL | Inositol metabolism, Propanoate metabolism, Valine, leucine and |
| | | | | isoleucine degradation |
| 17269 | 1051 | NM_031057 | GENERAL | Inositol metabolism, Propanoate metabolism, Valine, leucine and |
| | | | | isoleucine degradation |
| 20449 | 1074 | NM_031530 | GENERAL | Msp/Ron Receptor Signaling Pathway, Pertussis toxin-insensitive |
| | | | | CCR5 Signaling in Macrophage |
| 6782 | 606 | AI176170 | B | mTOR Signaling Pathway |
| 15295 | 887 | NM_013102 | GENERAL, H, I | mTOR Signaling Pathway |
| 15296 | 887 | NM_013102 | H, I | mTOR Signaling Pathway |
| 15297 | 887 | NM_013102 | K | mTOR Signaling Pathway |
| 16625 | 324 | AA998062 | D | N-Glycans biosynthesis |
| 21575 | 1093 | NM_031698 | J | N-Glycans biosynthesis |
| 11653 | 62 | AA848689 | A, F | Nitrogen metabolism |
| 18597 | 1067 | NM_031325 | B, H | Nucleotide sugars metabolism, Pentose and glucuronate |
| | | | | interconversions, Starch and sucrose metabolism |
| 12606 | 1016 | NM_022547 | E, K | One carbon pool by folate |
| 15050 | 520 | AI103911 | I | Oxidative phosphorylation |
| 3099 | 664 | AI229680 | E | Oxidative phosphorylation, Ubiquinone biosynthesis |
| 15653 | 1236 | X14210 | G | Oxidative phosphorylation, Ubiquinone biosynthesis |
| 21302 | 404 | AI013297 | J | Oxidative phosphorylation, Ubiquinone biosynthesis |
| 11454 | 1004 | NM_022381 | GENERAL | p53 Signaling Pathway |
| 11455 | 1004 | NM_022381 | GENERAL | p53 Signaling Pathway |
| 811 | 1095 | NM_031705 | GENERAL, I | Pantothenate and CoA biosynthesis, Pyrimidine metabolism, beta- |
| | | | | Alanine metabolism |
| 812 | 1095 | NM_031705 | GENERAL, I | Pantothenate and CoA biosynthesis, Pyrimidine metabolism, beta- |
| | | | | Alanine metabolism |
| 1508 | 1163 | NM_053845 | G | Pantothenate and CoA biosynthesis, Pyrimidine metabolism, beta- |
| | | | | Alanine metabolism |
| 24643 | 1006 | NM_022400 | K | Pantothenate and CoA biosynthesis, Valine, leucine and |
| | | | | isoleucine biosynthesis, Valine, leucine and isoleucine |
| | | | | degradation |
| 16039 | 1107 | NM_031811 | H | Pentose phosphate pathway |
| 24582 | 939 | NM_017243 | D | Pentose phosphate pathway, Purine metabolism |
| 1847 | 834 | NM_012634 | B | Pentose phosphate pathway, Purine metabolism |
| 6055 | 831 | NM_012619 | GENERAL, D | Phenylalanine, tyrosine and tryptophan biosynthesis |
| 14978 | 622 | AI177386 | F | Phosphatidylinositol signaling system |
| 1844 | 835 | NM_012637 | J | Phosphatidylinositol signaling system |
| 245 | 952 | NM_017336 | J | Phosphatidylinositol signaling system |
| 247 | 952 | NM_017336 | J | Phosphatidylinositol signaling system |
| 18095 | 624 | AI177482 | D | Phosphatidylinositol signaling system |
| 23868 | 825 | NM_012551 | GENERAL, L | Phosphorylation of MEK1 by cdk5/p35 down regulates the MAP |
| | | | | kinase pathway |
| 23869 | 825 | NM_012551 | L | Phosphorylation of MEK1 by cdk5/p35 down regulates the MAP |
| | | | | kinase pathway |
| 23872 | 825 | NM_012551 | GENERAL | Phosphorylation of MEK1 by cdk5/p35 down regulates the MAP |
| | | | | kinase pathway |
| 18564 | 865 | NM_012899 | GENERAL | Porphyrin and chlorophyll metabolism |
| 14138 | 94 | AA859700 | GENERAL | Porphyrin and chlorophyll metabolism |
| 16521 | 379 | AI010470 | B, J, L | Porphyrin and chlorophyll metabolism |
| 16520 | 823 | NM_012532 | GENERAL, B, C, L | Porphyrin and chlorophyll metabolism |
| 1447 | 944 | NM_017281 | D | Proteasome |
| 3987 | 943 | NM_017280 | GENERAL | Proteasome |
| 3254 | 945 | NM_017282 | L | Proteasome |
| 25253 | 1173 | NM_057099 | H | Proteasome |
| 15535 | 946 | NM_017283 | L | Proteasome |
| 15538 | 946 | NM_017283 | L | Proteasome |
| 16708 | 864 | NM_012895 | GENERAL | Purine metabolism |
| 1246 | 847 | NM_012770 | GENERAL, J | Purine metabolism |
| 8888 | 916 | NM_017090 | B | Purine metabolism |
| 14184 | 1106 | NM_031776 | GENERAL | Purine metabolism |
| 14185 | 1106 | NM_031776 | GENERAL | Purine metabolism |
| 17332 | 177 | AA892829 | J | Purine metabolism, Selenoamino acid metabolism, Sulfur |
| | | | | metabolism |
| 20896 | 1148 | NM_053592 | A, F | Pyrimidine metabolism |
| 2059 | 565 | AI146005 | A, H | Pyrimidine metabolism |
| 12921 | 546 | AI112636 | GENERAL, B, L | Pyrimidine metabolism |
| 24234 | 1086 | NM_031614 | GENERAL, A, I | Pyrimidine metabolism |
| 24235 | 1086 | NM_031614 | GENERAL, H, I | Pyrimidine metabolism |
| 1409 | 1124 | NM_033349 | GENERAL, A, C, | Pyruvate metabolism |
| | | | E, F | |
| 18713 | 987 | NM_020075 | L | Regulation of eIF2 |
| 18716 | 987 | NM_020075 | F | Regulation of eIF2 |
| 1929 | 1045 | NM_030872 | A, C, D, E | Regulation of eIF4e and p70 S6 Kinase |
| 24649 | 903 | NM_016988 | C, K | Riboflavin metabolism |
| 17104 | 924 | NM_017160 | GENERAL, G | Skeletal muscle hypertrophy is regulated via AKT/mTOR pathway, |
| | | | | mTOR Signaling Pathway |
| 18354 | 1246 | X59859 | J | Small Leucine-rich Proteoglycan (SLRP) molecules |
| 18352 | 1260 | Z12298 | L | Small Leucine-rich Proteoglycan (SLRP) molecules |
| 15393 | 581 | AI170663 | J | SREBP and controls lipid synthesis |
| 16681 | 920 | NM_017136 | B, L | Sterol biosynthesis, Terpenoid biosynthesis |
| 15069 | 1111 | NM_031840 | H | Sterol biosynthesis, Terpenoid biosynthesis |
| 23961 | 929 | NM_017181 | GENERAL, E, G, I | Styrene degradation, Tyrosine metabolism |
| 14970 | 1059 | NM_031127 | GENERAL, B, H, | Sulfur metabolism |
| | | | I, K | |
| 4749 | 1110 | NM_031834 | L | Sulfur metabolism |
| 19824 | 995 | NM_021750 | G, K | Taurine and hypotaurine metabolism |
| 17541 | 858 | NM_012844 | GENERAL, A, B, | Tetrachloroethene degradation |
| | | | H, I | |
| 15242 | 964 | NM_019191 | D | TGF beta signaling pathway, tgf-beta |
| 20493 | 988 | NM_020076 | GENERAL | Tryptophan metabolism |
| 20494 | 988 | NM_020076 | E | Tryptophan metabolism |
| 794 | 1166 | NM_053902 | GENERAL, I | Tryptophan metabolism |
| 21950 | 412 | AI013861 | G | Valine, leucine and isoleucine degradation |
| 4449 | 827 | NM_012592 | B, G, K | Valine, leucine and isoleucine degradation |
| 4450 | 827 | NM_012592 | E | Valine, leucine and isoleucine degradation |
| 4451 | 827 | NM_012592 | GENERAL, F | Valine, leucine and isoleucine degradation |
| 17284 | 789 | J02827 | G | Valine, leucine and isoleucine degradation |

TABLE 3
HUMAN HOMOLOGUES

Atty. Docket No. GENE-077/26US
Doc. No. 44941

| GLGC | | GenBank Acc or | Human Homologous Gene | | |
|---|---|---|---|---|---|
| Identifier | Seq ID | RefSeq ID | Name | Human Homologous Cluster Title | Model Code |
| 15409 | 1182 | NM_057197 | 2,4-dienoyl CoA reductase 1, | 2,4-dienoyl CoA reductase 1, mitochondrial | L |
| | | | mitochondrial | | |
| 22602 | 341 | AF044574 | 2,4-dienoyl CoA reductase 2, | 2,4-dienoyl CoA reductase 1, mitochondrial, 2,4-dienoyl CoA reductase 2, peroxisomal, 2- | GENERAL |
| | | | peroxisomal, 2-4-dienoyl- | 4-dienoyl-Coenzyme A reductase 2, peroxisomal, Mus musculus, Similar to hypothetical | |
| | | | Coenzyme A reductase 2, | protein MGC4172, clone MGC: 18716 IMAGE: 4219994, mRNA, complete cds, carbonyl | |
| | | | peroxisomal | reductase 2, peroxisomal trans 2-enoyl CoA reductase; putative short chain alcohol | |
| | | | | dehydrogenase, peroxisomal trans-2-enoyl-CoA reductase | |
| 20493 | 988 | NM_020076 | 3-hydroxyanthranilate 3,4- | 3-hydroxyanthranilate 3,4-dioxygenase | GENERAL |
| | | | dioxygenase | | |
| 20494 | 988 | NM_020076 | 3-hydroxyanthranilate 3,4- | 3-hydroxyanthranilate 3,4-dioxygenase | E |
| | | | dioxygenase | | |
| 21585 | 1087 | NM_031620 | 3-phosphoglycerate | 3-phosphoglycerate dehydrogenase, EST, Moderately similar to SERA MOUSE D-3- | D |
| | | | dehydrogenase, | PHOSPHOGLYCERATE DEHYDROGENASE [M. musculus], ESTs, Weakly similar to 3- | |
| | | | phosphoglycerate | phosphoglycerate dehydrogenase [Rattus norvegicus] [R. norvegicus], Mus musculus | |
| | | | dehydrogenase | adult male testis cDNA, RIKEN full-length enriched library, clone: 4930404C15:3- | |
| | | | | phosphoglycerate dehydrogenase, full insert sequence, glyoxylate | |
| | | | | reductase/hydroxypyruvate reductase, phosphoglycerate dehydrogenase | |
| 21586 | 1087 | NM_031620 | 3-phosphoglycerate | 3-phosphoglycerate dehydrogenase, EST, Moderately similar to SERA MOUSE D-3- | D |
| | | | dehydrogenase, | PHOSPHOGLYCERATE DEHYDROGENASE [M. musculus], ESTs, Weakly similar to 3- | |
| | | | phosphoglycerate | phosphoglycerate dehydrogenase [Rattus norvegicus] [R. norvegicus], Mus musculus | |
| | | | dehydrogenase | adult male testis cDNA, RIKEN full-length enriched library, clone: 4930404C15:3- | |
| | | | | phosphoglycerate dehydrogenase, full insert sequence, glyoxylate | |
| | | | | reductase/hydroxypyruvate reductase, phosphoglycerate dehydrogenase | |
| 21587 | 1087 | NM_031620 | 3-phosphoglycerate | 3-phosphoglycerate dehydrogenase, EST, Moderately similar to SERA MOUSE D-3- | D |
| | | | dehydrogenase, | PHOSPHOGLYCERATE DEHYDROGENASE [M. musculus], ESTs, Weakly similar to 3- | |
| | | | phosphoglycerate | phosphoglycerate dehydrogenase [Rattus norvegicus] [R. norvegicus], Mus musculus | |
| | | | dehydrogenase | adult male testis cDNA, RIKEN full-length enriched library, clone: 4930404C15:3- | |
| | | | | phosphoglycerate dehydrogenase, full insert sequence, glyoxylate | |
| | | | | reductase/hydroxypyruvate reductase, phosphoglycerate dehydrogenase | |
| 1527 | 934 | NM_017220 | 6-pyruvoyl-tetrahydropterin | 6-pyruvoyl-tetrahydropterin synthase, 6-pyruvoyltetrahydropterin synthase, ESTs, Weakly | B |
| | | | synthase, 6- | similar to JC1405 6-pyruvoyltetrahydropterin synthase [H. sapiens], ESTs, Weakly similar | |
| | | | pyruvoyltetrahydropterin | to PTPS RAT 6-PYRUVOYL TETRAHYDROBIOPTERIN SYNTHASE PRECURSOR | |
| | | | synthase | [R. norvegicus] | |
| 19936 | 1071 | NM_031357 | 6-pyruvoyl-tetrahydropterin | ceroid-lipofuscinosis, neuronal 2, ceroid-lipofuscinosis, neuronal 2, late infantile (Jansky- | D |
| | | | synthase, 6- | Bielschowsky disease) | |
| | | | pyruvoyltetrahydropterin | | |
| | | | synthase, lysosomal | | |
| | | | membrane glycoprotein 1, | | |
| | | | lysosomal-associated | | |
| | | | membrane protein 1 | | |
| 21882 | 815 | M83740 | 6-pyruvoyl-tetrahydropterin | | GENERAL, D |
| | | | synthase/dimerization cofactor | | |
| | | | of hepatocyte nuclear factor 1 | | |
| | | | alpha (TCF1) | | |
| 22626 | 1040 | NM_024400 | a disintegrin-like and | ESTs, Highly similar to ATS8_MOUSE ADAM-TS 8 PRECURSOR (A DISINTEGRIN | GENERAL, K |
| | | | metalloprotease (reprolysin | AND METALLOPROTEINASE WITH THROMBOSPONDIN MOTIFS 8) (ADAMTS-8) | |
| | | | type) with thrombospondin | (ADAM-TS8) (METH-2) [M. musculus], ESTs, Weakly similar to ATS1_MOUSE ADAM-TS | |
| | | | type 1 motif, 1 | 1 PRECURSOR (A DISINTEGRIN AND METALLOPROTEINASE WITH | |
| | | | | THROMBOSPONDIN MOTIFS 1) (ADAMTS-1) (ADAM-TS1) [M. musculus], ESTs, | |
| | | | | Weakly similar to T47158 hypothetical protein DKFZp762C1110.1 [H. sapiens], Mus | |
| | | | | musculus, Similar to a disintegrin and metalloproteinase with thrombospondin motifs 1 | |
| | | | | (ADAMTS-1), clone IMAGE: 3491991, mRNA, partial cds, Mus musculus, Similar to a | |
| | | | | disintegrin-like and metalloprotease (reprolysin type) with thrombospondin type 1 motif, 4, | |
| | | | | clone MGC: 38401 IMAGE: 5345809, mRNA, complete cds, a disintegrin-like and | |
| | | | | metalloprotease (reprolysin type) with thrombospondin type 1 motif, 1 a disintegrin-like | |
| | | | | and metalloprotease (reprolysin type) with thrombospondin type 1 motif, 8 | |
| 2153 | 1227 | U75404 | A kinase (PRKA) anchor | A kinase (PRKA) anchor protein (gravin) 12, ESTs, Highly similar to gravin [H. sapiens] | GENERAL, L |
| | | | protein (gravin) 12 | | |
| 23698 | 821 | NM_012489 | acetyl-Coenzyme A | Mus musculus, Similar to Acetyl-Co A acetyltransferase 1, mitochondrial, clone | D |
| | | | acyltransferase (peroxisomal 3- | MGC: 39067 IMAGE: 5365469, mRNA, complete cds, acetyl-Coenzyme A acyltransferase | |
| | | | oxoacyl-Coenzyme A | (peroxisomal 3-oxoacyl-Coenzyme A thiolase), acetyl-Coenzyme A acyltransferase 1 | |
| | | | thiolase), acetyl-Coenzyme A | (peroxisomal 3-oxoacyl-Coenzyme A thiolase) | |
| | | | acyltransferase 1 (peroxisomal | | |
| | | | 3-oxoacyl-Coenzyme A | | |
| | | | thiolase) | | |
| 23699 | 821 | NM_012489 | acetyl-Coenzyme A | Mus musculus, Similar to Acetyl-Co A acetyltransferase 1, mitochondrial, clone | D, E |
| | | | acyltransferase (peroxisomal 3- | MGC: 39067 IMAGE: 5365469, mRNA, complete cds, acetyl-Coenzyme A acyltransferase | |
| | | | oxoacyl-Coenzyme A | (peroxisomal 3-oxoacyl-Coenzyme A thiolase), acetyl-Coenzyme A acyltransferase 1 | |
| | | | thiolase), acetyl-Coenzyme A | (peroxisomal 3-oxoacyl-Coenzyme A thiolase) | |
| | | | acyltransferase 1 (peroxisomal | | |
| | | | 3-oxoacyl-Coenzyme A | | |
| | | | thiolase) | | |
| 21078 | 902 | NM_016986 | acetyl-Coenzyme A | ESTs, Highly similar to ACYL-COA DEHYDROGENASE, MEDIUM-CHAIN SPECIFIC | G |
| | | | dehydrogenase, medium | PRECURSOR [M. musculus], acetyl-Coenzyme A dehydrogenase, medium chain, acyl- | |
| | | | chain, acyl-Coenzyme A | Coenzyme A dehydrogenase, C-4 to C-12 straight chain | |
| | | | dehydrogenase, C-4 to C-12 | | |
| | | | straight chain | | |
| 24649 | 903 | NM_016988 | acid phosphatase 2, lysosomal | ESTs, Weakly similar to A33395 acid phosphatase (EC 3.1.3.2) precursor - rat | C, K |
| | | | | [R. norvegicus], acid phosphatase 2, lysosomal, acid phosphatase, testicular | |
| 19991 | 1169 | NM_053961 | aconitase 2, mitochondrial | aconitase 2, mitochondrial | K |
| 21165 | 1047 | NM_031005 | actinin, alpha 1 | ESTs, Weakly similar to alpha actinin 4 [Mus musculus] [M. musculus], RIKEN cDNA | K |
| | | | | 3110023F10 gene, actinin alpha 2, actinin alpha 3, actinin, alpha 1, actinin, alpha 2, | |
| | | | | actinin, alpha 3, alpha actinin 4 | |
| 21166 | 1047 | NM_031005 | actinin, alpha 1 | ESTs, Weakly similar to alpha actinin 4 [Mus musculus] [M. musculus], RIKEN cDNA | K |
| | | | | 3110023F10 gene, actinin alpha 2, actinin alpha 3, actinin, alpha 1, actinin, alpha 2, | |
| | | | | actinin, alpha 3, alpha actinin 4 | |
| 24431 | 868 | NM_012912 | activating transcription factor 3 | ESTs, Weakly similar to A39382 liver regeneration factor LRF1 - rat [R. norvegicus], | GENERAL, F |
| | | | | ESTs, Weakly similar to A54025 transcription factor ATF3 [H. sapiens], activating | |
| | | | | transcription factor 3 | |
| 13104 | 374 | AI010224 | adducin 3 (gamma) | | D |
| 16708 | 864 | NM_012895 | adenosine kinase | adenosine kinase, expressed sequence AI987814 | GENERAL |
| 22219 | 972 | NM_019286 | alcohol dehydrogenase 1, | ESTs, Weakly similar to ADHA MOUSE ALCOHOL DEHYDROGENASE A CHAIN | F |
| | | | complex, alcohol | [M. musculus], alcohol dehydrogenase 1, complex, alcohol dehydrogenase 1A (class I), | |
| | | | dehydrogenase 1A (class I), | alpha polypeptide, alcohol dehydrogenase IB (class I), beta polypeptide | |
| | | | alpha polypeptide | | |
| 23884 | 1099 | NM_031731 | aldehyde dehydrogenase 3 | RIKEN cDNA 1700001N19 gene, RIKEN cDNA 1700055N04 gene, aldehyde | J |
| | | | family, member A2, aldehyde | dehydrogenase 3 family, member A2, aldehyde dehydrogenase family 3, subfamily A2, | |
| | | | dehydrogenase family 3, | expressed sequence AI848594 | |
| | | | subfamily A2 | | |
| 16884 | 517 | AI103758 | aldehyde dehydrogenase 9 | Mus musculus, Similar to aldehyde dehydrogenase 4 family, member A1, clone | E |
| | | | family, member A1, aldehyde | IMAGE: 5102023, mRNA, partial cds, RIKEN cDNA 1110038I05 gene, aldehyde | |
| | | | dehydrogenase 9, subfamily | dehydrogenase 4 family, member A1, aldehyde dehydrogenase 9 family, member A1, | |
| | | | A1 | aldehyde dehydrogenase 9, Subfamily A1 | |
| 16885 | 531 | AI105188 | aldehyde dehydrogenase 9 | Mus musculus, Similar to aldehyde dehydrogenase 4 family, member A1, clone | K |
| | | | family, member A1, aldehyde | IMAGE: 5102023, mRNA, partial cds, RIKEN cDNA 1110038I05 gene, aldehyde | |
| | | | dehydrogenase 9, subfamily | dehydrogenase 4 family, member A1, aldehyde dehydrogenase 9 family, member A1, | |
| | | | A1 | aldehyde dehydrogenase 9, subfamily A1 | |
| 16625 | 324 | AA998062 | Alg5, S. cerevisiae, homolog | Alg5, S. cerevisiae, homolog of | D |
| | | | of | | |
| 15032 | 852 | NM_012816 | alpha-methylacyl-CoA | alpha-methylacyl-CoA racemase, cDNA sequence AF397014, chromosome 7 open | GENERAL, A, H, I, K, L |
| | | | racemase | reading frame 10 | |
| 18564 | 865 | NM_012899 | aminolevulinate, delta-, | aminolevulinate, delta-, dehydratase | GENERAL |
| | | | dehydratase | | |
| 21038 | 1042 | NM_024484 | aminolevulinate, delta-, | aminolevulinate, delta-, synthase 1, aminolevulinic acid synthase 1, aminolevulinic acid | H |
| | | | synthase 1, aminolevulinic | synthase 2, erythroid, serine palmitoyltransferase, long chain base subunit 1, serine | |
| | | | acid synthase 1 | palmitoyltransferase long chain base subunit 2 | |
| 21039 | 1042 | NM_024484 | aminolevulinate, delta-, | aminolevulinate, delta-, synthase 1, aminolevulinic acid synthase 1, aminolevulinic acid | H |
| | | | synthase 1, aminolevulinic | synthase 2, erythroid, serine palmitoyltransferase, long chain base subunit 1, serine | |
| | | | acid synthase 1 | palmitoyltransferase, long chain base subunit 2 | |
| 2079 | 966 | NM_019220 | amino-terminal enhancer of | amino-terminal enhancer of split | F |
| | | | split | | |
| 7196 | 867 | NM_012904 | annexin A1 | annexin A1 | GENERAL, E, G, K |
| 7197 | 867 | NM_012904 | annexin A1 | annexin A1 | GENERAL, G, K, L |
| 574 | 985 | NM_019905 | annexin A2, hydroxyacid | EST, Moderately similar to 0806162C protein COI [M. musculus], EST, Moderately similar | GENERAL, E, G, K |
| | | | oxidase (glycolate oxidase) 3, | to 810024C cytochrome oxidase I [H. sapiens], EST, Weakly similar to 0806162C protein | |
| | | | hydroxyacid oxidase 3 | COI [M. musculus], ESTs, Highly similar to hydroxyacid oxidase 3 (medium-chain) | |
| | | | (medium-chain) | [Rattus norvegicus] [R. norvegicus], ESTs, Moderately similar to 0806162C protein COI | |
| | | | | [M. musculus], ESTs, Moderately similar to 810024C cytochrome oxidase I [H. sapiens], | |
| | | | | ESTs, Weakly similar to 0806162C protein COI [M. musculus], annexin A2, annexin A9, | |
| | | | | hydroxyacid oxidase (glycolate oxidase) 3, hydroxyacid oxidase 1, liver | |
| 21391 | 1192 | NM_130416 | annexin A7 | annexin A11, annexin A13, annexin A7 | GENERAL, K |
| 19252 | 1145 | NM_053576 | anti-oxidant protein 2 (non- | ESTs, Moderately similar to AOP2 MOUSE ANTIOXIDANT PROTEIN 2 [M. musculus], | H |
| | | | selenium glutathione | ESTs, Moderately similar to AOP2_HUMAN ANTIOXIDANT PROTEIN 2 [H. sapiens], anti- | |
| | | | peroxidase, acidic calcium- | oxidant protein 2 (non-selenium glutathione peroxidase, acidic calcium-independent | |
| | | | independent phospholipase | phospholipase A2), peroxiredoxin 5 | |
| | | | A2), peroxiredoxin 5 | | |
| 19254 | 1145 | NM_053576 | anti-oxidant protein 2 (non- | ESTs, Moderately similar to AOP2 MOUSE ANTIOXIDANT PROTEIN 2 [M. musculus], | H |
| | | | selenium glutathione | ESTs, Moderately similar to AOP2_HUMAN ANTIOXIDANT PROTEIN 2 [H. sapiens], anti- | |
| | | | peroxidase, acidic calcium- | oxidant protein 2 (non-selenium glutathione peroxidase, acidic calcium-independent | |
| | | | independent phospholipase | phospholipase A2), peroxiredoxin 5 | |
| | | | A2), peroxiredoxin 5 | | |
| 20801 | 1033 | NM_024148 | APEX nuclease | APEX nuclease (multifunctional DNA repair enzyme), Mus musculus ape2 mRNA for AP | GENERAL, H, I, J, L |
| | | | (multifunctional DNA repair | endonuclease 2, complete cds, apurinic/apyrimidinic endonuclease | |
| | | | enzyme), apurinic/apyrimidinic | | |
| | | | endonuclease | | |
| 1509 | 962 | NM_019157 | aquaporin 7 | EST, Moderately similar to AQP7_HUMAN AQUAPORIN 7 [H. sapiens], ESTs, Highly | A |
| | | | | similar to AQP7_HUMAN AQUAPORIN 7 [H. sapiens], aquaporin 7 | A |
| 20173 | 959 | NM_019136 | arginine vasopressin receptor | arginine vasopressin receptor 2, arginine vasopressin receptor 2 (nephrogenic diabetes | C |
| | | | 2, arginine vasopressin | insipidus) | |
| | | | receptor 2 (nephrogenic | | |
| | | | diabetes insipidus) | | |
| 20725 | 1149 | NM_053602 | ATP synthase, H+ | ATP synthase, H+ transporting, mitochondrial F0 complex subunit F, ATP synthase, H+ | A |
| | | | transporting, mitochondrial F0 | transporting, mitochondrial F0 complex, subunit F6 | |
| | | | complex subunit F, ATP | | |
| | | | synthase, H+ transporting, | | |
| | | | mitochondrial F0 complex, | | |
| | | | subunit F6 | | |
| 12349 | 947 | NM_017290 | ATPase, Ca++ transporting, | | GENERAL |
| | | | cardiac muscle, slow twitch 2 | | |
| 15701 | 1187 | NM_080581 | ATP-binding cassette, sub- | ATP-binding cassette, sub-family C (CFTR/MRP), member 1, ATP-binding cassette, sub- | A, I |
| | | | family C (CFTR/MRP), | family C (CFTR/MRP), member 1a, ATP-binding cassette, sub-family C (CFTR/MRP), | |
| | | | member 3 | member 3, Mus musculus multidrug resistance-associated protein 7B mRNA, complete | |
| | | | | cds | |
| 989 | 976 | NM_019318 | avian musculoaponeurotic | EST, Moderately similar to MAF2 MOUSE TRANSCRIPTION FACTOR MAF2 | D, F |
| | | | fibrosarcoma (v-maf) AS42 | [M. musculus], ESTs, Highly similar to MAF2 MOUSE TRANSCRIPTION FACTOR MAF2 | |
| | | | oncogene homolog, solute | [M. musculus], ESTs, Weakly similar to MAF2 MOUSE TRANSCRIPTION FACTOR | |
| | | | carrier family 24 | MAF2 [M. musculus], v-maf musculoaponeurotic fibrosarcoma oncogene homolog (avian) | |
| | | | (sodium/potassium/calcium | | |
| | | | exchanger), member 2, v-maf | | |
| | | | musculoaponeurotic | | |
| | | | fibrosarcoma oncogene | | |
| | | | homolog (avian) | | |
| 5565 | 1153 | NM_053618 | Bardet-Biedl syndrome 2, | Bardet-Biedl syndrome 2, ESTs, Weakly similar to Bardet-Biedl syndrome 2 (human) | GENERAL, C |
| | | | Bardet-Biedl syndrome 2 | [Rattus norvegicus] [R. norvegicus] | |
| | | | (human) | | |
| 19 | 941 | NM_017258 | B-cell translocation gene 1, | B-cell translocation gene 1, anti-proliferative, Homo sapiens cDNA FLJ30547 fis, clone | GENERAL |
| | | | anti-proliferative | BRAWH2001439, transducer of ERBB2, 1, transducer of ERBB2, 2, transducer of ErbB- | |
| | | | | 2.1 | |
| 15299 | 942 | NM_017259 | B-cell translocation gene 2, | B-cell translocation gene 2, anti-proliferative, B-cell translocation gene 4, BTG family, | GENERAL, I, J |
| | | | anti-proliferative, BTG family, | member 2, ESTs, Highly similar to BTG2_HUMAN BTG2 PROTEIN PRECURSOR | |
| | | | member 2 | [H. sapiens] | |
| 15300 | 942 | NM_017259 | B-cell translocation gene 2, | B-cell translocation gene 2, anti-proliferative, B-cell translocation gene 4, BTG family, | GENERAL |
| | | | anti-proliferative, BTG family, | member 2, ESTs, Highly similar to BTG2_HUMAN BTG2 PROTEIN PRECURSOR | |
| | | | member 2 | [H. sapiens] | |
| 439 | 854 | NM_012827 | bone morphogenetic protein 4 | bone morphogenetic protein 4, endometrial bleeding associated factor, growth | F |
| | | | | differentiation factor 2, growth differentiation factor 5 | |
| 24643 | 1006 | NM_022400 | branched chain | Homo sapiens cDNA FLJ13847 fis, clone THYRO1000852, highly similar to Human | K |
| | | | aminotransferase 2, | branched-chain amino acid aminotransferase (ECA40) mRNA, branched chain | |
| | | | mitochondrial | aminotransferase 2, mitochondrial | |
| 17284 | 789 | J02827 | branched chain keto acid | | G |
| | | | dehydrogenase E1, alpha | | |
| | | | polypeptide (maple syrup urine | | |
| | | | disease), branched chain | | |
| | | | ketoacid dehydrogenase E1, | | |
| | | | alpha polypeptide | | |
| 433 | 869 | NM_012916 | brevican, chondroitin sulfate | | C |
| | | | proteoglycan BEHAB/brevican | | |
| 18502 | 1118 | NM_031984 | calbindin 1, (28 kD), calbindin- | Mus musculus, Similar to secretagogin, clone MGC: 27615 IMAGE: 4504330, mRNA, | G, J |
| | | | 28K | complete cds, calbindin 1, (28 kD), calbindin-28K | |
| 18503 | 1118 | NM_031984 | calbindin 1, (28 kD), calbindin- | Mus musculus, Similar to secretagogin, clone MGC: 27615 IMAGE: 4504330, mRNA, | G |
| | | | 28K | complete cds, calbindin 1, (28 kD), calbindin-28K | |
| 25802 | 1113 | NM_031969 | calmodulin 1, calmodulin 1 | RIKEN cDNA 2310068O22 gene, calmodulin 1, calmodulin 1 (phosphorylase kinase, | G, K |
| | | | (phosphorylase kinase, delta) | delta), calmodulin 2, calmodulin 2 (phosphorylase kinase, delta), calmodulin 3, calmodulin | |
| | | | | like 3, centrin 1, centrin, EF-hand protein, 1, expressed sequence AI327027, expressed | |
| | | | | sequence AL024000, troponin C, fast skeletal | |
| 20809 | 951 | NM_017326 | calmodulin 2, calmodulin 2 | RIKEN cDNA 2310068O22 gene, calmodulin 1, calmodulin 1 (phosphorylase kinase, | D |
| | | | (phosphorylase kinase, delta) | delta), calmodulin 2, calmodulin 2 (phosphorylase kinase, delta), calmodulin 3, calmodulin | |
| | | | | like 3, centrin 1, centrin, EF-hand protein, 1, expressed sequence AI327027, expressed | |
| | | | | sequence AL024000, troponin C, fast skeletal | |
| 15035 | 855 | NM_012836 | carboxypeptidase D | carboxypeptidase D, carboxypeptidase M | B |
| 20555 | 1120 | NM_031987 | carnitine O- | carnitine O-octanoyltransferase | F |
| | | | octanoyltransferase | | |
| 15411 | 1078 | NM_031559 | carnitine palmitoyltransferase | ESTs, Weakly similar to CPT1 MOUSE CARNITINE O-PALMITOYLTRANSFERASE I, | B, L |
| | | | 1, liver, carnitine | MITOCHONDRIAL LIVER ISOFORM [M. musculus], carnitine palmitoyltransferase 1, | |
| | | | palmitoyltransferase I, liver | liver, carnitine palmitoyltransferase I, liver | |
| 1977 | 870 | NM_012930 | carnitine palmitoyltransferase | carnitine palmitoyltransferase 2, carnitine palmitoyltransferase II | L |
| | | | 2, carnitine | | |
| | | | palmitoyltransferase II | | |
| 16116 | 1105 | NM_031775 | caspase 6, caspase 6, | caspase 6, caspase 6, apoptosis-related cysteine protease | F |
| | | | apoptosis-related cysteine | | |
| | | | protease | | |
| 3430 | 897 | NM_013156 | cathepsin L | ESTs, Weakly similar to CATL MOUSE CATHEPSIN L PRECURSOR [M. musculus], | GENERAL, G, I |
| | | | | RIKEN cDNA 4930486L24 gene, cathepsin L, expressed sequence AA408230 | |
| 21239 | 1029 | NM_024125 | CCAAT/enhancer binding | CCAAT/enhancer binding protein (C/EBP), beta | GENERAL, H, I |
| | | | protein (C/EBP), beta | | |
| 21683 | 896 | NM_013154 | CCAAT/enhancer binding | CCAAT/enhancer binding protein (C/EBP), delta | GENERAL, C, I, L |
| | | | protein (C/EBP), delta | | |
| 20828 | 846 | NM_012752 | CD24 antigen (small cell lung | | GENERAL, E, K |
| | | | carcinoma cluster 4 antigen), | | |
| | | | CD24a antigen | | |
| 20829 | 846 | NM_012752 | CD24 antigen (small cell lung | | GENERAL, D |
| | | | carcinoma cluster 4 antigen), | | |
| | | | CD24a antigen | | |
| 20830 | 846 | NM_012752 | CD24 antigen (small cell lung | | GENERAL |
| | | | carcinoma cluster 4 antigen), | | |
| | | | CD24a antigen | | |
| 16521 | 379 | AI010470 | ceruloplasmin, ceruloplasmin | DNA segment, Chr 3, ERATO Doi 555, expressed, EST, Highly similar to FA8_HUMAN | B, J, L |
| | | | (ferroxidase) | COAGULATION FACTOR VIII PRECURSOR [H. sapiens], ESTs, Weakly similar to | |
| | | | | CERU MOUSE CERULOPLASMIN PRECURSOR [M. musculus], ESTs, Weakly similar to | |
| | | | | CERU_RAT CERULOPLASMIN PRECURSOR (FERROXIDASE) [R. norvegicus], ESTs, | |
| | | | | Weakly similar to KUHU ferroxidase [H. sapiens], ceruloplasmin, ceruloplasmin | |
| | | | | (ferroxidase), coagulation factor VIII, procoagulant component (hemophilia A) | |
| 16520 | 823 | NM_012532 | ceruloplasmin, ceruloplasmin | DNA segment, Chr 3, ERATO Doi 555, expressed, EST, Highly similar to FA8_HUMAN | GENERAL, B, C, L |
| | | | (ferroxidase) | COAGULATION FACTOR VIII PRECURSOR [H. sapiens], ESTs, Weakly similar to | |
| | | | | CERU MOUSE CERULOPLASMIN PRECURSOR [M. musculus], ESTs, Weakly similar to | |
| | | | | CERU_RAT CERULOPLASMIN PRECURSOR (FERROXIDASE) [R. norvegicus], ESTs, | |
| | | | | Weakly similar to KUHU ferroxidase [H. sapiens], ceruloplasmin, ceruloplasmin | |
| | | | | (ferroxidase), coagulation factor VIII, procoagulant component (hemophilia A) | |
| 3512 | 927 | NM_017177 | choline kinase-like | EST, Weakly similar to KICE MOUSE CHOLINE/ETHANOLAMINE KINASE | F |
| | | | | [M. musculus], ESTs, Weakly similar to KICE_RAT Choline/ethanolamine kinase | |
| | | | | [Includes: Choline kinase (CK); Ethanolamine kinase (EK)] [R. norvegicus], Homo | |
| | | | | sapiens, Similar to hypothetical protein FLJ10761, clone MGC: 19512 IMAGE: 4329734, | |
| | | | | mRNA, complete cds, RIKEN cDNA 4930555L11 gene, choline kinase-like, ethanolamine | |
| | | | | kinase, expressed sequence AI197444 | |
| 20404 | 1094 | NM_031700 | claudin 3 | claudin 3 | L |
| 20405 | 1094 | NM_031700 | claudin 3 | claudin 3 | B |
| 16350 | 777 | AJ011811 | claudin 7 | ESTs, Weakly similar to CLD7_RAT CLAUDIN-7 [R. norvegicus], Mus musculus claudin | G |
| | | | | 19 mRNA, complete cds, claudin 10, claudin 15, claudin 7 | |
| 16351 | 777 | AJ011811 | claudin 7 | ESTs, Weakly similar to CLD7_RAT CLAUDIN-7 [R. norvegicus], Mus musculus claudin | G |
| | | | | 19 mRNA, complete cds, claudin 10, claudin 15, claudin 7 | |
| 15364 | 921 | NM_017147 | cofilin 1 (non-muscle), cofilin | cofilin 1 (non-muscle), cofilin 1, non-muscle, cofilin 2 (muscle), cofilin 2, muscle, | J |
| | | | 1, non-muscle | expressed sequence AW987265 | |
| 16610 | 781 | D28557 | cold shock domain protein A | Mus musculus 10 days embryo whole body cDNA, RIKEN full-length enriched library, | E, L |
| | | | | clone: 2610205I19:Y box protein 1, full insert sequence, Mus musculus Y-box binding | |
| | | | | protein (oxyR) mRNA, partial cds, cold shock domain protein A | |
| 21443 | 968 | NM_019262 | complement component 1, q | | GENERAL, L |
| | | | subcomponent, beta | | |
| | | | polypeptide | | |
| 15851 | 1219 | U42719 | complement component 4 | complement component 4 (within H-2S), complement component 4A | GENERAL |
| | | | (within H-2S), complement | | |
| | | | component 4B | | |
| 954 | 1121 | NM_032061 | contactin associated protein 1 | EST, Weakly similar to T14158 neurexin IV - mouse [M. musculus], EST, Weakly similar | B |
| | | | | to T31083 paranodin - rat [R. norvegicus], ESTs, Weakly similar to T14158 neurexin IV - | |
| | | | | mouse [M. musculus], ESTs, Weakly similar to T31083 paranodin - rat [R. norvegicus], | |
| | | | | contactin associated protein 1 | |
| 1727 | 1088 | NM_031642 | core promoter element binding | DNA segment, Chr 12, ERATO Doi 427, expressed, EST, Moderately similar to core | GENERAL |
| | | | protein | promoter element binding protein [Rattus norvegicus] [R. norvegicus], ESTs, Weakly | |
| | | | | similar to core promoter element binding protein [Rattus norvegicus] [R. norvegicus], | |
| | | | | Kruppel-like factor 7 (ubiquitous), core promoter element binding protein | |
| 13723 | 871 | NM_012935 | crystallin, alpha B | ESTs, Moderately similar to T46637 transcription factor 1, neural - rat [R. norvegicus], | K |
| | | | | ESTs, Weakly similar to A35804 nucleolin [H. sapiens], ESTs, Weakly similar to alpha- | |
| | | | | crystallin chain B [M. musculus], Homo sapiens mRNA; cDNA DKFZp434E0922 (from | |
| | | | | clone DKFZp434E0922), Mus musculus 10, 11 days embryo whole body cDNA, RIKEN | |
| | | | | full-length enriched library, clone: 2810003I18:myelin transcription factor 1-like, full insert | |
| | | | | sequence, crystallin, alpha B, myelin transcription factor 1-like, nucleolin | |
| 3572 | 325 | AA998516 | cyclin A2 | Cyclin B1, DNA segment, Chr 4, ERATO Doi 639, expressed, EST, Moderately similar to | E |
| | | | | G2/MITOTIC-SPECIFIC CYCLIN B2 [M. musculus], ESTs, Weakly similar to CGB1_RAT | |
| | | | | G2/mitotic-specific cyclin B1 [R. norvegicus], cyclin A2, cyclin B1, related sequence 1 | |
| 11434 | 778 | D14014 | cyclin D1, cyclin D1 (PRAD1: | EST, Moderately similar to JC2342 cyclin D1 - rat [R. norvegicus], cyclin D1, cyclin D1 | B |
| | | | parathyroid adenomatosis 1) | (PRAD1: parathyroid adenomatosis 1) | |
| 24232 | 1252 | X75207 | cyclin D1, cyclin D1 (PRAD1: | EST, Moderately similar to JC2342 cyclin D1 - rat [R. norvegicus], cyclin D1, cyclin D1 | B |
| | | | parathyroid adenomatosis 1) | (PRAD1: parathyroid adenomatosis 1) | |
| 291 | 822 | NM_012522 | cystathionine beta-synthase, | cystathionine-beta-synthase, expressed sequence AU040765, serine dehydratase, serine | GENERAL, F |
| | | | cystathionine-beta-synthase | racemase | |
| 15028 | 1129 | NM_052809 | cysteine dioxygenase 1, | cysteine dioxygenase 1, cytosolic, cysteine dioxygenase, type I | F |
| | | | cytosolic, cysteine | | |
| | | | dioxygenase, type I | | |
| 11137 | 856 | NM_012839 | cytochrome c, cytochrome c, | | J |
| | | | somatic | | |
| 4011 | 1076 | NM_031543 | cytochrome P450, 2e1, | | J |
| | | | ethanol inducible, cytochrome | | |
| | | | P450, subfamily IIE (ethanol- | | |
| | | | inducible) | | |
| 4012 | 1076 | NM_031543 | cytochrome P450, 2e1, | | J |
| | | | ethanol inducible, cytochrome | | |
| | | | P450, subfamily IIE (ethanol- | | |
| | | | inducible) | | |
| 20711 | 905 | NM_016999 | cytochrome P450, subfamily | EST, Moderately similar to I65981 fatty acid omega-hydroxylase [H. sapiens], Mus | L |
| | | | IV B, polypeptide 1, | musculus, Similar to cytochrome P450, 4a10, clone MGC: 18880 IMAGE: 4237837, | |
| | | | cytochrome P450, subfamily | mRNA, complete cds, Mus musculus, Similar to cytochrome P450, 4a10, clone | |
| | | | IVB, polypeptide 1 | MGC: 25972 IMAGE: 4240359, mRNA, complete cds, RIKEN cDNA A230105L22 gene, | |
| | | | | cytochrome P450, 4a10, cytochrome P450, subfamily IVA, polypeptide 11, expressed | |
| | | | | sequence AI314743 | |
| 20713 | 905 | NM_016999 | cytochrome P450, subfamily | EST, Moderately similar to I65981 fatty acid omega-hydroxylase [H. sapiens], Mus | J, L |
| | | | IV B, polypeptide 1, | musculus, Similar to cytochrome P450, 4a10, clone MGC: 18880 IMAGE: 4237837, | |
| | | | cytochrome P450, subfamily | mRNA, complete cds, Mus musculus, Similar to cytochrome P450, 4a10, clone | |
| | | | IVB, polypeptide 1 | MGC: 25972 IMAGE: 4240359, mRNA, complete cds, RIKEN cDNA A230105L22 gene, | |
| | | | | cytochrome P450, 4a10, cytochrome P450, subfamily IVA, polypeptide 11, expressed | |
| | | | | sequence AI314743 | |
| 20714 | 905 | NM_016999 | cytochrome P450, subfamily | EST, Moderately similar to I65981 fatty acid omega-hydroxylase [H. sapiens], Mus | J, L |
| | | | IV B, polypeptide 1, | musculus, Similar to cytochrome P450, 4a10, clone MGC: 18880 IMAGE: 4237837, | |
| | | | cytochrome P450, subfamily | mRNA, complete cds, Mus musculus, Similar to cytochrome P450, 4a10, clone | |
| | | | IVB, polypeptide 1 | MGC: 25972 IMAGE: 4240359, mRNA, complete cds, RIKEN cDNA A230105L22 gene, | |
| | | | | cytochrome P450, 4a10, cytochrome P450, subfamily IVA, polypeptide 11, expressed | |
| | | | | sequence AI314743 | |
| 20715 | 905 | NM_016999 | cytochrome P450, subfamily | EST, Moderately similar to I65981 fatty acid omega-hydroxylase [H. sapiens], Mus | L |
| | | | IV B, polypeptide 1, | musculus, Similar to cytochrome P450, 4a10, clone MGC: 18880 IMAGE: 4237837, | |
| | | | cytochrome P450, subfamily | mRNA, complete cds, Mus musculus, Similar to cytochrome P450, 4a10, clone | |
| | | | IVB, polypeptide 1 | MGC: 25972 IMAGE: 4240359, mRNA, complete cds, RIKEN cDNA A230105L22 gene, | |
| | | | | cytochrome P450, 4a10, cytochrome P450, subfamily IVA, polypeptide 11, expressed | |
| | | | | sequence AI314743 | |
| 1858 | 1064 | NM_031315 | cytosolic acyl-CoA | EST, Moderately similar to PTE2_HUMAN PEROXISOMAL ACYL-COENZYME A | B, L |
| | | | thioesterase 1, mitochondrial | THIOESTER HYDROLASE 2 (PEROXISOMAL LONG-CHAIN ACYL-COA | |
| | | | acyl-CoA thioesterase 1, | THIOESTERASE 2) (ZAP128) [H. sapiens], ESTs, Weakly similar to MTE1_RAT Acyl | |
| | | | peroxisomal long-chain acyl- | coenzyme A thioester hydrolase, mitochondrial precursor (Very-long-chain acyl-CoA | |
| | | | coA thioesterase | thioesterase) (MTE-I) [R. norvegicus], ESTs, Weakly similar to PTE2_HUMAN | |
| | | | | PEROXISOMAL ACYL-COENZYME A THIOESTER HYDROLASE 2 (PEROXISOMAL | |
| | | | | LONG-CHAIN ACYL-COA THIOESTERASE 2) (ZAP128) [H. sapiens], Homo sapiens | |
| | | | | cDNA FLJ31235 fis, clone KIDNE2004681, moderately similar to Mus musculus | |
| | | | | peroxisomal long chain acyl-CoAthioesterase lb (Pte1b) gene, Mus musculus, Similar to | |
| | | | | bile acid Coenzyme A: amino acid N-acyltransferase (glycine N-choloyltransferase), clone | |
| | | | | MGC: 19156 IMAGE: 4220620, mRNA, complete cds, cytosolic acyl-CoA thioesterase 1, | |
| | | | | mitochondrial acyl-CoA thioesterase 1, peroxisomal long-chain acyl-coA thioesterase | |
| 1857 | 1064 | NM_031315 | cytosolic acyl-CoA | EST, Moderately similar to PTE2_HUMAN PEROXISOMAL ACYL-COENZYME A | L |
| | | | thioesterase 1, peroxisomal | THIOESTER HYDROLASE 2 (PEROXISOMAL LONG-CHAIN ACYL-COA | |
| | | | long-chain acyl-coA | THIOESTERASE 2) (ZAP128) [H. sapiens], ESTs, Weakly similar to PTE2_HUMAN | |
| | | | thioesterase | PEROXISOMAL ACYL-COENZYME A THIOESTER HYDROLASE 2 (PEROXISOMAL | |
| | | | | LONG-CHAIN ACYL-COA THIOESTERASE 2) (ZAP128) [H. sapiens], Homo sapiens | |
| | | | | cDNA FLJ31235 fis, clone KIDNE2004681, moderately similar to Mus musculus | |
| | | | | peroxisomal long chain acyl-CoA thioesterase lb (Pte1b) gene, cytosolic acyl-CoA | |
| | | | | thioesterase 1, peroxisomal long-chain acyl-coA thioesterase | |
| 17226 | 1031 | NM_024131 | D-dopachrome tautomerase | D-dopachrome tautomerase, EST, Moderately similar to DOPD_HUMAN D- | C, E |
| | | | | DOPACHROME TAUTOMERASE [H. sapiens] | |
| 17227 | 1031 | NM_024131 | D-dopachrome tautomerase | D-dopachrome tautomerase, EST, Moderately similar to DOPD_HUMAN D- | E |
| | | | | DOPACHROME TAUTOMERASE [H. sapiens] | |
| 18354 | 1246 | X59859 | decorin | RIKEN cDNA 5530600M07 gene, decorin, expressed sequence C85409, extracellular | J |
| | | | | matrix protein 2, female organ and adipocyte specific | |
| 18352 | 1260 | Z12298 | decorin | RIKEN cDNA 5530600M07 gene, decorin, expressed sequence C85409, extracellular | L |
| | | | | matrix protein 2, female organ and adipocyte specific | |
| 19678 | 992 | NM_021653 | deiodinase, iodothyronine, | ESTs, Moderately similar to IOD1_RAT TYPE I IODOTHYRONINE DEIODINASE (TYPE- | GENERAL |
| | | | type I | I 5′DEIODINASE) (DIOI) (TYPE 1 DI) (5DI) [R. norvegicus], deiodinase, iodothyronine, | |
| | | | | type I | |
| 19679 | 992 | NM_021653 | deiodinase, odothyronine, | ESTs, Moderately similar to IOD1_RAT TYPE I IODOTHYRONINE DEIODINASE (TYPE- | GENERAL, A, D, G, I |
| | | | type I | I 5′DEIODINASE) (DIOI) (TYPE 1 DI) (5DI) [R. norvegicus], deiodinase, iodothyronine, | |
| | | | | type I | |
| 755 | 890 | NM_013126 | diacylglycerol kinase, gamma | ESTs, Highly similar to KDGA MOUSE DIACYLGLYCEROL KINASE, ALPHA | GENERAL |
| | | | (90 kD), diacylglycerol kinase, | [M. musculus], ESTs, Moderately similar to KDGG_HUMAN DIACYLGLYCEROL | |
| | | | gamma 3 | KINASE, GAMMA [H. sapiens], ESTs, Weakly similar to KDGA MOUSE | |
| | | | | DIACYLGLYCEROL KINASE, ALPHA [M. musculus], diacylglycerol kinase, alpha (80 kDA), | |
| | | | | diacylglycerol kinase, gamma (90 kD), diacylglycerol kinase, gamma 3 | |
| 811 | 1095 | NM_031705 | dihydropyrimidinase | ESTs, Weakly similar to DPY1 MOUSE DIHYDROPYRIMIDINASE RELATED PROTEIN- | GENERAL, I |
| | | | | 1 [M. musculus], dihydropyrimidinase | |
| 812 | 1095 | NM_031705 | dihydropyrimidinase | ESTs, Weakly similar to DPY1 MOUSE DIHYDROPYRIMIDINASE RELATED PROTEIN- | GENERAL, I |
| | | | | 1 [M. musculus], dihydropyrimidinase | |
| 7784 | 848 | NM_012789 | dipeptidylpeptidase 4, | ESTs, Weakly similar to DPP4 MOUSE DIPEPTIDYL PEPTIDASE IV [M. musculus], | GENERAL, I |
| | | | dipeptidylpeptidase IV (CD26, | ESTs, Weakly similar to DPP4_RAT Dipeptidyl peptidase IV (DPP IV) (GP110 | |
| | | | adenosine deaminase | glycoprotein) (Bile canaliculus domain-specific membrane glycoprotein) [R. norvegicus], | |
| | | | complexing protein 2) | dipeptidylpeptidase 4, dipeptidylpeptidase 8, fibroblast activation protein, fibroblast | |
| | | | | activation protein, alpha | |
| 1430 | 816 | M84648 | dopa decarboxylase, dopa | EST, Highly similar to DDC_RAT Aromatic-L-amino-acid decarboxylase (AADC) (DOPA | GENERAL |
| | | | decarboxylase (aromatic L- | decarboxylase) (DDC) [R. norvegicus], EST, Moderately similar to DDC_RAT Aromatic-L- | |
| | | | amino acid decarboxylase) | amino-acid decarboxylase (AADC) (DOPA decarboxylase) (DDC) [R. norvegicus], Mus | |
| | | | | musculus 10 days embryo whole body cDNA, RIKEN full-length enriched library, | |
| | | | | clone: 2610109O21:dopa decarboxylase, full insert sequence, dopa decarboxylase, dopa | |
| | | | | decarboxylase (aromatic L-amino acid decarboxylase) | |
| 1431 | 824 | NM_012545 | dopa decarboxylase, dopa | EST, Highly similar to DDC_RAT Aromatic-L-amino-acid decarboxylase (AADC) (DOPA | D |
| | | | decarboxylase (aromatic L- | decarboxylase) (DDC) [R. norvegicus], EST, Moderately similar to DDC_RAT Aromatic-L- | |
| | | | amino acid decarboxylase) | amino-acid decarboxylase (AADC) (DOPA decarboxylase) (DDC) [R. norvegicus], Mus | |
| | | | | musculus 10 days embryo whole body cDNA, RIKEN full-length enriched library, | |
| | | | | clone: 2610109O21:dopa decarboxylase, full insert sequence, dopa decarboxylase, dopa | |
| | | | | decarhoxylase (aromatic L-amino acid decarboxylase | |
| 17473 | 1132 | NM_053319 | dynein, cytoplasmic, light | ESTs, Moderately similar to protein inhibitor of nitric oxide synthase [M. musculus], | GENERAL, K |
| | | | chain 1, dynein, cytoplasmic, | dynein, axon, light chain 4, dynein, axonemal, light polypeptide 4, dynein, cytoplasmic, | |
| | | | light polypeptide | light chain 1, dynein, cytoplasmic, light polypeptide | |
| 23868 | 825 | NM_012551 | early growth response 1 | early growth response 1, expressed sequence AI835008 | GENERAL, L |
| 23869 | 825 | NM_012551 | early growth response 1 | early growth response 1, expressed sequence AI835008 | L |
| 23872 | 825 | NM_012551 | early growth response 1 | early growth response 1, expressed sequence AI835008 | GENERAL |
| 16227 | 960 | NM_019137 | early growth response 4 | RIKEN cDNA 4930563M09 gene, early growth response 4 | F |
| 20865 | 795 | L00117 | elastase 1, pancreatic | elastase 1, pancreatic | GENERAL |
| 20925 | 1019 | NM_022594 | enoyl Coenzyme A hydratase | EST, Moderately similar to Peroxisomal enoyl hydratase-like protein; enoyl hydratase- | L |
| | | | 1, peroxisomal, enoyl | like protein, peroxisomal [Rattus norvegicus] [R. norvegicus], enoyl Coenzyme A | |
| | | | coenzyme A hydratase 1, | hydratase 1, peroxisomal, enoyl coenzyme A hydratase 1, peroxisomal | |
| | | | peroxisomal | | |
| 21562 | 1185 | NM_078623 | enoyl Coenzyme A hydratase, | AU RNA binding protein/enoyl-Coenzyme A hydratase, AU RNA binding protein/enoyl- | A |
| | | | short chain, 1, mitochondrial | coenzyme A hydratase, Mus musculus, Similar to 3-hydroxyisobutyryl-Coenzyme A | |
| | | | | hydrolase, clone MGC: 31364 IMAGE: 4238681, mRNA, complete cds, RIKEN cDNA | |
| | | | | 1300017C12 gene, RIKEN cDNA 1810022C23 gene, RIKEN cDNA 2310005D12 gene, | |
| | | | | enoyl Coenzyme A hydratase, short chain, 1, mitochondrial, hypothetical protein | |
| | | | | FLJ10948 | |
| 2465 | 812 | M59814 | Eph receptor B2, EphB2 | EST, Highly similar to putative protein-tyrosine kinase [Homo sapiens] [H. sapiens], Eph | G, K |
| | | | | receptor B1, Eph receptor B2, Eph receptor B3, EphB1, expressed sequence AW456895, | |
| | | | | expressed sequence AW488255 | |
| 17907 | 708 | AI233224 | epidermal growth factor | EST, Moderately similar to EGFR_HUMAN EPIDERMAL GROWTH FACTOR | GENERAL |
| | | | receptor, epidermal growth | RECEPTOR PRECURSOR [H. sapiens], Homo sapiens truncated epidermal growth factor | |
| | | | factor receptor (erythroblastic | receptor (EGFR) mRNA, partial cds; alternatively spliced, epidermal growth factor | |
| | | | leukemia viral (v-erb-b) | receptor | |
| | | | oncogene homolog, avian) | | |
| 20884 | 857 | NM_012842 | epidermal growth factor, | Homo sapiens mRNA; cDNA DKFZp667O055 (from clone DKFZp667O055), epidermal | G, K |
| | | | epidermal growth factor (beta- | growth factor, epidermal growth factor (beta-urogastrone), nidogen 2 | |
| | | | urogastrone) | | |
| 20885 | 857 | NM_012842 | epidermal growth factor, | Homo sapiens mRNA; cDNA DKFZp667O055 (from clone DKFZp667O055), epidermal | G, K |
| | | | epidermal growth factor (beta- | growth factor, epidermal growth factor (beta-urogastrone), nidogen 2 | |
| | | | urogastrone) | | |
| 17541 | 858 | NM_012844 | epoxide hydrolase 1, | epoxide hydrolase 1, microsomal, epoxide hydrolase 1, microsomal (xenobiotic) | GENERAL, A, B, H, I |
| | | | microsomal, epoxide | | |
| | | | hydrolase 1, microsomal | | |
| | | | (xenobiotic) | | |
| 8188 | 1167 | NM_053927 | erythrocyte membrane protein | FERM, RhoGEF (ARHGEF) and pleckstrin domain protein 1 (chondrocyte-derived), | GENERAL |
| | | | band 4.1-like 3, erythrocyte | Homo sapiens, Similar to erythrocyte membrane protein band 4.1-like 3, clone | |
| | | | protein band 4.1-like 3 | MGC: 12343 IMAGE: 4044866, mRNA, complete cds, KIAA0793 gene product, | |
| | | | | erythrocyte membrane protein band 4.1-like 3, erythrocyte protein band 4.1-like 3, | |
| | | | | erythrocyte protein band 4.1-like 4b, myosin regulatory light chain interacting protein, | |
| | | | | protein tyrosine phosphatase non-receptor type 3 | |
| 744 | 983 | NM_019622 | espin | ankyrin 2, neuronal, espin, expressed sequence AW549277, feminization 1 homolog a | GENERAL |
| | | | | (C. elegans), hypothetical protein LOC51239, synuclein, alpha interacting protein | |
| | | | | (synphilin) | |
| 18713 | 987 | NM_020075 | eukaryotic translation initiation | DNA segment, Chr 1, ERATO Doi 692, expressed, ESTs, Highly similar to EUKARYOTIC | L |
| | | | factor 5 | TRANSLATION INITIATION FACTOR 5 [R. norvegicus], KIAA1856 protein, eukaryotic | |
| | | | | translation initiation factor 5 | |
| 18716 | 987 | NM_020075 | eukaryotic translation initiation | DNA segment, Chr 1, ERATO Doi 692, expressed, ESTs, Highly similar to EUKARYOTIC | F |
| | | | factor 5 | TRANSLATION INITIATION FACTORS 5 [R. norvegicus], KIAA1856 protein, eukaryotic | |
| | | | | translation initiation factor 5 | |
| 15069 | 1111 | NM_031840 | farnesyl diphosphate synthase | ESTs, Moderately similar to A34713 farnesyl-pyrophosphate synthetase, testis - rat | H |
| | | | (farnesyl pyrophosphate | [R. norvegicus], ESTs, Weakly similar to A34713 farnesyl-pyrophosphate synthetase, | |
| | | | synthetase, | testis - rat [R. norvegicus], farnesyl diphosphate synthase (farnesyl pyrophosphate | |
| | | | dimethylallyltranstransferase, | synthetase, dimethylallyltranstransferase, geranyltranstransferase) | |
| | | | geranyltranstransferase), | | |
| | | | farnesyl diphosphate | | |
| | | | synthetase | | |
| 16476 | 1036 | NM_024162 | fatty acid binding protein 3, | EST, Moderately similar to FABH MOUSE FATTY ACID-BINDING PROTEIN, HEART | GENERAL, L |
| | | | muscle and heart, fatty acid | [M. musculus], fatty acid binding protein 3, muscle and heart, fatty acid binding protein 3, | |
| | | | binding protein 3, muscle and | muscle and heart (mammary-derived growth inhibitor) | |
| | | | heart (mammary-derived | | |
| | | | growth inhibitor) | | |
| 20983 | 440 | AI044900 | fatty acid Coenzyme A ligase, | ESTs, Weakly similar to fatty acid Coenzyme A ligase, long chain 2; acetyl-Coenzyme A | K |
| | | | long chain 2, fatty-acid- | synthetase; acetate-CoA ligase; acetyl-Coenzyme A synthetase 1 (ADP forming); acetyl- | |
| | | | Coenzyme A ligase, long- | CoA synthetase [Mus musculus] [M. musculus], Mus musculus, Similar to fatty-acid- | |
| | | | chain 2 | Coenzyme A ligase, long-chain 6, clone MGC: 28744 IMAGE: 4481949, mRNA, complete | |
| | | | | cds, Mus musculus, Similar to hypothetical protein FLJ20920, clone MGC: 25878 | |
| | | | | IMAGE: 4210220, mRNA, complete cds, fatty acid Coenzyme A ligase, long chain 2, fatty | |
| | | | | acid Coenzyme A ligase, long chain 5, fatty-acid-Coenzyme A ligase, long-chain 1, | |
| | | | | gonadotropin-regulated long chain acyl-CoA synthetase, lipidosis-related protein lipidosin | |
| 15926 | 1150 | NM_053607 | fatty acid Coenzyme A ligase, | ESTs, Weakly similar to fatty acid Coenzyme A ligase, long chain 2; acetyl-Coenzyme A | D |
| | | | long chain 5, fatty-acid- | synthetase; acetate-CoA ligase; acetyl-Coenzyme A synthetase 1 (ADP forming); acetyl- | |
| | | | Coenzyme A ligase, long- | CoA synthetase [Mus musculus] [M. musculus], Mus musculus, Similar to fatty-acid- | |
| | | | chain 5 | Coenzyme A ligase, long-chain 6, clone MGC: 28744 IMAGE: 4481949, mRNA, complete | |
| | | | | cds, Mus musculus, Similar to hypothetical protein FLJ20920, clone MGC: 25878 | |
| | | | | IMAGE: 4210220, mRNA, complete cds, fatty acid Coenzyme A ligase, long chain 2, fatty | |
| | | | | acid Coenzyme A ligase, long chain 5, fatty-acid-Coenzyme A ligase, long-chain 5, | |
| | | | | hypothetical protein PRTD-NY3 | |
| 13004 | 1154 | NM_053623 | fatty acid-Coenzyme A ligase, | | J, L |
| | | | long chain 4, fatty-acid- | | |
| | | | Coenzyme A ligase, long- | | |
| | | | chain 4 | | |
| 13005 | 1154 | NM_053623 | fatty acid-Coenzyme A ligase, | | C |
| | | | long chain 4, fatty-acid- | | |
| | | | Coenzyme A ligase, long- | | |
| | | | chain 4 | | |
| 8215 | 588 | AI171692 | ferritin light chain 1, ferritin, | ESTs, Moderately similar to ferritin light chain 1 [Rattus norvegicus] [R. norvegicus], | D |
| | | | light polypeptide | ESTs, Moderately similar to FRL2 MOUSE FERRITIN LIGHT CHAIN 2 [M. musculus], | |
| | | | | RIKEN cDNA 2010009K05 gene, RIKEN cDNA 4933416E14 gene, cysteine conjugate- | |
| | | | | beta lyase; cytoplasmic (glutamine transaminase K, kyneurenine aminotransferase), | |
| | | | | ferritin light chain 1, ferritin light chain 2, ferritin light polypeptide | |
| 8211 | 1008 | NM_022500 | ferritin light chain 1, ferritin, | ESTs, Moderately similar to ferritin light chain 1 [Rattus norvegicus] [R. norvegicus], | H |
| | | | light polypeptide | ESTs, Moderately similar to FRL2 MOUSE FERRITIN LIGHT CHAIN 2 [M. musculus], | |
| | | | | RIKEN cDNA 4933416E14 gene, ferritin light chain 1, ferritin light chain 2, ferritin, light | |
| | | | | polypeptide | |
| 8212 | 1008 | NM_022500 | ferritin light chain 1, ferritin, | ESTs, Moderately similar to ferritin light chain 1 [Rattus norvegicus] [R. norvegicus], | L |
| | | | light polypeptide | ESTs, Moderately similar to FRL2 MOUSE FERRITIN LIGHT CHAIN 2 [M. musculus], | |
| | | | | RIKEN cDNA 4933416E14 gene, ferritin light chain 1, ferritin light chain 2, ferritin, light | |
| | | | | polypeptide | |
| 8210 | 1195 | S61960 | ferritin light chain 1, ferritin, | ESTs, Moderately similar to ferritin light chain 1 [Rattus norvegicus] [R. norvegicus], | GENERAL |
| | | | light polypeptide | ESTs, Moderately similar to FRL2 MOUSE FERRITIN LIGHT CHAIN 2 [M. musculus], | |
| | | | | RIKEN cDNA 4933416E14 gene, ferritin light chain 1, ferritin light chain 2, ferritin, light | |
| | | | | polypeptide | |
| 6782 | 606 | AI176170 | FK506 binding protein 1A | FK506 binding protein 10 (65 kDa), FK506 binding protein 1A (12 kD), FK506 binding | B |
| | | | (12 kD), FK506 binding protein | protein 1a (12 kDa), FK506 binding protein 5, FK506 binding protein 7 (23 kDa), FK506 | |
| | | | 1a (12 kDa) | binding protein 8 (38 kDa) | |
| 15295 | 887 | NM_013102 | FK506 binding protein 1A | FK506 binding protein 10 (65 kDa), FK506 binding protein 1A (12 kD), FK506 binding | GENERAL, H, I |
| | | | (12 kD), FK506 binding protein | protein 1a (12 kDa), FK506 binding protein 5, FK506 binding protein 7 (23 kDa), FK506 | |
| | | | 1a (12 kDa), FK506 binding | binding protein 8 (38 kDa) | |
| | | | protein 2 (13 kDa), FK506 | | |
| | | | binding protein 2 (13 kD) | | |
| 15296 | 887 | NM_013102 | FK506 binding protein 1A | FK506 binding protein 10 (65 kDa), FK506 binding protein 1A (12 kD), FK506 binding | H, I |
| | | | (12 kD), FK506 binding protein | protein 1a (12 kDa), FK506 binding protein 5, FK506 binding protein 7 (23 kDa), FK506 | |
| | | | 1a (12 kDa), FK506 binding | binding protein 8 (38 kDa) | |
| | | | protein 2 (13 kDa), FK506 | | |
| | | | binding protein 2 (13 kD) | | |
| 15297 | 887 | NM_013102 | FK506 binding protein 1A | FK506 binding protein 10 (65 kDa), FK506 binding protein 1A (12 kD), FK506 binding | K |
| | | | (12 kD), FK506 binding protein | protein 1a (12 kDa), FK506 binding protein 5, FK506 binding protein 7 (23 kDa), FK506 | |
| | | | 1a (12 kDa), FK506 binding | binding protein 8 (38 kDa) | |
| | | | protein 2 (13 kDa), FK506 | | |
| | | | binding protein 2 (13 kD) | | |
| 23445 | 849 | NM_012792 | flavin containing | EST, Weakly similar to FMO1 MOUSE DIMETHYLANILINE MONOOXYGENASE | GENERAL |
| | | | monooxygenase 1 | [M. musculus], ESTs, Weakly similar to S33758 flavin-containing monooxygenase 1 - rat | |
| | | | | [R. norvegicus], Mus musculus flavin-containing monooxygenase 4 mRNA, complete cds, | |
| | | | | expressed sequence AW107733, flavin containing monooxygenase 1, hypothetical | |
| | | | | protein PRO1257 | |
| 23961 | 929 | NM_017181 | fumarylacetoacetate | ESTs, Weakly similar to FAAA_RAT Fumarylacetoacetase (Fumarylacetoacetate | GENERAL, E, G, I |
| | | | hydrolase, | hydrolase) (Beta-diketonase) (FAA) [R. norvegicus], fumarylacetoacetate hydrolase, | |
| | | | fumarylacetoacetate hydrolase | fumarylacetoacetate hydrolase (fumarylacetoacetase) | |
| | | | (fumarylacetoacetase) | | |
| 23151 | 1000 | NM_022005 | FXYD domain-containing ion | | B, L |
| | | | transport regulator 6 | | |
| 45 | 904 | NM_016996 | G protein-coupled receptor, | ESTs, Highly similar to 2121236A Ca-sensing receptor [H. sapiens], ESTs, Weakly similar | GENERAL, J, L |
| | | | family C, group 2, member A, | to CASR_MOUSE EXTRACELLULAR CALCIUM-SENSING RECEPTOR PRECURSOR | |
| | | | calcium-sensing receptor | (CASR) (PARATHYROID CELL CALCIUM-SENSING RECEPTOR) [M. musculus], G | |
| | | | (hypocalciuric hypercalcemia | protein-coupled receptor, family C, group 2, member A, RIKEN cDNA 1700108E19 gene, | |
| | | | 1, severe neonatal | calcium-sensing receptor (hypocalciuric hypercalcemia 1, severe neonatal | |
| | | | hyperparathyroidism) | hyperparathyroidism), taste receptor, type 1, member 1, vomeronasal 2, receptor, 10, | |
| | | | | vomeronasal 2, receptor, 11, vomeronasal 2, receptor, 13, vomeronasal 2, receptor, 5, | |
| | | | | vomeronasal 2, receptor 9 | |
| 1143 | 971 | NM_019280 | gap junction membrane | gap junction membrane channel protein alpha 5, gap junction protein, alpha 5, 40 kD | A |
| | | | channel protein alpha 5, gap | (connexin 40) | |
| | | | junction protein, alpha 5, 40 kD | | |
| | | | (connexin 40) | | |
| 15072 | 726 | AI234969 | GATA binding protein 4 | GATA binding protein 4, GATA binding protein 5, trichorhinophalangeal syndrome I, | A |
| | | | | trichorhinophalangeal syndrome I (human) | |
| 5496 | 1083 | NM_031589 | glucose-6-phosphatase, | Mus musculus, Similar to solute carrier family 37 (glycerol-3-phosphate transporter), | GENERAL, D, E |
| | | | transport (glucose-6- | member 1, clone MGC: 28167 IMAGE: 3985469, mRNA, complete cds, glucose-6- | |
| | | | phosphate) protein 1, glucose- | phosphatase, transport (glucose-6-phosphate) protein 1, glucose-6-phosphatase, | |
| | | | 6-phosphatase, transport | transport protein 1, solute carrier family 37 (glycerol-3-phosphate transporter), member 1 | |
| | | | protein 1 | | |
| 5497 | 1083 | NM_031589 | glucose-6-phosphatase, | Mus musculus, Similar to solute carrier family 37 (glycerol-3-phosphate transporter), | GENERAL, D, E |
| | | | transport (glucose-6- | member 1, clone MGC: 28167 IMAGE: 3985469, mRNA, complete cds, glucose-6- | |
| | | | phosphate) protein 1, glucose- | phosphatase, transport (glucose-6-phosphate) protein 1, glucose-6-phosphatase, | |
| | | | 6-phosphatase, transport | transport protein 1, solute carrier family 37 (glycerol-3-phosphate transporter), member 1 | |
| | | | protein 1 | | |
| 1399 | 907 | NM_017006 | glucose-6-phosphate | glucose-6-phosphate dehydrogenase, glucose-6-phosphate dehydrogenase 2, glucose-6- | GENERAL, H, I |
| | | | dehydrogenase, glucose-6- | phosphate dehydrogenase X-linked, hexose-6-phosphate dehydrogenase (glucose 1- | |
| | | | phosphate dehydrogenase X- | dehydrogenase) | |
| | | | linked | | |
| 14003 | 948 | NM_017305 | glutamate-cysteine ligase, | glutamate-cysteine ligase, modifier subunit, glutamate-cysteine ligase, modifier subunit | B, J |
| | | | modifier subunit, glutamate- | | |
| | | | cysteine ligase, modifier | | |
| | | | subunit | | |
| 1247 | 792 | J05181 | glutamate-cysteine ligase, | Homo sapiens, Similar to glutamate-cysteine ligase, catalytic subunit, clone MGC: 26341 | J |
| | | | catalytic subunit | IMAGE: 4814728, mRNA, complete cds, glutamate-cysteine ligase, catalytic subunit | |
| 5206 | 235 | AA925755 | glutaminase | ESTs, Highly similar to GLSK RAT GLUTAMINASE, KIDNEY ISOFORM PRECURSOR | E |
| | | | | [R. norvegicus], ESTs, Moderately similar to GLSK_HUMAN GLUTAMINASE, KIDNEY | |
| | | | | ISOFORM, MITOCHONDRIAL PRECURSOR (GLS) (L-GLUTAMINE | |
| | | | | AMIDOHYDROLASE) (K-GLUTAMINASE) [H. sapiens], Homo sapiens glutaminase | |
| | | | | isoform M precursor, mRNA, complete cds, expressed sequence AI314027, glutaminase | |
| 18990 | 1072 | NM_031509 | glutathione S-transferase A2, | ESTs, Weakly similar to GTA1_RAT GLUTATHIONE S-TRANSFERASE YA (LIGANDIN) | H |
| | | | glutathione S-transferase, | (CHAIN 1) (GST CLASS-ALPHA) (CLONES PGST94 & PGTR261) [R. norvegicus], | |
| | | | alpha 2 (Yc2) | glutathione S-transferase A2, glutathione S-transferase, alpha 2 (Yc2) | |
| 21012 | 788 | J02592 | glutathione S-transferase M2 | | B |
| | | | (muscle), glutathione S- | | |
| | | | transferase, mu 2 | | |
| 21014 | 791 | J03914 | glutathione S-transferase M2 | | B, L |
| | | | (muscle), glutathione S- | | |
| | | | transferase, mu 2 | | |
| 6405 | 801 | L38615 | glutathione synthetase | EST, Highly similar to GSHB MOUSE GLUTATHIONE SYNTHETASE [M. musculus], | G |
| | | | | glutathione synthetase | |
| 16775 | 1048 | NM_031031 | glycine amidinotransferase (L- | glycine amidinotransferase (L-arginine:glycine amidinotransferase) | GENERAL, D, I, L |
| | | | arginine:glycine | | |
| | | | amidinotransferase) | | |
| 1551 | 915 | NM_017084 | glycine N-methyltransferase | glycine N-methyltransferase | G |
| 16756 | 38 | AA818089 | glycyl-tRNA synthetase | glycyl-tRNA synthetase | GENERAL, A, I |
| 352 | 1030 | NM_024127 | growth arrest and DNA- | growth arrest and DNA-damage-inducible 45 alpha, growth arrest and DNA-damage- | H |
| | | | damage-inducible 45 alpha, | inducible 45 beta, growth arrest and DNA-damage-inducible, alpha | |
| | | | growth arrest and DNA- | | |
| | | | damage-inducible, alpha | | |
| 353 | 1030 | NM_024127 | growth arrest and DNA- | growth arrest and DNA-damage-inducible 45 alpha, growth arrest and DNA-damage- | GENERAL, H, I |
| | | | damage-inducible 45 alpha, | inducible 45 beta, growth arrest and DNA-damage-inducible, alpha | |
| | | | growth arrest and DNA- | | |
| | | | damage-inducible, alpha | | |
| 354 | 1030 | NM_024127 | growth arrest and DNA- | growth arrest and DNA-damage-inducible 45 alpha, growth arrest and DNA-damage- | GENERAL, H, I |
| | | | damage-inducible 45 alpha, | inducible 45 beta, growth arrest and DNA-damage-inducible, alpha | |
| | | | growth arrest and DNA- | | |
| | | | damage-inducible, alpha | | |
| 25290 | 1174 | NM_057100 | growth arrest specific 6, | ESTs, Highly similar to growth arrest specific 6 [Rattus norvegicus] [R. norvegicus], | J |
| | | | growth arrest-specific 6 | growth arrest specific 6, growth arrest-specific 6 | |
| 17524 | 381 | AI010568 | growth hormone receptor | growth hormone receptor | GENERAL, A, I |
| 10887 | 917 | NM_017094 | growth hormone receptor | growth hormone receptor | GENERAL, I |
| 16948 | 850 | NM_012793 | guanidinoacetate N- | expressed sequence AA571402, guanidinoacetate N-methyltransferase, | A, C |
| | | | methyltransferase, | guanidinoacetate methyltransferase | |
| | | | guanidinoacetate | | |
| | | | methyltransferase | | |
| 8888 | 916 | NM_017090 | guanylate cyclase 1, soluble, | ESTs, Weakly similar to CYG3 RAT GUANYLATE CYCLASE SOLUBLE, ALPHA-1 | B |
| | | | alpha 3 | CHAIN [R. norvegicus], guanylate cyclase 1, soluble, alpha 3 | |
| 17661 | 1025 | NM_022674 | H2A histone family, member Z | EST, Weakly similar to histone H2A.F/Z variant [Homo sapiens] [H. sapiens], ESTs, | E |
| | | | | Highly similar to S03644 histone H2A.Z - rat [R. norvegicus], ESTs, Weakly similar to | |
| | | | | H2AZ_HUMAN HISTONE H2A [H. sapiens], H2A histone family, member Z, Homo | |
| | | | | sapiens cDNA FLJ32241 fis, clone PLACE6005231, RIKEN cDNA C530002L11 gene, | |
| | | | | histone H2A.F/Z variant | |
| 1687 | 645 | AI179971 | hemoglobin alpha, adult chain | EST, Moderately similar to HBA_RAT HEMOGLOBIN ALPHA-1 AND ALPHA-2 CHAINS | J |
| | | | 2, hemoglobin, alpha 1 | [R. norvegicus], EST, Weakly similar to HBA_RAT HEMOGLOBIN ALPHA-1 AND ALPHA- | |
| | | | | 2 CHAINS [R. norvegicus], ESTs, Moderately similar to HBA_RAT HEMOGLOBIN ALPHA | |
| | | | | 1 AND ALPHA-2 CHAINS [R. norvegicus], RIKEN cDNA 2510042H12 gene, hemoglobin | |
| | | | | alpha chain complex, hemoglobin alpha, adult chain 1, hemoglobin, alpha 1, hemoglobin, | |
| | | | | alpha 2, hemoglobin, theta 1 | |
| 1684 | 885 | NM_013096 | hemoglobin alpha, adult chain | EST, Moderately similar to HBA_RAT HEMOGLOBIN ALPHA-1 AND ALPHA-2 CHAINS | J |
| | | | 2, hemoglobin, alpha 1 | [R. norvegicus], EST, Weakly similar to HBA_RAT HEMOGLOBIN ALPHA-1 AND ALPHA- | |
| | | | | 2 CHAINS [R. norvegicus], ESTs, Moderately similar to HBA_RAT HEMOGLOBIN ALPHA | |
| | | | | 1 AND ALPHA-2 CHAINS [R. norvegicus], RIKEN cDNA 2510042H12 gene, hemoglobin | |
| | | | | alpha chain complex, hemoglobin alpha, adult chain 1, hemoglobin, alpha 1, hemoglobin, | |
| | | | | alpha 2, hemoglobin, theta 1 | |
| 1685 | 885 | NM_013096 | hemoglobin alpha, adult chain | EST, Moderately similar to HBA_RAT HEMOGLOBIN ALPHA-1 AND ALPHA-2 CHAINS | J |
| | | | 2, hemoglobin, alpha 1 | [R. norvegicus], EST, Weakly similar to HBA_RAT HEMOGLOBIN ALPHA-1 AND ALPHA- | |
| | | | | 2 CHAINS [R. norvegicus], ESTs, Moderately similar to HBA_RAT HEMOGLOBIN ALPHA | |
| | | | | 1 AND ALPHA-2 CHAINS [R. norvegicus], RIKEN cDNA 2510042H12 gene, hemoglobin | |
| | | | | alpha chain complex, hemoglobin alpha, adult chain 1, hemoglobin, alpha 1, hemoglobin, | |
| | | | | alpha 2, hemoglobin, theta 1 | |
| 1688 | 885 | NM_013096 | hemoglobin alpha, adult chain | EST, Moderately similar to HBA_RAT HEMOGLOBIN ALPHA-1 AND ALPHA-2 CHAINS | J |
| | | | 2, hemoglobin, alpha 1 | [R. norvegicus], EST, Weakly similar to HBA_RAT HEMOGLOBIN ALPHA-1 AND ALPHA- | |
| | | | | 2 CHAINS [R. norvegicus], ESTs, Moderately similar to HBA_RAT HEMOGLOBIN ALPHA | |
| | | | | 1 AND ALPHA-2 CHAINS [R. norvegicus], RIKEN cDNA 2510042H12 gene, hemoglobin | |
| | | | | alpha chain complex, hemoglobin alpha, adult chain 1, hemoglobin, alpha 1, hemoglobin, | |
| | | | | alpha 2, hemoglobin, theta 1 | |
| 1689 | 885 | NM_013096 | hemoglobin alpha, adult chain | EST, Moderately similar to HBA_RAT HEMOGLOBIN ALPHA-1 AND ALPHA-2 CHAINS | J |
| | | | 2, hemoglobin, alpha 1 | [R. norvegicus], EST, Weakly similar to HBA_RAT HEMOGLOBIN ALPHA-1 AND ALPHA- | |
| | | | | 2 CHAINS [R. norvegicus], ESTs, Moderately similar to HBA_RAT HEMOGLOBIN ALPHA | |
| | | | | 1 AND ALPHA-2 CHAINS [R. norvegicus], RIKEN cDNA 2510042H12 gene, hemoglobin | |
| | | | | alpha chain complex, hemoglobin alpha, adult chain 1, hemoglobin, alpha 1, hemoglobin, | |
| | | | | alpha 2, hemoglobin, theta 1 | |
| 25468 | 1123 | NM_033234 | hemoglobin beta chain | EST, Moderately similar to HBB1_RAT Hemoglobin beta chain, major-form | J |
| | | | complex, hemoglobin, beta | [R. norvegicus], expressed sequence AI036344, hemoglobin, beta, hemoglobin, beta adult | |
| | | | | major chain, hemoglobin, beta adult minor chain, hemoglobin, delta | |
| 17829 | 1123 | NM_033234 | hemoglobin beta chain | EST, Moderately similar to HBB1_RAT Hemoglobin beta chain, major-form | J |
| | | | complex, hemoglobin, beta | [R. norvegicus], expressed sequence AI036344, hemoglobin, beta, hemoglobin, beta adult | |
| | | | | major chain, hemoglobin, beta adult minor chain, hemoglobin, delta | |
| 17832 | 1123 | NM_033234 | hemoglobin beta chain | EST, Moderately similar to HBB1_RAT Hemoglobin beta chain, major-form | J |
| | | | complex, hemoglobin, beta | [R. norvegicus], expressed sequence AI036344, hemoglobin, beta, hemoglobin, beta adult | |
| | | | | major chain, hemoglobin, beta adult minor chain, hemoglobin, delta | |
| 17833 | 1123 | NM_033234 | hemoglobin beta chain | EST, Moderately similar to HBB1_RAT Hemoglobin beta chain, major-form | F |
| | | | complex, hemoglobin, beta | [R. norvegicus], expressed sequence AI036344, hemoglobin, beta, hemoglobin, beta adult | |
| | | | | major chain, hemoglobin, beta adult minor chain, hemoglobin, delta | |
| 6758 | 405 | AI013394 | heparan sulfate (glucosamine) | EST, Highly similar to HSS2 MOUSE HEPARIN SULFATE N-DEACETYLASE/N- | B, L |
| | | | 3-O-sulfotransferase 1 | SULFOTRANSFERASE [M. musculus], ESTs, Weakly similar to HSS2 MOUSE HEPARIN | |
| | | | | SULFATE N-DEACETYLASE/N-SULFOTRANSFERASE [M. musculus], ESTs, Weakly | |
| | | | | similar to HSS2_HUMAN HEPARIN SULFATE N-DEACETYLASE/N- | |
| | | | | SULFOTRANSFERASE [H. sapiens], N-deacetylase/N-sulfotransferase (heparan | |
| | | | | glucosaminyl) 2,N-deacetylase/N-sulfotransferase (heparan glucosaminyl) 3,N- | |
| | | | | deacetylase/N-sulfotransferase (heparin glucosaminyl) 4,N-deacetylase/N- | |
| | | | | sulfotransferase 4, RIKEN cDNA 4930439H17 gene, heparan sulfate (glucosamine) 3-O- | |
| | | | | sulfotransferase 3A heparan sulfate (glucosamine) 3-O-sulfotransferase 4 | |
| 4234 | 1068 | NM_031330 | heterogeneous nuclear | DAZ associated protein 1, Musashi homolog 1(Drosophila), Musashi homolog 2 | K |
| | | | ribonucleoprotein A/B | (Drosophila), RIKEN cDNA 4933434H11 gene, expressed sequence AA959857, | |
| | | | | heterogeneous nuclear ribonucleoprotein A/B, musashi homolog 1 (Drosophila) | |
| 4235 | 1068 | NM_031330 | heterogeneous nuclear | DAZ associated protein 1, Musashi homolog 1(Drosophila), Musashi homolog 2 | GENERAL, H, K, L |
| | | | ribonucleoprotein A/B | (Drosophila), RIKEN cDNA 4933434H11 gene, expressed sequence AA959857, | |
| | | | | heterogeneous nuclear ribonucleoprotein A/B, musashi homolog 1 (Drosophila) | |
| 19834 | 1179 | NM_057139 | heterogeneous nuclear | E1B-55 kDa-associated protein 5, EST, Weakly similar to heterogenous nuclear | E |
| | | | ribonucleoprotein U, | ribonucleoprotein U; scaffold attachment factor A; nuclear matrix protein sp120 [Mus | |
| | | | heterogeneous nuclear | musculus] [M. musculus], expressed sequence AI465155, heterogeneous nuclear | |
| | | | ribonucleoprotein U (scaffold | ribonucleoprotein U | |
| | | | attachment factor A) | | |
| 15437 | 930 | NM_017187 | high mobility group box 2, high | EST, Moderately similar to HMG2_RAT High mobility group protein 2 (HMG-2) | E |
| | | | mobility group (nonhistone | [R. norvegicus], ESTs, Weakly similar to 2001363A high mobility group protein 2 | |
| | | | chromosomal) protein 2 | [H. sapiens], ESTs, Weakly similar to HMG2_RAT High mobility group protein 2 (HMG-2) | |
| | | | | [R. norvegicus], Homo sapiens, clone MGC: 33358 IMAGE: 5266418, mRNA, complete | |
| | | | | cds, RIKEN cDNA 2610021J01 gene, expressed sequence C80539, high mobility group | |
| | | | | box 2 high-mobility group (nonhistone chromosomal) protein 2 | |
| 3608 | 1049 | NM_031044 | histamine N-methyltransferase | histamine N-methyltransferase | GENERAL, J |
| 3610 | 1049 | NM_031044 | histamine N-methyltransferase | histamine N-methyltransferase | GENERAL, G, I, J |
| 3609 | 1203 | S82579 | histamine N-methyltransferase | histamine N-methyltransferase | F |
| 17345 | 144 | AA892014 | HLA-B associated transcript 1, | ESTs, Highly similar to S33681 translation initiation factor elF-4A.I [H. sapiens], ESTs, | E |
| | | | HLA-B-associated transcript | Weakly similar to A42811 nuclear RNA helicase (DEAD family) homolog - rat | |
| | | | 1A | [R. norvegicus], RIKEN cDNA 2610307C23 gene, hypothetical protein MGC6664 | |
| 15750 | 1131 | NM_053309 | Homer, neuronal immediate | Homer, neuronal immediate early gene, 2 homer, neuronal immediate early gene, 1 | H |
| | | | early gene, 2, homer, neuronal | | |
| | | | immediate early gene, 2 | | |
| 24631 | 1032 | NM_024137 | human immunodeficiency virus | KIAA1555 protein, human immunodeficiency virus type I enhancer binding protein 2, | F |
| | | | type I enhancer binding protein 2 | human immunodeficiency virus type I enhancer binding protein 3, kappa B and Rss | |
| | | | | recognition component | |
| 573 | 692 | AI232087 | hydroxyacid oxidase (glycolate | | J |
| | | | oxidase) 3, hydroxyacid | | |
| | | | oxidase 3 (medium-chain) | | |
| 1409 | 1124 | NM_033349 | hydroxyacyl glutathione | ESTs, Highly similar to GLO2_HUMAN HYDROXYACYLGLUTATHIONE HYDROLASE | GENERAL, A, C, E, F |
| | | | hydrolase | [H. sapiens], Mus musculus, Similar to hydroxyacyl glutathione hydrolase, clone | |
| | | | | MGC: 6697 IMAGE: 3583919, mRNA, complete cds, RIKEN cDNA 0610025L15 gene, | |
| | | | | RIKEN cDNA 1500017E18 gene, brain protein 17, hydroxyacyl glutathione hydrolase | |
| 15175 | 1091 | NM_031682 | hydroxyacyl-Coenzyme A | hydroxyacyl-Coenzyme A dehydrogenase, type II, hydroxysteroid (17-beta) | E |
| | | | dehydrogenase, type II, | dehydrogenase 10, retinal short-chain dehydrogenase/reductase retSDR3 | |
| | | | hydroxysteroid (17-beta) | | |
| | | | dehydrogenase 10 | | |
| 275 | 914 | NM_017081 | hydroxysteroid (11-beta) | hydroxysteroid (11-beta) dehydrogenase 2, hydroxysteroid 11-beta dehydrogenase 2 | GENERAL |
| | | | dehydrogenase 2, | | |
| | | | hydroxysteroid 11-beta | | |
| | | | dehydrogenase 2 | | |
| 10464 | 793 | J05510 | inositol 1,4,5-triphosphate | ESTs, Highly similar to A36579 inositol 1,4,5-triphosphate receptor 1 - rat [R. norvegicus], | GENERAL, I |
| | | | receptor 1, inositol 1,4,5- | ESTs, Highly similar to IP3R MOUSE INOSITOL 1,4,5-TRISPHOSPHATE-BINDING | |
| | | | triphosphate receptor, type 1 | PROTEIN TYPE 1 RECEPTOR [M. musculus], ESTs, Highly similar to S54974 type 1 | |
| | | | | inositol 1,4,5-trisphosphate receptor [H. sapiens], ESTs, Moderately similar to IP3R | |
| | | | | MOUSE INOSITOL 1,4,5-TRISPHOSPHATE-BINDING PROTEIN TYPE 1 RECEPTOR | |
| | | | | [M. musculus], ESTs, Weakly similar to IP3R MOUSE INOSITOL 1,4,5- | |
| | | | | TRISPHOSPHATE-BINDING PROTEIN TYPE 1 RECEPTOR [M. musculus], inositol 1,4,5 | |
| | | | | triphosphate receptor 1, inositol 1,4,5-triphosphate receptor, type 1 | |
| 1712 | 892 | NM_013138 | inositol 1,4,5-triphosphate | ESTs, Highly similar to IP3R MOUSE INOSITOL 1,4,5-TRISPHOSPHATE-BINDING | GENERAL |
| | | | receptor 3, inositol 1,4,5- | PROTEIN TYPE 1 RECEPTOR [M. musculus], ESTs, Moderately similar to IP3R MOUSE | |
| | | | triphosphate receptor, type 3 | INOSITOL 1,4,5-TRISPHOSPHATE-BINDING PROTEIN TYPE 1 RECEPTOR | |
| | | | | [M. musculus], ESTs, Moderately similar to IP3S_MOUSE_1 [Segment 1 of 2] Inositol | |
| | | | | 1,4,5-trisphosphate receptor type 2 (Type 2 inositol 1,4,5-trisphosphate receptor) (Type 2 | |
| | | | | InsP3 receptor) (IP3 receptor isoform 2) (InsP3R2) (Inositol 1,4,5-trisphosphate type V | |
| | | | | receptor) (Fragments) [M. musculus], ESTs, Weakly similar to IP3R MOUSE INOSITOL | |
| | | | | 1,4,5-TRISPHOSPHATE-BINDING PROTEIN TYPE 1 RECEPTOR [M. musculus], | |
| | | | | inositol 1,4,5-triphosphate receptor 1, inositol 1,4,5-triphosphate receptor 3, inositol 1,4,5- | |
| | | | | triphosphate receptor type 3 | |
| 21053 | 805 | M15481 | insulin-like growth factor 1, | | GENERAL |
| | | | insulin-like growth factor 1 | | |
| | | | (somatomedin C) | | |
| 24893 | 853 | NM_012817 | insulin-like growth factor | | B |
| | | | binding protein 5 | | |
| 21977 | 1133 | NM_053329 | insulin-like growth factor | ESTs, Weakly similar to A41915 insulin-like growth factor-binding complex acid-labile | A, B |
| | | | binding protein, acid labile | chain precursor [H. sapiens], ESTs, Weakly similar to ALS MOUSE INSULIN-LIKE | |
| | | | subunit | GROWTH FACTOR BINDING PROTEIN COMPLEX ACID LABILE CHAIN | |
| | | | | PRECURSOR [M. musculus], RIKEN cDNA 1200009O22 gene, glycoprotein A repetitions | |
| | | | | predominant, glycoprotein lb (platelet), alpha polypeptide, insulin-like growth factor | |
| | | | | binding protein, acid labile subunit, toll-like receptor 3, toll-like receptor 4, toll-like receptor 5 | |
| 14989 | 621 | AI177366 | integrin beta 1 (fibronectin | integrin beta 1 (fibronectin receptor beta), integrin beta 2, integrin beta 7, integrin, beta 1 | GENERAL, K |
| | | | receptor beta), integrin, beta 1 | (fibronectin receptor, beta polypeptide, antigen CD29 includes MDF2, MSK12), integrin, | |
| | | | (fibronectin receptor, beta | beta 2 (antigen CD18 (p95), lymphocyte function-associated antigen 1; macrophage | |
| | | | polypeptide, antigen CD29 | antigen 1 (mac-1) beta subunit), integrin, beta 7 | |
| | | | includes MDF2, MSK12) | | |
| 2554 | 873 | NM_012967 | intercellular adhesion | ESTs, Weakly similar to ICA1_HUMAN INTERCELLULAR ADHESION MOLECULE-1 | GENERAL |
| | | | molecule, intercellular | PRECURSOR [H. sapiens], intercellular adhesion molecule, intercellular adhesion | |
| | | | adhesion molecule 1 (CD54), | molecule 1 (CD54), human rhinovirus receptor, intercellular adhesion molecule 3, | |
| | | | human rhinovirus receptor | intercellular adhesion molecule 5, telencephalin | |
| 2555 | 873 | NM_012967 | intercellular adhesion | ESTs, Weakly similar to ICA1_HUMAN INTERCELLULAR ADHESION MOLECULE-1 | GENERAL, C, I |
| | | | molecule, intercellular | PRECURSOR [H. sapiens], intercellular adhesion molecule, intercellular adhesion | |
| | | | adhesion molecule 1 (CD54), | molecule 1 (CD54), human rhinovirus receptor, intercellular adhesion molecule 3, | |
| | | | human rhinovirus receptor | intercellular adhesion molecule 5, telencephalin | |
| 20126 | 826 | NM_012591 | interferon regulatory factor 1 | ESTs, Moderately similar to sirtuin 2 (silent mating type information regulation 2, | K |
| | | | | homolog) 2 (S. cerevisiae) [Rattus norvegicus] [R. norvegicus], Mus musculus, Similar to | |
| | | | | sirtuin silent mating type information regulation 2 homolog 7 (S. cerevisiae), clone | |
| | | | | MGC: 37560 IMAGE: 4987746, mRNA, complete cds, expressed sequence AI646973, | |
| | | | | interferon regulatory factor 1, interferon regulatory factor 2, interferon regulatory factor 4, | |
| | | | | interferon regulatory factor 5, sirtuin 1 ((silent mating type information regulation 2, | |
| | | | | homolog) 1 (S. cerevisiae), sirtuin 2 (silent mating type information regulation 2, homolog) | |
| | | | | 2 (S. cerevisiae), sirtuin 3 (silent mating type information regulation 2, homolog) 3 (S. cerevisiae) | |
| 17908 | 967 | NM_019242 | interferon-related | ESTs, Weakly similar to IFR1_RAT INTERFERON-RELATED DEVELOPMENTAL | GENERAL |
| | | | developmental regulator 1 | REGULATOR 1 (NERVE GROWTH FACTOR-INDUCIBLE PROTEIN PC4) (IRPR) | |
| | | | | [R. norvegicus], interferon-related developmental regulator 1, interferon-related | |
| | | | | developmental regulator 2 | |
| 4449 | 827 | NM_012592 | isovaleryl Coenzyme A | ESTs, Moderately similar to IVD_HUMAN ISOVALERYL-COA DEHYDROGENASE, | B, G, K |
| | | | dehydrogenase, isovaleryl | MITOCHONDRIAL PRECURSOR [H. sapiens], isovaleryl Coenzyme A dehydrogenase, | |
| | | | coenzyme A dehydrogenase | isovaleryl coenzyme A dehydrogenase | |
| 4450 | 827 | NM_012592 | isovaleryl Coenzyme A | ESTs, Moderately similar to IVD_HUMAN ISOVALERYL-COA DEHYDROGENASE, | E |
| | | | dehydrogenase, isovaleryl | MITOCHONDRIAL PRECURSOR [H. sapiens], isovaleryl Coenzyme A dehydrogenase, | |
| | | | coenzyme A dehydrogenase | isovaleryl coenzyme A dehydrogenase | |
| 4451 | 827 | NM_012592 | isovaleryl Coenzyme A | ESTs, Moderately similar to IVD_HUMAN ISOVALERYL-COA DEHYDROGENASE, | GENERAL, F |
| | | | dehydrogenase, isovaleryl | MITOCHONDRIAL PRECURSOR [H. sapiens], isovaleryl Coenzyme A dehydrogenase, | |
| | | | coenzyme A dehydrogenase | isovaleryl coenzyme A dehydrogenase | |
| 1729 | 961 | NM_019147 | jagged 1, jagged 1 (Alagille | jagged 1, jagged 1 (Alagille syndrome) | B |
| | | | syndrome) | | |
| 25233 | 774 | AJ000556 | Janus kinase 1, Janus kinase | | E |
| | | | 1 (a protein tyrosine kinase) | | |
| 2632 | 965 | NM_019213 | jumping translocation | ESTs, Highly similar to jumping translocation breakpoint [Rattus norvegicus] | A, D |
| | | | breakpoint | [R. norvegicus], ESTs, Moderately similar to jumping translocation breakpoint [Rattus | |
| | | | | norvegicus] [R. norvegicus], jumping translocation breakpoint | |
| 22352 | 603 | AI175959 | Jun oncogene, v-jun sarcoma | Jun oncogene, v-jun sarcoma virus 17 oncogene homolog (avian) | GENERAL, H |
| | | | virus 17 oncogene homolog | | |
| | | | (avian) | | |
| 17198 | 828 | NM_012593 | kallikrein 1, | EST, Highly similar to KLKC_HUMAN KALLIKREIN 12 PRECURSOR [H. sapiens], | G |
| | | | renal/pancreas/salivary | kallikrein 1, renal/pancreas/salivary, kallikrein 24, kallikrein 27, kallikrein 5 | |
| | | | kallikrein 6 | | |
| 16726 | 1112 | NM_031855 | ketohexokinase, | ketohexokinase, ketohexokinase (fructokinase) | GENERAL, E, G, H, I |
| | | | ketohexokinase (fructokinase) | | |
| 1850 | 840 | NM_012696 | kininogen | kininogen | GENERAL |
| 8640 | 1184 | NM_057211 | Kruppel-like factor 9, basic | ESTs, Moderately similar to Kruppel-like factor 9 [Rattus norvegicus] [R. norvegicus], | D |
| | | | transcription element binding | Kruppel-like factor 9, basic transcription element binding protein 1, expressed sequence | |
| | | | protein 1 | AL022736 | |
| 794 | 1166 | NM_053902 | kynureninase (L-kynurenine | Mus musculus, Similar to kynureninase (L-kynurenine hydrolase), clone MGC: 30315 | GENERAL, I |
| | | | hydrolase) | IMAGE: 5136970, mRNA, complete cds, kynureninase (L-kynurenine hydrolase) | |
| 17807 | 909 | NM_017025 | lactate dehydrogenase 1, A | lactate dehydrogenase 1, A chain, lactate dehydrogenase A, lactate dehydrogenase A- | GENERAL, G |
| | | | chain, lactate dehydrogenase A | like, lactate dehydrogenase C | |
| 7124 | 829 | NM_012595 | lactate dehydrogenase 2, B | lactate dehydrogenase 2, B chain, lactate dehydrogenase B | E |
| | | | chain, lactate dehydrogenase B | | |
| 20086 | 403 | AI013260 | lamin A, lamin A/C | | GENERAL, H |
| 20085 | 997 | NM_021755 | lamin A, lamin A/C | | C |
| 22434 | 874 | NM_012974 | laminin, beta 2, laminin, beta 2 | ESTs, Weakly similar to LMB2_HUMAN LAMININ BETA-2 CHAIN PRECURSOR | F |
| | | | (laminin S) | [H. sapiens], Rattus norvegicus laminin-5 alpha 3 chain mRNA, complete cds, expressed | |
| | | | | sequence AW211941, expressed sequence C80098, hypothetical protein BC018697, | |
| | | | | laminin B1 subunit 1, laminin, beta 1, laminin, beta 2, laminin, beta 2 (laminin S), laminin, | |
| | | | | beta 4 | |
| 1993 | 1089 | NM_031655 | latexin, latexin protein | ESTs, Weakly similar to latexin [Rattus norvegicus] [R. norvegicus], latexin, retinoic acid | GENERAL, E, G, K |
| | | | | receptor responder (tazarotene induced) 1 | |
| 22321 | 1109 | NM_031832 | lectin, galactose binding, | EST, Weakly similar to A35820 galectin 3 [H. sapiens], galectin-related inter-fiber protein, | GENERAL, B, G, L |
| | | | soluble 3, lectin, galactoside- | lectin, galactoside-binding, soluble, 3 (galectin 3) | |
| | | | binding, soluble, 3 (galectin 3) | | |
| 783 | 859 | NM_012859 | lipase, hormone sensitive, | EST, Highly similar to hormone - sensitive lipase, testicular isofom [Rattus norvegicus] | F |
| | | | lipase, hormone-sensitive | [R. norvegicus], lipase, hormone sensitive, lipase, hormone-sensitive | |
| 1542 | 932 | NM_017193 | L-kynurenine/alpha- | | J |
| | | | aminoadipate | | |
| | | | aminotransferase, kynurenine | | |
| | | | aminotransferase II | | |
| 15110 | 1043 | NM_030827 | low density lipoprotein | EST, Highly similar to T42737 gp330 protein precursor - rat [R. norvegicus], EST, | GENERAL, I |
| | | | receptor-related protein 2, low | Moderately similar to S25111 alpha-2-macroglobulin receptor precursor - mouse | |
| | | | density lipoprotein-related | [M. musculus], ESTs, Highly similar to S25111 alpha-2-macroglobulin receptor precursor - | |
| | | | protein 2 | mouse [M. musculus], ESTs, Weakly similar to LDVR MOUSE VERY LOW-DENSITY | |
| | | | | LIPOPROTEIN RECEPTOR PRECURSOR [M. musculus], ESTs, Weakly similar to | |
| | | | | S25111 alpha-2-macroglobulin receptor precursor - mouse [M. musculus], expressed | |
| | | | | sequence AI315343, low density lipoprotein receptor-related protein 1, low density | |
| | | | | lipoprotein-related protein 1 (alpha-2-macroglobulin receptor), low density lipoprotein- | |
| | | | | related protein 2 | |
| 15111 | 1043 | NM_030827 | low density lipoprotein | EST, Highly similar to T42737 gp330 protein precursor - rat [R. norvegicus], EST, | GENERAL, I |
| | | | receptor-related protein 2, low | Moderately similar to S25111 alpha-2-macroglobulin receptor precursor - mouse | |
| | | | density lipoprotein-related | [M. musculus], ESTs, Highly similar to S25111 alpha-2-macroglobulin receptor precursor - | |
| | | | protein 2 | mouse [M. musculus], ESTs, Weakly similar to LDVR MOUSE VERY LOW-DENSITY | |
| | | | | LIPOPROTEIN RECEPTOR PRECURSOR [M. musculus], ESTs, Weakly similar to | |
| | | | | S25111 alpha-2-macroglobulin receptor precursor - mouse [M. musculus], expressed | |
| | | | | sequence AI315343, low density lipoprotein receptor-related protein 1, low density | |
| | | | | lipoprotein-related protein 1 (alpha-2-macroglobulin receptor), low density lipoprotein- | |
| | | | | related protein 2 | |
| 15112 | 1043 | NM_030827 | low density lipoprotein | EST, Highly similar to T42737 gp330 protein precursor - rat [R. norvegicus], EST, | I |
| | | | receptor-related protein 2, low | Moderately similar to S25111 alpha-2-macroglobulin receptor precursor - mouse | |
| | | | density lipoprotein-related | [M. musculus], ESTs, Highly similar to S25111 alpha-2-macroglobulin receptor precursor - | |
| | | | protein 2 | mouse [M. musculus], ESTs, Weakly similar to LDVR MOUSE VERY LOW-DENSITY | |
| | | | | LIPOPROTEIN RECEPTOR PRECURSOR [M. musculus], ESTs, Weakly similar to | |
| | | | | S25111 alpha-2-macroglobulin receptor precursor - mouse [M. musculus], expressed | |
| | | | | sequence AI315343, low density lipoprotein receptor-related protein 1, low density | |
| | | | | lipoprotein-related protein 1 (alpha-2-macroglobulin receptor), low density lipoprotein- | |
| | | | | related protein 2 | |
| 1943 | 912 | NM_017061 | lysyl oxidase | ESTs, Moderately similar to LYOX_HUMAN PROTEIN-LYSINE 6-OXIDASE | L |
| | | | | PRECURSOR [H. sapiens], ESTs, Moderately similar to LYOX_RAT Protein-lysine 6- | |
| | | | | oxidase precursor (Lysyl oxidase) [R. norvegicus], ESTs, Weakly similar to LYOX_RAT | |
| | | | | Protein-lysine 6-oxidase precursor (Lysyl oxidase) [R. norvegicus], lysyl oxidase, lysyl | |
| | | | | oxidase-like, lysyl oxidase-like 1, lysyl oxidase-like 2 | |
| 1946 | 912 | NM_017061 | lysyl oxidase | ESTs, Moderately similar to LYOX_HUMAN PROTEIN-LYSINE 6-OXIDASE | F |
| | | | | PRECURSOR [H. sapiens], ESTs, Moderately similar to LYOX_RAT Protein-lysine 6- | |
| | | | | oxidase precursor (Lysyl oxidase) [R. norvegicus], ESTs, Weakly similar to LYOX_RAT | |
| | | | | Protein-lysine 6-oxidase precursor (Lysyl oxidase) [R. norvegicus], lysyl oxidase, lysyl | |
| | | | | oxidase-like, lysyl oxidase-like 1, lysyl oxidase-like 2 | |
| 15242 | 964 | NM_019191 | MAD homolog 2 (Drosophila), | MAD homolog 2 (Drosophila), MAD, mothers against decapentaplegic homolog 2 | D |
| | | | MAD, mothers against | (Drosophila) | |
| | | | decapentaplegic homolog 2 | | |
| | | | (Drosophila) | | |
| 24437 | 931 | NM_017190 | malignancy-associated | CD33 antigen (gp67), ESTs, Weakly similar to MAG_RAT Myelin-associated glycoprotein | A |
| | | | protein, myelin-associated | precursor (L-MAG/S-MAG) (Brain neuron cytoplasmic protein 3) [R. norvegicus], Mus | |
| | | | glycoprotein | musculus sialic acid-binding lectin Siglec-F mRNA, complete cds, myelin-associated | |
| | | | | glycoprotein, sialic acid binding Ig-like lectin 5 | |
| 13151 | 860 | NM_012862 | matrix Gla protein, matrix | EST, Weakly similar to MGP_HUMAN MATRIX GLA-PROTEIN PRECURSOR | GENERAL |
| | | | gamma-carboxyglutamate | [H. sapiens], ESTs, Highly similar to MGP_HUMAN MATRIX GLA-PROTEIN | |
| | | | (gla) protein | PRECURSOR [H. sapiens], matrix Gla protein, matrix gamma-carboxyglutamate (gla) | |
| | | | | protein | |
| 16676 | 762 | AI639082 | MCM6 minichromosome | EST, Weakly similar to MCM5_HUMAN DNA REPLICATION LICENSING FACTOR | E |
| | | | maintenance deficient 6 (MIS5 | MCM5 [H. sapiens], ESTs, Weakly similar to MCM6_HUMAN DNA REPLICATION | |
| | | | homolog, S. pombe) (S. cerevisiae), | LICENSING FACTOR MCM6 [H. sapiens], MCM2 minichromosome maintenance | |
| | | | mini chromosome | deficient 2, mitotin (S. cerevisiae), MCM6 minichromosome maintenance deficient 6 | |
| | | | maintenance deficient 6 (S. cerevisiae) | (MIS5 homolog, S. pombe) (S. cerevisiae), mini chromosome maintenance deficient 2 (S. cerevisiae), | |
| | | | | mini chromosome maintenance deficient 5 (S. cerevisiae), mini chromosome | |
| | | | | maintenance deficient 6 (S. cerevisiae), mini chromosome maintenance deficient 7 (S. cerevisiae) | |
| 16674 | 1208 | U17565 | MCM6 minichromosome | EST, Weakly similar to MCM5_HUMAN DNA REPLICATION LICENSING FACTOR | E |
| | | | maintenance deficient 6 (MIS5 | MCM5 [H. sapiens], ESTs, Weakly similar to MCM6_HUMAN DNA REPLICATION | |
| | | | homolog, S. pombe) (S. cerevisiae), | LICENSING FACTOR MCM6 [H. sapiens], MCM2 minichromosome maintenance | |
| | | | mini chromosome | deficient 2, mitotin (S. cerevisiae), MCM6 minichromosome maintenance deficient 6 | |
| | | | maintenance deficient 6 (S. cerevisiae) | (MIS5 homolog, S. pombe) (S. cerevisiae), mini chromosome maintenance deficient 2 (S. cerevisiae), | |
| | | | | mini chromosome maintenance deficient 5 (S. cerevisiae), mini chromosome | |
| | | | | maintenance deficient 6 (S. cerevisiae), mini chromosome maintenance deficient 7 (S. cerevisiae) | |
| 16675 | 1208 | U17565 | MCM6 minichromosome | EST, Weakly similar to MCM5_HUMAN DNA REPLICATION LICENSING FACTOR | E |
| | | | maintenance deficient 6 (MIS5 | MCM5 [H. sapiens], ESTs, Weakly similar to MCM6_HUMAN DNA REPLICATION | |
| | | | homolog, S. pombe) (S. cerevisiae), | LICENSING FACTOR MCM6 [H. sapiens], MCM2 minichromosome maintenance | |
| | | | mini chromosome | deficient 2, mitotin (S. cerevisiae), MCM6 minichromosome maintenance deficient 6 | |
| | | | maintenance deficient 6 (S. cerevisiae) | (MIS5 homolog, S. pombe) (S. cerevisiae), mini chromosome maintenance deficient 2 (S. cerevisiae), | |
| | | | | mini chromosome maintenance deficient 5 (S. cerevisiae), mini chromosome | |
| | | | | maintenance deficient 6 (S. cerevisiae), mini chromosome maintenance deficient 7 (S. cerevisiae) | |
| 17933 | 1122 | NM_032615 | membrane interacting protein | | K |
| | | | of RGS16 | | |
| 5837 | 893 | NM_013143 | meprin 1 alpha, meprin A, | expressed sequence AI098089, meprin 1 alpha, meprin A, alpha (PABA peptide | GENERAL, F |
| | | | alpha (PABA peptide | hydrolase) | |
| | | | hydrolase) | | |
| 5838 | 893 | NM_013143 | meprin 1 alpha, meprin A, | expressed sequence AI098089, meprin 1 alpha, meprin A, alpha (PABA peptide | GENERAL, F, G |
| | | | alpha (PABA peptide | hydrolase) | |
| | | | hydrolase) | | |
| 17357 | 899 | NM_013183 | meprin 1 beta, meprin A, beta | EST, Weakly similar to A48040 meprin A [M. musculus], expressed sequence C87576, | GENERAL, F, G, I, L |
| | | | | meprin 1 beta, meprin A, beta | |
| 16354 | 782 | D50564 | mercaptopyruvate | ESTs, Moderately similar to THTM_RAT 3-MERCAPTOPYRUVATE | C |
| | | | sulfurtransferase | SULFURTRANSFERASE (MST) [R. norvegicus], mercaptopyruvate sulfurtransferase, | |
| | | | | thiosulfate sulfurtransferase, mitochondrial | |
| 15190 | 503 | AI102562 | metallothionein 1, | EST, Moderately similar to Cd-7 Metallothionein-2 [H. sapiens], EST, Moderately similar to | GENERAL |
| | | | metallothionein 1A (functional) | SMHU1E metallothionein 1E [H. sapiens], ESTs, Moderately similar to MT1_RAT | |
| | | | | METALLOTHIONEIN-I (MT-I) [R. norvegicus], metallothionein 1, metallothionein 4, | |
| | | | | metallothionein IV | |
| 15189 | 803 | M11794 | metallothionein 1, | EST, Moderately similar to Cd-7 Metallothionein-2 [H. sapiens], EST, Moderately similar to | B |
| | | | metallothionein 1A (functional) | SMHU1E metallothionein 1E [H. sapiens], ESTs, Moderately similar to MT1_RAT | |
| | | | | METALLOTHIONEIN-I (MT-I) [R. norvegicus], metallothionein 1, metallothionein 4, | |
| | | | | metallothionein IV | |
| 8984 | 1014 | NM_022539 | methionine aminopeptidase 2, | ESTs, Moderately similar to AMP2 MOUSE METHIONINE AMINOPEPTIDASE 2 | D |
| | | | methionyl aminopeptidase 2 | [M. musculus], methionine aminopeptidase 2, methionyl aminopeptidase 2 | |
| 9332 | 694 | AI232210 | MIC2 (monoclonal Imperial | ESTs, Weakly similar to S26689 hypothetical protein hc1 - mouse [M. musculus], MIC2 | F |
| | | | Cancer Research Fund 2)-like | like 1, expressed sequence AI893641 | |
| | | | 1, MIC2 like 1 | | |
| 15017 | 790 | J03752 | microsomal glutathione S- | | B |
| | | | transferase 1 | | |
| 13939 | 933 | NM_017212 | microtubule-associated protein | | D |
| | | | tau | | |
| 13940 | 933 | NM_017212 | microtubule-associated protein | | D |
| | | | tau | | |
| 15291 | 537 | AI111401 | multiple inositol polyphosphate | | D |
| | | | histidine phosphatase 1, | | |
| | | | multiple inositol polyphosphate | | |
| | | | histidine phosphatase, 1 | | |
| 2629 | 830 | NM_012603 | myelocytomatosis oncogene, v | myelocytomatosis oncogene, v-myc myelocytomatosis viral oncogene homolog (avian) | K |
| | | | myc myelocytomatosis viral | | |
| | | | oncogene homolog (avian) | | |
| 1698 | 906 | NM_017000 | NAD(P)H dehydrogenase, | ESTs, Weakly similar to A34162 NAD(P)H dehydrogenase (quinone) (EC 1.6.99.2) - rat | GENERAL, B, H, I |
| | | | quinone 1 | [R. norvegicus], NAD(P)H dehydrogenase, quinone 1, NAD(P)H dehydrogenase, quinone | |
| | | | | 2, NAD(P)H menadione oxidoreductase 2, dioxin inducible | |
| 3099 | 664 | AI229680 | NADH dehydrogenase | NADH dehydrogenase (ubiquinone) Fe—S protein 3 (30 kD) (NADH-coenzyme Q | E |
| | | | (ubiquinone) Fe—S protein 3 | reductase) | |
| | | | (30 kD) (NADH-coenzyme Q | | |
| | | | reductase) | | |
| 1597 | 1151 | NM_053611 | nuclear protein 1, p8 protein | EST, Weakly similar to P8_HUMAN P8 PROTEIN [H. sapiens], nuclear protein 1, p8 | L |
| | | | (candidate of metastasis 1) | protein (candidate of metastasis 1) | |
| 19712 | 994 | NM_021745 | nuclear receptor subfamily 1, | EST, Weakly similar to I38975 nuclear orphan receptor LXR-alpha [H. sapiens], ESTs, | K |
| | | | group H, member 4 | Moderately similar to JC4014 steroid hormone-nuclear receptor NER [H. sapiens], | |
| | | | | expressed sequence AI957360, nuclear receptor subfamily 1, group H, member 4 | |
| 1214 | 1102 | NM_031741 | nuclear receptor subfamily 1, | solute carrier family 2 (facilitated glucose transporter), member 5, solute carrier family 2 | GENERAL, K |
| | | | group H, member 4, solute | (facilitated glucose/fructose transporter), member 5 | |
| | | | carrier family 2 (facilitated | | |
| | | | glucose transporter), member | | |
| | | | 5, solute carrier family 2 | | |
| | | | (facilitated glucose/fructose | | |
| | | | transporter), member 5, | | |
| | | | synaptojanin 2 binding protein | | |
| 17393 | 875 | NM_012992 | nucleophosmin (nucleolar | ESTs, Highly similar to A32915 nucleophosmin [H. sapiens], nucleophosmin 1 | GENERAL |
| | | | phosphoprotein B23, | | |
| | | | numatrin), nucleophosmin 1 | | |
| 17394 | 875 | NM_012992 | nucleophosmin (nucleolar | ESTs, Highly similar to A32915 nucleophosmin [H. sapiens], nucleophosmin 1 | GENERAL, L |
| | | | phosphoprotein B23, | | |
| | | | numatrin), nucleophosmin 1 | | |
| 1401 | 1152 | NM_053616 | nucleoporin 88 kD, | nucleoporin 88 kD, preimplantation protein 2 | J |
| | | | preimplantation protein 2 | | |
| 16006 | 344 | AF062594 | nucleosome assembly protein | ESTs, Highly similar to 2008109A set gene [Rattus norvegicus] [R. norvegicus], ESTs, | GENERAL |
| | | | 1-like 1 | Highly similar to SET_HUMAN SET PROTEIN [H. sapiens], SET translocation, SET | |
| | | | | translocation (myeloid leukemia-associated), nucleosome assembly protein 1-like 1 | |
| 16007 | 344 | AF062594 | nucleosome assembly protein | ESTs, Highly similar to 2008109A set gene [Rattus norvegicus] [R. norvegicus], ESTs, | E |
| | | | 1-like 1 | Highly similar to SET_HUMAN SET PROTEIN [H. sapiens], SET translocation, SET | |
| | | | | translocation (myeloid leukemia-associated), nucleosome assembly protein 1-like 1 | |
| 7665 | 429 | AI030668 | nucleosome assembly protein | ESTs, Highly similar to 2008109A set gene [Rattus norvegicus] [R. norvegicus], ESTs, | E |
| | | | 1-like 1 | Highly similar to SET_HUMAN SET PROTEIN [H. sapiens], SET translocation, SET | |
| | | | | translocation (myeloid leukemia-associated), nucleosome assembly protein 1-like 1 | |
| 24264 | 876 | NM_012999 | paired basic amino acid | EST, Highly similar to I53282 gene PACE4 protein - rat [R. norvegicus], RIKEN cDNA | GENERAL |
| | | | cleaving system 4, proprotein | A930029K19 gene, paired basic amino acid cleaving system 4, proprotein convertase | |
| | | | convertase subtilisin/kexin | subtilisin/kexin type 6 | |
| | | | type 6 | | |
| 1581 | 955 | NM_017365 | PDZ and LIM domain 1 (elfin) | EST, Moderately similar to CL36_HUMAN LIM DOMAIN PROTEIN CLP-36 [H. sapiens], | GENERAL, A, C |
| | | | | ESTs, Weakly similar to PDL1_RAT PDZ and LIM domain protein 1 (LIM domain protein | |
| | | | | CLP-36) (C-terminal LIM domain protein 1) (Elfin) [R. norvegicus], Mus musculus, clone | |
| | | | | MGC: 37634 IMAGE: 4990983, mRNA, complete cds, PDZ and LIM domain 1 (elfin), PDZ | |
| | | | | and LIM domain 3, Rattus norvegicus LIM-domain protein LMP-1 mRNA, complete cds, | |
| | | | | actinin alpha 2 associated LIM protein | |
| 1081 | 1097 | NM_031712 | PDZ domain containing 1 | ESTs, Highly similar to PDZ domain containing-protein [H. sapiens], PDZ domain | GENERAL, D |
| | | | | containing 1, natrium-phosphate cotransporter IIa C-terminal-associated protein 2, | |
| | | | | pleckstrin homology, Sec7 and coiled/coil domains, binding protein | |
| 19998 | 1125 | NM_033352 | PDZ domain containing 1 | ESTs, Highly similar to PDZ domain containing-protein [H. sapiens], PDZ domain | GENERAL |
| | | | | containing 1, natrium-phosphate cotransporter IIa C-terminal-associated protein 2, | |
| | | | | pleckstrin homology, Sec7 and coiled/coil domains, binding protein | |
| 1650 | 34 | AA817825 | peptidylglycine alpha- | ESTs, Weakly similar to AMD MOUSE PEPTIDYL-GLYCINE ALPHA-AMIDATING | A |
| | | | amidating monooxygenase | MONOOXYGENASE PRECURSOR [M. musculus], peptidylglycine alpha-amidating | |
| | | | | monooxygenase | |
| 1644 | 121 | AA891068 | peptidylglycine alpha- | ESTs, Weakly similar to AMD MOUSE PEPTIDYL-GLYCINE ALPHA-AMIDATING | A, F |
| | | | amidating monooxygenase | MONOOXYGENASE PRECURSOR [M. musculus], peptidylglycine alpha-amidating | |
| | | | | monooxygenase | |
| 1649 | 518 | AI103782 | peptidylglycine alpha- | ESTs, Weakly similar to AMD MOUSE PEPTIDYL-GLYCINE ALPHA-AMIDATING | F |
| | | | amidating monooxygenase | MONOOXYGENASE PRECURSOR [M. musculus], peptidylglycine alpha-amidating | |
| | | | | monooxygenase | |
| 1651 | 651 | AI228068 | peptidylglycine alpha- | ESTs, Weakly similar to AMD MOUSE PEPTIDYL-GLYCINE ALPHA-AMIDATING | A, H |
| | | | amidating monooxygenase | MONOOXYGENASE PRECURSOR [M. musculus], peptidylglycine alpha-amidating | |
| | | | | monooxygenase | |
| 1652 | 665 | AI229728 | peptidylglycine alpha- | ESTs, Weakly similar to AMD MOUSE PEPTIDYL-GLYCINE ALPHA-AMIDATING | A |
| | | | amidating monooxygenase | MONOOXYGENASE PRECURSOR [M. musculus], peptidylglycine alpha-amidating | |
| | | | | monooxygenase | |
| 1653 | 719 | AI233806 | peptidylglycine alpha- | ESTs, Weakly similar to AMD MOUSE PEPTIDYL-GLYCINE ALPHA-AMIDATING | A |
| | | | amidating monooxygenase | MONOOXYGENASE PRECURSOR [M. musculus], peptidylglycine alpha-amidating | |
| | | | | monooxygenase | |
| 4392 | 918 | NM_017101 | peptidylprolyl isomerase A, | EST, Moderately similar to A Chain A, Cyclophilin A [H. sapiens], ESTs, Highly similar to | H |
| | | | peptidylprolyl isomerase A | CYPH MOUSE PEPTIDYL-PROLYL CIS-TRANS ISOMERASE A [M. musculus], ESTs, | |
| | | | (cyclophilin A) | Moderately similar to A Chain A, Human Cyclophilin A Complexed With 2-Thr Cyclosporin | |
| | | | | [H. sapiens], ESTs, Weakly similar to A Chain A, Cyclophilin A [H. sapiens], ESTs, Weakly | |
| | | | | similar to A Chain A, Human Cyclophilin A Complexed With 2-Thr Cyclosporin | |
| | | | | [H. sapiens], ESTs, Weakly similar to CYPH_RAT Peptidyl-prolyl cis-trans isomerase A | |
| | | | | (PPlase) (Rotamase) (Cyclophilin A) (Cyclosporin A-binding protein) (P31) | |
| | | | | [R. norvegicus], RIKEN cDNA 2510026K04 gene, expressed sequence AI256741, | |
| | | | | expressed sequence AW457192 peptidylprolyl isomerase A | |
| 405 | 1081 | NM_031587 | peroxisomal membrane | ESTs, Weakly similar to MPV1 MOUSE MPV17 PROTEIN [M. musculus], MpV17 | GENERAL, H, K |
| | | | protein 2 (22 kD), peroxisomal | transgene, murine homolog, glomerulosclerosis, Mpv17 transgene, kidney disease | |
| | | | membrane protein 2, 22 kDa | mutant, peroxisomal membrane protein 2, 22 kDa | |
| 6055 | 831 | NM_012619 | phenylalanine hydroxylase | ESTs, Highly similar to WHHUF phenylalanine 4-monooxygenase [H. sapiens], | GENERAL, D |
| | | | | phenylalanine hydroxylase | |
| 15599 | 938 | NM_017236 | phosphatidylethanolamine | Homo sapiens, clone MGC: 22776 IMAGE: 4700840, mRNA, complete cds, RIKEN cDNA | J |
| | | | binding protein, prostatic | 1700023A18 gene, RIKEN cDNA 1700081D17 gene, phosphatidylethanolamine binding | |
| | | | binding protein | protein, prostatic binding protein | |
| 1340 | 1098 | NM_031715 | phosphofructokinase, muscle | ESTs, Highly similar to phosphofructokinase, muscle; phosphofructokinase-1 A isozyme | B |
| | | | | [Mus musculus] [M. musculus], expressed sequence AI131669, phosphofructokinase, | |
| | | | | muscle | |
| 25377 | 800 | L25387 | phosphofructokinase, platelet | | D |
| 1312 | 1130 | NM_053291 | phosphoglycerate kinase 1 | ESTs, Highly similar to A33792 phosphoglycerate kinase (EC 2.7.2.3) - rat | J |
| | | | | [R. norvegicus], phosphoglycerate kinase 1, phosphoglycerate kinase 2 | |
| 20414 | 799 | L14323 | phospholipase C, beta 1, | | GENERAL |
| | | | phospholipase C, beta 1 | | |
| | | | (phosphoinositide-specific) | | |
| 1535 | 331 | AB000778 | phospholipase D1, | EST, Highly similar to PLD1_MOUSE PHOSPHOLIPASE D1 (PLD 1) (CHOLINE | F |
| | | | phospholipase D1, | PHOSPHATASE 1) (PHOSPHATIDYLCHOLINE-HYDROLYZING PHOSPHOLIPASE D1) | |
| | | | phophatidylcholine-specific | [M. musculus], phospholipase D1, phophatidylcholine-specific | |
| 24582 | 939 | NM_017243 | phosphoribosyl pyrophosphate | Mus musculus, phosphoribosyl pyrophosphate synthetase-associated protein 2, clone | D |
| | | | synthetase 1 | MGC: 36957 IMAGE: 4947226, mRNA, complete cds, RIKEN cDNA 5730409F23 gene, | |
| | | | | expressed sequence C76678, phosphoribosyl pyrophosphate synthetase 1 | |
| 1847 | 834 | NM_012634 | phosphoribosyl pyrophosphate | RIKEN cDNA 2610101M19 gene, phosphoribosyl pyrophosphate synthetase 2 | B |
| | | | synthetase 2 | | |
| 13369 | 1157 | NM_053742 | phosphotidylinositol transfer | ESTs, Highly similar to PPI2_HUMAN PHOSPHATIDYLINOSITOL TRANSFER | D |
| | | | protein, beta | PROTEIN BETA ISOFORM [H. sapiens], phosphotidylinositol transfer protein, beta | |
| 20298 | 981 | NM_019374 | prodynorphin | | I |
| 24566 | 833 | NM_012630 | prolactin receptor | prolactin receptor, prolactin receptor related sequence 1 | B, F, L |
| 24567 | 833 | NM_012630 | prolactin receptor | prolactin receptor, prolactin receptor related sequence 1 | F |
| 24568 | 833 | NM_012630 | prolactin receptor | prolactin receptor, prolactin receptor related sequence 1 | GENERAL, B |
| 11454 | 1004 | NM_022381 | proliferating cell nuclear | proliferating cell nuclear antigen | GENERAL |
| | | | antigen | | |
| 11455 | 1004 | NM_022381 | proliferating cell nuclear | proliferating cell nuclear antigen | GENERAL |
| | | | antigen | | |
| 503 | 841 | NM_012704 | prostaglandin E receptor 3 | | C |
| | | | (subtype EP3) | | |
| 15470 | 1116 | NM_031978 | proteasome (prosome, | proteasome (prosome, macropain) 26S subunit, non-ATPase, 1, proteasome (prosome, | H |
| | | | macropain) 26S subunit, non- | macropain) 26S subunit, non-ATPase, 2 | |
| | | | ATPase, 1 | | |
| 18750 | 940 | NM_017257 | proteasome (prosome, | expressed sequence AA589371, expressed sequence AI788882, proteasome (prosome, | G |
| | | | macropain) 28 subunit, beta, | macropain) 28 subunit, beta, proteasome (prosome, macropain) activator subunit 2 | |
| | | | proteasome (prosome, | (PA28 beta) | |
| | | | macropain) activator subunit 2 | | |
| | | | (PA28 beta) | | |
| 18751 | 940 | NM_017257 | proteasome (prosome, | expressed sequence AA589371, expressed sequence AI788882, proteasome (prosome, | G |
| | | | macropain) 28 subunit, beta, | macropain) 28 subunit, beta, proteasome (prosome, macropain) activator subunit 2 | |
| | | | proteasome (prosome, | (PA28 beta) | |
| | | | macropain) activator subunit 2 | | |
| | | | (PA28 beta) | | |
| 3987 | 943 | NM_017280 | proteasome (prosome, | EST, Weakly similar to SNHUC8 multicatalytic endopeptidase complex [H. sapiens], | GENERAL |
| | | | macropain) subunit, alpha type | ESTs, Highly similar to PRC8 MOUSE PROTEASOME COMPONENT C8 [M. musculus], | |
| | | | 3, proteasome (prosome, | ESTs, Weakly similar to PRC8 MOUSE PROTEASOME COMPONENT C8 [M. musculus], | |
| | | | macropain) subunit, alpha | proteasome (prosome, macropain) subunit, alpha type 3, proteasome (prosome, | |
| | | | type, 3 | macropain) subunit, alpha type, 3 | |
| 1447 | 944 | NM_017281 | proteasome (prosome, | EST, Moderately similar to PRC9_HUMAN PROTEASOME COMPONENT C9 | D |
| | | | macropain) subunit, alpha type | [H. sapiens], proteasome (prosome, macropain) subunit, alpha type 4, proteasome | |
| | | | 4, proteasome (prosome, | (prosome, macropain) subunit, alpha type, 4 | |
| | | | macropain) subunit, alpha | | |
| | | | type, 4 | | |
| 3254 | 945 | NM_017282 | proteasome (prosome, | proteasome (prosome, macropain) subunit, alpha type 5, proteasome (prosome, | L |
| | | | macropain) subunit, alpha type | macropain) subunit, alpha type, 5 | |
| | | | 5, proteasome (prosome, | | |
| | | | macropain) subunit, alpha | | |
| | | | type, 5 | | |
| 15535 | 946 | NM_017283 | proteasome (prosome, | ESTs, Highly similar to S30274 multicatalytic endopeptidase complex [H. sapiens], ESTs, | L |
| | | | macropain) subunit, alpha type | Weakly similar to JX0230 multicatalytic endopeptidase complex (EC 3.4.99.46) iota chain - | |
| | | | 6, proteasome (prosome, | rat [R. norvegicus], proteasome (prosome, macropain) subunit, alpha type 6 | |
| | | | macropain) subunit, alpha | | |
| | | | type, 6 | | |
| 15538 | 946 | NM_017283 | proteasome (prosome, | ESTs, Highly similar to S30274 multicatalytic endopeptidase complex [H. sapiens], ESTs, | L |
| | | | macropain) subunit, alpha type | Weakly similar to JX0230 multicatalytic endopeptidase complex (EC 3.4.99.46) iota chain - | |
| | | | 6, proteasome (prosome, | rat [R. norvegicus], proteasome (prosome, macropain) subunit, alpha type 6 | |
| | | | macropain) subunit, alpha | | |
| | | | type, 6 | | |
| 25253 | 1173 | NM_057099 | proteasome (prosome, | proteasome (prosome, macropain) subunit, beta type 6, proteasome (prosome, | H |
| | | | macropain) subunit, beta type | macropain) subunit, beta type, 6 | |
| | | | 6, proteasome (prosome, | | |
| | | | macropain) subunit, beta type, 6 | | |
| 556 | 851 | NM_012803 | protein C, protein C | B-factor, properdin, ESTs, Weakly similar to S18994 protein C (activated) (EC 3.4.21.69) | GENERAL |
| | | | (inactivator of coagulation | precursor - rat [R. norvegicus], histocompatibility 2, complement component factor B, | |
| | | | factors Va and VIIIa) | protein C, protein C (inactivator of coagulation factors Va and VIIIa) | |
| 24563 | 1026 | NM_022676 | protein phosphatase 1, | EST, Weakly similar to IPP1_HUMAN PROTEIN PHOSPHATASE INHIBITOR 1 | G, K |
| | | | regulatory (inhibitor) subunit | [H. sapiens], ESTs, Moderately similar to PROTEIN PHOSPHATASE INHIBITOR 1 | |
| | | | 1A | [R. norvegicus], Mus musculus, clone MGC: 18770 IMAGE: 4164563, mRNA, complete | |
| | | | | cds, RIKEN cDNA 4930565M23 gene, protein phosphatase 1 regulatory subunit 1A, | |
| | | | | protein phosphatase 1, regulatory (inhibitor) subunit 1A | |
| 24564 | 1026 | NM_022676 | protein phosphatase 1 | EST, Weakly similar to IPP1_HUMAN PROTEIN PHOSPHATASE INHIBITOR 1 | G, K |
| | | | regulatory (inhibitor) subunit | [H. sapiens], ESTs, Moderately similar to PROTEIN PHOSPHATASE INHIBITOR 1 | |
| | | | 1A | [R. norvegicus], Mus musculus, clone MGC: 18770 IMAGE: 4164563, mRNA, complete | |
| | | | | cds, RIKEN cDNA 4930565M23 gene, protein phosphatase 1 regulatory subunit 1A, | |
| | | | | protein phosphatase 1, regulatory (inhibitor) subunit 1A | |
| 24219 | 1079 | NM_031579 | protein tyrosine phosphatase | protein tyrosine phosphatase 4a1, protein tyrosine phosphatase 4a3, protein tyrosine | GENERAL, L |
| | | | 4a1, protein tyrosine | phosphatase type IVA, member 1, protein tyrosine phosphatase type IVA, member 3 | |
| | | | phosphatase type IVA, | | |
| | | | member 1 | | |
| 1844 | 835 | NM_012637 | protein tyrosine phosphatase, | EST, Moderately similar to A34845 protein-tyrosine-phosphatase (EC 3.1.3.48), | J |
| | | | non-receptor type 1 | nonreceptor type 1B - rat [R. norvegicus], ESTs, Moderately similar to PTN1_HUMAN | |
| | | | | PROTEIN-TYROSINE PHOSPHATASE, NON-RECEPTOR TYPE 1 [H. sapiens], protein | |
| | | | | tyrosine phosphatase, non-receptor type 1 | |
| 14978 | 622 | AI177386 | protein tyrosine phosphatase, | ESTs, Weakly similar to 2103274A receptor type protein Tyr phosphatase [M. musculus], | F |
| | | | receptor type, D | RIKEN cDNA 1600019O04 gene, expressed sequence AU040377, protein tyrosine | |
| | | | | phosphatase, receptor type, S | |
| 245 | 952 | NM_017336 | protein tyrosine phosphatase, | | J |
| | | | receptor type, O | | |
| 247 | 952 | NM_017336 | protein tyrosine phosphatase, | | J |
| | | | receptor type, O | | |
| 1929 | 1045 | NM_030872 | pyruvate dehydrogenase 2, | Mus musculus, Similar to pyruvate dehydrogenase kinase, isoenzyme 1, clone | A, C, D, E |
| | | | pyruvate dehydrogenase | MGC: 28719 IMAGE: 4458562, mRNA, complete cds, Mus musculus, Similar to pyruvate | |
| | | | kinase, isoenzyme 2 | dehydrogenase kinase, isoenzyme 3, clone MGC: 6383 IMAGE: 3500763, mRNA, | |
| | | | | complete cds, pyruvate dehydrogenase 2, pyruvate dehydrogenase kinase, isoenzyme 2 | |
| 20831 | 1147 | NM_053589 | RAB14, member RAS | EST, Highly similar to GTPase Rab14 [Rattus norvegicus] [R. norvegicus], ESTs, Highly | B |
| | | | oncogene family | similar to F34323 GTP-binding protein Rab5 [H. sapiens], ESTs, Highly similar to | |
| | | | | RB14_HUMAN RAS-RELATED PROTEIN RAB-14 [R. norvegicus], ESTs, Weakly similar | |
| | | | | to RB14_HUMAN Ras-related protein Rab-14 [R. norvegicus], Mus musculus Rab-related | |
| | | | | GTP-binding protein (Rabj) mRNA, complete cds, RAB14, member RAS oncogene family | |
| 6577 | 1011 | NM_022532 | raf-related oncogene, v-raf | Mus musculus adult male lung cDNA, RIKEN full-length enriched library, | F |
| | | | murine sarcoma 3611 viral | clone: 1200013E08:raf-related oncogene, full insert sequence, expressed sequence | |
| | | | oncogene homolog 1 | AW495444, raf-related oncogene, v-raf murine sarcoma 3611 viral oncogene homolog 1 | |
| 4661 | 207 | AA899709 | receptor (calcitonin) activity | receptor (calcitonin) activity modifying protein 3 | GENERAL, B, L |
| | | | modifying protein 3 | | |
| 28 | 1077 | NM_031546 | regucalcin, regucalcin | regucalcin, regucalcin (senescence marker protein-30) | GENERAL, F, G, I, J, L |
| | | | (senescence marker protein- | | |
| | | | 30) | | |
| 23806 | 842 | NM_012733 | retinol binding protein 1, | ESTs, Weakly similar to RET1_RAT Retinol-binding protein I, cellular (Cellular retinol- | D |
| | | | cellular | binding protein) (CRBP) [R. norvegicus], retinoid binding protein 7, retinol binding protein | |
| | | | | 1, cellular, retinol binding protein 5, cellular, retinol binding protein 7, cellular | |
| 21575 | 1093 | NM_031698 | ribophorin II | EST, Moderately similar to RIB2_HUMAN DOLICHYL- | J |
| | | | | DIPHOSPHOOLIGOSACCHARIDE-PROTEIN GLYCOSYLTRANSFERASE 63 KDA | |
| | | | | SUBUNIT PRECURSOR [H. sapiens], ESTs, Moderately similar to RIB2_HUMAN | |
| | | | | DOLICHYL-DIPHOSPHOOLIGOSACCHARIDE-PROTEIN GLYCOSYLTRANSFERASE | |
| | | | | 63 KDA SUBUNIT PRECURSOR [H. sapiens], ribophorin 2, related sequence 1, | |
| | | | | ribophorin II | |
| 11849 | 1052 | NM_031065 | ribosomal protein L10A, | EST, Moderately similar to R10A MOUSE 60S RIBOSOMAL PROTEIN L10A | GENERAL, G |
| | | | ribosomal protein L10a | [M. musculus], ribosomal protein L10A, ribosomal protein L10a | |
| 19112 | 764 | AI639157 | ribosomal protein L13 | EST, Moderately similar to JC2368 ribosomal protein L13, cytosolic [validated] - rat | J |
| | | | | [R. norvegicus], EST, Weakly similar to JC2368 ribosomal protein L13, cytosolic | |
| | | | | [validated] - rat [R. norvegicus], ESTs, Highly similar to ribosomal protein L13; 60S | |
| | | | | ribosomal protein L13; breast basic conserved protein 1 [Homo sapiens] [H. sapiens], | |
| | | | | ESTs, Moderately similar to RL13 MOUSE 60S RIBOSOMAL PROTEIN L13 | |
| | | | | [M. musculus], Homo sapiens cDNA FLJ30941 fis, clone FEBRA2007458, Human RPL13- | |
| | | | | 2 pseudogene mRNA complete cds ribosomal protein L13 | |
| 23854 | 1054 | NM_031101 | ribosomal protein L13 | EST, Moderately similar to JC2368 ribosomal protein L13, cytosolic [validated] - rat | G |
| | | | | [R. norvegicus], EST, Weakly similar to JC2368 ribosomal protein L13, cytosolic | |
| | | | | [validated] - rat [R. norvegicus], ESTs, Highly similar to ribosomal protein L13; 60S | |
| | | | | ribosomal protein L13; breast basic conserved protein 1 [Homo sapiens] [H. sapiens], | |
| | | | | ESTs, Moderately similar to RL13 MOUSE 60S RIBOSOMAL PROTEIN L13 | |
| | | | | [M. musculus], Homo sapiens cDNA FLJ30941 fis, clone FEBRA2007458, Human RPL13- | |
| | | | | 2 pseudogene mRNA. complete cds ribosomal protein L13 | |
| 14929 | 1134 | NM_053330 | ribosomal protein L21 | EST, Moderately similar to 2113200B ribosomal protein L21 [H. sapiens], EST, | GENERAL, G, K |
| | | | | Moderately similar to RL21_RAT 60S RIBOSOMAL PROTEIN L21 [R. norvegicus], EST, | |
| | | | | Weakly similar to 2113200B ribosomal protein L21 [H. sapiens], EST, Weakly similar to | |
| | | | | RL21 MOUSE 60S RIBOSOMAL PROTEIN L21 [M. musculus], EST, Weakly similar to | |
| | | | | RL21_HUMAN 60S RIBOSOMAL PROTEIN L21 [H. sapiens], ESTs, Highly similar to | |
| | | | | 2113200B ribosomal protein L21 [H. sapiens], ESTs, Highly similar to RL21 MOUSE 60S | |
| | | | | RIBOSOMAL PROTEIN L21 [M. musculus], ESTs, Moderately similar to RL21 MOUSE | |
| | | | | 60S RIBOSOMAL PROTEIN L21 [M. musculus], ribosomal protein L21 | |
| 19268 | 1055 | NM_031104 | ribosomal protein L22 | ESTs, Highly similar to 60S RIBOSOMAL PROTEIN L22 [H. sapiens], RIKEN cDNA | D |
| | | | | 2700038K18 gene, RIKEN cDNA 3110001N18 gene, ribosomal protein L22 | |
| 18612 | 658 | AI228624 | ribosomal protein L29 | EST, Moderately similar to RL29_HUMAN 60S RIBOSOMAL PROTEIN L29 [H. sapiens], | G |
| | | | | EST, Moderately similar to RL29_RAT 60S RIBOSOMAL PROTEIN L29 (P23) | |
| | | | | [R. norvegicus], ESTs, Highly similar to S65784 ribosomal protein L29, cytosolic | |
| | | | | [H. sapiens], ribosomal protein L29 | |
| 25718 | 1248 | X62145 | ribosomal protein L8 | | GENERAL, G |
| 24615 | 1057 | NM_031112 | ribosomal protein S24 | EST, Weakly similar to JH0213 ribosomal protein S24, cytosolic [H. sapiens], EST, | D |
| | | | | Weakly similar to RS24_HUMAN 40S RIBOSOMAL PROTEIN S24 [M. musculus], ESTs, | |
| | | | | Highly similar to JH0213 ribosomal protein S24, cytosolic [H. sapiens], ribosomal protein | |
| | | | | S24 | |
| 25686 | 1237 | X51536 | ribosomal protein S3 | | F |
| 25702 | 1244 | X58465 | ribosomal protein S5 | EST, Moderately similar to 2113200E ribosomal protein S5 [H. sapiens], EST, Weakly | G |
| | | | | similar to 2113200E ribosomal protein S5 [H. sapiens], ribosomal protein S5 | |
| 10109 | 1244 | X58465 | ribosomal protein S5 | EST, Moderately similar to 2113200E ribosomal protein S5 [H. sapiens], EST, Weakly | G |
| | | | | similar to 2113200E ribosomal protein S5 [H. sapiens], ribosomal protein S5 | |
| 17104 | 924 | NM_017160 | ribosomal protein S6 | EST, Moderately similar to R3HU6 ribosomal protein S6, cytosolic [H. sapiens], EST, | GENERAL, G |
| | | | | Moderately similar to RS6_HUMAN 40S RIBOSOMAL PROTEIN S6 [H. sapiens], EST, | |
| | | | | Weakly similar to R3HU6 ribosomal protein S6, cytosolic [H. sapiens], ESTs, Highly | |
| | | | | similar to RS6_HUMAN 40S RIBOSOMAL PROTEIN S6 [H. sapiens], ESTs, Weakly | |
| | | | | similar to RS6_HUMAN 40S RIBOSOMAL PROTEIN S6 [H. sapiens], ribosomal protein | |
| | | | | S6 | |
| 16204 | 1096 | NM_031706 | ribosomal protein S8 | EST, Weakly similar to 40S RIBOSOMAL PROTEIN S8 [M. musculus], ESTs, Highly | GENERAL, G |
| | | | | similar to S25022 ribosomal protein S8, cytosolic [H. sapiens], ESTs, Moderately similar | |
| | | | | to RS8_HUMAN 40S RIBOSOMAL PROTEIN S [H. sapiens], RIKEN cDNA 1110008P08 | |
| | | | | gene, ribosomal protein S8 | |
| 16205 | 1096 | NM_031706 | ribosomal protein S8 | EST, Weakly similar to 40S RIBOSOMAL PROTEIN S8 [M. musculus], ESTs, Highly | F |
| | | | | similar to S25022 ribosomal protein S8, cytosolic [H. sapiens], ESTs, Moderately similar | |
| | | | | to RS8_HUMAN 40S RIBOSOMAL PROTEIN S [H. sapiens], RIKEN cDNA 1110008P08 | |
| | | | | gene, ribosomal protein S8 | |
| 1382 | 332 | AB002406 | RuvB-like 1 (E. coli), RuvB-like | Homer, neuronal immediate early gene, 1B, homer, neuronal immediate early gene, 1 | G |
| | | | protein 1 | | |
| 19040 | 1058 | NM_031114 | S100 calcium binding protein | EST, Moderately similar to S110_RAT Calpactin I light chain (P10 protein) (P11) (Cellular | GENERAL, C, G, K |
| | | | A10 (annexin II ligand, | ligand of annexin II) (Nerve growth factor induced protein 42C) [R. norvegicus], S100 | |
| | | | calpactin I, light polypeptide | calcium binding protein A10 (annexin II ligand, calpactin I, light polypeptide (p11)), S100 | |
| | | | (p11)), S100 calcium binding | calcium binding protein A10 (calpactin) | |
| | | | protein A10 (calpactin) | | |
| 16394 | 1140 | NM_053485 | S100 calcium binding protein | | K |
| | | | A6 (calcyclin) | | |
| 16318 | 678 | AI230724 | SAC1 (supressor of actin | | GENERAL, I |
| | | | mutations 1, homolog)-like (S. cerevisiae), | | |
| | | | SAC1 suppressor | | |
| | | | of actin mutations 1-like | | |
| | | | (yeast) | | |
| 23651 | 862 | NM_012881 | secreted phosphoprotein 1, | | GENERAL, G, K |
| | | | secreted phosphoprotein 1 | | |
| | | | (osteopontin, bone sialoprotein | | |
| | | | I, early T-lymphocyte | | |
| | | | activation 1) | | |
| 4280 | 672 | AI230247 | selenoprotein P, plasma, 1 | selenoprotein P, plasma, 1 | F |
| 21400 | 811 | M36410 | sepiapterin reductase, | ESTs, Highly similar to A36024 sepiapterin reductase (EC 1.1.1.153) - rat [R. norvegicus], | C, F |
| | | | sepiapterin reductase (7,8- | sepiapterin reductase, sepiapterin reductase (7,8-dihydrobiopterin: NADP+ | |
| | | | dihydrobiopterin: NADP+ | oxidoreductase) | |
| | | | oxidoreductase) | | |
| 15540 | 832 | NM_012620 | serine (or cysteine) proteinase | | K |
| | | | inhibitor, clade E (nexin, | | |
| | | | plasminogen activator inhibitor | | |
| | | | type 1), member 1 | | |
| 17301 | 926 | NM_017173 | serine (or cysteine) proteinase | serine (or cysteine) proteinase inhibitor, clade H (heat shock protein 47), member 1, | E, I |
| | | | inhibitor, clade H (heat shock | serine (or cysteine) proteinase inhibitor, clade H (heat shock protein 47), member 1, | |
| | | | protein 47), member 1, serine | (collagen binding protein 1), serine (or cysteine) proteinase inhibitor, clade H (heat shock | |
| | | | (or cysteine) proteinase | protein 47), member 2 | |
| | | | inhibitor, clade H (heat shock | | |
| | | | protein 47), member 1, | | |
| | | | (collagen binding protein 1) | | |
| 20449 | 1074 | NM_031530 | small inducible cytokine A2, | EST, Weakly similar to S07723 immediate-early serum-responsive protein JE precursor - | GENERAL |
| | | | small inducible cytokine A2 | rat [R. norvegicus], expressed sequence AI323594, small inducible cytokine A2, small | |
| | | | (monocyte chemotactic protein | inducible cytokine A24, small inducible cytokine subfamily A (Cys—Cys), member 24 | |
| | | | 1) | | |
| 21145 | 339 | AF038571 | solute carrier family 1 | ESTs, Weakly similar to EAA3_RAT Excitatory amino acid transporter 3 (Sodium- | GENERAL, B |
| | | | (neuronal/epithelial high | dependent glutamate/aspartate transporter 3) (Excitatory amino-acid carrier 1) | |
| | | | affinity glutamate transporter, | [R. norvegicus], Mus musculus adult male testis cDNA, RIKEN full-length enriched library, | |
| | | | system Xag), member 1, | clone: 4931413K05:solute carrier family 1, member 1, full insert sequence, Rattus | |
| | | | solute carrier family 1, | norvegicus mRNA for sodium-dependent neutral amino acid transporter, ASCT2, solute | |
| | | | member 1 | carrier family 1 (neuronal/epithelial high affinity glutamate transporter, system Xag), | |
| | | | | member 1, solute carrier family 1, member 1, solute carrier family 1, member 7 | |
| 21147 | 784 | D63772 | solute carrier family 1 | ESTs, Weakly similar to EAA3_RAT Excitatory amino acid transporter 3 (Sodium- | GENERAL, F, H, I, J, L |
| | | | (neuronal/epithelial high | dependent glutamate/aspartate transporter 3) (Excitatory amino-acid carrier 1) | |
| | | | affinity glutamate transporter, | [R. norvegicus], Mus musculus adult male testis cDNA, RIKEN full-length enriched library, | |
| | | | system Xag), member 1, | clone: 4931413K05:solute carrier family 1, member 1, full insert sequence, Rattus | |
| | | | solute carrier family 1, | norvegicus mRNA for sodium-dependent neutral amino acid transporter, ASCT2, solute | |
| | | | member 1 | carrier family 1 (neuronal/epithelial high affinity glutamate transporter, system Xag), | |
| | | | | member 1, solute carrier family 1, member 1, solute carrier family 1, member 7 | |
| 645 | 977 | NM_019345 | solute carrier family 12 | ESTs, Moderately similar to Na+/K+/Cl−-cotransport protein renal splice form F | G, K |
| | | | (sodium/chloride transporters), | [M. musculus], solute carrier family 12 (sodium/chloride transporters), member 3, solute | |
| | | | member 3, solute carrier | carrier family 12, member 3 | |
| | | | family 12, member 3 | | |
| 646 | 977 | NM_019345 | solute carrier family 12 | ESTs, Moderately similar to Na+/K+/Cl−-cotransport protein renal splice form F | G, K |
| | | | (sodium/chloride transporters), | [M. musculus], solute carrier family 12 (sodium/chloride transporters), member 3, solute | |
| | | | member 3, solute carrier | carrier family 12, member 3 | |
| | | | family 12, member 3 | | |
| 4532 | 958 | NM_019134 | solute carrier family 12 | EST, Weakly similar to NKC2_HUMAN BUMETANIDE-SENSITIVE SODIUM- | J |
| | | | (sodium/potassium/chloride | (POTASSIUM)-CHLORIDE COTRANSPORTER 2 (KIDNEY-SPECIFIC NA-K-CL | |
| | | | transporters), member 1, | SYMPORTER) [H. sapiens], ESTs, Moderately similar to Na+/K+/Cl−-cotransport protein | |
| | | | solute carrier family 12, | renal splice form F [M. musculus], solute carrier family 12 (potassium/chloride | |
| | | | member 1 | transporters), member 8, solute carrier family 12 (sodium/potassium/chloride | |
| | | | | transporters), member 1, solute carrier family 12, member 1 | |
| 235 | 978 | NM_019347 | solute carrier family 14 (urea | solute carrier family 14 (urea transporter), member 2 | C |
| | | | transporter), member 2 | | |
| 15039 | 1090 | NM_031672 | solute carrier family 15 | | GENERAL, F, I |
| | | | (H+/peptide transporter), | | |
| | | | member 2 | | |
| 24770 | 919 | NM_017111 | solute carrier family 21 | solute carrier family 21 (organic anion transporter), member 1, solute carrier family 21 | GENERAL, G, I, J |
| | | | (organic anion transporter), | (organic anion transporter), member 12, solute carrier family 21 (organic anion | |
| | | | member 1 | transporter), member 3, solute carrier family 21 (organic anion transporter), member 6 | |
| 1510 | 937 | NM_017224 | solute carrier family 22 | Homo sapiens, Similar to ust3, clone MGC: 23972 IMAGE: 4714598, mRNA, complete | GENERAL, D, K |
| | | | (organic anion transporter), | cds, Mus musculus, Similar to solute carrier family 22 (organic anion transporter), | |
| | | | member 6 | member 7, clone MGC: 18877 IMAGE: 4236556, mRNA, complete cds, Rattus norvegicus | |
| | | | | mRNA for organic anion transporter 5, complete cds, expressed sequence AI648912, | |
| | | | | putative integral membrane transport UST1r, solute carrier family 22 (organic anion | |
| | | | | transporter), member 6, solute carrier family 22 (organic cation transporter)-like 2, ust3 | |
| 770 | 1080 | NM_031584 | solute carrier family 22 | Mus musculus, clone MGC: 29260 IMAGE: 5064542, mRNA, complete cds, SV2 related | GENERAL |
| | | | (organic cation transporter), | protein, solute carrier family 22 (organic cation transporter), member 2 | |
| | | | member 2 | | |
| 23625 | 969 | NM_019269 | solute carrier family 22 | ESTs, Weakly similar to solute carrier family 22 (organic cation transporter), member 5; | D |
| | | | (organic cation transporter), | Lstp-like [Mus musculus] [M. musculus], ESTs, Weakly similar to OCN2 MOUSE | |
| | | | member 5 | ORGANIC CATION/CARNITINE TRANSPORTER 2 [M. musculus], Homo sapiens | |
| | | | | OAT4L mRNA for organic anion transpoter 4 like protein, complete cds, Mus musculus, | |
| | | | | Similar to solute carrier family 22 (organic cation transporter)-like 2, clone MGC: 25980 | |
| | | | | IMAGE: 4242162, mRNA, complete cds, RIKEN cDNA 4921504E14 gene, expressed | |
| | | | | sequence AI987855, solute carrier family 22 (organic anion/cation transporter), member | |
| | | | | 11, solute carrier family 22 (organic cation transporter), member 5, solute carrier family | |
| | | | | 22 (organic cation transporter) member 9 | |
| 18074 | 1100 | NM_031738 | solute carrier family 29 | | K |
| | | | (nucleoside transporters), | | |
| | | | member 2 | | |
| 1511 | 1137 | NM_053424 | solute carrier family 4 (anion | ESTs, Weakly similar to T14031 sodium bicarbonate cotransporter, pancreatic - mouse | D |
| | | | exchanger), member 4, solute | [M. musculus], solute carrier family 4 (anion exchanger), member 4, solute carrier family | |
| | | | carrier family 4, sodium | 4, sodium bicarbonate cotransporter, member 4, solute carrier family 4, sodium | |
| | | | bicarbonate cotransporter, | bicarbonate cotransporter, member 5 | |
| | | | member 4 | | |
| 24496 | 837 | NM_012654 | solute carrier family 9 | ESTs, Weakly similar to B40204 Na+/H+-exchanging protein 3 - rat [R. norvegicus], | GENERAL, I, K |
| | | | (sodium/hydrogen exchanger), | ESTs, Weakly similar to NAH1 MOUSE SODIUM/HYDROGEN EXCHANGER 1 | |
| | | | isoform 3, solute carrier family | [M. musculus], Mus musculus Na—H exchanger isoform NHE8 mRNA, complete cds, | |
| | | | 9 (sodium/hydrogen | RIKEN cDNA 0610040A22 gene, RIKEN cDNA 6430709P13 gene, expressed sequence | |
| | | | exchanger), member 3 | AI182282, expressed sequence AI930210, solute carrier family 9 (sodium/hydrogen | |
| | | | | exchanger), isoform 6, solute carrier family 9 (sodium/hydrogen exchanger), member 1 | |
| 605 | 935 | NM_017221 | sonic hedgehog homolog | ESTs, Highly similar to SHH MOUSE SONIC HEDGEHOG PROTEIN PRECURSOR | C |
| | | | (Drosophila), sonic hedgehog | [M. musculus], Indian hedgehog homolog, (Drosophila), desert hedgehog homolog, | |
| | | | homolog, (Drosophila) | (Drosophila), sonic hedgehog homolog (Drosophila), sonic hedgehog homolog, | |
| | | | | (Drosophila) | |
| 1877 | 911 | NM_017052 | sorbitol dehydrogenase, | ESTs, Highly similar to A54674 L-iditol 2-dehydrogenase [H. sapiens], sorbitol | A, D, E |
| | | | sorbitol dehydrogenase 1 | dehydrogenase, sorbitol dehydrogenase 1 | |
| 16681 | 920 | NM_017136 | squalene epoxidase | Homo sapiens cDNA FLJ30795 fis, clone FEBRA2001124, squalene epoxidase | B, L |
| 15393 | 581 | AI170663 | sterol regulatory element | sterol regulatory element binding factor 1, sterol regulatory element binding factor 2, | J |
| | | | binding transcription factor 2 | sterol regulatory element binding transcription factor 2 | |
| 24321 | 698 | AI232340 | stromal cell derived factor 1, | | GENERAL, K, L |
| | | | stromal cell-derived factor 1 | | |
| 17514 | 232 | AA925554 | succinate dehydrogenase | succinate dehydrogenase complex, subunit A, flavoprotein (Fp) | E, G |
| | | | complex, subunit A, | | |
| | | | flavoprotein (Fp) | | |
| 4749 | 1110 | NM_031834 | sulfotransferase family 1A, | Aryl sulfotransferase cytosolic, 1A, phenol-preferring, member 3, RIKEN cDNA | L |
| | | | phenol-preferring, member 1, | 1110030E23 gene, sulfotransferase family 1A, phenol-preferring, member 1, | |
| | | | sulfotransferase family, | sulfotransferase family, cytosolic, 1A, phenol-preferring, member 1, sulfotransferase | |
| | | | cytosolic, 1A, phenol- | family, cytosolic, 1A, phenol-preferring, member 2 | |
| | | | preferring, member 1 | | |
| 20876 | 910 | NM_017050 | superoxide dismutase 1, | EST, Weakly similar to SODC MOUSE SUPEROXIDE DISMUTASE [M. musculus], | J |
| | | | soluble, superoxide dismutase | superoxide dismutase 1, soluble (amyotrophic lateral sclerosis 1 (adult)) | |
| | | | 1, soluble (amyotrophic lateral | | |
| | | | sclerosis 1 (adult)) | | |
| 494 | 861 | NM_012880 | superoxide dismutase 3, | superoxide dismutase 3, extracellular | J |
| | | | extracellular | | |
| 495 | 861 | NM_012880 | superoxide dismutase 3, | superoxide dismutase 3, extracellular | J |
| | | | extracellular | | |
| 24821 | 1158 | NM_053788 | syntaxin 1A (brain) | syntaxin 1A (brain) | J |
| 7489 | 963 | NM_019169 | synuclein, alpha, synuclein, | synuclein, alpha, synuclein, alpha (non A4 component of amyloid precursor) | GENERAL, G, I, J, L |
| | | | alpha (non A4 component of | | |
| | | | amyloid precursor) | | |
| 19031 | 928 | NM_017180 | T-cell death associated gene, | ESTs, Weakly similar to S58222 PQ-rich protein [H. sapiens], T-cell death associated | GENERAL, L |
| | | | pleckstrin homology-like | gene, pleckstrin homology-like domain, family A, member 1, pleckstrin homology-like | |
| | | | domain, family A, member 1 | domain, family A, member 3, tumor suppressing subtransferable candidate 3, tumor- | |
| | | | | suppressing subchromosomal transferable fragment 3 | |
| 3407 | 322 | AA997953 | TCF3 (E2A) fusion partner, | TCF3 (E2A) fusion partner, TCF3 (E2A) fusion partner (in childhood Leukemia) | F |
| | | | TCF3 (E2A) fusion partner (in | | |
| | | | childhood Leukemia) | | |
| 15662 | 1065 | NM_031318 | t-complex testis expressed 1, t- | Homo sapiens, Similar to RIKEN cDNA 0610012D17 gene, clone MGC: 33212 | G |
| | | | complex-associated-testis- | IMAGE: 4830500, mRNA, complete cds, RIKEN cDNA 2310075M16 gene, t-complex | |
| | | | expressed 1-like 1 | testis expressed 1, t-complex-associated-testis-expressed 1-like, t-complex-associated- | |
| | | | | testis-expressed 1-like 1 | |
| 15663 | 1065 | NM_031318 | t-complex testis expressed 1, t- | Homo sapiens, Similar to RIKEN cDNA 0610012D17 gene, clone MGC: 33212 | GENERAL |
| | | | complex-associated-testis- | IMAGE: 4830500, mRNA, complete cds, RIKEN cDNA 2310075M16 gene, t-complex | |
| | | | expressed 1-like 1 | testis expressed 1, t-complex-associated-testis-expressed 1-like, t-complex-associated- | |
| | | | | testis expressed 1-like 1 | |
| 24234 | 1086 | NM_031614 | thioredoxin reductase 1 | thioredoxin reductase 1, thioredoxin reductase 2 | GENERAL, A, I |
| 24235 | 1086 | NM_031614 | thioredoxin reductase 1 | thioredoxin reductase 1, thioredoxin reductase 2 | GENERAL, H, I |
| 21122 | 1242 | X56228 | thiosulfate sulfurtransferase | mercaptopyruvate sulfurtransferase, thiosulfate sulfurtransferase (rhodanese), thiosulfate | E |
| | | | (rhodanese), thiosulfate | sulfurtransferase, mitochondrial | |
| | | | sulfurtransferase, | | |
| | | | mitochondrial | | |
| 21123 | 1242 | X56228 | thiosulfate sulfurtransferase | mercaptopyruvate sulfurtransferase, thiosulfate sulfurtransferase (rhodanese), thiosulfate | D |
| | | | (rhodanese), thiosulfate | sulfurtransferase, mitochondrial | |
| | | | sulfurtransferase, | | |
| | | | mitochondrial | | |
| 12031 | 201 | AA893860 | threonyl-tRNA synthetase | threonyl-tRNA synthetase | GENERAL, I |
| 16871 | 863 | NM_012887 | thymopoietin | ESTs, Highly similar to THPA_HUMAN THYMOPOIETIN ALPHA [H. sapiens], RIKEN | E |
| | | | | cDNA 5630400D24 gene, thymopoietin | |
| 20816 | 990 | NM_021261 | thymosin, beta 10 | | GENERAL, G, K |
| 17234 | 507 | AI102741 | tissue inhibitor of | tissue inhibitor of metalloproteinase 3, tissue inhibitor of metalloproteinase 3 (Sorsby | J |
| | | | metalloproteinase 3, tissue | fundus dystrophy, pseudoinflammatory) | |
| | | | inhibitor of metalloproteinase 3 | | |
| | | | (Sorsby fundus dystrophy, | | |
| | | | pseudoinflammatory) | | |
| 23778 | 209 | AA899854 | topoisomerase (DNA) II alpha, | ESTs, Moderately similar to A40493 DNA topoisomerase [H. sapiens], ESTs, Weakly | E |
| | | | topoisomerase (DNA) II alpha | similar to topoisomerase (DNA) II alpha [Rattus norvegicus] [R. norvegicus], | |
| | | | (170 kD) | topoisomerase (DNA) II alpha, topoisomerase (DNA) II beta | |
| 23780 | 1001 | NM_022183 | topoisomerase (DNA) II alpha, | ESTs, Moderately similar to A40493 DNA topoisomerase [H. sapiens], ESTs, Weakly | E |
| | | | topoisomerase (DNA) II alpha | similar to topoisomerase (DNA) II alpha [Rattus norvegicus] [R. norvegicus], | |
| | | | (170 kD) | topoisomerase (DNA) II alpha, topoisomerase (DNA) II beta | |
| 1885 | 888 | NM_013103 | transcription factor 2, | transcription factor 2, transcription factor 2, hepatic; LF-B3; variant hepatic nuclear factor | GENERAL |
| | | | transcription factor 2, hepatic; | | |
| | | | LF-B3; variant hepatic nuclear | | |
| | | | factor | | |
| 24843 | 880 | NM_013042 | trefoil factor 3 (intestinal), | | J |
| | | | trefoil factor 3, intestinal | | |
| 457 | 813 | M60666 | tropomyosin 1 (alpha), | Homo sapiens cDNA FLJ30635 fis, clone CTONG2002520, expressed sequence | E, G, K |
| | | | tropomyosin 1, alpha | AI854628, expressed sequence C76867, tropomyosin 4, tuftelin 1 | |
| 455 | 957 | NM_019131 | tropomyosin 1 (alpha), | Homo sapiens cDNA FLJ30635 fis, clone CTONG2002520, expressed sequence | E |
| | | | tropomyosin 1, alpha | AI854628, expressed sequence C76867, tropomyosin 4, tuftelin 1 | |
| 16684 | 882 | NM_013052 | tyrosine 3- | ESTs, Highly similar to 143F MOUSE 14-3-3 PROTEIN ETA [M. musculus], tyrosine 3- | GENERAL |
| | | | monooxygenase/tryptophan 5- | monooxygenase/tryptophan 5-monooxygenase activation protein, eta polypeptide, | |
| | | | monooxygenase activation | tyrosine 3-monooxygenase/tryptophan 5-monooxygenase activation protein, gamma | |
| | | | protein, eta polypeptide | polypeptide | |
| 25279 | 877 | NM_013011 | tyrosine 3- | ESTs, Highly similar to A Chain A, 14-3-3 ZetaPHOSPHOPEPTIDE COMPLEX | C |
| | | | monooxygenase/tryptophan 5- | [H. sapiens], tyrosine 3-monooxygenase/tryptophan 5-monooxygenase activation protein, | |
| | | | monooxygenase activation | zeta polypeptide | |
| | | | protein, zeta polypeptide | | |
| 15050 | 520 | AI103911 | ubiquinol-cytochrome c | EST, Weakly similar to UCRI_HUMAN UBIQUINOL-CYTOCHROME C REDUCTASE | I |
| | | | reductase, Rieske iron-sulfur | IRON-SULFUR SUBUNIT, MITOCHONDRIAL PRECURSOR [H. sapiens], ESTs, | |
| | | | polypeptide 1 | Moderately similar to UCRI_HUMAN UBIQUINOL-CYTOCHROME C REDUCTASE | |
| | | | | IRON-SULFUR SUBUNIT, MITOCHONDRIAL PRECURSOR [H. sapiens], RIKEN cDNA | |
| | | | | 4430402G14 gene, ubiquinol-cytochrome c reductase, Rieske iron-sulfur polypeptide 1 | |
| 15124 | 1175 | NM_057105 | UDP glycosyltransferase 1 | UDP glycosyltransferase 1 family, polypeptide A6, UDP glycosyltransferase 1 family, | B |
| | | | family, polypeptide A cluster, | polypeptide A8 | |
| | | | UDP glycosyltransferase 1 | | |
| | | | family, polypeptide A6, UDP- | | |
| | | | glucuronosyltransferase 1 | | |
| | | | family, member 1 | | |
| 15125 | 1175 | NM_057105 | UDP glycosyltransferase 1 | UDP glycosyltransferase 1 family, polypeptide A6, UDP glycosyltransferase 1 family, | B |
| | | | family, polypeptide A6 | polypeptide A8 | |
| 10241 | 1101 | NM_031740 | UDP-Gal:betaGlcNAc beta 1,4- | UDP-Gal:betaGlcNAc beta 1,4- galactosyltransferase, polypeptide 1, UDP- | C, K |
| | | | galactosyltransferase, | Gal:betaGlcNAc beta 1,4-galactosyltransferase, polypeptide 2, UDP-Gal:betaGlcNAc | |
| | | | polypeptide 6, UDP- | beta 1,4-galactosyltransferase, polypeptide 5, UDP-Gal:betaGlcNAc beta 1,4- | |
| | | | Gal:betaGlcNAc beta 1,4- | galactosyltransferase, polypeptide 6, UDP-Gal:betaGlcNAc beta 1,4- | |
| | | | galactosyltransferase, | galactosyltransferase, polypeptide 3, UDP-Gal:betaGlcNAc beta 1,4- | |
| | | | polypeptide 6 | galactosyltransferase, polypeptide 5, UDP-Gal:betaGlcNAc beta 1,4- | |
| | | | | galactosyltransferase, polypeptide 6 | |
| 20443 | 982 | NM_019379 | vesicle docking protein p115, | vesicle docking protein p115, vesicle docking protein, 115 kDa | H |
| | | | vesicle docking protein, 115 kDa | | |
| 21975 | 923 | NM_017154 | xanthene dehydrogenase, | | B, L |
| | | | xanthine dehydrogenase | | |
| 17695 | 704 | AI232784 | | 2,4-dienoyl CoA reductase 1, mitochondrial, 2,4-dienoyl CoA reductase 2, peroxisomal, 2- | E |
| | | | | 4-dienoyl-Coenzyme A reductase 2, peroxisomal, Mus musculus, clone MGC: 6971 | |
| | | | | IMAGE: 3154595, mRNA, complete cds, RIKEN cDNA 0610039E24 gene, dicarbonyl/L- | |
| | | | | xylulose reductase, hydroxysteroid (17-beta) dehydrogenase 8, hypothetical protein | |
| | | | | BC014057, oxidoreductase UCPA, putative peroxisomal 2,4-dienoyl-CoA reductase | |
| 3279 | 512 | AI103224 | | 2,4-dienoyl CoA reductase 1, mitochondrial, 2,4-dienoyl CoA reductase 2, peroxisomal, 2- | F |
| | | | | 4-dienoyl-Coenzyme A reductase 2, peroxisomal, RIKEN cDNA 5430405K24 gene, | |
| | | | | putative peroxisomal 2,4-dienoyl-CoA reductase | |
| 4462 | 105 | AA866264 | | 20 alpha-hydroxysteroid dehydrogenase, ESTs, Weakly similar to DHBX MOUSE | GENERAL, A, C, I |
| | | | | ESTRADIOL 17 BETA-DEHYDROGENASE, A-SPECIFIC [M. musculus], aldo-keto | |
| | | | | reductase family 1, member C1 (dihydrodiol dehydrogenase 1; 20-alpha (3-alpha)- | |
| | | | | hydroxysteroid dehydrogenase), aldo-keto reductase family 1, member C2 (dihydrodiol | |
| | | | | dehydrogenase 2; bile acid binding protein; 3-alpha hydroxysteroid dehydrogenase, type | |
| | | | | III), aldo-keto reductase family 1, member C3 (3-alpha hydroxysteroid dehydrogenase, | |
| | | | | type II), aldo-keto reductase family 1, member C4 (chlordecone reductase; 3-alpha | |
| | | | | hydroxysteroid dehydrogenase, type I; dihydrodiol dehydrogenase 4), expressed | |
| | | | | sequence AW146047 | |
| 4463 | 135 | AA891831 | | 20 alpha-hydroxysteroid dehydrogenase, ESTs, Weakly similar to DHBX MOUSE | GENERAL, A, I |
| | | | | ESTRADIOL 17 BETA-DEHYDROGENASE, A-SPECIFIC [M. musculus], aldo-keto | |
| | | | | reductase family 1, member C1 (dihydrodiol dehydrogenase 1; 20-alpha (3-alpha)- | |
| | | | | hydroxysteroid dehydrogenase), aldo-keto reductase family 1, member C2 (dihydrodiol | |
| | | | | dehydrogenase 2; bile acid binding protein; 3-alpha hydroxysteroid dehydrogenase, type | |
| | | | | III), aldo-keto reductase family 1, member C3 (3-alpha hydroxysteroid dehydrogenase, | |
| | | | | type II), aldo-keto reductase family 1, member C4 (chlordecone reductase; 3-alpha | |
| | | | | hydroxysteroid dehydrogenase, type I; dihydrodiol dehydrogenase 4), expressed | |
| | | | | sequence AW146047 | |
| 21950 | 412 | AI013861 | | 3-hydroxyisobutyrate dehydrogenase, ESTs, Highly similar to D3HI_HUMAN 3- | G |
| | | | | HYDROXYISOBUTYRATE DEHYDROGENASE, MITOCHONDRIAL PRECURSOR | |
| | | | | (HIBADH) [H. sapiens], RIKEN cDNA 3930401K13 gene | |
| 22537 | 175 | AA892799 | | 3-phosphoglycerate dehydrogenase, EST, Moderately similar to SERA MOUSE D-3- | GENERAL, A, D |
| | | | | PHOSPHOGLYCERATE DEHYDROGENASE [M. musculus], Mus musculus adult male | |
| | | | | testis cDNA, RIKEN full-length enriched library, clone: 4930404C15:3-phosphoglycerate | |
| | | | | dehydrogenase, full insert sequence, glyoxylate reductase/hydroxypyruvate reductase, | |
| | | | | phosphoglycerate dehydrogenase | |
| 22538 | 175 | AA892799 | | 3-phosphoglycerate dehydrogenase, EST, Moderately similar to SERA MOUSE D-3- | GENERAL, D |
| | | | | PHOSPHOGLYCERATE DEHYDROGENASE [M. musculus], Mus musculus adult male | |
| | | | | testis cDNA, RIKEN full-length enriched library, clone: 4930404C15:3-phosphoglycerate | |
| | | | | dehydrogenase, full insert sequence, glyoxylate reductase/hydroxypyruvate reductase, | |
| | | | | phosphoglycerate dehydrogenase | |
| 22539 | 175 | AA892799 | | 3-phosphoglycerate dehydrogenase, EST, Moderately similar to SERA MOUSE D-3- | GENERAL |
| | | | | PHOSPHOGLYCERATE DEHYDROGENASE [M. musculus], Mus musculus adult male | |
| | | | | testis cDNA, RIKEN full-length enriched library, clone: 4930404C15:3-phosphoglycerate | |
| | | | | dehydrogenase, full insert sequence, glyoxylate reductase/hydroxypyruvate reductase, | |
| | | | | phosphoglycerate dehydrogenase | |
| 22540 | 221 | AA924630 | | 3-phosphoglycerate dehydrogenase, EST, Moderately similar to SERA MOUSE D-3- | E |
| | | | | PHOSPHOGLYCERATE DEHYDROGENASE [M. musculus], Mus musculus adult male | |
| | | | | testis cDNA, RIKEN full-length enriched library, clone: 4930404C15:3-phosphoglycerate | |
| | | | | dehydrogenase, full insert sequence, glyoxylate reductase/hydroxypyruvate reductase, | |
| | | | | phosphoglycerate dehydrogenase | |
| 13485 | 989 | NM_020306 | | a disintegrin and metalloproteinase domain 17, a disintegrin and metalloproteinase | B |
| | | | | domain 17 (tumor necrosis factor, alpha, converting enzyme) | |
| 347 | 1205 | U01914 | | A kinase (PRKA) anchor protein 8, ESTs, Weakly similar to A53414 A-kinase anchor | D |
| | | | | protein 95, AKAP9S - rat [R. norvegicus], Mus musculus 10 days embryo whole body | |
| | | | | cDNA, RIKEN full-length enriched library, clone: 2610301A12:neighbor of A-kinase | |
| | | | | anchoring protein 95, full insert sequence, expressed sequence AI467606, neighbor of A- | |
| | | | | kinase anchoring protein 95, zinc finger protein 326 | |
| 17516 | 950 | NM_017321 | | aconitase 1, aconitase 1, soluble | A, E, L |
| 23758 | 285 | AA956414 | | acyl-Coenzyme A dehydrogenase family, member 8, hypothetical protein FLJ12592, | C, G |
| | | | | hypothetical protein MGC5601 | |
| 21696 | 1034 | NM_024152 | | ADP-ribosylation factor 6, ESTs, Weakly similar to ARF6_HUMAN ADP-RIBOSYLATION | C |
| | | | | FACTOR 6 [M. musculus], ESTs, Weakly similar to ARF6_HUMAN ADP-ribosylation | |
| | | | | factor 6 [R. norvegicus], RIKEN cDNA 1110033P22 gene, RIKEN cDNA 2310075M17 | |
| | | | | gene, RIKEN cDNA 9130014L17 gene, SAR1 protein, SAR1a gene homolog (S. cerevisiae), | |
| | | | | hypothetical protein FLJ22595 | |
| 11968 | 597 | AI172208 | | Alpha-fetoprotein, alpha fetoprotein, alpha-fetoprotein | F |
| 24648 | 1046 | NM_030985 | | angiotensin receptor 1 | GENERAL |
| 16649 | 891 | NM_013132 | | annexin A5 | GENERAL, E |
| 16650 | 891 | NM_013132 | | annexin A5 | E |
| 21462 | 77 | AA851261 | | ART-4 protein | GENERAL, J |
| 5867 | 85 | AA858953 | | asparaginyl-tRNA synthetase, hypothetical protein FLJ23441 | GENERAL |
| 18449 | 1204 | U00926 | | ATP synthase, H+ transporting, mitochondrial F1 complex, delta subunit, EST, | H |
| | | | | Moderately similar to ATPD_HUMAN ATP SYNTHASE DELTA CHAIN, | |
| | | | | MITOCHONDRIAL PRECURSO [H. sapiens], RIKEN cDNA 0610008F14 gene, RIKEN | |
| | | | | cDNA 1500000I11 gene, expressed sequence AI467246 | |
| 16907 | 35 | AA817977 | | ATPase, H+ transporting, lysosomal 42 kD, V1 subunit C, isoform 1, RIKEN cDNA | C |
| | | | | 1110038G14 gene | |
| 22662 | 725 | AI234939 | | ATPase, H+ transporting, lysosomal interacting protein 1, EST, Weakly similar to I54197 | GENERAL |
| | | | | hypothetical protein [H. sapiens], ESTs, Weakly similar to VAS1_RAT Vacuolar ATP | |
| | | | | synthase subunit S1 precursor (V-ATPase S1 subunit) (V-ATPase S1 accessory protein) | |
| | | | | (V-ATPase Ac45 subunit) (C7-1 protein) [R. norvegicus], Homo sapiens cDNA FLJ12563 | |
| | | | | fis, clone NT2RM4000820, weakly similar to VACUOLAR ATP SYNTHASE SUBUNIT | |
| | | | | AC45 PRECURSOR (EC 3.6.1.34), expressed sequence AW108110 | |
| 20841 | 1084 | NM_031604 | | ATPase, H+ transporting, lysosomal V0 subunit A isoform 4, ATPase, H+ transporting, | H |
| | | | | lysosomal V0 subunit a isoform 1, ATPase, H+ transporting, lysosomal V0 subunit a | |
| | | | | isoform 2, ATPase, H+ transporting, lysosomal V0 subunit a isoform 4, EST, Weakly | |
| | | | | similar to B38656 vacuolar proton pump 116K chain - rat [R. norvegicus], ESTs, | |
| | | | | Moderately similar to B38656 vacuolar proton pump 116K chain - rat [R. norvegicus] | |
| 9176 | 490 | AI072675 | | ATP-dependant interferon responsive, Mus musculus, clone IMAGE: 4952483, mRNA, | A |
| | | | | partial cds, Mus musculus, clone MGC: 18883 IMAGE: 4238480, mRNA, complete cds, | |
| | | | | dystonia 1, torsion (autosomal dominant; torsin A), torsin family 2, member A, torsin | |
| | | | | family 3, member A | |
| 20582 | 93 | AA859688 | | AU RNA binding protein/enoyl-Coenzyme A hydratase, AU RNA binding protein/enoyl- | A, E, F, K |
| | | | | coenzyme A hydratase, ESTs, Weakly similar to I37195 AU-specific RNA-binding protein/ | |
| | | | | enoyl-CoA hydratase homolog [H. sapiens], Mus musculus, Similar to 3- | |
| | | | | hydroxyisobutyryl-Coenzyme A hydrolase, clone MGC: 31364 IMAGE: 4238681, mRNA, | |
| | | | | complete cds, RIKEN cDNA 1300017C12 gene, uncharacterized hypothalamus protein | |
| | | | | HCDASE | |
| 23679 | 974 | NM_019290 | | B-cell translocation gene 3, BTG family, member 3 | C, L |
| 23033 | 1188 | NM_080888 | | BCL2/adenovirus E1B 19 kDa-interacting protein 3-like, BCL2/adenovirus E1B 19 kD | A, C, K |
| | | | | interacting protein 3-like | |
| 21632 | 359 | AI009167 | | BCL2-associated athanogene 2 | GENERAL, H, I |
| 15171 | 690 | AI231792 | | BCL2-associated athanogene 3, BCL2-associated athanogene 5, Bcl2-associated | H |
| | | | | athanogene 3, RIKEN cDNA 1700081D05 gene | |
| 17824 | 54 | AA819362 | | beta-site APP-cleaving enzyme, hypothetical protein MGC7474 | A |
| 17823 | 76 | AA851214 | | beta-site APP-cleaving enzyme, hypothetical protein MGC7474 | D |
| 1888 | 1177 | NM_057130 | | BH3 interacting (with BCL2 family) domain, apoptosis agonist, ESTs, Weakly similar to | B |
| | | | | HRK MOUSE ACTIVATOR OF APOPTOSIS HARAKIRI [M. musculus], harakiri, BCL2 | |
| | | | | interacting protein (contains only BH3 domain) | |
| 23957 | 291 | AA957123 | | brain expressed, X-linked 1, hypothetical protein FLJ10097 | GENERAL |
| 17836 | 198 | AA893626 | | BUB3 budding uninhibited by benzimidazoles 3 homolog (yeast), Guanine nucleotide- | D |
| | | | | binding protein beta 1, RIKEN cDNA 2700038L12 gene, budding uninhibited by | |
| | | | | benzimidazoles 3 homolog (S. cerevisiae), neural precursor cell expressed, | |
| | | | | developmentally down-regulated gene 1 | |
| 17550 | 387 | AI011607 | | butyrobetaine (gamma), 2-oxoglutarate dioxygenase (gamma-butyrobetaine hydroxylase) | GENERAL, I |
| | | | | 1, butyrobetaine (gamma), 2-oxoglutarate dioxygenase 1 (gamma-butyrobetaine | |
| | | | | hydroxylase), epsilon-trimethyllysine 2-oxoglutarate dioxygenase, gamma-butyrobetaine | |
| | | | | hydroxylase | |
| 17249 | 137 | AA891858 | | cadherin 16, cadherin 16, KSP-cadherin, cadherin 17, cadherin 17, LI cadherin (liver- | K |
| | | | | intestine) | |
| 24672 | 810 | M34097 | | cathepsin G, granzyme B, granzyme B (granzyme 2, cytotoxic T-lymphocyte-associated | C |
| | | | | serine esterase 1), granzyme C, similar to granzyme B (granzyme 2, cytotoxic T- | |
| | | | | lymphocyte-associated serine esterase 1) (H. sapiens) | |
| 1894 | 949 | NM_017320 | | cathepsin S | B, L |
| 6635 | 68 | AA849786 | | CDC-like kinase 2, CDC-like kinase 3, EST, Highly similar to CLK3_RAT Protein kinase | GENERAL |
| | | | | CLK3 (CDC-like kinase 3) [R. norvegicus], ESTs, Weakly similar to CLK3_RAT Protein | |
| | | | | kinase CLK3 (CDC-like kinase 3) [R. norvegicus] | |
| 15237 | 773 | AI639535 | | CDw92 antigen, ESTs, Weakly similar to CTL2 gene [Homo sapiens] [H. sapiens], Homo | J |
| | | | | sapiens, clone MGC: 34032 IMAGE: 4828797, mRNA, complete cds, Mus musculus, | |
| | | | | Similar to transporter-like protein, clone MGC: 7894 IMAGE: 3582543, mRNA, complete | |
| | | | | cds, RIKEN cDNA 1110028E10 gene, RIKEN cDNA 2210409B01 gene, chromosome 6 | |
| | | | | open reading frame 29, expressed sequence AW547365, transporter-like protein | |
| 21651 | 975 | NM_019296 | | cell division cycle 2 homolog A (S. pombe), cell division cycle 2, G1 to S and G2 to M, | E |
| | | | | cyclin-dependent kinase-like 1 (CDC2-related kinase) | |
| 12716 | 372 | AI010178 | | CGI-100 protein | GENERAL |
| 3121 | 353 | AI008160 | | CGI-83 protein | GENERAL, G, K |
| 8944 | 466 | AI070597 | | CGI-97 protein, EST, Weakly similar to YC97_HUMAN HYPOTHETICAL PROTEIN CGI- | F |
| | | | | 97 [H. sapiens] | |
| 17154 | 1161 | NM_053835 | | clathrin, light polypeptide (Lca), clathrin, light polypeptide (Lcb), expressed sequence | J |
| | | | | AV026556 | |
| 108 | 797 | L14002 | | CMRF35 leukocyte immunoglobulin-like receptor, EST, Weakly similar to PIGR_RAT | J |
| | | | | Polymeric-immunoglobulin receptor precursor (Poly-IG receptor) (PIGR) [Contains: | |
| | | | | Secretory component] [R. norvegicus], Fc receptor, IgA, IgM, high affinity, Homo sapiens, | |
| | | | | similar to CMRF35 ANTIGEN PRECURSOR, clone MGC: 26887 IMAGE: 4827737, | |
| | | | | mRNA, complete cds, Mus musculus polymeric immunoglobulin receptor 3 precursor | |
| | | | | (Pigr3) mRNA, complete cds, RIKEN cDNA 1810037B05 gene, RIKEN cDNA | |
| | | | | 2310016B05 gene, immunoglobulin superfamily, member 7, polymeric immunoglobulin | |
| | | | | receptor regulator of Fas-induced apoptosis | |
| 2782 | 326 | AA998565 | | cyclin-dependent kinase inhibitor 1C (P57), cyclin-dependent kinase inhibitor 1C (p57, | J |
| | | | | Kip2) | |
| 19003 | 1189 | NM_080903 | | cystatin and DUF19 domain containing 1, ret finger protein 2, ring finger protein 28, ring | F |
| | | | | finger protein 29, ring finger protein 30, tripartite motif protein 13 | |
| 4327 | 1144 | NM_053563 | | DEAD/H (Asp-Glu-Ala-Asp/His) box polypeptide 20, DEAD/H (Asp-Glu-Ala-Asp/His) box | GENERAL, G, I |
| | | | | polypeptide 20, 103 kD, DEAD/H (Asp-Glu-Ala-Asp/His) box polypeptide 39, DEAD/H | |
| | | | | (Asp-Glu-Ala-Asp/His) box polypeptide 6 (RNA helicase, 54 kD), DEAD/H (Asp-Glu-Ala- | |
| | | | | Asp/His) box polypeptide 7 (RNA helicase, 52 kD), EST, Moderately similar to HLA-B- | |
| | | | | associated transcript 1A; DNA segment, Chr 17, human D6S81E 1; nuclear RNA helicase | |
| | | | | Bat1 [Mus musculus] [M. musculus], HLA-B-associated transcript 1A | |
| 24459 | 1183 | NM_057209 | | death-associated kinase 3, expressed sequence AI120141, myosin light chain kinase 2, | C |
| | | | | skeletal muscle | |
| 22612 | 262 | AA945624 | | Diaphorase (NADH/NADPH), EST, Weakly similar to A32667 NAD(P)H dehydrogenase | GENERAL, I |
| | | | | [H. sapiens], NAD(P)H dehydrogenase, quinone 1, NAD(P)H dehydrogenase, quinone 2, | |
| | | | | NAD(P)H menadione oxidoreductase 2, dioxin inducible | |
| 4504 | 1035 | NM_024159 | | disabled homolog 1 (Drosophila), disabled homolog 2 (Drosophila), disabled homolog 2, | D |
| | | | | mitogen-responsive phosphoprotein (Drosophila) | |
| 14267 | 389 | AI011738 | | DKFZP564B167 protein, RIKEN cDNA 2010002I07 gene, RIKEN cDNA 2610205H19 | A |
| | | | | gene | |
| 4360 | 785 | H31813 | | DKFZP586B1621 protein | GENERAL, G, I |
| 3834 | 629 | AI177902 | | DKFZP586F1524 protein | G |
| 1949 | 1212 | U19614 | | DKFZP586G011 protein, ESTs, Moderately similar to I61730 lamina associated | A |
| | | | | polypeptide 1C short splice form - rat [R. norvegicus], ESTs, Weakly similar to I61730 | |
| | | | | lamina associated polypeptide 1C short splice form - rat [R. norvegicus], ESTs, Weakly | |
| | | | | similar to T08767 probable lamina-associated protein DKFZp586G011.1 [H. sapiens], | |
| | | | | Homo sapiens, clone IMAGE: 4651703, mRNA, Mus musculus, clone MGC: 6357 | |
| | | | | IMAGE: 3493883, mRNA, complete cds | |
| 7307 | 736 | AI235935 | | DKFZP586G1517 protein, EST, Moderately similar to A Chain A, Human | G, K |
| | | | | Tetrahydrofolate Dehydrogenase [H. sapiens], ESTs, Highly similar to T17244 | |
| | | | | hypothetical protein DKFZp586G1517.1 [H. sapiens], ESTs, Weakly similar to C1TC_RAT | |
| | | | | C-1-tetrahydrofolate synthase, cytoplasmic (C1-THF synthase) [Includes: | |
| | | | | Methylenetetrahydrofolate dehydrogenase; Methenyltetrahydrofolate cyclohydrolase; | |
| | | | | Formyltetrahydrofolate synthetase] [R. norvegicus], expressed sequence AI647056, | |
| | | | | hypothetical protein FLJ13105 | |
| 4373 | 153 | AA892310 | | DKFZP58600120 protein | F |
| 1824 | 1210 | U17971 | | DNA segment, Chr 10, ERATO Doi 398, expressed, EST, Weakly similar to 2102279A | K |
| | | | | protein Tyr phosphatase [Rattus norvegicus] [R. norvegicus], ESTs, Weakly similar to 41 | |
| | | | | MOUSE PROTEIN 4.1 [M. musculus], protein tyrosine phosphatase, non-receptor type | |
| | | | | 14, protein tyrosine phosphatase, non-receptor type 21 | |
| 17535 | 1108 | NM_031816 | | DNA segment, Chr 12, ERATO Doi 604, expressed, ESTs, Moderately similar to | E |
| | | | | hypothetical protein FLJ10416 similar to constitutive photomorph [Homo sapiens] | |
| | | | | [H. sapiens], ESTs, Weakly similar to retinoblastoma binding protein 7 [Rattus | |
| | | | | norvegicus] [R. norvegicus], Mus musculus, Similar to glutamate rich WD repeat protein | |
| | | | | GRWD, clone IMAGE: 3498842, mRNA, partial cds, RIKEN cDNA 2610016K01 gene, | |
| | | | | RIKEN cDNA 2610529I12 gene, constitutive photomorphogenic protein 1 (Arabidopsis), | |
| | | | | retinoblastoma binding protein 4, retinoblastoma binding protein 7 | |
| 2912 | 373 | AI010220 | | DNA segment, Chr 14, ERATO Doi 728, expressed, RIKEN cDNA 6720456I16 gene, | GENERAL, A, F |
| | | | | claudin 10, claudin 15, claudin 7 | |
| 22648 | 636 | AI178996 | | DNA segment, Chr 15, Wayne State University 77, expressed, EST, Moderately similar to | A |
| | | | | K2C8_RAT Keratin, type II cytoskeletal 8 (Cytokeratin 8) (Cytokeratin endo A) | |
| | | | | [R. norvegicus], ESTs, Highly similar to K2C8_RAT Keratin, type II cytoskeletal 8 | |
| | | | | (Cytokeratin 8) (Cytokeratin endo A) [R. norvegicus], ESTs, Moderately similar to I37982 | |
| | | | | Keratin 8 [H. sapiens], keratin 7, keratin 8, keratin complex 2, basic, gene 8 | |
| 1460 | 1199 | S76054 | | DNA segment, Chr 15, Wayne State University 77, expressed, EST, Moderately similar to | GENERAL, A, C, I, K |
| | | | | K2C8_RAT Keratin, type II cytoskeletal 8 (Cytokeratin 8) (Cytokeratin endo A) | |
| | | | | [R. norvegicus], ESTs, Moderately similar to I37982 Keratin 8 [H. sapiens], Homo sapiens | |
| | | | | mRNA; cDNA DKFZp434C107 (from clone DKFZp434C107), Homo sapiens mRNA; | |
| | | | | cDNA DKFZp762H106 (from clone DKFZp762H106), keratin 8, keratin complex 2, basic, | |
| | | | | gene 8 | |
| 21157 | 271 | AA946189 | | DNA segment, Chr 17, ERATO Doi 663, expressed, Homo sapiens cDNA FLJ25377 fis, | I |
| | | | | clone TST02084 | |
| 5990 | 290 | AA956907 | | DnaJ (Hsp40) homolog, subfamily C, member 8, Homo sapiens cDNA FLJ13613 fis, | GENERAL |
| | | | | clone PLACE1010856, Homo sapiens mRNA; cDNA DKFZp434C2016 (from clone | |
| | | | | DKFZp434C2016), hypothetical protein DKFZp434B227 | |
| 14484 | 628 | AI177867 | | EH-domain containing 1, ESTs, Highly similar to intersectin 2 [Homo sapiens] | GENERAL |
| | | | | [H. sapiens], Mus musculus, Similar to EH-domain containing 2, clone MGC: 38650 | |
| | | | | IMAGE: 5356224, mRNA, complete cds, SH3 domain protein 1B, expressed sequence | |
| | | | | AW108387, intersectin (SH3 domain protein 1A), intersectin 1 (SH3 domain protein) | |
| 10667 | 742 | AI236366 | | ELAV (embryonic lethal, abnormal vision, Drosophila)-like 2 (Hu antigen B), ELAV | C |
| | | | | (embryonic lethal, abnormal vision, Drosophila)-like 4 (Hu antigen D), ESTs, Highly | |
| | | | | similar to ELV4_RAT ELAV-like protein 4 (Paraneoplastic encephalomyelitis antigen | |
| | | | | HuD) (Hu-antigen D) [R. norvegicus], ESTs, Moderately similar to ELV4_RAT ELAV-like | |
| | | | | protein 4 (Paraneoplastic encephalomyelitis antigen HuD) (Hu-antigen D) [R. norvegicus], | |
| | | | | ESTs, Moderately similar to PAB1 MOUSE POLYADENYLATE-BINDING PROTEIN 1 | |
| | | | | [M. musculus], ESTs, Weakly similar to PAB1 MOUSE POLYADENYLATE-BINDING | |
| | | | | PROTEIN 1 [M. musculus], RIKEN cDNA 4932702K14 gene, poly A binding protein, | |
| | | | | cytoplasmic 1, poly(A) binding protein, cytoplasmic 4 (inducible form) | |
| 17921 | 607 | AI176422 | | electron-transferring-flavoprotein dehydrogenase | F |
| 17268 | 686 | AI231317 | | endothelial-derived gene, endothelial-derived gene 1 | F |
| 23194 | 159 | AA892417 | | ephrin A1, ephrin-A1 | GENERAL |
| 21509 | 1044 | NM_030847 | | epithelial membrane protein 3 | G |
| 21796 | 392 | AI012221 | | EST X83352, ESTs, Weakly similar to intracellular chloride ion channel protein p64H1 | GENERAL, K |
| | | | | [Rattus norvegicus] [R. norvegicus], RIKEN cDNA 5730531E12 gene, chloride intracellular | |
| | | | | channel 1, chloride intracellular channel 3, chloride intracellular channel 4 (mitochondrial), | |
| | | | | intracellular chloride ion channel protein p64H1 | |
| 21797 | 488 | AI072439 | | EST X83352, ESTs, Weakly similar to intracellular chloride ion channel protein p64H1 | G, K |
| | | | | [Rattus norvegicus] [R. norvegicus], RIKEN cDNA 5730531E12 gene, chloride intracellular | |
| | | | | channel 1, chloride intracellular channel 3, chloride intracellular channel 4 (mitochondrial), | |
| | | | | intracellular chloride ion channel protein p64H1 | |
| 12606 | 1016 | NM_022547 | | EST, Highly similar to 10-formyltetrahydrofolate dehydrogenase [Rattus norvegicus] | E, K |
| | | | | [R. norvegicus], EST, Highly similar to FTDH_HUMAN 10- | |
| | | | | FORMYLTETRAHYDROFOLATE DEHYDROGENASE [H. sapiens], ESTs, Moderately | |
| | | | | similar to 10-formyltetrahydrofolate dehydrogenase [Rattus norvegicus] [R. norvegicus], | |
| | | | | ESTs, Moderately similar to FTDH_HUMAN 10-FORMYLTETRAHYDROFOLATE | |
| | | | | DEHYDROGENASE [H. sapiens], RIKEN cDNA 1810048F20 gene, RIKEN cDNA | |
| | | | | 2310020P08 gene, aldehyde dehydrogenase family 1, subfamily A7, | |
| | | | | formyltetrahydrofolate dehydrogenase | |
| 7101 | 839 | NM_012679 | | EST, Highly similar to Clusterin; Testostrone-repressed prostate message 2 [Rattus | GENERAL, E |
| | | | | norvegicus] [R. norvegicus], clusterin, clusterin (complement lysis inhibitor, SP-40, 40, | |
| | | | | sulfated glycoprotein 2, testosterone-repressed prostate message 2, apolipoprotein J) | |
| 4589 | 343 | AF062389 | | EST, Highly similar to A61209 hypertension-associated protein SA - rat [R. norvegicus], | GENERAL, D |
| | | | | ESTs, Highly similar to A61209 hypertension-associated protein SA - rat [R. norvegicus], | |
| | | | | Homo sapiens cDNA FLJ31305 fis, clone LIVER1000104, moderately similar to Rattus | |
| | | | | norvegicus kidney-specific protein (KS) mRNA, Homo sapiens cDNA FLJ33088 fis, clone | |
| | | | | TRACH2000496, highly similar to Rattus norvegicus kidney-specific protein (KS) mRNA, | |
| | | | | KIAA1504 protein, SA hypertension-associated homolog (rat), SA rat hypertension- | |
| | | | | associated homolog, cat eye syndrome chromosome region, candidate 7, hypothetical | |
| | | | | protein FLJ20581, solute carrier family 27 (fatty acid transporter), member 1, solute | |
| | | | | carrier family 27 (fatty acid transporter), member 4 | |
| 10015 | 973 | NM_019289 | | EST, Highly similar to AR41_HUMAN ARP2/3 COMPLEX 41 KDA SUBUNIT [H. sapiens], | GENERAL, G, K |
| | | | | actin related protein 2/3 complex, subunit 1B (41 kD), actin related protein 2/3 complex, | |
| | | | | subunit 1B (41 kDa) | |
| 10016 | 973 | NM_019289 | | EST, Highly similar to AR41_HUMAN ARP2/3 COMPLEX 41 KDA SUBUNIT [H. sapiens], | GENERAL, G |
| | | | | actin related protein 2/3 complex, subunit 1B (41 kD), actin related protein 2/3 complex, | |
| | | | | subunit 1B (41 kDa) | |
| 15137 | 1050 | NM_031051 | | EST, Highly similar to C Chain C, Macrophage Migration Inhibitory Factor [H. sapiens], | L |
| | | | | EST, Moderately similar to C Chain C, Macrophage Migration Inhibitory Factor | |
| | | | | [H. sapiens], EST, Moderately similar to MIF_RAT Macrophage migration inhibitory factor | |
| | | | | (MIF) (Phenylpyruvate tautomerase) (Glutathione-binding 13 kDa protein) [R. norvegicus], | |
| | | | | ESTs, Moderately similar to MIF_HUMAN MACROPHAGE MIGRATION INHIBITORY | |
| | | | | FACTOR [H. sapiens], macrophage migration inhibitory factor, macrophage migration | |
| | | | | inhibitory factor (glycosylation-inhibiting factor) | |
| 15138 | 1050 | NM_031051 | | EST, Highly similar to C Chain C, Macrophage Migration Inhibitory Factor [H. sapiens], | C |
| | | | | EST, Moderately similar to C Chain C, Macrophage Migration Inhibitory Factor | |
| | | | | [H. sapiens], EST, Moderately similar to MIF_RAT Macrophage migration inhibitory factor | |
| | | | | (MIF) (Phenylpyruvate tautomerase) (Glutathione-binding 13 kDa protein) [R. norvegicus], | |
| | | | | ESTs, Moderately similar to MIF_HUMAN MACROPHAGE MIGRATION INHIBITORY | |
| | | | | FACTOR [H. sapiens], macrophage migration inhibitory factor, macrophage migration | |
| | | | | inhibitory factor (glycosylation-inhibiting factor) | |
| 1246 | 847 | NM_012770 | | EST, Highly similar to CYG2_HUMAN GUANYLATE CYCLASE SOLUBLE, BETA-2 | GENERAL, J |
| | | | | CHAIN [H. sapiens], guanylate cyclase 1, soluble, beta 2, guanylate cyclase 1, soluble, | |
| | | | | beta 3 | |
| 7892 | 661 | AI229172 | | EST, Highly similar to FIBA_RAT Fibrinogen alpha/alpha-E chain precursor | K |
| | | | | [R. norvegicus], Homo sapiens clone HQ0582, Mus musculus, Similar to angiopoietin-like | |
| | | | | factor, clone MGC: 32448 IMAGE: 5043159, mRNA, complete cds, angiopoietin, | |
| | | | | expressed sequence AI303526, fibrinogen, A alpha polypeptide, fibrinogen, alpha | |
| | | | | polypeptide, fibrinogen, gamma polypeptide | |
| 15850 | 749 | AI236795 | | EST, Highly similar to HS9B MOUSE HEAT SHOCK PROTEIN HSP 90-BETA | K |
| | | | | [M. musculus], EST, Weakly similar to HHMS84 heat shock protein 84 - mouse | |
| | | | | [M. musculus], ESTs, Highly similar to HS9A_HUMAN HEAT SHOCK PROTEIN HSP 90- | |
| | | | | ALPHA [H. sapiens], ESTs, Highly similar to T46243 hypothetical protein | |
| | | | | DKFZp761K0511.1 [H. sapiens], expressed sequence C81438, heat shock 90 kD protein | |
| | | | | 1, beta, heat shock protein, 84 kDa, 1, heat shock protein, 86 kDa 1 | |
| 16967 | 895 | NM_013146 | | EST, Highly similar to JH0628 caldesmon [H. sapiens], ESTs, Weakly similar to JC5314 | E |
| | | | | CDC28/cdc2-like kinase associating arginine-serine cyclophilin [H. sapiens], Mus | |
| | | | | musculus, Similar to Caldesmon 1, clone MGC: 30319 IMAGE: 5148205, mRNA, complete | |
| | | | | cds, RIKEN cDNA 4833423D12 gene, caldesmon 1, major urinary protein 4 | |
| 17684 | 154 | AA892345 | | EST, Highly similar to M2GD_HUMAN DIMETHYLGLYCINE DEHYDROGENASE, | GENERAL, I |
| | | | | MITOCHONDRIAL PRECURSOR [H. sapiens], ESTs, Weakly similar to | |
| | | | | DIMETHYLGLYCINE DEHYDROGENASE PRECURSOR [R. norvegicus], RIKEN cDNA | |
| | | | | 1200014D15 gene, dimethylglycine dehydrogenase precursor, expressed sequence | |
| | | | | AW495222, hypothetical protein FLJ10079, sarcosine dehydrogenase | |
| 21025 | 88 | AA859241 | | EST, Highly similar to OM25_RAT MITOCHONDRIAL OUTER MEMBRANE PROTEIN | GENERAL, A, C |
| | | | | 25 (NPW16) [R. norvegicus], EST, Weakly similar to OM25_RAT Mitochondrial outer | |
| | | | | membrane protein 25 (NPW16) [R. norvegicus], hypothetical protein FLJ11271, | |
| | | | | synaptojanin 2 binding protein | |
| 21024 | 1021 | NM_022599 | | EST, Highly similar to OM25_RAT MITOCHONDRIAL OUTER MEMBRANE PROTEIN | GENERAL |
| | | | | 25 (NPW16) [R. norvegicus], EST, Weakly similar to OM25_RAT Mitochondrial outer | |
| | | | | membrane protein 25 (NPW16) [R. norvegicus], hypothetical protein FLJ11271, | |
| | | | | synaptojanin 2 binding protein | |
| 15876 | 169 | AA892582 | | EST, Highly similar to RL8_HUMAN 60S ribosomal protein L8 [R. norvegicus], EST, | G |
| | | | | Weakly similar to JN0923 ribosomal protein L8, cytosolic [H. sapiens], ESTs, Highly | |
| | | | | similar to R5RTL8 ribosomal protein L8, cytosolic [validated] - rat [R. norvegicus], ESTs, | |
| | | | | Highly similar to RL8_HUMAN 60S RIBOSOMAL PROTEIN L [M. musculus], ESTs, | |
| | | | | Moderately similar to RL8_HUMAN 60S RIBOSOMAL PROTEIN L [M. musculus], | |
| | | | | expressed sequence AL024098, ribosomal protein L8 | |
| 343 | 844 | NM_012747 | | EST, Highly similar to STA3_RAT Signal transducer and activator of transcription 3 | L |
| | | | | [R. norvegicus], signal transducer and activator of transcription 3, signal transducer and | |
| | | | | activator of transcription 3 (acute-phase response factor) | |
| 3439 | 185 | AA893000 | | EST, Highly similar to T00335 hypothetical protein KIAA0564 [H. sapiens], KIAA0564 | B |
| | | | | protein | |
| 3822 | 211 | AA900863 | | EST, Moderately similar to HLA-B-associated transcript 1A; DNA segment, Chr 17, | GENERAL, H |
| | | | | human D6S81E 1; nuclear RNA helicase Bat1 [Mus musculus] [M. musculus], EST, | |
| | | | | Weakly similar to HE47_RAT Probable ATP-dependent RNA helicase p47 | |
| | | | | [R. norvegicus], ESTs, Moderately similar to IF41_HUMAN EUKARYOTIC INITIATION | |
| | | | | FACTOR 4A-I [M. musculus], ESTs, Weakly similar to HE47 RAT PROBABLE ATP- | |
| | | | | DEPENDENT RNA HELICASE P47 [R. norvegicus], HLA-B-associated transcript 1A, | |
| | | | | RIKEN cDNA 2410004K13 gene, RIKEN cDNA 2600001H07 gene, RIKEN cDNA | |
| | | | | 2610307C23 gene, eukaryotic translation initiation factor 4A, isoform 1, eukaryotic | |
| | | | | translation initiation factor 4A1 | |
| 3823 | 706 | AI233147 | | EST, Moderately similar to HLA-B-associated transcript 1A; DNA segment, Chr 17, | GENERAL |
| | | | | human D6S81E 1; nuclear RNA helicase Bat1 [Mus musculus] [M. musculus], EST, | |
| | | | | Weakly similar to HE47_RAT Probable ATP-dependent RNA helicase p47 | |
| | | | | [R. norvegicus], ESTs, Moderately similar to IF41_HUMAN EUKARYOTIC INITIATION | |
| | | | | FACTOR 4A-I [M. musculus], ESTs, Weakly similar to HE47 RAT PROBABLE ATP- | |
| | | | | DEPENDENT RNA HELICASE P47 [R. norvegicus], HLA-B-associated transcript 1A, | |
| | | | | RIKEN cDNA 2410004K13 gene, RIKEN cDNA 2600001H07 gene, RIKEN cDNA | |
| | | | | 2610307C23 gene, eukaryotic translation initiation factor 4A, isoform 1, eukaryotic | |
| | | | | translation initiation factor 4A1 | |
| 23115 | 29 | AA801165 | | EST, Moderately similar to RIKEN cDNA 1700113O17 [Mus musculus] [M. musculus], | A, F |
| | | | | H2A histone family, member L, Homo sapiens, clone MGC: 21597 IMAGE: 4511035, | |
| | | | | mRNA, complete cds, Mus musculus, similar to H2A histone family, member O, clone | |
| | | | | MGC: 36202 IMAGE: 5055276, mRNA, complete cds, expressed sequence R75370 | |
| 15489 | 1060 | NM_031137 | | EST, Moderately similar to tripeptidylpeptidase II [Rattus norvegicus] [R. norvegicus], | F |
| | | | | ESTs, Highly similar to TRIPEPTIDYL-PEPTIDASE II [M. musculus], tripeptidyl peptidase | |
| | | | | II | |
| 14983 | 637 | AI179150 | | EST, Moderately similar to 0806162B cytochrome b [M. musculus], EST, Moderately | D |
| | | | | similar to 810024B cytochrome b [H. sapiens], EST, Weakly similar to 0806162B | |
| | | | | cytochrome b [M. musculus], EST, Weakly similar to 0812187A cytochrome b [Rattus | |
| | | | | norvegicus] [R. norvegicus], EST, Weakly similar to 810024M URF 6 [H. sapiens] | |
| 1570 | 1164 | NM_053857 | | EST, Moderately similar to 2021415A initiation factor 4E-binding protein: ISOTYPE = 1 | A |
| | | | | [H. sapiens], ESTs, Weakly similar to A55258 insulin-stimulated phosphoprotein PHAS-I- | |
| | | | | rat [R. norvegicus], RIKEN cDNA 1110004O12 gene, eukaryotic translation initiation factor | |
| | | | | 4E binding protein 1, eukaryotic translation initiation factor 4E binding protein 2, | |
| | | | | eukaryotic translation initiation factor 4E binding protein 3 | |
| 15185 | 1062 | NM_031140 | | EST, Moderately similar to A25074 vimentin [H. sapiens], EST, Weakly similar to A25074 | GENERAL |
| | | | | vimentin [H. sapiens], ESTs, Weakly similar to A25074 vimentin [H. sapiens], Mus | |
| | | | | musculus, similar to FLJ00074 protein, clone MGC: 36549 IMAGE: 4952810, mRNA, | |
| | | | | complete cds, desmuslin, intermediate filament-like MGC: 2625, vimentin | |
| 1501 | 489 | AI072634 | | EST, Moderately similar to A40452 keratin 21, type I, cytoskeletal - rat [R. norvegicus], | GENERAL, C, G, K |
| | | | | ESTs, Weakly similar to A40452 keratin 21, type I, cytoskeletal - rat [R. norvegicus], | |
| | | | | RIKEN cDNA 9030623C06 gene, Rat cytokeratin 21 mRNA, complete cds, keratin 18, | |
| | | | | keratin complex 1, acidic, gene 18 | |
| 9504 | 549 | AI136723 | | EST, Moderately similar to HKR3_HUMAN KRUEPPEL-RELATED ZINC FINGER | F |
| | | | | PROTEIN 3 [H. sapiens], EST, Weakly similar to ZF37_RAT Zinc finger protein 37 (Zfp- | |
| | | | | 37) [R. norvegicus], ESTs, Weakly similar to I48668 zinc finger protein 51 - mouse | |
| | | | | [M. musculus], ESTs, Weakly similar to ZF93_MOUSE ZINC FINGER PROTEIN 93 (ZFP- | |
| | | | | 93) [M. musculus], GLI-Kruppel family member HKR3, Mus musculus, clone MGC: 35978 | |
| | | | | IMAGE: 5353641, mRNA, complete cds, zinc finger protein 37, zinc finger protein 37 | |
| | | | | homolog (mouse) zinc finger protein 51 | |
| 22412 | 1005 | NM_022392 | | EST, Moderately similar to ISI1_RAT Insulin-induced protein 1 (Insulin-induced growth | C, H |
| | | | | response protein CL-6) (Immediate-early protein CL-6) [R. norvegicus], RIKEN cDNA | |
| | | | | 2900053I11 gene, insulin induced gene 1, insulin induced protein 2 | |
| 22413 | 1005 | NM_022392 | | EST, Moderately similar to ISI1_RAT Insulin-induced protein 1 (Insulin-induced growth | C, H |
| | | | | response protein CL-6) (Immediate-early protein CL-6) [R. norvegicus], RIKEN cDNA | |
| | | | | 2900053I11 gene, insulin induced gene 1, insulin induced protein 2 | |
| 22414 | 1005 | NM_022392 | | EST, Moderately similar to ISI1_RAT Insulin-induced protein 1 (Insulin-induced growth | H |
| | | | | response protein CL-6) (Immediate-early protein CL-6) [R. norvegicus], RIKEN cDNA | |
| | | | | 2900053I11 gene, insulin induced gene 1, insulin induced protein 2 | |
| 22415 | 1005 | NM_022392 | | EST, Moderately similar to ISI1_RAT Insulin-induced protein 1 (Insulin-induced growth | C |
| | | | | response protein CL-6) (Immediate-early protein CL-6) [R. norvegicus], RIKEN cDNA | |
| | | | | 2900053I11 gene, insulin induced gene 1, insulin induced protein 2 | |
| 165 | 561 | AI145329 | | EST, Moderately similar to MDHM_RAT MALATE DEHYDROGENASE, | F |
| | | | | MITOCHONDRIAL PRECURSOR [R. norvegicus], EST, Weakly similar to DEMSMM | |
| | | | | malate dehydrogenase [M. musculus], malate dehydrogenase 2, NAD (mitochondrial), | |
| | | | | malate dehydrogenase, mitochondrial | |
| 1478 | 843 | NM_012744 | | EST, Moderately similar to PYC_RAT Pyruvate carboxylase, mitochondrial precursor | GENERAL |
| | | | | (Pyruvic carboxylase) (PCB) [R. norvegicus], Mus musculus, Similar to Propionyl | |
| | | | | Coenzyme A carboxylase, alpha polypeptide, clone MGC: 11973 IMAGE: 3601148, | |
| | | | | mRNA, complete cds, pyruvate carboxylase, pyruvate decarboxylase | |
| 1479 | 843 | NM_012744 | | EST, Moderately similar to PYC_RAT Pyruvate carboxylase, mitochondrial precursor | D |
| | | | | (Pyruvic carboxylase) (PCB) [R. norvegicus], Mus musculus, Similar to Propionyl | |
| | | | | Coenzyme A carboxylase, alpha polypeptide, clone MGC: 11973 IMAGE: 3601148, | |
| | | | | mRNA, complete cds, pyruvate carboxylase, pyruvate decarboxylase | |
| 20873 | 616 | AI177042 | | EST, Moderately similar to R3RT19 ribosomal protein S19, cytosolic [validated] - rat | G |
| | | | | [R. norvegicus], EST, Weakly similar to RS19_HUMAN 40S RIBOSOMAL PROTEIN S19 | |
| | | | | [H. sapiens] | |
| 4441 | 1249 | X62146 | | EST, Moderately similar to RL11_HUMAN 60S RIBOSOMAL PROTEIN L11 [H. sapiens], | G |
| | | | | EST, Moderately similar to RL11_HUMAN 60S ribosomal protein L11 [R. norvegicus], | |
| | | | | EST, Weakly similar to RL11_HUMAN 60S RIBOSOMAL PROTEIN L11 [H. sapiens], | |
| | | | | ESTs, Highly similar to RIKEN cDNA 2010203J19 [Mus musculus] [M. musculus], ESTs, | |
| | | | | Moderately similar to RL11_HUMAN 60S RIBOSOMAL PROTEIN L11 [H. sapiens], | |
| | | | | RIKEN cDNA 2010203J19 gene, ribosomal protein L11 | |
| 17175 | 1243 | X58389 | | EST, Moderately similar to RL17_HUMAN 60S RIBOSOMAL PROTEIN L17 [H. sapiens], | GENERAL |
| | | | | EST, Weakly similar to RL17 RAT 60S RIBOSOMAL PROTEIN L17 [R. norvegicus], EST, | |
| | | | | Weakly similar to RL17_HUMAN 60S RIBOSOMAL PROTEIN L17 [H. sapiens], ESTs, | |
| | | | | Highly similar to R5HU22 ribosomal protein L17, cytosolic [H. sapiens], ESTs, Highly | |
| | | | | similar to RL17 RAT 60S RIBOSOMAL PROTEIN L17 [R. norvegicus], ESTs, Weakly | |
| | | | | similar to R5HU22 ribosomal protein L17, cytosolic [H. sapiens], Mus musculus adult | |
| | | | | female placenta cDNA, RIKEN full-length enriched library, clone: 1600029O15: hexokinase | |
| | | | | 1 full insert sequence ribosomal protein L17 | |
| 18642 | 500 | AI102023 | | EST, Moderately similar to RL35_HUMAN 60S RIBOSOMAL PROTEIN L3 [H. sapiens], | C |
| | | | | EST, Moderately similar to RL35_RAT 60S RIBOSOMAL PROTEIN L35 [R. norvegicus], | |
| | | | | Homo sapiens, clone IMAGE: 4183312, mRNA, partial cds, ribosomal protein L35 | |
| 24108 | 679 | AI230728 | | EST, Moderately similar to Rna-Binding Domain Of The U1a Spliceosomal Protein | G |
| | | | | U1a117, Nmr, 43 Structures {SUB 2-117 [H. sapiens], EST, Weakly similar to Rna-Binding | |
| | | | | Domain Of The U1a Spliceosomal Protein U1a117, Nmr, 43 Structures {SUB 2-117 | |
| | | | | [H. sapiens], ESTs, Moderately similar to Rna-Binding Domain Of The U1a Spliceosomal | |
| | | | | Protein U1a117, Nmr, 43 Structures {SUB 2-117 [H. sapiens], U2 small nuclear | |
| | | | | ribonucleoprotein B, small nuclear ribonucleoprotein polypeptide A | |
| 13647 | 155 | AA892367 | | EST, Moderately similar to S34195 ribosomal protein L3, cytosolic [H. sapiens], EST, | G |
| | | | | Weakly similar to S34195 ribosomal protein L3, cytosolic [H. sapiens], ESTs, Highly | |
| | | | | similar to S34195 ribosomal protein L3, cytosolic [H. sapiens], ESTs, Moderately similar to | |
| | | | | RL3_RAT 60S RIBOSOMAL PROTEIN L3 (L4) [R. norvegicus], ESTs, Weakly similar to | |
| | | | | RL3 MOUSE 60S RIBOSOMAL PROTEIN L3 [M. musculus], RIKEN cDNA 1110057H16 | |
| | | | | gene, ribosomal protein L3, ribosomal protein L3-like | |
| 13646 | 1250 | X62166 | | EST, Moderately similar to S34195 ribosomal protein L3, cytosolic [H. sapiens], EST, | GENERAL, A, G |
| | | | | Weakly similar to S34195 ribosomal protein L3, cytosolic [H. sapiens], ESTs, Highly | |
| | | | | similar to S34195 ribosomal protein L3, cytosolic [H. sapiens], ESTs, Moderately similar to | |
| | | | | RL3_RAT 60S RIBOSOMAL PROTEIN L3 (L4) [R. norvegicus], ESTs, Weakly similar to | |
| | | | | RL3 MOUSE 60S RIBOSOMAL PROTEIN L3 [M. musculus], RIKEN cDNA 1110057H16 | |
| | | | | gene, ribosomal protein L3, ribosomal protein L3-like | |
| 2232 | 303 | AA963990 | | EST, Moderately similar to S70642 ubiquitin ligase Nedd4 - rat (fragment) [R. norvegicus], | D |
| | | | | ESTs, Highly similar to S70642 ubiquitin ligase Nedd4 - rat (fragment) [R. norvegicus], | |
| | | | | ESTs, Moderately similar to S70642 ubiquitin ligase Nedd4 - rat (fragment) | |
| | | | | [R. norvegicus], ESTs, Weakly similar to NED4 MOUSE NEDD-4 PROTEIN | |
| | | | | [M. musculus], neural precursor cell expressed, developmentally down-regulated 4, neural | |
| | | | | precursor cell expressed, developmentally down-regulated gene 4a | |
| 15191 | 608 | AI176456 | | EST, Moderately similar to SMHU1E metallothionein 1E [H. sapiens], ESTs, Highly similar | GENERAL, F, L |
| | | | | to SMHU1B metallothionein 1B [H. sapiens], H. sapiens mRNA for metallothionein isoform | |
| | | | | 1R, Homo sapiens metallothionein 1H-like protein mRNA, complete cds, Homo sapiens | |
| | | | | unknown mRNA, Homo sapiens, Similar to RNA helicase-related protein, clone | |
| | | | | MGC: 9246 IMAGE: 3892441, mRNA, complete cds, Mus musculus, metallothionein 2A, | |
| | | | | clone MGC: 30400 IMAGE: 4501155, mRNA, complete cds, metallothionein 1H, | |
| | | | | metallothionein 1X metallothionein 2 | |
| 13607 | 640 | AI179403 | | EST, Moderately similar to U520_HUMAN U5 SMALL NUCLEAR | H |
| | | | | RIBONUCLEOPROTEIN 200 KDA HELICASE (U5 SNRNP-SPECIFIC 200 KDA | |
| | | | | PROTEIN) (U5-200 KD) [H. sapiens], Homo sapiens cDNA FLJ11356 fis, clone | |
| | | | | HEMBA1000150, highly similar to Homo sapiens putative RNA helicase mRNA, Homo | |
| | | | | sapiens cDNA FLJ11521 fis, clone HEMBA1002486, KIAA0788 protein, RNA helicase | |
| | | | | family | |
| 21491 | 1027 | NM_022951 | | EST, Weakly similar to proline rich protein 2 [Mus musculus] [M. musculus], EST, Weakly | B |
| | | | | similar to ZAP3_MOUSE Nuclear protein ZAP3 [M. musculus], ESTs, Weakly similar to | |
| | | | | proline rich protein 2 [Mus musculus] [M. musculus], expressed sequence AA408880, | |
| | | | | pantothenate kinase, proline rich protein 2, protein phosphatase 1, regulatory subunit 10 | |
| 20810 | 1235 | X14181 | | EST, Weakly similar to ribosomal protein L18a; 60S ribosomal protein L18a [Homo | G |
| | | | | sapiens] [H. sapiens], ESTs, Highly similar to ribosomal protein L18a; 60S ribosomal | |
| | | | | protein L18a [Homo sapiens] [H. sapiens] | |
| 18269 | 129 | AA891769 | | EST, Weakly similar to SC65 synaptonemal complex protein [Rattus norvegicus] | GENERAL, D, L |
| | | | | [R. norvegicus], ESTs, Weakly similar to SC65 synaptonemal complex protein [Rattus | |
| | | | | norvegicus] [R. norvegicus], SC65 synaptonemal complex protein, cartilage associated | |
| | | | | protein, growth suppressor 1, nucleolar autoantigen (55 kD) similar to rat synaptonemal | |
| | | | | complex protein | |
| 6917 | 1 | AA012709 | | EST, Weakly similar to splicing factor 3b, subunit 1, 155 kDa [Mus musculus] | B |
| | | | | [M. musculus], ESTs, Weakly similar to S3B1_HUMAN Splicing factor 3B subunit 1 | |
| | | | | (Spliceosome associated protein 155) (SAP 155) (SF3b155) (Pre-mRNA splicing factor | |
| | | | | SF3b 155 kDa subunit) [H. sapiens], splicing factor 3b, subunit 1, 155 kDa, splicing factor | |
| | | | | 3b, subunit 1, 155 kD | |
| 3125 | 682 | AI231028 | | EST, Weakly similar to 2102279A protein Tyr phosphatase [Rattus norvegicus] | K |
| | | | | [R. norvegicus], erythrocyte membrane protein band 4.1-like 1, erythrocyte protein band | |
| | | | | 4.1-like 1, protein tyrosine phosphatase 2E, protein tyrosine phosphatase, non-receptor | |
| | | | | type 14, protein tyrosine phosphatase, non-receptor type 21 | |
| 15135 | 1170 | NM_053971 | | EST, Weakly similar to 60S RIBOSOMAL PROTEIN L6 [M. musculus], ESTs, Weakly | G |
| | | | | similar to 60S RIBOSOMAL PROTEIN L6 [M. musculus], ribosomal protein L6 | |
| 3995 | 388 | AI011678 | | EST, Weakly similar to A33880 syndecan 2 [H. sapiens], Mus musculus, clone | GENERAL, I, K |
| | | | | IMAGE: 4983756, mRNA, partial cds, syndecan 2, syndecan 2 (heparan sulfate | |
| | | | | proteoglycan 1, cell surface-associated, fibroglycan) | |
| 1529 | 884 | NM_013082 | | EST, Weakly similar to A33880 syndecan 2 [H. sapiens], Mus musculus, clone | GENERAL, B, F, I |
| | | | | IMAGE: 4983756, mRNA, partial cds, syndecan 2, syndecan 2 (heparan sulfate | |
| | | | | proteoglycan 1, cell surface-associated, fibroglycan) | |
| 13633 | 1041 | NM_024403 | | EST, Weakly similar to A45377 transcription factor ATF4 [H. sapiens], ESTs, Highly | GENERAL |
| | | | | similar to A45377 transcription factor ATF4 [H. sapiens], activating transcription factor 4, | |
| | | | | activating transcription factor 4 (tax-responsive enhancer element B67), activating | |
| | | | | transcription factor 5 | |
| 13634 | 1041 | NM_024403 | | EST, Weakly similar to A45377 transcription factor ATF4 [H. sapiens], ESTs, Highly | GENERAL |
| | | | | similar to A45377 transcription factor ATF4 [H. sapiens], activating transcription factor 4, | |
| | | | | activating transcription factor 4 (tax-responsive enhancer element B67), activating | |
| | | | | transcription factor 5 | |
| 1490 | 1226 | U63839 | | EST, Weakly similar to A56573 nuclear pore complex glycoprotein p62 - mouse | E |
| | | | | [M. musculus], Mus musculus, clone IMAGE: 5148310, mRNA, RIKEN cDNA 1700017F11 | |
| | | | | gene, melanoma antigen, family D, 3, nucleoporin 98, nucleoporin 98 kD, nucleoporin p45, | |
| | | | | plasma membrane associated protein, S3-12 | |
| 17378 | 1061 | NM_031138 | | EST, Weakly similar to B41222 ubiquitin - protein ligase [H. sapiens], ESTs, Highly similar | D |
| | | | | to ubiquitin conjugating enzyme [Rattus norvegicus] [R. norvegicus], ESTs, Highly similar | |
| | | | | to A41222 ubiquitin-protein ligase [H. sapiens], ESTs, Moderately similar to B41222 | |
| | | | | ubiquitin-protein ligase [H. sapiens], ESTs, Weakly similar to UBC2_HUMAN UBIQUITIN- | |
| | | | | CONJUGATING ENZYME E2-17 KD [M. musculus], RIKEN cDNA 2610301N02 gene, | |
| | | | | expressed sequence AI327276, ubiquitin-conjugating enzyme E2A (RAD6 homolog), | |
| | | | | ubiquitin-conjugating enzyme E2A, RAD6 homolog (S. cerevisiae), ubiquitin-conjugating | |
| | | | | enzyme E2B (RAD6 homolog), ubiquitin-conjugating enzyme E2B, RAD6 homology (S. cerevisiae), | |
| | | | | ubiquitin-conjugating enzyme E2C | |
| 2010 | 1206 | U05675 | | EST, Weakly similar to beta-fibrinogen precursor [H. sapiens], ESTs, Moderately similar to | K |
| | | | | ANL2_MOUSE Angiopoietin-related protein 2 precursor (Angiopoietin-like 2) | |
| | | | | [M. musculus], ESTs, Weakly similar to FIBB_RAT Fibrinogen beta chain precursor | |
| | | | | [Contains: Fibrinopeptide B] [R. norvegicus], Mus musculus, Similar to angiopoietin- | |
| | | | | related protein 5, clone MGC: 32467 IMAGE: 5049765, mRNA, complete cds, Mus | |
| | | | | musculus, Similar to fibrinogen-like 1, clone MGC: 37822 IMAGE: 5098805, mRNA, | |
| | | | | complete cds angiopoietin-like 2, expressed sequence AI593246 | |
| 16929 | 1056 | NM_031108 | | EST, Weakly similar to COLLAGEN ALPHA 2(VI) CHAIN PRECURSOR [M. musculus], | G |
| | | | | Mus musculus, Similar to splicing factor, arginine/serine-rich 8 (suppressor-of-white- | |
| | | | | apricot homolog, Drosophila), clone MGC: 31019 IMAGE: 5006904, mRNA, complete cds, | |
| | | | | RIKEN cDNA 3010033P07 gene, expressed sequence AL022771, expressed sequence | |
| | | | | AL022885, ribosomal protein S9 | |
| 15653 | 1236 | X14210 | | EST, Weakly similar to G02526 NADH dehydrogenase [H. sapiens], NADH | G |
| | | | | dehydrogenase (ubiquinone) 1 alpha subcomplex, 5 (13 kD, B13), RIKEN cDNA | |
| | | | | 2900002J19 gene | |
| 17734 | 1114 | NM_031970 | | EST, Weakly similar to HHHU27 heat shock protein 27 [H. sapiens], ESTs, Highly similar | GENERAL, C, I |
| | | | | to HHHU27 heat shock protein 27 [H. sapiens], ESTs, Moderately similar to HHHU27 heat | |
| | | | | shock protein 27 [H. sapiens], heat shock 27 kD protein 1, hypothetical protein MGC10974 | |
| 17735 | 1114 | NM_031970 | | EST, Weakly similar to HHHU27 heat shock protein 27 [H. sapiens], ESTs, Highly similar | C, K |
| | | | | to HHHU27 heat shock protein 27 [H. sapiens], ESTs, Moderately similar to HHHU27 heat | |
| | | | | shock protein 27 [H. sapiens], heat shock 27 kD protein 1, hypothetical protein MGC10974 | |
| 17736 | 1114 | NM_031970 | | EST, Weakly similar to HHHU27 heat shock protein 27 [H. sapiens], ESTs, Highly similar | H, K |
| | | | | to HHHU27 heat shock protein 27 [H. sapiens], ESTs, Moderately similar to HHHU27 heat | |
| | | | | shock protein 27 [H. sapiens], heat shock 27 kD protein 1, hypothetical protein MGC10974 | |
| 9191 | 485 | AI072107 | | EST, Weakly similar to I73674 chlordecone reductase homolog [H. sapiens], ESTs, Highly | A |
| | | | | similar to 2008147B protein RAKc [Rattus norvegicus] [R. norvegicus], ESTs, Highly | |
| | | | | similar to DBDD_HUMAN TRANS-1,2-DIHYDROBENZENE-1,2-DIOL | |
| | | | | DEHYDROGENASE [H. sapiens], ESTs, Moderately similar to DBDD_HUMAN TRANS- | |
| | | | | 1,2-DIHYDROBENZENE-1,2-DIOL DEHYDROGENASE [H. sapiens], ESTs, Weakly | |
| | | | | similar to DHBX MOUSE ESTRADIOL 17 BETA-DEHYDROGENASE, A-SPECIFIC | |
| | | | | [M. musculus], Homo sapiens truncated AKR mRNA for truncated aldo-keto reductase | |
| | | | | type B, partial cds, aldo-keto reductase family 1, member C4 (chlordecone reductase; 3- | |
| | | | | alpha hydroxysteroid dehydrogenase, type I; dihydrodiol dehydrogenase 4), | |
| | | | | hydroxysteroid (17-beta) dehydrogenase 5 | |
| 7414 | 557 | AI137586 | | EST, Weakly similar to IMB3_HUMAN IMPORTIN BETA-3 SUBUNIT [H. sapiens], Homo | K |
| | | | | sapiens cDNA FLJ12978 fis, clone NT2RP2006321, RAN binding protein 6, importin 4 | |
| 23195 | 223 | AA925026 | | EST, Weakly similar to MAST CELL PROTEASE 7 PRECURSOR [M. musculus], ESTs, | GENERAL |
| | | | | Weakly similar to A35863 tryptase [H. sapiens], ESTs, Weakly similar to MCT6 MOUSE | |
| | | | | MAST CELL PROTEASE 6 PRECURSOR [M. musculus], ESTs, Weakly similar to | |
| | | | | MCT7_RAT Mast cell protease 7 precursor (RMCP-7) (Tryptase, skin) [R. norvegicus], | |
| | | | | Homo sapiens cDNA FLJ30744 fis, clone FEBRA2000378, mast cell protease 7, tryptase | |
| | | | | beta 1, tryptase delta 1, tryptase, alpha | |
| 24472 | 117 | AA875523 | | EST, Weakly similar to MOHU6N myosin alkali light chain 6, nonmuscle form [H. sapiens], | L |
| | | | | myosin light chain, alkali, nonmuscle, myosin, light polypeptide 6, alkali, smooth muscle | |
| | | | | and non-muscle | |
| 12587 | 668 | AI229979 | | EST, Weakly similar to MOT2_RAT Monocarboxylate transporter 2 (MCT 2) | GENERAL |
| | | | | [R. norvegicus], ESTs, Weakly similar to MOT2 MOUSE MONOCARBOXYLATE | |
| | | | | TRANSPORTER 2 [M. musculus], ESTs, Weakly similar to MOT2_RAT Monocarboxylate | |
| | | | | transporter 2 (MCT 2) [R. norvegicus], ESTs, Weakly similar to MOT3_HUMAN | |
| | | | | MONOCARBOXYLATE TRANSPORTER 3 [H. sapiens], solute carrier family 16 | |
| | | | | (monocarboxylic acid transporters), member 6, solute carrier family 16 (monocarboxylic | |
| | | | | acid transporters), member 7 | |
| 725 | 1225 | U62316 | | EST, Weakly similar to MOT2_RAT Monocarboxylate transporter 2 (MCT 2) | B |
| | | | | [R. norvegicus], ESTs, Weakly similar to MOT2 MOUSE MONOCARBOXYLATE | |
| | | | | TRANSPORTER 2 [M. musculus], ESTs, Weakly similar to MOT2_RAT Monocarboxylate | |
| | | | | transporter 2 (MCT 2) [R. norvegicus], ESTs, Weakly similar to MOT3_HUMAN | |
| | | | | MONOCARBOXYLATE TRANSPORTER 3 [H. sapiens], solute carrier family 16 | |
| | | | | (monocarboxylic acid transporters), member 6, solute carrier family 16 (monocarboxylic | |
| | | | | acid transporters), member 7 | |
| 1558 | 1217 | U28504 | | EST, Weakly similar to NPT1_RAT RENAL SODIUM-DEPENDENT PHOSPHATE | H |
| | | | | TRANSPORT PROTEIN 1 (SODIUM/PHOSPHATE COTRANSPORTER 1) (NA(+)/PI | |
| | | | | COTRANSPORTER 1) (RENAL SODIUM-PHOSPHATE TRANSPORT PROTEIN 1) | |
| | | | | (RENAL NA+-DEPENDENT PHOSPHATE COTRANSPORTER 1) [R. norvegicus], ESTs, | |
| | | | | Weakly similar to RENAL SODIUM-DEPENDENT PHOSPHATE TRANSPORT PROTEIN | |
| | | | | 1 [M. musculus], Mus musculus, Similar to solute carrier family 17 (sodium phosphate), | |
| | | | | member 2, clone MGC: 19073 IMAGE: 4193755, mRNA, complete cds, expressed | |
| | | | | sequence AW261723, solute carrier family 17 (sodium phosphate), member 1, solute | |
| | | | | carrier family 17 (sodium phosphate), member 2, solute carrier family 17 (sodium | |
| | | | | phosphate), member 3, solute carrier family 17 (sodium phosphate), member 4, solute | |
| | | | | carrier family 17 vesicular glutamate transporter), member 1 | |
| 14138 | 94 | AA859700 | | EST, Weakly similar to PPOX MOUSE PROTOPORPHYRINOGEN OXIDASE | GENERAL |
| | | | | [M. musculus], protoporphyrinogen oxidase | |
| 2109 | 1010 | NM_022511 | | EST, Weakly similar to PRO1 MOUSE PROFILIN I [M. musculus], EST, Weakly similar to | G |
| | | | | PRO2_HUMAN PROFILIN II [H. sapiens], ESTs, Weakly similar to PRO2_HUMAN | |
| | | | | PROFILIN II [H. sapiens], Mk1 protein, profilin 1 | |
| 5208 | 747 | AI236754 | | EST, Weakly similar to PRP3 MOUSE PROLINE-RICH PROTEIN MP-3 [M. musculus], | G |
| | | | | ESTs, Weakly similar to PRP3 MOUSE PROLINE-RICH PROTEIN MP-3 [M. musculus], | |
| | | | | Mus musculus, clone IMAGE: 5251262, mRNA, partial cds, expressed sequence C78515, | |
| | | | | pregnancy-induced growth inhibitor | |
| 18606 | 1239 | X53504 | | EST, Weakly similar to RL12_HUMAN 60S RIBOSOMAL PROTEIN L12 [H. sapiens], | GENERAL |
| | | | | ESTs, Weakly similar to RL12_HUMAN 60S RIBOSOMAL PROTEIN L12 [H. sapiens], | |
| | | | | ribosomal protein L12 | |
| 6049 | 3 | AA685178 | | EST, Weakly similar to S49326 nascent polypeptide-associated complex alpha chain | F |
| | | | | [H. sapiens], EST, Weakly similar to T30827 nascent polypeptide-associated complex | |
| | | | | alpha chain, non-muscle splice form - mouse [M. musculus], FKSG17, KIAA0363 protein, | |
| | | | | expressed sequence AL022831, nascent-polypeptide-associated complex alpha | |
| | | | | polypeptide | |
| 11953 | 501 | AI102505 | | EST, Weakly similar to S71929 cytochrome-c oxidase (EC 1.9.3.1) chain VIII precursor, | A |
| | | | | hepatic - mouse [M. musculus], cytochrome c oxidase, subunit VIIIa, heme-regulated | |
| | | | | initiation factor 2-alpha kinase | |
| 6059 | 632 | AI178245 | | EST, Weakly similar to T13963 formin related protein, lymphocyte specific - mouse | GENERAL, J |
| | | | | [M. musculus], ESTs, Highly similar to T13963 formin related protein, lymphocyte specific - | |
| | | | | mouse [M. musculus], ESTs, Moderately similar to T13963 formin related protein, | |
| | | | | lymphocyte specific - mouse [M. musculus], Homo sapiens mRNA; cDNA DKFZp762B245 | |
| | | | | (from clone DKFZp762B245); partial cds, formin homology 2 domain containing 1, formin- | |
| | | | | like | |
| 17159 | 787 | J00797 | | EST, Weakly similar to TBA1 MOUSE TUBULIN ALPHA-1 CHAIN [M. musculus], tubulin, | GENERAL, G, K |
| | | | | alpha 1, tubulin, alpha 2, tubulin, alpha 3, tubulin, alpha 6, tubulin, alpha 7, tubulin, alpha, | |
| | | | | ubiquitous | |
| 17161 | 1002 | NM_022298 | | EST, Weakly similar to TBA1 MOUSE TUBULIN ALPHA-1 CHAIN [M. musculus], tubulin, | GENERAL |
| | | | | alpha 1, tubulin, alpha 2, tubulin, alpha 3, tubulin, alpha 6, tubulin, alpha 7, tubulin, alpha, | |
| | | | | ubiquitous | |
| 13974 | 103 | AA860030 | | EST, Weakly similar to TBB5 MOUSE TUBULIN BETA-5 CHAIN [M. musculus], RIKEN | GENERAL, F |
| | | | | cDNA 2310061K05 gene, RIKEN cDNA 2410129E14 gene, RIKEN cDNA 4930542G03 | |
| | | | | gene, tubulin, beta 5, tubulin, beta polypeptide, tubulin, beta, 2, tubulin, beta, 5 | |
| 13973 | 334 | AB011679 | | EST, Weakly similar to TBB5 MOUSE TUBULIN BETA-5 CHAIN [M. musculus], RIKEN | E |
| | | | | cDNA 2310061K05 gene, RIKEN cDNA 2410129E14 gene, RIKEN cDNA 4930542G03 | |
| | | | | gene, tubulin, beta 5, tubulin, beta polypeptide, tubulin, beta, 2, tubulin, beta, 5 | |
| 15273 | 1063 | NM_031237 | | EST, Weakly similar to UB5C_HUMAN Ubiquitin-conjugating enzyme E2-17 kDa 3 | E |
| | | | | (Ubiquitin-protein ligase) (Ubiquitin carrier protein) (E2(17)KB 3) [R. norvegicus], ESTs, | |
| | | | | Weakly similar to S53358 ubiquitin-conjugating enzyme E2.17 kB - rat [R. norvegicus], | |
| | | | | Homo sapiens EST from clone 37208, full insert, RIKEN cDNA 1100001F19 gene, | |
| | | | | RIKEN cDNA 1600028I17 gene, prefoldin 5, ubiquitin-conjugating enzyme E2D 3 | |
| | | | | (UBC4/5 homolog, yeast) | |
| 15277 | 1063 | NM_031237 | | EST, Weakly similar to UB5C_HUMAN Ubiquitin-conjugating enzyme E2-17 kDa 3 | D |
| | | | | (Ubiquitin-protein ligase) (Ubiquitin carrier protein) (E2(17)KB 3) [R. norvegicus], ESTs, | |
| | | | | Weakly similar to S53358 ubiquitin-conjugating enzyme E2.17 kB - rat [R. norvegicus], | |
| | | | | Homo sapiens EST from clone 37208, full insert, RIKEN cDNA 1100001F19 gene, | |
| | | | | RIKEN cDNA 1600028I17 gene, prefoldin 5, ubiquitin-conjugating enzyme E2D 3 | |
| | | | | (UBC4/5 homolog, yeast) | |
| 15302 | 9 | AA799518 | | ESTs, Highly similar to hypothetical protein FLJ13725; KIAA1930 protein [Homo sapiens] | GENERAL |
| | | | | [H. sapiens] | |
| 15303 | 9 | AA799518 | | ESTs, Highly similar to hypothetical protein FLJ13725; KIAA1930 protein [Homo sapiens] | F |
| | | | | [H. sapiens] | |
| 16913 | 652 | AI228236 | | ESTs, Highly similar to neuronal protein 17.3; similar to mouse neuronal protein 15.6 | E |
| | | | | [Homo sapiens] [H. sapiens], nuclear protein 15.6 | |
| 23307 | 1176 | NM_057119 | | ESTs, Highly similar to TLS-associated serine-arginine protein 1, isoform 1; TLS- | D |
| | | | | associated serine-arginine protein 1; TLS-associated protein TASR [Homo sapiens] | |
| | | | | [H. sapiens], ESTs, Weakly similar to splicing factor, arginine/serine-rich (transformer 2 | |
| | | | | Drosophila homolog) 10 [Rattus norvegicus] [R. norvegicus], Mus musculus | |
| | | | | hexaribonucleotide binding protein 3 (Hrnbp3) mRNA, partial cds, RIKEN cDNA | |
| | | | | 1500010G04 gene, neural-salient serine/arginine-rich, silica-induced gene 41, splicing | |
| | | | | factor arginine/serine-rich 10 (transformer 2 homolog Drosophila) | |
| 2250 | 1024 | NM_022643 | | ESTs, Highly similar to 0506206A histone H2B [Rattus norvegicus] [R. norvegicus], H2B | GENERAL |
| | | | | histone family, member A, H2B histone family, member B, H2B histone family, member | |
| | | | | D, H2B histone family, member G, H2B histone family, member H, H2B histone family, | |
| | | | | member K, histone family member | |
| 20082 | 771 | AI639488 | | ESTs, Highly similar to 1814460A p53-associated protein [H. sapiens], Mdm2, | GENERAL, H, I, J |
| | | | | transformed 3T3 cell double minute 2, p53 binding protein (mouse), transformed mouse | |
| | | | | 3T3 cell double minute 2 | |
| 20848 | 954 | NM_017343 | | ESTs, Highly similar to A37100 myosin regulatory light chain A, smooth muscle - rat | GENERAL, G, K |
| | | | | [R. norvegicus], RIKEN cDNA 2900073G15 gene, myosin light chain, phosphorylatable, | |
| | | | | cardiac ventricles, myosin regulatory light chain, myosin, light polypeptide, regulatory, | |
| | | | | non-sarcomeric (20 kD) | |
| 20849 | 954 | NM_017343 | | ESTs, Highly similar to A37100 myosin regulatory light chain A, smooth muscle - rat | GENERAL, G, K |
| | | | | [R. norvegicus], RIKEN cDNA 2900073G15 gene, myosin light chain, phosphorylatable, | |
| | | | | cardiac ventricles, myosin regulatory light chain, myosin, light polypeptide, regulatory, | |
| | | | | non-sarcomeric (20 kD) | |
| 4198 | 814 | M83143 | | ESTs, Highly similar to A41734 beta-galactoside alpha-2,6-sialyltransferase [H. sapiens], | GENERAL, I |
| | | | | sialyltransferase 1 (beta-galactoside alpha-2,6-sialyltransferase), sialyltransferase 1 (beta- | |
| | | | | galactoside alpha-2,6-sialytransferase) | |
| 4199 | 814 | M83143 | | ESTs, Highly similar to A41734 beta-galactoside alpha-2,6-sialyltransferase [H. sapiens], | GENERAL |
| | | | | sialyltransferase 1 (beta-galactoside alpha-2,6-sialyltransferase), sialyltransferase 1 (beta- | |
| | | | | galactoside alpha-2,6-sialytransferase) | |
| 6290 | 571 | AI169232 | | ESTs, Highly similar to ANK1 MOUSE ANKYRIN 1 [M. musculus], ESTs, Weakly similar | C |
| | | | | to ANK1 MOUSE ANKYRIN 1 [M. musculus], GASZ, Gasz, Homo sapiens cDNA | |
| | | | | FLJ25053 fis, clone CBL04266, Mus musculus ankyrin repeat domain-containing SOCS | |
| | | | | box protein Asb-16 mRNA, complete cds, Mus musculus, Similar to hypothetical protein | |
| | | | | DKFZp564O043, clone MGC: 36949 IMAGE: 4946879, mRNA, complete cds, RIKEN | |
| | | | | cDNA 1110058D09 gene, RIKEN cDNA 4933400N19 gene, hypothetical protein similar to | |
| | | | | ankyrin repeat-containing priotein AKR1, likely homolog of rat kinase D-interacting | |
| | | | | substance of 220 kDa, regulatory factor X-associated ankyrin-containing protein | |
| 20682 | 1028 | NM_022952 | | ESTs, Highly similar to AP19_HUMAN CLATHRIN COAT ASSEMBLY PROTEIN AP19 | B |
| | | | | [H. sapiens], ESTs, Highly similar to clathrin-associated protein AP17 delta [H. sapiens], | |
| | | | | ESTs, Weakly similar to A2S1_MOUSE Clathrin coat assembly protein AP17 (Clathrin | |
| | | | | coat associated protein AP17) (Plasma membrane adaptor AP-2 17 kDa protein) (HA2 17 kDa | |
| | | | | subunit) (Clathrin assembly protein 2 small chain) [R. norvegicus], Homo sapiens, | |
| | | | | clone MGC: 17284 IMAGE: 4340257, mRNA, complete cds, adaptor-related protein | |
| | | | | complex 2, sigma 1 subunit, expressed sequence AI043088 | |
| 19235 | 441 | AI045074 | | ESTs, Highly similar to BGAL MOUSE BETA-GALACTOSIDASE PRECURSOR | GENERAL |
| | | | | [M. musculus], RIKEN cDNA 2810025E10 gene, galactosidase, beta 1, hypothetical | |
| | | | | protein BC008326, hypothetical protein BC011001 | |
| 20753 | 1104 | NM_031763 | | ESTs, Highly similar to CIA1_HUMAN WD40-REPEAT CONTAINING PROTEIN CIAO 1 | GENERAL, C, I |
| | | | | [H. sapiens], ESTs, Weakly similar to LIS1_HUMAN PLATELET-ACTIVATING FACTOR | |
| | | | | ACETYLHYDROLASE IB ALPHA SUBUNIT [H. sapiens], ESTs, Weakly similar to | |
| | | | | LIS1_MOUSE Platelet-activating factor acetylhydrolase IB alpha subunit (PAF | |
| | | | | acetylhydrolase 45 kDa subunit) (PAF-AH 45 kDa subunit) (PAF-AH alpha) (PAFAH | |
| | | | | alpha) (Lissencephaly-1 protein) (LIS-1) [R. norvegicus], F-box and WD-40 domain protein | |
| | | | | 7 (archipelago homolog, Drosophila), Homo sapiens cDNA FLJ31861 fis, clone | |
| | | | | NT2RP7001319, KIAA0007 protein, MEP50 protein, Mus musculus F-box-WD40 repeat | |
| | | | | protein 6 (Fbxw6) mRNA, complete cds, Mus musculus, Similar to RIKEN cDNA | |
| | | | | 1500041N16 gene, clone MGC: 12066 IMAGE: 3708188, mRNA, complete cds, | |
| | | | | hypothetical protein FLJ11848, hypothetical protein similar to beta-transducin family, | |
| | | | | platelet-activating factor acetylhydrolase, isoform 1b, beta1 subunit, platelet-activating | |
| | | | | factor acetylhydrolase, isoform lb, alpha subunit (45 kD) | |
| 13954 | 1168 | NM_053955 | | ESTs, Highly similar to CRYM_HUMAN MU-CRYSTALLIN HOMOLOG [H. sapiens], | GENERAL |
| | | | | crystallin, mu | |
| 17570 | 626 | AI177683 | | ESTs, Highly similar to DDRT helix-destabilizing protein - rat [R. norvegicus], ESTs, | C, E |
| | | | | Highly similar to ROA3_HUMAN HETEROGENEOUS NUCLEAR | |
| | | | | RIBONUCLEOPROTEIN A3 [H. sapiens], ESTs, Highly similar to S12520 core protein A1 | |
| | | | | [H. sapiens], ESTs, Highly similar to heterogeneous ribonuclear particle protein A1 | |
| | | | | [H. sapiens], ESTs, Moderately similar to heterogeneous ribonuclear particle protein A1 | |
| | | | | [H. sapiens], ESTs, Weakly similar to ROA2 MOUSE HETEROGENEOUS NUCLEAR | |
| | | | | RIBONUCLEOPROTEINS A2/B1 [M. musculus], Mus musculus, similar to heterogeneous | |
| | | | | nuclear ribonucleoprotein A3 (H. sapiens), clone MGC: 37309 IMAGE: 4975085, mRNA, | |
| | | | | complete cds, RIKEN cDNA 2610510D13 gene, RIKEN cDNA 3010025E17 gene, | |
| | | | | heterogeneous nuclear ribonucleoprotein A1, heterogeneous nuclear ribonucleoprotein | |
| | | | | A2/B1, heterogeneous nuclear ribonucleoprotein A3, hypothetical protein 23851 | |
| 2242 | 1138 | NM_053433 | | ESTs, Highly similar to FMO3_HUMAN DIMETHYLANILINE MONOOXYGENASE | GENERAL, H, I, J |
| | | | | [H. sapiens], ESTs, Weakly similar to FMO3_HUMAN DIMETHYLANILINE | |
| | | | | MONOOXYGENASE [H. sapiens], Mus musculus flavin-containing monooxygenase 4 | |
| | | | | mRNA, complete cds, flavin containing monooxygenase 2, flavin containing | |
| | | | | monooxygenase 3, flavin containing monooxygenase 5 | |
| 1546 | 1231 | U85512 | | ESTs, Highly similar to GFRP RAT GTP CYCLOHYDROLASE I FEEDBACK | GENERAL, G |
| | | | | REGULATORY PROTEIN [R. norvegicus], GTP cyclohydrolase I feedback regulatory | |
| | | | | protein | |
| 24211 | 540 | AI111853 | | ESTs, Highly similar to H33_HUMAN HISTONE H3.3 [H. sapiens], H3 histone, family 3A, | G |
| | | | | H3 histone, family 3B, H3 histone, family 3B (H3.3B), RIKEN cDNA 1810027O10 gene | |
| 15642 | 1172 | NM_053985 | | ESTs, Highly similar to H33_HUMAN HISTONE H3.3 [H. sapiens], H3 histone, family 3A, | GENERAL, F, J |
| | | | | H3 histone, family 3B, H3 histone, family 3B (H3.3B), RIKEN cDNA 1810027O10 gene | |
| 19110 | 872 | NM_012963 | | ESTs, Highly similar to HMG1_HUMAN HIGH MOBILITY GROUP PROTEIN HMG1 | A, J |
| | | | | [H. sapiens], ESTs, Moderately similar to HMG1 MOUSE HIGH MOBILITY GROUP | |
| | | | | PROTEIN HMG1 [M. musculus], ESTs, Moderately similar to high mobility group protein | |
| | | | | homolog HMG4 [M. musculus], ESTs, Weakly similar to HMG1_HUMAN HIGH MOBILITY | |
| | | | | GROUP PROTEIN HMG1 [H. sapiens], RIKEN cDNA 4932431P20 gene, Rattus | |
| | | | | norvegicus epidermal Langerhans cell protein LCP1 mRNA, complete cds, high mobility | |
| | | | | group 20A, high mobility group box 1, high-mobility group (nonhistone chromosomal) | |
| | | | | protein 1 high-mobility group 20A | |
| 19433 | 57 | AA819776 | | ESTs, Highly similar to HS9A_HUMAN HEAT SHOCK PROTEIN HSP 90-ALPHA | H |
| | | | | [H. sapiens], ESTs, Highly similar to HS9B_RAT Heat shock protein HSP 90-beta (HSP | |
| | | | | 84) [R. norvegicus], ESTs, Highly similar to T46243 hypothetical protein | |
| | | | | DKFZp761K0511.1 [H. sapiens], Mus musculus, clone IMAGE: 3584589, mRNA, partial | |
| | | | | cds, expressed sequence C81438, heat shock 90 kD protein 1, beta, heat shock protein, | |
| | | | | 84 kDa 1, heat shock protein, 86 kDa 1 | |
| 20795 | 253 | AA944397 | | ESTs, Highly similar to HS9B_RAT Heat shock protein HSP 90-beta (HSP 84) | H |
| | | | | [R. norvegicus], ESTs, Highly similar to T46243 hypothetical protein DKFZp761K0511.1 | |
| | | | | [H. sapiens], Mus musculus, clone IMAGE: 3584589, mRNA, partial cds, expressed | |
| | | | | sequence C81438, heat shock 90 kD protein 1 beta, heat shock protein, 84 kDa 1, heat | |
| | | | | shock protein, 86 kDa 1 | |
| 16518 | 612 | AI176546 | | ESTs, Highly similar to HS9B_RAT Heat shock protein HSP 90-beta (HSP 84) | C, K |
| | | | | [R. norvegicus], ESTs, Highly similar to T46243 hypothetical protein DKFZp761K0511.1 | |
| | | | | [H. sapiens], Mus musculus, clone IMAGE: 3584589, mRNA, partial cds, expressed | |
| | | | | sequence C81438, heat shock 90 kD protein 1, beta, heat shock protein, 84 kDa 1, heat | |
| | | | | shock protein, 86 kDa 1 | |
| 67 | 1085 | NM_031605 | | ESTs, Highly similar to I65981 fatty acid omega-hydroxylase [H. sapiens], Homo sapiens, | B |
| | | | | Similar to cytochrome P450, subfamily IVA, polypeptide 11, clone MGC: 22151 | |
| | | | | IMAGE: 4072062, mRNA, complete cds, Mus musculus, Similar to cytochrome P450, | |
| | | | | 4a10, clone MGC: 18880 IMAGE: 4237837, mRNA, complete cds, Mus musculus, Similar | |
| | | | | to cytochrome P450, 4a10, clone MGC: 25972 IMAGE: 4240359, mRNA, complete cds, | |
| | | | | RIKEN cDNA A230105L22 gene, cytochrome P450, 4a10, expressed sequence | |
| | | | | AI314743 | |
| 11840 | 1258 | Y15068 | | ESTs, Highly similar to IEFS_HUMAN TRANSFORMATION-SENSITIVE PROTEIN IEF | H, I |
| | | | | SSP 3521 [H. sapiens], ESTs, Weakly similar to small glutamine-rich tetratricopeptide | |
| | | | | repeat (TPR) containing protein (SGT) [Rattus norvegicus] [R. norvegicus], Mus | |
| | | | | musculus, clone MGC: 27660 IMAGE: 4527683, mRNA, complete cds, RIKEN cDNA | |
| | | | | 5330427H01 gene, hypothetical protein FLJ12788, small glutamine-rich tetratricopeptide | |
| | | | | repeat (TPR) containing protein (SGT), small glutamine-rich tetratricopeptide repeat | |
| | | | | (TPR)-containing, stress-induced phosphoprotein 1, stress-induced-phosphoprotein 1 | |
| | | | | (Hsp70/Hsp90-organizing protein) | |
| 9067 | 460 | AI070087 | | ESTs, Highly similar to IF34 MOUSE EUKARYOTIC TRANSLATION INITIATION | GENERAL |
| | | | | FACTOR 3 SUBUNIT 4 [M. musculus], ESTs, Moderately similar to NUCLEOLIN | |
| | | | | [M. musculus], ESTs, Weakly similar to NUCL_HUMAN NUCLEOLIN [H. sapiens], | |
| | | | | Nucleolin, RIKEN cDNA 0610008K04 gene, eukaryotic translation initiation factor 3, | |
| | | | | subunit 4 (delta, 44 kDa), eukaryotic translation initiation factor 3, subunit 4 (delta, 44 kD), | |
| | | | | nucleolin, pigpen | |
| 1764 | 1171 | NM_053974 | | ESTs, Highly similar to IF4E_HUMAN EUKARYOTIC TRANSLATION INITIATION | C |
| | | | | FACTOR 4E [H. sapiens], RIKEN cDNA 1300018P11 gene, RIKEN cDNA 2700069E09 | |
| | | | | gene, eukaryotic translation initiation factor 4E, eukaryotic translation initiation factor 4E- | |
| | | | | like 3 | |
| 21659 | 382 | AI010584 | | ESTs, Highly similar to IFM3_HUMAN INTERFERON-INDUCED TRANSMEMBRANE | D |
| | | | | PROTEIN 3 [H. sapiens], ESTs, Highly similar to S17182 interferon-induced protein 1-8 U | |
| | | | | [H. sapiens], RIKEN cDNA 1110004C05 gene, interferon induced transmembrane protein | |
| | | | | 1 (9-27), interferon induced transmembrane protein 3 (1-8 U) | |
| 21657 | 1247 | X61381 | | ESTs, Highly similar to IFM3_HUMAN INTERFERON-INDUCED TRANSMEMBRANE | GENERAL |
| | | | | PROTEIN 3 [H. sapiens], ESTs, Highly similar to S17182 interferon-induced protein 1-8 U | |
| | | | | [H. sapiens], RIKEN cDNA 1110004C05 gene, interferon induced transmembrane protein | |
| | | | | 1 (9-27), interferon induced transmembrane protein 3 (1-8 U) | |
| 3016 | 37 | AA818069 | | ESTs, Highly similar to JE0190 polyubiquitin unit [H. sapiens], ESTs, Highly similar to | H |
| | | | | UQHUC polyubiquitin 9 [H. sapiens], Homo sapiens, Similar to orosomucoid 1, clone | |
| | | | | MGC: 24263 IMAGE: 3934516, mRNA, complete cds, expressed sequence AL033289, | |
| | | | | ubiquitin B, ubiquitin C | |
| 3015 | 779 | D16554 | | ESTs, Highly similar to JE0190 polyubiquitin unit [H. sapiens], ESTs, Highly similar to | A |
| | | | | UQHUC polyubiquitin 9 [H. sapiens], Homo sapiens, Similar to orosomucoid 1, clone | |
| | | | | MGC: 24263 IMAGE: 3934516, mRNA, complete cds, expressed sequence AL033289, | |
| | | | | ubiquitin B, ubiquitin C | |
| 825 | 270 | AA946108 | | ESTs, Highly similar to LMA3 MOUSE LAMININ ALPHA-3 CHAIN PRECURSOR | GENERAL, A |
| | | | | [M. musculus], Laminin chain beta 2, expressed sequence AW211941, expressed | |
| | | | | sequence C80098, laminin, alpha 3, laminin, alpha 3 (nicein (150 kD), kalinin (165 kD), | |
| | | | | BM600 (150 kD), epilegrin), laminin, beta 2, laminin, beta 2 (laminin S) | |
| 18070 | 898 | NM_013160 | | ESTs, Highly similar to MXI1_RAT MAX interacting protein 1 (MXI1 protein) | GENERAL |
| | | | | [R. norvegicus], ESTs, Moderately similar to MXI1_RAT MAX interacting protein 1 (MXI1 | |
| | | | | protein) [R. norvegicus], ESTs, Weakly similar to MXI1_RAT MAX interacting protein 1 | |
| | | | | (MXI1 protein) [R. norvegicus], MAX dimerization protein, MAX interacting protein 1, Max | |
| | | | | interacting protein 1 | |
| 3467 | 756 | AI237835 | | ESTs, Highly similar to MXI1_RAT MAX interacting protein 1 (MXI1 protein) | GENERAL, I |
| | | | | [R. norvegicus], ESTs, Weakly similar to MXI1_RAT MAX interacting protein 1 (MXI1 | |
| | | | | protein) [R. norvegicus], MAX dimerization protein, MAX interacting protein 1, Max | |
| | | | | interacting protein 1 | |
| 3465 | 898 | NM_013160 | | ESTs, Highly similar to MXI1_RAT MAX interacting protein 1 (MXI1 protein) | GENERAL, B, F |
| | | | | [R. norvegicus], ESTs, Weakly similar to MXI1_RAT MAX interacting protein 1 (MXI1 | |
| | | | | protein) [R. norvegicus], MAX dimerization protein, MAX interacting protein 1, Max | |
| | | | | interacting protein 1 | |
| 1970 | 900 | NM_013194 | | ESTs, Highly similar to MYH9_RAT Myosin heavy chain, nonmuscle type A (Cellular | K |
| | | | | myosin heavy chain, type A) (Nonmuscle myosin heavy chain-A) (NMMHC-A) | |
| | | | | [R. norvegicus], ESTs, Highly similar to MYHA_MOUSE Myosin heavy chain, nonmuscle | |
| | | | | type B (Cellular myosin heavy chain, type B) (Nonmuscle myosin heavy chain-B) | |
| | | | | (NMMHC-B) [M. musculus], ESTs, Weakly similar to MYH9_RAT Myosin heavy chain, | |
| | | | | nonmuscle type A (Cellular myosin heavy chain, type A) (Nonmuscle myosin heavy chain- | |
| | | | | A) (NMMHC-A) [R. norvegicus], ESTs, Weakly similar to MYHA_MOUSE Myosin heavy | |
| | | | | chain, nonmuscle type B (Cellular myosin heavy chain, type B) (Nonmuscle myosin | |
| | | | | heavy chain-B) (NMMHC-B) [M. musculus], RIKEN cDNA 2400004E04 gene, RIKEN | |
| | | | | cDNA 5730504C04 gene, TGFB1-induced anti-apoptotic factor 1, myosin heavy chain IX, | |
| | | | | myosin, heavy polypeptide 9, non-muscle, protein tyrosine phosphatase, receptor-type, F | |
| | | | | interacting protein, binding protein 2 | |
| 18011 | 1082 | NM_031588 | | ESTs, Highly similar to NRG2_MOUSE PRO-NEUREGULIN-2 PRECURSOR (PRO- | GENERAL, H |
| | | | | NRG2) [CONTAINS: NEUREGULIN-2 (NRG-2) (DIVERGENT OF NEUREGULIN 1) | |
| | | | | (DON-1)] [M. musculus], ESTs, Weakly similar to NRG2_MOUSE PRO-NEUREGULIN-2 | |
| | | | | PRECURSOR (PRO-NRG2) [CONTAINS: NEUREGULIN-2 (NRG-2) (DIVERGENT OF | |
| | | | | NEUREGULIN 1) (DON-1)] [M. musculus], neuregulin 1 | |
| 1141 | 1007 | NM_022401 | | ESTs, Highly similar to PLE1_MOUSE PLECTIN 1 (PLTN) (PCN) [M. musculus], ESTs, | GENERAL, C, G |
| | | | | Weakly similar to plectin [Rattus norvegicus] [R. norvegicus], KIAA1009 protein, Mus | |
| | | | | musculus, clone IMAGE: 4188338, mRNA, partial cds, desmoplakin (DPI, DPII), | |
| | | | | expressed sequence AA407888, plectin 1, intermediate filament binding protein, 500 kD | |
| 472 | 780 | D26111 | | ESTs, Highly similar to putative basolateral mTAL chloride channel CIC-Ka [M. musculus], | G |
| | | | | chloride channel 2, chloride channel K1-like, chloride channel Ka | |
| 4445 | 602 | AI175466 | | ESTs, Highly similar to RASH_RAT TRANSFORMING PROTEIN P21/H-RAS-1 (C-H- | G |
| | | | | RAS) [R. norvegicus], Harvey rat sarcoma oncogene, subgroup R, Harvey rat sarcoma | |
| | | | | virus oncogene, Mus musculus, Similar to v-Ha-ras Harvey rat sarcoma viral oncogene | |
| | | | | homolog, clone MGC: 19390 IMAGE: 3152667, mRNA, complete cds, related RAS viral (r- | |
| | | | | ras) oncogene homolog, v-Ha-ras Harvey rat sarcoma viral oncogene homolog | |
| 18741 | 107 | AA874859 | | ESTs, Highly similar to S12207 hypothetical protein [M. musculus], ESTs, Highly similar to | GENERAL |
| | | | | S70642 ubiquitin ligase Nedd4 - rat (fragment) [R. norvegicus], ESTs, Moderately similar | |
| | | | | to S70642 ubiquitin ligase Nedd4 - rat (fragment) [R. norvegicus], RIKEN cDNA | |
| | | | | 1110046J11 gene, neural precursor cell expressed, developmentally down-regulated 4, | |
| | | | | neural precursor cell expressed, developmentally down-regulated gene 4a | |
| 12016 | 158 | AA892404 | | ESTs, Highly similar to S12207 hypothetical protein [M. musculus], ESTs, Highly similar to | C |
| | | | | S70642 ubiquitin ligase Nedd4 - rat (fragment) [R. norvegicus], ESTs, Moderately similar | |
| | | | | to S70642 ubiquitin ligase Nedd4 - rat (fragment) [R. norvegicus], RIKEN cDNA | |
| | | | | 1110046J11 gene, neural precursor cell expressed, developmentally down-regulated 4, | |
| | | | | neural precursor cell expressed, developmentally down-regulated gene 4a | |
| 5601 | 700 | AI232461 | | ESTs, Highly similar to S29125 dimethylaniline monooxygenase [H. sapiens], ESTs, | GENERAL, I |
| | | | | Weakly similar to S33758 flavin-containing monooxygenase 1 - rat [R. norvegicus], Flavin- | |
| | | | | containing monooxygenase 1, Mus musculus flavin-containing monooxygenase 4 mRNA, | |
| | | | | complete cds, expressed sequence AW107733, flavin containing monooxygenase 1, | |
| | | | | flavin containing monooxygenase 3, flavin containing monooxygenase 4 | |
| 18678 | 685 | AI231295 | | ESTs, Highly similar to SM4F_HUMAN SEMAPHORIN 4F PRECURSOR [H. sapiens], | L |
| | | | | sema domain, immunoglobulin domain (Ig), TM domain, and short cytoplasmic domain, | |
| | | | | sema domain, immunoglobulin domain (Ig), transmembrane domain (TM) and short | |
| | | | | cytoplasmic domain, (semaphorin) 4B, sema domain, immunoglobulin domain (Ig), | |
| | | | | transmembrane domain (TM) and short cytoplasmic domain, (semaphorin) 4D, sema | |
| | | | | domain, immunoglobulin domain (Ig), transmembrane domain (TM) and short cytoplasmic | |
| | | | | domain (semaphorin) 4F | |
| 17771 | 42 | AA818224 | | ESTs, Highly similar to T08726 tubulin beta chain [H. sapiens], ESTs, Highly similar to | GENERAL |
| | | | | TBB1_RAT TUBULIN BETA CHAIN (T BETA-15) [R. norvegicus], ESTs, Highly similar to | |
| | | | | TBB2_HUMAN TUBULIN BETA-2 CHAIN [H. sapiens], RIKEN cDNA 2410129E14 gene, | |
| | | | | RIKEN cDNA 4930447K03 gene, RIKEN cDNA 4930542G03 gene, expressed sequence | |
| | | | | AI451582, expressed sequence C79445, tubulin beta-5, tubulin, beta 3 | |
| 18361 | 12 | AA799591 | | ESTs, Highly similar to T08726 tubulin beta chain [H. sapiens], ESTs, Highly similar to | GENERAL |
| | | | | TBB1_RAT TUBULIN BETA CHAIN (T BETA-15) [R. norvegicus], ESTs, Highly similar to | |
| | | | | TBB2_HUMAN TUBULIN BETA-2 CHAIN [H. sapiens], RIKEN cDNA 2410129E14 gene, | |
| | | | | RIKEN cDNA 4930447K03 gene, RIKEN cDNA 4930542G03 gene, Rat mRNA for beta- | |
| | | | | tubulin T beta15, expressed sequence AI451582, expressed sequence C79445, tubulin | |
| | | | | beta-5, tubulin, beta 3, tubulin, beta 2 | |
| 19412 | 66 | AA849222 | | ESTs, Highly similar to T46904 hypothetical protein DKFZp761D081.1 [H. sapiens], Homo | D |
| | | | | sapiens cDNA: FLJ21587 fis, clone COL06946, likely ortholog of mouse Arkadia | |
| 14121 | 1202 | S82383 | | ESTs, Highly similar to TPMN_HUMAN TROPOMYOSIN, CYTOSKELETAL TYPE | I |
| | | | | [H. sapiens], ESTs, Moderately similar to TROPOMYOSIN 5, CYTOSKELETAL TYPE | |
| | | | | [M. musculus] | |
| 13563 | 718 | AI233773 | | ESTs, Highly similar to ULA4_HUMAN MAWD binding protein (Unknown protein 32 from | E |
| | | | | 2D-page of liver tissue) [H. sapiens], MAWD binding protein | |
| 1410 | 1126 | NM_052798 | | ESTs, Moderately similar to hypothetical protein MGC2663 [Homo sapiens] [H. sapiens], | H |
| | | | | ESTs, Moderately similar to S47073 finger protein HZF2, Krueppel-related [H. sapiens], | |
| | | | | ESTs, Weakly similar to TC17 MOUSE TRANSCRIPTION FACTOR 17 [M. musculus], | |
| | | | | ESTs, Weakly similar to TC17_RAT Zinc finger protein 354A (Transcription factor 17) | |
| | | | | (Renal transcription factor Kid-1) (Kidney, ischemia, and developmentally regulated | |
| | | | | protein-1) [R. norvegicus], expressed sequence AI875089, hypermethylated in cancer 2, | |
| | | | | zinc finger protein 354A, zinc finger protein 354B | |
| 9541 | 1015 | NM_022542 | | ESTs, Moderately similar to rhoB gene [Rattus norvegicus] [R. norvegicus], ESTs, | L |
| | | | | Weakly similar to rhoB gene [Rattus norvegicus] [R. norvegicus], Mus musculus, clone | |
| | | | | MGC: 29297 IMAGE: 5003249, mRNA, complete cds, RIKEN cDNA 5830400A04 gene, | |
| | | | | ras homolog B (RhoB), ras homolog gene family, member B | |
| 24438 | 817 | M85183 | | ESTs, Moderately similar to ribonuclease/angiogenin inhibitor 2 [Mus musculus] | GENERAL, F, L |
| | | | | [M. musculus], Homo sapiens, clone MGC: 40117 IMAGE: 5212737, mRNA, complete cds, | |
| | | | | PYRIN-containing APAF1-like protein 5, apoptosis-associated speck-like protein | |
| | | | | containing a CARD, cold autoinflammatory syndrome 1, death effector filament-forming | |
| | | | | Ced-4-like apoptosis protein, expressed sequence AI504961, ribonuclease/angiogenin | |
| | | | | inhibitor 2 | |
| 17401 | 881 | NM_013043 | | ESTs, Moderately similar to DIP_HUMAN DIP PROTEIN [H. sapiens], KIAA0669 gene | GENERAL, B, G |
| | | | | product, RIKEN cDNA 0610009M14 gene, RIKEN cDNA 1810043J12 gene, TSC-22-like, | |
| | | | | transforming growth factor beta 1 induced transcript 4, transforming growth factor beta- | |
| | | | | stimulated protein TSC-22 | |
| 16718 | 538 | AI111537 | | ESTs, Moderately similar to HB2D_RAT RT1 CLASS II HISTOCOMPATIBILITY | H |
| | | | | ANTIGEN, D-1 BETA CHAIN PRECURSOR [R. norvegicus], ESTs, Weakly similar to | |
| | | | | HB2D_RAT RT1 CLASS II HISTOCOMPATIBILITY ANTIGEN, D-1 BETA CHAIN | |
| | | | | PRECURSOR [R. norvegicus], Rattus norvegicus Class II MHC RT1.D(a) beta chain | |
| | | | | precursor (RT1.D(a)) mRNA, complete cds, Rattus norvegicus Class II MHC RT1.D(n) | |
| | | | | beta chain precursor (RT1.D(n)) mRNA, complete cds, histocompatibility 2, class II | |
| | | | | antigen E beta, major histocompatibility complex, class II, DR beta 1, major | |
| | | | | histocompatibility complex class II DR beta 5 | |
| 22386 | 27 | AA800844 | | ESTs, Moderately similar to LYOX_HUMAN PROTEIN-LYSINE 6-OXIDASE | F |
| | | | | PRECURSOR [H. sapiens], ESTs, Weakly similar to LYOX_RAT Protein-lysine 6-oxidase | |
| | | | | precursor (Lysyl oxidase) [R. norvegicus], Lysyl oxidase, lysyl oxidase, lysyl oxidase-like, | |
| | | | | lysyl oxidase-like 1, lysyl oxidase-like 2 | |
| 8829 | 845 | NM_012749 | | ESTs, Moderately similar to NUCLEOLIN [M. musculus], ESTs, Weakly similar to A35804 | GENERAL, A, F, K |
| | | | | nucleolin [H. sapiens], ESTs, Weakly similar to NUCL_HUMAN NUCLEOLIN [H. sapiens], | |
| | | | | ESTs, Weakly similar to NUCL_RAT Nucleolin (Protein C23) [R. norvegicus], RIKEN | |
| | | | | cDNA 1200009A02 gene, eukaryotic translation initiation factor 3, subunit 4 (delta, 44 KDa), | |
| | | | | nucleolin, pigpen | |
| 17477 | 1181 | NM_057194 | | ESTs, Moderately similar to PLS1_RAT Phospholipid scramblase 1 (PL scramblase 1) | GENERAL, K, L |
| | | | | (Ca2+ dependent phospholipid scramblase 1) [R. norvegicus], ESTs, Weakly similar to | |
| | | | | PLS1_RAT Phospholipid scramblase 1 (PL scramblase 1) (Ca2+ dependent phospholipid | |
| | | | | scramblase 1) [R. norvegicus], phospholipid scramblase 1, phospholipid scramblase 2 | |
| 1884 | 783 | D50695 | | ESTs, Moderately similar to PRS6_HUMAN 26S PROTEASE REGULATORY SUBUNIT | I |
| | | | | 6B [H. sapiens], proteasome (prosome, macropain) 26S subunit, ATPase, 4 | |
| 6321 | 496 | AI101256 | | ESTs, Moderately similar to S09017 heterogeneous ribonuclear particle protein type C - | GENERAL |
| | | | | rat (fragment) [R. norvegicus], Homo sapiens cDNA FLJ32918 fis, clone TESTI2006588, | |
| | | | | Homo sapiens, clone IMAGE: 3450973, mRNA, Mus musculus, clone MGC: 36467 | |
| | | | | IMAGE: 5359082, mRNA, complete cds, heterogeneous nuclear ribonucleoprotein D, high- | |
| | | | | glycine/tyrosine protein type I E5, musashi homolog 2 (Drosophila) | |
| 1453 | 1165 | NM_053887 | | ESTs, Moderately similar to S12207 hypothetical protein [M. musculus], ESTs, Weakly | F, K |
| | | | | similar to mitogen activated protein kinase kinase kinase 1 [Rattus norvegicus] | |
| | | | | [R. norvegicus], mitogen activated protein kinase kinase kinase 1, mitogen activated | |
| | | | | protein kinase kinase kinase 2, mitogen activated protein kinase kinase kinase 3, mitogen | |
| | | | | activated protein kinase kinase kinase 1, mitogen-activated protein kinase kinase kinase 3 | |
| 1454 | 1165 | NM_053887 | | ESTs, Moderately similar to S12207 hypothetical protein [M. musculus], ESTs, Weakly | GENERAL, K |
| | | | | similar to mitogen activated protein kinase kinase kinase 1 [Rattus norvegicus] | |
| | | | | [R. norvegicus], mitogen activated protein kinase kinase kinase 1, mitogen activated | |
| | | | | protein kinase kinase kinase 2, mitogen activated protein kinase kinase kinase 3, mitogen | |
| | | | | activated protein kinase kinase kinase 1, mitogen-activated protein kinase kinase kinase 3 | |
| 2439 | 970 | NM_019277 | | ESTs, Moderately similar to T09221 exocyst complex protein Sec15 - rat [R. norvegicus], | A, F |
| | | | | Homo sapiens rsec15-like protein mRNA, partial cds, Mus musculus, Similar to SEC15 | |
| | | | | (S. cerevisiae)-like, clone MGC: 30428 IMAGE: 2631201, mRNA, complete cds, RIKEN | |
| | | | | cDNA 4930569O18 gene, SEC15 (S. cerevisiae)-like, SEC15 homolog (S. cerevisiae), | |
| | | | | Sec15B protein | |
| 22596 | 277 | AA955298 | | ESTs, Moderately similar to T46637 transcription factor 1, neural - rat [R. norvegicus], | GENERAL |
| | | | | ESTs, Weakly similar to A35804 nucleolin [H. sapiens], Homo sapiens mRNA; cDNA | |
| | | | | DKFZp434E0922 (from clone DKFZp434E0922), Mus musculus 10, 11 days embryo | |
| | | | | whole body cDNA, RIKEN full-length enriched library, clone: 2810003I18: myelin | |
| | | | | transcription factor 1-like, full insert sequence, myelin transcription factor 1-like, nucleolin | |
| 14346 | 1075 | NM_031533 | | ESTs, Moderately similar to UDB5 MOUSE UDP-GLUCURONOSYLTRANSFERASE | B, H |
| | | | | 2B5 PRECURSOR, MICROSOMAL [M. musculus], Mus musculus, Similar to UDP | |
| | | | | glycosyltransferase 2 family, polypeptide B4, clone MGC: 37823 IMAGE: 5098890, mRNA, | |
| | | | | complete cds, RIKEN cDNA 1300012D20 gene, UDP glycosyltransferase 2 family, | |
| | | | | polypeptide B17, UDP-glucuronosyltransferase 2 family, member 5, expressed sequence | |
| | | | | AA986709 | |
| 14633 | 1075 | NM_031533 | | ESTs, Moderately similar to UDB5 MOUSE UDP-GLUCURONOSYLTRANSFERASE | H |
| | | | | 2B5 PRECURSOR, MICROSOMAL [M. musculus], Mus musculus, Similar to UDP | |
| | | | | glycosyltransferase 2 family, polypeptide B4, clone MGC: 37823 IMAGE: 5098890, mRNA, | |
| | | | | complete cds, RIKEN cDNA 1300012D20 gene, UDP glycosyltransferase 2 family, | |
| | | | | polypeptide B17, UDP-glucuronosyltransferase 2 family, member 5, expressed sequence | |
| | | | | AA986709 | |
| 14347 | 1075 | NM_031533 | | ESTs, Moderately similar to UDB5 MOUSE UDP-GLUCURONOSYLTRANSFERASE | H |
| | | | | 2B5 PRECURSOR, MICROSOMAL [M. musculus], Mus musculus, Similar to UDP | |
| | | | | glycosyltransferase 2 family, polypeptide B4, clone MGC: 37823 IMAGE: 5098890, mRNA, | |
| | | | | complete cds, RIKEN cDNA 1300012D20 gene, UDP glycosyltransferase 2 family, | |
| | | | | polypeptide B17, UDP-glucuronosyltransferase 2 family, member 5, expressed sequence | |
| | | | | AA986709 | |
| 17805 | 1117 | NM_031980 | | ESTs, Moderately similar to UDB5 MOUSE UDP-GLUCURONOSYLTRANSFERASE | B |
| | | | | 2B5 PRECURSOR, MICROSOMAL [M. musculus], Mus musculus, Similar to UDP | |
| | | | | glycosyltransferase 2 family, polypeptide B4, clone MGC: 37823 IMAGE: 5098890, mRNA, | |
| | | | | complete cds, RIKEN cDNA 1300012D20 gene, UDP glycosyltransferase 2 family, | |
| | | | | polypeptide B17, UDP-glucuronosyltransferase 2 family, member 5, expressed sequence | |
| | | | | AA986709 | |
| 1537 | 1216 | U27518 | | ESTs, Moderately similar to UDB5 MOUSE UDP-GLUCURONOSYLTRANSFERASE | H |
| | | | | 2B5 PRECURSOR, MICROSOMAL [M. musculus], Mus musculus, Similar to UDP | |
| | | | | glycosyltransferase 2 family, polypeptide B4, clone MGC: 37823 IMAGE: 5098890, mRNA, | |
| | | | | complete cds, RIKEN cDNA 1300012D20 gene, UDP glycosyltransferase 2 family, | |
| | | | | polypeptide B17, UDP-glucuronosyltransferase 2 family, member 5, expressed sequence | |
| | | | | AA986709 | |
| 15904 | 414 | AI013971 | | ESTs, Weakly similar to L1 cell adhesion molecule [Mus musculus] [M. musculus], ESTs, | F |
| | | | | Weakly similar to A41060 neural cell adhesion molecule L1 precursor [H. sapiens], ESTs, | |
| | | | | Weakly similar to S36126 neural cell adhesion molecule L1 - rat [R. norvegicus], L1 cell | |
| | | | | adhesion molecule, L1 cell adhesion molecule (hydrocephalus, stenosis of aqueduct of | |
| | | | | Sylvius 1, MASA (mental retardation, aphasia, shuffling gait and adducted thumbs) | |
| | | | | syndrome, spastic paraplegia 1), close homolog of L1, neuronal cell adhesion molecule | |
| 20780 | 1017 | NM_022590 | | ESTs, Weakly similar to low affinity Na-dependent glucose transporter (SGLT2) [Rattus | GENERAL, D |
| | | | | norvegicus] [R. norvegicus], Mus musculus, Similar to hypothetical protein FLJ13868, | |
| | | | | clone MGC: 28903 IMAGE: 4919869, mRNA, complete cds, low affinity sodium-dependent | |
| | | | | glucose cotransporter, solute carrier family 5 (sodium/glucose cotransporter), member 2, | |
| | | | | solute carrier family 5, member 1 | |
| 6641 | 1012 | NM_022533 | | ESTs, Weakly similar to plasmolipin [Rattus norvegicus] [R. norvegicus], ESTs, Weakly | GENERAL, A, I |
| | | | | similar to PLLP_HUMAN PLASMOLIPIN [H. sapiens], Mus musculus, Similar to BENE | |
| | | | | protein, clone MGC: 19097 IMAGE: 4205488, mRNA, complete cds, Mus musculus, clone | |
| | | | | IMAGE: 4022528, mRNA, RIKEN cDNA 0610010I06 gene, RIKEN cDNA 2700018N07 | |
| | | | | gene, expressed sequence D19397, myelin and lymphocyte protein, T-cell differentiation | |
| | | | | protein, plasmolipin | |
| 18246 | 1003 | NM_022300 | | ESTs, Weakly similar to Ser/Arg-related nuclear matrix protein; plenty-of-prolines-101; | B, F |
| | | | | serine/arginine repetitive matrix protein 1 [Mus musculus] [M. musculus], Mus musculus, | |
| | | | | Similar to hypothetical protein MGC13125, clone MGC: 38070 IMAGE: 5252666, mRNA, | |
| | | | | complete cds, brain abundant, membrane attached signal protein 1, expressed sequence | |
| | | | | AI480556, glucocorticoid-induced gene 1, serine/arginine repetitive matrix 1 | |
| 5711 | 442 | AI045151 | | ESTs, Weakly similar to solute carrier family 25 (carnitine/acylcarnitine translocase), | GENERAL |
| | | | | member 20 [Rattus norvegicus] [R. norvegicus], KIAA0446 gene product, Mus musculus, | |
| | | | | Similar to CG4995 gene product, clone MGC: 7958 IMAGE: 3584570, mRNA, complete | |
| | | | | cds, RIKEN cDNA 1300006L01 gene, expressed sequence AW491445, hypothetical | |
| | | | | protein FLJ13044, solute carrier family 25 (carnitine/acylcarnitine translocase), member | |
| | | | | 20, solute carrier family 25 (mitochondrial carnitine/acylcarnitine translocase), member | |
| | | | | 20, solute carrier family 25 (mitochondrial carrier), member 18, solute carrier family 25 | |
| | | | | (mitochondrial carrier, Aralar), member 12, solute carrier family 25 (mitochondrial carrier; | |
| | | | | adenine nucleotide translocator), member 13, solute carrier family 25 (mitochondrial | |
| | | | | oxodicarboxylate carrier), member 21, solute carrier family 25, (mitochondrial carrier), | |
| | | | | member 18, solute carrier family 25, member 13 (citrin) | |
| 6416 | 1136 | NM_053380 | | ESTs, Weakly similar to solute carrier family 34 (sodium phosphate), member 2; type II | GENERAL, K |
| | | | | sodium-dependent phosphate transporter 3b [Homo sapiens] [H. sapiens], solute carrier | |
| | | | | family 34 (sodium phosphate), member 2 | |
| 19768 | 1119 | NM_031986 | | ESTs, Weakly similar to syntenin [Rattus norvegicus] [R. norvegicus], syndecan binding | GENERAL, C, G |
| | | | | protein, syndecan binding protein (syntenin), syndecan binding protein (syntenin) 2 | |
| 1798 | 261 | AA945569 | | ESTs, Weakly similar to A2MG MOUSE ALPHA-2-MACROGLOBULIN PRECURSOR | GENERAL, D |
| | | | | [M. musculus], Mus musculus GPI-anchored alpha-2 macroglobulin-related protein | |
| | | | | mRNA, complete cds, alpha-2-macroglobulin | |
| 8426 | 338 | AF036335 | | ESTs, Weakly similar to A54691 octamer-binding protein NonO - mouse [M. musculus], | E, F |
| | | | | ESTs, Weakly similar to PSF_HUMAN PTB-ASSOCIATED SPLICING FACTOR | |
| | | | | [H. sapiens], RIKEN cDNA 9030402K04 gene, non-POU-domain-containing, octamer | |
| | | | | binding protein, splicing factor proline/glutamine rich (polypyrimidine tract binding protein | |
| | | | | associated) | |
| 3438 | 182 | AA892921 | | ESTs, Weakly similar to A55143 calpain (EC 3.4.22.17) light chain - rat (fragment) | K |
| | | | | [R. norvegicus], Mus musculus, Similar to grancalcin, EF-hand calcium binding protein, | |
| | | | | clone MGC: 29240 IMAGE: 5044040, mRNA, complete cds, RIKEN cDNA 2310005G05 | |
| | | | | gene, calpain, small subunit 1, programmed cell death 6, sorcin | |
| 15051 | 741 | AI236332 | | ESTs, Weakly similar to ATDA_HUMAN DIAMINE ACETYLTRANSFERASE [H. sapiens], | GENERAL |
| | | | | RIKEN cDNA 2610016A03 gene, spermidine/spermine N1-acetyltransferase | |
| 10378 | 709 | AI233300 | | ESTs, Weakly similar to CO5 MOUSE COMPLEMENT C5 PRECURSOR [M. musculus], | A |
| | | | | complement component 5, hemolytic complement | |
| 20832 | 268 | AA946040 | | ESTs, Weakly similar to COXG MOUSE CYTOCHROME C OXIDASE POLYPEPTIDE | A |
| | | | | VIB [M. musculus], Homo sapiens, hypothetical gene LOC125965, clone MGC: 33640 | |
| | | | | IMAGE: 4827471, mRNA, complete cds | |
| 20833 | 524 | AI104035 | | ESTs, Weakly similar to COXG MOUSE CYTOCHROME C OXIDASE POLYPEPTIDE | A |
| | | | | VIB [M. musculus], Homo sapiens, hypothetical gene LOC125965, clone MGC: 33640 | |
| | | | | IMAGE: 4827471, mRNA, complete cds | |
| 20716 | 984 | NM_019623 | | ESTs, Weakly similar to CYP4B1 [M. musculus], RIKEN cDNA 1810054N16 gene, | G |
| | | | | cytochrome P450, subfamily IVF, polypeptide 14 (leukotriene B4 omega hydroxylase), | |
| | | | | cytochrome P450, subfamily IVF, polypeptide 2, cytochrome P450, subfamily IVF, | |
| | | | | polypeptide 8, expressed sequence AW108534, expressed sequence AW111961 | |
| 21914 | 1257 | Y13336 | | ESTs, Weakly similar to DAD1_HUMAN Defender against cell death 1 (DAD-1) | J |
| | | | | [R. norvegicus], defender against cell death 1 | |
| 25070 | 1038 | NM_024392 | | ESTs, Weakly similar to DHB4 MOUSE ESTRADIOL 17 BETA-DEHYDROGENASE 4 | GENERAL |
| | | | | [M. musculus], ESTs, Weakly similar to DHB4_HUMAN ESTRADIOL 17 BETA- | |
| | | | | DEHYDROGENASE 4 [H. sapiens], RIKEN cDNA 1110029G07 gene, RIKEN cDNA | |
| | | | | 1700010M22 gene, RIKEN cDNA 3110069K09 gene, hydroxysteroid (17-beta) | |
| | | | | dehydrogenase 4 | |
| 14083 | 619 | AI177181 | | ESTs, Weakly similar to FYV1 MOUSE FYVE FINGER-CONTAINING | C |
| | | | | PHOSPHOINOSITIDE KINASE [M. musculus], MAD, mothers against decapentaplegic | |
| | | | | homolog (Drosophila) interacting protein, receptor activation anchor, RIKEN cDNA | |
| | | | | 1110013H04 gene, myotubularin related protein 3, phosphatidylinositol-4-phosphate 5- | |
| | | | | kinase, type III | |
| 20817 | 398 | AI012589 | | ESTs, Weakly similar to GTP_RAT Glutathione S-transferase P (GST 7-7) (Chain 7) | GENERAL |
| | | | | (GST class-pi) [R. norvegicus], Mus musculus, clone MGC: 37914 IMAGE: 5102505, | |
| | | | | mRNA, complete cds, glutathione S-transferase pi, glutathione S-transferase, pi 2 | |
| 20818 | 1233 | X02904 | | ESTs, Weakly similar to GTP_RAT Glutathione S-transferase P (GST 7-7) (Chain 7) | GENERAL |
| | | | | (GST class-pi) [R. norvegicus], Mus musculus, clone MGC: 37914 IMAGE: 5102505, | |
| | | | | mRNA, complete cds, glutathione S-transferase pi, glutathione S-transferase, pi 2 | |
| 11421 | 1190 | NM_130405 | | ESTs, Weakly similar to I49140 p62 ras-GAP associated phosphoprotein - mouse | E |
| | | | | [M. musculus], Homo sapiens Sam68-like mammalian protein 1 (SLM1) mRNA, complete | |
| | | | | cds, KH domain containing, RNA binding, signal transduction associated 1, homolog of | |
| | | | | mouse quaking QKI (KH domain RNA binding protein), quaking | |
| 6630 | 594 | AI172184 | | ESTs, Weakly similar to I53171 pantophysin [H. sapiens], RIKEN cDNA 1500003F20 | F |
| | | | | gene, Synaptophysin, mitsugumin 29, pantophysin, synaptophysin, synaptophysin-like | |
| | | | | protein | |
| 5952 | 298 | AA963102 | | ESTs, Weakly similar to JC7328 amino acid transporter A1 [H. sapiens], Homo sapiens | E |
| | | | | clone 24674 mRNA sequence, solute carrier family 38, member 1, solute carrier family | |
| | | | | 38, member 2 | |
| 17850 | 508 | AI102750 | | ESTs, Weakly similar to JQ0866 T-complex protein 1 - rat [R. norvegicus], T-complex 1, | H |
| | | | | chaperonin containing TCP1, subunit 2 (beta), chaperonin containing TCP1, subunit 7 | |
| | | | | (eta), chaperonin subunit 2 (beta), chaperonin subunit 7 (eta), expressed sequence | |
| | | | | AA408524, expressed sequence AL024346, t-complex protein 1 | |
| 187 | 866 | NM_012903 | | ESTs, Weakly similar to LANP_RAT Leucine-rich acidic nuclear protein [R. norvegicus], | F |
| | | | | acidic (leucine-rich) nuclear phosphoprotein 32 family, member A, acidic nuclear | |
| | | | | phosphoprotein 32, cerebellar ataxia 3, hypothetical gene MGC16309, small nuclear | |
| | | | | ribonucleoprotein polypeptide A′ | |
| 24762 | 1139 | NM_053442 | | ESTs, Weakly similar to LAT2_RAT Large neutral amino acids transporter small subunit 2 | GENERAL, D |
| | | | | (L-type amino acid transporter 2) [R. norvegicus], solute carrier family 7 (cationic amino | |
| | | | | acid transporter, y+ system), member 8 | |
| 16003 | 1103 | NM_031757 | | ESTs, Weakly similar to MM24_MOUSE MATRIX METALLOPROTEINASE-24 | C |
| | | | | PRECURSOR (MMP-24) (MEMBRANE-TYPE MATRIX METALLOPROTEINASE 5) (MT- | |
| | | | | MMP 5) (MEMBRANE-TYPE-5 MATRIX METALLOPROTEINASE) (MT5-MMP) (MMP- | |
| | | | | 21) [M. musculus], matrix metalloproteinase 17, matrix metalloproteinase 19, matrix | |
| | | | | metalloproteinase 24, matrix metalloproteinase 24 (membrane-inserted) | |
| 16147 | 1220 | U51898 | | ESTs, Weakly similar to PA26_RAT 85 kDa calcium-independent phospholipase A2 | GENERAL |
| | | | | (iPLA2) (Cal-PLA2) (Group VI phospholipase A2) (GVI PLA2) [R. norvegicus], Homo | |
| | | | | sapiens cDNA FLJ10428 fis, clone NT2RP1000376, highly similar to Homo sapiens | |
| | | | | mRNA; cDNA DKFZp434A102, RIKEN cDNA 2310026G15 gene, ankyrin repeat and | |
| | | | | SOCS box-containing 13, ankyrin repeat and SOCS box-containing protein 1, | |
| | | | | chromosome 20 open reading frame 86, phospholipase A2, group VI, phospholipase A2, | |
| | | | | group VI (cytosolic, calcium-independent) | |
| 13609 | 161 | AA892468 | | ESTs, Weakly similar to PSS8_RAT Prostasin precursor [R. norvegicus], RIKEN cDNA | GENERAL, H, I |
| | | | | 1700112C13 gene, RIKEN cDNA 2010001P08 gene, marapsin, protease, serine, 8 | |
| | | | | (prostasin), tryptase gamma 1 | |
| 13610 | 161 | AA892468 | | ESTs, Weakly similar to PSS8_RAT Prostasin precursor [R. norvegicus], RIKEN cDNA | GENERAL, A, C, F, H, I, K |
| | | | | 1700112C13 gene, RIKEN cDNA 2010001P08 gene, marapsin, protease, serine, 8 | |
| | | | | (prostasin), typtase gamma 1 | |
| 13611 | 639 | AI179378 | | ESTs, Weakly similar to PSS8_RAT Prostasin precursor [R. norvegicus], RIKEN cDNA | GENERAL, F, H, |
| | | | | 1700112C13 gene, RIKEN cDNA 2010001P08 gene, marapsin, protease, serine, 8 | |
| | | | | (prostasin), tryptase gamma 1 | |
| 7299 | 413 | AI013911 | | ESTs, Weakly similar to RBM3 MOUSE PUTATIVE RNA-BINDING PROTEIN 3 | GENERAL, A, B, L |
| | | | | [M. musculus], Mus musculus adult male tongue cDNA, RIKEN full-length enriched library, | |
| | | | | clone: 2310074E15:RNA binding motif protein 3, full insert sequence, RNA binding motif | |
| | | | | protein 3, RNA binding motif protein, X chromosome, RNA binding motif protein, X | |
| | | | | chromosome retrogene, cold inducible RNA binding protein, cold inducible RNA-binding | |
| | | | | protein | |
| 1475 | 1115 | NM_031971 | | ESTs, Weakly similar to S10A MOUSE S-100 PROTEIN, ALPHA CHAIN [M. musculus], | C |
| | | | | S100 calcium binding protein A1, S100 calcium binding protein A11 (calizzarin), S100 | |
| | | | | calcium binding protein P, S100Z protein, expressed sequence AI266795 | |
| 1472 | 1215 | U26356 | | ESTs, Weakly similar to S10A MOUSE S-100 PROTEIN, ALPHA CHAIN [M. musculus], | K |
| | | | | S100 calcium binding protein A1, S100 calcium binding protein A11 (calizzarin), S100 | |
| | | | | calcium binding protein P, S100Z protein, expressed sequence AI266795 | |
| 20886 | 886 | NM_013097 | | ESTs, Weakly similar to S13676 deoxyribonuclease I (EC 3.1.21.1) - rat [R. norvegicus], | E, G |
| | | | | RIKEN cDNA 4733401H14 gene, deoxyinbonuclease I, deoxyribonuclease I-like 2 | |
| 20887 | 886 | NM_013097 | | ESTs, Weakly similar to S13676 deoxyribonuclease I (EC 3.1.21.1) - rat [R. norvegicus], | E, G |
| | | | | RIKEN cDNA 4733401H14 gene, deoxyribonuclease I, deoxyribonuclease I-like 2 | |
| 13392 | 922 | NM_017148 | | ESTs, Weakly similar to S53580 cysteine-rich protein - rat [R. norvegicus], RIKEN cDNA | GENERAL |
| | | | | 0610025L06 gene, cysteine and glycine-rich protein 1, cysteine rich protein | |
| 20802 | 1018 | NM_022592 | | ESTs, Weakly similar to TKT_HUMAN TRANSKETOLASE [H. sapiens], RIKEN cDNA | H |
| | | | | 4933401I19 gene, hypothetical protein DKFZp434L1717, transketolase, transketolase | |
| | | | | (Wernicke-Korsakoff syndrome), transketolase-like 1 | |
| 20803 | 1018 | NM_022592 | | ESTs, Weakly similar to TKT_HUMAN TRANSKETOLASE [H. sapiens], RIKEN cDNA | B, H, I |
| | | | | 4933401I19 gene, hypothetical protein DKFZp434L1717, transketolase, transketolase | |
| | | | | (Wernicke-Korsakoff syndrome), transketolase-like 1 | |
| 20804 | 1018 | NM_022592 | | ESTs, Weakly similar to TKT_HUMAN TRANSKETOLASE [H. sapiens], RIKEN cDNA | H |
| | | | | 4933401I19 gene, hypothetical protein DKFZp434L1717, transketolase, transketolase | |
| | | | | (Wernicke-Korsakoff syndrome), transketolase-like 1 | |
| 11843 | 1143 | NM_053555 | | ESTs, Weakly similar to VAM5_HUMAN VESICULE-ASSOCIATED MEMBRANE | A |
| | | | | PROTEIN 5 (VAMP-5) (MYOBREVIN) (HSPC191) [H. sapiens], vesicle-associated | |
| | | | | membrane protein 5, vesicle-associated membrane protein 5 (myobrevin) | |
| 4592 | 979 | NM_019356 | | eukaryotic translation initiation factor 2, subunit 1 (alpha, 35 kD), eukaryotic translation | H |
| | | | | initiation factor 2A | |
| 5481 | 647 | AI180170 | | eukaryotic translation termination factor 1 | GENERAL |
| 12682 | 1069 | NM_031332 | | expressed sequence AA986766, organic cationic transporter-like 4, reduced in | D |
| | | | | osteosclerosis transporter, solute carrier family 22 (organic anion transporter), member 8 | |
| 17324 | 991 | NM_021593 | | expressed sequence AI046660, kynurenine 3-monooxygenase (kynurenine 3- | GENERAL |
| | | | | hydroxylase) | |
| 7690 | 48 | AA818875 | | expressed sequence AV066530, guanylate cyclase activator 2B (uroguanylin), guanylate | GENERAL |
| | | | | cyclase activator 2b (retina) | |
| 1809 | 274 | AA946503 | | expressed sequence AW212229, lipocalin 2 (oncogene 24p3) | G, K |
| 20740 | 1197 | S69874 | | fatty acid binding protein 5 (psoriasis-associated), fatty acid binding protein 5, epidermal | D |
| 13091 | 550 | AI136977 | | FK506 binding protein 4 (59 kD), RIKEN cDNA 4930571K23 gene | L |
| 13092 | 689 | AI231547 | | FK506 binding protein 4 (59 kD), RIKEN cDNA 4930571K23 gene | L |
| 23987 | 1238 | X51615 | | gap junction protein, beta 2, 26 kD (connexin 26) | B |
| 7451 | 420 | AI029450 | | glutamyl-prolyl-tRNA synthetase | L |
| 17325 | 22 | AA800587 | | Glutathione peroxidase 1, glutathione peroxidase 1, glutathione peroxidase 2, glutathione | GENERAL, G, K |
| | | | | peroxidase 2 (gastrointestinal) | |
| 22675 | 980 | NM_019358 | | glycoprotein 38, lung type-I cell membrane-associated glycoprotein | G |
| 6675 | 36 | AA817994 | | GTP-rho binding protein 1, RIKEN cDNA 1300002E07 gene, expressed sequence | C |
| | | | | BB023497, hypothetical protein FLJ22938, regulator of G-protein signaling 3, rhophilin- | |
| | | | | like protein | |
| 14184 | 1106 | NM_031776 | | guanine deaminase | GENERAL |
| 14185 | 1106 | NM_031776 | | guanine deaminase | GENERAL |
| 13285 | 586 | AI171361 | | heterogeneous nuclear ribonucleoprotein A0 | A |
| 8820 | 1186 | NM_080399 | | HIF-1 responsive RTP801, Homo sapiens, Similar to RIKEN cDNA 1700037B15 gene, | B, H, L |
| | | | | clone MGC: 9960 IMAGE: 3877854, mRNA, complete cds | |
| 23282 | 1232 | U90725 | | high density lipoprotein binding protein (vigilin) | A |
| 3083 | 459 | AI060150 | | HIRA interacting protein 3 | E |
| 3816 | 716 | AI233729 | | Homo sapiens cDNA FLJ10203 fis, clone HEMBA1004930, moderately similar to 26S | H |
| | | | | PROTEASOME SUBUNIT S5B, proteasome (prosome, macropain) 26S subunit, non- | |
| | | | | ATPase, 5 | |
| 4944 | 218 | AA924405 | | Homo sapiens cDNA FLJ11845 fis, clone HEMBA1006674, Mus musculus, Similar to | GENERAL, H, I, K |
| | | | | hypothetical protein FLJ10350, clone MGC: 27585 IMAGE: 4489521, mRNA, complete | |
| | | | | cds, Mus musculus, Similar to neurofilament, heavy polypeptide (200 kD), clone | |
| | | | | MGC: 32399 IMAGE: 5037953, mRNA, complete cds, nucleolar protein 5A (56 kD with | |
| | | | | KKE/D repeat) | |
| 3941 | 386 | AI011598 | | Homo sapiens cDNA FLJ14042 fis, clone HEMBA1006038, weakly similar to LAMININ | GENERAL, J |
| | | | | ALPHA-5 CHAIN, expressed sequence AA408762, expressed sequence AI853660, | |
| | | | | laminin, alpha 5 | |
| 8739 | 469 | AI070859 | | Homo sapiens cDNA FLJ20166 fis, clone COL09511, KIAA0984 protein, KIAA1055 | D |
| | | | | protein, TBC1 domain family, member 2, hypothetical protein FLJ22474 | |
| 20896 | 1148 | NM_053592 | | Homo sapiens cDNA FLJ25344 fis, clone TST01087, RIKEN cDNA 5031412I06 gene | A, F |
| 24197 | 462 | AI070314 | | Homo sapiens cDNA FLJ30453 fis, clone BRACE2009307, weakly similar to P120 | B, L |
| | | | | PROTEIN, armadillo repeat gene deletes in velocardiofacial syndrome, catenin (cadherin- | |
| | | | | associated protein), delta 2 (neural plakophilin-related arm-repeat protein), plakophilin 4 | |
| 24900 | 925 | NM_017163 | | Homo sapiens cDNA FLJ31236 fis, clone KIDNE2004828, moderately similar to Mus | H |
| | | | | musculus orphan transporter isoform A12 (Xtrp2) mRNA, RIKEN cDNA 4632401C08 | |
| | | | | gene, X transporter protein 2 | |
| 7540 | 450 | AI045882 | | Homo sapiens cDNA FLJ31665 fis, clone NT2RI2004606, Homo sapiens, clone | GENERAL, B, L |
| | | | | IMAGE: 4690662, mRNA | |
| 22592 | 410 | AI013740 | | Homo sapiens cDNA FLJ31762 fis, clone NT2RI2007754, weakly similar to INTESTINAL | GENERAL, G, K |
| | | | | MEMBRANE A4 PROTEIN, hypothetical protein BC010116, hypothetical protein | |
| | | | | BC013109 | |
| 11164 | 735 | AI235739 | | Homo sapiens cDNA FLJ31775 fis, clone NT2RI2008115, biphenyl hydrolase-like (serine | GENERAL, I |
| | | | | hydrolase; breast epithelial mucin-associated antigen) | |
| 22984 | 220 | AA924560 | | Homo sapiens cDNA FLJ32770 fis, clone TESTI2001898, Homo sapiens mRNA; cDNA | E |
| | | | | DKFZp434I0121 (from clone DKFZp434I0121), fer-1-like 3, myoferlin (C. elegans), fer-1- | |
| | | | | like 4 (C. elegans) | |
| 7300 | 1070 | NM_031341 | | Homo sapiens cDNA FLJ33031 fis, clone THYMU2000176, expressed sequence | C |
| | | | | AI643885, solute carrier family 7 (cationic amino acid transporter, y+ system), member 6, | |
| | | | | solute carrier family 7 (cationic amino acid transporter, y+ system), member 7 | |
| 3615 | 754 | AI237645 | | Homo sapiens mRNA; cDNA DKFZp434M2227 (from clone DKFZp434M2227), Homo | J |
| | | | | sapiens prostate-specific membrane antigen PSM mRNA, exon 6 alternative splice | |
| | | | | variant, partial cds, RIKEN cDNA 2610028K12 gene, transferrin receptor, transferrin | |
| | | | | receptor (p90, CD71), transferrin receptor 2 | |
| 6518 | 391 | AI012114 | | Homo sapiens mRNA; cDNA DKFZp547I147 (from clone DKFZp547I147), Homo | GENERAL |
| | | | | sapiens, Similar to hypothetical protein FLJ20244, clone MGC: 17561 IMAGE: 3463518, | |
| | | | | mRNA, complete cds, chromosome 1 open reading frame 25, hypothetical protein | |
| | | | | FLJ20244 | |
| 23748 | 566 | AI169037 | | Homo sapiens PP3958 mRNA, complete cds, Mus musculus, similar to MANNOSE-P- | F |
| | | | | DOLICHOL UTILIZATION DEFECT 1 PROTEIN HOMOLOG, clone MGC: 32303 | |
| | | | | IMAGE: 5025905, mRNA, complete cds, mannose-P-dolichol utilization defect 1 | |
| 21211 | 1023 | NM_022607 | | Homo sapiens, clone MGC: 12790 IMAGE: 4302265, mRNA, complete cds, NADH | C |
| | | | | dehydrogenase (ubiquinone) flavoprotein 3 (10 kD), nucleolar and coiled-body | |
| | | | | phosphoprotein 1 | |
| 8665 | 483 | AI071965 | | Homo sapiens, clone MGC: 25063 IMAGE: 4480702, mRNA, complete cds | C |
| 8664 | 1261 | Z75029 | | Homo sapiens, clone MGC: 25063 IMAGE: 4480702, mRNA, complete cds | C, D |
| 22569 | 646 | AI179979 | | Homo sapiens, clone MGC: 26636 IMAGE: 4825619, mRNA, complete cds | GENERAL, I |
| 20960 | 1020 | NM_022598 | | Homo sapiens, Similar to RIKEN cDNA 4930513O09 gene, clone MGC: 33185 | D |
| | | | | IMAGE: 5269882, mRNA, complete cds, Mus musculus, Similar to hypothetical protein | |
| | | | | DKFZp761J139, clone MGC: 11924 IMAGE: 3599595, mRNA, complete cds, RIKEN | |
| | | | | cDNA 4930513O09 gene, cellular nucleic acid binding protein, zinc finger protein 9 (a | |
| | | | | cellular retroviral nucleic acid binding protein) | |
| 729 | 819 | M95762 | | Homo sapiens, Similar to solute carrier family 6 (neurotransmitter transporter, GABA), | D |
| | | | | member 13, clone MGC: 24068 IMAGE: 4594185, mRNA, complete cds, Homo sapiens, | |
| | | | | clone MGC: 24098 IMAGE: 4612245, mRNA, complete cds, Mus musculus, Similar to | |
| | | | | solute carrier family 6 (neurotransmitter transporter, GABA), member 13, clone | |
| | | | | MGC: 28956 IMAGE: 4240641, mRNA, complete cds, expressed sequence AA589632 | |
| 15986 | 1256 | Y09945 | | Homo sapiens, Similar to ust3, clone MGC: 23972 IMAGE: 4714598, mRNA, complete | GENERAL, I |
| | | | | cds, Mus musculus, Similar to solute carrier family 22 (organic anion/cation transporter), | |
| | | | | member 11, clone MGC: 31374 IMAGE: 4239636, mRNA, complete cds, Rattus | |
| | | | | norvegicus mRNA for organic anion transporter 5, complete cds, expressed sequence | |
| | | | | AA986766, expressed sequence AI648912, organic anion transporter 6, solute carrier | |
| | | | | family 22 (organic anion transporter), member 6, solute carrier family 22 (organic cation | |
| | | | | transporter)-like 2, ust3 | |
| 18128 | 134 | AA891800 | | hypothetical protein BC008246, inorganic pyrophosphatase, pyrophosphatase (inorganic) | I |
| 15339 | 113 | AA875171 | | hypothetical protein CAB56184 | D |
| 5369 | 567 | AI169058 | | hypothetical protein CL25084 | A |
| 18168 | 247 | AA942995 | | hypothetical protein DKFZp762N0610 | E |
| 2059 | 565 | AI146005 | | hypothetical protein FKSG32, pseudouridine synthase 1, pseudouridylate synthase 1 | A, H |
| 2191 | 203 | AA894086 | | hypothetical protein MGC17552 | F |
| 16982 | 894 | NM_013144 | | insulin-like growth factor binding protein 1 | GENERAL, B, L |
| 23076 | 752 | AI237388 | | interferon-related developmental regulator 1, interferon-related developmental regulator 2 | K |
| 16731 | 293 | AA957244 | | JTV1 gene | D |
| 5384 | 120 | AA891041 | | Jun-B oncogene, jun B proto-oncogene | I |
| 20161 | 998 | NM_021836 | | Jun-B oncogene, jun B proto-oncogene | GENERAL, C, I |
| 3053 | 320 | AA997726 | | KIAA0185 protein | H |
| 10069 | 452 | AI058503 | | KIAA0247 gene product | F |
| 17363 | 227 | AA925150 | | KIAA0438 gene product, Mus musculus, clone IMAGE: 3499845, mRNA, partial cds, | F, K |
| | | | | goliath protein, hypothetical protein FLJ20552, hypothetical protein LOC51255, praja 1, | |
| | | | | praja1, RING-H2 motif containing, rotein carrying the RING-H2 sequence motif, similar to | |
| | | | | RIKEN cDNA 1300002C13, zinc finger protein 364 | |
| 22490 | 206 | AA899289 | | KIAA1049 protein | A |
| 15761 | 345 | AF062741 | | KIAA1348 protein, protein phosphatase 1G (formerly 2C), magnesium-dependent, | B |
| | | | | gamma isoform | |
| 25379 | 1156 | NM_053713 | | Kruppel-like factor 1 (erythroid), Kruppel-like factor 2 (lung), Kruppel-like factor 4 (gut) | GENERAL, C |
| 410 | 358 | AI008974 | | low density lipoprotein receptor-related protein associated protein 1, low density | GENERAL, E |
| | | | | lipoprotein-related protein-associated protein 1 (alpha-2-macroglobulin receptor- | |
| | | | | associated protein 1) | |
| 409 | 695 | AI232268 | | low density lipoprotein receptor-related protein associated protein 1, low density | GENERAL, I |
| | | | | lipoprotein-related protein-associated protein 1 (alpha-2-macroglobulin receptor- | |
| | | | | associated protein 1) | |
| 408 | 1169 | NM_053961 | | low density lipoprotein receptor-related protein associated protein 1, low density | GENERAL |
| | | | | lipoprotein-related protein-associated protein 1 (alpha-2-macroglobulin receptor- | |
| | | | | associated protein 1) | |
| 406 | 1259 | Z11995 | | low density lipoprotein receptor-related protein associated protein 1, low density | GENERAL |
| | | | | lipoprotein-related protein-associated protein 1 (alpha-2-macroglobulin receptor- | |
| | | | | associated protein 1) | |
| 407 | 1259 | Z11995 | | low density lipoprotein receptor-related protein associated protein 1, low density | C |
| | | | | lipoprotein-related protein-associated protein 1 (alpha-2-macroglobulin receptor- | |
| | | | | associated protein 1) | |
| 21653 | 753 | AI237535 | | LPS-induced TNF-alpha factor | GENERAL, C, K |
| 21654 | 1221 | U53184 | | LPS-induced TNF-alpha factor | GENERAL, I, L |
| 8317 | 149 | AA892234 | | microsomal glutathione S-transferase 3 | GENERAL |
| 17923 | 178 | AA892843 | | mitochondrial ribosomal protein L24 | D |
| 20866 | 236 | AA926098 | | mitochondrial ribosomal protein L53 | J |
| 19152 | 768 | AI639387 | | mitochondrial ribosomal protein S6 | GENERAL, D |
| 3925 | 75 | AA851017 | | molybdenum cofactor synthesis 2 | A, E |
| 809 | 1207 | U17035 | | monokine induced by gamma interferon, small inducible cytokine B subfamily (Cys-X-Cys | C |
| | | | | motif), member 13 (B-cell chemoattractant), small inducible cytokine B subfamily (Cys-X- | |
| | | | | Cys), member 10, small inducible cytokine subfamily B (Cys-X-Cys), member 10, small | |
| | | | | inducible cytokine subfamily B (Cys-X-Cys), member 11 | |
| 17223 | 605 | AI176140 | | MORF-related gene 15, RIKEN cDNA 1700060H10 gene, testis expressed gene 189 | D |
| 21672 | 132 | AA891789 | | MORF-related gene X | C, D |
| 1462 | 733 | AI235585 | | Mus musculus 10 day old male pancreas cDNA, RIKEN full-length enriched library, | GENERAL, E, G, |
| | | | | clone: 1810054L16:kidney-derived aspartic protease-like protein, full insert sequence, | |
| | | | | cathepsin D, cathepsin D (lysosomal aspartyl protease) | |
| 1463 | 1241 | X54467 | | Mus musculus 10 day old male pancreas cDNA, RIKEN full-length enriched library, | GENERAL, G, K |
| | | | | clone: 1810054L16:kidney-derived aspartic protease-like protein, full insert sequence, | |
| | | | | cathepsin D, cathepsin D (lysosomal aspartyl protease) | |
| 23810 | 402 | AI012781 | | Mus musculus adult male brain cDNA, RIKEN full-length enriched library, | E |
| | | | | clone: 0710008P15:enhancer of zeste homolog 1 (Drosophila), full insert sequence, | |
| | | | | enhancer of zeste homolog 2 (Drosophila), nuclear receptor binding SET domain protein 1 | |
| 19824 | 995 | NM_021750 | | Mus musculus adult male liver cDNA, RIKEN full-length enriched library, | G, K |
| | | | | clone: 1300015E02:deoxyribonuclease II alpha, full insert sequence, cysteine sulfinic acid | |
| | | | | decarboxylase-related protein 2 | |
| 23261 | 226 | AA925145 | | Mus musculus adult male testis cDNA, RIKEN full-length enriched library, | GENERAL, I |
| | | | | clone: 4930572N12:betaine-homocysteine methyltransferase, full insert sequence, betaine | |
| | | | | homocysteine methyltransferase, betaine-homocysteine methyltransferase 2 | |
| 22781 | 111 | AA874926 | | Mus musculus dual specificity phosphatase T-DSP10 mRNA, complete cds, RIKEN | F |
| | | | | cDNA 5930436K22 gene, protein phosphatase | |
| 22783 | 205 | AA894207 | | Mus musculus dual specificity phosphatase T-DSP10 mRNA, complete cds, RIKEN | A, F |
| | | | | cDNA 5930436K22 gene, protein phosphatase | |
| 23093 | 217 | AA924342 | | Mus musculus dual specificity phosphatase T-DSP10 mRNA, complete cds, RIKEN | G |
| | | | | cDNA 5930436K22 gene, protein phosphatase | |
| 15790 | 1135 | NM_053341 | | Mus musculus mRNA for PDZ-domain protein Gipc3, complete cds, PDZ domain protein | E |
| | | | | GIPC2, expressed sequence AU021850, regulator of G-protein signaling 19 interacting | |
| | | | | protein 1, regulator of G-protein signalling 19 interacting protein 1, semaF cytoplasmic | |
| | | | | domain associated protein 2 | |
| 15791 | 1135 | NM_053341 | | Mus musculus mRNA for PDZ-domain protein Gipc3, complete cds, PDZ domain protein | C |
| | | | | GIPC2, expressed sequence AU021850, regulator of G-protein signaling 19 interacting | |
| | | | | protein 1, regulator of G-protein signalling 19 interacting protein 1, semaF cytoplasmic | |
| | | | | domain associated protein 2 | |
| 24484 | 1128 | NM_052806 | | Mus musculus nicotinic acetylcholine receptor beta4 subunit (Chmb4) mRNA, complete | H |
| | | | | cds, cholinergic receptor, nicotinic, beta polypeptide 2 (neuronal), cholinergic receptor, | |
| | | | | nicotinic, beta polypeptide 4 | |
| 19184 | 631 | AI178025 | | Mus musculus testis expressed homeobox mRNA, complete cds, RIKEN cDNA | GENERAL, H, I |
| | | | | 5430405H02 gene, RIKEN cDNA 5730599O09 gene, TG interacting factor, TGF(beta)- | |
| | | | | induced transcription factor 2-like, TGFB-induced factor (TALE family homeobox), TGFB- | |
| | | | | induced factor 2 (TALE family homeobox) | |
| 11653 | 62 | AA848689 | | Mus musculus, Carbonic anhydrase-related protein 10, clone MGC: 27641 | A, F |
| | | | | IMAGE: 4507552, mRNA, complete cds, carbonic anhydrase 11, carbonic anhydrase 5, | |
| | | | | carbonic anhydrase 5a, mitochondrial, carbonic anhydrase 5b, mitochondrial, carbonic | |
| | | | | anhydrase 7, carbonic anhydrase VA, mitochondrial, carbonic anhydrase VB, | |
| | | | | mitochondrial | |
| 1962 | 995 | NM_021750 | | Mus musculus, clone IMAGE: 3491119, mRNA, partial cds, Rattus norvegicus 3beta- | J |
| | | | | hydroxysteroid dehydrogenase/delta5-delta4 isomerase (3beta-HSD) mRNA, complete | |
| | | | | cds, hydroxy-delta-5-steroid dehydrogenase, 3 beta- and steroid delta-isomerase 1, | |
| | | | | hydroxysteroid dehydrogenase-1, delta<5>-3-beta, hydroxysteroid dehydrogenase-2, | |
| | | | | delta<5>-3-beta, hydroxysteroid dehydrogenase-3, delta<5>-3-beta, hydroxysteroid | |
| | | | | dehydrogenase-6 delta<5>-3-beta | |
| 35 | 1162 | NM_053840 | | Mus musculus, clone MGC: 12004 IMAGE: 3602314, mRNA, complete cds, RIKEN cDNA | C |
| | | | | 9030405D14 gene, gamma-glutamyl transpeptidase, gamma-glutamyltransferase 1 | |
| 699 | 1223 | U55765 | | Mus musculus, clone MGC: 25863 IMAGE: 4196269, mRNA, complete cds, Mus | E |
| | | | | musculus, clone MGC: 37860 IMAGE: 5100400, mRNA, complete cds, serine (or cysteine) | |
| | | | | proteinase inhibitor, clade A (alpha-1 antiproteinase, antitrypsin), member 10, serine | |
| | | | | protease inhibitor 1-1 | |
| 4312 | 333 | AB010635 | | Mus musculus, clone MGC: 28542 IMAGE: 4194872, mRNA, complete cds, Mus | J |
| | | | | musculus, clone MGC: 31116 IMAGE: 4163362, mRNA, complete cds, carboxylesterase | |
| | | | | 1, carboxylesterase 1 (monocyte/macrophage serine esterase 1), carboxylesterase 2 | |
| | | | | (intestine, liver), carboxylesterase 3, carboxylesterase 3 (brain), carboxylesterase-related | |
| | | | | protein, expressed sequence AI266984. neuroligin 1 | |
| 15132 | 684 | AI231180 | | Mus musculus, clone MGC: 28736 IMAGE: 4461170, mRNA, complete cds, R. norvegicus | G |
| | | | | mRNA for unknown protein (PIPPin), RIKEN cDNA 1200011K09 gene, calcium-regulated | |
| | | | | heat-stable protein (24 kD), ortholog of rat pippin | |
| 11162 | 354 | AI008183 | | Mus musculus, clone MGC: 38048 IMAGE: 5250967, mRNA, complete cds, RIKEN cDNA | C |
| | | | | 4933435C21 gene, solute carrier family 29 (nucleoside transporters), member 1 | |
| 21695 | 1191 | NM_130411 | | Mus musculus, Similar to coronin, actin binding protein, 2A, clone IMAGE: 4984475, | G |
| | | | | mRNA, partial cds, coronin, actin binding protein 1A, coronin, actin binding protein, 1A | |
| 19058 | 342 | AF054618 | | Mus musculus, Similar to cortactin isoform B, clone MGC: 18474 IMAGE: 3981559, | E |
| | | | | mRNA, complete cds, cortactin, ems1 sequence (mammary tumor and squamous cell | |
| | | | | carcinoma-associated (p80/85 src substrate), hematopoietic cell specific Lyn substrate 1, | |
| | | | | hematopoietic cell-specific Lyn substrate 1 | |
| 3454 | 1155 | NM_053662 | | Mus musculus, Similar to cyclin K, clone MGC: 28173 IMAGE: 3986609, mRNA, complete | J |
| | | | | cds, Paneth cell enhanced expression, RIKEN cDNA 1810009O10 gene, cyclin L, cyclin | |
| | | | | T1, cyclin T2 | |
| 20741 | 347 | AF084186 | | Mus musculus, similar to src homology three (SH3) and cysteine rich domain, clone | A, J |
| | | | | MGC: 38869 IMAGE: 5361431, mRNA, complete cds, RIKEN cDNA 2610027H02 gene, | |
| | | | | RIKEN cDNA 2610301F02 gene, alpha-spectrin 1, erythroid, nesprin-1, spectrin, alpha, | |
| | | | | erythrocytic 1 (elliptocytosis 2), spectrin, alpha, non-erythrocytic 1 (alpha-fodrin), src | |
| | | | | homology three (SH3) and cysteine rich domain | |
| 14970 | 1059 | NM_031127 | | Mus musculus, Similar to sulfite oxidase, clone MGC: 28458 IMAGE: 4160277, mRNA, | GENERAL, B, H, I, K |
| | | | | complete cds, RIKEN cDNA 1810044O22 gene, RIKEN cDNA 2810034J18 gene, sulfite | |
| | | | | oxidase | |
| 16881 | 190 | AA893185 | | NADH dehydrogenase (ubiquinone) 1 beta subcomplex, 5 (16 kD, SGDH) | J |
| 18509 | 526 | AI104528 | | NADH dehydrogenase (ubiquinone) 1 beta subcomplex, 6 (17 kD, B17) | A |
| 21302 | 404 | AI013297 | | NADH dehydrogenase (ubiquinone) Fe—S protein 4, NADH dehydrogenase (ubiquinone) | J |
| | | | | Fe—S protein 4 (18 kD) (NADH-coenzyme Q reductase) | |
| 23843 | 296 | AA957410 | | NCK adaptor protein 2 | D |
| 14638 | 551 | AI137049 | | Nijmegen breakage syndrome 1 (nibrin), nibrin | J |
| 1508 | 1163 | NM_053845 | | Nit protein 2, expressed sequence AI195023, nitrilase 1, ureidopropionase, beta | G |
| 3874 | 419 | AI029428 | | nuclear cap binding protein subunit 1, 80 kD | GENERAL, I |
| 3875 | 727 | AI235047 | | nuclear cap binding protein subunit 1, 80 kD | GENERAL, A |
| 13111 | 553 | AI137224 | | oxysterol binding protein 2 | GENERAL |
| 14332 | 775 | AJ001044 | | p53-induced protein PIGPC1, tumor-associated calcium signal transducer 1 | D |
| 20457 | 986 | NM_020073 | | parathyroid hormone receptor, parathyroid hormone receptor 1, parathyroid hormone | GENERAL, B, K, L |
| | | | | receptor 2 | |
| 20458 | 986 | NM_020073 | | parathyroid hormone receptor, parathyroid hormone receptor 1, parathyroid hormone | GENERAL, I, K, L |
| | | | | receptor 2 | |
| 4290 | 1141 | NM_053487 | | peroxisomal biogenesis factor 11A, peroxisomal biogenesis factor 11B, peroxisomal | L |
| | | | | biogenesis factor 11a, peroxisomal biogenesis factor 11b | |
| 7270 | 406 | AI013564 | | PEST-containing nuclear protein | D |
| 21976 | 266 | AA946011 | | phosphatidylinositol-4-phosphate 5-kinase, type II, beta, phosphatidylinositol-4-phosphate | B |
| | | | | 5-kinase, type II, gamma | |
| 5295 | 240 | AA926247 | | potassium channel, subfamily K, member 1, potassium channel, subfamily K, member 1 | GENERAL, L |
| | | | | (TWIK-1), potassium channel, subfamily K, member 7, potassium channel, subfamily K, | |
| | | | | member 8 | |
| 19665 | 993 | NM_021688 | | potassium channel, subfamily K, member 1, potassium channel, subfamily K, member 1 | D, L |
| | | | | (TWIK-1), potassium channel, subfamily K, member 7, potassium channel, subfamily K, | |
| | | | | member 8 | |
| 19469 | 146 | AA892112 | | proline dehydrogenase, proline dehydrogenase (oxidase) 1 | GENERAL, D |
| 1422 | 1066 | NM_031324 | | prolyl endopeptidase | GENERAL, B, G, L |
| 25198 | 996 | NM_021754 | | PRP31 pre-mRNA processing factor 31 homolog (yeast), RIKEN cDNA 1500019O16 | GENERAL, I, K |
| | | | | gene, nucleolar protein 5, nucleolar protein 5A (56 kD with KKE/D repeat), nucleolar | |
| | | | | protein NOP5/NOP58 | |
| 20035 | 996 | NM_021754 | | PRP31 pre-mRNA processing factor 31 homolog (yeast), RIKEN cDNA 1500019O16 | GENERAL, H |
| | | | | gene, nucleolar protein 5, nucleolar protein 5A (56 kD with KKE/D repeat), nucleolar | |
| | | | | protein NOP5/NOP58 | |
| 19822 | 643 | AI179599 | | RAB7, member RAS oncogene family-like 1, RAB9, member RAS oncogene family, | A |
| | | | | RAB9A, member RAS oncogene family, RAB9B, member RAS oncogene family, RIKEN | |
| | | | | cDNA 2810011A17 gene | |
| 18300 | 878 | NM_013030 | | Rattus norvegicus mRNA for Na+/Pi-cotransporter type IIc, complete cds, Solute carrier | GENERAL, H, I, L |
| | | | | family 17 (sodium/hydrogen exchanger), member 2, expressed sequence AI649385, | |
| | | | | solute carrier family 34 (sodium phosphate), member 1 | |
| 1515 | 1053 | NM_031095 | | renin binding protein | J |
| 10789 | 1039 | NM_024399 | | RIKEN cDNA 0610006H10 gene, aspartoacylase (aminoacylase 2, Canavan disease), | GENERAL |
| | | | | aspartoacylase (aminoacylase) 2, similar to RIKEN cDNA 0610006H10 gene | |
| 18452 | 913 | NM_017074 | | RIKEN cDNA 0610010I13 gene, cystathionase (cystathionine gamma-lyase), expressed | GENERAL |
| | | | | sequence AI098105 | |
| 18453 | 913 | NM_017074 | | RIKEN cDNA 0610010I13 gene, cystathionase (cystathionine gamma-lyase), expressed | G |
| | | | | sequence AI098105 | |
| 23321 | 176 | AA892821 | | RIKEN cDNA 0610025K21 gene, aflatoxin B1 aldehyde reductase, aldo-keto reductase | GENERAL |
| | | | | family 7, member A2 (aflatoxin aldehyde reductase) | |
| 20864 | 901 | NM_013215 | | RIKEN cDNA 0610025K21 gene, aldo-keto reductase family 7, member A2 (aflatoxin | B, J |
| | | | | aldehyde reductase) | |
| 18001 | 79 | AA858573 | | RIKEN cDNA 0610038O04 gene, secreted phosphoprotein 2, 24 kD | GENERAL |
| 17999 | 1211 | U19485 | | RIKEN cDNA 0610038O04 gene, secreted phosphoprotein 2, 24 kD | GENERAL |
| 18000 | 1211 | U19485 | | RIKEN cDNA 0610038O04 gene, secreted phosphoprotein 2, 24 kD | I |
| 14763 | 256 | AA944481 | | RIKEN cDNA 1110007F23 gene, angiopoietin 2, angiopoietin-like 3, angiopoietin-like 4, | L |
| | | | | ficolin (collagen/fibrinogen domain containing lectin) 2 (hucolin), ficolin | |
| | | | | (collagen/fibrinogen domain containing) 1, ficolin B | |
| 1549 | 1009 | NM_022508 | | RIKEN cDNA 1110019K23 gene, methylene tetrahydrofolate dehydrogenase (NAD+ | G |
| | | | | dependent), methenyltetrahydrofolate cyclohydrolase, methylenetetrahydrofolate | |
| | | | | dehydrogenase (NAD+ dependent), methenyltetrahydrofolate cyclohydrolase, | |
| | | | | methylenetetrahydrofolate dehydrogenase (NADP+ dependent), methenyltetrahydrofolate | |
| | | | | cyclohydrolase, formyltetrahydrofolate synthase, methylenetetrahydrofolate | |
| | | | | dehydrogenase (NADP+ dependent), methenyltetrahydrofolate cyclohydrolase, | |
| | | | | formyltetrahydrofolate synthetase | |
| 15800 | 1159 | NM_053810 | | RIKEN cDNA 1300018G05 gene, synaptosomal-associated protein, 29 kD | A |
| 25467 | 818 | M93297 | | RIKEN cDNA 1300019H02 gene, RIKEN cDNA 2900006B13 gene, omithine | G |
| | | | | aminotransferase, omithine aminotransferase (gyrate atrophy) | |
| 21253 | 530 | AI105110 | | RIKEN cDNA 1500010M16 gene, translation factor sui1 homolog | F |
| 12921 | 546 | AI112636 | | RIKEN cDNA 1700124F02 gene, uridine phosphorylase | GENERAL, B, L |
| 3878 | 193 | AA893230 | | RIKEN cDNA 2310068O22 gene, calmodulin 1, calmodulin 1 (phosphorylase kinase, | GENERAL |
| | | | | delta), calmodulin 2, calmodulin 2 (phosphorylase kinase, delta), calmodulin 3, calmodulin | |
| | | | | like 3, centrin 1, centrin, EF-hand protein, 1, expressed sequence AI327027, expressed | |
| | | | | sequence AL024000, troponin C, fast skeletal | |
| 24233 | 308 | AA964756 | | RIKEN cDNA 2310068O22 gene, calmodulin 1, calmodulin 2, calmodulin-like 3, centrin 1, | F |
| | | | | centrin, EF-hand protein, 1, centrin, EF-hand protein, 2, expressed sequence AI327027, | |
| | | | | expressed sequence AL024000, troponin C, fast skeletal, troponin C2, fast | |
| 16168 | 194 | AA893280 | | RIKEN cDNA 2310076L09 gene, adipose differentiation related protein, adipose | GENERAL, J |
| | | | | differentiation-related protein | |
| 16169 | 430 | AI030932 | | RIKEN cDNA 2310076L09 gene, adipose differentiation related protein, adipose | J |
| | | | | differentiation-related protein | |
| 3172 | 317 | AA997406 | | RIKEN cDNA 2410072D24 gene, proteasome (prosome, macropain) subunit, alpha type | B |
| | | | | 7, proteasome (prosome, macropain) subunit, alpha type, 7 | |
| 13157 | 558 | AI138020 | | RIKEN cDNA 2610016A03 gene, polyamine N-acetyltransferase | D |
| 7700 | 534 | AI105383 | | RIKEN cDNA 2610037M15 gene, sphingosine kinase 1, sphingosine kinase 2 | GENERAL, D |
| 2098 | 20 | AA799995 | | RIKEN cDNA 3100001N19 gene, ribosomal protein L14 | C |
| 23166 | 100 | AA859954 | | RIKEN cDNA 4930579A11 gene, likely ortholog of rat vacuole membrane protein 1 | GENERAL, C, L |
| 16082 | 109 | AA874887 | | RIKEN cDNA C030018L16 gene, SMC (segregation of mitotic chromosomes 1)-like 1 | E |
| | | | | (yeast), SMC (structural maintenace of chromosomes 1)-like 2 (S. cerevisiae), SMC | |
| | | | | (structural maintenance of chromosomes 1)-like 1 (S. cerevisiae), SMC1 structural | |
| | | | | maintenance of chromosomes 1-like 1 (yeast), SMC4 structural maintenance of | |
| | | | | chromosomes 4-like 1 (yeast) | |
| 16552 | 1169 | NM_053961 | | RIKEN cDNA C030022K24 gene, chromosome 12 open reading frame 8, endoplasmic | L |
| | | | | reticulum protein 29 | |
| 17088 | 142 | AA891998 | | sequestosome 1 | B, L |
| 1439 | 1224 | U57391 | | SH2-B PH domain containing signaling mediator 1, SH2-B homolog, adaptor protein with | H |
| | | | | pleckstrin homology and src, adaptor protein with pleckstrin homology and src homology | |
| | | | | 2 domains, src homology 2 domain-containing transforming protein C3 | |
| 7888 | 715 | AI233583 | | similar to arginyl-tRNA synthetase | GENERAL |
| 23538 | 506 | AI102727 | | solute carrier family 20 (phosphate transporter), member 1, solute carrier family 20 | GENERAL |
| | | | | (phosphate transporter), member 2, solute carrier family 20, member 1, solute carrier | |
| | | | | family 20, member 2 | |
| 17468 | 165 | AA892545 | | solute carrier family 22 (organic cation transporter), member 1-like | D |
| 23509 | 383 | AI010962 | | sorting nexin 3 | A |
| 11692 | 758 | AI638982 | | sulfotransferase family, cytosolic, 1C, member 1 | GENERAL |
| 15004 | 729 | AI235224 | | tissue inhibitor of metalloproteinase, tissue inhibitor of metalloproteinase 1 (erythroid | GENERAL, G, K |
| | | | | potentiating activity, collagenase inhibitor) | |
| 15002 | 1160 | NM_053819 | | tissue inhibitor of metalloproteinase, tissue inhibitor of metalloproteinase 1 (erythroid | GENERAL, E, G, K |
| | | | | potentiating activity, collagenase inhibitor) | |
| 15003 | 1160 | NM_053819 | | tissue inhibitor of metalloproteinase, tissue inhibitor of metalloproteinase 1 (erythroid | G, K |
| | | | | potentiating activity, collagenase inhibitor) | |
| 16039 | 1107 | NM_031811 | | transaldolase 1 | H |
| 7505 | 1013 | NM_022534 | | transcobalamin 2, transcobalamin II; macrocytic anemia | A |
| 2125 | 502 | AI102519 | | TYRO protein tyrosine kinase binding protein | G |
| 16469 | 160 | AA892462 | | ubiquinol-cytochrome c reductase (6.4 kD) subunit | A, C |
| 16468 | 238 | AA926137 | | ubiquinol-cytochrome c reductase (6.4 kD) subunit | A |
| 18597 | 1067 | NM_031325 | | UDP-glucose dehydrogenase | B, H |
| 15576 | 148 | AA892132 | | uncharacterized hematopoietic stem/progenitor cells protein MDS032 | J |
| 12331 | 1180 | NM_057155 | | X-prolyl aminopeptidase (aminopeptidase P) 2, membrane-bound, membrane-bound | GENERAL, H |
| | | | | aminopeptidase P | |
| 12332 | 1180 | NM_057155 | | X-prolyl aminopeptidase (aminopeptidase P) 2, membrane-bound, membrane-bound | GENERAL, G |
| | | | | aminopeptidase P | |
| 15008 | 340 | AF038591 | | X-prolyl aminopeptidase (aminopeptidase P)-like, cytosolic aminopeptidase P | E |

TABLE 4
CODE KEY

Atty. Docket No. GENE-077/26US
Doc. No. 44941

| GLGC Model | Model Code |
|---|---|
| General Nephrotoxicity | GENERAL |
| Chloroform | A |
| Diclofenac | B |
| Menadione | C |
| SodiumChromate | D |
| SodiumOxalate | E |
| Thioacetamide | F |
| Vancomycin | G |
| S2 | H |
| Tubular Toxicity | I |
| Glomerular Injury | J |
| Tubular Obstruction | K |
| NSAIDS | L |

TABLE 5
GENERAL

Atty. Docket No. GENE-077/26US
Doc. No. 44941

| | | Tox | Tox | Non-Tox | Non-Tox |
|---|---|---|---|---|---|
| GLGC | | Group | Group | Group | Group |
| Identifier | LDA Score | Mean | SD | Mean | SD |
| 3050 | 76.59 | 151.97 | 82.62 | 77.07 | 24.98 |
| 10789 | 71.31 | 226.28 | 98.93 | 319.54 | 77.45 |
| 14020 | 70.44 | 212.80 | 56.70 | 266.01 | 46.38 |
| 15955 | 73.57 | 515.14 | 191.35 | 728.18 | 122.31 |
| 24321 | 70.99 | 515.86 | 195.77 | 686.86 | 131.04 |
| 5601 | 74.82 | 640.28 | 294.69 | 934.56 | 178.65 |
| 4440 | 73.28 | 210.00 | 74.37 | 306.59 | 75.86 |
| 7285 | 72.30 | 183.98 | 45.26 | 227.37 | 39.94 |
| 12467 | 70.48 | 91.52 | 43.59 | 57.64 | 16.70 |
| 19998 | 70.32 | 192.15 | 78.72 | 267.63 | 67.09 |
| 3823 | 75.50 | 654.04 | 216.61 | 458.26 | 76.00 |
| 11967 | 70.95 | 1213.17 | 570.43 | 1709.91 | 412.19 |
| 13954 | 71.06 | 948.19 | 350.16 | 1298.60 | 301.79 |
| 17907 | 71.03 | 1012.87 | 306.06 | 1257.12 | 200.00 |
| 14095 | 70.92 | 281.28 | 79.38 | 369.45 | 63.47 |
| 6046 | 77.32 | 132.00 | 60.76 | 209.20 | 53.92 |
| 7888 | 71.84 | 318.41 | 78.58 | 247.97 | 40.89 |
| 6416 | 72.17 | 221.69 | 181.98 | 105.92 | 33.73 |
| 14677 | 73.22 | 105.84 | 49.33 | 62.34 | 18.47 |
| 3875 | 75.61 | 354.67 | 119.89 | 510.04 | 111.81 |
| 15004 | 71.20 | 315.68 | 341.04 | 126.60 | 39.41 |
| 11164 | 73.11 | 349.24 | 142.19 | 507.35 | 120.35 |
| 6336 | 70.98 | 336.24 | 89.69 | 418.43 | 89.90 |
| 3091 | 76.72 | 545.67 | 168.85 | 749.73 | 128.16 |
| 14867 | 70.80 | 101.12 | 62.31 | 165.12 | 71.18 |
| 15051 | 72.81 | 870.06 | 414.32 | 531.84 | 140.63 |
| 16859 | 71.33 | 166.91 | 73.19 | 112.81 | 33.48 |
| 24388 | 72.16 | 256.14 | 119.20 | 163.06 | 35.67 |
| 18303 | 70.44 | 281.64 | 239.24 | 513.56 | 243.07 |
| 3467 | 73.26 | 477.56 | 179.67 | 670.32 | 151.77 |
| 7279 | 70.58 | 177.33 | 131.04 | 191.37 | 58.86 |
| 5867 | 70.42 | 195.07 | 60.67 | 148.14 | 26.48 |
| 17361 | 77.49 | 81.56 | 49.55 | 151.85 | 49.33 |
| 21025 | 74.37 | 313.31 | 107.42 | 441.97 | 94.86 |
| 16314 | 77.26 | 103.96 | 76.71 | 33.61 | 21.85 |
| 1698 | 70.92 | 172.23 | 191.95 | 50.55 | 32.52 |
| 5297 | 67.89 | 282.49 | 103.56 | 368.51 | 102.45 |
| 8317 | 68.06 | 1149.89 | 388.88 | 1428.19 | 346.12 |
| 11454 | 70.33 | 328.59 | 156.12 | 216.73 | 53.33 |
| 11455 | 70.50 | 162.65 | 95.78 | 94.80 | 26.70 |
| 1850 | 67.86 | 62.21 | 93.09 | 24.45 | 96.13 |
| 15295 | 67.57 | 171.07 | 70.81 | 126.38 | 31.75 |
| 17734 | 71.76 | 206.37 | 202.42 | 95.30 | 30.54 |
| 20817 | 68.72 | 1865.76 | 1135.85 | 1150.17 | 447.11 |
| 21061 | 68.32 | 67.94 | 30.57 | 46.71 | 18.28 |
| 22352 | 69.21 | 240.63 | 198.59 | 129.55 | 52.38 |
| 22662 | 69.52 | 107.46 | 29.01 | 136.36 | 29.33 |
| 23837 | 68.09 | 121.06 | 52.18 | 85.23 | 27.33 |
| 20801 | 71.85 | 199.99 | 73.50 | 140.35 | 32.13 |
| 353 | 70.73 | 272.05 | 161.59 | 149.39 | 40.00 |
| 354 | 71.60 | 342.25 | 192.43 | 190.95 | 42.15 |
| 7101 | 73.48 | 1028.63 | 1448.92 | 269.03 | 75.33 |
| 17541 | 67.78 | 1031.81 | 707.66 | 671.17 | 173.64 |
| 1399 | 70.32 | 291.48 | 158.06 | 180.41 | 40.15 |
| 1454 | 69.83 | 155.56 | 72.94 | 98.16 | 40.12 |
| 15185 | 68.29 | 234.32 | 137.00 | 142.70 | 43.80 |
| 23445 | 68.77 | 516.36 | 187.24 | 686.21 | 139.36 |
| 25070 | 70.39 | 353.20 | 90.91 | 442.88 | 89.02 |
| 20818 | 67.77 | 1218.48 | 808.49 | 683.44 | 312.98 |
| 20161 | 74.51 | 72.01 | 53.68 | 25.32 | 16.61 |
| 17157 | 70.27 | 66.75 | 35.98 | 40.40 | 14.13 |
| 20457 | 74.51 | 307.25 | 108.92 | 417.65 | 84.52 |
| 18300 | 75.29 | 313.22 | 163.49 | 527.19 | 147.37 |
| 1727 | 73.95 | 105.41 | 122.47 | 22.30 | 20.76 |
| 11483 | 73.32 | 116.30 | 97.07 | 45.20 | 13.89 |
| 23868 | 75.06 | 476.59 | 578.57 | 104.39 | 73.16 |
| 21145 | 68.42 | 166.45 | 59.78 | 210.98 | 64.34 |
| 22602 | 68.23 | 241.70 | 126.48 | 348.96 | 102.98 |
| 16649 | 67.98 | 147.87 | 84.06 | 97.60 | 32.65 |
| 17324 | 69.51 | 312.59 | 107.12 | 383.77 | 72.30 |
| 16006 | 68.36 | 71.88 | 53.76 | 35.40 | 17.42 |
| 25198 | 71.55 | 41.84 | 21.30 | 24.47 | 10.29 |
| 744 | 69.51 | 282.84 | 77.81 | 353.13 | 70.01 |
| 5496 | 69.23 | 508.95 | 208.94 | 686.29 | 135.72 |
| 5497 | 69.71 | 618.39 | 241.87 | 823.93 | 151.32 |
| 10015 | 71.92 | 325.47 | 153.58 | 212.06 | 42.33 |
| 10016 | 71.00 | 301.53 | 145.98 | 190.35 | 43.04 |
| 2554 | 67.63 | 57.16 | 20.54 | 42.64 | 12.31 |
| 2555 | 78.32 | 138.95 | 71.04 | 72.75 | 17.34 |
| 3608 | 73.18 | 234.71 | 128.06 | 383.50 | 124.15 |
| 1214 | 68.38 | 128.30 | 68.13 | 158.55 | 45.71 |
| 18452 | 69.52 | 321.39 | 118.91 | 424.39 | 94.63 |
| 20493 | 69.93 | 391.49 | 143.65 | 510.95 | 105.19 |
| 28 | 78.46 | 337.76 | 190.36 | 572.67 | 145.84 |
| 3987 | 68.10 | 229.04 | 70.17 | 180.46 | 37.27 |
| 17159 | 72.54 | 1017.46 | 356.32 | 743.47 | 134.89 |
| 574 | 75.37 | 578.23 | 363.75 | 306.48 | 52.52 |
| 25379 | 69.82 | 91.37 | 33.44 | 67.37 | 15.00 |
| 24219 | 76.53 | 444.44 | 155.56 | 293.46 | 58.45 |
| 20458 | 75.73 | 275.50 | 100.52 | 389.11 | 82.95 |
| 8829 | 72.83 | 370.34 | 120.13 | 265.09 | 63.72 |
| 21882 | 72.04 | 626.54 | 164.71 | 793.68 | 153.08 |
| 1430 | 69.19 | 91.41 | 91.79 | 157.32 | 82.87 |
| 25453 | 72.92 | 169.54 | 55.07 | 219.24 | 42.22 |
| 7872 | 70.14 | 85.77 | 33.42 | 118.89 | 31.25 |
| 5837 | 69.05 | 707.52 | 227.34 | 877.59 | 176.16 |
| 5838 | 67.71 | 538.51 | 169.64 | 674.95 | 122.93 |
| 7196 | 73.11 | 293.56 | 170.45 | 155.35 | 40.04 |
| 8210 | 68.29 | 744.10 | 212.87 | 921.28 | 180.15 |
| 3244 | 69.31 | 95.07 | 31.63 | 119.82 | 24.28 |
| 1460 | 75.38 | 290.35 | 157.01 | 170.57 | 30.83 |
| 25567 | 70.13 | 673.51 | 317.82 | 438.95 | 133.11 |
| 3430 | 70.44 | 621.18 | 275.86 | 418.22 | 103.80 |
| 22196 | 68.49 | 63.02 | 25.82 | 44.77 | 14.72 |
| 16708 | 70.11 | 207.75 | 51.37 | 256.42 | 46.45 |
| 24234 | 69.97 | 302.51 | 219.14 | 168.07 | 50.65 |
| 2153 | 69.24 | 324.59 | 302.82 | 143.84 | 45.14 |
| 1546 | 67.70 | 196.17 | 73.15 | 253.35 | 55.86 |
| 14996 | 71.12 | 339.33 | 144.00 | 507.21 | 153.71 |
| 20449 | 68.80 | 100.49 | 132.92 | 33.15 | 21.87 |
| 18606 | 67.59 | 847.38 | 254.52 | 660.80 | 115.15 |
| 20848 | 75.49 | 739.86 | 245.09 | 506.98 | 87.27 |
| 19678 | 74.00 | 44.46 | 60.23 | 110.35 | 45.84 |
| 17175 | 67.70 | 829.25 | 224.80 | 660.02 | 115.42 |
| 25705 | 68.69 | 571.36 | 176.40 | 451.97 | 76.32 |
| 21657 | 67.75 | 540.36 | 166.22 | 426.24 | 80.59 |
| 25718 | 67.76 | 500.44 | 141.40 | 404.97 | 60.85 |
| 13646 | 68.61 | 999.55 | 297.34 | 776.97 | 122.96 |
| 16012 | 68.18 | 93.81 | 55.30 | 58.56 | 15.00 |
| 25747 | 71.58 | 77.46 | 61.57 | 34.94 | 16.33 |
| 12978 | 77.09 | 161.06 | 78.86 | 82.73 | 24.07 |
| 25777 | 70.16 | 731.13 | 475.10 | 385.64 | 125.24 |
| 406 | 69.98 | 313.92 | 96.72 | 398.37 | 80.51 |
| 10887 | 73.15 | 45.60 | 19.26 | 68.19 | 20.96 |
| 24431 | 75.66 | 140.50 | 186.74 | 42.64 | 13.20 |
| 24438 | 68.73 | 114.07 | 42.85 | 148.98 | 36.10 |
| 17269 | 68.45 | 556.66 | 223.69 | 748.94 | 194.32 |
| 24496 | 73.35 | 77.54 | 41.57 | 118.88 | 29.67 |
| 20414 | 68.68 | 85.25 | 29.18 | 114.52 | 31.67 |
| 291 | 68.98 | 188.63 | 56.91 | 232.01 | 38.29 |
| 24770 | 67.96 | 167.86 | 99.91 | 258.46 | 101.06 |
| 45 | 69.84 | 120.96 | 88.26 | 186.49 | 67.03 |
| 24568 | 72.93 | 100.99 | 45.78 | 166.37 | 65.68 |
| 17999 | 68.25 | 901.71 | 380.29 | 1228.53 | 405.22 |
| 15851 | 68.33 | 317.19 | 273.69 | 160.11 | 75.58 |
| 18011 | 68.45 | 55.33 | 47.59 | 21.92 | 18.16 |
| 556 | 69.38 | 55.50 | 17.48 | 75.28 | 24.04 |
| 770 | 67.51 | 701.61 | 282.78 | 933.20 | 236.57 |
| 794 | 73.03 | 150.00 | 59.20 | 220.62 | 54.40 |
| 811 | 73.48 | 192.98 | 69.93 | 265.15 | 46.49 |
| 812 | 77.52 | 110.30 | 37.74 | 159.20 | 31.00 |
| 24648 | 69.01 | 23.19 | 11.70 | 35.71 | 12.85 |
| 1246 | 75.48 | 51.06 | 35.74 | 88.19 | 29.97 |
| 21053 | 68.52 | 66.73 | 31.72 | 102.83 | 48.28 |
| 11692 | 69.79 | 1135.77 | 414.48 | 1546.52 | 408.08 |
| 15330 | 75.22 | 58.49 | 22.62 | 86.85 | 21.03 |
| 19152 | 69.04 | 209.49 | 82.42 | 150.47 | 38.00 |
| 19679 | 72.17 | 554.05 | 249.84 | 799.21 | 160.22 |
| 19943 | 69.50 | 284.30 | 126.39 | 383.93 | 104.87 |
| 20082 | 71.73 | 92.50 | 42.33 | 59.76 | 14.72 |
| 20056 | 75.15 | 244.80 | 87.52 | 328.98 | 56.50 |
| 14970 | 76.68 | 152.21 | 48.93 | 210.61 | 31.30 |
| 15110 | 75.65 | 524.74 | 161.30 | 744.40 | 164.54 |
| 17684 | 70.48 | 183.88 | 61.32 | 243.76 | 49.96 |
| 408 | 69.14 | 130.38 | 67.28 | 191.46 | 65.83 |
| 18564 | 71.21 | 177.18 | 50.69 | 222.90 | 43.22 |
| 15299 | 76.65 | 136.30 | 106.16 | 61.66 | 17.89 |
| 1798 | 70.19 | 258.62 | 95.82 | 346.73 | 96.89 |
| 825 | 67.73 | 33.82 | 15.83 | 49.46 | 17.83 |
| 17473 | 68.53 | 518.00 | 161.86 | 427.54 | 71.99 |
| 13151 | 76.24 | 1189.02 | 539.58 | 699.61 | 197.75 |
| 1409 | 71.37 | 356.35 | 100.26 | 457.09 | 90.41 |
| 17908 | 74.57 | 121.36 | 116.12 | 42.53 | 16.55 |
| 1501 | 72.34 | 109.79 | 98.72 | 39.88 | 21.66 |
| 15002 | 73.73 | 244.23 | 206.55 | 112.57 | 27.72 |
| 15190 | 67.62 | 3108.28 | 1723.86 | 1862.43 | 876.50 |
| 4235 | 72.16 | 511.71 | 134.64 | 389.70 | 70.88 |
| 20828 | 73.01 | 502.25 | 271.18 | 284.53 | 92.49 |
| 7197 | 69.38 | 282.33 | 150.96 | 170.15 | 54.40 |
| 15191 | 68.53 | 3290.47 | 1751.22 | 2180.50 | 805.93 |
| 14989 | 68.14 | 631.44 | 150.80 | 512.71 | 97.02 |
| 15642 | 71.14 | 552.69 | 175.75 | 408.68 | 83.66 |
| 24264 | 69.25 | 26.11 | 22.43 | 43.28 | 18.56 |
| 17196 | 72.16 | 105.36 | 26.39 | 132.08 | 22.43 |
| 15039 | 73.41 | 191.98 | 102.72 | 287.95 | 78.11 |
| 409 | 68.88 | 803.46 | 193.90 | 969.12 | 164.62 |
| 13392 | 70.20 | 239.32 | 71.29 | 181.66 | 37.09 |
| 1462 | 73.80 | 698.28 | 424.37 | 379.74 | 81.29 |
| 21653 | 72.94 | 312.54 | 114.31 | 222.64 | 40.98 |
| 1712 | 68.62 | 209.69 | 68.61 | 160.39 | 35.88 |
| 4451 | 67.65 | 238.86 | 88.60 | 300.33 | 63.65 |
| 16726 | 67.70 | 870.29 | 304.51 | 1099.44 | 185.70 |
| 17807 | 70.62 | 1025.46 | 284.12 | 795.89 | 128.79 |
| 17357 | 74.57 | 177.83 | 108.45 | 287.60 | 80.31 |
| 23651 | 79.97 | 1637.54 | 1189.42 | 542.91 | 191.30 |
| 6055 | 67.75 | 852.91 | 291.95 | 1087.75 | 221.20 |
| 17104 | 68.26 | 595.24 | 185.16 | 458.24 | 73.96 |
| 19040 | 77.34 | 341.45 | 225.23 | 150.68 | 34.34 |
| 20816 | 68.80 | 595.84 | 369.92 | 370.47 | 83.63 |
| 15111 | 74.61 | 829.53 | 273.33 | 1166.38 | 236.68 |
| 23872 | 71.41 | 128.39 | 182.32 | 24.92 | 23.80 |
| 16684 | 70.36 | 709.36 | 236.74 | 508.89 | 112.43 |
| 18301 | 68.57 | 62.34 | 33.80 | 100.81 | 42.71 |
| 18302 | 71.39 | 60.93 | 77.95 | 124.38 | 68.01 |
| 20780 | 68.40 | 441.75 | 191.55 | 567.49 | 192.61 |
| 19 | 69.63 | 426.88 | 118.63 | 336.43 | 62.64 |
| 12349 | 74.05 | 196.48 | 54.09 | 244.57 | 51.80 |
| 275 | 70.45 | 453.71 | 254.44 | 576.80 | 132.19 |
| 20481 | 71.33 | 164.23 | 44.85 | 208.90 | 36.60 |
| 20829 | 70.25 | 1242.42 | 483.51 | 851.32 | 199.41 |
| 20830 | 74.35 | 763.47 | 278.51 | 513.07 | 135.94 |
| 1581 | 70.90 | 84.40 | 27.90 | 62.31 | 13.19 |
| 21443 | 72.53 | 141.51 | 81.92 | 79.90 | 27.47 |
| 1478 | 70.03 | 270.27 | 105.77 | 371.66 | 79.44 |
| 20753 | 69.46 | 146.99 | 39.00 | 114.61 | 22.23 |
| 21654 | 80.33 | 549.42 | 209.67 | 339.69 | 55.84 |
| 20865 | 70.38 | 235.52 | 58.52 | 291.31 | 53.15 |
| 405 | 71.41 | 163.66 | 53.25 | 214.37 | 52.03 |
| 1463 | 70.30 | 1010.91 | 562.23 | 597.63 | 147.52 |
| 6641 | 76.29 | 306.07 | 88.62 | 420.70 | 68.82 |
| 20849 | 70.93 | 372.72 | 145.97 | 262.85 | 56.36 |
| 16204 | 67.81 | 1040.09 | 276.03 | 829.95 | 117.99 |
| 17401 | 74.89 | 1485.70 | 694.85 | 908.51 | 210.90 |
| 21239 | 76.72 | 181.72 | 94.61 | 89.35 | 26.32 |
| 1885 | 70.24 | 271.09 | 74.77 | 352.55 | 81.06 |
| 16775 | 70.92 | 829.81 | 416.75 | 1259.06 | 355.54 |
| 1993 | 69.60 | 43.10 | 30.86 | 20.51 | 10.49 |
| 11849 | 69.60 | 948.18 | 279.84 | 737.49 | 123.97 |
| 755 | 68.38 | 34.87 | 29.79 | 64.08 | 34.39 |
| 4198 | 69.32 | 622.34 | 199.77 | 799.21 | 160.47 |
| 4199 | 70.34 | 447.79 | 168.99 | 592.87 | 144.27 |
| 16147 | 71.31 | 133.27 | 41.17 | 174.38 | 34.99 |
| 1141 | 71.70 | 310.45 | 97.82 | 226.16 | 48.17 |
| 15300 | 76.22 | 266.45 | 233.70 | 96.88 | 38.59 |
| 21147 | 75.23 | 286.27 | 82.62 | 378.80 | 67.04 |
| 15986 | 74.10 | 229.66 | 101.29 | 339.59 | 70.49 |
| 1422 | 74.28 | 203.51 | 89.60 | 319.04 | 84.84 |
| 15032 | 82.28 | 177.33 | 70.87 | 283.54 | 59.41 |
| 17393 | 70.75 | 204.12 | 109.17 | 121.38 | 33.64 |
| 17394 | 67.82 | 452.07 | 169.87 | 324.74 | 84.03 |
| 22321 | 77.79 | 179.86 | 123.24 | 75.47 | 26.58 |
| 4589 | 68.43 | 1175.41 | 346.46 | 1472.99 | 302.81 |
| 4327 | 71.73 | 124.90 | 64.17 | 73.51 | 19.33 |
| 21683 | 77.71 | 55.09 | 33.27 | 21.13 | 9.74 |
| 16520 | 70.54 | 132.86 | 84.97 | 72.66 | 44.25 |
| 18070 | 68.56 | 29.37 | 22.00 | 48.21 | 19.39 |
| 7489 | 78.41 | 39.97 | 22.84 | 80.91 | 28.10 |
| 1081 | 71.67 | 413.82 | 133.92 | 554.09 | 106.66 |
| 1510 | 72.14 | 644.69 | 250.30 | 882.92 | 187.47 |
| 7784 | 72.19 | 562.83 | 162.41 | 718.79 | 107.93 |
| 16476 | 69.47 | 661.97 | 207.06 | 807.34 | 148.25 |
| 23961 | 70.55 | 666.12 | 193.40 | 805.83 | 112.84 |
| 1529 | 78.52 | 215.94 | 69.39 | 311.30 | 57.34 |
| 10464 | 72.10 | 93.88 | 31.76 | 126.65 | 27.53 |
| 16982 | 82.32 | 483.69 | 552.30 | 49.88 | 32.90 |
| 18001 | 68.00 | 322.92 | 154.38 | 447.93 | 164.83 |
| 4178 | 69.85 | 527.87 | 134.53 | 640.23 | 119.95 |
| 19067 | 70.28 | 126.08 | 48.73 | 169.73 | 43.06 |
| 14138 | 68.34 | 60.32 | 26.71 | 75.29 | 17.84 |
| 14184 | 69.13 | 138.85 | 74.22 | 90.86 | 35.51 |
| 14185 | 72.71 | 286.60 | 150.72 | 168.45 | 57.75 |
| 23166 | 78.56 | 206.85 | 101.43 | 108.11 | 29.94 |
| 13974 | 67.81 | 486.20 | 343.78 | 277.98 | 70.48 |
| 4462 | 70.66 | 730.63 | 304.66 | 995.43 | 245.77 |
| 18741 | 68.46 | 22.46 | 9.47 | 31.42 | 12.25 |
| 16312 | 78.77 | 101.86 | 64.40 | 38.36 | 14.62 |
| 7936 | 75.61 | 108.44 | 31.04 | 144.70 | 27.85 |
| 15618 | 74.29 | 115.86 | 40.32 | 80.50 | 17.75 |
| 4360 | 71.67 | 269.80 | 91.90 | 345.45 | 58.55 |
| 24235 | 70.28 | 713.05 | 392.66 | 431.13 | 115.32 |
| 17420 | 70.15 | 61.25 | 32.18 | 94.13 | 32.93 |
| 17256 | 71.81 | 324.85 | 154.43 | 449.98 | 98.33 |
| 18269 | 70.99 | 637.39 | 170.20 | 810.10 | 163.94 |
| 9905 | 75.17 | 584.58 | 181.18 | 780.68 | 116.13 |
| 4463 | 74.77 | 101.60 | 62.28 | 161.67 | 53.31 |
| 17438 | 70.47 | 26.74 | 45.54 | 57.63 | 34.17 |
| 1159 | 70.78 | 806.92 | 265.61 | 1032.09 | 192.03 |
| 4473 | 71.43 | 131.05 | 57.90 | 181.27 | 41.72 |
| 23047 | 67.77 | 56.55 | 20.02 | 70.52 | 16.28 |
| 19469 | 68.42 | 301.34 | 113.03 | 382.87 | 90.35 |
| 18190 | 68.25 | 182.25 | 61.26 | 229.51 | 48.59 |
| 17161 | 76.03 | 1821.71 | 615.92 | 1215.71 | 234.86 |
| 19768 | 70.65 | 963.11 | 248.77 | 752.70 | 130.89 |
| 17682 | 77.92 | 543.63 | 230.34 | 801.63 | 133.44 |
| 23194 | 69.65 | 62.70 | 24.82 | 41.17 | 22.22 |
| 13609 | 74.00 | 176.81 | 58.87 | 251.92 | 56.78 |
| 13610 | 76.70 | 274.96 | 90.97 | 381.83 | 61.63 |
| 8599 | 70.30 | 289.71 | 121.75 | 408.81 | 103.34 |
| 12276 | 69.15 | 146.83 | 72.19 | 197.32 | 55.12 |
| 18906 | 74.86 | 170.78 | 84.29 | 280.26 | 81.30 |
| 19085 | 70.14 | 94.40 | 39.41 | 61.51 | 14.57 |
| 19086 | 69.77 | 146.30 | 67.62 | 91.90 | 25.41 |
| 23783 | 68.29 | 395.54 | 88.23 | 467.98 | 73.38 |
| 22537 | 69.21 | 218.54 | 146.77 | 320.54 | 127.57 |
| 22538 | 67.97 | 268.39 | 96.52 | 356.51 | 83.52 |
| 22539 | 69.48 | 36.74 | 37.02 | 67.51 | 37.70 |
| 4529 | 69.23 | 67.85 | 27.85 | 90.38 | 24.21 |
| 23321 | 67.96 | 543.48 | 158.95 | 669.18 | 121.28 |
| 9053 | 76.00 | 188.41 | 54.90 | 248.83 | 39.54 |
| 13332 | 71.48 | 348.32 | 115.94 | 459.97 | 88.50 |
| 21305 | 70.70 | 335.54 | 107.08 | 461.13 | 122.43 |
| 17447 | 69.72 | 757.11 | 315.00 | 1014.03 | 248.79 |
| 17744 | 67.69 | 46.15 | 26.53 | 64.03 | 23.43 |
| 3878 | 70.74 | 403.23 | 111.47 | 513.41 | 109.35 |
| 16168 | 77.12 | 630.28 | 458.34 | 308.50 | 64.72 |
| 9082 | 68.21 | 53.73 | 28.47 | 38.09 | 10.56 |
| 3465 | 69.60 | 210.03 | 70.49 | 271.47 | 62.45 |
| 12031 | 67.78 | 168.78 | 59.30 | 130.32 | 25.69 |
| 18396 | 67.63 | 90.02 | 44.80 | 61.70 | 16.44 |
| 15302 | 68.05 | 20.31 | 8.69 | 27.82 | 10.24 |
| 23063 | 69.28 | 328.27 | 83.61 | 404.56 | 68.57 |
| 18361 | 67.66 | 621.87 | 267.20 | 448.88 | 121.61 |
| 14309 | 68.46 | 112.88 | 71.13 | 191.14 | 83.99 |
| 17494 | 68.74 | 185.71 | 45.49 | 223.03 | 37.75 |
| 18360 | 74.08 | 154.48 | 47.05 | 214.39 | 51.15 |
| 23202 | 72.92 | 121.82 | 37.42 | 164.36 | 35.74 |
| 23203 | 73.16 | 136.45 | 40.61 | 175.94 | 38.17 |
| 17325 | 76.58 | 189.74 | 208.06 | 31.06 | 24.22 |
| 13930 | 69.50 | 214.91 | 153.33 | 106.24 | 42.57 |
| 7543 | 70.50 | 178.55 | 78.57 | 269.04 | 91.31 |
| 22820 | 70.89 | 288.12 | 111.45 | 200.74 | 47.58 |
| 21125 | 71.35 | 116.79 | 56.18 | 159.82 | 40.70 |
| 17339 | 71.93 | 1792.99 | 669.14 | 2389.41 | 537.66 |
| 6635 | 70.12 | 193.74 | 78.12 | 263.66 | 72.24 |
| 21462 | 72.14 | 306.54 | 72.05 | 242.55 | 45.95 |
| 13349 | 72.86 | 172.75 | 55.73 | 123.93 | 27.78 |
| 24762 | 70.27 | 718.38 | 276.15 | 983.32 | 297.96 |
| 4661 | 70.12 | 388.81 | 126.78 | 288.37 | 54.81 |
| 9114 | 70.18 | 693.86 | 204.93 | 879.83 | 192.79 |
| 3822 | 73.37 | 1222.47 | 463.13 | 866.86 | 181.13 |
| 6039 | 71.15 | 398.06 | 140.85 | 292.56 | 43.87 |
| 21318 | 71.20 | 71.29 | 31.21 | 42.85 | 22.49 |
| 22681 | 78.67 | 469.72 | 361.56 | 167.25 | 55.58 |
| 6711 | 70.23 | 67.65 | 24.44 | 47.11 | 22.07 |
| 11974 | 70.51 | 172.05 | 92.75 | 244.79 | 74.37 |
| 22554 | 73.07 | 415.02 | 141.56 | 556.65 | 106.86 |
| 22612 | 75.13 | 343.73 | 116.51 | 484.30 | 98.81 |
| 22656 | 71.02 | 175.60 | 69.45 | 113.00 | 41.69 |
| 5565 | 70.16 | 296.76 | 131.21 | 413.36 | 102.23 |
| 18337 | 73.92 | 1205.41 | 398.90 | 1647.91 | 276.54 |
| 12331 | 71.08 | 472.78 | 167.06 | 617.17 | 120.69 |
| 12332 | 73.05 | 411.16 | 193.59 | 580.89 | 134.53 |
| 17499 | 70.54 | 50.18 | 30.54 | 22.00 | 22.13 |
| 3959 | 73.37 | 453.59 | 139.95 | 330.92 | 74.22 |
| 17477 | 72.97 | 152.23 | 61.42 | 103.95 | 20.62 |
| 4933 | 70.18 | 388.41 | 424.08 | 93.57 | 104.19 |
| 4944 | 74.65 | 188.84 | 90.79 | 105.86 | 33.59 |
| 23195 | 72.30 | 232.92 | 106.75 | 322.66 | 70.57 |
| 21458 | 72.29 | 333.72 | 163.53 | 208.78 | 68.34 |
| 14790 | 70.53 | 109.41 | 74.62 | 185.30 | 76.26 |
| 23261 | 74.33 | 1167.64 | 374.52 | 1601.58 | 272.59 |
| 18271 | 71.71 | 622.18 | 201.29 | 765.39 | 134.28 |
| 23978 | 73.34 | 86.93 | 32.19 | 116.83 | 26.50 |
| 13411 | 73.35 | 525.65 | 243.99 | 878.97 | 298.41 |
| 5295 | 70.27 | 300.37 | 122.64 | 200.38 | 56.99 |
| 22928 | 70.99 | 162.55 | 62.71 | 235.92 | 78.67 |
| 9452 | 70.35 | 245.76 | 292.62 | 114.97 | 32.36 |
| 23512 | 70.99 | 828.99 | 249.33 | 1077.38 | 203.72 |
| 22596 | 71.68 | 80.40 | 26.07 | 58.43 | 14.91 |
| 498 | 71.09 | 683.30 | 214.01 | 507.78 | 92.93 |
| 5990 | 70.86 | 366.35 | 68.11 | 308.36 | 51.82 |
| 23957 | 72.26 | 111.14 | 62.08 | 56.84 | 26.48 |
| 2702 | 71.60 | 366.96 | 146.76 | 258.70 | 49.00 |
| 2195 | 73.27 | 58.13 | 36.42 | 94.82 | 34.86 |
| 12561 | 73.13 | 102.28 | 52.57 | 159.13 | 45.42 |
| 2905 | 75.28 | 347.69 | 151.38 | 208.05 | 61.26 |
| 20694 | 73.26 | 743.85 | 251.48 | 959.05 | 180.74 |
| 3079 | 70.80 | 63.05 | 43.41 | 28.63 | 23.27 |
| 20035 | 73.52 | 306.77 | 177.36 | 157.60 | 53.17 |
| 6804 | 74.11 | 789.99 | 408.84 | 1302.23 | 346.25 |
| 3121 | 74.54 | 959.69 | 406.12 | 1369.21 | 250.58 |
| 22599 | 70.26 | 66.34 | 31.77 | 41.25 | 18.37 |
| 410 | 71.29 | 870.97 | 244.82 | 1083.44 | 197.61 |
| 21632 | 73.03 | 81.28 | 68.17 | 22.00 | 38.30 |
| 6382 | 71.38 | 168.36 | 54.67 | 117.22 | 30.59 |
| 15089 | 74.51 | 251.33 | 99.68 | 160.38 | 49.68 |
| 21105 | 70.12 | 249.54 | 66.26 | 312.18 | 54.81 |
| 12716 | 72.49 | 131.67 | 35.67 | 169.49 | 38.21 |
| 2912 | 72.39 | 1931.74 | 615.06 | 2564.08 | 522.30 |
| 6916 | 70.52 | 317.82 | 111.03 | 408.61 | 85.19 |
| 6927 | 70.39 | 264.79 | 87.91 | 348.90 | 78.76 |
| 17524 | 72.11 | 874.88 | 306.13 | 1156.44 | 234.27 |
| 3941 | 73.09 | 308.74 | 77.68 | 230.07 | 48.84 |
| 17550 | 72.46 | 986.16 | 374.79 | 1326.29 | 307.30 |
| 3995 | 75.44 | 463.57 | 147.80 | 633.82 | 110.34 |
| 6518 | 70.44 | 144.08 | 37.09 | 112.71 | 24.88 |
| 21796 | 70.33 | 888.40 | 360.47 | 657.75 | 113.15 |
| 23946 | 72.63 | 163.74 | 60.23 | 222.35 | 52.10 |
| 13633 | 71.57 | 490.86 | 292.91 | 281.77 | 78.22 |
| 2250 | 70.10 | 1118.06 | 305.47 | 1406.39 | 242.10 |
| 24200 | 75.63 | 597.89 | 203.15 | 387.86 | 82.10 |
| 7127 | 72.10 | 189.63 | 95.07 | 284.50 | 81.78 |
| 2242 | 78.44 | 1562.27 | 687.27 | 2311.30 | 401.81 |
| 20086 | 70.93 | 176.26 | 100.98 | 94.57 | 56.93 |
| 22592 | 74.45 | 441.33 | 302.53 | 185.74 | 92.86 |
| 15928 | 77.50 | 230.62 | 81.86 | 144.79 | 33.22 |
| 21391 | 75.21 | 385.81 | 231.51 | 186.38 | 64.93 |
| 7299 | 74.79 | 340.48 | 256.92 | 144.54 | 52.30 |
| 12812 | 71.13 | 71.16 | 36.21 | 103.45 | 31.82 |
| 3874 | 77.99 | 655.53 | 183.38 | 905.21 | 155.11 |
| 7537 | 71.69 | 182.30 | 58.80 | 237.28 | 52.88 |
| 2370 | 71.01 | 915.70 | 221.20 | 1099.41 | 156.58 |
| 7903 | 70.99 | 350.55 | 194.24 | 521.87 | 172.15 |
| 10818 | 74.69 | 290.08 | 197.30 | 507.06 | 156.48 |
| 2348 | 72.14 | 327.63 | 189.49 | 501.70 | 190.96 |
| 5329 | 70.75 | 33.31 | 19.25 | 51.50 | 17.82 |
| 5461 | 80.13 | 363.25 | 214.86 | 167.06 | 45.38 |
| 19235 | 70.79 | 763.49 | 289.13 | 1038.84 | 281.39 |
| 5711 | 72.45 | 273.46 | 99.05 | 392.06 | 106.55 |
| 5474 | 72.45 | 535.29 | 201.95 | 756.74 | 194.06 |
| 5855 | 72.52 | 48.55 | 32.00 | 74.58 | 25.26 |
| 7540 | 73.88 | 252.91 | 154.86 | 138.96 | 33.26 |
| 8143 | 74.69 | 104.77 | 84.14 | 29.09 | 30.03 |
| 4789 | 72.94 | 59.69 | 25.79 | 36.25 | 16.93 |
| 8188 | 72.32 | 307.46 | 113.44 | 412.60 | 118.99 |
| 8721 | 76.93 | 122.24 | 61.91 | 198.85 | 58.96 |
| 9067 | 70.10 | 803.78 | 204.39 | 624.95 | 138.76 |
| 14424 | 74.93 | 239.44 | 296.66 | 40.59 | 37.53 |
| 19031 | 73.02 | 115.05 | 95.44 | 48.91 | 21.83 |
| 18792 | 71.15 | 105.56 | 35.07 | 140.76 | 34.60 |
| 9583 | 83.08 | 136.55 | 110.28 | 37.67 | 13.20 |
| 22929 | 76.66 | 487.92 | 270.63 | 875.04 | 272.83 |
| 22930 | 71.79 | 198.01 | 107.43 | 333.60 | 130.90 |
| 9673 | 72.89 | 41.63 | 23.96 | 67.92 | 25.83 |
| 9699 | 71.31 | 40.80 | 21.59 | 56.86 | 17.18 |
| 9781 | 70.77 | 92.59 | 36.11 | 127.64 | 32.76 |
| 20003 | 71.55 | 27.27 | 18.64 | 51.09 | 22.28 |
| 21885 | 70.82 | 142.81 | 40.76 | 189.08 | 42.70 |
| 9468 | 70.74 | 42.87 | 35.25 | 68.53 | 31.39 |
| 4479 | 73.91 | 235.81 | 118.85 | 131.97 | 56.66 |
| 9017 | 72.38 | 76.73 | 33.17 | 116.29 | 36.85 |
| 3713 | 71.70 | 870.09 | 222.47 | 1118.08 | 183.65 |
| 12921 | 74.78 | 160.55 | 75.66 | 89.61 | 28.74 |
| 13111 | 70.79 | 174.86 | 60.32 | 227.47 | 55.78 |
| 6638 | 75.69 | 69.36 | 25.20 | 99.44 | 21.50 |
| 14458 | 75.02 | 66.07 | 38.46 | 29.15 | 17.52 |
| 3610 | 77.34 | 786.52 | 383.16 | 1195.76 | 266.77 |
| 8339 | 73.49 | 292.74 | 124.63 | 423.11 | 88.77 |
| 5923 | 70.80 | 483.78 | 173.48 | 620.25 | 121.74 |
| 6796 | 71.31 | 237.51 | 61.53 | 182.40 | 44.67 |
| 22885 | 73.32 | 1845.03 | 706.08 | 1184.43 | 338.85 |
| 7128 | 73.03 | 239.14 | 69.19 | 314.35 | 55.04 |
| 22101 | 73.01 | 95.07 | 89.98 | 187.48 | 72.69 |
| 24237 | 74.97 | 89.34 | 56.62 | 42.92 | 17.41 |
| 11618 | 78.26 | 253.39 | 122.31 | 409.80 | 86.37 |
| 12979 | 80.37 | 643.96 | 322.54 | 306.53 | 85.14 |
| 6321 | 71.43 | 574.05 | 185.59 | 430.15 | 101.43 |
| 23538 | 74.66 | 187.01 | 128.86 | 88.48 | 33.57 |
| 16756 | 76.04 | 221.62 | 72.76 | 160.63 | 27.83 |
| 12798 | 71.21 | 127.92 | 41.67 | 161.96 | 30.85 |
| 5199 | 71.59 | 426.68 | 194.60 | 588.24 | 150.06 |
| 7700 | 70.23 | 122.86 | 82.18 | 72.08 | 16.69 |
| 13343 | 73.07 | 157.21 | 46.99 | 208.91 | 43.13 |
| 17771 | 72.79 | 987.24 | 409.54 | 656.09 | 156.81 |
| 3916 | 72.16 | 521.25 | 191.64 | 693.18 | 117.69 |
| 14929 | 76.37 | 1275.17 | 801.09 | 653.70 | 132.62 |
| 10130 | 71.36 | 174.06 | 65.67 | 230.52 | 47.39 |
| 22626 | 72.89 | 183.92 | 157.82 | 66.65 | 23.30 |
| 4291 | 77.82 | 182.86 | 89.68 | 304.13 | 72.33 |
| 4330 | 74.56 | 347.34 | 137.46 | 482.98 | 108.28 |
| 19723 | 76.28 | 128.30 | 90.41 | 60.09 | 19.40 |
| 10087 | 71.09 | 1154.32 | 346.71 | 1463.96 | 251.64 |
| 11708 | 70.94 | 386.80 | 118.03 | 291.40 | 61.62 |
| 22747 | 70.84 | 74.15 | 30.31 | 98.19 | 26.54 |
| 21024 | 70.13 | 455.62 | 93.78 | 553.76 | 96.13 |
| 15382 | 77.33 | 389.13 | 422.35 | 77.25 | 48.54 |
| 7690 | 70.79 | 257.59 | 97.89 | 171.85 | 74.75 |
| 4952 | 73.35 | 155.59 | 74.76 | 95.46 | 25.89 |
| 15663 | 73.12 | 250.33 | 89.70 | 172.23 | 33.35 |
| 10985 | 74.58 | 800.41 | 240.23 | 1100.95 | 203.66 |
| 24236 | 70.36 | 98.11 | 31.97 | 73.04 | 15.29 |
| 23299 | 74.52 | 468.81 | 165.84 | 330.31 | 69.58 |
| 15146 | 70.08 | 203.62 | 143.51 | 112.76 | 37.18 |
| 5863 | 74.20 | 106.06 | 33.34 | 146.26 | 29.69 |
| 15964 | 81.61 | 743.87 | 299.36 | 1181.36 | 213.16 |
| 14425 | 79.32 | 289.30 | 105.74 | 184.96 | 40.75 |
| 14484 | 72.73 | 334.28 | 89.84 | 437.97 | 96.59 |
| 19184 | 80.30 | 184.51 | 138.40 | 57.13 | 21.22 |
| 6059 | 72.36 | 154.20 | 39.08 | 195.04 | 41.70 |
| 22197 | 75.26 | 157.37 | 70.51 | 101.32 | 27.04 |
| 8477 | 71.07 | 659.05 | 204.66 | 463.62 | 103.03 |
| 13611 | 74.84 | 171.03 | 92.33 | 268.13 | 69.59 |
| 13634 | 72.92 | 1089.91 | 505.62 | 708.27 | 127.16 |
| 15042 | 71.38 | 113.78 | 77.47 | 57.28 | 27.29 |
| 3049 | 71.78 | 291.79 | 154.63 | 166.94 | 53.28 |
| 22569 | 78.32 | 433.31 | 165.33 | 660.29 | 135.05 |
| 5481 | 71.53 | 91.61 | 65.17 | 28.15 | 47.24 |
| 6765 | 70.92 | 585.04 | 187.80 | 763.40 | 148.50 |
| 6487 | 73.18 | 87.46 | 24.67 | 113.17 | 25.19 |
| 15879 | 73.89 | 284.57 | 70.17 | 362.84 | 59.91 |
| 13727 | 73.69 | 67.87 | 42.12 | 119.18 | 37.60 |
| 13176 | 70.47 | 46.42 | 20.28 | 65.32 | 19.51 |
| 22328 | 70.21 | 317.09 | 111.22 | 404.07 | 93.92 |
| 12587 | 70.38 | 172.84 | 49.41 | 225.04 | 48.37 |
| 12961 | 73.90 | 137.35 | 37.57 | 177.07 | 32.16 |
| 18529 | 72.64 | 279.81 | 134.55 | 172.94 | 39.31 |
| 13618 | 72.50 | 131.45 | 42.44 | 95.50 | 21.06 |

TABLE 5A
CHLOROFORM

Atty. Docket No. GENE-077/26US
Doc. No. 44941

| | | | Tox | | |
|---|---|---|---|---|---|
| GLGC | LDA | Tox Group | Group | Non-Tox Group | Non-Tox |
| Identifier | Score | Mean | SD | Mean | Group SD |
| 17824 | 85.62 | 205.14 | 27.09 | 142.57 | 42.17 |
| 10378 | 84.82 | 69.21 | 33.23 | 143.74 | 101.86 |
| 1653 | 85.35 | 686.13 | 93.92 | 993.47 | 242.55 |
| 3875 | 88.29 | 252.35 | 75.16 | 478.18 | 126.13 |
| 15836 | 86.00 | 121.07 | 16.96 | 214.57 | 101.58 |
| 3091 | 95.09 | 421.64 | 58.81 | 713.53 | 158.43 |
| 22855 | 85.05 | 373.13 | 49.91 | 519.30 | 117.46 |
| 17361 | 90.70 | 50.93 | 20.08 | 137.86 | 55.93 |
| 21025 | 92.15 | 233.83 | 71.17 | 418.06 | 106.83 |
| 23115 | 86.26 | 278.57 | 65.22 | 503.85 | 159.60 |
| 6343 | 82.92 | 46.79 | 4.81 | 34.28 | 11.62 |
| 11953 | 88.88 | 1079.47 | 146.45 | 1693.94 | 588.62 |
| 18509 | 83.95 | 311.54 | 43.78 | 430.03 | 88.77 |
| 20832 | 83.65 | 534.47 | 85.79 | 785.26 | 199.66 |
| 20833 | 82.32 | 1010.33 | 178.76 | 1449.79 | 326.39 |
| 21060 | 84.30 | 133.69 | 25.56 | 83.14 | 27.48 |
| 21061 | 83.52 | 86.99 | 17.50 | 50.51 | 22.34 |
| 15701 | 83.20 | 63.42 | 22.84 | 30.93 | 12.46 |
| 1143 | 82.38 | 131.83 | 21.57 | 92.25 | 32.27 |
| 16468 | 84.29 | 831.97 | 118.43 | 1136.11 | 219.87 |
| 17541 | 84.35 | 1464.81 | 514.58 | 725.03 | 344.90 |
| 3015 | 82.18 | 2837.91 | 186.68 | 2819.00 | 1012.99 |
| 20896 | 83.09 | 106.66 | 65.89 | 141.12 | 40.19 |
| 1570 | 85.17 | 98.50 | 59.57 | 39.00 | 13.49 |
| 2632 | 82.26 | 190.41 | 17.08 | 153.91 | 30.61 |
| 25168 | 83.29 | 32.68 | 2.87 | 23.16 | 9.80 |
| 15800 | 83.74 | 56.84 | 10.37 | 34.45 | 19.58 |
| 11843 | 83.88 | 61.43 | 4.65 | 52.11 | 10.69 |
| 20741 | 84.26 | 236.26 | 31.17 | 175.32 | 43.96 |
| 8829 | 87.88 | 505.66 | 151.99 | 282.86 | 84.70 |
| 21977 | 87.24 | 38.53 | 11.16 | 77.01 | 45.15 |
| 1460 | 81.41 | 281.25 | 87.21 | 192.24 | 83.91 |
| 24234 | 84.86 | 408.25 | 208.57 | 188.66 | 107.50 |
| 25643 | 88.48 | 187.37 | 74.36 | 110.76 | 25.22 |
| 23282 | 87.61 | 425.15 | 71.15 | 283.98 | 52.36 |
| 13646 | 82.98 | 1169.38 | 295.87 | 817.10 | 184.73 |
| 25777 | 84.83 | 1173.74 | 710.54 | 439.45 | 241.72 |
| 24437 | 82.76 | 56.38 | 5.77 | 61.94 | 29.69 |
| 1929 | 81.33 | 536.97 | 208.01 | 870.13 | 215.86 |
| 6127 | 83.24 | 41.36 | 8.04 | 64.30 | 27.81 |
| 20000 | 84.67 | 93.69 | 19.60 | 127.60 | 71.39 |
| 25862 | 82.39 | 38.61 | 8.30 | 23.01 | 10.20 |
| 25921 | 81.56 | 47.30 | 10.74 | 28.36 | 16.07 |
| 19679 | 83.24 | 440.67 | 183.93 | 755.52 | 202.10 |
| 825 | 82.62 | 22.20 | 8.99 | 46.45 | 18.16 |
| 1409 | 85.68 | 298.20 | 49.00 | 438.84 | 99.15 |
| 17516 | 85.33 | 500.55 | 239.88 | 547.02 | 127.42 |
| 15072 | 81.24 | 42.04 | 6.55 | 31.15 | 15.09 |
| 1949 | 83.61 | 57.75 | 7.72 | 90.12 | 37.12 |
| 1581 | 84.77 | 87.66 | 15.15 | 66.76 | 21.00 |
| 20725 | 88.97 | 621.86 | 57.64 | 801.80 | 141.09 |
| 21562 | 85.05 | 265.87 | 68.99 | 468.38 | 147.67 |
| 6641 | 84.21 | 233.86 | 84.82 | 396.94 | 88.30 |
| 1877 | 82.89 | 444.75 | 101.68 | 652.86 | 170.37 |
| 15032 | 87.42 | 175.94 | 47.04 | 265.22 | 74.56 |
| 19110 | 83.92 | 84.32 | 32.08 | 204.53 | 96.17 |
| 1509 | 81.62 | 431.65 | 81.24 | 550.73 | 118.16 |
| 20708 | 82.38 | 80.85 | 9.57 | 61.19 | 17.28 |
| 2439 | 86.44 | 102.63 | 17.35 | 147.69 | 27.96 |
| 16948 | 82.71 | 145.85 | 69.01 | 317.13 | 132.79 |
| 4178 | 86.29 | 444.39 | 54.78 | 619.34 | 136.02 |
| 20582 | 84.74 | 347.72 | 63.49 | 487.44 | 95.49 |
| 23033 | 87.21 | 431.39 | 57.07 | 579.07 | 117.99 |
| 19377 | 85.21 | 155.74 | 30.08 | 109.47 | 24.61 |
| 19144 | 82.32 | 36.63 | 8.07 | 25.15 | 10.80 |
| 4462 | 93.09 | 414.41 | 198.64 | 953.78 | 313.55 |
| 7936 | 83.74 | 93.98 | 18.72 | 137.68 | 31.48 |
| 1644 | 82.23 | 418.83 | 62.93 | 560.68 | 126.32 |
| 9905 | 81.30 | 538.90 | 116.34 | 744.96 | 153.52 |
| 4463 | 88.62 | 43.16 | 34.48 | 150.98 | 58.66 |
| 4473 | 86.50 | 95.76 | 32.22 | 172.47 | 49.25 |
| 16469 | 88.06 | 991.10 | 103.75 | 1321.05 | 271.57 |
| 13610 | 92.33 | 226.14 | 59.71 | 365.06 | 107.29 |
| 22537 | 84.18 | 145.19 | 78.83 | 301.55 | 137.94 |
| 7505 | 81.98 | 274.29 | 43.54 | 384.55 | 118.76 |
| 22783 | 83.67 | 473.86 | 73.76 | 347.89 | 212.99 |
| 11653 | 87.24 | 306.58 | 112.65 | 560.40 | 195.77 |
| 12129 | 84.85 | 245.65 | 111.61 | 646.79 | 334.57 |
| 3925 | 86.50 | 275.69 | 80.34 | 461.73 | 112.55 |
| 22490 | 86.42 | 811.57 | 139.35 | 602.93 | 96.00 |
| 4933 | 84.98 | 743.88 | 516.81 | 142.53 | 232.49 |
| 23718 | 84.42 | 65.41 | 10.03 | 97.59 | 40.96 |
| 2912 | 90.89 | 1436.37 | 179.76 | 2437.60 | 603.29 |
| 17524 | 86.71 | 799.10 | 105.47 | 1115.60 | 282.08 |
| 23509 | 89.88 | 1570.55 | 137.71 | 2086.99 | 379.49 |
| 14267 | 86.42 | 1171.51 | 258.92 | 1706.75 | 393.91 |
| 9116 | 86.14 | 269.31 | 52.99 | 392.85 | 75.60 |
| 3961 | 91.61 | 74.40 | 10.55 | 49.45 | 14.81 |
| 7216 | 86.71 | 123.29 | 34.23 | 234.44 | 71.10 |
| 7299 | 85.42 | 334.53 | 109.96 | 181.79 | 143.50 |
| 7634 | 84.86 | 538.91 | 181.95 | 645.21 | 126.88 |
| 14856 | 86.45 | 330.60 | 53.33 | 438.34 | 100.70 |
| 8721 | 85.83 | 73.87 | 43.04 | 183.86 | 66.21 |
| 26183 | 84.58 | 64.68 | 11.03 | 47.22 | 22.02 |
| 8927 | 86.42 | 508.53 | 79.40 | 689.86 | 154.77 |
| 8946 | 86.39 | 112.12 | 21.59 | 186.07 | 74.49 |
| 9191 | 87.55 | 277.28 | 132.99 | 657.06 | 277.10 |
| 9176 | 86.73 | 288.61 | 15.81 | 245.52 | 51.27 |
| 18522 | 87.29 | 490.66 | 94.81 | 759.01 | 194.27 |
| 2059 | 87.30 | 219.06 | 65.06 | 136.38 | 34.61 |
| 5369 | 85.88 | 274.28 | 47.68 | 200.95 | 43.34 |
| 1650 | 87.97 | 569.84 | 94.38 | 790.48 | 182.69 |
| 13028 | 89.85 | 137.00 | 17.66 | 89.57 | 32.90 |
| 7622 | 85.09 | 88.74 | 20.90 | 56.95 | 16.90 |
| 16756 | 84.59 | 361.18 | 150.11 | 171.51 | 41.28 |
| 10130 | 84.36 | 117.70 | 66.31 | 221.33 | 55.16 |
| 3803 | 85.73 | 975.63 | 205.56 | 722.11 | 154.02 |
| 22985 | 84.55 | 83.55 | 9.87 | 108.90 | 29.86 |
| 13285 | 85.94 | 110.31 | 17.04 | 71.38 | 16.98 |
| 11761 | 86.64 | 49.48 | 6.15 | 68.95 | 26.33 |
| 16958 | 86.15 | 61.46 | 19.84 | 30.96 | 13.91 |
| 21088 | 87.30 | 56.92 | 8.06 | 40.35 | 14.32 |
| 15964 | 84.88 | 583.51 | 205.70 | 1089.69 | 286.46 |
| 22648 | 92.73 | 313.31 | 70.15 | 490.37 | 101.26 |
| 19822 | 86.82 | 994.53 | 147.26 | 1418.54 | 381.93 |
| 1651 | 85.17 | 577.75 | 69.32 | 788.50 | 180.99 |
| 13727 | 87.53 | 35.36 | 28.82 | 109.18 | 42.58 |
| 13740 | 84.64 | 257.51 | 18.03 | 221.70 | 39.96 |
| 1652 | 88.73 | 476.16 | 64.04 | 656.76 | 161.47 |

TABLE 5B
DICLOFENAC

Atty. Docket No. GENE-077/26US
Doc. No. 44941

| | | Tox | | | Non-Tox |
|---|---|---|---|---|---|
| GLGC | LDA | Group | Tox Group | Non-Tox Group | Group |
| Identifier | Score | Mean | SD | Mean | SD |
| 13966 | 89.97 | 227.19 | 38.65 | 159.84 | 32.03 |
| 6278 | 91.08 | 58.48 | 10.10 | 94.99 | 25.06 |
| 6046 | 92.65 | 83.37 | 33.70 | 193.87 | 62.20 |
| 8850 | 89.82 | 175.34 | 58.83 | 99.07 | 34.66 |
| 7937 | 91.71 | 34.46 | 21.21 | 176.64 | 93.91 |
| 8759 | 88.36 | 237.31 | 41.30 | 156.57 | 41.79 |
| 6917 | 88.81 | 111.53 | 14.34 | 176.04 | 69.10 |
| 1698 | 90.48 | 190.91 | 66.62 | 70.39 | 93.92 |
| 6782 | 85.13 | 310.65 | 67.44 | 219.45 | 62.29 |
| 21012 | 92.66 | 445.05 | 162.22 | 203.66 | 116.06 |
| 20864 | 87.40 | 3112.64 | 637.13 | 1921.03 | 633.85 |
| 11434 | 86.18 | 181.39 | 56.52 | 324.42 | 119.03 |
| 15124 | 85.11 | 1897.22 | 536.70 | 1048.98 | 283.10 |
| 21014 | 92.42 | 352.43 | 145.68 | 149.67 | 82.43 |
| 15189 | 90.00 | 4842.58 | 1706.56 | 2020.75 | 1168.41 |
| 11755 | 90.42 | 343.83 | 127.98 | 144.25 | 136.11 |
| 15125 | 91.33 | 3102.06 | 1017.25 | 1525.20 | 405.25 |
| 17541 | 91.84 | 1839.84 | 669.37 | 724.33 | 339.91 |
| 67 | 85.37 | 1551.30 | 178.56 | 1151.89 | 254.88 |
| 17805 | 96.58 | 1504.75 | 444.21 | 682.13 | 328.81 |
| 1858 | 88.43 | 253.42 | 73.25 | 153.78 | 50.88 |
| 14346 | 90.51 | 174.62 | 63.19 | 52.54 | 90.15 |
| 15017 | 92.48 | 2241.27 | 415.11 | 1149.81 | 399.55 |
| 23987 | 86.20 | 596.80 | 251.48 | 276.13 | 75.22 |
| 25106 | 87.02 | 28.05 | 3.19 | 38.61 | 13.12 |
| 20457 | 86.13 | 235.87 | 68.78 | 395.90 | 100.59 |
| 21145 | 86.79 | 76.23 | 47.54 | 200.42 | 66.53 |
| 15761 | 85.67 | 22.22 | 16.23 | 77.85 | 34.65 |
| 13485 | 85.51 | 38.32 | 7.99 | 57.48 | 16.43 |
| 18246 | 84.64 | 100.99 | 77.72 | 258.41 | 95.94 |
| 24566 | 87.61 | 32.95 | 21.32 | 180.03 | 89.43 |
| 7872 | 92.44 | 63.92 | 8.33 | 112.60 | 35.96 |
| 21977 | 94.77 | 30.72 | 6.14 | 76.98 | 45.11 |
| 14003 | 84.35 | 1575.92 | 414.94 | 932.50 | 241.80 |
| 9520 | 89.02 | 69.60 | 25.47 | 140.86 | 46.37 |
| 1888 | 84.83 | 101.45 | 32.01 | 52.26 | 33.35 |
| 24568 | 85.63 | 78.30 | 23.68 | 153.33 | 67.67 |
| 1527 | 88.63 | 51.23 | 9.78 | 88.23 | 39.31 |
| 20000 | 84.61 | 24.08 | 20.83 | 127.92 | 70.97 |
| 15379 | 85.72 | 33.32 | 11.21 | 67.90 | 28.41 |
| 14970 | 90.99 | 134.42 | 36.31 | 199.60 | 41.02 |
| 8888 | 88.78 | 22.26 | 7.29 | 48.79 | 20.58 |
| 1729 | 85.55 | 81.89 | 44.56 | 212.81 | 80.84 |
| 24893 | 86.30 | 20.58 | 18.68 | 85.55 | 52.17 |
| 4449 | 86.33 | 156.15 | 44.78 | 243.11 | 70.20 |
| 21975 | 89.03 | 357.73 | 79.92 | 212.58 | 62.99 |
| 20405 | 86.92 | 133.28 | 70.23 | 29.80 | 29.59 |
| 20831 | 89.50 | 55.62 | 17.29 | 138.12 | 57.86 |
| 20803 | 84.29 | 737.50 | 199.95 | 473.34 | 124.77 |
| 24232 | 85.94 | 48.69 | 39.24 | 151.29 | 60.27 |
| 1847 | 86.15 | 22.26 | 10.03 | 62.17 | 36.21 |
| 17401 | 90.15 | 1909.24 | 588.72 | 1010.74 | 422.89 |
| 725 | 94.04 | 33.60 | 10.05 | 110.06 | 46.60 |
| 16681 | 85.68 | 134.46 | 57.78 | 63.59 | 25.88 |
| 1340 | 89.87 | 124.95 | 20.55 | 184.83 | 85.84 |
| 20682 | 84.77 | 226.38 | 89.62 | 409.19 | 108.15 |
| 1422 | 87.45 | 174.39 | 46.71 | 300.07 | 105.44 |
| 22321 | 85.13 | 138.89 | 29.75 | 94.97 | 68.63 |
| 18597 | 84.32 | 987.07 | 317.42 | 563.12 | 200.20 |
| 15411 | 94.83 | 552.53 | 112.91 | 304.39 | 94.23 |
| 16520 | 87.97 | 174.46 | 63.58 | 88.91 | 110.98 |
| 954 | 84.94 | 54.36 | 5.77 | 71.54 | 20.36 |
| 15035 | 89.99 | 23.84 | 16.64 | 124.98 | 68.66 |
| 1894 | 84.89 | 294.35 | 70.10 | 198.20 | 72.90 |
| 21491 | 86.07 | 67.51 | 10.34 | 100.55 | 23.55 |
| 1529 | 84.43 | 194.31 | 45.08 | 294.86 | 70.18 |
| 16982 | 91.81 | 1036.49 | 606.21 | 130.48 | 296.12 |
| 19067 | 92.38 | 76.83 | 28.49 | 162.21 | 46.61 |
| 11481 | 84.61 | 20.44 | 15.73 | 65.86 | 29.15 |
| 7936 | 93.59 | 82.66 | 12.40 | 137.66 | 31.43 |
| 20523 | 89.18 | 1004.68 | 208.03 | 579.32 | 164.47 |
| 17088 | 87.37 | 98.27 | 17.79 | 58.55 | 31.41 |
| 14595 | 90.21 | 167.82 | 59.62 | 77.65 | 33.41 |
| 11991 | 89.35 | 20.14 | 10.16 | 46.26 | 16.40 |
| 13542 | 85.67 | 321.75 | 219.70 | 462.35 | 148.34 |
| 3439 | 86.94 | 135.79 | 26.09 | 92.94 | 24.52 |
| 3465 | 92.50 | 152.39 | 23.63 | 263.07 | 79.12 |
| 2128 | 86.56 | 97.35 | 47.36 | 32.61 | 16.44 |
| 4661 | 96.19 | 555.94 | 110.43 | 307.06 | 85.59 |
| 21354 | 89.39 | 640.85 | 156.38 | 418.77 | 127.04 |
| 26083 | 88.38 | 403.60 | 200.12 | 1199.39 | 721.99 |
| 21976 | 89.24 | 462.91 | 64.44 | 316.41 | 69.92 |
| 22479 | 88.52 | 693.29 | 140.68 | 417.80 | 129.01 |
| 3172 | 90.74 | 36.28 | 40.56 | 206.90 | 111.79 |
| 16521 | 89.73 | 453.74 | 109.04 | 284.15 | 76.30 |
| 15679 | 91.36 | 309.12 | 62.83 | 174.14 | 47.36 |
| 24200 | 97.01 | 885.64 | 139.99 | 426.56 | 138.77 |
| 6758 | 89.57 | 59.84 | 19.18 | 28.92 | 13.70 |
| 7299 | 97.61 | 595.57 | 144.70 | 180.65 | 140.60 |
| 665 | 91.27 | 849.30 | 217.79 | 538.96 | 94.94 |
| 5461 | 91.99 | 694.84 | 296.55 | 199.69 | 117.96 |
| 7540 | 97.91 | 504.78 | 145.39 | 158.51 | 83.92 |
| 8065 | 94.80 | 236.57 | 31.67 | 163.82 | 37.32 |
| 8104 | 90.62 | 85.37 | 9.09 | 60.70 | 24.71 |
| 8820 | 97.91 | 743.55 | 284.97 | 139.15 | 119.88 |
| 24197 | 95.31 | 82.06 | 26.90 | 235.59 | 79.78 |
| 10434 | 89.97 | 77.07 | 35.03 | 33.65 | 20.30 |
| 10446 | 90.14 | 22.58 | 15.15 | 127.88 | 91.52 |
| 9079 | 88.46 | 1099.28 | 237.43 | 736.13 | 163.45 |
| 8099 | 88.52 | 72.23 | 24.65 | 43.64 | 14.56 |
| 12925 | 88.48 | 44.20 | 4.65 | 69.36 | 29.98 |
| 12921 | 89.73 | 213.56 | 56.93 | 102.59 | 48.69 |
| 13013 | 89.59 | 32.49 | 10.44 | 65.57 | 21.46 |
| 6796 | 89.30 | 304.75 | 71.31 | 192.78 | 51.24 |
| 22885 | 89.51 | 2441.02 | 725.57 | 1292.56 | 483.73 |
| 5930 | 90.51 | 73.85 | 24.31 | 26.85 | 19.94 |
| 5920 | 97.46 | 1412.80 | 271.66 | 635.94 | 191.82 |
| 12979 | 89.39 | 742.50 | 248.93 | 366.97 | 196.56 |
| 6014 | 90.36 | 183.73 | 46.62 | 80.51 | 44.34 |
| 8234 | 92.38 | 22.24 | 6.70 | 47.07 | 15.98 |
| 16898 | 90.26 | 55.03 | 10.77 | 78.17 | 16.44 |
| 4330 | 93.19 | 242.18 | 59.53 | 461.51 | 139.37 |
| 22311 | 91.96 | 1255.02 | 184.06 | 688.00 | 158.37 |
| 15964 | 95.49 | 487.88 | 126.89 | 1089.29 | 286.36 |
| 13614 | 90.06 | 497.29 | 91.75 | 324.46 | 71.36 |
| 23151 | 90.62 | 204.97 | 55.56 | 355.14 | 101.19 |
| 14450 | 93.98 | 45.80 | 9.30 | 146.93 | 73.46 |

TABLE 5C
MENADIONE

Atty. Docket No. GENE-077/26US
Doc. No. 44941

| | | Tox | | | Non-Tox |
|---|---|---|---|---|---|
| GLGC | LDA | Group | Tox Group | Non-Tox Group | Group |
| Identifier | Score | Mean | SD | Mean | SD |
| 12343 | 95.55 | 89.32 | 12.94 | 50.29 | 16.25 |
| 6632 | 92.08 | 270.94 | 30.65 | 167.71 | 54.30 |
| 3091 | 92.52 | 531.24 | 38.99 | 712.74 | 159.66 |
| 10667 | 92.09 | 94.44 | 15.07 | 38.95 | 41.37 |
| 18350 | 92.35 | 276.28 | 122.54 | 92.32 | 51.93 |
| 21025 | 91.61 | 267.66 | 41.37 | 417.82 | 107.31 |
| 16518 | 93.89 | 2054.01 | 385.94 | 949.88 | 306.74 |
| 17734 | 98.79 | 321.98 | 49.82 | 114.29 | 102.66 |
| 17735 | 94.05 | 363.65 | 53.62 | 178.33 | 104.47 |
| 10241 | 90.38 | 114.02 | 25.12 | 59.17 | 24.28 |
| 1475 | 95.17 | 2063.49 | 658.77 | 155.80 | 379.29 |
| 8664 | 95.29 | 1388.21 | 550.83 | 89.50 | 215.23 |
| 20161 | 92.68 | 128.82 | 47.99 | 32.65 | 31.21 |
| 25098 | 90.52 | 176.46 | 75.02 | 35.80 | 33.18 |
| 235 | 91.30 | 320.65 | 25.66 | 230.34 | 61.53 |
| 17426 | 90.61 | 429.40 | 38.59 | 568.65 | 91.40 |
| 23679 | 90.38 | 78.01 | 14.28 | 38.29 | 19.90 |
| 15791 | 90.79 | 201.52 | 56.18 | 123.78 | 84.57 |
| 2555 | 91.44 | 145.97 | 22.76 | 85.01 | 42.88 |
| 503 | 92.18 | 150.85 | 14.24 | 103.15 | 29.15 |
| 25279 | 90.97 | 751.86 | 61.65 | 549.26 | 116.47 |
| 22412 | 93.08 | 196.70 | 39.42 | 91.13 | 45.28 |
| 22413 | 91.53 | 141.51 | 32.80 | 68.54 | 38.43 |
| 25379 | 91.38 | 117.64 | 16.80 | 71.75 | 25.39 |
| 9224 | 90.94 | 418.49 | 23.57 | 559.20 | 140.71 |
| 1460 | 92.12 | 251.67 | 29.18 | 192.46 | 84.37 |
| 25547 | 92.64 | 407.00 | 28.91 | 267.96 | 104.45 |
| 809 | 93.23 | 100.66 | 16.68 | 39.56 | 39.66 |
| 25606 | 92.45 | 66.28 | 8.55 | 40.17 | 15.01 |
| 25747 | 90.98 | 80.78 | 19.33 | 42.91 | 38.40 |
| 20173 | 92.18 | 32.74 | 11.51 | 77.29 | 31.95 |
| 407 | 90.64 | 264.48 | 35.26 | 395.09 | 94.07 |
| 24459 | 91.21 | 398.68 | 40.21 | 276.39 | 76.14 |
| 24672 | 92.12 | 65.39 | 7.99 | 39.44 | 14.11 |
| 433 | 90.88 | 134.41 | 23.78 | 80.86 | 34.13 |
| 605 | 91.39 | 38.02 | 5.26 | 21.20 | 10.90 |
| 20085 | 90.68 | 375.42 | 39.17 | 247.93 | 59.19 |
| 1929 | 91.29 | 473.25 | 68.26 | 870.59 | 215.67 |
| 21211 | 91.55 | 548.25 | 69.20 | 850.78 | 217.13 |
| 21696 | 90.92 | 282.32 | 32.07 | 175.33 | 47.74 |
| 15138 | 91.39 | 196.35 | 69.14 | 471.14 | 175.95 |
| 1409 | 94.27 | 290.95 | 26.81 | 438.89 | 99.13 |
| 1501 | 91.02 | 99.81 | 25.56 | 52.93 | 56.99 |
| 17570 | 93.36 | 379.60 | 47.99 | 240.61 | 81.89 |
| 24649 | 94.42 | 65.78 | 19.06 | 112.21 | 22.95 |
| 21653 | 91.50 | 363.77 | 66.02 | 237.45 | 68.10 |
| 19040 | 91.74 | 323.49 | 86.16 | 184.44 | 121.72 |
| 21400 | 92.85 | 211.40 | 61.58 | 361.76 | 72.81 |
| 35 | 91.15 | 784.74 | 75.75 | 1207.71 | 355.24 |
| 1581 | 91.79 | 87.16 | 7.56 | 66.76 | 21.04 |
| 17226 | 90.79 | 433.99 | 33.61 | 577.07 | 118.33 |
| 1764 | 93.42 | 138.74 | 17.01 | 88.17 | 27.95 |
| 20753 | 90.89 | 184.62 | 20.62 | 119.99 | 28.26 |
| 1141 | 95.33 | 394.51 | 55.69 | 241.23 | 66.76 |
| 16354 | 95.03 | 20.78 | 35.33 | 279.68 | 148.90 |
| 21683 | 91.05 | 65.76 | 22.22 | 27.27 | 20.99 |
| 16520 | 90.36 | 123.97 | 17.89 | 89.12 | 111.29 |
| 13005 | 90.56 | 143.19 | 30.68 | 80.63 | 29.18 |
| 16948 | 95.36 | 125.57 | 23.36 | 317.27 | 132.70 |
| 23033 | 91.64 | 422.53 | 36.80 | 579.14 | 117.96 |
| 23166 | 90.98 | 229.86 | 42.08 | 126.92 | 62.06 |
| 4462 | 91.48 | 567.85 | 100.01 | 952.66 | 315.50 |
| 15421 | 90.70 | 562.11 | 32.28 | 738.52 | 153.62 |
| 7936 | 91.91 | 84.99 | 15.68 | 137.74 | 31.39 |
| 17256 | 91.27 | 259.66 | 52.16 | 429.33 | 122.40 |
| 21672 | 93.27 | 447.28 | 37.64 | 314.18 | 77.63 |
| 19768 | 92.02 | 1218.83 | 166.71 | 787.22 | 172.80 |
| 3474 | 93.52 | 345.67 | 22.76 | 483.73 | 104.79 |
| 12016 | 91.15 | 252.53 | 37.75 | 465.80 | 181.24 |
| 16469 | 90.82 | 1028.80 | 54.62 | 1320.78 | 271.98 |
| 13610 | 91.17 | 219.12 | 31.55 | 365.11 | 107.30 |
| 19251 | 90.88 | 562.71 | 31.16 | 694.44 | 105.77 |
| 3863 | 94.79 | 122.87 | 17.81 | 196.59 | 86.02 |
| 4542 | 90.94 | 270.11 | 21.67 | 180.81 | 56.07 |
| 21029 | 94.64 | 126.09 | 12.20 | 81.52 | 23.49 |
| 2098 | 90.58 | 232.32 | 22.55 | 177.21 | 39.37 |
| 6595 | 91.85 | 109.39 | 17.61 | 68.80 | 30.49 |
| 21388 | 97.24 | 104.79 | 11.52 | 27.72 | 24.11 |
| 21990 | 92.48 | 28.82 | 20.42 | 121.58 | 57.45 |
| 5565 | 92.52 | 206.09 | 47.75 | 389.83 | 117.52 |
| 6736 | 92.06 | 131.85 | 22.79 | 69.09 | 33.18 |
| 23758 | 93.24 | 103.71 | 16.35 | 174.80 | 41.71 |
| 23834 | 91.74 | 142.01 | 30.15 | 74.82 | 24.22 |
| 18288 | 94.67 | 217.71 | 34.85 | 124.55 | 43.60 |
| 12561 | 94.73 | 64.62 | 15.14 | 148.52 | 51.53 |
| 11162 | 91.45 | 324.91 | 48.59 | 495.59 | 118.35 |
| 17938 | 93.15 | 319.01 | 21.59 | 447.84 | 95.68 |
| 9116 | 92.64 | 273.80 | 27.04 | 392.81 | 75.75 |
| 7142 | 95.27 | 363.26 | 34.37 | 610.43 | 144.19 |
| 22415 | 92.95 | 375.76 | 48.28 | 206.41 | 158.59 |
| 7586 | 93.24 | 455.38 | 78.29 | 769.55 | 187.42 |
| 11559 | 93.06 | 318.57 | 60.32 | 552.63 | 125.46 |
| 10004 | 93.55 | 78.40 | 13.45 | 39.38 | 19.65 |
| 17755 | 92.18 | 246.88 | 32.61 | 383.76 | 97.58 |
| 9583 | 91.92 | 154.31 | 44.35 | 55.84 | 61.67 |
| 8665 | 95.26 | 2691.53 | 1101.20 | 343.63 | 497.74 |
| 8837 | 91.52 | 234.73 | 29.31 | 331.74 | 63.42 |
| 12450 | 91.48 | 35.96 | 20.64 | 127.75 | 69.86 |
| 22101 | 95.58 | 21.93 | 23.56 | 170.51 | 83.23 |
| 7300 | 93.06 | 545.82 | 63.96 | 744.66 | 285.54 |
| 11618 | 94.03 | 224.46 | 33.16 | 380.82 | 110.84 |
| 6290 | 94.18 | 167.05 | 14.13 | 232.79 | 37.78 |
| 2824 | 91.79 | 65.68 | 9.52 | 100.88 | 21.89 |
| 18642 | 98.09 | 492.19 | 42.17 | 881.32 | 192.80 |
| 16907 | 96.36 | 33.38 | 19.54 | 131.32 | 51.03 |
| 6675 | 92.06 | 362.12 | 33.19 | 548.28 | 144.52 |
| 7049 | 92.42 | 153.66 | 20.90 | 227.04 | 46.15 |
| 3698 | 91.97 | 66.85 | 13.21 | 128.16 | 41.97 |
| 4952 | 91.59 | 200.30 | 34.51 | 106.14 | 44.92 |
| 16003 | 92.45 | 198.48 | 23.57 | 334.94 | 104.96 |
| 14083 | 93.91 | 297.20 | 43.33 | 473.74 | 100.64 |
| 24042 | 95.76 | 73.75 | 40.11 | 21.09 | 79.30 |
| 12551 | 92.58 | 95.87 | 15.38 | 164.16 | 42.22 |

TABLE 5D
SODIUM CHROMATE

Atty. Docket No. GENE-077/26US
Doc. No. 44941

| | | Tox | | | Non-Tox |
|---|---|---|---|---|---|
| GLGC | LDA | Group | Tox Group | Non-Tox Group | Group |
| Identifier | Score | Mean | SD | Mean | SD |
| 15246 | 95.23 | 104.02 | 19.45 | 63.14 | 17.15 |
| 15277 | 95.56 | 1199.28 | 124.15 | 856.07 | 134.65 |
| 16859 | 96.50 | 245.89 | 56.54 | 122.60 | 47.46 |
| 11615 | 95.14 | 539.91 | 16.66 | 412.37 | 87.18 |
| 19412 | 96.11 | 219.32 | 2.99 | 183.37 | 50.07 |
| 5297 | 94.75 | 143.95 | 30.44 | 352.41 | 109.46 |
| 14983 | 93.93 | 3935.84 | 130.20 | 5873.51 | 4368.56 |
| 17378 | 95.02 | 212.42 | 29.92 | 131.90 | 39.98 |
| 8664 | 92.82 | 246.38 | 136.12 | 98.44 | 245.29 |
| 15926 | 93.75 | 149.75 | 18.03 | 92.20 | 42.90 |
| 2632 | 94.09 | 197.64 | 7.08 | 154.04 | 30.64 |
| 23625 | 94.57 | 138.13 | 48.08 | 319.20 | 91.62 |
| 15242 | 93.06 | 108.52 | 12.92 | 80.06 | 15.30 |
| 19665 | 95.81 | 204.31 | 35.07 | 88.59 | 51.54 |
| 5496 | 93.96 | 268.43 | 102.39 | 651.85 | 166.35 |
| 5497 | 93.48 | 371.29 | 150.42 | 785.01 | 190.34 |
| 14332 | 95.90 | 951.74 | 99.04 | 604.90 | 155.26 |
| 8640 | 94.33 | 66.36 | 5.36 | 141.04 | 58.77 |
| 20960 | 93.54 | 443.32 | 50.92 | 295.69 | 74.33 |
| 8984 | 92.67 | 399.31 | 28.86 | 308.62 | 53.47 |
| 25377 | 94.93 | 56.11 | 8.35 | 26.88 | 13.79 |
| 21882 | 94.51 | 486.74 | 47.85 | 758.64 | 167.24 |
| 24615 | 94.84 | 1270.53 | 105.47 | 933.13 | 210.70 |
| 20740 | 93.84 | 355.52 | 75.34 | 210.92 | 62.22 |
| 14996 | 94.42 | 206.77 | 60.78 | 471.76 | 163.11 |
| 25692 | 93.75 | 70.08 | 7.62 | 156.74 | 181.44 |
| 1447 | 92.70 | 268.68 | 38.24 | 201.70 | 34.81 |
| 24590 | 94.36 | 43.33 | 17.37 | 166.07 | 70.63 |
| 729 | 93.93 | 39.48 | 6.73 | 77.25 | 26.06 |
| 1929 | 93.93 | 476.55 | 93.68 | 868.90 | 216.79 |
| 4504 | 93.75 | 445.80 | 139.02 | 1087.15 | 323.13 |
| 19152 | 96.14 | 320.13 | 96.93 | 160.67 | 53.93 |
| 19679 | 94.75 | 329.18 | 166.41 | 754.53 | 202.48 |
| 23307 | 94.90 | 142.12 | 10.93 | 93.63 | 26.00 |
| 1798 | 94.69 | 119.14 | 47.77 | 336.07 | 205.61 |
| 19268 | 95.08 | 1507.38 | 104.73 | 1082.49 | 316.16 |
| 15291 | 97.74 | 227.69 | 93.17 | 97.65 | 27.73 |
| 13939 | 93.72 | 124.71 | 48.61 | 325.12 | 109.46 |
| 23698 | 96.41 | 147.28 | 9.50 | 275.19 | 124.72 |
| 23699 | 92.76 | 186.00 | 34.99 | 331.03 | 104.73 |
| 6055 | 95.56 | 447.44 | 133.36 | 1045.52 | 255.69 |
| 13369 | 93.12 | 232.19 | 7.82 | 184.45 | 38.15 |
| 20780 | 93.33 | 152.07 | 119.67 | 539.74 | 202.23 |
| 20829 | 95.84 | 1805.57 | 324.13 | 925.21 | 315.25 |
| 347 | 93.87 | 123.84 | 14.40 | 78.57 | 23.09 |
| 1479 | 95.11 | 92.37 | 36.66 | 221.32 | 62.74 |
| 24582 | 94.45 | 69.68 | 15.24 | 31.85 | 17.38 |
| 21123 | 93.09 | 321.71 | 96.61 | 661.80 | 184.33 |
| 1877 | 92.82 | 314.31 | 125.56 | 652.38 | 170.00 |
| 13940 | 95.72 | 100.29 | 27.43 | 216.02 | 51.74 |
| 16775 | 94.57 | 349.58 | 178.66 | 1164.24 | 399.53 |
| 989 | 94.78 | 38.30 | 12.87 | 147.38 | 60.50 |
| 1511 | 94.81 | 28.36 | 22.05 | 333.19 | 206.19 |
| 21585 | 93.18 | 157.63 | 45.39 | 342.07 | 89.26 |
| 21586 | 94.18 | 70.26 | 31.01 | 220.53 | 67.79 |
| 4589 | 92.97 | 724.19 | 281.99 | 1414.61 | 338.33 |
| 20809 | 93.33 | 437.50 | 34.89 | 329.95 | 63.72 |
| 23806 | 94.33 | 167.38 | 49.48 | 459.19 | 167.23 |
| 1081 | 93.03 | 278.96 | 102.51 | 527.65 | 126.56 |
| 1510 | 94.93 | 412.23 | 94.86 | 837.44 | 225.06 |
| 14353 | 95.05 | 92.56 | 11.29 | 55.60 | 17.26 |
| 16070 | 94.60 | 96.59 | 3.46 | 128.18 | 52.11 |
| 15339 | 95.47 | 139.74 | 20.03 | 227.15 | 74.31 |
| 474 | 92.73 | 490.32 | 88.10 | 749.79 | 130.85 |
| 11959 | 96.86 | 62.25 | 10.64 | 125.40 | 27.59 |
| 18269 | 94.00 | 394.51 | 86.48 | 771.13 | 179.69 |
| 21672 | 93.48 | 474.43 | 83.01 | 314.66 | 77.75 |
| 22124 | 93.60 | 116.89 | 12.88 | 78.17 | 21.00 |
| 1159 | 93.75 | 590.14 | 150.75 | 991.96 | 225.85 |
| 4473 | 94.36 | 67.70 | 30.48 | 172.24 | 49.29 |
| 2107 | 95.11 | 260.72 | 38.29 | 437.31 | 95.82 |
| 19469 | 95.84 | 134.02 | 40.80 | 367.99 | 99.90 |
| 12276 | 94.78 | 72.82 | 16.26 | 186.84 | 61.45 |
| 17468 | 95.87 | 240.19 | 29.50 | 414.57 | 80.60 |
| 17469 | 93.72 | 34.52 | 5.63 | 72.44 | 30.50 |
| 22537 | 95.96 | 40.88 | 34.27 | 301.20 | 137.68 |
| 22538 | 96.29 | 172.72 | 15.27 | 339.80 | 93.47 |
| 17923 | 93.81 | 83.10 | 5.93 | 58.07 | 17.69 |
| 3863 | 93.87 | 25.92 | 20.32 | 196.57 | 85.56 |
| 21305 | 94.06 | 194.67 | 46.54 | 437.54 | 129.56 |
| 17836 | 93.69 | 121.68 | 5.52 | 90.78 | 19.92 |
| 22669 | 93.45 | 61.36 | 13.28 | 33.21 | 14.07 |
| 15844 | 93.36 | 70.68 | 14.50 | 37.72 | 16.43 |
| 21086 | 94.21 | 164.64 | 11.89 | 103.24 | 34.93 |
| 12797 | 96.56 | 166.69 | 40.58 | 73.77 | 27.51 |
| 15027 | 96.86 | 228.67 | 10.97 | 139.90 | 39.67 |
| 12129 | 96.29 | 143.53 | 31.03 | 645.40 | 334.58 |
| 17823 | 94.84 | 683.68 | 66.28 | 459.89 | 95.30 |
| 21587 | 95.08 | 63.47 | 12.04 | 184.59 | 76.44 |
| 24762 | 97.07 | 206.67 | 49.31 | 926.38 | 314.75 |
| 22180 | 96.14 | 145.82 | 40.45 | 88.52 | 23.95 |
| 12673 | 95.84 | 106.88 | 41.08 | 40.72 | 22.46 |
| 18524 | 94.90 | 410.60 | 75.64 | 697.54 | 141.17 |
| 22770 | 95.99 | 460.91 | 61.30 | 293.34 | 60.75 |
| 12355 | 95.20 | 55.04 | 2.97 | 32.72 | 17.38 |
| 3631 | 97.59 | 146.49 | 9.89 | 93.75 | 22.59 |
| 19347 | 94.93 | 82.73 | 6.92 | 47.68 | 20.04 |
| 23626 | 97.10 | 201.76 | 49.28 | 78.54 | 37.73 |
| 23790 | 96.53 | 123.00 | 38.12 | 63.08 | 19.14 |
| 19936 | 94.78 | 417.94 | 86.08 | 787.51 | 166.53 |
| 23839 | 95.17 | 215.43 | 62.86 | 469.65 | 119.97 |
| 16731 | 95.53 | 164.04 | 17.44 | 86.12 | 38.17 |
| 23843 | 96.32 | 187.45 | 30.50 | 103.55 | 28.14 |
| 17523 | 96.17 | 123.97 | 10.52 | 81.13 | 19.15 |
| 2232 | 97.16 | 36.74 | 0.82 | 24.79 | 11.77 |
| 2113 | 96.38 | 222.44 | 37.93 | 132.53 | 29.47 |
| 2423 | 96.59 | 192.07 | 14.10 | 132.98 | 27.14 |
| 11558 | 96.56 | 70.08 | 17.91 | 160.77 | 43.05 |
| 3145 | 95.56 | 152.93 | 22.06 | 426.44 | 138.00 |
| 21959 | 95.41 | 234.36 | 36.74 | 132.11 | 42.91 |
| 16625 | 96.89 | 237.89 | 5.08 | 180.96 | 38.01 |
| 15232 | 96.26 | 257.50 | 24.61 | 169.53 | 35.85 |
| 6869 | 95.20 | 79.10 | 7.52 | 32.43 | 29.17 |
| 16824 | 96.41 | 72.56 | 17.91 | 227.30 | 79.50 |
| 13104 | 95.32 | 217.32 | 35.96 | 479.57 | 130.05 |
| 12095 | 94.99 | 365.17 | 58.23 | 1298.24 | 810.83 |
| 21659 | 96.32 | 386.36 | 74.64 | 204.80 | 61.71 |
| 3934 | 95.50 | 716.78 | 83.73 | 1225.51 | 254.53 |
| 3493 | 96.95 | 123.15 | 24.99 | 61.58 | 18.38 |
| 7270 | 96.02 | 267.75 | 28.36 | 171.64 | 36.71 |
| 15159 | 96.02 | 419.08 | 74.41 | 872.31 | 214.06 |
| 17419 | 95.90 | 336.07 | 70.94 | 197.65 | 45.14 |
| 7896 | 97.71 | 173.75 | 8.10 | 283.20 | 65.35 |
| 2348 | 95.81 | 97.18 | 36.13 | 463.64 | 200.40 |
| 1431 | 95.53 | 84.36 | 35.10 | 462.05 | 168.52 |
| 8721 | 96.14 | 35.66 | 23.53 | 183.51 | 66.31 |
| 8739 | 94.99 | 97.84 | 18.34 | 265.76 | 118.29 |
| 5290 | 96.17 | 22.52 | 4.12 | 50.65 | 15.13 |
| 13157 | 95.59 | 99.31 | 44.78 | 328.67 | 105.58 |
| 16338 | 96.77 | 97.00 | 8.89 | 58.64 | 16.37 |
| 7700 | 96.11 | 135.98 | 23.23 | 80.56 | 43.28 |
| 24592 | 96.05 | 74.35 | 27.61 | 329.43 | 142.17 |
| 12682 | 95.62 | 511.62 | 150.58 | 1734.71 | 588.20 |
| 2534 | 96.56 | 68.06 | 11.48 | 35.59 | 11.40 |
| 8215 | 95.08 | 916.05 | 104.30 | 1510.03 | 332.10 |
| 13106 | 95.99 | 68.92 | 9.31 | 37.20 | 21.98 |
| 17223 | 96.41 | 1104.50 | 35.58 | 868.15 | 118.29 |
| 18418 | 96.35 | 370.51 | 71.34 | 245.92 | 41.02 |
| 23018 | 96.05 | 150.06 | 18.94 | 105.15 | 19.40 |
| 18095 | 95.84 | 1118.60 | 126.43 | 801.84 | 125.83 |
| 5901 | 96.74 | 159.91 | 19.26 | 91.66 | 42.91 |
| 6629 | 95.02 | 314.77 | 37.87 | 540.04 | 121.47 |

TABLE 5E
SODIUM OXALATE

Atty. Docket No. GENE-077/26US
Doc. No. 44941

| | | Tox | | | Non-Tox |
|---|---|---|---|---|---|
| GLGC | LDA | Group | Tox Group | Non-Tox Group | Group |
| Identifier | Score | Mean | SD | Mean | SD |
| 17695 | 99.21 | 249.77 | 34.66 | 668.20 | 180.15 |
| 13563 | 99.55 | 355.81 | 42.90 | 937.62 | 228.58 |
| 535 | 98.79 | 96.78 | 13.35 | 38.89 | 21.47 |
| 8325 | 98.97 | 99.90 | 20.29 | 23.02 | 13.28 |
| 11421 | 99.31 | 341.72 | 20.35 | 194.63 | 40.25 |
| 896 | 99.67 | 191.75 | 36.71 | 23.81 | 21.26 |
| 23778 | 99.03 | 364.40 | 111.41 | 62.36 | 35.91 |
| 7101 | 98.61 | 3734.58 | 971.30 | 404.36 | 664.35 |
| 17301 | 98.88 | 593.47 | 75.23 | 238.07 | 75.73 |
| 20886 | 98.70 | 94.56 | 45.86 | 798.30 | 318.63 |
| 20887 | 98.52 | 191.50 | 66.84 | 871.37 | 342.61 |
| 20167 | 99.03 | 96.57 | 19.35 | 24.31 | 11.29 |
| 21651 | 98.79 | 211.95 | 80.37 | 26.88 | 22.79 |
| 23780 | 99.43 | 120.05 | 46.77 | 20.80 | 30.16 |
| 13973 | 99.34 | 247.62 | 42.45 | 33.40 | 20.04 |
| 15790 | 98.61 | 112.29 | 21.33 | 35.96 | 18.51 |
| 16649 | 98.52 | 361.29 | 75.07 | 105.60 | 48.12 |
| 16007 | 99.25 | 128.45 | 19.80 | 21.47 | 13.08 |
| 5496 | 98.79 | 219.25 | 23.70 | 652.26 | 165.76 |
| 5497 | 99.28 | 248.05 | 17.62 | 785.70 | 189.15 |
| 17535 | 98.82 | 560.61 | 73.51 | 244.84 | 64.97 |
| 25233 | 98.76 | 62.01 | 2.18 | 31.39 | 13.04 |
| 19834 | 98.76 | 416.63 | 72.40 | 169.62 | 42.80 |
| 16650 | 98.58 | 650.04 | 84.16 | 256.56 | 84.67 |
| 20494 | 99.15 | 297.13 | 78.23 | 1055.83 | 319.86 |
| 574 | 98.73 | 912.07 | 67.77 | 352.32 | 185.51 |
| 455 | 99.73 | 571.19 | 126.84 | 138.41 | 189.56 |
| 25470 | 99.79 | 125.97 | 5.72 | 31.22 | 18.52 |
| 7196 | 98.52 | 549.97 | 33.63 | 177.67 | 91.15 |
| 457 | 98.61 | 897.31 | 151.83 | 285.93 | 92.35 |
| 15273 | 99.09 | 132.66 | 22.37 | 32.60 | 18.78 |
| 16674 | 98.88 | 180.45 | 57.13 | 27.50 | 22.94 |
| 16675 | 99.00 | 328.75 | 104.16 | 29.43 | 36.26 |
| 699 | 99.61 | 74.54 | 12.40 | 23.01 | 34.32 |
| 19058 | 99.06 | 122.17 | 14.88 | 52.83 | 19.42 |
| 1929 | 98.61 | 362.48 | 40.32 | 869.55 | 215.82 |
| 16610 | 99.25 | 316.65 | 10.82 | 165.32 | 65.78 |
| 8426 | 98.67 | 120.65 | 12.99 | 49.38 | 20.34 |
| 16676 | 98.91 | 271.51 | 96.32 | 33.53 | 29.58 |
| 15175 | 98.79 | 116.18 | 37.93 | 319.43 | 57.36 |
| 1409 | 98.73 | 201.45 | 22.59 | 438.68 | 98.73 |
| 15002 | 98.55 | 420.90 | 46.06 | 135.44 | 107.26 |
| 20828 | 98.97 | 1005.07 | 82.88 | 323.14 | 162.23 |
| 17516 | 98.64 | 304.60 | 25.38 | 547.56 | 127.91 |
| 17570 | 99.82 | 642.60 | 29.35 | 240.16 | 79.04 |
| 16967 | 99.18 | 136.29 | 21.82 | 33.25 | 18.18 |
| 1462 | 98.85 | 1628.61 | 155.82 | 431.68 | 216.05 |
| 4450 | 98.91 | 136.12 | 13.21 | 279.34 | 61.49 |
| 16726 | 99.09 | 352.81 | 48.90 | 1059.59 | 226.33 |
| 23699 | 98.82 | 137.82 | 16.18 | 331.30 | 104.43 |
| 7124 | 99.00 | 529.78 | 56.03 | 1203.74 | 312.97 |
| 16871 | 98.64 | 206.80 | 46.25 | 79.45 | 24.72 |
| 12606 | 99.25 | 130.99 | 7.64 | 295.10 | 99.03 |
| 17226 | 99.64 | 253.12 | 22.46 | 577.21 | 117.15 |
| 17227 | 99.06 | 499.29 | 60.99 | 982.39 | 179.08 |
| 21122 | 98.76 | 534.05 | 73.79 | 1146.33 | 236.16 |
| 1877 | 98.52 | 254.30 | 28.09 | 652.80 | 169.49 |
| 1993 | 98.94 | 96.08 | 5.11 | 24.14 | 17.89 |
| 1490 | 98.67 | 52.85 | 7.86 | 20.79 | 7.83 |
| 15437 | 98.91 | 193.06 | 63.58 | 32.08 | 19.16 |
| 1564 | 98.88 | 1294.14 | 223.87 | 44.50 | 193.91 |
| 15008 | 98.94 | 306.66 | 36.44 | 576.58 | 114.19 |
| 23961 | 98.79 | 379.40 | 51.33 | 785.34 | 150.80 |
| 17661 | 98.76 | 580.72 | 105.12 | 262.94 | 68.13 |
| 1801 | 99.06 | 255.70 | 34.95 | 89.47 | 28.47 |
| 20582 | 98.52 | 287.05 | 13.73 | 487.15 | 95.43 |
| 11079 | 99.12 | 328.58 | 20.15 | 185.07 | 44.66 |
| 22927 | 98.64 | 210.74 | 21.37 | 84.48 | 34.52 |
| 19377 | 99.76 | 215.21 | 4.72 | 109.43 | 24.18 |
| 16082 | 98.88 | 129.78 | 28.85 | 40.75 | 17.41 |
| 17256 | 99.09 | 125.36 | 14.47 | 429.20 | 121.73 |
| 17289 | 99.43 | 410.41 | 33.11 | 1059.53 | 278.91 |
| 17290 | 99.18 | 509.27 | 62.67 | 1294.21 | 373.99 |
| 17345 | 98.55 | 263.93 | 24.68 | 127.21 | 36.29 |
| 9084 | 98.85 | 145.53 | 46.17 | 40.68 | 17.08 |
| 3925 | 99.00 | 198.37 | 20.86 | 461.33 | 112.52 |
| 18168 | 98.79 | 168.33 | 33.83 | 38.38 | 34.80 |
| 22618 | 99.31 | 117.66 | 20.00 | 30.61 | 11.80 |
| 22984 | 99.34 | 266.02 | 27.63 | 100.26 | 30.89 |
| 22540 | 99.49 | 599.57 | 49.16 | 1780.91 | 551.74 |
| 17514 | 98.82 | 358.61 | 50.80 | 817.29 | 188.14 |
| 5206 | 99.12 | 507.97 | 41.61 | 176.59 | 77.00 |
| 894 | 99.15 | 1783.60 | 174.73 | 652.12 | 224.42 |
| 23532 | 98.88 | 124.66 | 30.17 | 22.30 | 16.51 |
| 23533 | 98.97 | 204.49 | 10.44 | 83.11 | 38.10 |
| 23958 | 99.06 | 203.79 | 34.98 | 61.18 | 25.94 |
| 5952 | 98.82 | 255.47 | 23.17 | 83.50 | 40.80 |
| 9309 | 99.67 | 329.43 | 22.61 | 174.98 | 41.72 |
| 12616 | 98.91 | 144.41 | 20.14 | 60.76 | 20.41 |
| 3269 | 99.03 | 366.86 | 112.74 | 81.91 | 44.65 |
| 21959 | 99.40 | 327.36 | 32.91 | 131.72 | 41.66 |
| 3572 | 99.03 | 172.95 | 63.76 | 38.98 | 21.80 |
| 410 | 99.00 | 465.49 | 50.55 | 1037.75 | 225.86 |
| 895 | 99.21 | 668.52 | 123.70 | 177.65 | 76.45 |
| 23810 | 99.21 | 84.71 | 11.03 | 27.57 | 13.19 |
| 7665 | 98.91 | 723.79 | 74.48 | 290.61 | 94.65 |
| 3083 | 99.21 | 158.35 | 14.18 | 74.00 | 21.63 |
| 3584 | 99.00 | 203.98 | 20.49 | 61.56 | 30.32 |
| 16884 | 98.79 | 1053.19 | 76.80 | 1909.01 | 474.48 |
| 6022 | 98.85 | 414.10 | 35.32 | 217.84 | 63.57 |
| 5929 | 99.28 | 168.33 | 15.69 | 36.89 | 20.17 |
| 16913 | 99.15 | 613.71 | 52.52 | 1257.86 | 287.28 |
| 3099 | 98.85 | 554.56 | 35.33 | 894.32 | 163.71 |

TABLE 5F
THIOACETAMIDE

Atty. Docket No. GENE-077/26US
Doc. No. 44941

| | | | Tox | Non-Tox | Non-Tox |
|---|---|---|---|---|---|
| GLGC | | Tox Group | Group | Group | Group |
| Identifier | LDA Score | Mean | SD | Mean | SD |
| 16087 | 88.96 | 147.89 | 19.38 | 87.68 | 30.47 |
| 13934 | 92.71 | 180.15 | 27.02 | 68.19 | 54.80 |
| 17268 | 90.32 | 317.63 | 20.88 | 445.26 | 113.01 |
| 12366 | 88.81 | 402.17 | 110.21 | 266.10 | 83.20 |
| 9332 | 90.02 | 39.70 | 10.71 | 102.53 | 42.52 |
| 783 | 90.47 | 122.89 | 16.37 | 83.12 | 25.36 |
| 2574 | 88.38 | 110.78 | 17.74 | 72.92 | 19.69 |
| 19890 | 89.34 | 114.05 | 11.07 | 80.22 | 26.45 |
| 23115 | 96.27 | 218.73 | 37.94 | 504.64 | 158.87 |
| 15028 | 89.26 | 172.40 | 66.68 | 366.39 | 126.77 |
| 17921 | 87.55 | 119.45 | 22.88 | 195.17 | 71.34 |
| 16116 | 82.88 | 61.16 | 6.60 | 78.82 | 19.59 |
| 1453 | 82.50 | 89.33 | 27.93 | 52.20 | 26.79 |
| 20896 | 85.56 | 83.44 | 18.33 | 141.36 | 40.26 |
| 18043 | 84.79 | 99.39 | 38.52 | 41.39 | 22.49 |
| 25235 | 90.29 | 187.30 | 55.17 | 84.23 | 49.84 |
| 18246 | 82.90 | 113.80 | 43.37 | 258.83 | 95.85 |
| 28 | 87.68 | 260.01 | 111.55 | 531.88 | 180.16 |
| 24631 | 84.37 | 36.22 | 7.30 | 21.68 | 10.08 |
| 20149 | 89.08 | 2751.06 | 487.03 | 1546.67 | 703.21 |
| 25364 | 86.35 | 104.43 | 36.32 | 56.18 | 57.10 |
| 2079 | 84.04 | 190.93 | 36.44 | 304.09 | 90.50 |
| 25399 | 83.38 | 392.81 | 122.41 | 185.18 | 190.17 |
| 8829 | 86.69 | 454.94 | 86.93 | 283.22 | 86.03 |
| 24566 | 82.52 | 103.57 | 24.04 | 179.92 | 89.90 |
| 5837 | 90.29 | 586.00 | 88.17 | 850.13 | 202.51 |
| 5838 | 83.75 | 443.80 | 68.13 | 652.08 | 145.88 |
| 3609 | 83.65 | 185.56 | 111.40 | 434.86 | 172.76 |
| 25589 | 82.84 | 220.29 | 33.93 | 150.66 | 41.90 |
| 25647 | 82.56 | 437.20 | 166.12 | 209.40 | 238.75 |
| 25662 | 85.35 | 210.06 | 62.21 | 117.83 | 97.01 |
| 25686 | 82.52 | 899.95 | 98.60 | 749.37 | 152.25 |
| 20617 | 86.99 | 425.33 | 118.93 | 206.81 | 228.40 |
| 22219 | 84.55 | 61.94 | 15.60 | 37.48 | 62.65 |
| 25777 | 84.09 | 809.02 | 317.73 | 441.84 | 253.01 |
| 24431 | 84.79 | 131.55 | 52.25 | 59.17 | 87.36 |
| 24438 | 85.26 | 89.77 | 17.89 | 143.35 | 40.49 |
| 24567 | 87.37 | 34.58 | 19.86 | 111.01 | 63.84 |
| 291 | 88.11 | 145.69 | 31.30 | 224.02 | 46.48 |
| 8426 | 83.89 | 77.60 | 12.47 | 49.42 | 20.66 |
| 1535 | 85.53 | 44.01 | 11.60 | 85.58 | 31.50 |
| 23781 | 82.57 | 67.71 | 7.21 | 85.97 | 27.49 |
| 10071 | 87.87 | 177.18 | 42.47 | 350.75 | 123.95 |
| 25921 | 86.50 | 50.94 | 6.86 | 28.33 | 16.05 |
| 15330 | 84.84 | 36.66 | 19.02 | 81.96 | 24.24 |
| 19003 | 84.31 | 141.69 | 17.27 | 102.43 | 33.94 |
| 19943 | 88.92 | 210.88 | 54.72 | 366.97 | 116.34 |
| 22434 | 83.07 | 68.42 | 18.29 | 43.74 | 20.91 |
| 1409 | 84.89 | 299.53 | 60.23 | 438.92 | 99.13 |
| 16227 | 83.44 | 152.60 | 38.37 | 88.54 | 40.73 |
| 15191 | 84.83 | 3728.02 | 829.67 | 2407.15 | 1233.18 |
| 15642 | 84.42 | 750.42 | 224.71 | 433.34 | 115.91 |
| 4280 | 90.44 | 2201.62 | 242.72 | 1538.01 | 535.02 |
| 15039 | 89.11 | 118.00 | 47.79 | 272.70 | 91.84 |
| 1946 | 89.66 | 64.08 | 9.55 | 39.55 | 12.41 |
| 4451 | 90.01 | 192.78 | 31.81 | 290.75 | 72.79 |
| 17357 | 85.93 | 89.91 | 76.51 | 270.04 | 95.73 |
| 21193 | 84.95 | 50.26 | 5.87 | 33.25 | 14.85 |
| 18716 | 85.36 | 53.32 | 13.29 | 29.64 | 11.72 |
| 21400 | 89.05 | 217.92 | 45.44 | 361.83 | 72.95 |
| 187 | 87.75 | 202.63 | 72.64 | 75.52 | 52.59 |
| 20555 | 90.10 | 70.09 | 13.74 | 116.38 | 35.29 |
| 15489 | 91.68 | 96.70 | 14.21 | 141.82 | 34.76 |
| 6577 | 85.16 | 122.77 | 12.31 | 178.46 | 48.88 |
| 439 | 84.00 | 28.56 | 7.59 | 45.33 | 16.65 |
| 16205 | 83.86 | 1418.72 | 140.70 | 1122.95 | 425.85 |
| 989 | 83.64 | 106.37 | 20.93 | 147.41 | 60.77 |
| 21147 | 88.84 | 223.85 | 45.68 | 361.29 | 80.82 |
| 3512 | 83.28 | 129.79 | 11.72 | 106.87 | 19.31 |
| 2439 | 88.38 | 98.92 | 17.04 | 147.82 | 27.80 |
| 1529 | 82.83 | 226.95 | 35.67 | 294.63 | 70.00 |
| 20582 | 85.77 | 353.36 | 43.17 | 487.57 | 95.61 |
| 22562 | 83.52 | 46.00 | 10.04 | 27.10 | 13.28 |
| 23000 | 84.06 | 41.94 | 3.47 | 35.87 | 9.55 |
| 13974 | 82.76 | 355.79 | 36.94 | 315.24 | 173.81 |
| 22781 | 82.81 | 229.37 | 43.64 | 143.62 | 72.36 |
| 6049 | 84.79 | 805.83 | 63.05 | 688.66 | 113.01 |
| 1644 | 88.98 | 444.20 | 28.05 | 560.84 | 126.28 |
| 4373 | 83.62 | 166.60 | 16.69 | 133.42 | 26.68 |
| 13610 | 82.68 | 257.86 | 38.84 | 365.13 | 107.29 |
| 8599 | 86.17 | 222.32 | 55.03 | 389.47 | 116.57 |
| 3870 | 84.58 | 91.07 | 23.43 | 152.03 | 56.60 |
| 3465 | 82.92 | 173.23 | 36.47 | 263.26 | 79.05 |
| 2191 | 83.36 | 42.32 | 13.37 | 22.22 | 8.81 |
| 22783 | 83.50 | 566.84 | 84.58 | 347.17 | 212.46 |
| 15303 | 85.43 | 68.69 | 8.52 | 95.79 | 28.70 |
| 22386 | 86.89 | 148.02 | 26.48 | 252.07 | 98.25 |
| 11653 | 92.35 | 269.88 | 75.12 | 561.59 | 194.36 |
| 18447 | 89.54 | 602.70 | 133.92 | 1098.88 | 276.35 |
| 14410 | 89.40 | 133.78 | 15.12 | 184.02 | 38.17 |
| 18285 | 94.66 | 425.99 | 37.64 | 688.90 | 152.65 |
| 17363 | 88.40 | 836.27 | 72.73 | 1036.86 | 193.05 |
| 2282 | 91.08 | 90.03 | 26.05 | 212.24 | 65.58 |
| 24233 | 90.10 | 411.31 | 46.44 | 567.75 | 108.66 |
| 2964 | 89.74 | 207.16 | 29.50 | 295.32 | 59.24 |
| 3407 | 88.84 | 48.51 | 16.65 | 22.82 | 14.74 |
| 26133 | 90.48 | 395.06 | 106.85 | 188.25 | 84.91 |
| 21105 | 93.53 | 188.56 | 23.10 | 300.96 | 60.90 |
| 2912 | 90.60 | 1472.50 | 191.19 | 2440.94 | 597.53 |
| 15904 | 89.80 | 81.53 | 10.99 | 56.69 | 23.58 |
| 11326 | 90.95 | 191.68 | 30.66 | 319.99 | 87.52 |
| 7825 | 89.05 | 120.48 | 23.58 | 70.06 | 27.39 |
| 5430 | 89.98 | 60.14 | 21.49 | 135.42 | 58.52 |
| 26173 | 90.08 | 265.60 | 25.65 | 171.81 | 48.30 |
| 10069 | 89.56 | 267.84 | 30.41 | 197.01 | 47.53 |
| 8944 | 89.19 | 61.50 | 9.22 | 40.45 | 16.66 |
| 22929 | 89.40 | 330.05 | 142.49 | 797.70 | 312.82 |
| 11075 | 88.93 | 99.43 | 19.68 | 58.88 | 21.11 |
| 10849 | 90.74 | 108.53 | 15.45 | 73.98 | 26.10 |
| 19930 | 89.51 | 49.33 | 6.03 | 28.71 | 11.78 |
| 11198 | 90.47 | 66.09 | 9.13 | 43.72 | 15.80 |
| 12945 | 89.02 | 168.30 | 33.30 | 289.09 | 69.55 |
| 13020 | 89.44 | 111.03 | 18.18 | 74.64 | 23.70 |
| 9504 | 93.05 | 71.31 | 11.15 | 48.44 | 20.69 |
| 2264 | 91.41 | 134.06 | 11.12 | 101.59 | 24.28 |
| 165 | 90.11 | 145.31 | 43.89 | 58.63 | 36.81 |
| 5531 | 88.65 | 41.41 | 2.58 | 32.86 | 11.29 |
| 18522 | 94.29 | 477.42 | 63.58 | 759.42 | 194.18 |
| 1649 | 90.83 | 363.72 | 54.17 | 561.87 | 156.83 |
| 22271 | 91.08 | 114.39 | 43.35 | 247.46 | 57.55 |
| 16887 | 89.89 | 107.51 | 10.43 | 154.97 | 45.52 |
| 21253 | 88.40 | 346.51 | 35.62 | 476.31 | 102.82 |
| 23748 | 89.13 | 67.98 | 29.82 | 154.15 | 63.22 |
| 11618 | 90.72 | 179.78 | 41.87 | 381.46 | 109.96 |
| 24165 | 88.10 | 119.54 | 15.30 | 72.25 | 33.85 |
| 3279 | 91.44 | 394.77 | 37.63 | 552.89 | 119.12 |
| 11232 | 90.98 | 413.94 | 45.20 | 291.89 | 76.35 |
| 22985 | 89.78 | 61.31 | 12.25 | 109.17 | 29.50 |
| 6630 | 89.22 | 1020.91 | 101.07 | 1270.63 | 199.90 |
| 11968 | 88.75 | 161.58 | 45.48 | 277.70 | 74.95 |
| 13457 | 90.47 | 108.45 | 8.39 | 75.26 | 26.79 |
| 14978 | 90.59 | 115.74 | 17.67 | 69.00 | 30.46 |
| 4987 | 89.86 | 161.07 | 15.62 | 234.26 | 58.10 |
| 150 | 89.74 | 44.55 | 4.99 | 31.82 | 9.68 |
| 12684 | 89.68 | 216.15 | 19.77 | 153.61 | 44.73 |
| 17833 | 88.80 | 178.08 | 13.51 | 132.77 | 41.58 |
| 13611 | 90.71 | 141.12 | 35.24 | 249.73 | 83.52 |
| 6886 | 88.66 | 74.86 | 18.86 | 44.24 | 15.63 |
| 9035 | 88.25 | 93.11 | 9.82 | 126.24 | 27.10 |
| 11866 | 88.65 | 193.70 | 21.24 | 133.49 | 72.18 |

TABLE 5G
VANCOMYCIN

Atty. Docket No. GENE-077/26US
Doc. No. 44941

| | | | Tox | Non-Tax | Non-Tax |
|---|---|---|---|---|---|
| GLGC | | Tox Group | Group | Group | Group |
| Identifier | LDA Score | Mean | SD | Mean | SD |
| 15132 | 97.42 | 556.28 | 65.10 | 314.76 | 79.74 |
| 15955 | 97.18 | 283.29 | 93.14 | 689.98 | 159.09 |
| 14677 | 97.45 | 165.57 | 17.88 | 69.76 | 30.34 |
| 15004 | 98.30 | 770.01 | 324.95 | 154.94 | 147.16 |
| 7307 | 97.18 | 92.05 | 30.06 | 28.29 | 16.83 |
| 5208 | 96.88 | 256.89 | 147.95 | 977.27 | 392.75 |
| 17361 | 96.18 | 28.93 | 11.40 | 138.07 | 55.62 |
| 6614 | 96.21 | 183.60 | 64.33 | 438.27 | 117.69 |
| 6405 | 95.90 | 202.88 | 43.49 | 403.99 | 105.10 |
| 21078 | 95.42 | 318.58 | 74.48 | 629.47 | 142.80 |
| 20716 | 94.54 | 407.31 | 96.00 | 723.45 | 165.86 |
| 20886 | 93.62 | 80.08 | 149.92 | 801.44 | 315.41 |
| 20887 | 93.22 | 168.32 | 177.62 | 874.64 | 339.69 |
| 15662 | 97.06 | 163.93 | 19.51 | 93.95 | 27.11 |
| 10015 | 98.18 | 563.53 | 77.79 | 229.49 | 80.02 |
| 10016 | 97.79 | 518.59 | 107.36 | 208.97 | 79.42 |
| 16350 | 97.91 | 140.55 | 45.36 | 43.66 | 26.40 |
| 16351 | 93.86 | 224.63 | 88.04 | 65.23 | 32.31 |
| 18453 | 93.28 | 88.03 | 19.21 | 218.34 | 72.82 |
| 472 | 99.03 | 243.72 | 82.34 | 732.71 | 178.26 |
| 28 | 95.42 | 145.06 | 98.13 | 532.55 | 178.76 |
| 18750 | 96.91 | 341.14 | 53.21 | 168.24 | 62.25 |
| 968 | 95.78 | 29.31 | 9.99 | 81.27 | 22.89 |
| 17159 | 93.07 | 1527.58 | 315.26 | 787.22 | 213.24 |
| 574 | 98.51 | 1391.19 | 255.85 | 347.01 | 165.41 |
| 25415 | 96.36 | 32.48 | 27.25 | 161.84 | 72.36 |
| 25419 | 96.81 | 31.08 | 22.07 | 149.42 | 67.18 |
| 25467 | 95.21 | 320.12 | 106.53 | 737.06 | 245.44 |
| 5838 | 97.36 | 301.27 | 68.21 | 652.99 | 143.93 |
| 7196 | 93.65 | 574.19 | 128.31 | 176.23 | 87.09 |
| 15135 | 96.00 | 1256.66 | 187.64 | 774.12 | 176.10 |
| 3430 | 92.98 | 1105.90 | 415.94 | 451.02 | 154.70 |
| 1546 | 94.36 | 122.71 | 35.02 | 244.53 | 64.28 |
| 22675 | 98.67 | 118.93 | 55.69 | 28.15 | 15.37 |
| 1551 | 97.57 | 44.36 | 13.06 | 122.96 | 105.41 |
| 20884 | 97.39 | 71.11 | 94.30 | 738.14 | 289.89 |
| 20810 | 94.99 | 2328.92 | 400.59 | 1448.17 | 356.77 |
| 15653 | 94.60 | 1852.53 | 268.29 | 1284.72 | 282.04 |
| 25691 | 92.89 | 1341.48 | 251.62 | 775.97 | 169.40 |
| 20848 | 97.57 | 1070.75 | 145.58 | 548.58 | 158.87 |
| 25702 | 97.97 | 1078.58 | 151.22 | 623.33 | 125.71 |
| 10109 | 97.82 | 1679.00 | 1324.10 | 1190.54 | 238.15 |
| 25718 | 93.13 | 683.37 | 89.19 | 419.94 | 86.09 |
| 4441 | 96.54 | 1550.03 | 172.22 | 1061.96 | 187.57 |
| 13646 | 97.06 | 1401.63 | 217.84 | 815.38 | 181.16 |
| 19824 | 96.75 | 72.58 | 25.39 | 216.05 | 72.84 |
| 25802 | 96.54 | 845.70 | 105.36 | 521.07 | 117.59 |
| 16245 | 97.42 | 69.92 | 89.96 | 412.35 | 124.91 |
| 24770 | 94.57 | 60.89 | 37.80 | 244.14 | 106.68 |
| 457 | 94.10 | 658.43 | 132.04 | 285.53 | 94.14 |
| 19679 | 97.03 | 257.82 | 106.61 | 757.15 | 199.62 |
| 19943 | 95.78 | 148.72 | 40.47 | 367.33 | 115.68 |
| 16150 | 95.51 | 274.61 | 48.72 | 520.97 | 135.92 |
| 1809 | 93.44 | 275.58 | 89.54 | 34.04 | 133.49 |
| 645 | 97.85 | 22.16 | 19.08 | 135.98 | 49.42 |
| 21950 | 94.42 | 493.04 | 82.54 | 812.67 | 152.27 |
| 1501 | 93.65 | 224.82 | 95.99 | 51.78 | 53.84 |
| 4449 | 94.72 | 115.32 | 31.26 | 243.54 | 69.77 |
| 15002 | 98.27 | 571.32 | 171.32 | 133.34 | 101.38 |
| 15003 | 98.33 | 454.25 | 157.22 | 31.60 | 90.05 |
| 2109 | 93.19 | 1476.03 | 210.52 | 911.33 | 166.60 |
| 7197 | 92.89 | 474.21 | 129.15 | 188.31 | 86.11 |
| 1462 | 93.19 | 954.56 | 196.88 | 432.34 | 223.37 |
| 17198 | 94.10 | 174.10 | 183.51 | 910.03 | 269.39 |
| 16726 | 93.28 | 486.85 | 132.99 | 1061.35 | 225.30 |
| 17807 | 97.06 | 1436.26 | 188.44 | 842.88 | 218.96 |
| 17357 | 97.12 | 50.26 | 40.35 | 270.21 | 95.37 |
| 23651 | 97.51 | 3310.38 | 741.12 | 733.68 | 659.72 |
| 20885 | 97.75 | 86.92 | 67.69 | 590.89 | 224.65 |
| 24563 | 94.16 | 24.77 | 36.61 | 322.32 | 110.47 |
| 24564 | 94.35 | 97.01 | 57.45 | 615.45 | 190.61 |
| 17104 | 93.04 | 855.38 | 133.20 | 481.52 | 111.05 |
| 19040 | 93.71 | 706.16 | 170.63 | 181.75 | 113.25 |
| 20816 | 98.12 | 1222.71 | 372.23 | 405.88 | 177.08 |
| 1549 | 94.54 | 114.38 | 21.37 | 201.87 | 48.01 |
| 18629 | 95.30 | 1002.30 | 147.79 | 653.52 | 144.64 |
| 20481 | 97.51 | 104.65 | 12.92 | 201.59 | 40.93 |
| 1463 | 93.38 | 1519.27 | 270.01 | 664.00 | 313.79 |
| 20849 | 93.47 | 566.69 | 140.91 | 281.36 | 87.91 |
| 16204 | 96.97 | 1384.43 | 194.54 | 865.08 | 172.51 |
| 16929 | 96.69 | 1743.43 | 228.03 | 1095.03 | 207.82 |
| 17401 | 93.04 | 2406.67 | 718.29 | 1005.70 | 409.58 |
| 23854 | 93.04 | 1043.25 | 158.05 | 521.42 | 171.16 |
| 646 | 98.30 | 83.09 | 64.74 | 528.44 | 191.02 |
| 1993 | 93.77 | 93.20 | 19.75 | 23.92 | 17.40 |
| 11849 | 96.69 | 1317.16 | 211.89 | 773.90 | 177.28 |
| 1141 | 96.60 | 436.63 | 69.87 | 241.00 | 65.86 |
| 1422 | 97.39 | 102.77 | 18.65 | 300.99 | 104.53 |
| 1508 | 95.33 | 269.31 | 91.76 | 654.52 | 194.51 |
| 17284 | 96.30 | 121.14 | 16.57 | 218.48 | 58.98 |
| 22321 | 97.54 | 321.53 | 86.82 | 93.58 | 65.67 |
| 18502 | 93.98 | 124.08 | 73.30 | 765.24 | 269.62 |
| 4327 | 97.66 | 213.79 | 52.87 | 82.05 | 36.57 |
| 7489 | 93.33 | 22.54 | 9.10 | 72.97 | 31.20 |
| 1382 | 96.51 | 90.08 | 11.91 | 49.24 | 15.74 |
| 1564 | 98.51 | 924.30 | 353.42 | 42.69 | 192.73 |
| 2465 | 95.39 | 67.67 | 23.37 | 131.86 | 26.71 |
| 23961 | 97.00 | 451.82 | 79.40 | 786.13 | 150.14 |
| 4360 | 96.45 | 162.70 | 43.83 | 333.15 | 72.47 |
| 13647 | 96.15 | 1685.74 | 240.33 | 965.67 | 279.68 |
| 19768 | 92.92 | 1379.96 | 280.91 | 786.38 | 167.89 |
| 21695 | 93.92 | 142.04 | 27.58 | 49.80 | 30.26 |
| 15876 | 97.45 | 2120.60 | 249.97 | 1361.28 | 237.57 |
| 3870 | 93.84 | 56.07 | 22.14 | 152.24 | 56.26 |
| 17325 | 98.06 | 566.28 | 234.26 | 55.28 | 99.39 |
| 18751 | 97.72 | 1011.52 | 204.86 | 514.43 | 129.28 |
| 21509 | 97.18 | 356.98 | 61.72 | 91.05 | 94.62 |
| 6039 | 97.88 | 656.26 | 129.35 | 309.49 | 76.09 |
| 12332 | 96.54 | 184.06 | 71.27 | 549.08 | 160.38 |
| 23093 | 96.03 | 106.37 | 12.36 | 186.37 | 43.33 |
| 17514 | 96.57 | 454.63 | 81.01 | 818.94 | 186.75 |
| 23758 | 95.45 | 88.49 | 20.75 | 175.01 | 41.28 |
| 3069 | 95.27 | 95.79 | 24.02 | 181.96 | 42.00 |
| 3121 | 96.09 | 495.24 | 184.53 | 1291.00 | 320.21 |
| 22592 | 98.27 | 1074.58 | 313.00 | 224.39 | 160.59 |
| 7964 | 96.81 | 121.19 | 45.58 | 325.72 | 93.20 |
| 21797 | 97.79 | 751.43 | 151.51 | 331.28 | 105.33 |
| 24211 | 97.63 | 363.77 | 83.59 | 128.82 | 74.63 |
| 3610 | 95.33 | 430.67 | 215.13 | 1122.89 | 327.90 |
| 18503 | 97.69 | 87.10 | 55.82 | 769.37 | 319.53 |
| 2125 | 96.27 | 190.48 | 54.94 | 69.66 | 70.52 |
| 4856 | 97.51 | 225.36 | 26.28 | 113.64 | 35.44 |
| 10983 | 98.15 | 26.59 | 14.05 | 150.11 | 58.58 |
| 5199 | 95.57 | 231.08 | 78.06 | 560.22 | 167.42 |
| 10839 | 97.69 | 522.43 | 88.99 | 296.05 | 56.93 |
| 14929 | 98.12 | 2704.92 | 750.05 | 750.97 | 385.07 |
| 736 | 97.15 | 1042.03 | 152.24 | 635.04 | 130.62 |
| 11205 | 97.54 | 218.47 | 59.26 | 555.88 | 160.64 |
| 4445 | 96.39 | 803.11 | 134.14 | 477.79 | 96.26 |
| 20873 | 96.03 | 3443.13 | 613.84 | 2121.19 | 488.68 |
| 3834 | 96.75 | 132.71 | 15.15 | 223.31 | 50.13 |
| 19188 | 97.42 | 527.70 | 117.58 | 1311.37 | 331.19 |
| 18612 | 96.69 | 212.66 | 25.56 | 128.14 | 27.31 |
| 24108 | 96.54 | 257.44 | 35.85 | 149.90 | 36.24 |

TABLE 5H
S2

Atty. Docket No: GENE-077/26US
Doc. No. 44941

| | | | Tox | Non-Tox | Non-Tox |
|---|---|---|---|---|---|
| GLGC | | Tox Group | Group | Group | Group |
| Identifier | LDA Score | Mean | SD | Mean | SD |
| 15171 | 84.95 | 419.71 | 164.49 | 224.19 | 79.03 |
| 3816 | 85.24 | 464.69 | 118.27 | 309.23 | 67.90 |
| 26319 | 82.82 | 76.87 | 13.91 | 48.99 | 22.63 |
| 3091 | 81.96 | 479.65 | 112.26 | 714.58 | 157.74 |
| 352 | 82.73 | 127.68 | 32.93 | 81.40 | 54.77 |
| 1698 | 95.69 | 476.04 | 217.52 | 66.29 | 80.81 |
| 4392 | 80.03 | 3259.52 | 1607.18 | 2948.56 | 850.63 |
| 18259 | 83.24 | 519.34 | 278.97 | 208.74 | 145.33 |
| 19252 | 88.05 | 1076.93 | 223.42 | 699.29 | 132.43 |
| 15295 | 81.48 | 211.13 | 62.16 | 133.01 | 44.12 |
| 15296 | 81.36 | 211.59 | 76.79 | 126.72 | 51.34 |
| 20795 | 89.27 | 395.60 | 169.67 | 145.49 | 73.47 |
| 22352 | 86.44 | 284.98 | 97.78 | 147.56 | 105.44 |
| 22625 | 82.55 | 203.73 | 89.37 | 109.20 | 101.37 |
| 11840 | 85.36 | 122.01 | 37.49 | 67.99 | 20.17 |
| 20801 | 80.66 | 227.27 | 55.54 | 150.06 | 48.38 |
| 353 | 88.14 | 319.61 | 99.94 | 169.89 | 88.77 |
| 354 | 85.33 | 388.15 | 110.75 | 216.19 | 104.30 |
| 11755 | 86.73 | 376.55 | 164.92 | 141.89 | 130.13 |
| 17736 | 80.81 | 182.31 | 146.86 | 69.27 | 157.44 |
| 17541 | 92.42 | 1949.27 | 848.82 | 715.92 | 315.92 |
| 1537 | 90.76 | 257.23 | 167.48 | 25.97 | 54.59 |
| 1399 | 87.58 | 525.84 | 225.50 | 194.83 | 76.18 |
| 25064 | 80.28 | 2074.70 | 700.66 | 1115.73 | 310.65 |
| 25069 | 90.61 | 345.14 | 130.65 | 122.58 | 64.89 |
| 14346 | 81.56 | 203.45 | 102.23 | 50.68 | 82.80 |
| 14633 | 85.60 | 234.78 | 89.03 | 88.80 | 83.21 |
| 14347 | 85.85 | 400.13 | 169.40 | 165.49 | 124.98 |
| 25098 | 79.90 | 93.64 | 67.91 | 36.16 | 34.64 |
| 19433 | 81.22 | 249.89 | 135.26 | 95.01 | 61.36 |
| 15750 | 79.71 | 47.36 | 18.14 | 21.51 | 14.89 |
| 18300 | 79.97 | 206.84 | 132.88 | 487.38 | 169.27 |
| 25253 | 80.87 | 356.00 | 58.62 | 290.00 | 68.77 |
| 22412 | 80.58 | 140.47 | 30.74 | 91.22 | 45.78 |
| 22413 | 81.99 | 109.06 | 23.31 | 68.44 | 38.34 |
| 15069 | 82.45 | 156.30 | 69.08 | 89.93 | 53.08 |
| 18990 | 90.28 | 86.48 | 40.00 | 20.60 | 20.74 |
| 15470 | 81.55 | 446.71 | 86.23 | 334.66 | 93.68 |
| 4956 | 81.16 | 164.38 | 98.90 | 69.29 | 29.02 |
| 12978 | 81.88 | 178.61 | 68.70 | 96.11 | 47.83 |
| 24484 | 80.31 | 66.39 | 12.02 | 92.42 | 26.08 |
| 18011 | 80.90 | 67.94 | 34.59 | 27.48 | 28.90 |
| 1439 | 81.65 | 147.91 | 28.34 | 225.64 | 53.27 |
| 25902 | 82.59 | 112.19 | 22.14 | 159.55 | 48.13 |
| 20082 | 81.87 | 91.12 | 20.35 | 66.30 | 28.33 |
| 14970 | 86.63 | 129.68 | 33.81 | 200.04 | 40.68 |
| 20802 | 87.50 | 435.04 | 93.17 | 244.10 | 82.49 |
| 3016 | 80.37 | 4148.89 | 2854.50 | 3998.79 | 1813.37 |
| 4235 | 82.01 | 583.10 | 107.05 | 411.30 | 95.75 |
| 8211 | 81.93 | 3918.21 | 2663.36 | 3502.10 | 1459.77 |
| 16726 | 82.61 | 775.42 | 171.63 | 1060.46 | 228.56 |
| 20841 | 81.92 | 143.31 | 33.78 | 95.74 | 25.14 |
| 18449 | 80.81 | 729.28 | 116.57 | 610.20 | 123.99 |
| 24900 | 79.96 | 488.04 | 143.15 | 638.38 | 155.04 |
| 20443 | 81.46 | 161.56 | 35.20 | 113.93 | 27.53 |
| 20803 | 91.23 | 799.85 | 172.29 | 470.96 | 121.12 |
| 1558 | 81.39 | 321.49 | 76.64 | 200.81 | 63.40 |
| 405 | 83.80 | 132.67 | 34.34 | 208.32 | 63.52 |
| 21239 | 80.43 | 229.76 | 97.82 | 106.28 | 59.82 |
| 1410 | 83.60 | 34.40 | 19.24 | 89.22 | 43.41 |
| 21147 | 79.81 | 268.70 | 99.55 | 361.28 | 80.70 |
| 15032 | 81.33 | 183.52 | 59.26 | 265.32 | 74.21 |
| 21038 | 86.52 | 242.02 | 70.96 | 103.82 | 41.91 |
| 21039 | 86.46 | 195.33 | 59.92 | 78.33 | 43.60 |
| 18597 | 80.46 | 1089.16 | 347.96 | 559.47 | 193.08 |
| 19254 | 93.32 | 450.27 | 111.28 | 243.51 | 70.21 |
| 4592 | 80.90 | 249.94 | 54.72 | 177.09 | 36.45 |
| 24377 | 81.36 | 145.34 | 38.16 | 203.71 | 49.55 |
| 15574 | 80.39 | 173.01 | 25.25 | 215.63 | 33.89 |
| 24033 | 81.42 | 259.06 | 80.18 | 347.59 | 75.37 |
| 24235 | 84.25 | 1152.14 | 527.92 | 473.62 | 203.30 |
| 13609 | 89.08 | 127.39 | 51.22 | 239.16 | 63.31 |
| 13610 | 85.29 | 239.35 | 63.10 | 365.74 | 106.91 |
| 12848 | 83.34 | 297.78 | 63.29 | 431.68 | 92.39 |
| 21305 | 80.36 | 272.12 | 81.64 | 438.75 | 129.17 |
| 18967 | 80.39 | 337.68 | 55.22 | 487.47 | 203.79 |
| 2979 | 81.44 | 245.69 | 57.16 | 282.97 | 42.84 |
| 18396 | 83.12 | 111.98 | 44.34 | 66.03 | 26.28 |
| 16039 | 82.15 | 697.44 | 191.99 | 482.12 | 97.81 |
| 2924 | 82.14 | 213.38 | 38.03 | 154.90 | 50.18 |
| 13349 | 81.88 | 200.63 | 47.75 | 132.83 | 38.04 |
| 3822 | 83.20 | 1346.58 | 265.08 | 925.26 | 284.34 |
| 22501 | 84.65 | 492.96 | 180.94 | 251.35 | 55.90 |
| 26083 | 82.21 | 1826.66 | 491.08 | 1187.90 | 721.09 |
| 22656 | 82.26 | 199.64 | 38.98 | 123.05 | 53.17 |
| 12331 | 83.65 | 391.83 | 107.95 | 591.12 | 141.29 |
| 24192 | 87.16 | 197.41 | 91.63 | 74.59 | 46.05 |
| 4944 | 86.29 | 211.24 | 47.96 | 119.87 | 58.35 |
| 21513 | 83.49 | 75.92 | 24.74 | 120.24 | 29.73 |
| 23314 | 85.33 | 562.77 | 365.79 | 72.82 | 278.18 |
| 24246 | 83.14 | 450.51 | 118.31 | 305.90 | 95.78 |
| 3053 | 83.04 | 154.60 | 38.76 | 96.88 | 33.21 |
| 20035 | 86.06 | 430.87 | 178.90 | 180.79 | 99.78 |
| 23917 | 92.66 | 1506.66 | 499.29 | 718.95 | 184.83 |
| 22414 | 82.49 | 91.38 | 20.25 | 62.37 | 32.42 |
| 21632 | 83.14 | 122.74 | 47.18 | 31.65 | 49.47 |
| 20804 | 87.44 | 1875.82 | 427.00 | 1059.53 | 324.98 |
| 2242 | 86.21 | 1439.71 | 469.38 | 2188.97 | 546.30 |
| 20086 | 82.52 | 270.19 | 119.18 | 107.78 | 72.84 |
| 22502 | 85.39 | 158.92 | 82.43 | 53.23 | 48.19 |
| 12812 | 85.49 | 52.00 | 16.73 | 97.11 | 34.86 |
| 8283 | 82.11 | 273.51 | 122.40 | 128.67 | 44.94 |
| 8820 | 84.40 | 597.48 | 343.99 | 137.31 | 114.55 |
| 16718 | 83.02 | 771.65 | 152.36 | 1131.02 | 291.60 |
| 2059 | 87.00 | 193.67 | 24.25 | 136.36 | 35.16 |
| 12979 | 82.91 | 827.72 | 363.04 | 363.63 | 189.87 |
| 17850 | 82.65 | 478.49 | 74.33 | 350.42 | 68.02 |
| 6014 | 89.18 | 250.89 | 107.92 | 79.07 | 39.75 |
| 11429 | 83.43 | 212.12 | 34.36 | 269.26 | 41.65 |
| 15382 | 82.29 | 978.24 | 634.06 | 120.29 | 179.44 |
| 5863 | 84.29 | 88.93 | 23.67 | 139.47 | 34.68 |
| 15964 | 85.54 | 674.79 | 216.85 | 1091.41 | 285.42 |
| 19184 | 82.21 | 185.49 | 78.89 | 78.67 | 75.04 |
| 22197 | 83.56 | 181.41 | 38.36 | 111.12 | 43.86 |
| 13611 | 82.20 | 130.10 | 78.13 | 250.25 | 82.89 |
| 13607 | 82.37 | 34.94 | 7.53 | 22.53 | 9.86 |
| 6765 | 82.55 | 507.81 | 142.81 | 730.21 | 168.95 |
| 1651 | 81.95 | 628.76 | 65.78 | 789.11 | 181.29 |
| 17892 | 83.55 | 153.95 | 40.92 | 306.40 | 134.74 |
| 23435 | 82.42 | 143.51 | 70.04 | 32.23 | 45.61 |
| 20895 | 83.42 | 188.70 | 90.22 | 303.22 | 74.58 |

TABLE 5I
TUBULAR TOXICITY

Atty. Docket No. GENE-077/26US
Doc. No. 44941

| | | | Tox | Non-Tox | Non-Tox |
|---|---|---|---|---|---|
| GLGC | | Tox Group | Group | Group | Group |
| Identifier | LDA Score | Mean | SD | Mean | SD |
| 15955 | 74.37 | 490.57 | 195.79 | 701.12 | 150.24 |
| 5601 | 80.41 | 570.05 | 236.57 | 903.71 | 216.83 |
| 4440 | 73.83 | 195.43 | 69.44 | 295.13 | 82.26 |
| 14095 | 74.13 | 270.72 | 76.14 | 358.04 | 71.36 |
| 6046 | 74.40 | 135.01 | 56.88 | 197.57 | 60.74 |
| 11164 | 74.38 | 332.33 | 139.83 | 485.92 | 129.73 |
| 3091 | 76.77 | 535.18 | 168.51 | 724.55 | 150.86 |
| 3467 | 73.54 | 461.68 | 163.07 | 646.99 | 168.60 |
| 16314 | 75.54 | 110.20 | 71.12 | 41.23 | 39.76 |
| 18272 | 75.77 | 134.16 | 52.28 | 179.70 | 40.85 |
| 1698 | 76.15 | 259.77 | 253.73 | 57.45 | 46.82 |
| 15295 | 71.74 | 190.57 | 76.92 | 129.84 | 38.91 |
| 15296 | 72.54 | 195.64 | 91.33 | 122.82 | 44.73 |
| 17734 | 71.52 | 279.85 | 275.77 | 104.11 | 64.03 |
| 11840 | 71.83 | 96.37 | 36.59 | 66.61 | 18.13 |
| 15701 | 71.80 | 47.52 | 19.49 | 30.00 | 11.38 |
| 20801 | 73.86 | 215.55 | 69.25 | 146.31 | 43.89 |
| 353 | 72.64 | 298.13 | 157.91 | 162.53 | 75.73 |
| 354 | 72.87 | 373.67 | 185.53 | 207.02 | 87.88 |
| 17541 | 71.55 | 1248.41 | 894.94 | 692.89 | 234.54 |
| 1399 | 72.16 | 341.24 | 183.76 | 188.40 | 64.08 |
| 17301 | 71.34 | 325.89 | 119.33 | 233.24 | 70.86 |
| 20161 | 73.64 | 80.23 | 54.25 | 29.99 | 27.33 |
| 18300 | 72.65 | 285.09 | 167.97 | 498.43 | 162.68 |
| 11483 | 71.74 | 141.85 | 116.98 | 51.93 | 39.61 |
| 25198 | 72.83 | 49.29 | 21.40 | 25.88 | 13.23 |
| 2555 | 74.79 | 134.28 | 53.66 | 81.97 | 40.03 |
| 28 | 77.64 | 315.43 | 178.66 | 545.11 | 171.54 |
| 20458 | 74.64 | 271.25 | 94.25 | 374.56 | 94.29 |
| 20298 | 71.28 | 409.64 | 131.62 | 556.86 | 153.30 |
| 1460 | 73.32 | 302.66 | 131.64 | 185.02 | 73.88 |
| 14121 | 71.92 | 492.14 | 155.94 | 350.47 | 102.93 |
| 25567 | 71.99 | 715.87 | 268.63 | 465.90 | 181.93 |
| 3430 | 71.70 | 651.98 | 230.79 | 441.70 | 152.47 |
| 24234 | 72.61 | 391.71 | 269.60 | 175.87 | 68.56 |
| 16012 | 71.84 | 101.22 | 49.06 | 62.06 | 26.39 |
| 12978 | 71.54 | 152.96 | 71.09 | 93.05 | 44.29 |
| 25777 | 71.29 | 882.80 | 556.03 | 413.32 | 182.36 |
| 10887 | 75.63 | 42.57 | 19.85 | 65.79 | 22.04 |
| 24496 | 76.32 | 72.15 | 40.14 | 113.67 | 35.59 |
| 24770 | 71.76 | 149.41 | 95.43 | 249.51 | 105.16 |
| 18000 | 72.20 | 1021.88 | 441.49 | 1515.83 | 541.89 |
| 794 | 71.77 | 143.65 | 62.53 | 212.58 | 63.38 |
| 811 | 73.98 | 180.08 | 66.32 | 257.46 | 56.05 |
| 812 | 76.93 | 105.28 | 36.08 | 153.16 | 36.80 |
| 15330 | 73.67 | 58.68 | 23.74 | 83.24 | 23.75 |
| 19679 | 76.55 | 499.67 | 216.56 | 771.74 | 190.03 |
| 20082 | 73.54 | 102.09 | 38.64 | 64.04 | 25.68 |
| 20056 | 71.66 | 246.08 | 95.02 | 318.69 | 67.21 |
| 14970 | 76.36 | 144.83 | 50.08 | 203.14 | 37.69 |
| 15110 | 73.25 | 505.21 | 179.79 | 713.50 | 178.30 |
| 17684 | 71.81 | 170.05 | 66.05 | 237.48 | 55.17 |
| 15299 | 75.82 | 120.11 | 57.11 | 72.50 | 54.88 |
| 15050 | 73.63 | 541.66 | 141.16 | 688.65 | 174.84 |
| 17196 | 71.36 | 99.85 | 27.32 | 128.69 | 24.41 |
| 15039 | 73.52 | 177.90 | 93.67 | 278.20 | 88.82 |
| 409 | 73.83 | 746.67 | 188.60 | 947.21 | 178.98 |
| 16726 | 72.69 | 800.41 | 280.17 | 1075.60 | 214.53 |
| 17357 | 71.23 | 178.34 | 104.23 | 275.09 | 93.07 |
| 15111 | 73.26 | 785.18 | 294.19 | 1118.72 | 264.03 |
| 15112 | 73.00 | 1338.19 | 433.49 | 1860.86 | 460.35 |
| 20803 | 71.57 | 629.95 | 256.03 | 463.60 | 103.39 |
| 20753 | 72.02 | 157.80 | 39.75 | 117.80 | 25.81 |
| 21654 | 75.86 | 551.82 | 178.12 | 366.37 | 116.43 |
| 6641 | 72.55 | 304.37 | 93.60 | 402.49 | 84.73 |
| 21239 | 75.09 | 197.82 | 98.17 | 101.23 | 52.71 |
| 16775 | 71.26 | 800.69 | 398.31 | 1188.38 | 388.39 |
| 1884 | 71.12 | 208.69 | 48.64 | 169.12 | 34.33 |
| 4198 | 72.64 | 603.75 | 177.10 | 780.82 | 177.13 |
| 21147 | 74.26 | 274.00 | 87.67 | 366.40 | 77.47 |
| 15986 | 73.46 | 214.52 | 95.30 | 326.69 | 83.60 |
| 15032 | 78.99 | 176.05 | 67.41 | 270.72 | 70.95 |
| 4327 | 72.45 | 133.62 | 67.44 | 79.38 | 32.50 |
| 21683 | 72.77 | 53.28 | 30.07 | 25.72 | 19.21 |
| 7489 | 75.92 | 37.03 | 20.90 | 75.16 | 30.46 |
| 7784 | 74.81 | 532.12 | 161.80 | 699.90 | 128.21 |
| 23961 | 71.60 | 644.10 | 203.09 | 793.72 | 143.04 |
| 1529 | 78.54 | 203.36 | 69.83 | 300.60 | 65.42 |
| 10464 | 72.19 | 90.84 | 30.16 | 122.79 | 30.91 |
| 4462 | 74.15 | 658.57 | 311.71 | 971.30 | 305.73 |
| 16312 | 76.70 | 108.77 | 62.22 | 45.54 | 31.63 |
| 7936 | 75.30 | 107.61 | 27.73 | 139.51 | 30.80 |
| 4360 | 74.46 | 253.43 | 81.01 | 337.54 | 69.89 |
| 5384 | 75.41 | 90.12 | 61.25 | 28.04 | 36.31 |
| 24235 | 72.19 | 833.55 | 457.25 | 456.15 | 168.02 |
| 17256 | 71.98 | 313.90 | 166.05 | 436.12 | 114.73 |
| 9905 | 73.49 | 576.55 | 180.69 | 755.53 | 145.11 |
| 18128 | 72.27 | 163.39 | 43.26 | 205.45 | 45.93 |
| 4463 | 74.19 | 86.69 | 63.34 | 154.87 | 56.17 |
| 1159 | 75.77 | 712.96 | 239.20 | 1011.11 | 211.67 |
| 4473 | 74.68 | 122.22 | 55.23 | 175.55 | 47.15 |
| 17682 | 78.29 | 507.13 | 211.81 | 773.82 | 172.62 |
| 13609 | 76.92 | 163.77 | 55.10 | 243.19 | 61.57 |
| 13610 | 78.86 | 260.43 | 88.06 | 371.73 | 104.73 |
| 18906 | 71.16 | 164.62 | 90.59 | 266.79 | 88.78 |
| 23783 | 72.45 | 376.37 | 89.08 | 460.99 | 76.97 |
| 9053 | 73.45 | 190.10 | 53.40 | 240.11 | 47.80 |
| 21305 | 73.82 | 298.39 | 90.29 | 446.76 | 126.64 |
| 12031 | 71.64 | 192.48 | 67.66 | 134.78 | 33.69 |
| 18396 | 72.13 | 106.40 | 55.73 | 63.70 | 20.92 |
| 18360 | 71.37 | 154.88 | 51.56 | 206.67 | 54.97 |
| 21341 | 73.57 | 463.05 | 136.52 | 620.74 | 147.68 |
| 13349 | 75.79 | 183.06 | 52.76 | 130.07 | 35.07 |
| 23005 | 75.72 | 694.34 | 270.62 | 901.12 | 190.44 |
| 22681 | 74.06 | 507.76 | 361.88 | 202.52 | 156.32 |
| 22554 | 75.51 | 387.64 | 139.23 | 544.84 | 133.65 |
| 22612 | 74.35 | 330.37 | 111.38 | 469.08 | 108.90 |
| 18337 | 76.16 | 1120.66 | 375.56 | 1593.01 | 326.83 |
| 21157 | 74.05 | 549.82 | 137.16 | 428.96 | 84.27 |
| 4944 | 80.39 | 210.32 | 80.95 | 114.51 | 51.54 |
| 23261 | 74.04 | 1121.37 | 378.88 | 1550.48 | 320.61 |
| 18271 | 74.07 | 587.16 | 201.63 | 753.02 | 149.78 |
| 23546 | 73.90 | 549.94 | 189.79 | 721.45 | 151.51 |
| 23314 | 77.31 | 506.68 | 414.87 | 47.74 | 245.21 |
| 2702 | 76.15 | 433.75 | 181.46 | 270.79 | 68.25 |
| 20694 | 76.61 | 688.47 | 220.38 | 933.57 | 204.17 |
| 23917 | 74.67 | 1098.72 | 458.70 | 701.40 | 145.27 |
| 21632 | 77.91 | 98.75 | 74.15 | 27.96 | 44.65 |
| 17524 | 77.19 | 794.19 | 308.69 | 1135.59 | 259.89 |
| 17550 | 77.50 | 879.01 | 298.17 | 1290.95 | 333.72 |
| 3995 | 74.45 | 447.64 | 135.49 | 615.34 | 139.51 |
| 2242 | 82.51 | 1386.39 | 557.25 | 2237.29 | 505.01 |
| 6674 | 74.54 | 1776.75 | 507.96 | 2387.57 | 539.31 |
| 3874 | 74.97 | 637.40 | 187.18 | 871.96 | 181.31 |
| 2370 | 74.04 | 876.31 | 227.54 | 1077.70 | 174.57 |
| 10818 | 76.28 | 251.30 | 167.92 | 480.32 | 177.62 |
| 17755 | 76.09 | 278.24 | 99.73 | 390.16 | 92.04 |
| 5900 | 74.94 | 205.87 | 72.79 | 265.10 | 54.52 |
| 8721 | 75.64 | 109.17 | 63.60 | 188.60 | 63.43 |
| 18792 | 73.60 | 98.71 | 33.22 | 136.87 | 36.34 |
| 9079 | 74.38 | 581.21 | 173.48 | 749.66 | 159.41 |
| 9673 | 74.72 | 35.38 | 16.35 | 65.52 | 26.97 |
| 9781 | 74.13 | 82.19 | 36.96 | 124.27 | 34.07 |
| 16813 | 73.61 | 231.75 | 81.80 | 331.59 | 80.11 |
| 11937 | 74.01 | 101.08 | 23.16 | 79.06 | 19.14 |
| 3610 | 78.84 | 722.35 | 368.53 | 1146.23 | 311.02 |
| 18522 | 74.81 | 548.81 | 212.63 | 772.15 | 185.03 |
| 5923 | 75.17 | 439.81 | 176.29 | 606.68 | 131.73 |
| 22101 | 73.80 | 85.02 | 82.10 | 175.65 | 80.50 |
| 11618 | 77.12 | 257.75 | 117.01 | 388.64 | 105.31 |
| 12979 | 73.96 | 632.88 | 317.40 | 350.02 | 172.71 |
| 16756 | 73.57 | 240.33 | 81.11 | 168.05 | 37.88 |
| 3916 | 75.59 | 472.89 | 195.40 | 675.96 | 140.94 |
| 10130 | 74.03 | 167.62 | 59.58 | 224.47 | 53.57 |
| 4291 | 74.22 | 180.51 | 91.51 | 288.32 | 84.88 |
| 10985 | 78.22 | 735.68 | 231.86 | 1069.30 | 225.65 |
| 5863 | 78.76 | 96.37 | 30.11 | 141.94 | 33.29 |
| 15964 | 77.61 | 745.68 | 276.40 | 1111.07 | 273.12 |
| 19184 | 75.15 | 190.82 | 119.94 | 71.94 | 64.87 |
| 22569 | 74.81 | 417.82 | 171.09 | 628.93 | 157.19 |
| 6765 | 74.29 | 544.27 | 202.38 | 740.81 | 159.94 |
| 23435 | 77.07 | 107.07 | 69.42 | 28.24 | 40.65 |
| 13618 | 74.08 | 137.35 | 40.63 | 99.14 | 26.21 |

TABLE 5J
GLOMERULAR INJURY

Atty. Docket No. GENE-078/06US
Doc. No. 44941

| | | | Tox | Non-Tox | Non-Tox |
|---|---|---|---|---|---|
| GLGC | | Tox Group | Group | Group | Group |
| Identifier | LDA Score | Mean | SD | Mean | SD |
| 1688 | 88.99 | 985.99 | 996.97 | 5062.79 | 2851.87 |
| 11967 | 83.98 | 1036.36 | 258.41 | 1617.83 | 495.77 |
| 11610 | 79.19 | 368.78 | 38.57 | 303.07 | 70.24 |
| 1689 | 82.61 | 1224.06 | 1215.72 | 4062.22 | 1648.08 |
| 3615 | 82.64 | 103.67 | 34.57 | 197.88 | 61.86 |
| 9391 | 80.47 | 668.60 | 95.16 | 863.78 | 204.49 |
| 16881 | 76.78 | 442.88 | 61.71 | 533.80 | 110.83 |
| 21302 | 76.45 | 175.69 | 45.11 | 245.52 | 73.79 |
| 4312 | 85.90 | 125.63 | 20.84 | 65.92 | 30.34 |
| 20864 | 84.41 | 1168.66 | 229.66 | 1938.09 | 636.48 |
| 20801 | 76.44 | 195.17 | 43.72 | 150.37 | 48.96 |
| 11136 | 78.76 | 832.19 | 153.81 | 1147.90 | 344.29 |
| 11137 | 76.72 | 1138.55 | 218.66 | 1635.07 | 463.88 |
| 20876 | 80.75 | 1429.42 | 179.01 | 2010.11 | 495.92 |
| 20713 | 79.77 | 321.28 | 83.43 | 211.11 | 121.91 |
| 494 | 84.50 | 1183.13 | 183.42 | 774.08 | 266.75 |
| 20714 | 80.11 | 251.69 | 65.33 | 169.88 | 95.99 |
| 1247 | 78.73 | 839.48 | 329.16 | 1582.78 | 517.89 |
| 495 | 81.45 | 270.73 | 74.76 | 127.48 | 87.19 |
| 21914 | 78.27 | 520.42 | 91.18 | 411.11 | 83.67 |
| 3454 | 77.15 | 100.75 | 18.92 | 75.51 | 30.81 |
| 4011 | 76.93 | 792.94 | 249.01 | 476.14 | 218.70 |
| 20741 | 80.44 | 223.50 | 26.65 | 175.19 | 43.80 |
| 3608 | 78.46 | 198.11 | 80.98 | 358.92 | 138.13 |
| 28 | 76.62 | 309.69 | 141.93 | 532.57 | 180.04 |
| 25290 | 76.53 | 233.26 | 73.75 | 140.64 | 55.93 |
| 108 | 76.86 | 612.75 | 314.84 | 275.19 | 150.60 |
| 25366 | 78.91 | 89.96 | 46.99 | 44.98 | 55.94 |
| 25468 | 90.11 | 657.58 | 614.46 | 2655.18 | 1078.33 |
| 25469 | 89.11 | 523.47 | 471.39 | 1875.13 | 750.57 |
| 4012 | 81.23 | 1137.93 | 352.70 | 702.11 | 303.50 |
| 14003 | 85.48 | 588.35 | 140.53 | 940.91 | 244.68 |
| 25550 | 81.11 | 130.44 | 21.18 | 99.94 | 23.47 |
| 1684 | 89.47 | 788.73 | 736.74 | 3493.87 | 1629.14 |
| 25705 | 78.67 | 608.91 | 95.39 | 477.51 | 114.34 |
| 24770 | 76.96 | 124.63 | 58.14 | 244.33 | 107.12 |
| 24843 | 80.63 | 1529.74 | 555.96 | 2719.25 | 1061.12 |
| 45 | 78.37 | 97.82 | 39.87 | 173.04 | 76.68 |
| 245 | 81.08 | 30.84 | 10.46 | 51.23 | 15.00 |
| 24821 | 82.27 | 34.36 | 7.77 | 54.32 | 19.77 |
| 1401 | 77.33 | 69.28 | 14.03 | 52.22 | 17.29 |
| 1962 | 78.25 | 44.77 | 12.65 | 26.15 | 23.39 |
| 1246 | 82.94 | 37.24 | 17.41 | 82.08 | 35.89 |
| 19112 | 83.49 | 227.09 | 41.26 | 162.45 | 41.41 |
| 21542 | 81.48 | 75.73 | 11.78 | 53.64 | 19.14 |
| 20082 | 86.48 | 84.34 | 9.94 | 66.36 | 28.45 |
| 15237 | 79.22 | 243.57 | 60.93 | 168.46 | 37.30 |
| 15299 | 77.05 | 115.51 | 45.17 | 75.17 | 56.24 |
| 15364 | 77.24 | 77.86 | 12.53 | 102.74 | 36.36 |
| 2812 | 79.92 | 250.95 | 52.91 | 182.78 | 42.75 |
| 15642 | 79.43 | 574.29 | 92.23 | 434.05 | 119.62 |
| 17829 | 92.65 | 759.68 | 633.86 | 2726.68 | 1360.50 |
| 573 | 77.61 | 1599.70 | 404.19 | 2608.86 | 1776.16 |
| 13004 | 78.85 | 174.31 | 28.36 | 131.55 | 40.25 |
| 23884 | 80.38 | 55.79 | 14.99 | 30.14 | 28.25 |
| 1312 | 79.31 | 877.80 | 98.92 | 1048.20 | 167.10 |
| 1844 | 79.43 | 215.94 | 40.20 | 163.57 | 52.46 |
| 17274 | 76.44 | 77.42 | 33.89 | 146.25 | 65.82 |
| 1553 | 81.63 | 1952.70 | 632.62 | 3812.62 | 1693.78 |
| 247 | 83.22 | 78.49 | 23.83 | 127.29 | 32.51 |
| 1542 | 83.19 | 741.70 | 151.84 | 1084.13 | 306.88 |
| 18354 | 76.71 | 704.94 | 297.65 | 400.28 | 242.40 |
| 15599 | 81.08 | 768.89 | 96.61 | 962.67 | 147.01 |
| 21575 | 77.78 | 452.86 | 97.04 | 333.22 | 68.32 |
| 4532 | 78.31 | 171.23 | 78.76 | 279.78 | 96.10 |
| 21147 | 77.30 | 282.41 | 67.81 | 361.22 | 81.20 |
| 19110 | 77.85 | 342.86 | 94.88 | 201.97 | 95.13 |
| 1515 | 77.63 | 246.92 | 46.18 | 186.59 | 43.06 |
| 18502 | 79.77 | 372.75 | 197.72 | 765.58 | 271.46 |
| 17154 | 77.24 | 245.45 | 57.67 | 186.78 | 60.02 |
| 7489 | 84.90 | 26.53 | 14.62 | 73.20 | 31.11 |
| 18468 | 81.39 | 106.55 | 21.07 | 77.98 | 27.23 |
| 16091 | 77.52 | 20.73 | 9.39 | 32.57 | 13.59 |
| 17693 | 78.46 | 1038.76 | 282.54 | 1505.15 | 387.40 |
| 15576 | 76.69 | 520.40 | 95.90 | 421.09 | 93.97 |
| 9073 | 77.63 | 44.73 | 15.30 | 22.89 | 18.48 |
| 17332 | 83.07 | 223.62 | 28.27 | 303.15 | 73.10 |
| 18887 | 76.75 | 165.20 | 20.55 | 143.02 | 37.45 |
| 16168 | 82.94 | 544.90 | 152.30 | 363.58 | 234.93 |
| 3886 | 76.75 | 74.47 | 22.33 | 42.38 | 20.96 |
| 19222 | 77.73 | 563.31 | 40.36 | 635.63 | 111.62 |
| 23505 | 81.63 | 790.51 | 196.75 | 566.19 | 124.65 |
| 21140 | 78.79 | 125.03 | 91.50 | 108.35 | 40.63 |
| 21766 | 83.55 | 202.85 | 35.26 | 284.66 | 63.71 |
| 21462 | 79.31 | 332.31 | 60.15 | 254.18 | 55.30 |
| 1685 | 85.14 | 1891.26 | 1942.12 | 8508.70 | 4812.11 |
| 6691 | 80.35 | 119.49 | 85.12 | 119.56 | 46.57 |
| 5129 | 85.32 | 88.98 | 34.42 | 179.18 | 56.59 |
| 20866 | 78.89 | 654.18 | 82.36 | 778.30 | 119.91 |
| 2702 | 80.11 | 352.18 | 62.63 | 280.79 | 90.45 |
| 24051 | 82.30 | 75.09 | 17.26 | 113.95 | 26.52 |
| 11324 | 79.74 | 567.08 | 75.40 | 686.26 | 133.81 |
| 21339 | 82.63 | 81.54 | 44.75 | 34.07 | 19.67 |
| 2782 | 79.00 | 413.70 | 142.88 | 205.21 | 80.64 |
| 24109 | 89.60 | 75.68 | 42.47 | 221.62 | 99.80 |
| 19358 | 80.77 | 230.36 | 276.27 | 811.89 | 308.44 |
| 16521 | 78.64 | 378.70 | 73.70 | 284.05 | 76.53 |
| 3941 | 80.35 | 312.71 | 52.90 | 243.38 | 62.94 |
| 17832 | 83.19 | 522.94 | 599.21 | 1979.69 | 796.76 |
| 2242 | 80.13 | 1529.47 | 425.16 | 2188.74 | 547.68 |
| 7278 | 83.62 | 1079.66 | 205.71 | 1408.78 | 288.29 |
| 7681 | 80.90 | 141.52 | 29.83 | 104.60 | 44.18 |
| 16169 | 84.14 | 336.78 | 145.47 | 178.83 | 293.41 |
| 12846 | 79.68 | 27.13 | 8.38 | 43.38 | 16.45 |
| 9439 | 79.37 | 715.53 | 238.18 | 1099.47 | 279.57 |
| 3713 | 80.93 | 785.80 | 153.20 | 1070.46 | 218.25 |
| 14638 | 80.72 | 103.18 | 17.90 | 77.40 | 20.36 |
| 3610 | 82.03 | 734.56 | 248.13 | 1122.80 | 330.52 |
| 17743 | 84.44 | 74.48 | 35.97 | 103.03 | 28.16 |
| 17234 | 80.44 | 450.62 | 66.65 | 591.69 | 138.75 |
| 20918 | 79.25 | 568.16 | 114.17 | 403.50 | 84.82 |
| 15393 | 81.33 | 222.37 | 28.91 | 286.78 | 51.31 |
| 4291 | 80.53 | 163.79 | 60.20 | 282.61 | 88.79 |
| 18681 | 81.30 | 388.94 | 53.06 | 282.82 | 72.56 |
| 17887 | 79.25 | 984.05 | 226.20 | 1384.89 | 288.41 |
| 6059 | 79.07 | 132.38 | 25.33 | 187.49 | 43.92 |
| 18996 | 83.22 | 175.14 | 36.61 | 124.78 | 29.81 |
| 8445 | 78.64 | 50.64 | 6.93 | 39.43 | 18.79 |
| 1687 | 84.65 | 544.45 | 532.83 | 1797.73 | 696.06 |
| 19188 | 80.32 | 899.58 | 236.54 | 1310.91 | 334.70 |
| 9035 | 79.04 | 153.86 | 24.05 | 125.62 | 27.03 |
| 21648 | 81.57 | 298.40 | 58.99 | 208.18 | 69.29 |

TABLE 5K
TUBULAR OBSTRUCTION

Att. Docket No. GENE-077/26US
Doc. No. 44941

| | | | Tox | Non-Tox | Non-Tox |
|---|---|---|---|---|---|
| GLGC | | Tox Group | Group | Group | Group |
| Identifier | LDA Score | Mean | SD | Mean | SD |
| 3125 | 97.51 | 134.07 | 16.15 | 301.07 | 82.87 |
| 24321 | 97.03 | 278.42 | 73.76 | 654.31 | 157.88 |
| 16172 | 97.00 | 196.13 | 57.63 | 438.64 | 92.11 |
| 11157 | 97.36 | 381.78 | 35.68 | 622.92 | 138.68 |
| 14120 | 95.69 | 344.76 | 63.42 | 681.34 | 196.77 |
| 7804 | 97.51 | 960.98 | 105.31 | 1652.52 | 334.35 |
| 6416 | 98.21 | 579.40 | 132.32 | 123.67 | 88.39 |
| 14677 | 96.97 | 173.50 | 38.06 | 69.76 | 30.14 |
| 22213 | 96.85 | 343.29 | 29.34 | 220.99 | 47.39 |
| 15004 | 98.36 | 1003.54 | 557.03 | 153.76 | 135.69 |
| 7307 | 97.33 | 78.43 | 11.40 | 28.42 | 17.35 |
| 24388 | 96.91 | 366.07 | 61.09 | 177.80 | 66.28 |
| 23076 | 95.88 | 225.13 | 23.27 | 126.52 | 43.88 |
| 14600 | 97.67 | 377.21 | 86.43 | 184.44 | 47.39 |
| 16518 | 97.39 | 1674.58 | 199.69 | 953.13 | 316.63 |
| 17735 | 94.00 | 260.66 | 25.70 | 179.21 | 105.51 |
| 15850 | 92.48 | 1864.12 | 172.78 | 1413.57 | 279.10 |
| 10241 | 97.00 | 135.36 | 24.60 | 59.08 | 23.90 |
| 15297 | 94.24 | 235.35 | 26.33 | 147.28 | 40.80 |
| 17736 | 92.57 | 156.31 | 28.57 | 69.99 | 158.10 |
| 1453 | 95.30 | 123.25 | 24.55 | 52.01 | 26.39 |
| 1454 | 95.27 | 243.07 | 44.54 | 107.34 | 52.73 |
| 25064 | 95.88 | 1945.50 | 256.26 | 1121.25 | 327.07 |
| 13723 | 95.97 | 1591.34 | 343.04 | 844.53 | 377.73 |
| 2629 | 92.97 | 126.65 | 56.54 | 22.18 | 24.99 |
| 20457 | 96.85 | 203.76 | 31.70 | 396.48 | 99.84 |
| 4234 | 92.87 | 227.21 | 26.55 | 368.61 | 110.36 |
| 25198 | 97.09 | 72.42 | 16.64 | 27.14 | 14.63 |
| 10015 | 96.85 | 467.24 | 95.91 | 230.34 | 82.57 |
| 2368 | 94.72 | 338.76 | 47.77 | 623.40 | 131.64 |
| 1214 | 94.88 | 67.47 | 15.18 | 153.85 | 51.68 |
| 968 | 95.42 | 28.67 | 11.78 | 81.24 | 22.91 |
| 17159 | 98.15 | 1500.61 | 126.72 | 787.85 | 215.88 |
| 574 | 97.85 | 1110.83 | 280.01 | 349.51 | 177.04 |
| 20458 | 95.48 | 190.71 | 40.37 | 368.84 | 96.93 |
| 8829 | 97.57 | 506.29 | 44.16 | 283.09 | 85.65 |
| 7196 | 98.06 | 534.14 | 57.92 | 176.74 | 89.27 |
| 1460 | 96.69 | 382.75 | 102.15 | 191.62 | 82.76 |
| 25546 | 94.39 | 236.19 | 103.10 | 500.97 | 150.34 |
| 1472 | 92.75 | 84.81 | 22.82 | 179.09 | 72.56 |
| 20884 | 96.88 | 157.01 | 69.56 | 737.17 | 291.54 |
| 20848 | 98.67 | 1124.03 | 59.72 | 548.54 | 158.49 |
| 25747 | 98.48 | 177.09 | 33.14 | 42.07 | 35.81 |
| 19824 | 94.72 | 96.00 | 24.52 | 215.81 | 73.19 |
| 25802 | 94.94 | 793.44 | 106.90 | 521.62 | 118.73 |
| 24496 | 98.09 | 30.75 | 7.27 | 111.42 | 36.91 |
| 457 | 98.36 | 766.78 | 198.11 | 285.03 | 90.56 |
| 18074 | 94.97 | 109.26 | 17.39 | 48.61 | 23.99 |
| 14970 | 96.85 | 103.48 | 14.71 | 199.88 | 40.65 |
| 1809 | 98.03 | 551.79 | 225.15 | 32.34 | 127.23 |
| 645 | 96.42 | 46.88 | 15.03 | 135.75 | 49.83 |
| 17473 | 96.51 | 693.48 | 64.78 | 442.45 | 103.23 |
| 20983 | 96.51 | 56.90 | 15.12 | 137.12 | 56.79 |
| 1501 | 98.15 | 248.82 | 53.21 | 51.72 | 53.85 |
| 4449 | 93.57 | 129.63 | 26.81 | 243.37 | 70.00 |
| 15002 | 98.24 | 640.78 | 258.49 | 133.14 | 98.70 |
| 15003 | 98.33 | 555.22 | 226.49 | 31.19 | 86.19 |
| 4235 | 96.03 | 655.06 | 64.01 | 411.65 | 95.74 |
| 20828 | 96.82 | 843.23 | 197.75 | 322.31 | 161.39 |
| 7197 | 98.06 | 552.05 | 97.28 | 187.97 | 84.72 |
| 14989 | 94.54 | 784.37 | 97.84 | 533.89 | 115.84 |
| 24649 | 92.66 | 80.76 | 6.94 | 112.06 | 23.19 |
| 21653 | 92.66 | 435.18 | 92.53 | 237.04 | 66.87 |
| 20126 | 92.54 | 206.98 | 53.24 | 75.61 | 46.32 |
| 23651 | 97.33 | 2999.14 | 682.81 | 737.32 | 670.73 |
| 20885 | 97.06 | 196.55 | 50.26 | 589.85 | 226.42 |
| 24563 | 97.73 | 53.16 | 51.89 | 321.95 | 111.13 |
| 24564 | 97.79 | 141.81 | 78.70 | 614.84 | 191.71 |
| 19040 | 98.36 | 746.18 | 87.47 | 181.80 | 113.32 |
| 20816 | 93.24 | 1045.14 | 268.49 | 407.56 | 184.26 |
| 15540 | 93.45 | 116.06 | 52.11 | 33.92 | 19.17 |
| 1824 | 92.72 | 58.52 | 11.62 | 110.12 | 31.28 |
| 2010 | 94.21 | 280.66 | 119.92 | 31.78 | 286.73 |
| 19712 | 94.12 | 38.70 | 9.79 | 84.74 | 26.43 |
| 12606 | 98.36 | 139.84 | 17.95 | 295.27 | 98.40 |
| 1970 | 93.12 | 395.31 | 97.34 | 159.82 | 57.55 |
| 20481 | 93.94 | 123.57 | 15.86 | 201.41 | 41.25 |
| 405 | 94.48 | 122.46 | 18.09 | 208.02 | 63.59 |
| 1463 | 97.48 | 1492.64 | 275.86 | 664.70 | 314.91 |
| 20849 | 92.82 | 517.85 | 86.60 | 281.86 | 89.61 |
| 646 | 94.72 | 210.57 | 63.36 | 527.32 | 192.98 |
| 1993 | 93.48 | 86.65 | 13.28 | 24.00 | 17.68 |
| 15032 | 97.03 | 98.00 | 17.89 | 265.50 | 73.53 |
| 24643 | 95.30 | 22.65 | 15.29 | 92.91 | 36.14 |
| 1510 | 93.94 | 410.93 | 156.67 | 839.46 | 222.78 |
| 1564 | 94.03 | 1045.96 | 352.70 | 42.41 | 190.11 |
| 2465 | 94.75 | 74.41 | 17.98 | 131.77 | 26.88 |
| 20582 | 98.21 | 294.34 | 14.97 | 487.80 | 95.06 |
| 23033 | 95.24 | 416.40 | 24.35 | 579.36 | 117.73 |
| 15833 | 95.39 | 347.90 | 22.55 | 491.39 | 86.11 |
| 9905 | 94.97 | 409.12 | 110.92 | 745.80 | 152.14 |
| 17249 | 93.63 | 662.67 | 98.62 | 1014.19 | 206.07 |
| 2576 | 92.78 | 43.64 | 15.68 | 84.39 | 23.87 |
| 17933 | 96.27 | 250.36 | 25.67 | 394.80 | 75.13 |
| 2107 | 95.94 | 286.61 | 18.41 | 438.00 | 95.36 |
| 13610 | 96.30 | 183.04 | 38.90 | 365.50 | 106.63 |
| 18275 | 97.21 | 161.22 | 17.79 | 261.59 | 56.25 |
| 20088 | 96.00 | 216.81 | 25.74 | 391.74 | 86.08 |
| 23783 | 92.87 | 303.32 | 50.24 | 456.35 | 79.84 |
| 12848 | 93.39 | 278.64 | 36.68 | 431.16 | 92.63 |
| 3438 | 92.81 | 157.80 | 81.72 | 149.25 | 39.94 |
| 14465 | 93.69 | 22.00 | 7.12 | 55.40 | 19.66 |
| 3853 | 94.00 | 89.36 | 14.28 | 154.56 | 34.31 |
| 13332 | 96.12 | 184.35 | 54.35 | 438.90 | 102.70 |
| 17800 | 93.81 | 115.79 | 18.77 | 196.78 | 42.92 |
| 23063 | 93.30 | 242.82 | 57.21 | 390.31 | 77.53 |
| 22910 | 94.33 | 205.38 | 23.87 | 311.27 | 55.99 |
| 17494 | 94.24 | 137.15 | 20.45 | 216.68 | 41.79 |
| 21072 | 93.88 | 97.50 | 27.28 | 199.81 | 51.39 |
| 17325 | 98.03 | 521.47 | 220.14 | 55.89 | 101.96 |
| 21165 | 98.33 | 169.51 | 57.41 | 28.30 | 24.49 |
| 21166 | 97.94 | 715.26 | 183.98 | 263.82 | 92.19 |
| 22631 | 97.57 | 1970.17 | 341.41 | 1035.66 | 227.87 |
| 22536 | 98.15 | 3172.12 | 437.63 | 1609.00 | 403.10 |
| 17477 | 98.03 | 241.66 | 34.05 | 111.41 | 35.04 |
| 4944 | 97.51 | 322.82 | 51.74 | 119.57 | 56.74 |
| 23123 | 98.54 | 948.44 | 137.32 | 316.83 | 113.69 |
| 17363 | 96.21 | 639.82 | 80.77 | 1037.93 | 191.02 |
| 5205 | 96.18 | 86.34 | 21.51 | 204.18 | 49.25 |
| 2563 | 97.12 | 270.81 | 32.33 | 158.90 | 37.75 |
| 2569 | 96.85 | 169.84 | 58.46 | 421.57 | 98.69 |
| 16394 | 97.42 | 1770.55 | 477.74 | 595.39 | 336.14 |
| 3121 | 97.79 | 435.91 | 101.84 | 1290.92 | 319.95 |
| 10532 | 97.54 | 194.55 | 35.06 | 100.22 | 29.27 |
| 15089 | 96.54 | 343.46 | 36.17 | 177.01 | 69.57 |
| 6842 | 98.00 | 214.44 | 33.38 | 110.48 | 29.69 |
| 18657 | 97.67 | 817.51 | 100.75 | 432.51 | 105.51 |
| 3995 | 95.85 | 316.65 | 57.49 | 606.04 | 143.87 |
| 21796 | 97.54 | 1253.95 | 159.97 | 690.15 | 198.29 |
| 3493 | 97.63 | 123.77 | 18.10 | 61.40 | 17.94 |
| 22592 | 98.33 | 743.64 | 93.52 | 227.11 | 172.72 |
| 15928 | 96.73 | 360.97 | 86.20 | 159.46 | 54.19 |
| 21391 | 97.39 | 491.14 | 76.01 | 218.82 | 131.14 |
| 9212 | 95.94 | 1468.88 | 150.78 | 909.30 | 234.39 |
| 21797 | 97.12 | 684.25 | 148.72 | 331.98 | 107.52 |
| 14142 | 96.57 | 126.88 | 24.18 | 75.34 | 18.27 |
| 7414 | 96.48 | 301.62 | 37.09 | 183.56 | 50.38 |
| 19991 | 96.66 | 169.60 | 23.54 | 342.07 | 85.80 |
| 16885 | 96.12 | 481.97 | 76.93 | 847.27 | 179.62 |
| 17221 | 97.03 | 228.07 | 58.62 | 528.15 | 137.97 |
| 14929 | 98.39 | 2578.08 | 443.16 | 753.00 | 395.31 |
| 2534 | 97.03 | 70.98 | 11.01 | 35.47 | 11.17 |
| 22626 | 98.06 | 466.77 | 115.62 | 84.66 | 75.68 |
| 15146 | 98.61 | 552.75 | 212.61 | 125.29 | 66.30 |
| 15964 | 97.03 | 389.05 | 102.49 | 1091.29 | 283.24 |
| 15879 | 97.09 | 195.88 | 18.98 | 348.95 | 67.27 |
| 7892 | 95.72 | 197.94 | 41.59 | 93.14 | 62.88 |
| 12551 | 97.39 | 81.94 | 8.91 | 164.20 | 42.11 |
| 18528 | 96.97 | 806.92 | 124.34 | 361.09 | 159.22 |
| 18529 | 98.00 | 501.19 | 67.11 | 190.38 | 73.93 |

TABLE 5L
NSAIDS

Atty. Docket No. GENE-077/26US
Doc. No. 44941

| | | | Tox | Non-Tox | Non-Tox |
|---|---|---|---|---|---|
| GLGC | | Tox Group | Group | Group | Group |
| Identifier | LDA Score | Mean | SD | Mean | SD |
| 18678 | 84.72 | 196.91 | 72.64 | 100.06 | 53.79 |
| 24321 | 87.93 | 413.07 | 112.27 | 654.29 | 158.97 |
| 19509 | 82.73 | 48.13 | 11.49 | 80.75 | 26.24 |
| 14131 | 82.63 | 69.28 | 24.69 | 33.77 | 24.51 |
| 6046 | 83.07 | 101.90 | 48.10 | 194.33 | 61.90 |
| 14677 | 82.70 | 123.20 | 43.11 | 69.90 | 30.74 |
| 17950 | 82.75 | 89.75 | 11.67 | 61.68 | 19.97 |
| 8759 | 86.16 | 246.43 | 53.78 | 156.18 | 40.90 |
| 6431 | 82.62 | 132.49 | 55.91 | 49.83 | 28.54 |
| 13615 | 90.34 | 398.90 | 85.87 | 240.22 | 52.84 |
| 15666 | 82.57 | 1060.02 | 522.22 | 2855.82 | 1671.25 |
| 15667 | 83.51 | 1304.24 | 352.22 | 2487.79 | 1225.01 |
| 13091 | 80.48 | 52.53 | 22.18 | 93.54 | 32.42 |
| 13092 | 79.97 | 78.72 | 26.06 | 126.13 | 38.28 |
| 15446 | 83.46 | 502.42 | 69.06 | 388.27 | 92.25 |
| 20711 | 84.95 | 140.70 | 71.44 | 33.55 | 34.91 |
| 1857 | 82.73 | 341.51 | 97.88 | 203.31 | 63.37 |
| 20801 | 80.39 | 235.97 | 71.05 | 150.06 | 48.11 |
| 21014 | 83.22 | 324.17 | 132.01 | 148.40 | 78.26 |
| 20713 | 88.19 | 613.63 | 263.40 | 208.35 | 112.71 |
| 4749 | 80.02 | 382.14 | 128.89 | 229.43 | 180.48 |
| 343 | 79.15 | 86.27 | 53.27 | 26.04 | 28.49 |
| 15409 | 80.33 | 650.73 | 204.15 | 413.05 | 118.78 |
| 4290 | 79.94 | 131.21 | 41.46 | 84.46 | 26.82 |
| 1858 | 82.64 | 264.03 | 71.62 | 153.29 | 49.94 |
| 20714 | 85.62 | 475.80 | 301.89 | 167.76 | 86.41 |
| 20457 | 79.40 | 282.98 | 97.45 | 396.37 | 100.16 |
| 18300 | 87.44 | 220.58 | 102.85 | 486.89 | 169.94 |
| 19665 | 78.87 | 164.53 | 59.70 | 88.19 | 51.24 |
| 23868 | 78.20 | 339.24 | 209.69 | 170.18 | 283.60 |
| 23679 | 81.96 | 67.13 | 19.94 | 38.29 | 19.93 |
| 20404 | 80.43 | 94.71 | 35.90 | 45.29 | 43.92 |
| 15535 | 84.79 | 635.56 | 107.51 | 476.52 | 79.47 |
| 3254 | 79.68 | 261.62 | 54.46 | 188.01 | 48.62 |
| 28 | 80.08 | 305.95 | 229.49 | 532.06 | 179.36 |
| 24219 | 79.60 | 487.67 | 128.97 | 321.74 | 100.36 |
| 20458 | 79.76 | 244.63 | 78.16 | 368.93 | 97.12 |
| 24566 | 81.55 | 61.11 | 42.07 | 180.55 | 89.38 |
| 25453 | 78.35 | 158.39 | 37.24 | 209.35 | 50.63 |
| 15137 | 79.56 | 1740.58 | 785.79 | 1800.11 | 446.41 |
| 1943 | 79.66 | 47.96 | 16.20 | 25.73 | 11.95 |
| 23869 | 81.20 | 68.78 | 38.38 | 35.67 | 78.90 |
| 2153 | 80.16 | 416.39 | 243.57 | 174.99 | 148.74 |
| 20715 | 84.77 | 296.44 | 124.89 | 126.05 | 58.80 |
| 18352 | 78.40 | 338.81 | 174.54 | 155.29 | 86.17 |
| 24438 | 82.21 | 98.87 | 20.24 | 143.39 | 40.54 |
| 45 | 78.36 | 76.12 | 49.26 | 173.08 | 76.39 |
| 16610 | 80.56 | 243.87 | 59.82 | 165.05 | 65.89 |
| 9541 | 80.05 | 434.33 | 105.00 | 293.71 | 104.56 |
| 1804 | 81.93 | 1429.11 | 390.65 | 3161.94 | 1771.85 |
| 18713 | 79.36 | 381.95 | 48.08 | 304.10 | 71.82 |
| 4235 | 79.08 | 495.44 | 76.22 | 412.41 | 97.43 |
| 7197 | 79.60 | 330.86 | 107.57 | 188.93 | 88.45 |
| 21975 | 84.94 | 342.10 | 74.80 | 211.95 | 62.48 |
| 15191 | 85.85 | 2673.45 | 2339.47 | 2414.85 | 1220.31 |
| 17516 | 84.12 | 769.10 | 139.21 | 544.65 | 126.18 |
| 8212 | 80.98 | 2755.24 | 1630.16 | 2776.64 | 1026.95 |
| 13004 | 80.46 | 212.11 | 74.18 | 131.27 | 39.09 |
| 17357 | 82.25 | 167.86 | 96.71 | 269.67 | 96.37 |
| 20925 | 78.68 | 466.02 | 114.97 | 342.39 | 120.38 |
| 21443 | 81.12 | 204.24 | 81.36 | 91.06 | 49.71 |
| 21654 | 86.49 | 610.80 | 129.78 | 376.37 | 127.86 |
| 16775 | 84.32 | 572.11 | 282.27 | 1168.56 | 397.36 |
| 1977 | 78.29 | 187.70 | 37.39 | 133.15 | 38.47 |
| 16681 | 81.28 | 120.46 | 46.82 | 63.39 | 25.75 |
| 16552 | 82.19 | 106.93 | 35.18 | 162.92 | 41.40 |
| 21147 | 82.43 | 260.55 | 45.69 | 361.25 | 81.16 |
| 1422 | 81.09 | 170.29 | 61.30 | 300.89 | 105.05 |
| 15032 | 81.50 | 153.02 | 48.41 | 265.54 | 73.91 |
| 17394 | 78.25 | 484.34 | 116.34 | 347.89 | 115.27 |
| 22321 | 82.42 | 175.73 | 62.89 | 94.40 | 68.17 |
| 15411 | 91.34 | 532.28 | 101.56 | 303.52 | 93.15 |
| 21683 | 84.77 | 83.44 | 41.31 | 26.99 | 20.17 |
| 16520 | 80.98 | 273.60 | 150.69 | 86.32 | 98.04 |
| 7489 | 78.33 | 30.74 | 20.35 | 73.04 | 31.19 |
| 1894 | 87.01 | 371.06 | 120.65 | 196.88 | 70.39 |
| 1597 | 84.01 | 141.64 | 66.96 | 42.68 | 38.09 |
| 16476 | 83.27 | 533.78 | 102.18 | 788.60 | 304.36 |
| 16982 | 88.41 | 872.27 | 500.25 | 127.82 | 293.88 |
| 23166 | 87.07 | 254.30 | 83.26 | 126.36 | 61.00 |
| 16312 | 80.12 | 102.23 | 41.22 | 49.22 | 37.54 |
| 15421 | 78.89 | 574.98 | 96.06 | 739.12 | 153.32 |
| 24472 | 78.43 | 185.77 | 62.80 | 235.91 | 53.31 |
| 16446 | 81.63 | 26.33 | 5.45 | 37.15 | 10.18 |
| 18269 | 84.55 | 548.35 | 110.14 | 772.70 | 179.32 |
| 20522 | 82.48 | 341.19 | 119.99 | 166.57 | 84.98 |
| 20523 | 78.29 | 867.83 | 225.50 | 579.11 | 163.88 |
| 17088 | 82.59 | 92.61 | 16.98 | 58.41 | 31.43 |
| 14595 | 92.40 | 158.58 | 45.64 | 77.34 | 33.09 |
| 12276 | 78.61 | 103.82 | 42.09 | 187.47 | 61.18 |
| 20961 | 78.19 | 20.76 | 3.97 | 29.87 | 11.94 |
| 21125 | 82.76 | 96.85 | 28.42 | 152.75 | 47.47 |
| 4661 | 95.47 | 517.39 | 93.47 | 306.62 | 84.32 |
| 21354 | 88.97 | 645.15 | 137.68 | 417.97 | 125.69 |
| 12673 | 82.79 | 90.29 | 25.44 | 40.47 | 22.14 |
| 14763 | 87.65 | 304.65 | 189.03 | 37.13 | 142.64 |
| 17477 | 84.19 | 180.63 | 52.28 | 111.57 | 35.73 |
| 23978 | 83.49 | 74.40 | 21.67 | 112.19 | 29.95 |
| 22479 | 92.04 | 716.72 | 125.18 | 416.64 | 126.59 |
| 5183 | 86.42 | 320.31 | 60.86 | 221.48 | 61.55 |
| 5295 | 83.12 | 408.06 | 135.30 | 217.58 | 80.67 |
| 2457 | 84.67 | 464.90 | 167.87 | 288.94 | 67.89 |
| 11324 | 83.67 | 525.31 | 77.71 | 686.40 | 133.36 |
| 21339 | 84.46 | 79.78 | 30.57 | 34.21 | 20.21 |
| 3020 | 85.38 | 424.83 | 78.70 | 293.70 | 77.59 |
| 22737 | 85.25 | 409.70 | 157.83 | 207.21 | 89.14 |
| 22698 | 87.20 | 115.27 | 56.59 | 268.84 | 120.86 |
| 6833 | 82.80 | 96.02 | 13.68 | 73.52 | 18.72 |
| 22619 | 88.03 | 501.19 | 81.50 | 363.98 | 67.50 |
| 16521 | 87.65 | 508.30 | 116.48 | 282.94 | 73.28 |
| 15679 | 84.16 | 286.66 | 65.08 | 173.83 | 46.74 |
| 24200 | 87.65 | 819.79 | 161.12 | 425.21 | 136.58 |
| 7471 | 82.90 | 308.76 | 49.66 | 224.13 | 54.98 |
| 6758 | 83.67 | 60.74 | 21.52 | 28.80 | 13.40 |
| 7299 | 97.84 | 646.85 | 211.22 | 178.29 | 134.95 |
| 7451 | 82.91 | 502.98 | 103.58 | 367.08 | 83.19 |
| 23712 | 83.36 | 224.13 | 38.61 | 157.15 | 38.03 |
| 7540 | 97.93 | 486.02 | 138.76 | 157.21 | 80.71 |
| 8065 | 85.15 | 225.82 | 45.65 | 163.47 | 35.91 |
| 8202 | 84.27 | 377.45 | 72.53 | 277.16 | 54.79 |
| 8820 | 82.74 | 530.25 | 320.31 | 138.57 | 119.39 |
| 24197 | 84.17 | 107.40 | 60.94 | 236.21 | 79.34 |
| 19031 | 85.24 | 118.24 | 42.75 | 59.90 | 50.43 |
| 9026 | 82.73 | 109.55 | 35.12 | 60.22 | 26.27 |
| 9583 | 85.07 | 208.74 | 101.61 | 55.02 | 59.66 |
| 11057 | 85.12 | 96.32 | 38.40 | 34.75 | 28.49 |
| 15538 | 85.56 | 293.17 | 36.37 | 218.71 | 56.03 |
| 12921 | 90.13 | 225.68 | 80.44 | 101.95 | 47.41 |
| 19011 | 82.51 | 487.88 | 60.90 | 393.64 | 86.49 |
| 12979 | 89.28 | 754.80 | 237.57 | 364.95 | 194.44 |
| 4119 | 85.47 | 162.78 | 28.48 | 109.13 | 32.45 |
| 1807 | 84.08 | 1593.11 | 543.91 | 4019.95 | 2715.05 |
| 21956 | 82.63 | 206.97 | 23.50 | 163.56 | 37.58 |
| 22103 | 86.70 | 364.57 | 103.66 | 219.40 | 53.63 |
| 13310 | 87.15 | 232.04 | 61.40 | 124.22 | 68.91 |
| 15964 | 91.55 | 539.50 | 171.88 | 1092.30 | 283.63 |
| 14425 | 82.88 | 332.80 | 79.03 | 203.82 | 68.76 |
| 13614 | 94.20 | 559.10 | 110.65 | 323.06 | 68.04 |
| 23151 | 91.91 | 200.64 | 48.10 | 356.08 | 100.63 |
| 6102 | 86.24 | 198.65 | 25.41 | 143.71 | 30.86 |

We claim:

1. A method of predicting for the nephrotoxicity of a test compound, comprising:
(a) preparing a gene expression profile of at least ten genes from a kidney tissue or kidney cell sample exposed to the test compound; and
(b) comparing the expression levels of said genes from the gene expression profile to a database comprising the gene expression levels of said genes derived from kidney tissue or kidney cell samples that have been exposed to at least one known nephrotoxin, wherein said at least ten genes are selected from the genes in any one of Tables 5-5L, thereby predicting for the nephrotoxicity of the test compound.

2. The method of claim 1, wherein the gene expression profile prepared from the kidney tissue or kidney cell sample comprises the level of expression for at least 100 genes.

3. The method of claim 1, wherein expression levels for said at least ten genes from the gene expression profile are compared to Toxic Mean and/or NonToxic Mean values in a database comprising any one of Tables 5-5L.

4. The method of claim 1, wherein the level of expression for each gene is normalized prior to comparison.

5. The method of claim 1, wherein the database comprises all of the data in any one of Tables 5-5L.

6. The method of claim 1, wherein the expression levels of at least 15 genes are compared to the database.

7. The method of claim 1, wherein the expression levels of at least 20 genes are compared to the database.

8. The method of claim 1, wherein the expression levels of at least 25 genes are compared to the database.

9. The method of claim 1, wherein the expression levels of at least 30 genes are compared to the database.

10. The method of claim 1, wherein the expression levels of at least 50 genes are compared to the database.

11. The method of claim 1 wherein the expression levels of at least 75 genes are compared to the database.

12. The method of claim 1, wherein the expression levels of at least 100 genes are compared to the database.

13. The method of claim 1, wherein the kidney cell or kidney tissue sample is exposed to the test compound in vivo and the kidney cell or kidney tissue samples from which database information is derived are exposed to the at least one known nephrotoxin in vivo.

14. The method of claim 13, wherein the nephrotoxicity is associated with at least one kidney disease pathology selected from the group consisting of nephritis, kidney necrosis, glomerular or tubular injury or toxicity, tubular obstruction, Non-Steroidal Anti-Inflammatory Drug (NSAID) exposure pathology, and focal segmental glomerulosclerosis.

15. The method of claim 13, wherein the nephrotoxin is selected from the group consisting of chloroform, diclofenac, menadione, sodium chromate, sodium oxalate, thioacetamide, and vancomycin.

16. The method of claim 1, wherein the gene expression profile is produced by hybridization of nucleic acids to a microarray.

17. The method of claim 1, wherein the kidney cell or kidney tissue sample is a rat kidney cell or rat kidney tissue sample.

18. The method of claim 1, wherein the genes in Tables 5-5L are rat genes.

19. The method of claim 13, wherein the nephrotoxicity is kidney necrosis.

20. A method of predicting for the renal toxicity of a test compound, comprising:
(a) preparing a gene expression profile of at least ten genes from a kidney tissue or kidney cell sample exposed to the test compound; and
(b) comparing the expression levels of said genes from the gene expression profile to a database comprising the gene expression levels of said genes derived from kidney tissue or kidney cell samples that have been exposed to at least one known renal toxin, wherein said at least ten genes are selected from the genes in any one of Tables 5-5L, thereby predicting for the renal toxicity of the test compound.

21. The method of claim 20, wherein the gene expression profile prepared from the kidney tissue or kidney cell sample comprises the level of expression for at least 100 genes.

22. The method of claim 20, wherein expression levels for said at least ten genes from the gene expression profile are compared to Toxic Mean and/or NonToxic Mean values in a database comprising Tables 5-5L.

23. The method of claim 20, wherein the level of expression for each gene is normalized prior to comparison.

24. The method of claim 20, wherein the database comprises all of the data in any one of Tables 5-5L.

25. The method of claim 20, wherein the expression levels of at least 15 genes are compared to the database.

26. The method of claim 20, wherein the expression levels of at least 20 genes are compared to the database.

27. The method of claim 20, wherein the expression levels of at least 25 genes are compared to the database.

28. The method of claim 20, wherein the expression levels of at least 30 genes are compared to the database.

29. The method of claim 20, wherein the expression levels of at least 50 genes are compared to the database.

30. The method of claim 20, wherein the expression levels of at least 75 genes are compared to the database.

31. The method of claim 20, wherein the expression levels of at least 100 genes are compared to the database.

32. The method of claim 20 wherein the kidney cell or kidney tissue sample is exposed to the compound in vivo and the kidney cell or kidney tissue samples from which database information is derived are exposed to the at least one known renal toxin in vivo.

33. The method of claim 32, wherein the renal toxicity is associated with at least one kidney disease pathology selected from the group consisting of nephritis, kidney necrosis, glomerular or tubular injury or toxicity, tubular obstruction, Non-Steroidal Anti-Inflammatory Drug (NSAID) exposure pathology, and focal segmental glomerulosclerosis.

34. The method of claim 32, wherein the renal toxin is selected from the group consisting of chloroform, diclofenac, menadione, sodium chromate, sodium oxalate, thioacetamide, and vancomycin.

35. The method of claim 20, wherein the gene expression profile is produced by hybridization of nucleic acids to a microarray.

36. The method of claim 20, wherein the kidney cell or kidney tissue sample is a rat kidney cell or rat kidney tissue sample.

37. The method of claim 20, wherein the genes in Tables 5-5L are rat genes.

38. The method of claim 32, wherein the renal toxicity is kidney necrosis.

39. A method of predicting for the nephrotoxicity of a test compound, comprising:
(a) preparing a gene expression profile of at least ten genes from a kidney tissue or kidney cell sample exposed to the test compound, wherein said at least ten genes are selected from any one of Tables 5-5L.

40. A method of predicting for the nephrotoxicity of a test compound, comprising:
(a) comparing the expression levels of at least ten genes from a kidney tissue or kidney cell sample exposed to the test compound to a database comprising the gene expression levels of said at least ten genes derived from kidney tissue or kidney cell samples that have been exposed to at least one known nephrotoxin, wherein said at least ten genes are selected from the genes in any one of Tables 5-5L, thereby predicting for the nephrotoxicity of the test compound.
